(19) United States
(12) Patent Application Publication
(10) Pub. No.: US 2003/0007442 A1
(43) Pub. Date: Jan. 9, 2003

(54) Light intensity modulated direct overwrite magneto-optical microhead array chip hard disk drive

(76) Inventor: Joseph Reid Henrichs, Lee's Summit, MO (US)

Correspondence Address: Joseph Reid Henrichs, 641 Northeast Swann Circle, Lee's Summit, MO, 64086, US

(21) Appl. No.: 10/191,459

(22) Filed: Jul. 9, 2002

Related U.S. Application Data
(60) Provisional application No. 60/304,064, filed on Jul. 9, 2001.

(51) Int. Cl. G11B 7/00

(52) U.S. Cl. 369/95; 369/124.03

(57) ABSTRACT

A magneto-optical data storage hard disk drive that uses stationary “Light Intensity Modulated Direct Over-Writey” (LIMDOW) or “Magnetically induced Super Resolution” (MSR) ‘Magneto-Optical Microhead Array Chips’ in place of conventional flying-heads, rotary voice-coil actuators, or other similar types of ‘servo-tracking’ mechanisms to simultaneously record and/or reproduce data to and/or from a multitude of data-tracks located across the data-surfaces of a multitude of LIMDOW or MSR disc media that comprise two or more different coercive force regions at room temperature, using a multitude of microheads.

### CROSS-REFERENCE TO RELATED APPLICATIONS

This application is entitled to the benefit of Provisional Patent Application, Ser. No. 60/304,064, filed in the U.S. Patent and Trademark Office Jul. 9, 2001.

### BACKGROUND—FIELD OF THE INVENTION

This invention relates to a magneto-optical data-storage hard disk drive device which uses stationary “Light Intensity Modulated Direct Over-Write” (LIMDOW) or “Magnetically induced Super Resolution” (MSR) Magneto-Optical Microhead Array Chips in place of conventional ‘Flying-Heads’, ‘Rotary Voice-Coil Actuators’, or other similar types of ‘Servo-Tracking’ mechanisms to simultaneously record and reproduce in parallel, using a multitude of microheads, data to and from a multitude of data-tracks located across a multitude of LIMDOW or MSR disc-platter data-surfaces that comprise two or more different coercive force regions.

### BACKGROUND—DESCRIPTION OF PRIOR ART

Magnetic-optical storage media used for the repeated writing and reading out of high-density information typically employ a medium that includes a substrate, a first magnetic layer for reading out information, a second magnetic intermediate layer, and a third magnetic layer for storing information, where the Curie temperature of the second layer is lower than the Curie temperature of the first and the third layer. Magneto-optical storage media enable economical storage and transport of large quantities of data. Moreover, as prior art shows, they combine the high bit density and data integrity of optical data recording with the permanence and ease of erasability of magnetic storage. As in conventional magnetic storage media, information is stored as a sequence of differently magnetized regions (i.e., as magnetic domain patterns). Furthermore, magneto-optical storage media are characterized by their extremely reliable, fast, and substantially unlimited rewritability.

Moreover, information can be written on a magneto-optical storage medium by combining the effect of a magnetic field with the heating effect of a laser. The laser light heats a local region of the storage medium while the magnetic field orients this region. The direction of the magnetization is then dependent on the direction of the applied magnetic field. Reading out data is performed by means of the same laser, which, however, is then operated with a lower intensity. The polarization direction of the reflected or transmitted light is dependent on the magnetization of the relevant location. This variation in polarization can be measured; thus, yields the stored information again. Physically speaking, this interaction between magnetic materials and polarized laser light is referred to as the Kerr Effect (i.e., reflection) or Faraday Effect (i.e., transmission). Magneto-optical storage media should have a high-data-density, a high-write-sensitivity, and a high-read-out accuracy.

Moreover, as prior art shows, the maximum data density that can be achieved for magneto-optical media is limited on the one hand by the minimum size of the magnetic domains and on the other hand by the optical resolution of the laser optical system. Because the minimum size of the magnetic domains is significantly smaller than the optical resolution of conventional laser optical systems, being proportional to the wavelength of the laser used, the storage density ultimately is limited by the resolution of the laser optical system. As opposed to optical phase change storage media, for magneto-optical storage media “Magnetically induced Super Resolution” (MSR) can be achieved by using exchange coupled layer systems while utilizing the temperature gradient produced on the medium by the laser beam. Such an MSR method enables the reading-out of data with a data density which is higher than that corresponding to the resolution of the laser optical system, because all bits, except the current bit being processed, are situated underneath a magnetic mask. Consequently, data can be read with a data density, which is higher than the density corresponding to the resolution of the laser optical system.

Nevertheless, it is attempted to increase the data density even further and to reduce the hardware required for the drives. For example, EP0 686,970 discloses a magneto-optical storage medium which includes a substrate, a first magnetic layer which is laminated on the substrate in order to reproduce information, a second magnetic layer which is laminated on the first magnetic layer in order to store the information, and a third magnetic layer which is disposed between the first and the second magnetic layer and has a Curie temperature which is lower than the Curie temperature of the first and the second magnetic layer, a direction of the magnetization of a region in the first magnetic layer, neighboring a region in the third magnetic layer, being oriented in the direction of the magnetization in the vicinity of the region in the first magnetic layer at a temperature which is equal to or higher than the Curie temperature of the third layer. It is an object of the present invention to provide a magneto-optical storage medium, which enables a high signal resolution with a high data-density.

According to the invention, this object is achieved by means of a magneto-optical storage medium for the repeated writing of information at a write temperature T_{w}, or at two write temperatures Tₕ, Tₗ above room temperature Tₐ and for the repeated reading out at a temperature Tₘ, with a front mask at the temperature T_{f} and a rear mask at a temperature Tᵣ, above the room temperature Tₐ, in an external magnetic field Hₑ; wherein, the disc medium includes a substrate, a first magnetic layer which is disposed onto the substrate and has a temperature-dependent coercivity H_{C1}(T), a compensation temperature T_{cp1} and a Curie temperature T_{C1}, a second magnetic layer, which is disposed onto the first magnetic layer and has a temperature-dependent coercivity H_{C2}(T), a compensation temperature T_{cp2} and a Curie temperature T_{C2}, and a third magnetic layer, which is disposed onto the second magnetic layer and has a temperature-dependent coercivity H_{C3}(T), a compensation temperature T_{cp3} and a Curie temperature T_{c3}, wherein:

Tₐ<T_{f}<Tₘ<T_{cp1}<T_{cp2}<T_{C2}<Tᵣ<T_{C1}<T_{cp3}<T_{C3}<T_{w}

and

H_{C1}(T)<Hₑ for Tₐ<T<Tₘ

H_{C2}(T)<Hₑ for Tₐ<T<Tₘ

H_{C3}(T)>Hₑ for T<T_{w}

Because of the enhanced magneto-optical effect, the magneto-optical storage medium according to the invention features a high signal-to-noise ratio. The magnetic properties of the read-out layer change drastically in the read-out spot and produce acute and suitably defined transitions between the various magnetic configurations during the reading-out by means of magnetic super resolution.

Moreover, a preferred embodiment of the magneto-optical storage medium according to prior art is characterized in a medium that includes a fourth magnetic layer, which is disposed on the third magnetic layer and has a temperature-dependent coercivity H_{C4}(T), a compensation temperature T_{cp4}, a Curie temperature T_{C4}, and the write temperatures Tₗ, and Tₕ, wherein:

Tₐ<T_{f}<Tₘ<T_{cp1}<T_{cp2}<T_{C2}<Tᵣ<T<T_{C1}<T_{cp3}<T_{cp4}<T_{C3}<Tₗ<T_{C4}<Tₕ

and

H_{C4}(T)<Hₑ for Tₐ<T<Tₘ and for T<Tₕ

Moreover, such an embodiment of a magneto-optical storage medium according to prior art is suitable for writing by means of a “Laser Intensity Modulated Direct Overwrite” (LIMDOW) method, where the intensity of the laser beam determines the ultimate magnetization direction. New data is then written directly over the old data in one pass, without it being necessary to erase the old data first, during a separate write cycle. The write cycle is thus reduced, and therefore the magneto-optical drive may have a simple construction for both embodiments, because only one external magnetic field is required for the write-data and read-data cycle.

Moreover, first recognized technique includes a conventional magneto-optical disc apparatus using a magneto-optical disc satisfying the requirements of the ISO standard (i.e., hereinafter abbreviated as ISO magneto-optical disc), for recording a new data on a magneto-optical recording medium of the magneto-optical disc, in which old data previously recorded on tracks on the magneto-optical recording medium is erased. The new data is then recorded on the tracks. Thus, a predetermined inherent time is needed for recording data on the magneto-optical recording medium.

In order to shorten the time for recording the data on the magneto-optical recording medium, a light intensity modulation overwriting technique is proposed. The light intensity modulation overwriting technique uses a magneto-optical recording medium having multi-layer configuration capable for directly overwriting the data on the recording medium. The recording medium includes a recording-reproducing layer having a first vertical magnetic anisotropy and a supplemental recording layer having a second vertical magnetic anisotropy which is different from the first vertical magnetic anisotropy of the recording-reproducing layer, (i.e., see: “Recording Power Characteristics of 130-mm Overwritable MO Disc by Laser Power Modulation Method” Japanese Journal of Applied Physics, Vol. 28 (1989) Supplement 28-3 pp. 367-370).

The principle of the light intensity modulation overwriting technique is described here using a recording medium such as a magneto-optical disc, which includes at least a referential layer and a recording layer. The coercive force of the referential layer is smaller than that of the recording layer at the room temperature. The Curie temperature of the referential layer is smaller than that of the recording layer at the room temperature. The Curie temperature of the referential layer is higher than that of the recording layer. In case of overwriting the data on the recording medium, an initializing magnetic field generator is typically used for arranging the magnetization in each region of the referential layer in the same direction. When the recording medium is rotated in a counterclockwise direction, the magnetization of the referential layer is arranged in, for example, the downward direction by the magnetic field of the initializing magnetic field generator (i.e., wherein the initializing magnetic field generator is structurally provided by a permanent magnet or induction-coil).

However, the magnetization in each region of the recording layer does not change, since the coercive force of the recording layer is selected to be much higher than the intensity of the magnetic field due to the initializing on a recording medium's surface by an objective lens. The intensity of the laser light-beam can be provided at three levels: 1.) A low-power output level; 2.) A normal-power output level; and 3.) A high-power output level. When the data is overwritten on the recording medium, the laser light-beams is adjusted at the normal powered level and at the higher-powered level. When the intensity of the laser light is adjusted at the normal powered level, a temperature in a first portion of the referential layer and a temperature in a second portion of the recording layer respectively positioned below region irradiated (i.e., hereinafter abbreviated as the laser irradiated region) respectively become higher than the Curie temperature of the recording layer, but lower than the Curie temperature of the referential layer.

Accordingly, the magnetization in the second portion of the recording layer positioned just below the laser-irradiated region will be erased. On the other hand, the magnetization in the first portion of the referential layer, which is below the laser-irradiated region via the second portion, is not erased. At this time, according to prior art, a magnetic field due to a biasing magnetic field generator or permanent magnet exists in the first and second portions, which are positioned below the laser-irradiated region.

However, the intensity of the magnetic field due to the biasing magnetic field generator or permanent magnet is too weak to change the magnetization in the first portion of the referential layer. When the second portion of the recording layer, where the magnetization was erased has receded from the laser-irradiated region, the temperature in the second portion of the recording layer becomes lower.

Thus, the magnetization will appear in the second portion of the recording layer again. At this time, the magnetic exchange interacts between the referential layer and the recording layer, so that the magnetization in the second portion of the recording layer arranges in the same direction (i.e., a downward magnetization direction that is oriented toward the medium substrate) as the magnetization in the first portion of the referential layer. When the intensity of the laser light is adjusted to the higher level, the temperature in the first region of the referential layer and the temperature in the second region, which are positioned below the laser irradiated region, respectively become higher than both the Curie temperature of the recording layer and the Curie temperature of the referential layer; both the magnetization in the second portion of the recording layer and the magnetization in the first portion of the referential layer are erased.

Moreover, when the first portion of the referential layer and the second portion of the recording layer have receded from the laser-irradiated region, the temperatures of the first and second portions will decrease. The magnetization appears to be in the first portion of the referential layer faster than in the second portion of the recording layer. At this time, the first portion of the referential layer is effected by the magnetic field due to the biasing magnetic field generator or permanent magnet, so that the magnetization in the first portion turns reversibly into an upward direction (i.e., away for the medium substrate). When the temperature of the first and second portions decrease further, then the magnetization in the second portion of the recording layer appears again. The magnetization in the second portion of the recording layer arranges in the same direction (i.e., into an upward direction away from medium substrate) as the magnetization in the first portion of the reference layer due to the magnetic exchange interaction.

Moreover, by changing the intensity of the laser light-beam between the normal powered level and the higher-powered level corresponding to the digital information of a “0” and a “1”, which are to be recorded, new data can be directly overwritten onto the recording medium free from the old previously recorded data. On the other hand, when the laser light-beam is irradiated at the lower powered level, which is used for reproducing the data recorded on the recording medium, the temperature in the second portion of the recording layer positioned below the laser irradiated region is lower than the Curie temperature of the recording layer, so that the magnetization in the second portion of the recording layer does not change. Accordingly, the data recorded on the recording layer can be reproduced by detecting the direction of the magnetization in the second portion of the recording layer by using the lower powered level laser light-beam.

In addition, as prior art shows, there is a second technique, which includes a multi-layer magneto-optical recording medium having two or more layers respectively having different coercive forces for increasing the recording density (i.e., sometimes called the reproducing density). The data is read out from a region narrower than the diameter on the laser light spot (i.e., see: NIKKEI ELECTRONICS, 1991.10.28 No. 539, pp 223-233). This technique is called “Magnetically induced Super Resolution” (i.e., hereinafter abbreviated as MSR technique), since the super resolution effect can be obtain by utilizing the magnetic characteristics of magnetic layers different from each other due to the temperature.

Moreover, the MSR technique can also include a “Front Aperture Detection” method of detection (i.e., hereinafter abbreviated as FAD) or a “Rear Aperture Detection” method of detection (i.e., hereinafter abbreviated as RAD). The FAD uses a recording medium having a recording layer, an insulating layer, and a reproducing layer, where the data is read out from a lower temperature portion on the recording medium. The RAD uses a recording medium having a recording layer and a reproducing layer, where the data is read out from a higher temperature portion on the recording medium. While another method called, the D-RAD method uses a recording medium having a recording layer, a middle layer, a supplemental reproducing layer, and a reproducing layer, where data is read out from a portion at a predetermined temperature on the recording medium.

In the above-mentioned MSR techniques, the FAD, the RAD, and the D-RAD methods all need a magnetic field generator for initializing the recording medium. In the FAD and RAD method, the magnetic field generator is used for arranging the magnetization in the reproducing layer into the same direction. In the D-RAD method, the magnetic field generator is used for arranging the magnetization of the supplemental reproducing layer and the reproducing layer into the same direction. Moreover, both the RAD and D-RAD need two magnetic field generators, an initializing magnetic field generator, and a reproducing magnetic field generator. The initializing magnetic field generator generates a large intensity magnetic field for initializing the recording medium. While, the reproducing magnetic field generator generates a magnetic field in the opposite direction to and smaller than the magnetic field generated by the initializing magnetic field generator.

Moreover, as prior art shows, both the RAD and the D-RAD media include a reproducing layer, a supplemental reproducing layer, a middle layer, a recording layer, and a substrate. When data on a RAD and a D-RAD magneto-optical disc is reproduced, a laser light spot is focused along the track on the magneto-optical disc. When the laser light spot is focused on the rotating magneto-optical disc, the temperature distribution of each magnetic layer, including the reproducing layer and the supplemental reproducing layer, becomes rotationally asymmetric, such as in an oval shape, which appears on the rear side of the laser light spot. The temperature distribution can be considered to be divided into two regions: 1.) A high temperature region, and 2.) A middle temperature region. The high temperature region is defined as a region where the temperature is higher than the Curie temperature T_{c} of the supplemental reproducing region.

Moreover, signals (i.e., data) that are assumed to be previously recorded as thermomagnetically recorded magnetic domains on the medium's recording layer. Wherein, the middle layer is provided for stabilizing the magnetic walls when the magnetization of the reproducing layer coincides with that of the recording layer, and the reproducing operation of the magneto-optical disc is as follows.

First, the magnetization in the reproducing layer is arranged in the same direction (i.e., for example, in a downward direction) by an initializing magnetic field. When the laser light is irradiated on the magneto-optical disc for reproducing the data, the temperature distribution such as the high temperature region and the middle temperature region occurs in each magnetic layer. In the reproducing layer, the coercive force is reduced due to the increase of the temperature, so that the magnetic exchange interaction between the reproducing layer and the recording layer governs in the middle temperature region.

Thus, the magnetization in the reproducing layer is arranged into the same direction as the magnetization in the recording layer. On the other hand, the temperature in the high temperature region in the supplemental reproducing layer becomes higher than the Curie temperature of the supplemental reproducing layer, so that the magnetization in the supplemental reproducing layer disappears. When the magnetization disappears, the magnetic exchange interaction between the reproducing layer and the recording layer corresponding to the high temperature region will be intercepted. Thus, the magnetization in the reproducing layer is governed by the reproducing magnetic field and the magnetization in the reproducing layer is arranged in the same direction (i.e., for example, in an upward direction).

Moreover, with respect to the direction of the magnetization in the reproducing layer under the laser light spot, there are three regions. The magnetization in a first region is arranged into a downward direction at all times by the effect of the initializing magnetic field. The magnetization in a second high-temperature region is arranged into an upward direction at all times by the biasing magnetic field. The magnetization in a third middle temperature region is arranged into the same direction as the magnetization in the recording magnetic domain. In the first and second regions, the magnetization is arranged into the constant direction at all times, so that data or information cannot be obtained from the first and second regions. The data or information in the recording layer can be obtained only from a region where the laser light spot and the middle temperature region are overlapped. The other region where the laser light spot is irradiated can be regarded as substantially masked. In other words, even when the recording magnetic domain is much smaller than the laser light spot, the data recorded in the recording magnetic domain can be reproduced. Therein, providing the MSR Magneto-Optical Microhead Array Chip Hard Disk Drive with an installed multiplicity of disk-platters comprised as double-sided multilayered MSR disk-media, which clearly exhibits an increase in the previously mentioned MSR disk-media's capacity for the storage and reproduction of information.

Moreover, the above-mentioned techniques relate to the recording and reproducing magneto-optical disc media. On the other hand, with respect to the single use of reproducing magneto-optical disc media, a method for increasing the recording density by using a super resolution method is discussed in, for example, Publication Gazette of Unexamined Japanese Patent Application Hei 5-266523.

In addition, as prior art shows, a third technique (i.e., typically a removable disc media) includes a first dielectric layer, a recording layer made of magnetic material, a second dielectric layer, and a reflection layer serially laminated on a transparent substrate. Marks, which are gathering of minute convex and concave, are typically formed on the surface of the transparent substrate. Wherein, data or information is defined by the marks, and the marks are transferred to a surface shape of the first dielectric layer. The surface shape of the first dielectric layer is reflected to the change of coercive force of the recording layer, which is disposed above the first dielectric layer. More specifically, the coercive force located in marked portions in the recording layer disposed above the marks is selected to be relatively larger, and the coercive force located in the other non-marked portions is selected to be relatively smaller. In other words, as prior art shows, the third technique relates to the super resolution reproducing method using the recording media in which the coercive force in marked portions is different from the other portions.

Moreover, in a first reproducing method, an initializing magnetic field H₁, which is larger than the coercive force Hₘ located in the marked portions and the coercive force Hₙ located in the non-marked portions and has a predetermined constant direction is applied to the recording medium. Thus, the marked portions and the non-marked portions are magnetized in the same direction. After applying the initializing magnetic field H₁, a reversing magnetic field H₂, which has an intensity between Hₘ and Hₙ and has a direction opposite to the initializing magnetic field H₁, is applied for reversing the magnetization direction in the non-marked portions.

Thus, the magnetization in the marked portions is reversed to that in the non-marked portions. Under this condition, when a laser light-beam, which is relatively intense so as to erase the magnetization in the marked portions and the non-marked portions in the rear of the laser light-beam spot is irradiated on the recording medium, a signal can be detected from the portion ahead of the laser light-beam spot. Thus, a signal from the marked portion, which is narrower than the laser light-beam spot, can be obtained. In this method, an initializing magnetic field generator and the reversing magnetic field generator are necessarily disposed ahead of the laser light-beam spot.

Furthermore, in a second reproducing method, the initializing magnetic field generator (i.e., intensity of output magnetic field H₁) is disposed ahead of the laser light-beam spot, and both of the marked portions are magnetized in a predetermined direction. After that, a relatively weak biasing magnetic field H₃ is typically applied, while the reproducing laser light-beam of the magnetic field H₃ is typically provided near the region where the reproducing laser light-beam is irradiated. At this time, the power (i.e., sometimes called amplitude) of the laser light-beam is controlled in order to heat the recording layer at a temperature lower than the Curie temperature of the recording layer in a manner so that only the magnetization in the non-marked portions in which the coercive force is relatively small turns reversibly by the biasing magnetic field H₃, but the magnetization in the marked portions in which the coercive force is relatively large is not turned. By such operations, the magnetization in the non-marked portions where the temperature reaches a predetermined value typically turns in a region where the reproducing laser light-beam is irradiated, and the change of the magnetization can be detected as a signal. Consequently, high-density reproduction can be achieved.

Moreover, the above-mentioned first reproducing technique needs an initializing magnetic field generator for generating an intense magnetic field of such as “2” to “5” kilo-oersted on the recording medium, and a recording magnetic field generator for generating a magnetic field in the several hundreds of oersted. The above mentioned second reproducing technique also needs an initializing magnetic field generator to generate an intense magnetic field of such as “2” to “5” kilooersted on the recording medium, and a reproducing magnetic field generator for generating the magnetic field in the several hundreds of oersted.

Moreover, the first reproducing method in the third technique needs an initializing magnetic field generator for generating an intense magnetic field of such as “2” to “5” kilooersted on the recording medium, and a reversing magnetic field generator for generating the magnetic field H₂ in the several hundreds of oersted, which has an intensity between Hₘ and Hₙ and a direction opposite to the initializing magnetic field H₁, and is used for reversing the magnetization direction in the non-marked portions. While, the second reproducing method in the third technique needs an initializing magnetic field generator for generating an intense magnetic field of such as “2” to “5” kilooersted on the recording medium, and a biasing magnetic field generator for generating the biasing magnetic field in the several hundreds of oersted, which is used for reversing the magnetization in the non-marked region.

Namely, each of the above-mentioned techniques involves a first (i.e., initializing) magnetic field generator for generating “2” to “5” kilooersted, and a second magnetic generator for generating the magnetic field of several hundreds oersted. It, however, is very difficult to dispose a second magnetic field generator under the condition that a magnetic field having intensity sufficient to prevent the contact of the initializing magnetic field generator and the recording medium when it is applied to the recording medium.

Actually, as prior art shows, in a conventional apparatus using an ISO 3.5-inch type cartridge containing a magneto-optical disc media, the opening of the cartridge is too narrow to provide two magnetic field generators. If magnetic field generators are forcibly provided in the opening, the intensity of the magnetic field generated by the initializing magnetic field generator is larger, so that the magnetic field leaks into an objective lens actuator (i.e., focusing lens induction coil) and the objective lens moves abnormally. Furthermore, the magnetic field generated by the second magnetic field generator is affected by the magnetic field generated by the initializing magnetic field generator, so that the intensity of the magnetic field generated by the second magnetic field generator cannot be controlled to the desired value.

In addition, prior art has also shown examples of disc media that incorporates an additional magnetic layer into itself to eliminate therein the need for an external biasing magnetic field. This is explained in more detail below. Moreover, a magneto-optical recording medium that is capable of direct overwriting by light intensity modulation without using a separate source for generating an external magnetic field. A prior art magneto-optical recording medium capable of light-modulated overwriting is described in Journal of Applied Physics, Vol. 67, No. 9, pp. 4415-4416. Typically, a device like the one described in the journal above normally comprises a light beam that issues from a light source such as a laser that is typically focused by a lens, a source for or of generating a magnetic field H_{b}, a transparent glass or plastic substrate overwritten with four magnetic layers that are bound together by exchange force; wherein, the first layer stores binary-level information “0” or “1” depending upon whether magnetization is directed upward or downward.

Moreover, in a reproduction mode, a laser beam is applied and the resulting magneto-optical Kerr Effect causes the plane of polarization to rotate, whereupon the direction of magnetization is read out as binary-level information. The second to fourth layers are necessary for achieving light-modulated overwriting. In particular, the fourth layer, after it is formed, is magnetized over the entire surface in a uniform direction, say, upward. Since, as prior art shows, the fourth layer has an extremely high Curie point and a large coercive force, it will not experience reversal of magnetization in either a recording or reproduction mode and instead it will maintain the upward direction of magnetization almost indefinitely. The specific actions of the second and third layers will be described later in this specification. The Curie points of the four layers generally have the following relationship (i.e., with the Curie point of the i-th layer being denoted by T_{ci}):

T_{c3}<T_{c1}<T_{c2}=T_{c4}

Furthermore, as prior art shows, the mechanism and method of direct overwriting is described as using a laser beam that can take on three intensity levels, P_{R}, P_{L} and P_{H} (i.e., _{R} for read; _{L} for low; _{H} for high). Wherein, P_{R}, which represents the intensity level in a reproduction mode, is so small that it will not cause any change in the state of magnetization of the medium. On the other hand, P_{L} and P_{H}, which represent the intensity levels of the laser beam applied in a recording mode, are large enough to change the state of magnetization of the medium. These two intensity levels satisfy the relation P_{H}>P_{L}. When “0” of binary-level information is to be recorded, the laser beam is applied at the intensity level P_{L} and, if “1” is to be recorded, the laser beam is applied at the intensity P_{H}. When the medium is illuminated with P_{L}, its temperature rises up to T_{L} and if it is illuminated with P_{H}, its temperature rises up to T_{H}(T_{H}>T_{L}).

Moreover, as the area of the medium heated by illumination with a laser beam spot begins to cool, the magnetization of each layer is reversed in this cooling process. However, before describing in detail the changes of magnetization that occurs during illumination and cooling processes let us make a brief review of the basic properties of rare-earth/transition metal (i.e., hereunder designated RE-TM) systems, which are commonly used as magneto-optical materials. RE-TM systems are generally referred to as ferrimagnetic materials and RE is bound to TM in such a way that their magnetizations cancel each other (i.e., in an antiparallel fashion).

Hence, the overall magnetization is oriented in the direction of whichever the greater of the magnetizations of RE and TM and its strength is determined by the difference between the two magnetizations. If the magnetization of RE is the stronger, the magneto-optical material of interest is said to be ‘RE dominant’ and, in the opposite case, it is said to be ‘TM dominant’. A composition where the overall magnetization is zero is given a special name, ‘Compensated Composition’. As the temperature increases, the magnetizations of both RE and TM decrease; however, since the magnetization of RE decreases more rapidly than the magnetization of TM, there is a tendency for the overall magnetization to shift from ‘RE dominant’ to ‘TM dominant’ state as the temperature increases.

Next, the properties of a multilayered film in which the individual layers are bound by exchange forces will be explained. ‘Exchange Force’ refers to the force that works between adjacent magnetic layers in such a way that the direction of magnetization of TM in one layer is parallel to that of magnetization of TM in the adjacent layer. Take, for example, the case where the magnetization of TM in the fourth layer is directed downward; then, exchange force acts in such a way that TM in the third layer will be magnetized in the same direction (i.e., downward). Needless to say, the magnetization of TM is antiparallel to that of RE in each layer, one may as well say that exchange force acts in such a way as to create parallelism in the magnetization of RE in two adjacent layers.

Moreover, the mechanism of overwriting will now be explained. Wherein, at room temperature, the magnetization of TM is directed upward in each of the four magnetic layers, except that magnetization in the first layer (i.e., or the topmost magnetic layer) is directed either upward or downward depending upon the binary-level information to be recorded. When the information to be recorded is “0” (i.e., if the magnetization of TM in the first top most magnetic layer is to be directed upward), a laser beam having intensity P_{L} is applied to the medium and the temperature of the medium will rise to T_{L}(>T_{c1}). Since T_{L} is higher than the Curie points of the first magnetic layer and the third magnetic layer, their magnetization disappears (called State 1). If the medium is cooled to a temperature below T_{c1}, the magnetization of TM in the first magnetic layer is so oriented by exchange force that it is directed downward, i.e., parallel to the magnetization of TM in the second magnetic layer (called State 2). If cooling proceeds until the temperature is close to room temperature, the first magnetic layer becomes stable and the recording of “0” is completed (called State 3).

Contradictory, when the information to be recorded is “1” (i.e., if the magnetization of TM in the first magnetic and top most layer is to be directed downward), a laser beam having intensity P_{H} is applied to the medium and the temperature of the medium will rise to T_{H}(>T_{c2}). Since T_{H} is higher than the Curie points of the first, second, and third magnetic layers, their magnetization disappears (called State 4). If the medium is cooled to a temperature below T_{c2}, it is magnetized into a downward direction by Hb, or as prior art shows, through magnetization applied externally into a downward direction. At the ‘WRITE’ temperature under consideration, the second magnetic layer is TM dominant, so the magnetization of TM is directed downward as is the overall magnetization (called State 5). In this state, the magnetization of the third magnetic layer having the lowest Curie point has of course disappeared and this blocks the exchange force acting from the fourth magnetic layer to the second magnetic layer. If the third magnetic layer were absent, the exchange force would act from the fourth magnetic layer to the second magnetic layer. This is the force that will render the magnetization of TM in the second magnetic layer to be directed upward in such a way as to impede the action of the bias magnetic field Hb.

Therefore, it is due to the presence of the third magnetic layer that binary-level information can be smoothly written into the second magnetic layer in ‘State 5’ even in a small bias magnetic field Hb. If cooling proceeds further than ‘State 5’ and the temperature becomes lower than T_{c1}, the Curie point of the first magnetic layer, the exchange force acts to orient the magnetization of TM in the first magnetic layer in such a way that it is directed downward in alignment with the magnetization of TM in the second magnetic layer (called State 6).

If, however, the temperature further decreases to become lower than T_{c3}, the Curie point of the third magnetic layer, the exchange force starts to act from the fourth magnetic layer to the third magnetic layer, orienting the magnetization of TM in the third magnetic layer to be directed upward. The exchange force also starts to act from the third magnetic layer to the second magnetic layer, reverting the magnetization of TM in the second magnetic layer to be directed upward (called State 7). In this state, the exchange force also acts from the second magnetic layer to the first magnetic layer. However, the first magnetic layer becomes very stable as room temperature is approached, so that it overcomes the exchange force to retain the present direction of magnetization, whereby the recording of “1” is completed. Moreover, as described above, the recording of “0” or “1” is accomplished by modulating the intensity of a laser light-beam to P_{L} or P_{H}. In other words, direct overwriting is performed by light modulation.

However, as prior art shows, typical magneto-optical recording media have the following various problems. They require a separate source of generating a bias magnetic field in a recording mode and this has increased the complexity of the equipment. This problem has been resolved, as prior art shows, for removable disc media by providing a magneto-optical recording medium that is capable of light-modulated direct overwriting without requiring any separate source of generating a magnetic field.

In addition, as prior art shows, there is a second problem with typical prior art magneto-optical recording media, and that is the exchange force acting between the first and second magnetic layers is strong at a temperature where the magnetization of the first magnetic layer is aligned to the direction of magnetization of sublattices of transition metals in the second magnetic layer whereas it is necessary to reduce the exchange force acting between the first and second magnetic layers in the process of initialization at a temperature near room temperature, and because of this small latitude in adjusting the thickness of the first and second magnetic layers, it has been difficult to achieve consistent production of reliable magneto-optical recording media.

However, this problem has been resolved, as prior art shows, for removable disc media by providing a magneto-optical recording medium that is capable of effectively controlling the exchange force acting between the first and second magnetic layers. The prior art magneto-optical recording media use magnetic layers typically made of ‘TbFeCo’ in consideration of several factors including the exchange force acting between the first and second magnetic layers. For achieving higher-density recording, extensive studies are being made by designers of magneto-optical recording apparatus to shorten the operating wavelength of the optical head (i.e., semiconductor laser) which is used in both recording and reproduction modes.

Typically, magneto-optical recording media, as prior art shows, have a sufficient Kerr magneto-optical effect for satisfactory reproduction output at or near “800” nanometers, which is currently used to operate the optical head but if the operating wavelength is reduced by half to “400” nanometers, the angle of rotation will decrease to less than a half of the value that is achievable at “800” nanometers and no satisfactory reproduction output can be obtained.

However, this problem has been resolved, as prior art shows, for removable disc media by providing a magneto-optical recording medium that is capable of light-intensity modulated direct overwriting, and yet achieves satisfactory reproduction output even at an operating wavelength of “400” nanometers, which is one half the currently employed value.

Moreover, a further problem with the prior art magneto-optical recording media capable of light-modulated direct overwriting is that they require a strong bias magnetic field in order to compensate for the spurious magnetic field originating from the fourth layer. In addition, the magnetization of the fourth magnetic layer is reversed during illumination with P_{H}, thereby making it impossible to perform another overwriting.

However, this problem has also been resolved, as prior art shows, for removable disc media, by providing a magneto-optical recording medium that is capable of direct overwriting in a weak bias magnetic field and which yet is characterized by the greater stability of the fourth magnetic layer under illumination with P_{H}.

In addition, as prior art shows magnetic and magneto-optical data-storage disk drives, particularly, fixed hard disk drives are typically valued because of several factors. Including, the disk drive's overall size (i.e., or what is sometimes referred to as ‘form factor’), data storage capacity, random access times (i.e., or what is sometimes referred to as ‘access time’ or ‘average access time’), cost per data-byte stored, and “Mean Time Before Failure” (MTBF). When data-tracks are arranged as concentric-circles on a circular storage disk-platter, its outermost tracks or concentric track-circles are longer therefore, having greater numbers of magnetic-storage data cell domains available than on a disk-platter's shorter innermost tracks of concentric track-circles. When data-storage disk-platters are rotated at a constant angular velocity the data transducers' head-sliders will fly at a faster and somewhat higher altitude above the beforementioned disk-platters outermost tracks, where relative head to disk velocity is greatest.

However, when data-storage disks are rotated at a constant angular velocity the data transducers' head-sliders will fly at a slower and somewhat lower altitude above the beforementioned disk-platter's innermost tracks, where relative head to disk velocity is at a minimum. One known way to increase data-storage capacity of a fixed disk drive is to divide the data-storage surface into radial data-zones (i.e., sometimes called data-sectors) of concentric and circular data-tracks, and optimize the associated data-transfer rates to the smallest track (i.e., innermost data-track) within each particular radial data-zone (i.e., this is sometimes called zoned data recording).

Moreover, the number of data-sectors or data-fields within each concentric track may vary from data-zone to data-zone. In order to switch from one data-zone to a different data-zone, it is necessary for a hard disk drive to adapt itself in real-time to a different number of data-sectors and a new data-rate for the switched to and different data-zone. Other known ways to increase data storage capacity, include a varying of disk rotation in function of the radial position of an optical-data transducer-head, while maintaining a data-transfer frequency-rate that is substantially constant, as in optical “Compact Disk” (CD) technologies, or varying a data-transfer frequency-rate with each data-track in function of the radial position of a magnetic-data transducer-head, while maintaining a disk-rotation as substantially constant, as in conventional magnetic, and non-conventional magneto-optical flying-head technologies.

Furthermore, another issue confronting the designer of a hard disk drive system is data-head positioning, and data-block transfer-rates. Typically, hard disk drive head positioning is carried out with a ‘Head Positioner’ or ‘Rotary Voice-Coil Actuator’, and normally involves track seeking operations for moving a hard disk drive's ‘Head-Stack’ assembly from a departure data-track to a different destination data-track. This is done throughout the radial-extents of a disk-platter's data-surface storage area, while using various data-track following operations for causing a hard disk drive's head-stack to follow precisely one particular data-track, during data-block read-data or data-block write-data disk-operations. Therefore, to provide precise head-stack positioning, during a data-track seeking and following operation, some servo information must be provided to a Rotary Voice-Coil Actuator's tracking mechanism.

Furthermore, this servo information may be contained on a special data-surface written exclusively with servo-information (i.e., sometimes called a ‘dedicated servo surface’), or may be externally supplied by an ‘Optical Encoder’ coupled to a head-stack assembly's positioning arm, or may be supplied from servo-information interspersed and embedded among the data-fields within each circular concentric data-track. In addition, one other approach not mentioned before is provided by the ‘Open Loop Stepper-Motor’ head-stack positioning servo technique; wherein, the positional stability of a data-head at any selected data-track location is provided by the electromagnetic detents of a hard disk drive's Stepper-Motor.

Consequently, when servo-information is embedded on a data-surface formatted for ‘Zoned-Data-Recording’, several complications may arise in the reliably of providing robust servo-head positioning information. Therefore, there must be sufficient embedded information to provide stability to the ‘Servo-Loop’ and to provide positional responses during the high-speed portions of track-seeking and track-following operations, so that velocity or position profiles may be adjusted on the fly, based on present head-velocity or head-position at the time of servo-sampling. Typically, if the servo-information is recorded at the same data-rate while in positional relationship with the recorded data-blocks, as has been conventionally employed in prior art, servo-architecture is normally complex enough to switch data-rates and servo-positions.

However, if regularly spaced servo-information were radially placed across data-storage disk-platter data-surfaces, while splitting some of the data-fields, located on the aforementioned data-surfaces, into segments, data-zones, when crossed-over, could cause serious complications to arise when trying to read each ‘Split Data Field’ as a single data-block.

Furthermore, the beforementioned disk-platter's rotational velocity must be constantly monitored and carefully maintained at a predetermined constant angular velocity for the aforesaid ‘Split Data Field’ scheme to function properly; therefore, adding additional complexity to the servo-tracking system. In addition, data-fields are conventionally managed by what is normally called a ‘Data Sequencer’; wherein, a Disk Controller's Data Sequencer may include an ‘Encoder and Decoder’ unit, which is used to transform “Non-Return to Zero” (NRZ) data-streams, into other, more manageable, data-formats.

For example, as in, a three-to-two 1,7 “Run Length-Limited” (RLL) code; moreover, used to achieve a compression of data relative to the ‘Flux-Transition Density’ on a disk-platter's data-surface (i.e., 1,7 RLL coding is based upon three code-bits or groups for two non-encoded data-bits, but results in a four-to-three overall data compression rate permitting more data to be recorded on a disk-platter's data-surface, per the number of flux-transitions that may be contained within a disk-platter's magnetic domain-cells).

Furthermore, a Disk Controller's Data Sequencer conventionally performs the task of decoding ‘Data Sector Overhead’ information in order to locate a desired data-sector storage location, and to obtain information relating to the correctness or validity of the data being read back from a particular data-sector storage location. A Data Sequencer is implemented as a state-machine that will conventionally monitor all incoming data-flow in order to locate a particular data-ID ‘Preamble-Field’, a particular data-ID ‘Address Mark’, a particular data-ID ‘Sector-Field’, a particular data-ID ‘Data-Field’, and a small number of ‘Error Correction Syndrome’ bytes appended to the end of said data-ID ‘Data-Field’.

Moreover, the aforementioned Data Sequencer will cause the appropriate action to be taken as each of the aforementioned fields are identified and located. For example, if a data-block contained within a ‘Data-Field’ of a particular cylinder/track's data-sector location being sought after, the aforementioned Data Sequencer will compare incoming data-ID ‘Sector-Field’ information with the sought after data-sector information stored in a particular register.

Moreover, when a positive comparison occurs a Disk Controller's Data Sequencer will cause the data-block read from the data-ID Data-Field, via a magnetic-transducer data-head and hard disk drive read-channel; moreover, to be sent to a Buffer Controller's “block buffer memory” location; wherein, its ‘Error Correction Syndrome’ remainder-bytes are checked, and if there are no detected errors within the read data-block, as determined by analyzing the “Error Correction Code” (ECC) remainder-bytes, the data-block is sent from the Buffer Controller's block buffer memory location to the host-system computer through a suitable interface, such as the “Small Computer System Interface” (SCSI), or the “Integrated Drive Electronics/AT Attachment” (IDE/ATA-2) interface.

Moreover, in conventional magnetic and non-conventional magneto-optical hard disk drive designs, each data-sector is individually handled in response to a specific-input from a supervisory microcontroller. Furthermore, as a particular data-sector is read, the aforementioned supervisory microcontroller will inform a Disk Controller's Data Sequencer, whether to read, or not to read, the next contiguous data-sector into a Disk Controller's buffer cache memory; moreover, causing a supervisory microcontroller's intervention to occur for every data-sector being processed.

Typically, this is done with a programmable ‘Sector Counter’, which is preset by a supervisory microcontroller to a desired sector count; wherein, a Data Sequencer can process data-sectors sequentially until the count in the aforementioned ‘Sector Counter’ is reached. However, some hard disk drive designs do not use, or normally include within their designs, the complication of Zoned Data-Recording and Split Data-Fields. Therefore, head-stack positioner stability in some hard disk drive designs is provided by an ‘Optical Encoder’; coupled between a rotary head-stack positioner and its drive-base, which foregoes the use of ‘Embedded Servo-Sectors’, as is conventional within some prior art.

Furthermore, while split-data recording schemes have been proposed in prior art, recent proposals have appointed the supervisory microcontroller with the responsibility of managing each Split Data-Field layout in “real-time”. However, this leads to a tremendous level of bus-traffic control between a supervisory microcontroller and a Disk Controller's Data Sequencer, during a hard disk drive's read-data or write-data disk-operations.

Therefore, precluding the aforementioned supervisory microcontroller from performing other useful tasks, such as head-positioning servo-supervision, error-correction, and command-status exchanges with the host computer system, which are communicated over a hard disk drive's interfacing bus-structure. Furthermore, to function effectively the beforementioned supervisory microcontroller approach would require a separate supervisory microcontroller for data-transference; meaning that at least two supervisory microprocessors would be required to implement a hard disk drive's command architecture and overall disk-operation.

### SUMMARY OF THE INVENTION

In accordance with the present invention, a LIMDOW magneto-optical disc apparatus that uses a magneto-optical disc media that includes a magneto-optical recording medium having at least two kinds of coercive forces at room temperature. A second magneto-optical disc apparatus uses a magneto-optical disc including a magneto-optical recording medium configured by at least two magnetic layers respectively having magnetic exchange interaction.

Moreover, in both of the first and second magneto-optical apparatus of this invention, a magneto-optical hard disk drive uses stationary LIMDOW or MSR Magneto-Optical Microhead Array Chips instead of conventional Flying-Head technologies, like Rotary Voice-Coil Actuators or Rotary Positioners to execute track seeking operations throughout the radial-extent of the disk-platter data-surfaces of LIMDOW and MSR Magneto-Optical Microhead Array Chip Hard Disk Drive s, which is accomplished by using an electronically controlled data-track switching operation that causes an optical microhead located above one particular data-track location to switch off, while at the same time, another optical microhead located above a different data-track location is simultaneously switched on.

Moreover, a compact permanent magnet is used in one embodiment of this present invention as the magnetic field generator; therefore, a magnetic field having a sufficient intensity can be obtained. Furthermore, an area of the permanent magnet facing the surface of the magneto-optical disc media can be made to several millimeters wide, while having a length that extends the whole length of a Magneto-Optical Microhead Array Chip. Therefore, a permanent magnet initializing magnetic field generator can be provided in a compact magneto-optical disc apparatus using a “3.5” inch type of magneto-optical disc media. Consequently, the magneto-optical disc apparatus and circuitry of this present invention can be downsized. In the above-mentioned first magneto-optical disc apparatus, it is preferable that the intensity of the magnetic field generated by the magnetic field generator is larger than at least one coercive force (i.e., for example, Hc1) of the magneto-optical recording medium and smaller than at least one of the remained coercive forces (i.e., for example, Hc2) of the magneto-optical recording medium.

In addition, a second embodiment of the present invention's magneto-optical disc apparatus is to preferably have a magnetic field generator that comprises a first magnetic field generating portion including a permanent magnet and a second magnetic field generating portion including a coiled electromagnet, where the first magnetic field generating portion is disposed in a manner so as to apply a magnetic field at a position to the laser light-beam spot incident upon the magneto-optical disc media, and the second magnetic field generating portion being disposed at a position in a manner so as to apply a magnetic field at the position of the laser light-beam spot, which is incident upon the magneto-optical disc media. By such a configuration, when the polarity of the magnetic field generated by the electromagnet is changed alternatively, the electromagnet can be used not only for recording the data on the magneto-optical recording medium, but can also be used for reproducing data previously recorded on the magneto-optical disc media.

Furthermore, the previously described electromagnet and permanent magnet are stationary and therefore are non-moving stationary field generators positioned above the magneto-optical disc media, so that the apparatus of the present invention can be downsized and electric power consumption can be reduced in comparison with that of a conventional magneto-optical data-storage apparatus.

Objects and Advantages

Furthermore, each LIMDOW and MSR Magneto-Optical Microhead Array Chip Hard Disk Drive will consist of at least, but not confined too, one disk-platter having two data-surfaces; wherein, the aforesaid data-surface will contain a multiplicity of concentric data-tracks that are rotated at a substantially constant angular velocity.

In addition, each LIMDOW or MSR Magneto-Optical Microhead Array Chip is placed into a stationary position above each disk-platter data-surface by a chip-positioning circuit board. Wherein, the number of cylinder/tracks available to each stationary LIMDOW or MSR Magneto-Optical Microhead Array Chip is determined by the number of diode laser emitters, diode laser, (VCSEL) “Vertical Cavity Surface Emitting Laser” microheads contained within a LIMDOW or MSR Magneto-Optical Microhead Array Chip's microhead array (e.g., “325,000” vertical cavity surface emitting laser microheads would physically equal “325,000” corresponding cylinder/tracks).

Moreover, each LIMDOW or MSR Magneto-Optical Microhead Array Chip will contain, a diode laser emitter array, a diode laser array, or VCSEL microhead array (e.g., an array containing a minimum of one thousand or a maximum of four billion individually addressable diode laser emitters, diode lasers, or VCSEL microheads, which are individually used as light sources during a read-data or write-data disk-operation), a microhead “Address Latch And Chip Select Circuit”, a microhead “Address Decoder Circuit”, a microhead “Address Buffer Circuit”, a “diode laser or VCSEL Microhead Power Control Circuit”, a “Read Preamp Circuit”, a “Read Decision Circuit”, a “Read Buffer Circuit”, a “Write Driver Circuit”, a “Write Preamp Circuit”, a “R/W Control Circuit”, two forward or reversed biased “Semiconductor Photo-Conductor” linear positioned light sensing “Cadmium-Sulfide” photocell-array of read-elements, or as in an optional embodiment, two reversed-biased “Semiconductor Silicon Photo-Diode” photocell-array read-elements (e.g., providing a optical read-data reference signal-voltage output and an optical read-data read signal-voltage output during read-data disk-operations).

Furthermore, the previously mentioned LIMDOW or MSR Magneto-Optical Microhead Array Chip will have its various photonic and electronic semiconductor components constructed from a single semiconductor wafer using conventional semiconductor manufacturing methods like “Molecular Beam Epitaxy” (MBE), photolithography, and chemically etching. In addition, if the beforementioned LIMDOW or MSR Magneto-Optical Microhead Array Chip contain a microhead array of three hundred and twenty-five thousand individual diode laser or VCSEL microheads; each microhead within said microhead array would have a 200-nm diameter (i.e., “200” nanometers). Wherein, the previously mentioned LIMDOW or MSR Magneto-Optical Microhead Array Chip would measure “2.358” inches in length.

Furthermore, if a “2.358” inch LIMDOW or MSR Magneto-Optical Microhead Array Chip were used in a LIMDOW and MSR LIMDOW or MSR Magneto-Optical Microhead Array Chip Hard Disk Drive, the beforementioned hard disk drive's form-factor would be a standard “3.5” inches. Wherein, every LIMDOW or MSR Magneto-Optical Microhead Array Chip that is installed into a hard disk drive's unit-assembly is assembled into one stationary fixed position.

Moreover, one LIMDOW or MSR Magneto-Optical Microhead Array Chip is to be positioned approximately fifty microns above and perpendicular to every disk-platter's data-surface used in a hard disk drive's unit-assembly. Furthermore, in one embodiment of the present invention, every diode laser or VCSEL microhead contained within a microhead array would have an emitter-centerline to emitter-centerline dimension of “300” nanometers, where each diode laser or VCSEL microhead emitter's top-surface would have an elliptical dimension of “200”×“210” nanometers. Furthermore, in one embodiment of the present invention, these diode laser or VCSEL dimensions would be atypical for any LIMDOW or MSR Magneto-Optical Microhead Array Chip installed into a LIMDOW and MSR Magneto-Optical Microhead Array Chip Hard Disk Drive's unit-assembly.

In addition, the use of standard semiconductor lithography, etching, and masking techniques are used to manufacture a LIMDOW or MSR Magneto-Optical Microhead Array Chip's two (SPD) “Semiconductor Photo-Diode” photocell array circuits, microhead-address latch-decoder circuits, chip-selection chip-control circuits, data I/O circuits, pre-amplification circuits, data encoding/decoding circuits, and digital-signal processing circuits, along with a LIMDOW or MSR Magneto-Optical Microhead Array Chip's address, data, and control-bus circuits. In addition, the diode laser or VCSEL microhead arrays contained within the Previously Mentioned LIMDOW or MSR Magneto-Optical Microhead Array Chips are created using MBE, or “Metal-Organic Vapor-Phase Epitaxy” (MOVPE), which are two well-known manufacturing methods used to manufacture integrated electro-optical components.

As demonstrated, within the well-known prior art, conventional flying-head assemblies (i.e., what are sometimes called “head stack assemblies”) are simultaneously moved, as a group, to or from cylinder/track locations during a host-requested read-data or write-data disk-operation. As defined, data-tracks are closed concentric circles of sectored digital-data, which begin at the center of a disk-platter's data-surface and radiate out away from that center, one concentric circle after another, toward a hard disk drive disk-platter's outer-most circumference. Moreover, conventional prior art technologies use a Rotary Voice-Coil Actuator or (i.e., what is sometimes called a “Rotary Positioner”) to accomplish track-to-track head-stack movements (i.e., the movement of a head-stack across a hard disk drive disk-platter's data surface from one concentric circle of sectored data to another).

However, during host-requested LIMDOW and MSR Magneto-Optical Microhead Array Chip Hard Disk Drive's disk-operations mechanical movements of the beforementioned LIMDOW or MSR Magneto-Optical Microhead Array Chips' diode laser or diode laser or VCSEL microheads, from one concentric cylinder/track to another, is unnecessary. Moreover, the beforementioned LIMDOW or MSR Magneto-Optical Microhead Array Chips, while containing a multitude of stationary diode laser or diode laser or VCSEL microheads, would already have, ready for use, one of its stationary diode laser or VCSEL microheads positioned at a host-requested cylinder/track location. Therefore, unlike conventional electromechanical Rotary Voice-Coil head switching and head-stack positioning, the LIMDOW or MSR Magneto-Optical Microhead Array Chips electronically switch off one diode laser or VCSEL microhead, while simultaneously switching on another.

Furthermore, a LIMDOW and MSR Magneto-Optical Microhead Array Chip Hard Disk Drive's cylinder and data-tracks and the beforementioned diode laser or VCSEL microheads positioned above them, have the same address numbers and locations. For example, during a host-requested disk-operation a LIMDOW and MSR Magneto-Optical Microhead Array Chip Hard Disk Drive's Disk Controller will address a single stationary diode laser or VCSEL microhead contained within a chip-selected LIMDOW or MSR Magneto-Optical Microhead Array Chip's microhead array; wherein, the aforesaid Disk Controller also selects a cylinder and data-track location which is directly underneath the selected microhead's fixed stationary position.

Therefore, a cylinder and data-track location and the beforementioned diode laser or VCSEL microhead positioned above it, consequently has the same address number and location. Furthermore, during a read-data or write-data disk-operation, a LIMDOW and MSR Magneto-Optical Microhead Array Chip Hard Disk Drive's Disk Controller will receive from a host computer, a request, to either read or write data at a particular disk-platter's data-surface that contains a particular data-sector location. Moreover, this host request would therefore contain:

(i) A data-head selection number (e.g., data-head number five, but sent as a binary code signal, like 00000101), which is translated and used by the aforesaid Disk Controller to select one particular stationary LIMDOW or MSR Magneto-Optical Microhead Array Chip located above a corresponding disk-platter's data-surface;

(ii) A cylinder and data-track number (e.g., cylinder and data-track number fifty-four, but sent as a binary code signal, like 00110110), which is translated and used by the aforesaid Disk Controller to locate and select one particular diode laser or VCSEL microhead which is located above the cylinder data-track location having the same address number, being a cylinder data-track location that contains the system requested data-sector data or data-sector data-area;

(iii) A data-sector number (e.g., data-sector number twelve, but sent as a binary code signal, like 00001100), which is also translated and used during a read-data or write-data disk-operation by the beforementioned Disk Controller to activate the selected diode laser or VCSEL microhead located above the host requested cylinder data-track location at a time when the host-requested data-sectors containing the host requested data are rotated into a position directly underneath an address selected diode laser or VCSEL microhead, where the read-data or write-data disk-operation will occur. *Note: “0”'s=low electrical signals, while “1”'s=high electrical signals.

Furthermore, a Disk Controller that is used in LIMDOW and MSR Magneto-Optical Microhead Array Chip Hard Disk Drives will forward all system supplied microhead location address numbers to a Disk Controller's PCB located “Asynchronous Optical Microhead Address Controller” for translation. Wherein, newly translated microhead location address numbers are to be forwarded through an Asynchronous Optical Microhead Address Controller's (MAB) “Microhead Address Bus” as thirty-two low and/or high binary-signals using a shared 32-bit microhead address bus line to chip-selected LIMDOW or MSR Magneto-Optical Microhead Array Chips. Therein, chip-selected LIMDOW or MSR Magneto-Optical Microhead Array Chips will respond to these bus supplied binary-signals by first latching the aforesaid thirty-two low and/or high binary-signals into its internally located “Address Latch And CSC” circuit, wherein decoding of the thirty-two low and/or high binary-signals can proceed.

Furthermore, the decoding of a diode laser or VCSEL microhead's location address number will cause a single selection line leading to the diode laser or VCSEL microhead to change from a logic-low voltage-signal to a logic-high voltage-signal, which will select the diode laser or VCSEL microhead, by giving it access to the (WLV) “Write Laser Voltage” or (RLV) “Read Laser Voltage” bus-line bus-signals, which are in turn used to activate the selected diode laser or VCSEL microhead's laser-emissions.

Consequently, a selected diode laser or VCSEL microhead will have the same physical-location and address-number as a host-requested cylinder data-track location containing a host requested data-sector(s) containing the host requested data to be read during a read-data disk-operation, or a host requested data-sector(s) containing host requested data-area(s) to be written to during a write-data disk-operation. Consequently, its only after the selection of a stationary diode laser or VCSEL microhead, which is located over a host requested cylinder data-track location, has been successfully accomplished, can the host-requested read-data or write-data disk-operation be executed.

Furthermore, because LIMDOW or MSR Magneto-Optical Microhead Array Chips are fully-integrated semiconductor devices the LIMDOW or MSR Magneto-Optical Microhead Array Chips can successfully accomplish 50-ns (i.e., 50 nanosecond) “track-to-track” switching times (i.e., what is sometimes called in conventional hard disk drive design “average seek time”). In addition, to increase user data storage capacity LIMDOW and MSR Magneto-Optical Microhead Array Chip Hard Disk Drive s will use an “ID-less” system for sector-locating and tracking.

Moreover, an ID-less system of sector locating and tracking has several advantages over the conventional “ID After Wedge” or “ID Before Sector” methods of sector locating and tracking. For example, the lack of an ID or “Identifier Field”, which are conventionally written to hard disk drive disk-platter data-surfaces, will regain approximately 4% of the beforementioned disk-platter data-surface's real estate for end-user data-storage. Furthermore, during a read-data or a write-data disk-operation and in case of errors a “Sector-ID” is neither read nor corrected increasing the overall data throughput for the hard disk drive.

Accordingly, besides the objects and advantages of the LIMDOW and MSR Magneto-Optical Microhead Array Chip Hard Disk Drive, which is described in my patent above, several objects and advantages of the present invention are:

(a) To provide a LIMDOW and MSR Magneto-Optical Microhead Array Chip Hard Disk Drive that overcomes several limitations and drawbacks present in the prior art previously disclose;

(b) To provide a LIMDOW and MSR Magneto-Optical Microhead Array Chip Hard Disk Drive that uses a dedicated head-to-track system. Wherein, each installed LIMDOW or MSR Magneto-Optical Microhead Array Chip can have a minimum of one-thousand or maximum of four-billion stationary, individual, and addressable read and write diode laser or VCSELs constructed into each LIMDOW or MSR Magneto-Optical Microhead Array Chip's microhead array;

(c) To provide a LIMDOW and MSR Magneto-Optical Microhead Array Chip Hard Disk Drive with “average access times” (i.e., typically the amount of time it takes to find requested data by moving head-stack assemblies from one data-track location to another data-track location as described in the prior art) that are about “50” nanoseconds in duration;

(d) To provide a LIMDOW and MSR Magneto-Optical Microhead Array Chip Hard Disk Drive that is during a hard disk drive crash non-destruction to previously recorded data, thus allowing full recovery of all previously recorded data, therein eliminating any catastrophic data loss;

(e) To provide a LIMDOW and MSR Magneto-Optical Microhead Array Chip Hard Disk Drive, which because of its simultaneous and independent control over each microhead array chip installed above each disk-platter data-surface, can provide greatly reduced rotational-latencies for a hard disk drive.

(f) To provide a LIMDOW and MSR Magneto-Optical Microhead Array Chip Hard Disk Drive capable of simultaneously using in parallel a multitude of data heads for each installed disk-platter data-surface.

Further objects and advantages are provided by the stationary LIMDOW or MSR Magneto-Optical Microhead Array Chips when they are used in place of Head Sliders, Air-Bearings, and Rotary Voice-Coil Actuators (i.e., sometimes called “Rotary Positioners”), and the other conventional flying-head technologies presently used in conventional hard disk drive designs.

Moreover, a LIMDOW and MSR Magneto-Optical Microhead Array Chip Hard Disk Drive is primarily a dedicated diode laser or VCSEL microhead to data-track information and data-storage non-volatile memory system. Wherein, each LIMDOW or MSR Magneto-Optical Microhead Array Chip will have a minimum of one thousand or a maximum of four billion stationary, individual, and addressable read/write diode laser or VCSEL microheads constructed into every LIMDOW or MSR Magneto-Optical Microhead Array Chip's microhead array.

Furthermore, data-track access times (i.e., what is normally called average-seek-times) or the amount of time it takes to address and find one host requested data-track location from a data-track location previously requested. This is done conventionally, as prior art shows, by moving a hard disk drive's head-stack assembly from one data-track location to another, and is a principle benchmark used in rating the performance of a hard disk drive and its system of data-access. If the “average seek time” as described above were decreased in any way for any particular hard disk drive design, it would demonstrate a marked improvement for that particular hard disk drive's design.

Typically, conventional flying-head hard disk drive designs have their “average-access-times” normally measured in “milliseconds” or thousandths of a second. If using milliseconds as a unit of measure, an “average-seek-time” of “8.5” milliseconds is today to be considered normal for conventional flying-head hard disk drive designs. However, a hard disk drive that is based upon the LIMDOW and MSR Magneto-Optical Microhead Array Chip Hard Disk Drive design, because it has LIMDOW or MSR Magneto-Optical Microhead Array Chips positioned over every disk-platter data-surface located within its unit-assembly that contain diode laser or VCSEL microhead array's comprising thousands of individual microheads located into a stationary position over every concentric data-track circle located on every disk-platter data-surface, its “average seek times” are thousands of times shorter than conventional hard disk drive designs.

Consequently, the “average-seek-time” bench-mark ratings for any flying-head (i.e., Magneto-Optical or conventional magnetic) hard disk drive design would be easily challenged by any hard disk drive design using the LIMDOW or MSR Magneto-Optical Microhead Array Chip approach to its hard disk drive design. This is simply because, unlike the slow mechanical track-to-track switching used by conventional “Rotary Positioned” flying-head technologies, the high speed data-track switching from one data-track location to another occurs, for a LIMDOW and MSR Magneto-Optical Microhead Array Chip Hard Disk Drive design, electronically, inside the drive's LIMDOW or MSR Magneto-Optical Microhead Array Chips. Therefore, instead of using “milliseconds” or thousandths of one second to measure “average-seek-time” time periods, “nanoseconds” or billionths of one second, are instead, used to measure the high speed “average-seek-time” and “full-stroke seek-time” time periods that will occur within a LIMDOW and MSR Magneto-Optical Microhead Array Chip Hard Disk Drive.

Furthermore, by using semiconductor-based transmission-gates to execute selection processes and data-head switching for any particular diode laser or VCSEL microhead present within a microhead array, new high-speed “average-seek-time” benchmark ratings have been made possible. Typically, semiconductor transmission-gates have their operational-speeds measured in nanoseconds (i.e., typically a single MOSFET or MESFET transmission-gate can change its electrical state at around 5.0 nanoseconds). Therefore, a LIMDOW or MSR Magneto-Optical Microhead Array Chip's “average-seek-times”, “track-to-track average-seeks”, or “full stroke seek times”, are in reality, the amount of time it takes to electronically switch-off a previously used selection line and to electronically switch-on a new selection line that leads to a particular diode laser or VCSEL microhead that is located in a stationary position over a host-requested cylinder data-track location.

Furthermore, by calculating the amount of time it takes for a chip-selected LIMDOW or MSR Magneto-Optical Microhead Array Chip's “Asynchronous Optical Microhead Address Controller” to receive a new thirty-two bit microhead-location-address signal from a LIMDOW and MSR Magneto-Optical Microhead Array Chip Hard Disk Drive's Disk Controller, adding in the time it takes for a single microhead selection line to become high-enabled, an “average-seek-time” of around 50-ns (i.e., 50 nanoseconds) can be determined. For example, if using CMOS transmission-gates, this new “average-seek-time” is calculated to be about two thousand times faster than the “average-seek-times” or “full-stroke seek-times” for any flying-head hard disk drive design in existence today. Consequently, this demonstrates,.over prior art, an incredible increase in the “average-seek-time” performance ratings for the LIMDOW and MSR Magneto-Optical Microhead Array Chip Hard Disk Drive design.

Furthermore, the LIMDOW and MSR Magneto-Optical Microhead Array Chip Hard Disk Drive design will also improve the (MTBF) “Mean Time Before Failure” or useful-life benchmark rating that is normally used by hard disk drive designers to predicate a particular hard disk drive design's usefulness before it has a failure. This, improvement in the (MTBF) “Mean Time Before Failure”, or useful-life benchmark rating is accomplished, by eliminating, from the LIMDOW and MSR Magneto-Optical Microhead Array Chip Hard Disk Drive design, the head-stack and rotary voice-coil assemblies normally used in today's conventional flying-head hard disk drive designs.

Furthermore, about 60% of all conventional flying-head hard disk drive fatal-error crashes (i.e., sometimes called a catastrophic hard disk failure) are catastrophic and are typically the result of Rotary Voice-Coil and/or Spindle-Motor mechanical malfunctions or failures. When examining this problem further, we find that flying-heads, in striving to maintain today's critical flying-height distance of “0.5” to “2.5” microns above disk-platter data-surfaces on what is sometimes called an “air-bearing”, the beforementioned flying-heads can be caused to easily make physical contact with data-surfaces, for example during a catastrophic hard disk fatal-error or crash, which will always result in data loss (i.e., sometimes called a catastrophic data loss). The production, as prior art shows, of an air bearing is accomplished through the use and aerodynamic design of flying-head head-sliders. In fact, within a conventional rotary positioned flying-head hard disk drive design, a head-slider's flight distance, which is today normally “0.5” to “2.5” microns, would be difficult, if not impossible to achieve, were it not for the aerodynamic design of conventional flying-head head-sliders and the air-bearings that they produce.

Furthermore, fatal-error hard disk drive crashes most often occur when a Spindle-Motor's power supply fails, or the hard disk drive, during a read-data or write-data disk-operation, is suddenly shaken or dropped, while the hard disk drive's head-stack assembly has not been properly repositioned into an innermost disk-platter area (i.e., sometimes called the head-stack parking area), but remains located over a data-surface when any of the malfunctions mentioned occurs. Consequently, during a power-supply failure a hard disk drive's Spindle-Motor will lose its momentum and begin to spin down; wherein, the head-slider air-bearings will begin to decay, and no longer maintain necessary aerodynamic lift for the beforementioned head-sliders.

Therefore, a conventional flying-head hard disk drive's head-stack assembly, not being repositioned into said head-stack parking area, and being subject too complete loss of head-slider air-bearings, the beforementioned hard disk drive flying-heads will make physical contact with the beforementioned disk-platter data-surfaces; ultimately, crashing into the data-sector areas located on the aforesaid hard disk drive's data-surfaces; moreover, destroying any previously recorded data therein. Typically, this kind of failure is normally referred to as “hard disk crash” or “hard disk fatal-error crash” and accounts for about 60% of all conventional flying-head hard disk drive failures.

Furthermore, the root-cause behind many hard disk drive failures is a Disk Controller's failed BIOS system or BIOS system-chip, or a Spindle-Motor's power-supply malfunctioning. Nevertheless, whatever the root-cause might be, the end-result is always the same, hard disk drive crashes and severe data-loss. In the event a LIMDOW and MSR Magneto-Optical Microhead Array Chip Hard Disk Drive should suffer a hard disk fatal-error crash, the severe data-loss that is normally associated with these hard disk drive fatal-error crashes, because of a LIMDOW and MSR Magneto-Optical Microhead Array Chip Hard Disk Drive's stationary microhead design, will not ever occur.

Although, a LIMDOW and MSR Magneto-Optical Microhead Array Chip Hard Disk Drive's Spindle-Motor should fail or if there is some kind of Disk Controller (BIOS) “Basic-In-Out System” system-chip failure, the LIMDOW or MSR Magneto-Optical Microhead Array Chips, which contain the diode laser or VCSEL microhead arrays are stationary; positioned by chip-positioning circuit boards about “50” microns above the hard disk drive disk-platter data-surfaces.

Therefore, unless a LIMDOW or MSR Magneto-Optical Microhead Array Chip fails or malfunctions the LIMDOW or MSR Magneto-Optical Microhead Array Chips are never moved, or repositioned in any way, once installed into a LIMDOW and MSR Magneto-Optical Microhead Array Chip Hard Disk Drive unit-assembly. Consequently, by using the stationary LIMDOW or MSR Magneto-Optical Microhead Array Chip approach to hard disk drive design, we have eliminated the need for any head-sliders, air-bearings, and rotary voice coils along with their potential for hard disk drive fatal-error crashes. Ultimately, this will double the MTBF benchmark rating for any hard disk drive design that uses the LIMDOW and MSR Magneto-Optical Microhead Array Chip Hard Disk Drive design approach.

### DRAWING FIGURES

In the drawings, closely related figures have the same number but different alphabetic suffixes:

FIG. 1 shows an orthographic plan-view of a LIMDOW and MSR Magneto-Optical Microhead Array Chip Hard Disk Drive unit-assembly, shown with the hard disk drive cover and sealing gasket removed and configured with a shared Microhead Array Chip bus system.

FIG. 2 shows an orthographic side-view of a LIMDOW and MSR Magneto-Optical Microhead Array Chip Hard Disk Drive unit-assembly, shown with the hard disk drive cover and sealing gasket removed and configured with a shared Microhead Array Chip bus system, displaying section 2-2.

FIG. 3 shows an orthographic front-view of a LIMDOW and MSR Magneto-Optical Microhead Array Chip Hard Disk Drive unit-assembly, shown with the hard disk drive cover and sealing gasket removed and configured with a shared Microhead Array Chip bus system, displaying section 3-3.

FIG. 4 shows an orthographic plan-view of an ATA-2 IDE Disk Controller PCB for a LIMDOW and MSR Magneto-Optical Microhead Array Chip Hard Disk Drive design.

FIG. 5 shows an orthographic plan-view of a SCSI Disk Controller PCB for a LIMDOW and MSR Magneto-Optical Microhead Array Chip Hard Disk Drive design.

FIG. 6 shows an orthographic plan-view of the chip-positioning circuit board and surface mounting chip-socket for the LIMDOW or MSR Magneto-Optical Microhead Array Chip.

FIG. 7 shows an orthographic plan-view of the Bottom Data Surface LIMDOW or MSR Magneto-Optical Microhead Array Chip.

FIG. 8 shows an orthographic plan-view of the Top Data Surface LIMDOW or MSR Magneto-Optical Microhead Array Chip.

FIG. 9 is an orthographic front-view drawing of a combination Top and Bottom chip-positioning circuit board, which is shown with the LIMDOW or MSR Magneto-Optical Microhead Array Chips installed into their surface-mounted chip-sockets.

FIG. 10 is an orthographic side-view drawing of a combination Top and Bottom chip-positioning circuit board, which is shown with the LIMDOW or MSR Magneto-Optical Microhead Array Chips installed into their surface-mounted chip-sockets.

FIG. 11 is an orthographic plan-view drawing of a LIMDOW or MSR Magneto-Optical Microhead Array Chip, shown installed into a surface-mounted chip-socket that displays pin locations, number assignments, and logic-function labels for the Bottom Data-Surface LIMDOW or MSR Magneto-Optical Microhead Array Chips.

FIG. 12 is an orthographic plan-view drawing of a LIMDOW or MSR Magneto-Optical Microhead Array Chips own installed into a surface-mounted chip-socket that displays pin locations, number assignments, and logic-function labels for the Top Data-Surface LIMDOW or MSR Magneto-Optical Microhead Array Chips.

FIG. 13 is a logic-signal flow schematic for the Bottom Data-Surface LIMDOW or MSR Magneto-Optical Microhead Array Chips, displaying signal direction, pin assignments, and function labels.

FIG. 14 is a logic-signal flow schematic for the Top Data-Surface LIMDOW or MSR Magneto-Optical Microhead Array Chips, displaying signal direction, pin assignments, and pin function labels.

FIG. 15 is a plan-view drawing of a Polymer flex bus-cable for the chip-positioning circuit boards' right side connector used in the LIMDOW or MSR Magneto-Optical Microhead Array Chip design, displaying data-bus, future-bus, and control-bus pin assignments.

FIG. 16 is a plan-view drawing of a Polymer flex bus-cable for the chip-positioning circuit boards' left side connector used in the LIMDOW or MSR Magneto-Optical Microhead Array Chip design, displaying the “32” bit address-bus pin assignments.

FIG. 17 is a plan-view drawing of a chip-positioning circuit board that displays a (RD) “Redirection” of the (-CS) “Chip Select” line for a LIMDOW or MSR Magneto-Optical Microhead Array Chip Number-1, which is positioned for disk-platter one's bottom-side; also called disk-platter one's data-surface side-one.

FIG. 18 is a plan-view drawing of a chip-positioning circuit board that displays a (RD) “Redirection” of the (-CS) “Chip Select” line for a LIMDOW or MSR Magneto-Optical Microhead Array Chip Number-2, which is positioned for disk-platter one's top-side; also called disk-platter one's data-surface side-two.

FIG. 19 is a plan-view drawing of a chip-positioning circuit board that displays a (RD) “Redirection” of the (-CS) “Chip Select” line for a LIMDOW or MSR Magneto-Optical Microhead Array Chip Number-3, which is positioned for disk-platter two's bottom-side; also called disk-platter two's data-surface side-one.

FIG. 20 is a plan-view drawing of a chip-positioning circuit board that displays a (RD) “Redirection” of the (-CS) “Chip Select” line for a LIMDOW or MSR Magneto-Optical Microhead Array Chip Number-4, which is positioned for disk-platter two's top-side; also called disk-platter two's data-surface side-two.

FIG. 21 is a plan-view drawing of a chip-positioning circuit board that displays a (RD) “Redirection” of the (-CS) “Chip Select” line for a LIMDOW or MSR Magneto-Optical Microhead Array Chip Number-5, which is positioned for disk-platter three's bottom-side; also called disk-platter three's data-surface side-one.

FIG. 22 is a plan-view drawing of a chip-positioning circuit board that displays a (RD) “Redirection” of the (-CS) “Chip Select” line for a LIMDOW or MSR Magneto-Optical Microhead Array Chip Number-6, which is positioned for disk-platter three's top-side; also called disk-platter three's data-surface side-two.

FIG. 23 is a plan-view drawing of a chip-positioning circuit board that displays a (RD) “Redirection” of the (-CS) “Chip Select” line for a LIMDOW or MSR Magneto-Optical Microhead Array Chip Number-7, which is positioned for disk-platter four's bottom-side; also called disk-platter four's data-surface side-one.

FIG. 24 is a plan-view drawing of a chip-positioning circuit board that displays a (RD) “Redirection” of the (-CS) “Chip Select” line for a LIMDOW or MSR Magneto-Optical Microhead Array Chip Number-8, which is positioned for disk-platter four's top-side; also called disk-platter four's data-surface side-two.

FIG. 25 is a 3D top-view drawing of the disk-platters' Top Data-Surface LIMDOW or MSR Magneto-Optical Microhead Array Chip.

FIG. 26 is a 3D bottom-view drawing of the disk-platters' Top Data-Surface LIMDOW or MSR Magneto-Optical Microhead Array Chip.

FIG. 27 is a 3D bottom-view drawing of the disk-platters' Bottom Data-Surface LIMDOW or MSR Magneto-Optical Microhead Array Chip.

FIG. 28 is a 3D top-view drawing of the disk-platters' Bottom Data-Surface LIMDOW or MSR Magneto-Optical Microhead Array Chip.

FIG. 29 is a 3D top back-view drawing of the between disk-platter chip-positioning circuit board assembly, shown with either LIMDOW or MSR Magneto-Optical Microhead Array Chips as being installed.

FIG. 30 is a 3D top back-view drawing of the between disk-platters chip-positioning circuit board assembly, shown with the LIMDOW or MSR Magneto-Optical Microhead Array Chips as not being installed.

FIG. 31 is a 3D-bottom front-view drawing of the between disk-platters chip-positioning circuit board assembly, shown with either LIMDOW or MSR Magneto-Optical Microhead Array Chips as being installed.

FIG. 32 is a 3D-bottom front-view drawing of the between disk-platters chip-positioning circuit board assembly, shown with the LIMDOW or MSR Magneto-Optical Microhead Array Chips as not being installed.

FIG. 33 is a 3D-bottom front-view drawing of a first disk-platter's chip-positioning circuit board assembly, shown with a LIMDOW or MSR Magneto-Optical Microhead Array Chip as being installed.

FIG. 34 is a 3D top front-view drawing of a first disk-platter's chip-positioning circuit board assembly, shown with a LIMDOW or MSR Magneto-Optical Microhead Array Chip as being installed.

FIG. 35 is a 3D top front-view drawing of a first disk-platter's chip-positioning circuit board assembly, shown with a LIMDOW or MSR Magneto-Optical Microhead Array Chip as not being installed.

FIG. 36 is a 3D-bottom front-view drawing of a last disk-platter's chip-positioning circuit board assembly, shown with the LIMDOW or MSR Magneto-Optical Microhead Array Chip as being installed.

FIG. 37 is a 3D-bottom front-view drawing of a last disk-platter's chip-positioning circuit board assembly, shown with a LIMDOW or MSR Magneto-Optical Microhead Array Chip as not being installed.

FIG. 38 is a 3D top front-view drawing of a last disk-platter's chip-positioning circuit board assembly, shown with a LIMDOW or MSR Magneto-Optical Microhead Array Chip as being installed.

FIG. 39 is a 3D top front-view drawing of a LIMDOW or MSR Magneto-Optical Microhead Array Chip's concealed VCSEL microhead array that displays the quarter-wave calcite plate covering the microhead array.

FIG. 40 is a 3D top front-view drawing of a LIMDOW or MSR Magneto-Optical Microhead Array Chip's two Bi-Metal Planar Induction Coils and concealed VCSEL microhead array that displays a smaller quarter-wave calcite plate covering the microhead array.

FIG. 41 is a 3D drawing of a top-front right-side view of a LIMDOW or MSR Magneto-Optical Microhead Array Chip's two Bi-Metal Planar Induction Coils and un-concealed VCSEL microhead array that displays the reference-voltage and signal-voltage read-channel photo-diode array semiconductor substrates.

FIG. 42 is a 3D drawing of a top-front left-side view of a LIMDOW or MSR Magneto-Optical Microhead Array Chip's two Bi-Metal Planar Induction Coils and un-concealed VCSEL microhead array that displays the reference-voltage and signal-voltage read-channel photo-diode array semiconductor substrates.

FIG. 43 is a 3D drawing showing a 30-degree top front right-side close-up view of a LIMDOW or MSR Magneto-Optical Microhead Array Chip's un-concealed VCSEL microhead array that displays details of the VCSEL microheads and two reversed-biased (SPC) “Semiconductor Photo-Conductor” linear position-sensing (CdS) “Cadmium Sulfide” semiconductor photo-diode devices.

FIG. 44 is a 3D drawing showing a 30-degree top back right-side close-up view of a LIMDOW or MSR Magneto-Optical Microhead Array Chip's un-concealed VCSEL microhead array that displays details of the VCSEL microheads and two reversed-biased (SPC) “Semiconductor Photo-Conductor” linear position-sensing (CdS) “Cadmium Sulfide” semiconductor photo-diode devices.

FIG. 45 is a 3D drawing showing a 10-degree top front-end right-side close-up view of a LIMDOW or MSR Magneto-Optical Microhead Array Chip's un-concealed VCSEL microhead array that displays details of the VCSEL microheads and two reversed-biased (SPC) “Semiconductor PhotoConductor” linear position-sensing (CdS) “Cadmium Sulfide” semiconductor photo-diode devices.

FIG. 46 is a 3D drawing of a 10-degree top back-end right-side close-up view of a LIMDOW or MSR Magneto-Optical Microhead Array Chip's un-concealed VCSEL microhead array that displays details of the VCSEL microheads and two reversed-biased (SPC) “Semiconductor Photo-Conductor” linear position-sensing (CdS) “Cadmium Sulfide” semiconductor photo-diode devices.

FIG. 47 is an orthographic drawing showing a front-end plan-view close-up of a LIMDOW or MSR Magneto-Optical Microhead Array Chip's un-concealed VCSEL microhead array that displays details of the VCSEL microheads and two reversed-biased (SPC) “Semiconductor Photo-Conductor” linear position-sensing (CdS) “Cadmium Sulfide” semiconductor photo-diode devices.

FIG. 48 is an orthographic drawing showing a back-end plan-view close-up of a LIMDOW or MSR Magneto-Optical Microhead Array Chip's un-concealed VCSEL microhead array that displays details of the VCSEL microheads and two reversed-biased (SPC) “Semiconductor Photo-Conductor” linear position-sensing (CdS) “Cadmium Sulfide” semiconductor photo-diode devices.

FIG. 49 is a 3D drawing showing a 30-degree top front-end left-side close-up view of a LIMDOW or MSR Magneto-Optical Microhead Array Chip's un-concealed VCSEL microhead array, while displaying details of the VCSEL microheads and two reversed-biased (SPC) “Semiconductor Photo-Conductor” linear position-sensing (CdS) “Cadmium Sulfide” semiconductor photo-diode devices.

FIG. 50 is a 3D drawing showing a 30-degree top back-end left-side close-up view of a LIMDOW or MSR Magneto-Optical Microhead Array Chip's un-concealed VCSEL microhead array, while displaying details of the VCSEL microheads and two reversed-biased (SPC) “Semiconductor Photo-Conductor” linear position-sensing (CdS) “Cadmium Sulfide” semiconductor photo-diode devices.

FIG. 51 is a 3D drawing showing a 10-degree top front-end left-side close-up view of a LIMDOW or MSR Magneto-Optical Microhead Array Chip's un-concealed VCSEL microhead array, while displaying details of the VCSEL microheads and two reversed-biased (SPC) “Semiconductor PhotoConductor” linear position-sensing (CdS) “Cadmium Sulfide” semiconductor photo-diode devices.

FIG. 52 is a 3D drawing showing a 10-degree top back-end left-side close-up view of a LIMDOW or MSR Magneto-Optical Microhead Array Chip's un-concealed VCSEL microhead array, while displaying details of the VCSEL microheads and two reversed-biased (SPC) “Semiconductor Photo-Conductor” linear position-sensing (CdS) “Cadmium Sulfide” semiconductor photo-diode devices.

FIG. 53 is a 3D drawing showing a 5-degree right-side close-up view of four LIMDOW or MSR Magneto-Optical Microhead Array Chip VCSEL microheads, while displaying minute structural details, along with typical diameter and spacing dimensions for the VCSEL microheads.

FIG. 54 is a 3D drawing showing a 5-degree left-side close-up view of four LIMDOW or MSR Magneto-Optical Microhead Array Chip VCSEL microheads, while displaying minute structural details, along with typical diameter and spacing dimensions for the VCSEL microheads.

FIG. 55 is a 3D drawing showing a 45-degree right-side close-up view of one LIMDOW or MSR Magneto-Optical Microhead Array Chip VCSEL microhead, while displaying minute structural details for a LIMDOW or MSR Magneto-Optical Microhead Array Chip VCSEL microhead.

FIG. 56 is a 3D drawing showing a 10-degree left-side close-up view of one LIMDOW or MSR Magneto-Optical Microhead Array Chip VCSEL microhead, while displaying minute structural details for a LIMDOW or MSR Magneto-Optical Microhead Array Chip VCSEL microhead.

FIG. 57 is an orthographic plan-view close-up drawing of seven LIMDOW or MSR Magneto-Optical Microhead Array Chip VCSEL microheads that display section lines 2-2 and 3-3, but the drawing also illustrates the diameter and the spacing dimensions for each of the seven LIMDOW or MSR Magneto-Optical Microhead Array Chip VCSEL microheads shown.

FIG. 58 is an orthographic side-view close-up drawing of a typical mesa-etched VCSEL device, which displays section 3-3 of FIG. 57 while illustrating the various layers and structures normally used in the construction of a typical prior art mesa-etched VCSEL device.

FIG. 59 is a 3D drawing showing as an alternative embodiment to FIGS. 55 and 56 a close-up view of a single (FCSEL) “Folded Cavity Surface Emitting Laser” microhead.

FIG. 60A is a block-diagram drawing of the ATA-2 IDE Disk Controller used in the LIMDOW and MSR Magneto-Optical Microhead Array Chip Hard Disk Drive design, which displays areas within FIG. 60A that were copied to separate drawing files as block-diagram drawing figures containing enlarged areas of block-diagram 60A.

FIG. 60B is an enlarged block-diagram drawing of the ATA-2 IDE Disk Controller used in the LIMDOW and MSR Magneto-Optical Microhead Array Chip Hard Disk Drive design, which displays an enlarged block-diagram showing details of the block-diagram illustrated in FIG. 60A.

FIG. 60C is an enlarged block-diagram drawing of the ATA-2 IDE Disk Controller used in the LIMDOW and MSR Magneto-Optical Microhead Array Chip Hard Disk Drive design, which displays an enlarged block-diagram showing details of the block-diagram illustrated in FIG. 60A.

FIG. 61A is a block-diagram drawing of the SCSI Disk Controller used in the LIMDOW and MSR Magneto-Optical Microhead Array Chip Hard Disk Drive design, which displays areas within FIG. 61A that were copied to separate drawing files as block-diagram drawing figures containing enlarged areas of block-diagram 61A.

FIG. 61B is an enlarged block-diagram drawing of the SCSI Disk Controller used in the LIMDOW and MSR Magneto-Optical Microhead Array Chip Hard Disk Drive design, which displays an enlarged block-diagram showing details of the block-diagram illustrated in FIG. 61A.

FIG. 61C is an enlarged block-diagram drawing of the SCSI Disk Controller used in the LIMDOW and MSR Magneto-Optical Microhead Array Chip Hard Disk Drive design, which displays an enlarged block-diagram showing details of the block-diagram illustrated in FIG. 61A.

FIG. 62A is a block-diagram drawing showing the internal component configurations for the ATA-2 IDE Disk Controller used in the LIMDOW and MSR Magneto-Optical Microhead Array Chip Hard Disk Drive design, which displays areas within FIG. 62A that were copied to separate drawing files as block-diagram drawing figures containing enlarged areas of block-diagram 62A.

FIG. 62B is an enlarged block-diagram drawing showing details of internal component configurations for the ATA-2 IDE Disk Controller used in the LIMDOW and MSR Magneto-Optical Microhead Array Chip Hard Disk Drive design, which displays an enlarged block-diagram showing details of the block-diagram illustrated in FIG. 62A.

FIG. 62C is an enlarged block-diagram drawing showing details of internal component configurations for the ATA-2 IDE Disk Controller used in the LIMDOW and MSR Magneto-Optical Microhead Array Chip Hard Disk Drive design, which displays an enlarged block-diagram drawing showing details of the block-diagram illustrated in FIG. 62A.

FIG. 63A is a block-diagram drawing showing the internal component configurations for the SCSI Disk Controller used in the LIMDOW and MSR Magneto-Optical Microhead Array Chip Hard Disk Drive design, which displays areas within FIG. 63A that were copied to separate drawing files as block-diagram drawing figures containing enlarged areas of block-diagram 63A.

FIG. 63B is an enlarged block-diagram drawing showing details of internal component configurations for the SCSI Disk Controller used in the LIMDOW and MSR Magneto-Optical Microhead Array Chip Hard Disk Drive design, which displays an enlarged block-diagram drawing showing details of the block-diagram illustrated in FIG. 63A.

FIG. 63C is an enlarged block-diagram drawing showing details of internal component configurations for the SCSI Disk Controller used in the LIMDOW and MSR Magneto-Optical Microhead Array Chip Hard Disk Drive design, which displays an enlarged block-diagram drawing showing details of the block-diagram illustrated in FIG. 63A.

FIG. 64A is a block-diagram drawing of the LIMDOW or MSR Magneto-Optical Microhead Array Chip design used in the LIMDOW and MSR Magneto-Optical Microhead Array Chip Hard Disk Drive, which displays areas within FIG. 64A copied to separate drawing files as block-diagram drawing figures containing enlarged areas of block-diagram 64A.

FIG. 64B is an enlarged block-diagram drawing of the LIMDOW or MSR Magneto-Optical Microhead Array Chip design used in the LIMDOW and MSR Magneto-Optical Microhead Array Chip Hard Disk Drive, which displays an enlarged block-diagram drawing showing details of the Microhead-Addressing and Chip-Selection circuits illustrated in block-diagram FIG. 64A.

FIG. 64C is an enlarged block-diagram drawing of the LIMDOW or MSR Magneto-Optical Microhead Array Chip design used in the LIMDOW and MSR Magneto-Optical Microhead Array Chip Hard Disk Drive, which displays an enlarged block-diagram drawing showing details of the Data Read-Channel and the Data-Acknowledgment circuits illustrated in block-diagram FIG. 64A.

FIG. 64D is an enlarged block-diagram drawing of the LIMDOW or MSR Magneto-Optical Microhead Array Chip design used in the LIMDOW and MSR Magneto-Optical Microhead Array Chip Hard Disk Drive, which displays an enlarged block-diagram drawing showing details of the Data Write-Channel and the Data-Acknowledgment circuits illustrated in block-diagram FIG. 64A.

FIG. 64E is an enlarged block-diagram drawing of the LIMDOW or MSR Magneto-Optical Microhead Array Chip design used in the LIMDOW and MSR Magneto-Optical Microhead Array Chip Hard Disk Drive, which displays an enlarged block-diagram drawing showing details of two Bi-Metal Planar Induction Coils, the VCSEL Microhead Array with Microhead Control-Lines, two (SPC) “Semiconductor Photo-Conductor” devices, and the Read and Write Bus circuits illustrated in block-diagram FIG. 64A.

FIG. 64F is an auxiliary block-diagram drawing, which displays details of the reverse-biased transimpedence amplifier circuits used by the LIMDOW or MSR Magneto-Optical Microhead Array Chip read-channel's two (SPC) “Semiconductor Photo-Conductor” devices.

FIG. 64G is an auxiliary block-diagram drawing, which displays details of the reversed-biased (SPD) “Semiconductor Photo-Diode” photocell semiconductor array labeled as “SPD Array 1” circuit.

FIG. 64H is an auxiliary block-diagram drawing, which displays details of the reversed-biased (SPD) “Semiconductor Photo-Diode” photocell semiconductor array labeled as “SPD Array 2” circuit.

FIG. 64I is an enlarged block-diagram drawing of the LIMDOW or MSR Magneto-Optical Microhead Array Chip design used in the LIMDOW and MSR Magneto-Optical Microhead Array Chip Hard Disk Drive, which displays an enlarged block-diagram drawing showing details of the Data Modulated Auxiliary Dummy Load Induction Coils and the pin assignments illustrated in FIG. 64A.

FIG. 65 is a logic-diagram drawing of the Address-Strobe And Chip-Select circuit.

FIG. 66 is a circuit-diagram drawing of the Address-Strobe And Chip-Select circuit.

FIG. 67 is a truth-table diagram for the Address-Strobe and Chip-Select circuit.

FIG. 68 is a conversion-table diagram for the Address-Strobe and Chip-Select circuit.

FIG. 69 is a logic-diagram drawing of the “32” bit Address Latch And Chip-Select circuit used in the LIMDOW or MSR Magneto-Optical Microhead Array Chip design, which displays a Chip-Select circuit's connectivity within the LIMDOW or MSR Magneto-Optical Microhead Array Chips.

FIG. 70A is a circuit-diagram drawing of the “32” bit Address-Latch And Chip-Select circuit used in the LIMDOW or MSR-Magneto-Optical Microhead Array Chip design, which displays circuit configurations of the Address-Latch And Chip-Select circuit.

FIG. 70B is an auxiliary circuit-diagram drawing showing circuit details of the buffers used in the Address-Latch circuit.

FIG. 71 is a logic-diagram drawing of the “32” bit Address-Decoder circuit.

FIG. 72 is a circuit-diagram drawing showing circuit details of the “32” bit Address-Decoder circuit.

FIG. 73 is a logic-diagram drawing of the Address-Buffers circuit used in the LIMDOW or MSR Magneto-Optical Microhead Array Chip design, which displays the digital logic behind the operation of a address-decoder selected microhead's line-buffer.

FIG. 74 is a circuit-diagram drawing of the Address-Buffers circuit used in the LIMDOW or MSR Magneto-Optical Microhead Array Chip design, which displays the circuit details behind an address-decoder selected microhead's line-buffer, while displaying how the un-selected microhead selection lines are pull-to-ground using Long-L inverter line-buffer circuits.

FIG. 75 is a logic-diagram drawing of the Flip-Flop, Coil Selection, and Coil Rotation control circuits.

FIG. 76 is a circuit-diagram drawing showing circuit details of the Flip-Flop, Coil Selection, and Coil Rotation control circuits.

FIG. 77 is a logic-diagram drawing showing the digital logic behind the control over Bi-Metal Planar Induction Coil data-heads used in the LIMDOW or MSR Magneto-Optical Microhead Array Chip design, while displaying the digital logic behind the transmission-gates controlling coil-selection control line access to the Write Driver Circuit's two power providing bridge buses, which are labeled as WDCI (A) and WDCI (B).

FIG. 78 is a circuit-diagram drawing showing the circuit configurations behind the Bi-Metal Planar Induction Coil data-head design used in the LIMDOW or MSR Magneto-Optical Microhead Array Chips, while displaying circuit details of the transmission-gate circuits controlling coil-selection control line access to the Write Driver Circuit's two power busing bridge circuits, which are labeled as WDCI (A) and WDCI (B).

FIG. 79 is a logic-diagram drawing showing the digital logic behind the operation of the read-channels used in the LIMDOW or MSR Magneto-Optical Microhead Array Chips, while displaying the digital logic behind the operation of the Voltage Dividers, the Analog/Digital Comparators, the Pre-Amps, and the XOR bi-phase data-stream encoders.

FIG. 80 is a circuit-diagram drawing showing the circuit configurations behind the operation of the read-channels used in the LIMDOW or MSR Magneto-Optical Microhead Array Chips, while displaying circuit configurations behind the operation of the Voltage Dividers, the Analog/Digital Comparators, the Pre-Amps, and the XOR bi-phase data-stream encoders.

FIG. 81 is a logic-diagram drawing detail showing the digital logic behind the operation of a read-channel's Voltage Divider, Analog-Comparator, Digital Pre-Amp, and (-RDTACK) “Read Data Acknowledge” control circuits.

FIG. 82 is a circuit-diagram drawing detail showing the circuit configurations behind the operation of a read-channel's Voltage Divider, Analog-Comparator, Digital Pre-Amp, and (-RDTACK) “Read Data Acknowledge” control circuits.

FIG. 83 is a logic-diagram drawing detail showing the digital logic behind the operation of a read-channel's Comparator Decision-Circuit and Read-Enable Latching Circuit.

FIG. 84 is a circuit-diagram drawing detail showing the circuit configurations behind the operation of a read-channel's Comparator Decision-Circuit and Read-Enable Latching Circuit.

FIG. 85 is a logic-diagram drawing detail showing the digital logic behind the operation of a read-channel's Comparator Buffer Post-Amp Circuits, (RD-TACK) “Read Data Acknowledge” Input Circuits, and XOR Bi-Phase Data-Stream Encoding Pre-DPLL Circuit.

FIG. 86 is a circuit-diagram drawing detail showing the circuit configurations behind the operation of a read-channel's Comparator Buffer Post-Amp Circuit, (-RDTACK) “Read Data Acknowledge” Input Circuit, and XOR Bi-Phase Data-Stream Encoding Pre-DPLL Circuit.

FIG. 87 is a logic-diagram drawing showing the digital logic behind the operation of the R/W Control Circuit.

FIG. 88 is a circuit-diagram drawing showing the circuit configurations behind the operation of the R/W Control Circuit.

FIG. 89 is a truth-table diagram drawing showing in word form the digital logic behind the operation of the R/W Control Circuit.

FIG. 90 is a conversion-table legend drawing used to translate drawing symbols that represent various voltage settings for circuits illustrated in FIGS. 87, and 88.

FIG. 91 is a logic-diagram drawing showing the digital logic behind the operation of a read-channel's AOI XOR Bi-Phase Encoded Data-Out Circuit, Pre-DPLL Circuit, and DClock-Input Circuit.

FIG. 92 is a circuit-diagram drawing showing the circuit configurations behind the operation of a read-channel's AOI XOR Bi-Phase Encoded Data-Out Circuit, Pre-DPLL Circuit, and Dclock-Input Circuit.

FIG. 93 is a Bi-Phase Data Encoding diagram drawing displaying the data-stream encoding scheme to be used by a read-channel's AOI XOR Bi-Phase Encoded Data-Out Circuit, Pre-DPLL Circuit, and Dclock-Input Circuit.

FIG. 94 is a truth-table diagram drawing showing in word form the digital logic behind the operation of a read-channel's AOI XOR Bi-Phase Encoded Data-Out Circuit, Pre-DPLL Circuit, and Dclock-Input Circuit.

FIG. 95 is a conversion-table legend drawing used to translate drawing symbols that represent various voltage settings for circuits illustrated in FIGS. 91, 92, and 93.

FIG. 96 is a logic-diagram drawing showing the digital logic behind the operation of a write-channel's Pre-Amp and Write Driver Circuit, while displaying the digital logic behind the operation of (-WDTACK) “Write Data Acknowledge” control signals.

FIG. 97 is a circuit-diagram drawing showing the circuit configurations behind the operation of a write-channel's Pre-Amp and Write Driver Circuits, while displaying the circuit configurations behind the operation of (WDTACK) “Write Data Acknowledge” control circuits.

FIG. 98 is a logic-diagram drawing showing the digital logic behind the operation of a write-channel's (AB Class) Pre-Amp Circuit, while displaying the digital logic behind the operation of (-WDTACK) “Write Data Acknowledge” control signals.

FIG. 99 is a circuit-diagram drawing showing the circuit configurations behind the operation of a write-channel's (AB Class) Pre-Amp Circuit, while displaying the circuit configurations behind the operation of (-WDTACK) “Write Data Acknowledge” control circuits.

FIG. 100 is a logic-diagram drawing showing the digital logic behind the operation of a write-channel's Data Modulated Write Driver Circuit, while displaying the digital logic behind the operation of (-WDTACK) “Write Data Acknowledge” control signals.

FIG. 101 is a circuit-diagram drawing showing the circuit configurations behind the operation of a write-channel's Data Modulated Write Driver Circuit, while displaying the circuit configurations behind the operation of (WDTACK) “Write Data Acknowledge” control circuits.

FIG. 102 is a logic-diagram drawing showing the digital logic behind the operation of write-channel's (-WDTACK) “Write Data Acknowledge” control signals.

FIG. 103 is a circuit-diagram drawing showing the circuit configurations behind the operation of a write-channel's (-WDTACK) “Write Data Acknowledge” control circuits.

FIG. 104 is a truth-table diagram drawing showing in word form the digital logic behind the operation of a write-channel's (-WDTACK) “Write Data Acknowledge” control signals.

FIG. 105 is a conversion-table legend drawing used to translate drawing symbols that represent various voltage settings for circuits illustrated in FIGS. 102 and 103.

FIG. 106 is both a logic and a block-diagram drawing showing the digital logic behind the operation of a read-channel's XOR and Pre-DPLL Circuit.

FIG. 107 is a logic-diagram drawing showing the digital logic behind the operation of the Microhead Selection Line and Transmission-Gate Switching Circuits, while displaying the digital logic behind the operation of a Microhead Selection Line Circuit's control over every VCSEL microhead's connection to the power buses used in the LIMDOW or MSR Magneto-Optical Microhead Array Chips, using three illustrated examples of VCSEL microheads, which are shown in FIG. 107 as VCSEL00, VCSEL01, and N.

FIG. 108A is an orthographic side-view drawing showing details of a One Half-Mirrored Beam-Splitting Analyzer, One Quarter-Wave Light Polarizing Calcite Plate, One VCSEL Microhead, and two (SPC) “Semiconductor Photo-Conductor” photo-detection arrays.

FIG. 108B is a close-up drawing figure detail that uses an enclosed hatched-pattern to illustrate the necessary crystallographic orientation of two crystals used in the construction of the Half-Mirrored Beam-Splitting Analyzer.

FIG. 109 is a circuit-diagram drawing showing the circuit configurations behind the operation of a read-channel's VCSEL Microhead (PCCs) “Power Control Circuits”, while displaying circuit configurations behind the operation of the two transmission-gates responsible for circuit pathway selection and power switching between the (WLV) “Write Laser Voltage” and the (RLV) “Read Laser Voltage” input power-bus lines.

FIG. 110 is a logic-diagram drawing showing the digital logic behind the operation of a read-channel's VCSEL Microhead (VCSEL Microhead PCC) “Vertical Cavity Surface Emitting Laser Power Control Circuit”, while displaying the digital logic behind the operation of the two transmission-gates responsible for circuit pathway selection and power switching between the (WLV) “Write Laser Voltage” and the (RLV) “Read Laser Voltage” input power-bus lines.

FIG. 111 is a circuit-diagram drawing showing the circuit configurations behind the operation of the Microhead Selection Line and Transmission-Gate Switching Circuits, while displaying the circuit configurations behind the operation of a Microhead Selection Line Circuit's control over the connectivity to power bus lines for every VCSEL microhead used within a LIMDOW or MSR Magneto-Optical Microhead Array Chip, which are illustrated in FIG. 111 as VCSEL00, VCSEL01, and N.

FIG. 112 is a 3D perspective-view drawing that illustrates how a LIMDOW and MSR Magneto-Optical Microhead Array Chip Hard Disk Drive unit-assembly will look when fully assembled, while for reasons of visual clarity is shown without a hard disk cover or a hard disk cover's sealing gasket.

FIG. 113 shows an orthographic plan-view of a LIMDOW and MSR Magneto-Optical Microhead Array Chip Hard Disk Drive unit-assembly, shown with the hard disk drive cover and sealing gasket removed and configured with a dedicated Microhead Array Chip bus system.

FIG. 114 shows an orthographic side-view of a LIMDOW and MSR Magneto-Optical Microhead Array Chip Hard Disk Drive unit-assembly, shown with the hard disk drive cover and sealing gasket removed and configured with a dedicated Microhead Array Chip bus system, displaying section 114-114.

FIG. 115 shows an orthographic front-view of a LIMDOW and MSR Magneto-Optical Microhead Array Chip Hard Disk Drive unit-assembly, shown with the hard disk drive cover and sealing gasket removed and configured with a dedicated Microhead Array Chip bus system, displaying section 115-115.

FIG. 116 is a plan-view drawing of a chip-positioning circuit board that displays a LIMDOW or MSR Magneto-Optical Microhead Array Chip Number-1, which is positioned for disk-platter one's bottom-side (also called disk-platter one's data-surface side-one).

FIG. 117 is a plan-view drawing of a chip-positioning circuit board that displays a LIMDOW or MSR Magneto-Optical Microhead Array Chip Number-2, which is positioned for disk-platter one's top-side (also called disk-platter one's data-surface side-two).

FIG. 118 is an orthographic plan-view drawing of a LIMDOW or MSR Magneto-Optical Microhead Array Chip, which shown installed into a surface-mounted chip-socket that displays pin locations, number assignments, and logic-function labels for the Bottom Data-Surface LIMDOW or MSR Multichannel Magneto-Optical Microhead Array Chip.

FIG. 119 is an orthographic plan-view drawing of a LIMDOW or MSR Magneto-Optical Microhead Array Chip, which is shown installed into a surface-mounted chip-socket that displays pin locations, number assignments, and logic-function labels for the Top Data-Surface LIMDOW or MSR Multichannel Magneto-Optical Microhead Array Chips.

FIG. 120 is a logic-signal flow schematic for the Bottom Data-Surface Multichannel LIMDOW or MSR Magneto-Optical Microhead Array Chips, displaying signal direction, pin assignments, and function labels.

FIG. 121 is a logic-signal flow schematic for the Top Data-Surface Multichannel LIMDOW or MSR Magneto-Optical Microhead Array Chips, displaying signal direction, pin assignments, and pin function labels.

FIG. 122 is an plan-view drawing of a Polymer flex bus-cable for the chip-positioning circuit boards' right side connector as used in the Multichannel LIMDOW or MSR Magneto-Optical Microhead Array Chip design, displaying data-bus, future-bus, and control-bus pin assignments.

FIG. 123 is a plan-view drawing of a Polymer flex bus-cable for the chip-positioning circuit boards' left side connector as used in the Multichannel LIMDOW or MSR Magneto-Optical Microhead Array Chip design, displaying the “32” bit address-bus pin assignments.

FIG. 124 is a block-diagram drawing showing the internal component configurations for the Multichannel LIMDOW and MSR Magneto-Optical Microhead Array Chips.

FIG. 125 is a block-diagram drawing showing the internal component configurations for a Multichannel LIMDOW and MSR Magneto-Optical Microhead Array Chip's multiple read channels.

FIG. 126 is a logic-diagram drawing showing the internal logic configurations for the Multichannel LIMDOW and MSR Magneto-Optical Microhead Array Chip's Multiswitching Voltage Detector Arrays, which are each located at the termination of every microhead selection line.

FIG. 127 is a logic-diagram drawing of the “32” bit Microhead Address Latch circuit used in every Multichannel LIMDOW or MSR Magneto-Optical Microhead Array Chip.

FIG. 128 is a circuit-diagram drawing showing circuit details of the “32” bit Address-Decoder circuit.

FIG. 129 is a logic-diagram drawing of the Voltage-Variable MSL Buffer and Latch Circuit used in every Multichannel LIMDOW or MSR Magneto-Optical Microhead Array Chip.

FIG. 130 is both a logic and a block-diagram drawing of a multiple read-channel's Self-Clocking DPLL circuit.

FIG. 131 is a block and logic-diagram drawing of one of the voltage detector circuits that makeup the Multiswitching Voltage Detector Arrays located within every Multichannel LIMDOW or MSR Magneto-Optical Microhead Array Chip.

FIG. 132 is a logic-diagram drawing of a Track-Channel Voltage Comparator circuit, which along with other voltage comparators form an array that partially comprises the multiple read-channel of every Multichannel LIMDOW or MSR Magneto-Optical Microhead Array Chip.

FIG. 133 is a circuit-diagram drawing of a Track-Channel Voltage Comparator circuit, which along with other voltage comparators form an array that partially comprises the multiple read-channel of every Multichannel LIMDOW or MSR Magneto-Optical Microhead Array Chip.

FIG. 134 is a circuit-diagram drawing of the photo-detectors and photo-emitters used to comprise the microhead array located within every Multichannel LIMDOW or MSR Magneto-Optical Microhead Array Chip.

FIG. 135 is a circuit and logic-diagram drawing of a Source Detector circuit, which along with other source detectors form an array that partially comprises the multiple read-channel of every Multichannel LIMDOW or MSR Magneto-Optical Microhead Array Chip.

FIG. 136 is a logic-diagram drawing of a Photo-Emitter Driver circuit, which along with other photo-emitter driver circuits form an array that partially comprises the multiple write-channel of every Multichannel LIMDOW or MSR Magneto-Optical Microhead Array Chip.

FIG. 137 is a logic-diagram drawing of a Voltage-Variable MSL Buffer and Latch circuit, which along with other voltage-variable msl buffer and latch circuits form a buffer and amplification circuit for every microhead selection line variable-voltage that occurs within a Multichannel LIMDOW or MSR Magneto-Optical Microhead Array Chip.

FIG. 138 is a block-diagram drawing of the Microhead Array Chip, Internal Data-Striping, Hard Disk Drive, I/O and Target Channel Adapter Interface Controller used in the Multichannel LIMDOW and MSR Magneto-Optical Microhead Array Chip Hard Disk Drive design.

FIG. 139 is a block-diagram drawing of the Microhead Array Chip, Internal Data-Striping, Hard Disk Drive, I/O, and Target Channel Adapter Interface Controller used in the Multichannel LIMDOW and MSR Magneto-Optical Microhead Array Chip Hard Disk Drive design that displays the internal component configurations of the controller.

### DETAILED DESCRIPTIONS OF INVENTION

This invention has two media embodiments, each based upon a different variation of storage disk media: 1.) A LIMDOW Magneto-Optical Microhead Array Chip Hard Disk Drive embodiment; 2.) A MSR Magneto-Optical Microhead Array Chip Hard Disk Drive embodiment, which comprises a more complex version of the LIMDOW media. Furthermore, each of the two previously mentioned media embodiments comprises three different bus-system embodiments:

i.) A LIMDOW and MSR Magneto-Optical Microhead Array Chip Hard Disk Drive design that uses microhead address, microhead control, and microhead data bus systems that are shared by all LIMDOW or MSR Magneto-Optical Microhead Array Chips that are installed into a LIMDOW and MSR Magneto-Optical Microhead Array Chip Hard Disk Drive's unit-assembly. Wherein, all LIMDOW or MSR Magneto-Optical Microhead Array Chips are connected together then collectively to the hard disk drive's unit-assembly using a shared daisy-chain bus-cable configuration. Whereby, only one LIMDOW or MSR Magneto-Optical Microhead Array Chip and one of its microheads can be selected at any one time to execute a read-data or a write-data disk-operation on a respective disk-platter's data-surface.

ii.) A LIMDOW and MSR Magneto-Optical Microhead Array Chip Hard Disk Drive design that uses microhead address, microhead control, and microhead data bus systems, which are dedicated and, therefore are independently connected to all LIMDOW or MSR Magneto-Optical Microhead Array Chips that are installed into a LIMDOW and MSR Magneto-Optical Microhead Array Chip Hard Disk Drive's unit-assembly using a separate and dedicated bus-cable configuration. Wherein, all LIMDOW or MSR Magneto-Optical Microhead Array Chips are not connected collectively to the hard disk drive, but are independently connected to the hard disk drive's unit-assembly using their own separate independent bus cables. Whereby, multiple LIMDOW or MSR Magneto-Optical Microhead Array Chips can be simultaneously selected and controlled independently to execute simultaneous read-data or write-data disk-operations on each of their separate and respective disk-platter data-surface.

iii.) A LIMDOW and MSR Magneto-Optical Microhead Array Chip Hard Disk Drive design that uses microhead address, microhead control, and microhead data bus systems, which are dedicated and, therefore independently connected to all LIMDOW or MSR Magneto-Optical Microhead Array Chips installed into a LIMDOW and MSR Magneto-Optical Microhead Array Chip Hard Disk Drive's unit-assembly, using a separate dedicated bus cable configuration. Wherein, all LIMDOW or MSR Magneto-Optical Microhead Array Chips are not connected collectively to the hard disk drive, but are independently connected to the hard disk drive using their own separate independent and dedicated bus cables. Whereby, multiple LIMDOW or MSR Magneto-Optical Microhead Array Chips can be simultaneously selected and controlled independently to execute simultaneous and multiple read-data or write-data disk-operations on each of their separate and respective disk-platter's data-surface, while using simultaneously a multiplicity of microheads on each of their respective data-surfaces.

Moreover, two performance issues confronting a designer of a high capacity magnetic or optical hard disk drive are “average seek times” and “full stroke seek times”. Seek-times are the movement of read/write data-head stack-assemblies from one data-track to another for the facilitation of data storage and data retrieval. To a designer the beforementioned seek-times presents a serious amount of lag-time or a ‘bottle neck’ in a hard disk drive's execution of data storage or data retrieval processes. In addition, is the loss of a hard disk drive's data-surface real estate to embedded-servo sectoring and servo-information fields; normally needed by a conventional hard disk drive's tracking system, as defined by prior art.

However, when it comes to LIMDOW and MSR Magneto-Optical Microhead Array Chip Hard Disk Drive designs, problems normally associated with traditional tracking methods and conventional voice-coil actuators are not improved upon, but are all together eliminated. Furthermore, to understand the functionality and improvements the LIMDOW and MSR Magneto-Optical Microhead Array Chip Hard Disk Drive design introduces, we must begin by considering the structures illustrated in drawing FIGS. 1, 2, and 3. Moreover, these illustrations are orthographic drawings of a LIMDOW and MSR Magneto-Optical Microhead Array Chip Hard Disk Drive's unit-assembly.

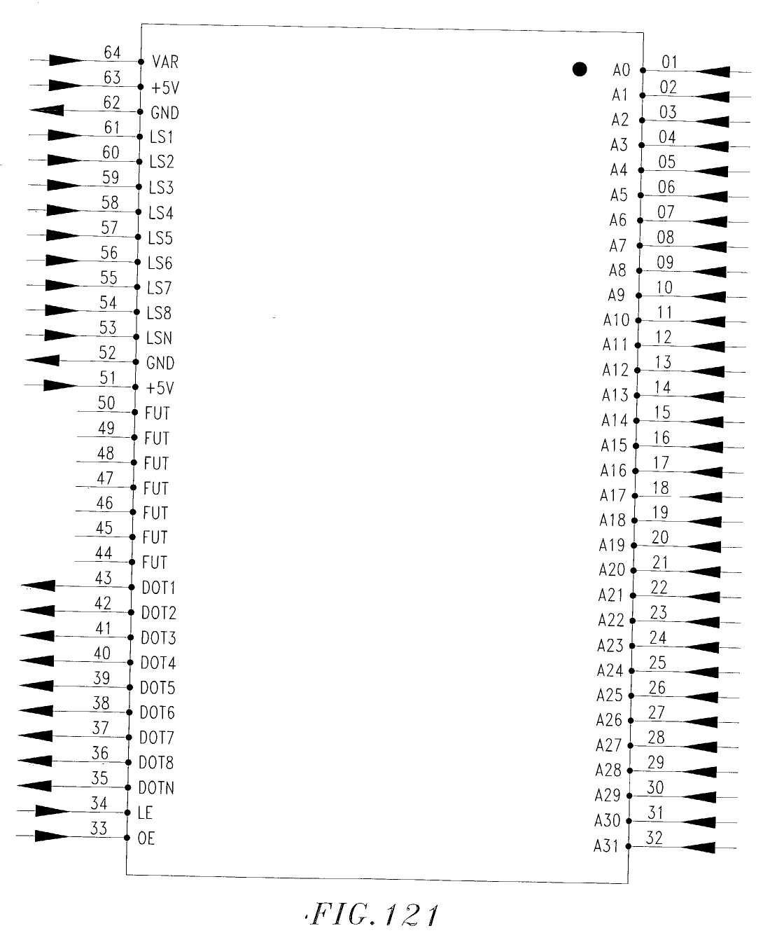

Furthermore, a first and basic embodiment, as illustrated in drawing FIGS. 1, 2, and 3, begins by describing a LIMDOW and MSR Magneto-Optical Microhead Array Chip Hard Disk Drive's structure and how its is constructed, starting with the drive's casting-base 12 (FIGS. 1, 2, and 3), which is constructed from a single machined piece of aluminum-alloy that provides a mounting surface for a spindle-motor drive mechanism 59 (FIGS. 2 and 3), a (PCB) “Printed Circuit Board” hard disk drive controller 53 (FIGS. 2 and 3), a hard disk drive's cover and cover sealing-gasket (i.e., not shown here), and LIMDOW or MSR Magneto-Optical Microhead Array Chip chip-positioning circuit board assemblies 27 (FIGS. 1, 2, 3, 6, 9, and 10). The bottom inside of the beforementioned casting-base 12 (FIGS. 1, 2, and 3) acts as a mounting flange for the beforementioned (DC) “Direct Current” “Spindle-Motor” drive assembly 59 (FIGS. 2 and 3). Furthermore, integral with the beforementioned casting-base 12 (FIGS. 1, 2, and 3), is the beforementioned DC Spindle-Motor's drive assembly, which is a fixed-shaft and brushless DC Spindle-Motor drive mechanism 59 (FIG. 2 and 3) that drives the “counterclockwise” rotation 48 (FIG. 1) of the data-storage disk-platters 13 (FIGS. 1, 2, and 3) installed in a LIMDOW and MSR Magneto-Optical Microhead Array Chip Hard Disk Drive's unit-assembly, as illustrated in FIG. 117.

In addition, a LIMDOW and MSR Magneto-Optical Microhead Array Chip Hard Disk Drive's unit-assembly uses data-storage disk-platters 13 (FIGS. 1, 2, and 3) to store various kinds of information, where the beforementioned disk-platters are constructed as double-sided, multi-layered, and circular-shaped disk structures. A substrate constructed from a composite of liquid crystal polymer and rare-earth magnetic powder which is caste into a disk shape than covered in a highly reflective composite alloy material like “Titanium-Chromate”, a transparent dielectric layer, several rare-earth magnetic transition and recording layers, and a protective layer, all of which comprise a disk-platter's multi-layered structure, where deposition of the beforementioned layers is outward from both sides of a disk-platter's substrate. The highly reflective substrate is made from a liquid crystal polymer rare-earth magnetic powder composite material, glass, Invar, or scintillated rare-earth magnetic material all of which can be coated with a reflective “Titanium-Chromate” material like “TiAlCo—B”, which is used by the beforementioned disk-platters to reflect laser-light produced by lasers located within the LIMDOW or MSR Magneto-Optical Microhead Array Chips. A first transparent dielectric layer, which is formed from a transparent de-oxygenated material such as (SiN) “Silicon-Nitride” or (AlN) “Aluminum-Nitride”, while the beforementioned transition and recording layers are formed from amorphous magnetic rare-earth and transition-metal alloys such as (TbFeCo) or (GdTbFe), and finally a second protective layer, which is also formed from a transparent de-oxygenated material such as (SiN) “Silicon-Nitride” or (AlN) “Aluminum-Nitride”.

Moreover, there are four types of magneto-optical disc media 13, which can be used in one or more embodiments of this invention. A first magneto-optical disc media 13 (i.e., hereinafter abbreviated as A-type disc), which relates to a direct overwriting system similar to the magneto-optical disc used in the first prior art technique previously described in the prior art section of this application. The A-type disc comprises a magneto-optical recording medium formed on a reflective or non-reflective non-magnetic substrate, which is constructed from a polymer, ceramic, glass or metallic material. The magneto-optical recording medium has a multi-layered structure, which is sputter deposited upon the previously mentioned substrate and includes a recording and reproducing layer having vertical magnetic anisotropy, and a supplemental recording layer having a different coercive force from that of the recording and reproducing layers previously mentioned.

A second magneto-optical disc media 13 (i.e., hereinafter abbreviated as B-type disc), which corresponds to the “Magnetically induced Super Resolution” (MSR) method similar to the magneto-optical disc used in the second technique previously described in the prior art section of this application. In particular, the B-type disc relates to the RAD or D-RAD method, which requires an initializing magnetic field. In the MSR method, data can be read out from a region narrower than the area of the laser light-beam spot, so that the recording density (i.e., specifically, reproducing density) can be significantly increased.

A third magneto-optical disc media 13 (i.e., hereinafter abbreviated as C-type disc), which has a single use for reproduction similar to the magneto-optical disc used in the third prior art technique previously described in the prior art section of this application. The C-type disc can have a high reproducing density using the MSR method. Remembering that in the A-type and the B-type discs the magneto-optical recording medium is formed by a plurality of magnetic layers respectively having different coercive forces. While in the C-type disc, the coercive force in a magnetic layer positioned above the marked portions is different from that in the same magnetic layer positioned above the non-marked portions.

A fourth magneto-optical disc media 13 (i.e., hereinafter abbreviated as D-type disc), which relates to all three systems: 1.) To the direct overwriting system; 2.) To the “Magnetically induced Super Resolution” (MSR) system, and 3.) To the single use for reproduction system, all previously mentioned. The D-type disc, however, it has one very important difference from that of the other three disc versions, and that is either 1.) A fifth magnetic layer used to create an initialization magnetic field, or preferably 2.) A substrate constructed from a rare-earth permanent magnetic material, where both can eliminate therein, the use of a permanent magnet or induction coil that is external to the disc media and used to generate an initialization magnetic field.

In this invention, these four types of magneto-optical disc media can be used, and the initializing magnetic field is necessary in each case. The spindle motor 59 rotates the magneto-optical disc 13 in counterclockwise direction sown by arrow 49. The microhead array 1 is stationary and used for accessing a desired data-sector or data-sector area that is located on the magneto-optical disc 13. When the magneto-optical disc 13 is an A-type or B-type, a selected microhead 1 records and reproduces the data about the magneto-optical disc media 13. On the other hand, when the magneto-optical disc 13 is a C-type, a selected microhead 1 only reproduces the data from the magneto-optical disc media 13. When a laser light-beam is irradiated on a surface of a magneto-optical recording medium of the magneto-optical disc media 13 for recording and reproducing the data, while with respect to the magneto-optical disc media 13 is C-type of single use for reproduction; moreover, the laser light-beam is correctly irradiated on the reproducing medium.

In the first embodiment, the first magnetic field generator does not need to me positioned ahead of the laser light-beam spot, this is simply because microhead array chips do not use focusing coils and lenses, which can become interrupted by magnetic field generators. In addition, if using the D-type of magneto-optical disc media a first magnetic field generator is typically replaced by the media's substrate, which is constructed from a permanent magnetic material. The laser light-beam is focused on the track on the magneto-optical disc media 13, so that the first magnetic field generator should be positioned in a manner to apply the magnetic field on the track. The laser light-beam comes from a selected microhead diode laser or VCSEL, which is stationary and positioned above the data containing data-track on a line crossing the rotation axis of the magneto-optical disc 13 that is the radial direction of the magneto-optical disc 13.

In addition, the second magnetic field generator is disposed to cover all the tracks on the magneto-optical disc 13. When the magneto-optical disc 13 is an A-type, the second magnetic field generator serves as a biasing magnetic field generator that is capable of generating a direct magnetic field having the intensity of about “300” oersted. Accordingly, a bar shaped permanent magnet can preferably be used for the second magnetic field generator. However, since the demanded intensity of the magnetic field is small, an electromagnet can also be used for the second magnetic field generator. The distance between the second magnetic field generator and the magneto-optical disc 13 is preferably about “50” microns.

Moreover, when the disc media is based upon MSR the polarity of the magnetic field must be changed corresponding to the recording and the erasing operation of data, an electromagnet 1 is preferably used as the second magnetic field generator. When the magneto-optical disc 13 is the C-type, the second magnetic field generator is used for reversing the magnetization in the non-marked portions on the magneto-optical disc where the coercive force is small. Thus, a bar shaped permanent magnet or an electromagnet can preferably be used as the second magnetic field generator. Moreover, when the intensity of the magnetic field needs more than “2” kilooersted, a permanent magnet material or magneto-optical disc media's substrate is to be made from a rare-earth material.

In addition, a second embodiment of a magneto-optical disc apparatus of this invention requires a first magnetic field generator for generation an intense magnetic field and a second magnetic field generator for generating a weak magnetic field. On the other hand, in the magneto-optical disc apparatus according to the second embodiment, the magnetic field generators for the intense magnetic field and for the weak magnetic field are commonly integrated in the same magnetic field generator.

Furthermore, the other configurations of the magneto-optical disc apparatus according to the second embodiment can be substantially the same as those of the above mentioned magneto-optical disc apparatus according to the first embodiment, so that the explanation of them are omitted. The kinds of magneto-optical disc media 13 used in the first (i.e., LIMDOW) and the second (i.e., MSR) embodiment correspond to the A-type, B-type, C-type, and D-type discs described with respect to the first embodiment. Both embodiments of the magnetic field generator are used for the A-type and C-type magneto-optical disc media, since the fixed magnetic field is used for reproducing the magneto-optical disc of A-type and C-type and the source for generating the magnetic field mounted in the magnetic field generator is the permanent magnet which can not change the direction of the magnetic field.

Moreover, in both embodiments a plurality of magnetic poles can appear on the LIMDOW or MSR Magneto-Optical Microhead Array Chip's housing surface 4. For example, a plurality of two bar shaped permanent magnets can be mounted inside the molded housing block 4 of the Magneto-Optical Microhead Array Chips. One magnetic pole, for example, could be disposed in a manner to apply a magnetic field on a position of laser light-beam irradiation on the magneto-optical disc 13. When the intensity of the magnetic field due to the magnetic pole is Hb and the intensity of the initializing magnetic field due to the magnetic pole is Hi, the intensity Hb and Hi are set to be Hb<Hi.

In another embodiment, two permanent magnets respectively having different magnetization are prepared with one having the weaker magnetization being disposed at the position of the magnetic pole of the other. In another embodiment, for reducing the intensity of the magnetic field Hb by a magnetic pole, a leg of the permanent magnet being disposed on the side of the magnetic pole is largely hollowed from the housing surface 4 than a leg disposed on the side of the other magnetic pole.

Moreover, FIG. 1 shows the plan view of the magnetic field generator 1, 4 in which a permanent magnet and an electromagnet are mounted. The magnetic field generator 1, 4 shown in FIGS. 1, 2, and 3 is used for the magneto-optical disc of B-type. Wherein, by changing the polarity of the electromagnet the biasing magnetic fields for a recording and an erasing operation of the data can be generated. The reproducing magnetic field is also generated by the electromagnet in reproducing operation of the data. The electromagnet is disposed so as to apply the biasing magnetic field in erasing the data and the reproducing magnetic field in reproducing the data at a position of the laser light-beam irradiation, which occurs on the magneto-optical disc media 13.

As mentioned above, the magneto-optical disc apparatus according to the second embodiment can generate a plurality of magnetic fields about respective A-type, B-type, C-type, and D-type of magneto-optical disc media with only one magnetic field generator 11. Thus, a more compact magneto-optical disc apparatus can be provided. Especially, the electromagnet 26 mounted inside the magnetic field generator 11 as shown in FIGS. 1, 2, and 3 is very compact, so that the consuming of the electric power becomes very small compared to that of a conventional apparatus using a large fixed electromagnet.

Furthermore, in the above-mentioned first and second configurations, the configurations or shapes of the permanent magnet and/or the electromagnet are not restricted in the embodiment shown in the figures. The polarity of the magnets shown by symbols of ‘S’ and ‘N’ in the figures are conveniently used, and the polarity of the magnet can be changeable in response to the different configurations or different kinds of magnetic layers that comprise the magneto-optical disc media used in the magneto-optical disc apparatus of this present invention. The invention may be embodied in other specific forms without departing from the spirit and scope thereof, but the preferable embodiment uses a disc media that employs a permanent rare-earth magnetic material internally; thus eliminating the use of an external electromagnet for the LIMDOW embodiment, while eliminating the use of an external permanent magnet for the MSR embodiment of the LIMDOW and MSR Magneto-Optical Microhead Array Chip Hard Disk Drive.

Moreover, a LIMDOW and MSR Magneto-Optical Microhead Array Chip Hard Disk Drive's unit-assembly will typically use data-storage disk-platters 13 (FIGS. 1, 2, and 3) to store various kinds of information, where the beforementioned disk-platters are constructed as double-sided, multi-layered, and circular-shaped disk structures.

Furthermore, the wavelength X of a readout beam to be used in the present invention is preferably at a level of from “630” to “800” nanometers. Usually, a wavelength of e.g. “780”, “680”, or “630” nanometers is employed. The substrate, which is preferably employed in the present invention, is generally reflective to a recording and readout beam, such as a highly reflective substrate, which is made from a single piece of thermally anisotropic liquid crystal polymer, glass, or Invar alloy material coated with a reflective material like “TiAlCo-B”, which is then used to reflect laser-light produced by lasers located within the LIMDOW or MSR Magneto-Optical Microhead Array Chips. On the substrate, land/groove tracks for servo can be formed; wherein each of the land and the groove of the land/groove track have a substantially flat region. To make the readout signals from the land and the groove to be equal, the widths of the flat regions are equal.

In addition, because rare-earth materials oxidize easily, destroying the rare-earth material's ability to record, a material coating that protects the rare-earth recording material from oxidation is employed; e.g., Silicon-Nitride, Aluminum-Nitride, Silicon-Carbide, Tantalum-Oxide, Zinc-Sulfide, or Zinc-Selenium is preferable. It is particularly preferable to employ Si-Nitride, where the nitrogen content is less than the stoicheometrical compositional ratio (i.e., Si₃N₄), which also provides a high refractive index, while the nitrogen content is at an atomic-ratio of “0.6” to “1.0” relative to “1.0” of Si. Further, to prepare a Si₃N₄ coating, it is preferred that a reactive sputtering of a Silicon target is carried out in a mixture of inert gas and nitrogen to cause a layer of (SiN) “Silicon-Nitride” to form upon the reflective substrate. The nitrogen content can be controlled by adjusting the mixing ratio of nitrogen to the inert gas (usually Argon) or the pressure during sputtering process.

Moreover, when the readout wavelength X is “680” nanometers and the refractive index N of the interference layer is “2.4”; the thickness d of the interference layer should be from 59.0- to 94.4-nm. The magnetic layer should preferably be made of an alloy of rare-earth metal and transition metal, and from the viewpoint of the recording sensitivity or the production cost its thickness should preferably be about 300-nm. Further, in the case of LIMDOW, the magnetic layer, may for example, comprise of a group of six layers:

i.) A readout layer;

ii.) A memory layer;

iii.) A control layer;

iv.) A writing layer;

v.) A switching layer; and

vi.) An initializing layer or substrate.

While, in the case of MSR, the magnetic layers, may for example, comprise of a group of three layers:

i.) A readout layer;

ii.) A switching layer; and

iii.) A writing layer.

The overall thickness of the magnetic layer, when the wavelength is “680” nanometers, should be from 44.2 to 102.0-nm. To prevent oxidation of the magnetic layer, it is preferred to provide a protective layer made of a dielectric material that is sputter deposited upon the magnetic layer. As the protective layer, an oxygen free dielectric material such as SiN, AlN, Tantalum-Oxide, or Silicon-Carbide is preferably employed. If the thickness of the protective layer is too thick, however, the productivity tends to be poor, and the recording sensitivity tends to be low.

Accordingly, the thickness of the protective layer is from 20- to 80-nm, more preferably from 30- to 70-nm. It is also possible to provide a metal layer via a dielectric layer or a dielectric layer via a metal layer. To provide a metal layer that serves to provide a role as a heat dissipation layer, whereby it is possible to obtain an effect of improving the recording power margin. It is preferred to form an organic protective layer in a thickness of a few micrometers on the protective layer by e.g. spin coating. A disk provided with these layers may be used alone, or two such disks, which may be used in a laminated state. The warpage of the disk media is preferably at most 3.0-mrad at the maximum; more preferably, it is at most 2.5-mrad. To reduce the warpage, it is preferred to use two disks in a laminated state. Further, in the case of a substrate made from a composite ceramic/rare-earth permanent magnetic material or a composite liquid crystal polymer/rare-earth permanent magnetic material, the stress of the interference layer, the writing layer, or the protective layer may be eliminated.

Moreover, as the present invention is described in further detail with reference to examples it should be understood that the present invention is by no means restricted to such specific examples only.

In addition, a first embodiment of a magneto-optical recording medium according to the present invention has a bias magnetic layer or substrate that generates a magnetic field in a recording mode, where binary-level information is written into the second layer. Hence, this recording medium can be operated without an external bias magnetic field that has been necessary in the prior art. This embodiment may include that a rare-earth element/transition metal alloy layer in which the magnetization of sublattices of rare-earth elements dominant is provided between the first and second magnetic layers. Hence, a magneto-optical recording medium capable of direct overwriting by light modulation can be produced in a consistent manner.

In addition, a second embodiment of a magneto-optical recording medium according to the present invention may include a layer formed of a Nd containing rare-earth element/transition metal alloy film that is bound to the first magnetic layer by exchange force is formed adjacent the first magnetic layer. Hence, this embodiment is capable of direct overwriting by light intensity modulation and yet it yields satisfactory reproduction output even at shorter wavelengths.

In addition, a third embodiment of a magneto-optical recording medium according to the present invention may include a magnetic layer (i.e., the zeroth magnetic layer) consisting of alternate films of Pt or Pd and Co that is bound to the first magnetic layer by exchange force is formed adjacent the first magnetic layer. Hence, this embodiment is capable of direct overwriting by light intensity modulation and yet it yields satisfactory reproduction output even at shorter wavelengths.

In addition, a fourth embodiment of a magneto-optical recording medium according to the present invention may have the fourth layer of a prior art version divided into two layers of different composition. The required bias magnetic field is accordingly reduced and the fourth layer consisting of two sub-layers is more stable than the conventional fourth layer during illumination with P_{H}.

Moreover, the first embodiment of the present invention's disc media is based upon a nonmagnetic layer, which is used for blocking the exchange force acting between two adjacent magnetic layers and a bias magnetic layer. Like the fourth layer, the bias magnetic layer has such a large coercive force and high Curie point that it will not experience reversal of magnetization during recording or reproduction. After film formation, the bias magnetic layer is magnetized with an electromagnet or by some other means, in order to orient the magnetization of TM in such a way that it is directed downward. This direction of magnetization will thereafter be retained almost indefinitely.

### MEDIA EXAMPLE 1

Layers having the following thicknesses and compositions were superposed:

i.) First layer: Tb₂₂(Fe₉₀Co₁₀)₇₈, 500 Angstroms;

ii.) Second layer: (Gd₃Tb₇₀)₂₅(Fe₇₀Co₃₀)₇₅, 1000 Angstroms;

iii.) Third layer: Tb₁₈(Fe₉₅Co₅)₈₂, 100 Angstroms;

iv.) Fourth layer: Tb₂₅Co₇₅, 400 Angstroms;

v.) Nonmagnetic layer: SiN, 50 Angstroms;

vi.) Bias layer: Tb₂₆Co₇₃, 2000 Angstroms.

Moreover, the first to the fourth magnetic layers were virtually the same as in the prior art version described in the prior art section of this patent application. The bias magnetic layer was magnetized in opposite direction to the fourth magnetic layer but the exchange force acting between them was blocked by the nonmagnetic layer, so they could retain their directions of magnetization in a stable manner. The mechanism of overwriting in this medium is essentially the same as in the prior art version except that the external bias magnetic field applied in State “6” (i.e., in writing mode) is replaced by the magnetic field generated by the bias magnetic layer itself.

Moreover, the mechanism by which a magnetic field is generated from the bias magnetic layer is described below. At room temperature, the bias magnetic layer is RE dominant, the magnetization of TM is directed downward, so the overall magnetization is directed upward. Upon illumination with a laser light-beam, a temperature profile develops in which the temperature of the medium is the highest at the center of the beam spot and gradually approaches room temperature with increasing distance from the center of the beam spot. At the temperature around the center of the beam spot, TM is dominant and RE becomes increasingly dominant as the distance from the center of the beam spot increases.

Obviously, the generated magnetic field is directed downward in areas near the center of the beam spot and it serves as an effective substitute for the conventional source of generating an external bias magnetic field. Thus, according to the present invention, light modulated overwriting could be accomplished without an external magnetic filed, or sources of generating an external bias magnetic field.

### MEDIA EXAMPLE 2

The nonmagnetic layer used in “Example 1” could also be formed of a dielectric material such as SiO₂. Instead of forming a separate nonmagnetic layer, the following approach could be taken: after the first to the fourth layers were formed, the sample could be taken out of the film forming apparatus and exposed to the ambient atmosphere so as to oxidize the surface of the fourth magnetic layer and, thereafter the bias magnetic layer could be formed next. In this way, the exchange force acting between the fourth magnetic layer and the bias magnetic layer would be blocked by the oxidized surface of the fourth magnetic layer and satisfactory overwriting operations could be performed. Moreover, the medium could comprise a substrate comprised from glass, Invar, ceramic, or a composite of liquid crystal polymer, all of which, would be overlaid with four magnetic layers that are bound together by exchange force, with a fifth magnetic layer being inserted between the first magnetic layer and the second magnetic layer. In the example described below, the first magnetic layer, the fifth magnetic layer, and the second magnetic layer were successively formed on a substrate by material sputtering.

### MEDIA EXAMPLE 3

i.) Substrate 1.2-mm thickness glass substrate with the groove Dielectric layer Si₃N₄;

ii.) First magnetic layer ternary TbFeCo amorphous alloy Tb₂₂Fe₆₉Co₉, 600 Angstroms;

iii.) Fifth magnetic layer binary GdFe amorphous alloy Gd₂₅Fe₇₅, 50 Angstroms;

iv.) Second magnetic layer quaternary GdDyFeCo amorphous alloy Gd₈Dy₁₇Fe₆₀Co₁₅, 1000 Angstroms;

v.) Third magnetic layer ternary TbFeCo amorphous alloy Tb₁₈Fe₈₂Co₁₅, 200 Angstroms;

vi.) Fourth magnetic layer binary TbCo amorphous alloy Tb₃₀Co₇₀, 400 Angstroms;

vii.) Protective layer Si₃N₄.

### MEDIA EXAMPLE 4

i.) A 1.2-mm thickness glass substrate with a grooved dielectric layer of Si₃N₄;

ii.) Zeroth magnetic layer quaternary NdTbFeCo amorphous alloy Nd₁₀Tb₁₀Fe₄₀Cp₄₀, 100 Angstroms;

iii.) First magnetic layer ternary TbFeCo amorphous alloy Tb₂₂Fe₆₉Co₉, 600 Angstroms;

iv.) Second magnetic layer quaternary GdDyFeCo amorphous alloy Gd₈Dy₁₇Fe₆₀Co₁₅, 1000 Angstroms;

v.) Third magnetic layer ternary TbFeCo amorphous alloy Tb₁₈Fe₈₂, 200 Angstroms;

vi.) Fourth magnetic layer binary TbCo amorphous alloy Tb₃₀Co₇₀, 400 Angstroms;

vii.) Protective layer Si₃N₄.

### MEDIA EXAMPLE 5

i.) A 1.2-mm thickness glass substrate with a grooved dielectric layer of Si₃N₄;

ii.) Zeroth magnetic layer laminated Pt/Co magnetic film Pt (20 Angstroms)/Co (5 Angstroms) thickness, 150 Angstroms;

iii.) First magnetic layer ternary TbFeCo amorphous alloy Tb₂₂Fe₆₉Co₉, 600 Angstroms;

iv.) Second magnetic layer quaternary GdDyFeCo amorphous alloy Gd₈Dy₁₇Fe₆₀Co₁₅, 1000 Angstroms;

v.) Third magnetic layer ternary TbFeCo amorphous alloy Tb₁₈Fe₈₂Co₉, 200 Angstroms;

vi.) Fourth magnetic layer binary TbCo amorphous alloy Tb₃₀Co₇₀, 400 Angstroms;

vii.) Protective layer Si₃N₄.

### MEDIA EXAMPLE 6

Layers having the following thicknesses and compositions were superposed:

i.) First layer: Tb₂₂(Fe₉₀Co₁₀)₇₈, 500 Angstroms;

ii.) Second layer: (Gd₃₀Tb₇₀)₂₅(Fe₇₀Co₃₀)₇₅, 1000 Angstroms;

iii.) Third layer: Tb₁₈(Fe₉₅Co₀₅)₈₂, 100 Angstroms;

iv.) Fourth layer 8 (I): Tb₁₈Co₈₂, 300 Angstroms;

v.) Fifth layer 9 (II): Tb₂₇Co₇₃, 100 Angstroms.

Moreover, the temperature of the area close to the center of the beam spot was a 300° Celsius, which corresponds to the maximum ultimate temperature that can be attained by illumination with P_{H}. The fourth magnetic layer in “Example 6” is RE dominant at room temperature and as the temperature increases, it makes a transition to the compensated composition and even to the TM dominant state. Hence, the overall magnetization is directed downward at room temperature and becomes directed upward as the temperature rises. Further, at elevated temperatures, the spurious magnetic field in the area near the center of the beam spot is directed upward. On the other hand, the fourth magnetic layer of the medium of “Example 6” is TM dominant at room temperature, so its magnetization is always directed upward at room temperature and above. The absolute value of magnetization in the hot area near the center of the beam spot is smaller than in the surrounding areas, with the spurious magnetic field in the hot area being directed downward.

As described above, the spurious magnetic field acting in the sub-layer 8 (I) is directed downward (in the same direction as the bias magnetic field) but in the sub-layer 9 (II) and the fourth layer, the spurious magnetic field is directed upward (in opposite direction to the bias magnetic field). The strength of the spurious magnetic field is proportional to the film thickness. the spurious magnetic field is obviously directed upward but in Example 6, the sub-layers 8 (I) and 9 (II) can be designed in such a way that the spurious magnetic fields that develop in those sub-layers cancel each other by adjusting their thicknesses. Therefore, the net spurious magnetic field that occurred within the magneto-optical recording medium of Example 6 was substantially zeroed.

In addition, there is another advantage of the embodiment under discussion. As already mentioned, the fourth magnetic layer in the magneto-optical recording medium has such a high Curie point and a large coercive force that it will not experience reversal of magnetization during recording. However, it has been found by experimentation that reversal of magnetization occurs in the fourth layer if it is illuminated with a very intense laser beam. Even if the laser beam applied is not very intense, reversal of magnetization can occur in the fourth magnetic layer if overwriting is repeated for more than 10₅ cycles. This phenomenon may be attributable to the ‘Storage Effect’ that occurs in the recording medium because of cyclic illuminations with laser light.

Moreover, in order to prevent the occurrence of magnetization reversal in the fourth magnetic layer due to the phenomena described above, the heat stability of that layer must be increased. In other words, it is necessary to provide the fourth layer with such a characteristic that no reversal of magnetization will occur in that layer even if it is illuminated with intense laser light. To this end, the fourth magnetic layer must have a large coercive force at elevated temperatures; namely, it must have a high compensation temperature. In order to increase the compensation temperature, it is desired that the composition of the fourth magnetic layer is RE dominant as much as possible at room temperature.

However, as is well known, the more RE dominant the composition of a layer is, the more rapidly the exchange force for binding to an adjacent layer will decrease. Obviously, it becomes difficult to attain ‘State 7’ if the exchange force acting between the fourth magnetic layer and the third magnetic layer decreases. The dual structure of the fourth magnetic layer is also very effective for solving the above-described problem. In this structure, the sub-layer 8 (I) which is TM dominant at room temperature is superposed on the third magnetic layer to increase the exchange force for binding to the latter and the sub-layer 9 (II) which is extremely RE dominant at room temperature is superposed on sublayer 8 (I) to increase the stability of the fourth layer at elevated temperatures.

Moreover, the CN ratio of the recording medium of “Example 6” deteriorated by no more than a few dB upon illumination with 20-mW laser light, and this demonstrates the marked improvement in the heat stability of the fourth layer having a dual structure. As described on the foregoing pages, the present invention relates to a magneto-optical recording medium that is capable of direct overwriting by light modulation and that comprises four magnetic layers superposed on a substrate, with individual magnetic layers being bound by exchange force. According to one embodiment, a fifth magnetic layer is provided on the top fourth magnetic layer without being bound to it by exchange force. This arrangement obviates the need to equip the recording medium with a source of generating an external magnetic field, whereby the construction of equipment can be simplified and easily reduced in size and thickness.

Moreover, according to another embodiment, an amorphous alloy layer in which the magnetization of sub-lattices of rare-earth elements is dominant is provided between the first and second magnetic layers. This arrangement is effective not only in reducing the exchange force acting between the first and second magnetic layers at temperatures near room temperature but also in permitting magneto-optical recording media to be fabricated in a consistent way. As a consequence, magneto-optical recording media capable of direct overwriting by light modulation that have improved characteristics can be manufactured at a higher production rate.

According to yet another embodiment, a layer made of a Nd containing rare-earth element/transition metal alloy film or a magnetic layer (i.e., a zeroth magnetic layer) consisting of alternate films of Pt or Pd and Co is provided adjacent the first magnetic layer in such a manner that they are bound to the first magnetic layer by exchange force. Having this arrangement, the recording medium of the present invention is capable of direct overwriting by light intensity modulation and yet it yields satisfactory reproduction output at shorter wavelengths. According to the embodiment, a fifth magnetic layer is provided over the fourth magnetic layer in such a manner that the two layers are bound to each other by exchange force. This arrangement is effective not only in reducing the external magnetic filed to be applied but also in increasing the durability of the medium under illumination with light of high output power.

In addition, the disk-platters are mounted upon a rotating spindle assembly 57 (FIG. 2), which is rotated “3,400” to “20,000” “Revolutions-Per-Minute” (RPM) by an in-spindle brushless DC Spindle-Motor 59 (FIGS. 2 and 3), relative to the beforementioned frame casting-base 12 (FIGS. 1, 2, and 3). Typically, the beforementioned Spindle-Motor is secured to an aluminum-alloy casting-base 12 (FIGS. 1, 2, and 3) with four motor mounting hex-screws 56 (FIGS. 2 and 3). In addition, the beforementioned Spindle-Motor 59 (FIGS. 2 and 3) has a rotor 57 (FIG. 2), which is flanged at the base, and a disk-platter axle, which is located at the center of the previously mentioned rotor 57 (FIG. 2).

In addition, a rotating flanged rotor housing is used to both position and firmly secure all of the beforementioned disk-platters, where each disk-platter has a disk-spacer 116 (FIG. 2) placed between each proceeded data-storage disk-platter installed. While, having a final data-storage disk-platter 13 (FIGS. 1, 2, and 3) secured into place with a rotor housing-cap 20 (FIGS. 1 and 2) and four-rotor housing-cap mounting hex-screws 17 (FIGS. 1, 2, and 3). Preferably, the Spindle-Motor bearings are formed as a part of the Spindle-Motor drive assembly 59 (FIGS. 2 and 3), and used to rotate the spindle-assembly 57 (FIG. 2) relative to the frame casting-base 12 (FIGS. 1, 2, and 3). The Spindle-Motor 59 (FIGS. 2 and 3) itself is mounted to the bottom-inside surface of the casting-base 12 (FIGS. 1, 2, and 3) with four motor mounting hex-screws 56 (FIGS. 2 and 3).

Furthermore, in the center of a rotor-housing's top bearing 18 (FIGS. 1, 2, and 3) is a Spindle-Motor's non-moving bearing-rod core 19 (FIGS. 1, 2, and 3), where a non-moving bearing-rod core 19 (FIGS. 1, 2, and 3) has its top-end threaded for a LIMDOW and MSR Magneto-Optical Microhead Array Chip Hard Disk Drive's housing-cover mounting screw-hole 19 (FIGS. 1, 2, and 3), which is used to secure a LIMDOW and MSR Magneto-Optical Microhead Array Chip Hard Disk Drive's housing-cover to the beforementioned casting-base 12 (FIGS. 1, 2, and 3). Preferably, there are “6” other threaded hex-screw holes 16 (FIGS. 1, 2, and 3) in a LIMDOW and MSR Magneto-Optical Microhead Array Chip Hard Disk Drive's casting-base 12 (FIGS. 1, 2, and 3), which are also used for the securing and sealing of a (i.e., not shown here) LIMDOW and MSR Magneto-Optical Microhead Array Chip Hard Disk Drive's housing-cover, which is used to cover and seal a LIMDOW and MSR Magneto-Optical Microhead Array Chip Hard Disk Drive's casting-base housing.

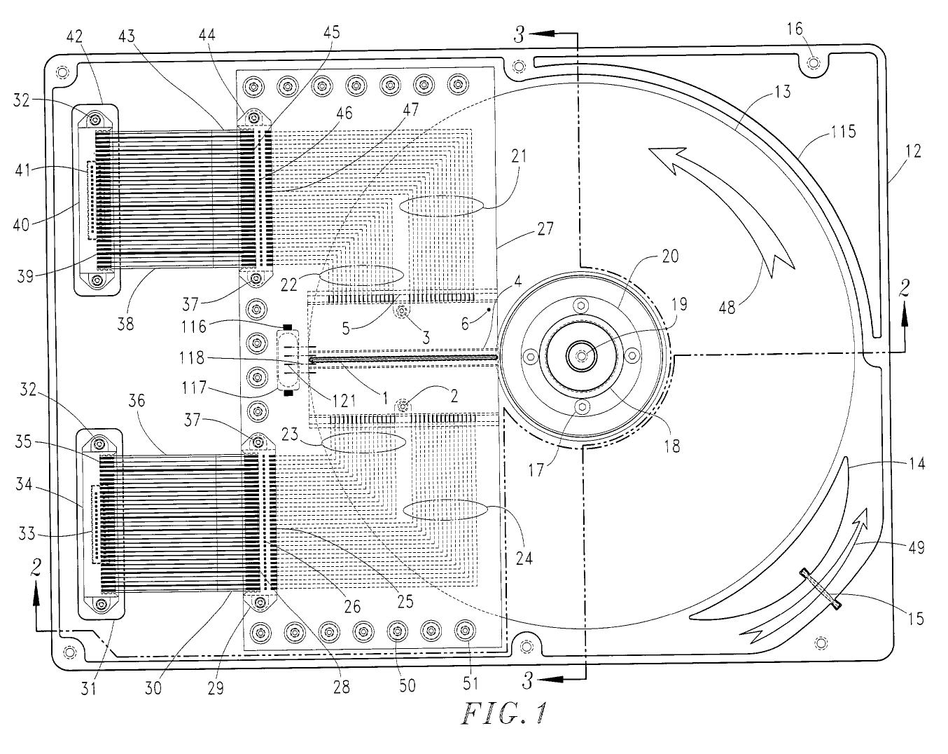

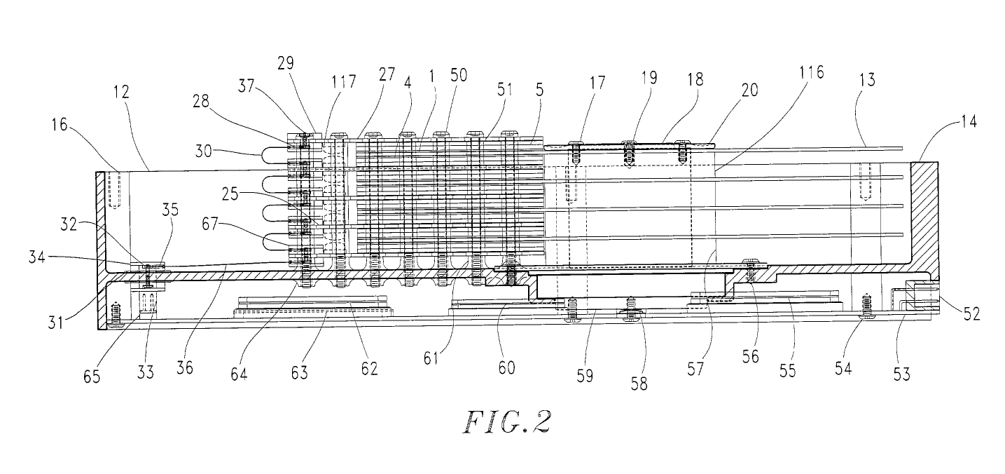

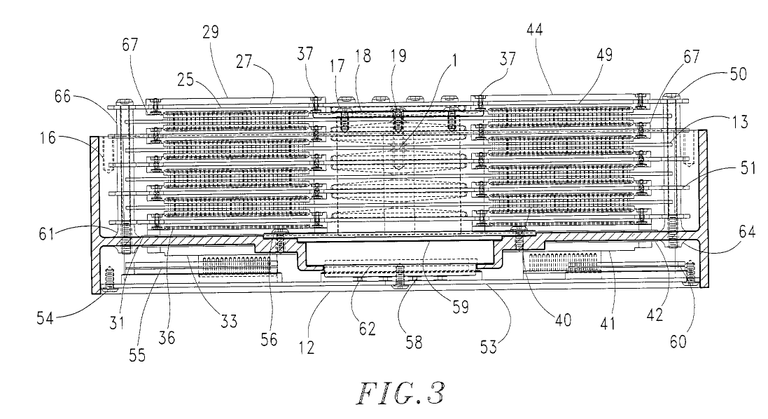

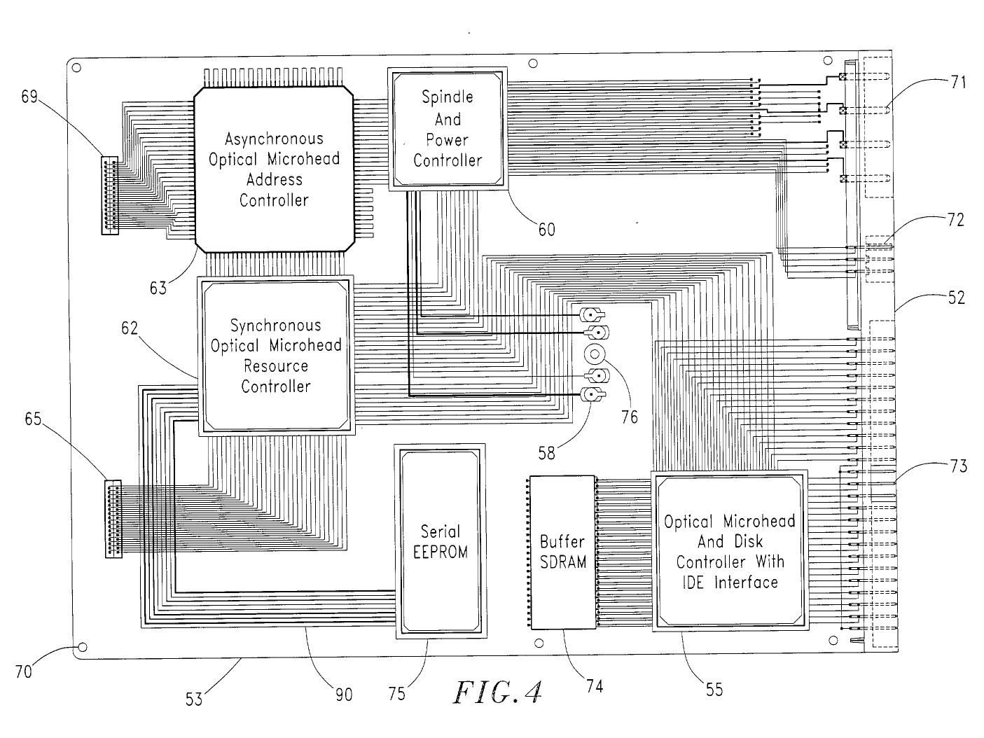

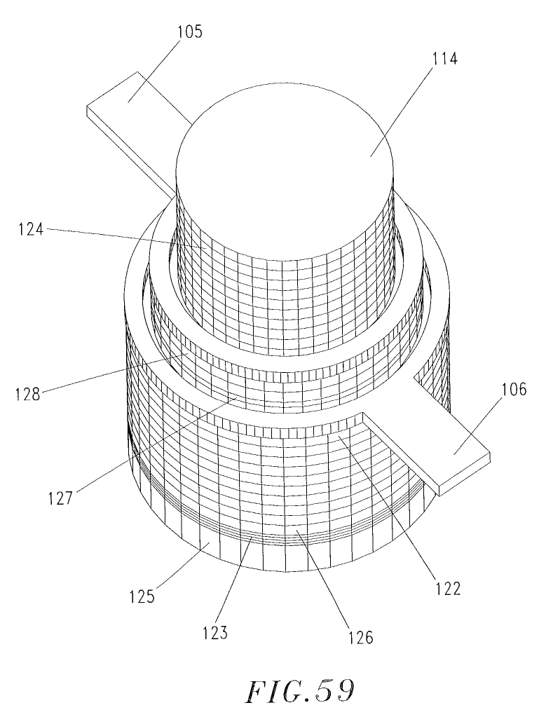

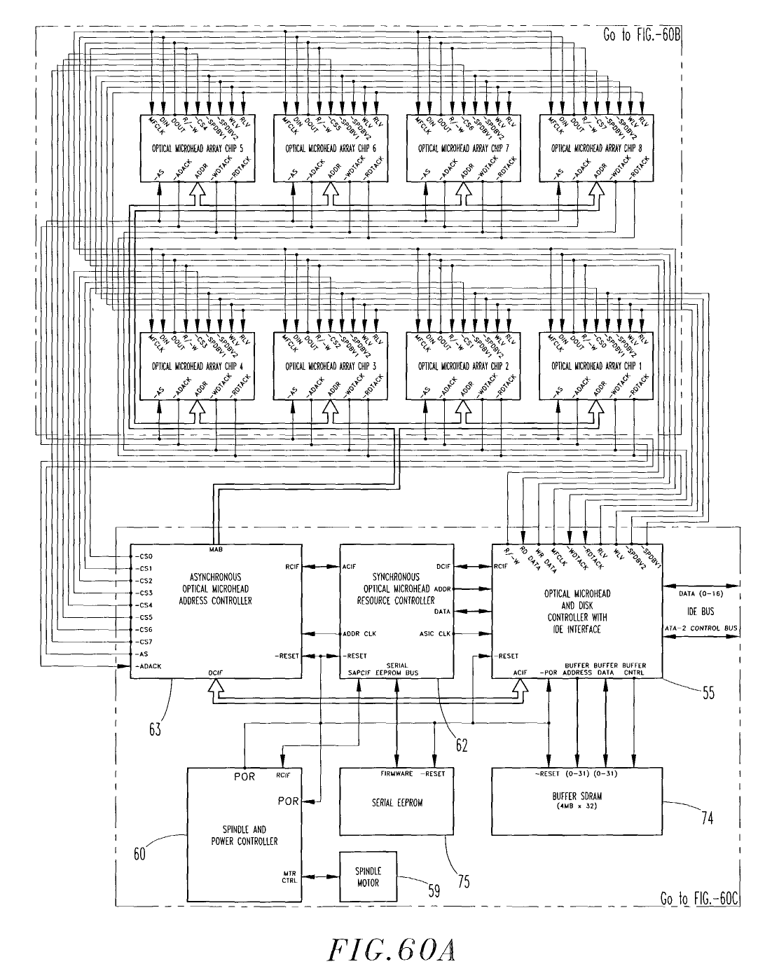

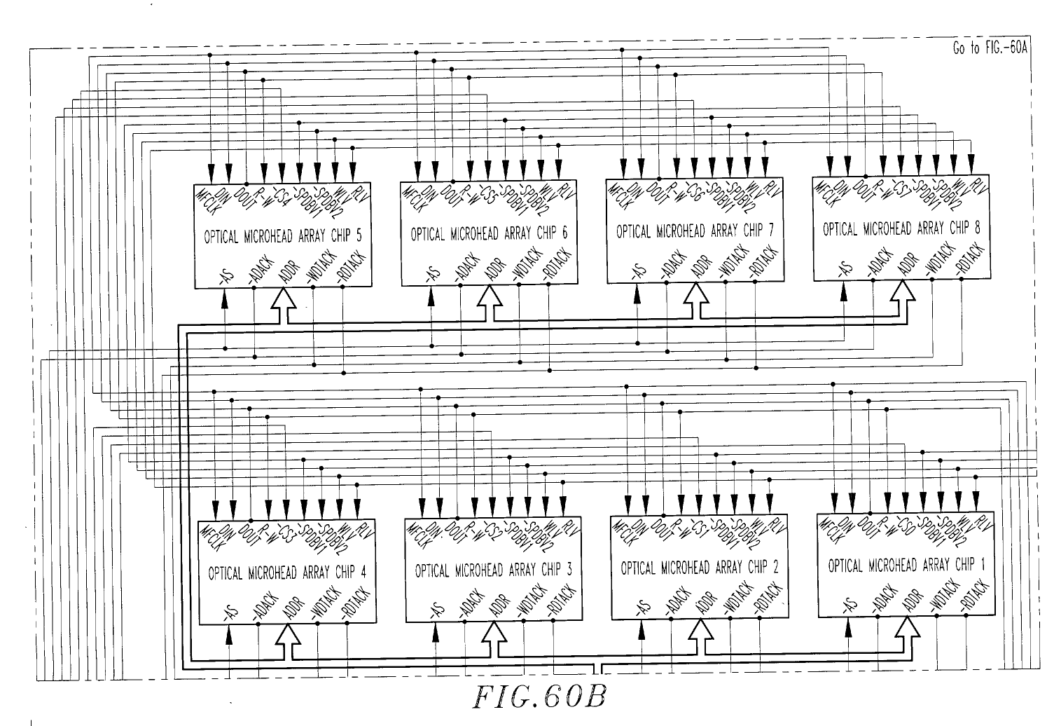

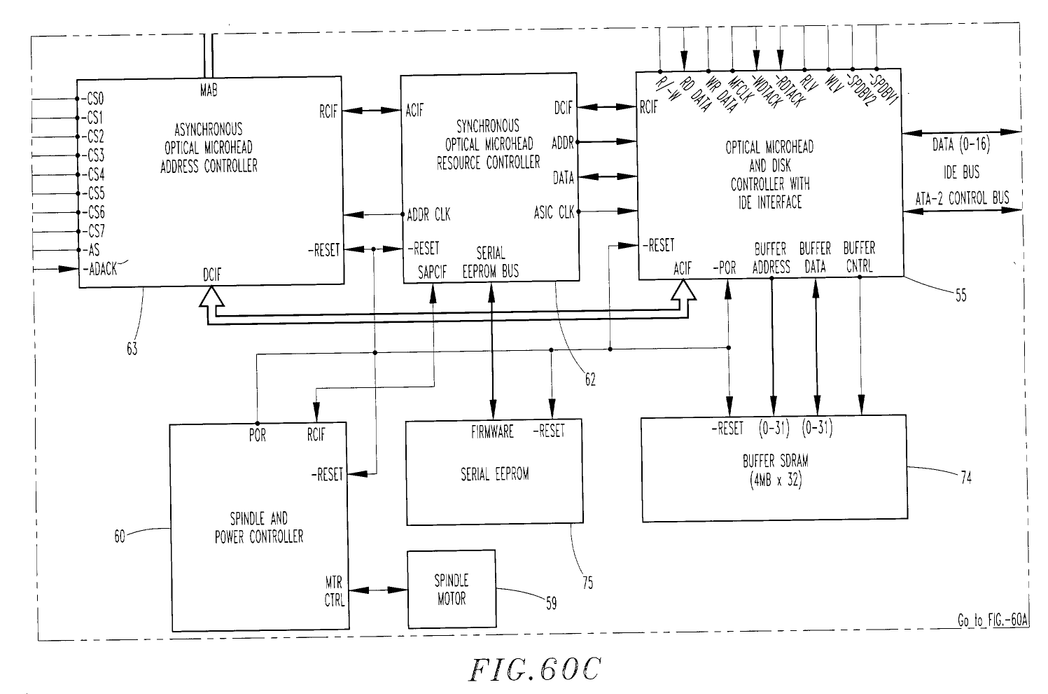

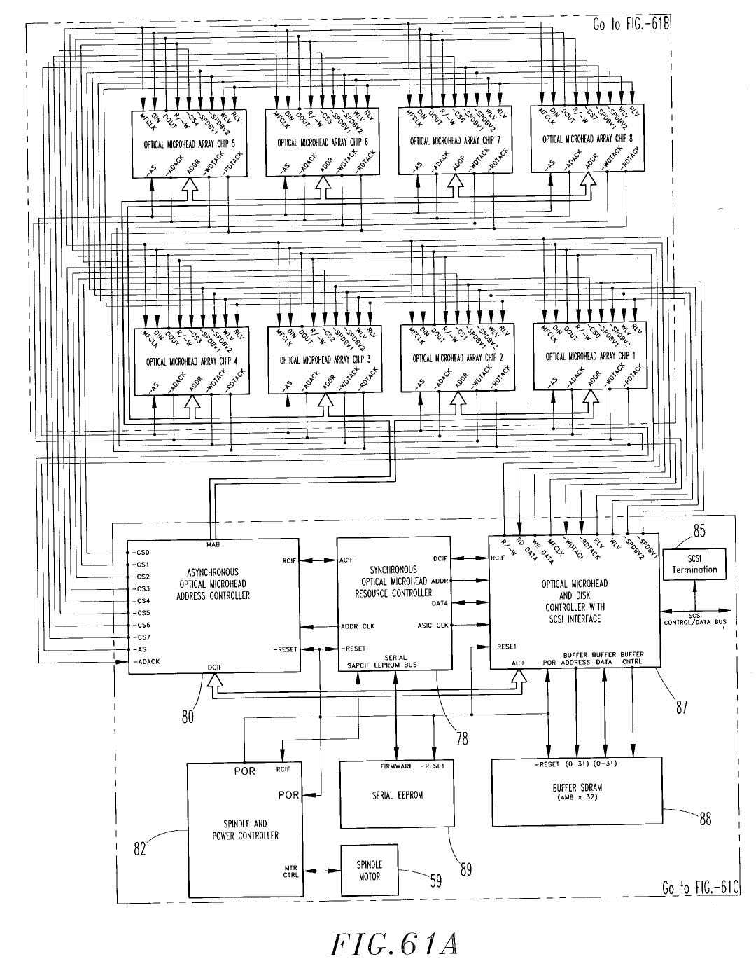

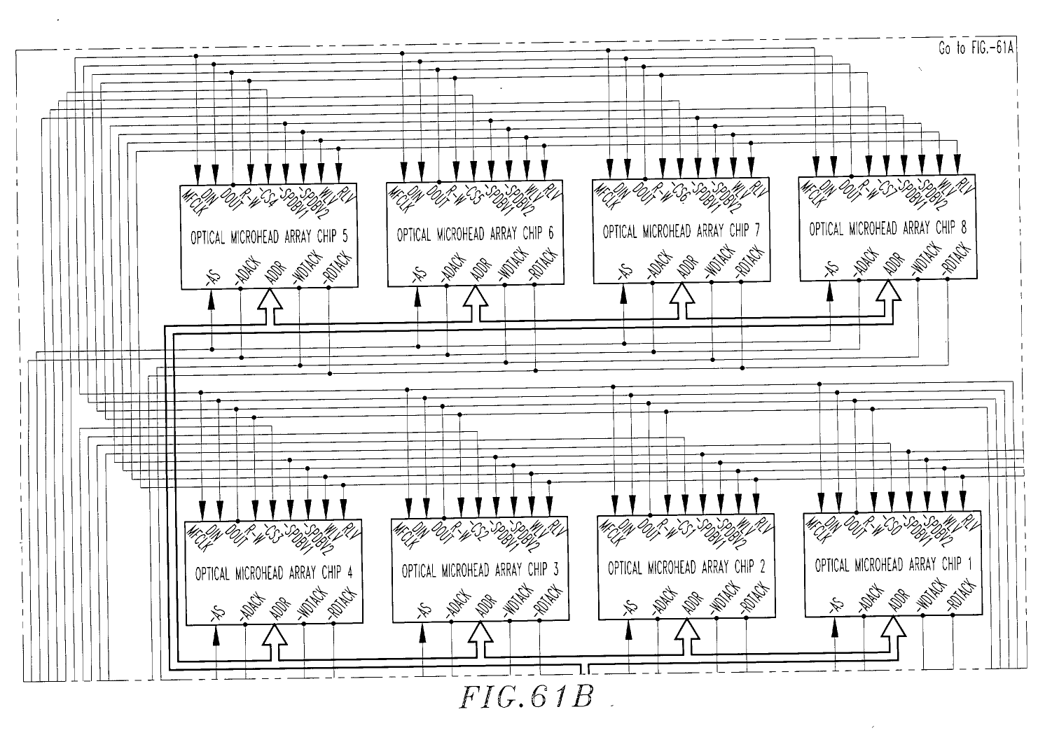

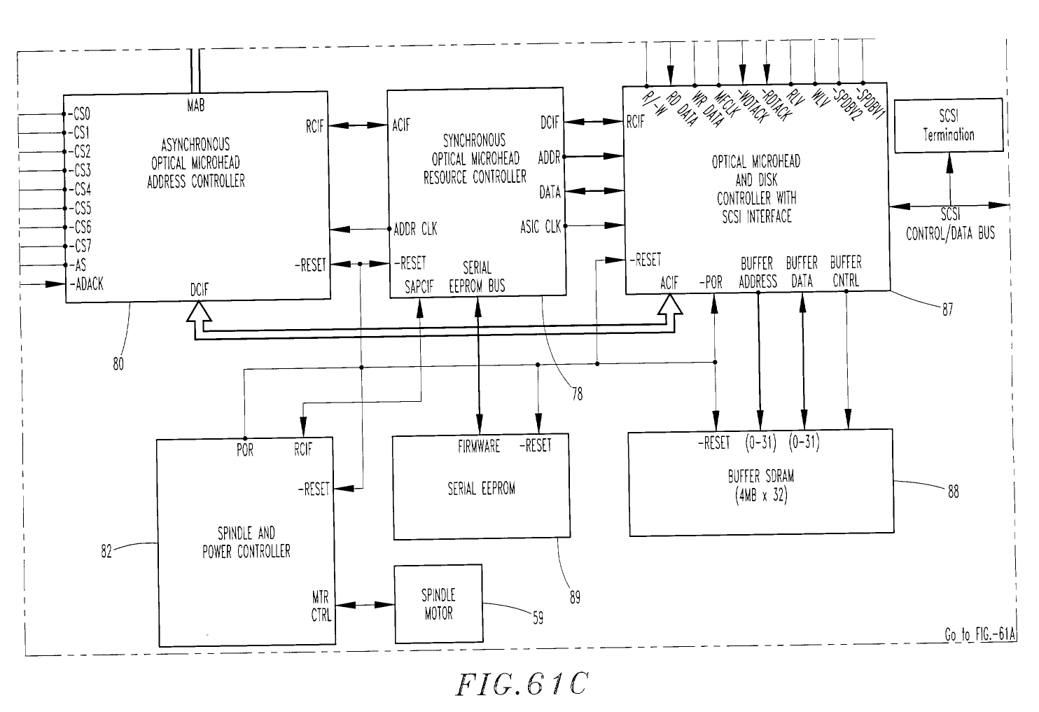

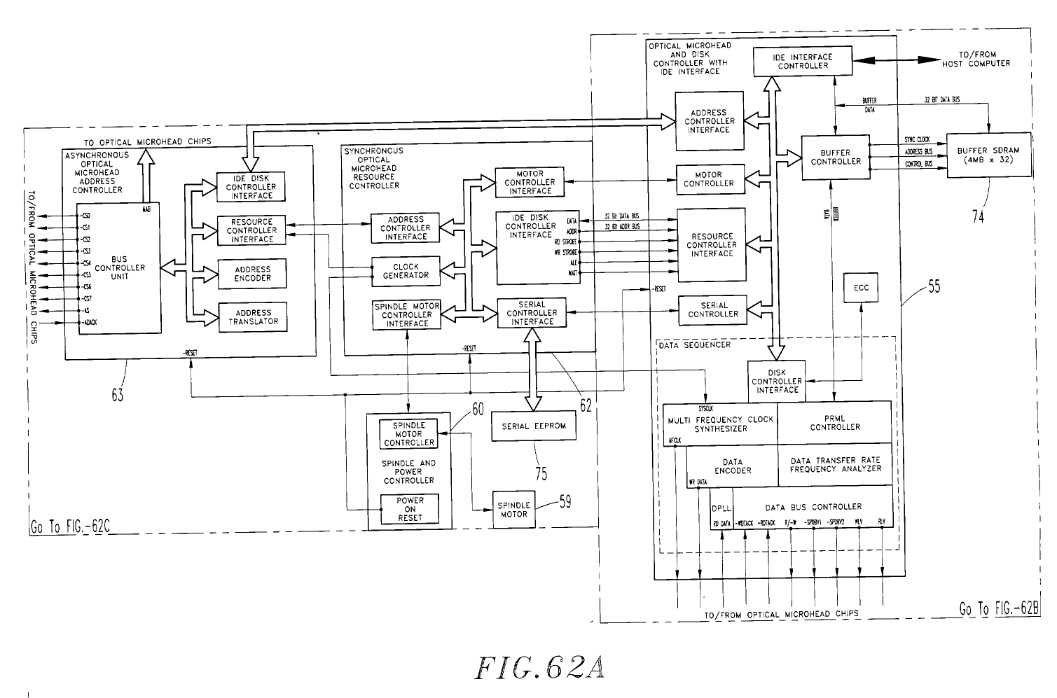

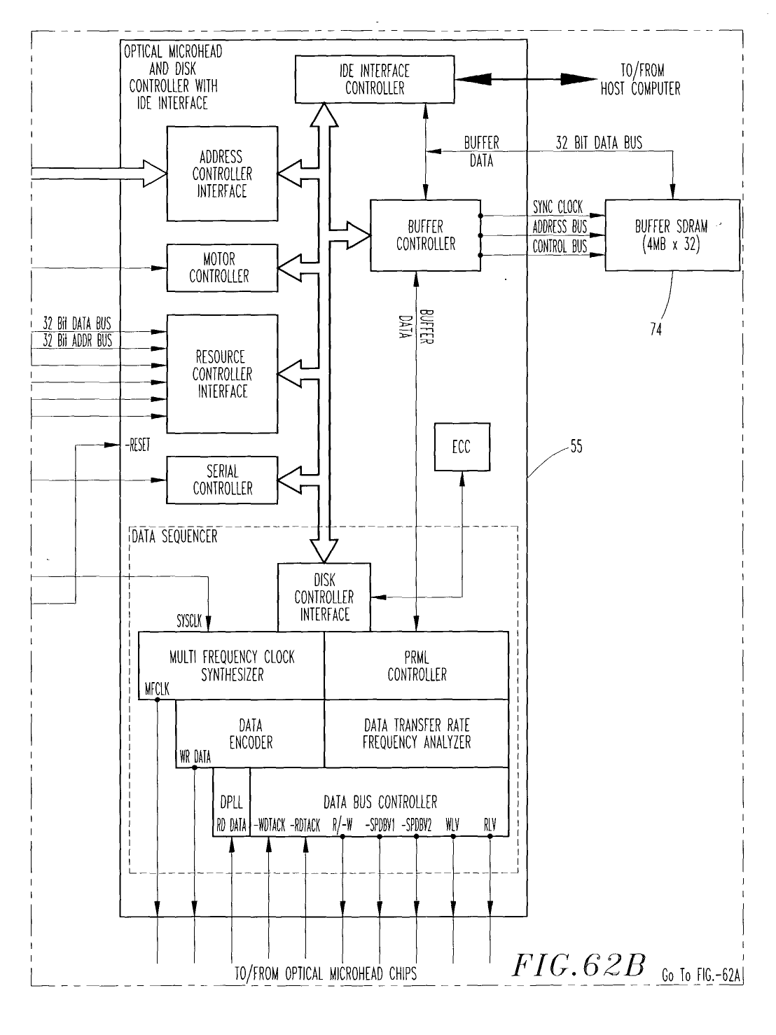

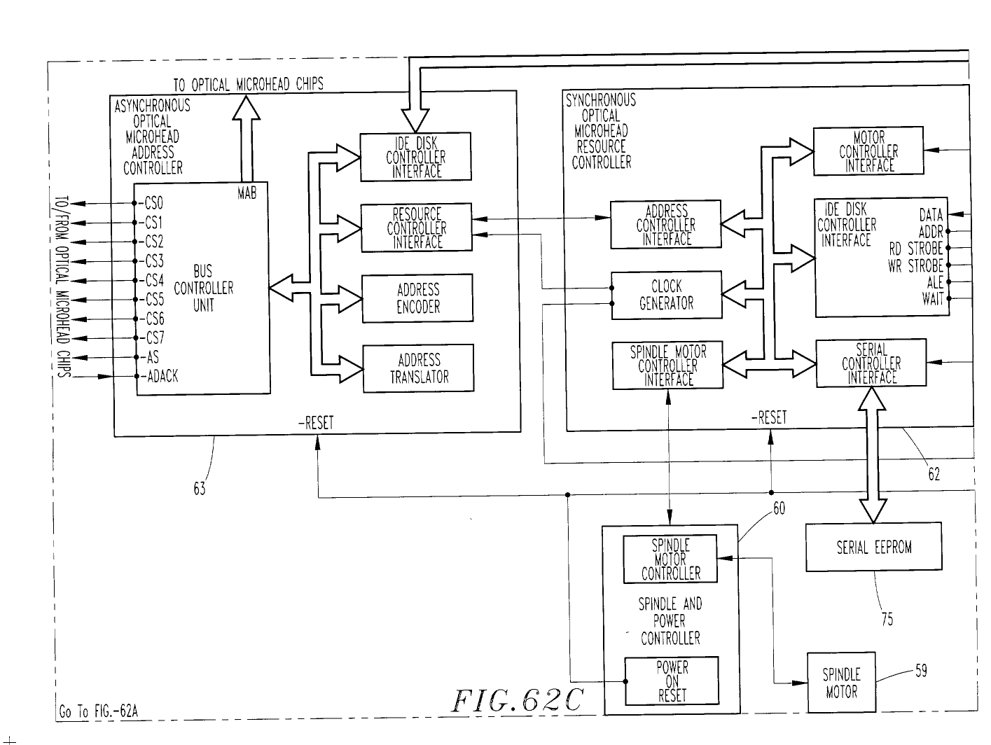

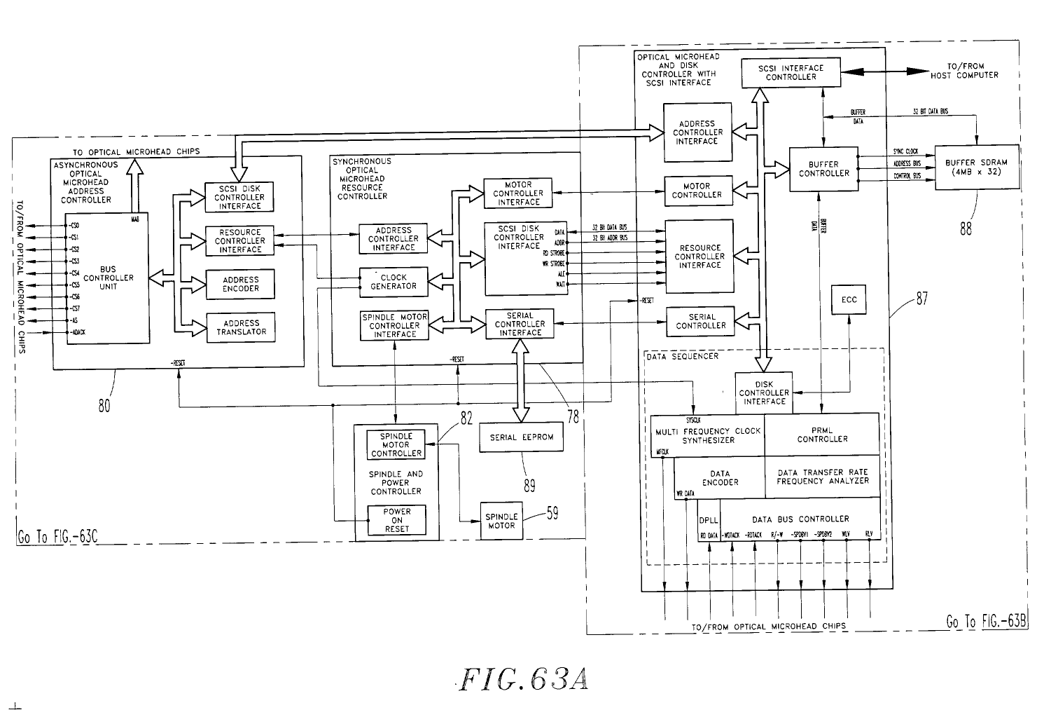

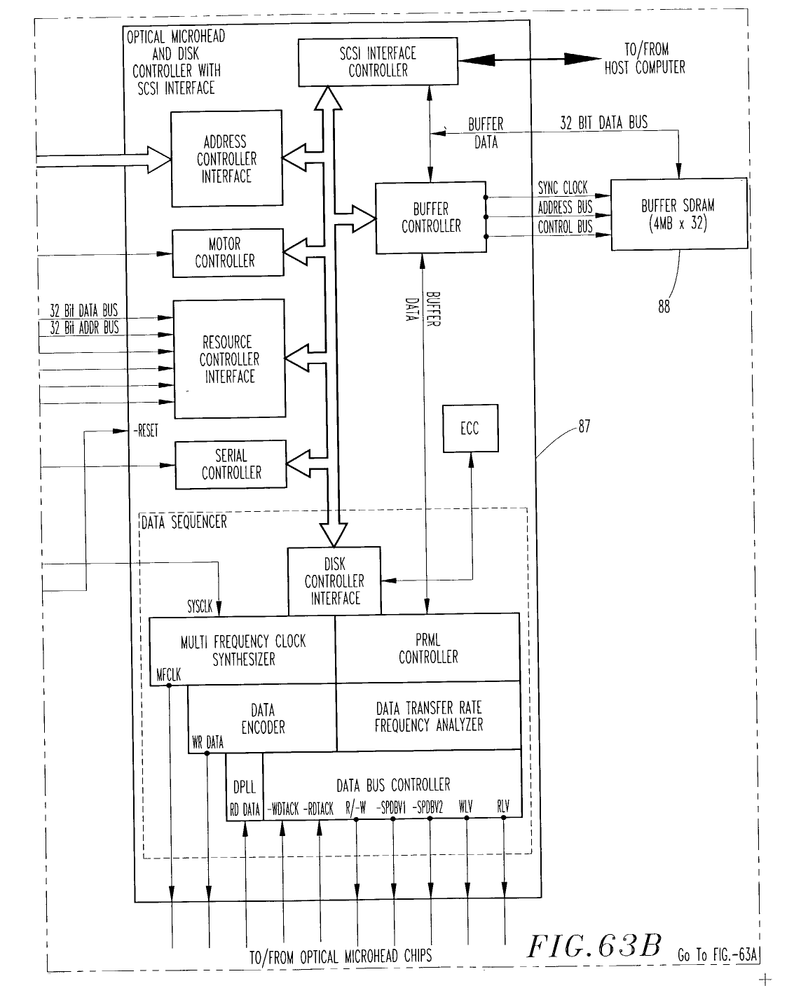

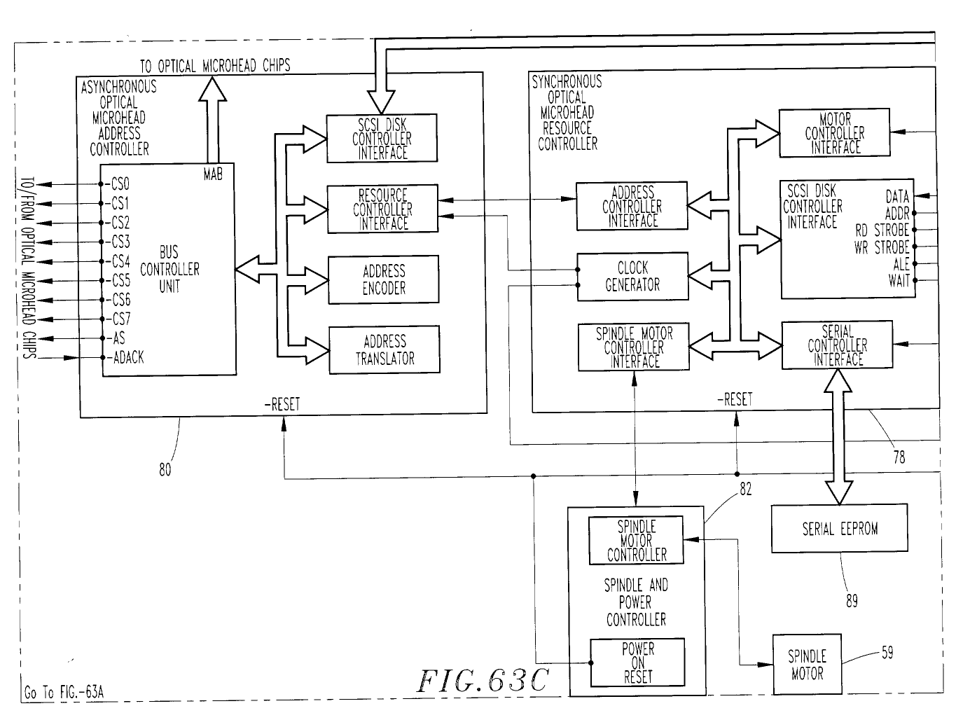

Furthermore, the beforementioned Spindle-Motor's driver-circuit, which is called the Spindle And Power Controller 60 (FIG. 4), 82 (FIG. 5), 60 (FIG. 60A), 60 (FIG. 60C), 82 (FIG. 61A), 82 (FIG. 61C), 60 (FIG. 62A), 60 (FIG. 62C), 82 (FIG. 63A), 82 (FIG. 63C) is provided to communtate e.g. with the three-phase windings of a LIMDOW and MSR Magneto-Optical Microhead Array Chip Hard Disk Drive's brushless Spindle-Motor 59 (FIGS. 2, 3, 60A, 60C, 61A, 61C, 62A, 62C, 63A, and 63C). Furthermore, “Hall-Sensors” (i.e., not shown here) are also provided to determine the position of the permanent-magnetic rotary-elements located within a rotor relative to the fixed windings and poles of the beforementioned Spindle-Motor 59 (FIG. 2), (FIG. 3). Typically, Hall-Sensors (i.e., not shown here) provide response-control information to a “Spindle And Power Controller” 60 (FIG. 4), 82 (FIG. 5), 60 (FIG. 60A), 60 (FIG. 60C), 82 (FIG. 61A), 82 (FIG. 61C), 60 (FIG. 62A), 60 (FIG. 62C), 82 (FIG. 63A), 82 (FIG. 63C). In addition, the previously mentioned Spindle And Power Controller's driver-circuit will also control the Hall-Sensors in a conventional fashion as well.

In addition, the final assembly of a LIMDOW and MSR Magneto-Optical Microhead Array Chip Hard Disk Drive is done in a contamination free “Clean Room” manufacturing facility. To provide the LIMDOW and MSR Magneto-Optical Microhead Array Chip Hard Disk Drive s with a contamination free environment a hard disk drive cover sealing-gasket provides an air-tight seal between a LIMDOW and MSR Magneto-Optical Microhead Array Chip Hard Disk Drive's casting-base 12 (FIGS. 1, 2, and 3) and its metal cast-aluminum (i.e., not shown here) housing cover. Sealing-gaskets will be installed during final assembly of the LIMDOW and MSR Magneto-Optical Microhead Array Chip Hard Disk Drive unit assemblies using “6” threaded hex-screws (i.e., not shown here).

Furthermore, to provide an environment that continues to be clean and free from air-contaminants; an internal air-filtering device is used 15 (FIG. 1) to filter the drive's internal air supply. Moreover, an orthographic plan-view drawing FIG. 1 shows the location of the beforementioned internal air-filtering device 15 (FIG. 1), which also displays internal airflow direction 49 (FIG. 1) with a direction indicating arrow. Indicating that the air flowing through the beforementioned air-filter 15 (FIG. 1) is moving in the same counterclockwise direction of rotation 48 (FIG. 1) as the data-storage disk-platters 13 (FIGS. 1, 2, and 3) of a LIMDOW and MSR Magneto-Optical Microhead Array Chip Hard Disk Drive does.

Moreover, the LIMDOW or MSR Magneto-Optical Microhead Array Chips that are used within a LIMDOW and MSR Magneto-Optical Microhead Array Chip Hard Disk Drive's unit-assembly are positioned very close to a LIMDOW and MSR Magneto-Optical Microhead Array Chip Hard Disk Drive's rotating disk-platter data-surfaces. Therefore, it is essential that the air circulation through LIMDOW and MSR Magneto-Optical Microhead Array Chip Hard Disk Drive s be kept free of dust, pollen, and other air-borne particles and contaminates, least they are trapped between a microhead array of a LIMDOW or MSR Magneto-Optical Microhead Array Chip and a disk-platter's data-surface, causing disk-platter data-surface damage and data-loss. Furthermore, when the LIMDOW and MSR Magneto-Optical Microhead Array Chip Hard Disk Drive s are in use the rotation of its installed disk-platters will force air through a LIMDOW and MSR Magneto-Optical Microhead Array Chip Hard Disk Drive's internal air-filter 15 (FIG. 1). Internal air-pressure within a LIMDOW and MSR Magneto-Optical Microhead Array Chip Hard Disk Drive's unit-assembly is shifted by a internal air-foil 14 (FIG. 1) from the outer-perimeter of its rotating disk-platters to a air-filter's 15 (FIG. 1) passage-way, where a constant stream of air is made to flow through a “0.3” micron air-filter 15 (FIG. 1).

Moreover, the beforementioned air-filter is installed into a slot lying between the upper right-hand corner of a LIMDOW and MSR Magneto-Optical Microhead Array Chip Hard Disk Drive's casting-base 12 (FIG. 1), and the beforementioned air-filter's air circulating airfoil air-scoop 14 (FIG. 1). Furthermore, during normal hard disk drive operation, while the disk-platters within a LIMDOW and MSR Magneto-Optical Microhead Array Chip Hard Disk Drive are rotating, the air-circulating airfoil air-scoop design 14 (FIG. 1) will also help a LIMDOW and MSR Magneto-Optical Microhead Array Chip Hard Disk Drive to keep cool.

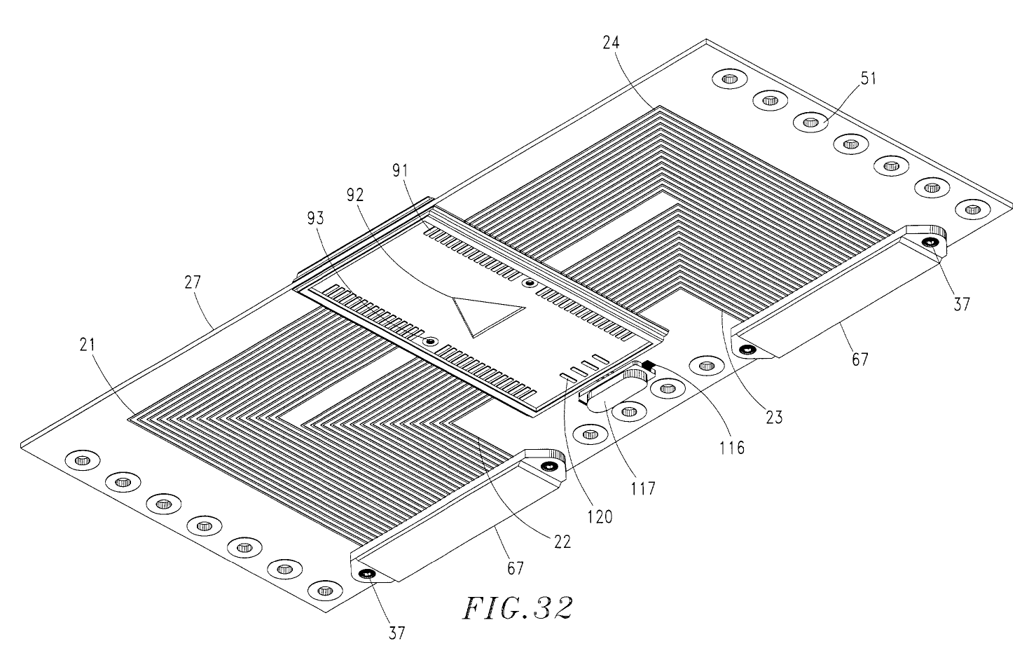

Another preferred, first, and basic embodiment, as illustrated in drawing FIGS. 1, 2, 3, 6, 9, 10, 29, 30, 31, 32, 33, 34, 35, 36, 37, and 38, shows how to execute the placement of the LIMDOW or MSR Magneto-Optical Microhead Array Chips. Moreover, positioned by specially designed chip-positioning circuit boards 27 (FIGS. 1, 2, 3, 6, 9, and 10). To insure rigid and stable placement of the beforementioned LIMDOW or MSR Magneto-Optical Microhead Array Chips, chip-positioning circuit boards need their core structures constructed from a rigid material, like “Titanium” or “Graphite Carbon Composite”. Furthermore, a chip-positioning circuit board's core structure 27 (FIGS. 1, 2, 3, 6, 9, and 10) has two sides, where each side of every chip-positioning circuit board would have eighteen embossed bolt-flanges; a total of thirty-six bolt-flanges 51 (FIGS. 1, 2, 3, and 6) for each chip-positioning circuit board's core structure. Moreover, each chip-positioning circuit board's thirty-six embossed bolt-flanges are created as raised surfaces; protruding “1/16” of one-inch in an outward direction, which is perpendicular to a chip-positioning circuit board's surface, which will later contain sixty-four copper-circuit trace-runs. Each embossed bolt-flange will have its top-surface area machined down and shaped into a bolt-flange with a high degree of flatness, which must be within an allowed tolerance of plus or minus “⅛” of one-micron.

Moreover, after each chip-positioning circuit board has its thirty-six embossed bolt-flanges machined down to a degree of flatness that is within their specified tolerances, a first-layer application of fiberglass insulation is applied to the outer surfaces of the chip-positioning circuit boards. The beforementioned first fiberglass insulation layer will provide fundamental electrical insulation for a chip-positioning circuit board's installed copper circuit trace-runs 21, 22, 23, 24 (FIGS. 1, 6, 29, 30, 31, 32, 34, 35, 36, and 37). Furthermore and only after the beforementioned fiberglass insulation has been applied to surfaces reserved for the future installation of a chip-positioning circuit board's copper circuit trace-runs, can installation of a chip-positioning circuit board's sixty-four copper circuit trace-runs proceed. Furthermore, installation of the beforementioned fiberglass insulation will both protect and isolate installed copper circuit trace-runs, not only from each other, but also from the metallic material used to construct a chip-positioning circuit board's core-structure.

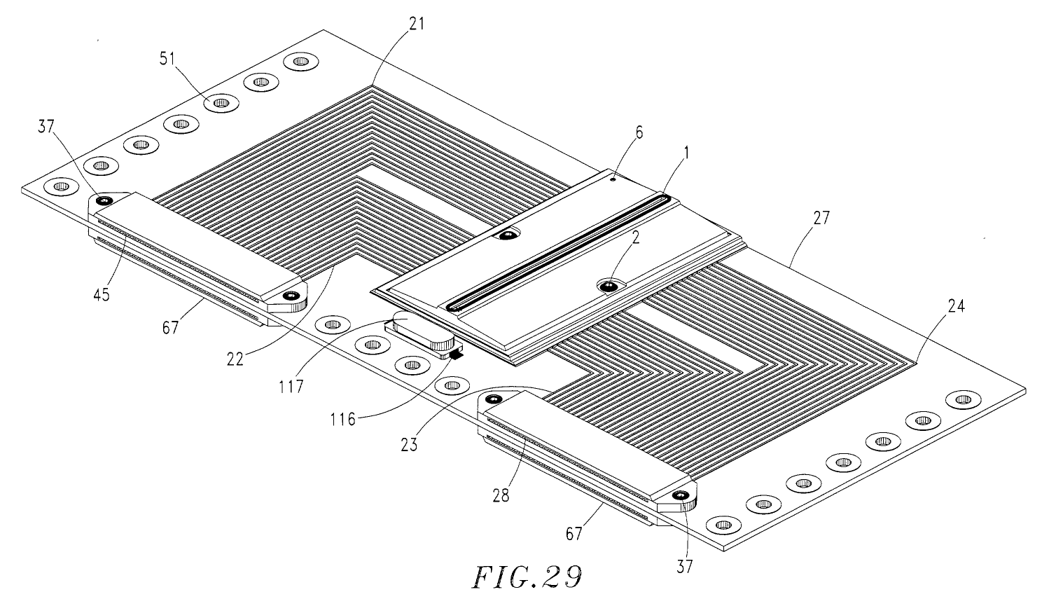

In addition, the beforementioned thirty-six embossed bolt-flanges 51 (FIGS. 1, 2, 3, and 6), which are passively used to install completed chip-positioning circuit boards into a LIMDOW and MSR Magneto-Optical Microhead Array Chip Hard Disk Drive's unit-assembly (FIG. 117) and, moreover will need to be free of dirt, fiberglass, or any other particulate matter. Moreover, to explain this further, if, during a LIMDOW and MSR Magneto-Optical Microhead Array Chip Hard Disk Drive's final assembly, illustrated by FIG. 117, any particulate matter were to be left on any chip-positioning circuit board's embossed bolt-flange mounting surfaces 51 (FIGS. 1, 2, 3, and 6), the installation and placement of chip-positioning circuit boards, as illustrated by FIGS. 29, 30, 31, 32, 33, 34, 35, 36, 37, and 38, and not yet installed would, after installation become misalign while in their respective LIMDOW and MSR Magneto-Optical Microhead Array Chip Hard Disk Drive's unit-assembly (FIG. 117), adversely affecting the respective LIMDOW and MSR Magneto-Optical Microhead Array Chip Hard Disk Drive's overall performance.

Therefore, after applying the beforementioned fiberglass insulation to a chip-positioning circuit board's outermost surfaces the thirty-six embossed bolt-flanges 51 (FIGS. 1, 2, 3, and 6) of the chip-positioning circuit boards must be cleaned and made fiberglass free.

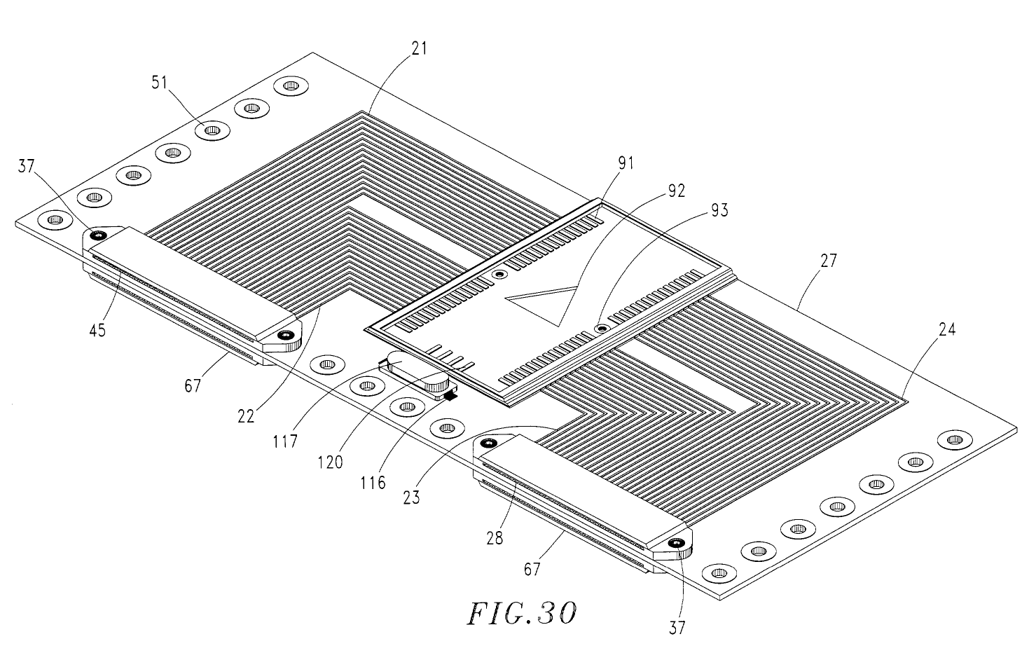

In addition, surface-mounted chip-socket 5 (FIGS. 1, 2, and 6), which are used by chip-positioning circuit boards, illustrated by FIGS. 29, 30, 31, 32, 33, 34, 35, 36, 37, and 38, to install, position, and connect LIMDOW or MSR Magneto-Optical Microhead Array Chips (FIGS. 25, 26, 27, and 28) into a LIMDOW and MSR Magneto-Optical Microhead Array Chip Hard Disk Drive's unit-assembly (FIG. 117), while providing connectivity between them and installed copper circuit trace-run surfaces 21, 22, 23, 24 (FIGS. 30, 32, 35, and 37) of chip-positioning circuit boards, as illustrated in FIGS. 29, 30, 31, 32, 33, 34, 35, 36, 37, and 38.

In addition, and only after the installation of a chip-positioning circuit board's surface-mounted chip-socket 5 (FIGS. 1, 2, and 6) has been accomplished, can a final topcoat layer of insulating fiberglass be applied to a chip-positioning circuit board's outer-most surface areas 21, 22, 23, 24 (FIGS. 30, 32, 35, and 37) and, therein to its surface-mounted chip-socket's base-area perimeter 5 (FIGS. 1, 2, and 6), which will help to seal and secure a chip-positioning circuit board's surface-mounted chip-socket(s) 5 (FIGS. 1, 2, and 6) into their final position(s). While applying fiberglass to a chip-positioning circuit board and to a chip-positioning circuit board's surface-mounted chip-socket(s) 5 (FIGS. 1, 2, and 6) care must be taken to keep the beforementioned fiberglass insulation off any chip-positioning circuit board's embossed machined bolt-flange mounting surfaces 51 (FIGS. 1, 2, 3, and 6), and out of the contact-circuit areas 93 (FIGS. 30, 32, 35, and 37) of a chip-positioning circuit board's surface-mounted chip-socket(s) 5 (FIGS. 1, 2, and 6).

Moreover, contact-circuit areas 93 (FIGS. 30, 32, 35, and 37), which are used to connect installed LIMDOW or MSR Magneto-Optical Microhead Array Chips, illustrated by FIGS. 29, 31, 34, and 36, to a LIMDOW and MSR Magneto-Optical Microhead Array Chip Hard Disk Drive's internal bus system are located at the inner-bottom surface-areas 93 (FIGS. 30, 32, 35, and 37) of every surface-mounted chip-socket(s) 5 (FIGS. 1, 2, and 6) of every chip-positioning circuit board installed into a LIMDOW and MSR Magneto-Optical Microhead Array Chip Hard Disk Drive's unit-assembly, as illustrated in FIG. 117.

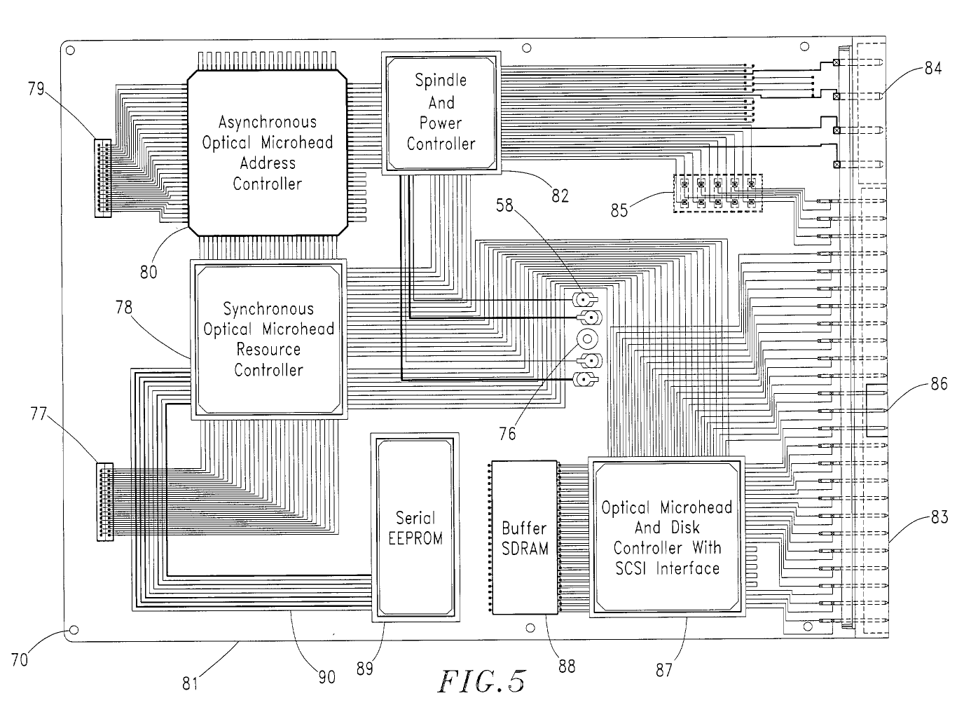

Moreover, the surface-mounted chip-sockets 5 (FIGS. 1, 2, and 6), like the ones illustrated in chip-positioning circuit board drawing FIGS. 29, 30, 31, 32, 33, 34, 35, 36, 37, and 38, have been designed to firmly secure and position LIMDOW or MSR Magneto-Optical Microhead Array Chips into pre-designated and stationary positions above disk-platter data-surfaces. Furthermore, the secured installation of the beforementioned LIMDOW or MSR Magneto-Optical Microhead Array Chips (FIGS. 29, 31, 34, and 36) into their surface-mounted chip-sockets 5 (FIGS. 1, 2, and 6) is accomplished through a triangular-shaped “Chip Placement Key” 11 (FIGS. 7, 8, 26, and 27) and two surface mounting chip-socket threaded hex-screws (i.e., two threaded hex-screws per LIMDOW or MSR Magneto-Optical Microhead Array Chip) 2 (FIGS. 1 and 6).

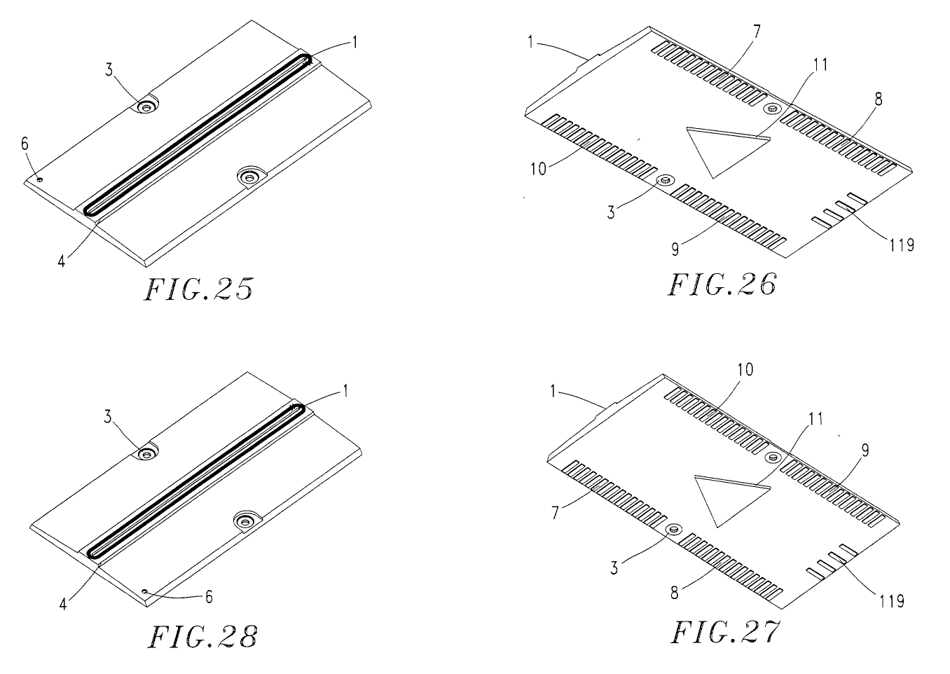

In addition, a triangular-shaped placement key 11 (FIGS. 7, 8, 26, and 27) of a LIMDOW or MSR Magneto-Optical Microhead Array Chip is molded and shaped out of an extruded bottom-surface material, which is part of every LIMDOW or MSR Magneto-Optical Microhead Array Chip's outer-casing package 4 (FIGS. 1, 26, and 27). To meet with tolerances, triangular-shaped placement keys 11 (FIGS. 7, 8, 26, and 27) of LIMDOW or MSR Magneto-Optical Microhead Array Chips are located at the bottom of every LIMDOW or MSR Magneto-Optical Microhead Array Chip and machined down into a final triangular-shaped extruding plate 11 (FIGS. 7, 8, 26, and 27). After final machining a LIMDOW or MSR Magneto-Optical Microhead Array Chip's placement key 11 (FIG. 7), (FIG. 8), (FIG. 26), (FIG. 27) will protrude about “1/16” of one-inch down from underneath the bottom-center surface of a LIMDOW or MSR Magneto-Optical Microhead Array Chip's outer-casing package 4 (FIGS. 1, 26, and 27). The triangle-shaped chip placement keys 11 (FIGS. 7, 8, 26, and 27) will both position and secure the LIMDOW or MSR Magneto-Optical Microhead Array Chips (FIGS. 29, 31, 34, and 36) into the surface-mounted chip-sockets 5 (FIGS. 1, 2, and 6) of chip-positioning circuit boards, as illustrated in FIGS. 29, 30, 31, 32, 33, 34, 35, 36, 37, and 38, by fitting the previously mentioned triangle-shaped keys 11 (FIGS. 7, 8, 26, and 27) into triangle-shaped and correspondingly sized chip placement keyholes 92 (FIGS. 30, 32, 35, and 37), which are located at the top-center surface of the bottom-center plane 92 of every surface-mounted chip-socket installed 5 (FIGS. 1, 2, and 6). Afterwards, the chip placement keyholes 92 (FIGS. 30, 32, 35, and 37) will have the apex of their triangular shaped keyhole pointed toward the front of its respective chip-positioning circuit board's front-end 92 (FIGS. 30, 32, 35, and 37).

Furthermore, LIMDOW or MSR Magneto-Optical Microhead Array Chips are secured into surface-mounted chip-sockets by using two threaded hex-screws 2 (FIGS. 1, 6, 7, and 8), which are pushed through a LIMDOW or MSR Magneto-Optical Microhead Array Chip's two un-threaded hex-screw holes 3 (FIGS. 1, 6, 7, 8, 25, 26, 27, and 28) into a surface-mounted chip-socket's two threaded hex-screw holes 93 (FIGS. 30, 32, 35, and 37) and threaded into the previously mentioned surface-mounted chip-socket's two threaded hex-screw holes 93, by turning them in a clockwise-direction, using torque wrench, until the two surface-mounted chip-socket's hex-screws 2 have reached a predetermined tightness. In this way, the surface-mounted chip-sockets will keep the LIMDOW or MSR Magneto-Optical Microhead Array Chips, illustrated by FIGS. 29, 31, 34, 36, tightly seated and secured into their respective chip-positioning circuit boards, as illustrated in FIGS. 29, 30, 31, 32, 33, 34, 35, 36, 37, and 38.

Another preferred first and basic embodiment of the LIMDOW and MSR Magneto-Optical Microhead Array Chip Hard Disk Drive design is the how, the where, and the why of the previously mentioned Polymer flex-cables, and their respective Polymer flex-cable connectors 67, as illustrated in FIGS. 1, 2, 3, 6, 9, 10, 29, 30, 31, 32, 33, 34, 35, 36, and 37, are used to give bus-system connectivity to installed LIMDOW or MSR Magneto-Optical Microhead Array Chips. Polymer flex-cable connectors 67 are installed onto chip-positioning circuit boards 27 (FIGS. 1, 2, 3, 6, 9, and 10) to provide, via Polymer flex-cables 43, 36, 38, 30 (FIGS. 1, 2, 3, 6, 9, and 10), to chip-positioning circuit boards, as illustrated in FIGS. 29, 30, 31, 32, 33, 34, 35, 36, 37, and 38, and their installed LIMDOW or MSR Magneto-Optical Microhead Array Chips (FIGS. 29, 31, 34, and 36), connectivity to a LIMDOW and MSR Magneto-Optical Microhead Array Chip Hard Disk Drive's Disk Controller, which is illustrated by FIGS. 4 and 5.

Moreover, Polymer flex-cable connectors 67 and Polymer flex-cables 43, 36, 38, 30 will giving to the beforementioned LIMDOW or MSR Magneto-Optical Microhead Array Chips (FIGS. 25, 26, 27, and 28) access to a LIMDOW and MSR Magneto-Optical Microhead Array Chip Hard Disk Drive's bus-systems, while in return giving to the beforementioned LIMDOW and MSR Magneto-Optical Microhead Array Chip Hard Disk Drive's bus-systems access to the beforementioned LIMDOW or MSR Magneto-Optical Microhead Array Chips, as illustrated in FIGS. 25, 26, 27, and 28. The beforementioned Polymer flex-cable connectors 67 make circuit connections with the chip-positioning circuit boards 27 and, therein to the chip-positioning circuit boards' sixty-four copper-circuit trace-runs 21, 22, 23, 24 (FIGS. 1, 6, 29, 30, 31, 32, 34, 35, 36, and 37).

Moreover, by using open-circuit contact-points 46, 26 (FIGS. 1 and 6), which are located on the forward-facing side of the bottom inside-edge of a Polymer flex-cable connector's outer-shell casing 25, 47 (FIGS. 1, 2, 3, 6, 9, and 10), the beforementioned open-circuit contact-points 46, 26 (FIGS. 1 and 6) shall form a multiple circuit connection with a chip-positioning circuit board's 27 (FIGS. 1, 2, 3, 6, 9, and 10) sixty-four copper-circuit trace-runs 21, 22, 23, 24 when the Polymer flex-cable connectors 67 (FIGS. 29, 30, 31, 32, 33, 34, 35, 36, and 37) are bolted, using two Polymer flex-cable connector hex-screws 37 (FIGS. 1, 2, and 3), onto the exposed copper-circuit trace-ends 47, 25 (FIG. 1) of the chip-positioning circuit boards 27 (FIGS. 1, 2, and 3) sixty-four copper-circuit trace-runs 21, 22, 23, 24 (FIGS. 29, 30, 31, 32, 33, 34, 35, 36, and 37).

In addition, when the exposed copper-circuit trace-ends 46, 26 (FIGS. 1 and 6) of Polymer flex-cables 43, 30 (FIGS. 1 and 6) are inserted into Polymer flex-cable connector female connections 28, 45 (FIGS. 1, 2, 6, 10, and 29) they are held into place by internal spring-contacts 28, 45 of Polymer flex-cable connectors, giving the Polymer flex-cable connectors 67 (FIGS. 1, 2, and 3) and chip-positioning circuit boards 27 (FIGS. 1, 2, 3, 6, 9, and 10) they are bolted onto, connectivity to a Disk Controller's bus-system.

In addition, open-circuit contact-points 46, 26 (FIGS. 1 and 6) located within each Polymer flex-cable connector's outer-shell casing 25, 47 (FIGS. 1, 2, 3, 6, 9, and 10), also connect to Polymer flex-cable connectors 67 (FIGS. 29, 30, 31, 32, 33, 34, 35, 36, and 37), which are installed onto a chip-positioning circuit-board's opposite-side or bottom side through, what is called a chip-positioning circuit board's pass-through circuit connection 46, 26 (FIGS. 1 and 6). The pass-through circuit connection 46, 26 (FIGS. 1 and 6) comprises a group of pin-holes 46, 26 (FIGS. 1 and 6), which act as unobstructed passageways that thirty-two micro-plugs having diameters one-half in size to the previously mentioned pin-hole passage-ways, connect two Polymer flex-cable connectors 67 with opposed locations, by allowing each Polymer flex-cable connector's respective group of micro-plugs to connect 46, 26 (FIGS. 1 and 6) with an opposed Polymer flex-cable connector's installation; moreover, creating a pass-through circuit connection 46, 26 (FIGS. 1 and 6). The just described pass-through circuit design also eliminates any possibility of a short-circuit between the beforementioned Polymer flex-cable connector's micro-plug contacts and its respective chip-positioning circuit board's inner metal-core 27 (FIGS. 1, 2, 3, 6, 9, and 10).

In addition, chip-positioning circuit board pass-through circuits 46, 26 (FIGS. 1 and 6) will give bus-system connectivity to installed Polymer flex-cable connectors 67 (FIGS. 1, 2, and 3), through the open-circuit contact-points 46, 26 of Polymer flex-cable connectors, which in turn gives bus-system connectivity to a chip-positioning circuit board's two groups of sixty-four copper-circuit trace-runs 21, 22, 23, 24 (FIGS. 29, 30, 31, 32, 34, 35, 36, and 37), which are located just under the outermost skin of a chip-positioning circuit board's last layer of applied fiber-glass insulation 27 (FIGS. 1, 2, 3, 6, 9, and 10).

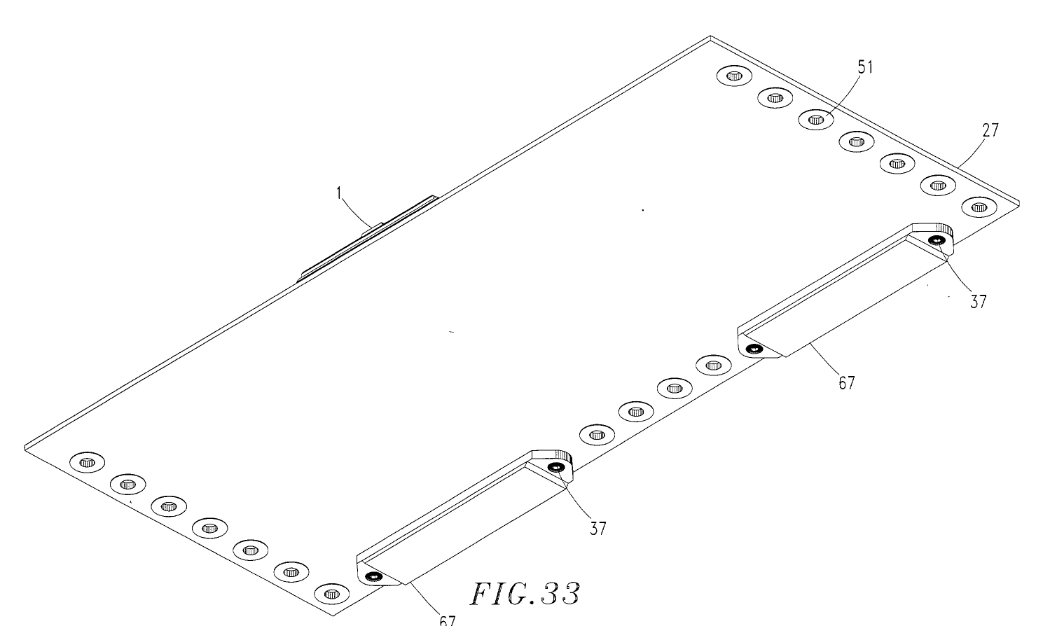

Moreover, a LIMDOW and MSR Magneto-Optical Microhead Array Chip Hard Disk Drive's first chip-positioning circuit board, as illustrated in FIGS. 33, 34, and 35, is positioned at and attached to a LIMDOW and MSR Magneto-Optical Microhead Array Chip Hard Disk Drive's casting-base 12 (FIGS. 1, 2, and 3) and chip-positioning circuit board mounting pedestals 61, 64 (FIGS. 2, 3, and 117). Furthermore, when a LIMDOW and MSR Magneto-Optical Microhead Array Chip Hard Disk Drive's unit-assembly (FIG. 117) is viewed with its front-end turned-up vertical into the Y-direction of Cartesian coordinates (i.e., what is sometimes called the portrait-position), the beforementioned Polymer flex-cable connectors 67 (FIGS. 29, 30, 31, 32, 33, 34, 35, 36, and 37) and the beforementioned Polymer flex-cables 30 (FIGS. 1, 6, 10, and 15), if located on the right-hand side of the chip-positioning circuit boards installed into a LIMDOW and MSR Magneto-Optical Microhead Array Chip Hard Disk Drive's unit-assembly (FIG. 117) are multiple connection cable circuits, which are dedicated to a LIMDOW and MSR Magneto-Optical Microhead Array Chip Hard Disk Drive's Power, Ground, Data I/O, and Control bus-systems.

Furthermore, the beforementioned Polymer flex-cable connectors 67 (FIGS. 29, 30, 31, 32, 33, 34, 35, 36, and 37) and the beforementioned Polymer flex-cables 30 (FIGS. 1, 6, 10, and 15), if installed on the right-hand side of the beforementioned chip-positioning circuit boards will form a multiple circuit connection between installed LIMDOW or MSR Magneto-Optical Microhead Array Chips (FIGS. 29, 31, 34, 36, and 38), through a LIMDOW or MSR Magneto-Optical Microhead Array Chip's chip-connecting contact-points 7, 8 (FIGS. 7, 8, 26, and 27), and a Disk Controller's (PCB) “Printed Circuit Board” unit-assembly 53 (FIGS. 2, 3, 4, and 5). Moreover, remembering that a Disk Controller's PCB 53 is positioned just under a LIMDOW and MSR Magneto-Optical Microhead Array Chip Hard Disk Drive's Spindle-Motor unit-assembly 59 (FIGS. 2 and 3), facing the bottom-inside surface of a LIMDOW and MSR Magneto-Optical Microhead Array Chip Hard Disk Drive's casting-base 12 (FIGS. 1, 2, and 3).

In addition, when a LIMDOW and MSR Magneto-Optical Microhead Array Chip Hard Disk Drive's unit-assembly (FIG. 117) is viewed with its front-end turned-up vertical into the Y-direction of Cartesian coordinates (i.e., what is sometimes called the portrait-position), the beforementioned Polymer flex-cable connectors 67 (FIGS. 29, 30, 31, 32, 33, 34, 35, 36, and 37) and the beforementioned Polymer flex-cables 43 (FIGS. 1, 6, 10, and 16), if located on the left-hand side of the chip-positioning circuit boards installed into a LIMDOW and MSR Magneto-Optical Microhead Array Chip Hard Disk Drive's unit-assembly (FIG. 117) are multiple connection cable circuits, which are dedicated to a LIMDOW and MSR Magneto-Optical Microhead Array Chip Hard Disk Drive's 32-bit microhead addressing bus-system.

In addition, the beforementioned Polymer flex-cable connectors 67 (FIGS. 29, 30, 31, 32, 33, 34, 35, 36, and 37) and the beforementioned Polymer flex-cables 43 (FIGS. 1, 6, 10, and 16), if installed on the left-hand side of the beforementioned chip-positioning circuit boards, will create a multiple circuit connection between installed LIMDOW or MSR Magneto-Optical Microhead Array Chips (FIGS. 29, 31, 34, 36, and 38), through their chip-connecting contact-points 9, 10 (FIGS. 7, 8, 26, and 27) and a Disk Controller's (PCB) “Printed Circuit Board” unit-assembly 53 (FIGS. 2, 3, 4, and 5). Moreover, remembering that a Disk Controller's PCB 53 (FIGS. 2, 3, 4, and 5) is positioned just under a LIMDOW and MSR Magneto-Optical Microhead Array Chip Hard Disk Drive's Spindle-Motor unit-assembly 59 (FIGS. 2 and 3), facing the bottom-inside surface of a LIMDOW and MSR Magneto-Optical Microhead Array Chip Hard Disk Drive's casting-base 12 (FIGS. 1, 2, and 3).

Furthermore, in addition too the previously mentioned Polymer flex-cable connectors 67 (FIGS. 29, 30, 31, 32, 33, 34, 35, 36, and 37) are the Polymer flex-cable connectors called female bridge-connectors 34, 40 (FIGS. 1, 2, and 3), which are used to connect a LIMDOW and MSR Magneto-Optical Microhead Array Chip Hard Disk Drive's chip-positioning circuit board assemblies, illustrated by FIGS. 29, 30, 31, 32, 33, 34, 35, 36, 37, and 38, up to the previously mentioned Disk Controller's PCB unit-assembly 53 (FIGS. 2, 3, 4, and 5). Wherein, a top-plug portion or first top-half of the beforementioned female bridge-connector 34, 40 (FIGS. 1, 2, and 3) comprises a 32-bit thirty-two spring-contact Polymer flex-cable female-connector 33, 41 (FIGS. 1, 2, and 3), a female bridge-connector's sealing-gasket 31, 42 (FIGS. 1, 2, and 3), and a female bridge-connector's two installation hex-screws 32 (FIGS. 1, 2, 3, 6, and 10).

Moreover, the aforesaid top-plug portions of the beforementioned two female bridge-connectors 34, 40 (FIGS. 1, 2, and 3) are to be installed into two slot-holes, which were previously created in the bottom-half of a casting-base's component mounting base-plate 12 (FIGS. 1, 2, and 3), which is opposite to the previously mentioned LIMDOW and MSR Magneto-Optical Microhead Array Chip Hard Disk Drive's front-end (FIGS. 1, 2, and 3). Moreover, the previously mentioned top-plug portions of the beforementioned female bridge-connectors 34, 40 (FIGS. 1, 2, and 3) are connected, using a female bridge-connector's two hex-screws 32 (FIGS. 1, 2, and 3), to the inside top-surface of the bottom-half of the beforementioned casting-base's component mounting base-plate 12 (FIGS. 1, 2, and 3).

Furthermore, in addition to the beforementioned top-plug portion or first-half of the beforementioned female bridge-connector 34, 40 (FIGS. 1, 2, and 3) is a bottom-plug portion or second-half of the beforementioned female bridge-connector 33, 41 (FIGS. 1, 2, and 3), which comprises a thirty-two pin micro-plug female-connector, which has an install location identical to the install location of its companion top-plug portion 34, 40 (FIGS. 1, 2, and 3). Moreover, the beforementioned two female bridge-connectors 34, 40 (FIGS. 1, 2, and 3) are used to connect a LIMDOW and MSR Magneto-Optical Microhead Array Chip Hard Disk Drive's chip-positioning circuit boards, as illustrated in FIGS. 29, 30, 31, 32, 33, 34, 35, 36, 37, and 38, to a Disk Controller's two thirty-two pin micro-plug male connectors 65, 69 (FIG. 4) 77, 79 (FIG. 5). The previously mentioned micro-plug male connectors 65, 69 (FIG. 4) 77, 79 (FIG. 5) are located on the top-surfaces of Disk Controller PCB unit-assemblies 53, 81 (FIGS. 2, 3, 4, and 5), which also face toward a Spindle-Motor's flanged mounting-base 12 (FIGS. 1, 2, and 3). The top-plug portions of the beforementioned female bridge-connectors 34, 40 (FIGS. 1, 2, and 3) comprise the same 32-bit thirty-two spring-contact Polymer flex-cable female connector 35, 39 (FIGS. 1, 2, and 3), which was used in the beforementioned chip-positioning circuit board's Polymer flex-cable connectors 67 (FIGS. 1, 2, and 3).

In addition, every female bridge-connector 34, 40 (FIGS. 1, 6, 10, and 117) that is installed into a LIMDOW and MSR Magneto-Optical Microhead Array Chip Hard Disk Drive has two sealing-gaskets 31, 42 (FIGS. 1, 6, and 10), which are used for sealing a LIMDOW and MSR Magneto-Optical Microhead Array Chip Hard Disk Drive's interior-space from any air-borne particles existing in the air outside a LIMDOW and MSR Magneto-Optical Microhead Array Chip Hard Disk Drive's enclosed interior-space.

Preferably, the LIMDOW and MSR Magneto-Optical Microhead Array Chip Hard Disk Drive design will use in its construction four of the previously mentioned sealing gaskets 31, 42 (FIG. 1) two for a right-side female bridge-connector and two for a left-side female bridge-connector 31, 42 (FIGS. 1, 2, 3, 6, 10, 117). Moreover, the sealing gaskets 31, 42 (FIG. 1) that will tightly seal the surface lying areas between a female bridge-connector's top-plug and bottom-plug portions and female bridge-connector installation slot-holes 34, 40, 33, 41 (FIGS. 1, 2, and 3). Moreover, the sealing gaskets 31, 42 (FIG. 1) also protect a LIMDOW and MSR Magneto-Optical Microhead Array Chip Hard Disk Drive's enclosed interior environment from air-borne dust and/or particle contamination. Furthermore, the beforementioned female bridge-connectors 34, 40, 33, 41 (FIGS. 1, 2, and 3) are fastened to a LIMDOW and MSR Magneto-Optical Microhead Array Chip Hard Disk Drive's casting-base 12 (FIGS. 1, 2, and 3) using two female bridge-connector threaded hex-screws 32, 43 (FIGS. 1, 2, 3, 6, 9, and 10).

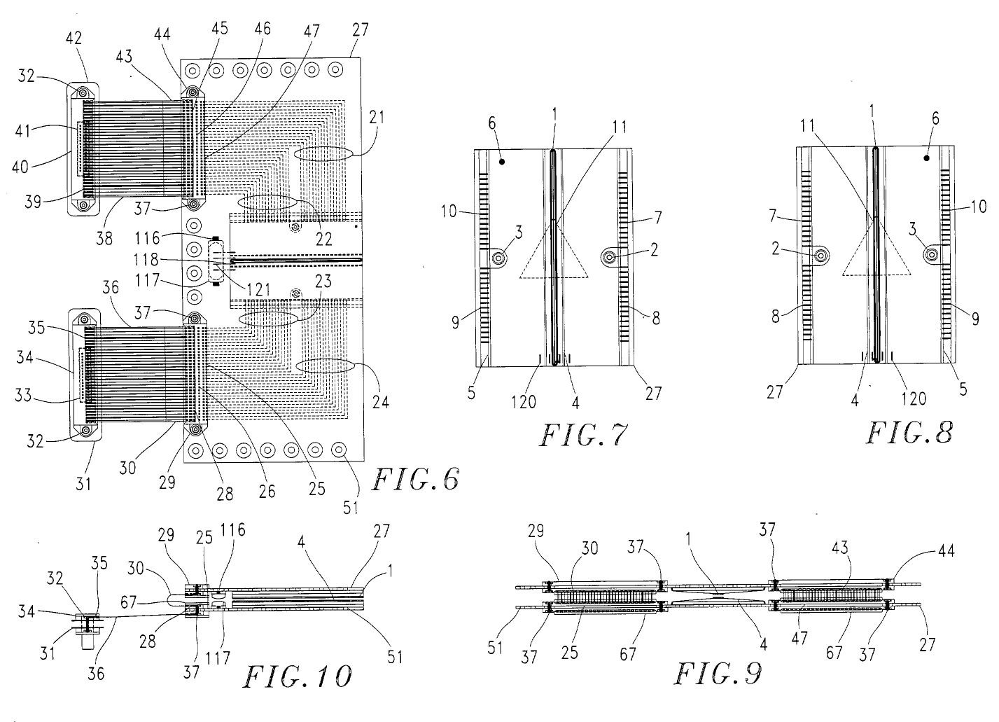

Furthermore, the top-plug portion or first-half of the previously mentioned female bridge-connectors 34, 40 (FIGS. 1 and 6) provides connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and a LIMDOW and MSR Magneto-Optical Microhead Array Chip Hard Disk Drive's chip-positioning circuit boards, illustrated by FIGS. 29, 30, 31, 32, 33, 34, 35, 36, 37, and 38, and their respective LIMDOW or MSR Magneto-Optical Microhead Array Chips (FIGS. 29, 31, 34, and 36). Moreover, the connectivity between the previously mentioned bus-system and Disk Controller is executed through two primary bus-system Polymer flex-cables 36, 38 (FIGS. 1, 6, 10, 15, 16, and 117), which are physically connected, using the beforementioned two female bridge-connector's top-plug portions 34, 40 (FIG. 1), to a first chip-positioning circuit board's two bottom Polymer flex-cable connectors 67 (FIGS. 2 and 10).

Furthermore, the first chip-positioning circuit board to be installed into a LIMDOW and MSR Magneto-Optical Microhead Array Chip Hard Disk Drive's unit-assembly (FIG. 117) is positioned by eighteen “Titanium” alloy circuit-board spacers 66 (FIGS. 1, 2, and 3), a casting-base 12 (FIGS. 1, 2, and 3), and eighteen hex-screw bolt-pedestals 61, 64 (FIGS. 2 and 3). Moreover, eighteen chip-positioning circuit board spacers 66 (FIGS. 1, 2, and 3) are also used to install each proceeding chip-positioning circuit board into a LIMDOW and MSR Magneto-Optical Microhead Array Chip Hard Disk Drive's unit-assembly, illustrated by FIG. 117. The last chip-positioning circuit board assembly, as illustrated in FIGS. 2, 3, 36, 37, 38, and 117, which is installed into a LIMDOW and MSR Magneto-Optical Microhead Array Chip Hard Disk Drive's unit-assembly (FIG. 117) and locked into place 66 (FIGS. 1, 2, 3, and 117) with eighteen chip-positioning circuit board's hex-screws 50 (FIGS. 1, 2, 3, and 117).

Installation of all chip-positioning circuit boards into a LIMDOW and MSR Magneto-Optical Microhead Array Chip Hard Disk Drive's unit-assembly (FIG. 117) is finally accomplished when the beforementioned chip-positioning circuit board's eighteen installation hex-screws 50 (FIGS. 1, 2, 3, and 117) are first inserted into and through a last chip-positioning circuit board's hex-screw holes 51 (FIGS. 1, 2, and 3), while continuing with the insertion of the beforementioned chip-positioning circuit board hex-screws 50 through all chip-positioning circuit board spacers and spacer holes 66 (FIGS. 1, 2, and 3) until they reach the hex-screw holes 51 (FIGS. 1, 2, 3, and 117) then, afterwards threading the beforementioned chip-positioning circuit board hex-screws 50 (FIGS. 1, 2, 3, and 117) into a casting-base's eighteen hex-screw bolt-pedestals 61, 64 (FIGS. 2 and 3), which are located on the upward facing outer-surface of a casting-base component mounting base-plate's bottom-half area 13 (FIGS. 1, 2, and 3).

Moreover, the threaded hex-screws 50 (FIGS. 1, 2, 3, and 117) are tightened into place by turning them clockwise with a torque hex-wrench into the eighteen hex-screw bolt-pedestals 61, 64 (FIGS. 1, 2, and 3) of a casting-base, which are located on the top outer-surface of the component mounting base-plate's bottom-half 13 (FIGS. 1, 2, and 3), which will secure all of the previously mentioned chip-positioning circuit boards into their final and stationary positions, as illustrated in FIGS. 1, 2, 3, and 117.

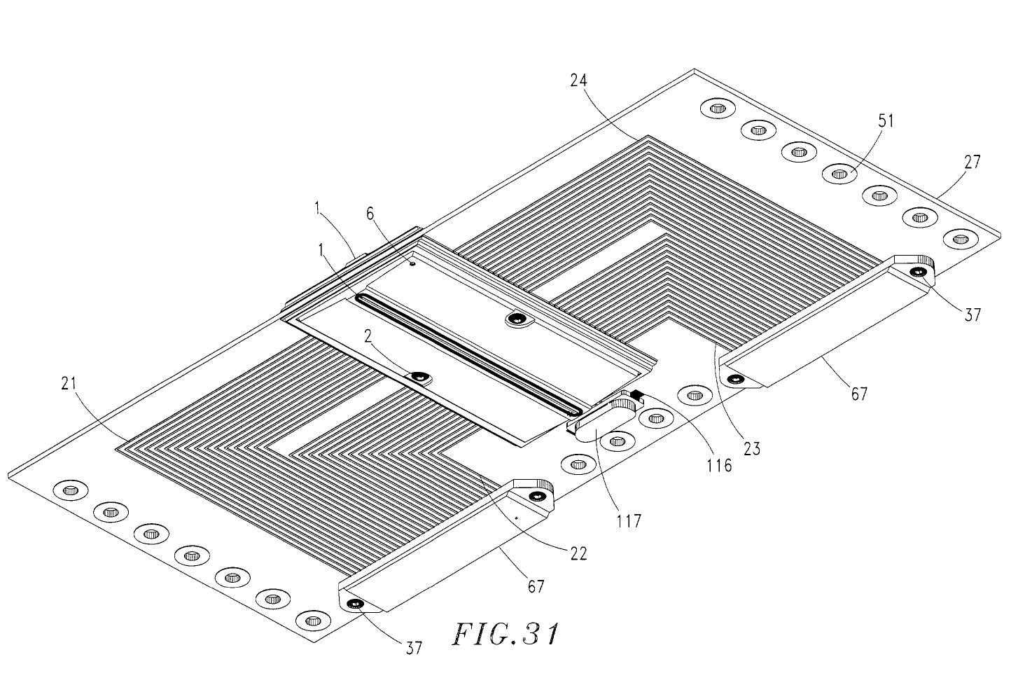

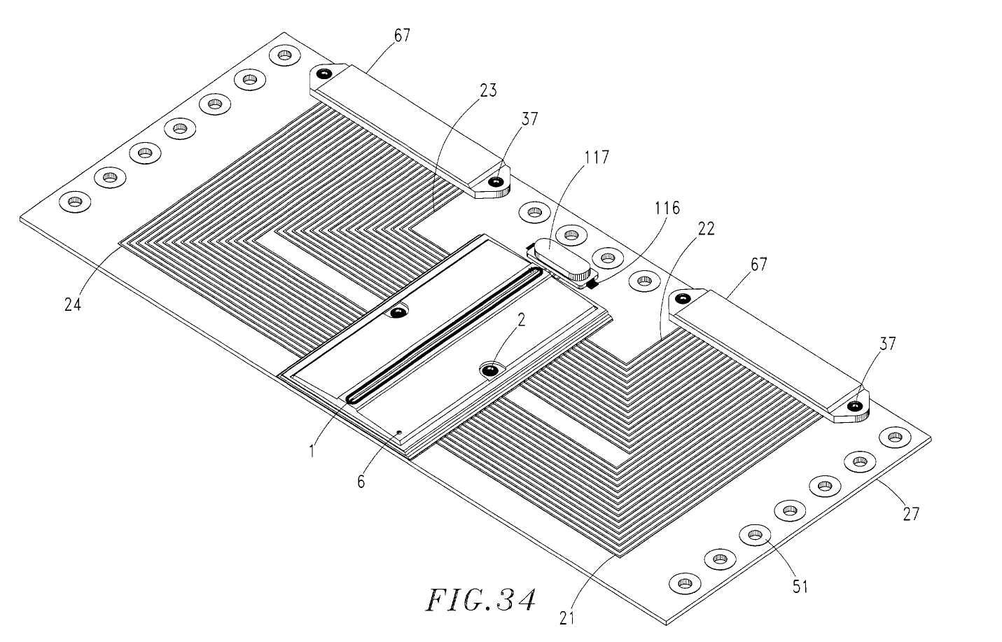

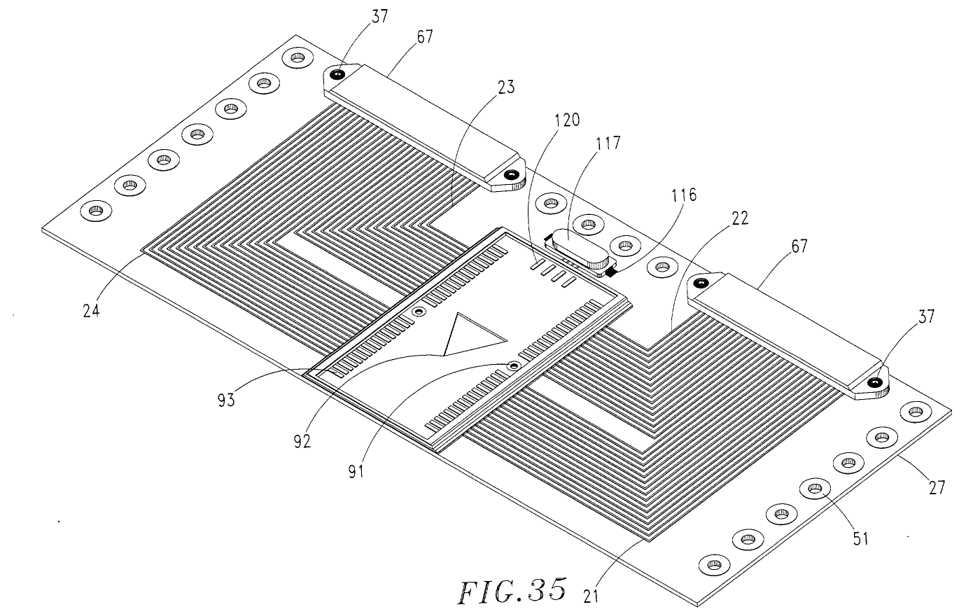

Another preferred first and basic embodiment of the present invention, as illustrated in drawing FIGS. 29, 30, 31, 32, 33, 34, 35, 36, 37, and 38, describes chip-positioning circuit board assemblies, which are used in the LIMDOW and MSR Magneto-Optical Microhead Array Chip Hard Disk Drive design to position their previously mentioned and respective LIMDOW or MSR Magneto-Optical Microhead Array Chips FIG. 29, FIG. 31, FIG. 34, FIG. 36 above their respective disk-platters 13 (FIGS. 1, 2, and 3). Moreover, with the first chip-positioning circuit board FIG. 33, FIG. 34, FIG. 35, having a top-installed “Bottom Surface LIMDOW or MSR Magneto-Optical Microhead Array Chip” FIG. 28, put into a stationary position above a LIMDOW and MSR Magneto-Optical Microhead Array Chip Hard Disk Drive's disk-platter one, data-surface one 13 (FIGS. 1, 2, and 3).

In addition, the first chip-positioning circuit board will provide system connectivity through its two bottom Polymer flex-cable connectors 36, 38 (FIGS. 1, 6, 15, 16, and 117), which are located closest to a LIMDOW and MSR Magneto-Optical Microhead Array Chip Hard Disk Drive's casting-base 12 (FIGS. 1, 2, and 3), connectivity is accomplished using two extra-long bus-system Polymer flex-cables 36, 38 (FIGS. 1, 2, and 117), which are inserted into the bottom two 32-bit spring-contact flex-cable connectors 67 (FIGS. 2, 3, 10, and 117) of the first chip-positioning circuit board.

Moreover, a first chip-positioning circuit board's spring-contact flex-cable connectors are ultimately used to parallel-connect all of the installed chip-positioning circuit board assemblies used in a LIMDOW and MSR Magneto-Optical Microhead Array Chip Hard Disk Drive's unit-assembly (FIG. 117) into a LIMDOW and MSR Magneto-Optical Microhead Array Chip Hard Disk Drive's bus-system, as illustrated in FIGS. 29, 30, 31, 32, 33, 34, 35, 36, 37, and 38. Moreover, by using the beforementioned two female bridge-connectors 34, 40 (FIGS. 1 and 6), which are located on the inside-bottom surface of a LIMDOW and MSR Magneto-Optical Microhead Array Chip Hard Disk Drive's casting-base 12 (FIGS. 1, 2, and 3); moreover, the beforementioned two female bridge-connector's bottom-plug portion female-connector 33, 41 (FIGS. 1, 2, and 3) connects to the Disk Controller's two “32-pin” mini-plug male connectors, which are located on the Disk Controller's PCB 65, 69 (FIG. 4) 77, 79 (FIG. 5), through two rectangular shaped slot-holes located in the bottom-half of the casting-base's component mounting base-plate 12 (FIGS. 1, 2, and 3).

In addition, the second chip-positioning circuit board installed into a LIMDOW and MSR Magneto-Optical Microhead Array Chip Hard Disk Drive's unit-assembly (FIG. 117) is an “In-between Disk-Platter” chip-positioning circuit board assembly, illustrated by FIGS. 29, 30, 31, and 32, which show a bottom-installed “Top-surface LIMDOW or MSR Magneto-Optical Microhead Array Chip” (FIG. 25) as being put into position for disk-platter one, data-surface two, while showing a top-installed “Bottom Surface LIMDOW or MSR Magneto-Optical Microhead Array Chip” (FIG. 28) as being put into position for disk-platter two, data-surface one.

Furthermore, a second chip-positioning circuit board's bottom two Polymer flex-cables 30, 43 (FIGS. 1, 2, 3, and 117) are used to connect to a first chip-positioning circuit board's top two 32-bit Polymer flex-cable spring-contact connectors 67 (FIGS. 2, 3, 10, and 117); moreover, creating a daisy chained bus-system for all installed LIMDOW or MSR Magneto-Optical Microhead Array Chips and their respective chip-positioning circuit board assemblies, as illustrated in FIGS. 29, 30, 31, 32, 33, 34, 35, 36, 37, and 38.

In addition, the third chip-positioning circuit board, illustrated by FIGS. 29, 30, 31, and 32, which is installed into a LIMDOW and MSR Magneto-Optical Microhead Array Chip Hard Disk Drive's unit-assembly as an “In-between Disk-Platter” chip-positioning circuit board assembly, illustrated by FIGS. 29, 30, 31, and 32, which show a bottom-installed “Top-surface LIMDOW or MSR Magneto-Optical Microhead Array Chip” (FIG. 25) as being put into position for disk-platter two, data-surface two, while showing a top-installed “Bottom Surface LIMDOW or MSR Magneto-Optical Microhead Array Chip” (FIG. 28) as being put into position for disk-platter three, data-surface one.

Furthermore, a third chip-positioning circuit board's bottom two Polymer flex-cables 30, 43 (FIGS. 1, 2, 3, and 117), which connect to a second chip-positioning circuit board's top two 32-bit flex-cable spring-contact connectors 67 (FIGS. 2, 3, 10, and 117), are used to provide a third chip-positioning circuit board with connectivity to a LIMDOW and MSR Magneto-Optical Microhead Array Chip Hard Disk Drive's system-bus.

In addition, the fourth chip-positioning circuit board to be installed into a LIMDOW and MSR Magneto-Optical Microhead Array Chip Hard Disk Drive's unit-assembly is also an “In-between Disk-Platter” chip-positioning circuit board, illustrated by FIGS. 29, 30, 31, and 32, which show a bottom-installed “Top-surface LIMDOW or MSR Magneto-Optical Microhead Array Chip” (FIG. 25) as being put into position for disk-platter three, data-surface two, while showing a top-installed “Bottom Surface LIMDOW or MSR Magneto-Optical Microhead Array Chip” (FIG. 28) as being put into position for disk-platter four, data-surface one.

Furthermore, the fourth chip-positioning circuit board's bottom two Polymer flex-cables 30, 43 (FIGS. 1, 2, 3, and 117), which connect to a third chip-positioning circuit board's top two 32-bit flex-cable spring-contact connectors 67 (FIGS. 2, 3, 10, and 117), are used to provide a fourth chip-positioning circuit board with connectivity to a LIMDOW and MSR Magneto-Optical Microhead Array Chip Hard Disk Drive's system-bus.

In addition, the fifth chip-positioning circuit board installed into a LIMDOW and MSR Magneto-Optical Microhead Array Chip Hard Disk Drive's unit-assembly is a “Last Disk Platter” chip-positioning circuit board assembly, illustrated by FIGS. 36, 37, and 38, which show its bottom-installed “Top-surface LIMDOW or MSR Magneto-Optical Microhead Array Chip” (FIG. 25) as being put into position for disk-platter four, data-surface two. Furthermore, the fifth LIMDOW or MSR Magneto-Optical Microhead Array Chip chip-positioning circuit board's bottom two Polymer flex-cables 30, 43 (FIGS. 1, 2, 3, and 117), which connect to the fourth chip-positioning circuit board's top two 32-bit flex-cable spring-contact connectors 67 (FIGS. 2, 3, 10, and 117).

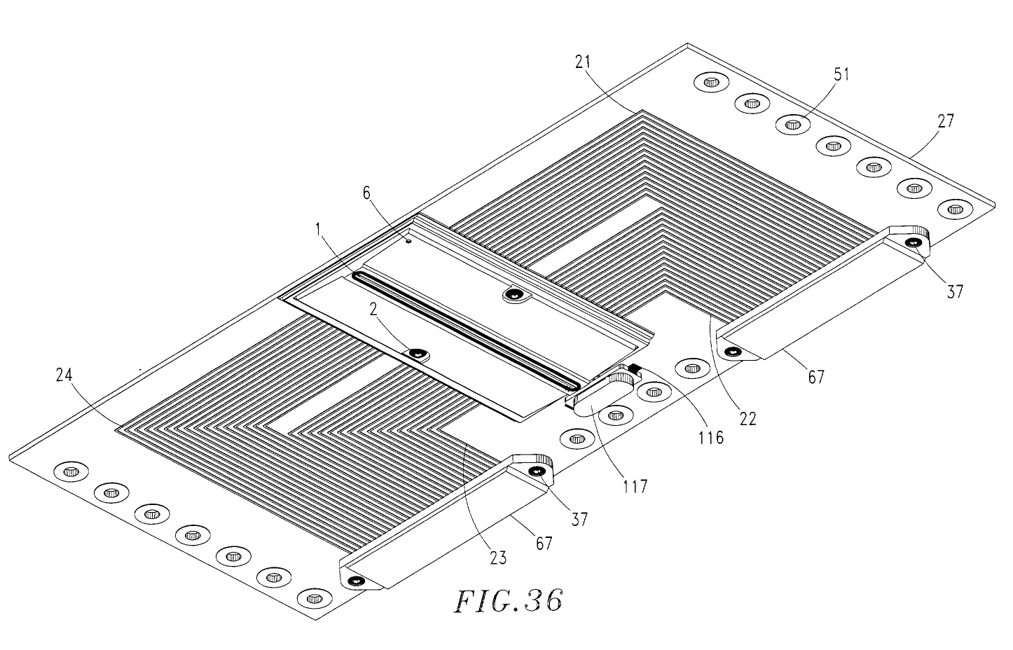

In addition, the last two Polymer flex-cable connectors 29, 44 (FIGS. 1, 2, 3, 6, 38, and 117) are not Polymer flex-cable connectors at all, but are in reality Polymer flex-cable connector termination-caps. Moreover, the termination-caps are located on the topside surface of the beforementioned fifth and last chip-positioning circuit board (FIG. 38) used in a LIMDOW and MSR Magneto-Optical Microhead Array Chip Hard Disk Drive's unit-assembly, as illustrated in FIG. 117. The fastening of the fifth chip-positioning circuit board's two termination-caps 29, 44 (FIGS. 1, 2, 3, 6, 38, and 117) to the fifth and last chip-positioning circuit board's (FIG. 38) topside surface is accomplished with four threaded flex-cable connector hex-screws 37 (FIGS. 1, 2, 3, 6, 9, 10, and 117).

In addition, every chip-positioning circuit board installed into a LIMDOW and MSR Magneto-Optical Microhead Array Chip Hard Disk Drive's unit-assembly (FIG. 117) is connected to the other chip-positioning circuit board, starting from the casting-base, with two Polymer flex-cables 30, 43 (FIGS. 1, 2, 3, and 117). The chip-positioning circuit boards used in LIMDOW and MSR Magneto-Optical Microhead Array Chip Hard Disk Drive s are all connected to one another in a daisy-chained bus-system cable configuration.

Moreover, a daisy-chained bus-system cable configuration starts from the casting-base female bridge-connectors 34, 40 (FIGS. 1, 6, and 10), and ending at the fifth and last chip-positioning circuit board (FIG. 38) to be installed into a LIMDOW and MSR Magneto-Optical Microhead Array Chip Hard Disk Drive's unit-assembly, as illustrated in FIG. 117. The daisy-chained bus-system cable configuration of chip-positioning circuit board assemblies, illustrated by FIGS. 29, 30, 31, 32, 33, 34, 35, 36, 37, and 38, will simplify a LIMDOW and MSR Magneto-Optical Microhead Array Chip Hard Disk Drive's manufacturing, upgrading, and repair.

In addition, the first and embodiment of the present invention, as illustrated in drawing FIGS. 2, 3, 4, 5, and 81, describes a printed circuit board 53 (FIGS. 2, 3, 4, 5, and 81), which is installed onto the bottom of a LIMDOW and MSR Magneto-Optical Microhead Array Chip Hard Disk Drive's casting-base 12 (FIGS. 1, 2, and 3). A LIMDOW and MSR Magneto-Optical Microhead Array Chip Hard Disk Drive's Disk Controller will control installed he LIMDOW or MSR Magneto-Optical Microhead Array Chips through two “32-pin” mini-plug male connectors 65, 69 (FIGS. 4, 5, 77, and 79). Moreover, the previously mentioned two “32-pin” mini-plug male connectors 65, 69 (FIGS. 4, 5, 77, and 79) will connect to two “32-pin” mini-plug female bridge-connectors 34, 40 (FIGS. 1, 6, 10, and 117), which are located at the bottom area of a casting-base's component mounting base-plate 12 (FIGS. 1, 2, and 3). The Disk Controller's PCB is attached to a LIMDOW and MSR Magneto-Optical Microhead Array Chip Hard Disk Drive's casting-base 12 (FIGS. 1, 2, and 3) with six PCB mounting hex-screws 54 (FIGS. 2 and 3). Moreover, the previously mentioned six PCB mounting hex-screws 54 are inserted through a Disk Controller's six PCB hex-screw holes 70 (FIGS. 4, 5, and 76), and screwed clockwise into the previously mentioned six PCB hex-screw holes, which are located around the bottom edge areas 16 (FIGS. 1, 2, and 3) of a LIMDOW and MSR Magneto-Optical Microhead Array Chip Hard Disk Drive's casting-base 12 (FIGS. 1, 2, and 3).

In addition, the previously mentioned Disk Controller's PCB has attached at its center, four metal circuit-contacts 58 (FIGS. 4 and 5). The previously mentioned metal circuit-contacts 58 are used by a Spindle And Power Controller's driver circuitry to communtate with a Spindle-Motor and its hall-sensor circuits (i.e., not shown here). Furthermore, when the Disk Controller's PCB unit-assembly is installed onto a LIMDOW and MSR Magneto-Optical Microhead Array Chip Hard Disk Drive's casting-base 16 (FIGS. 1, 2, and 3) the four metal circuit-contacts 58 (FIGS. 1, 2, 3, 4 and 5) will make a connection with the previously mentioned Spindle And Power Controller's driver circuitry through circuit-contacts located on a Polymer circuit-trace substrate flex-cable (FIGS. 1, 2, and 3), which is located at the bottom of a Spindle-Motor's stator housing 58 (FIGS. 1, 2, and 3). Through the beforementioned four circuit-contacts 58 (FIGS. 1, 2, 3, 4, and 5), all of a Spindle-Motor's 59 (FIGS. 1, 2, and 3) velocity and radial positioning control, along with its hall sensor monitoring signals, will be sent by two-way communication, through a Spindle-Motor's Polymer circuit-trace substrate-cable, to and from, the previously mentioned PCB's circuit-contacts 53 (FIGS. 2, 3, 4, and 5), and back again to a LIMDOW and MSR Magneto-Optical Microhead Array Chip Hard Disk Drive's “Spindle-Motor” 59 (FIGS. 1, 2, and 3). Moreover, a Disk Controller's PCB unit-assembly is used in a LIMDOW and MSR Magneto-Optical Microhead Array Chip Hard Disk Drive's unit-assembly to contain and install most of a LIMDOW and MSR Magneto-Optical Microhead Array Chip Hard Disk Drive's electronics. A Disk Controller's PCB unit-assembly consists of four main (VLSI) “Very Large Scale Integration” surface-mounted microprocessors.

Furthermore, the previously mentioned VLSI components will include an IDE bus-interface 55 (FIG. 4), or a SCSI bus-interface 87 (FIG. 5), which reside on a Disk Controller's PCB unit-assembly, as illustrated in FIGS. 4 and 5. However, the electronics used by every LIMDOW or MSR Magneto-Optical Microhead Array Chip to control functions like “Microhead-Addressing and Selection”, “Read and Write-Channel Pre-Amplification”, “Read and Write-Channel Data Stream Encoding and Decoding”, and “Write Driver Data Demodulation” are all built into the LIMDOW or MSR Magneto-Optical Microhead Array Chips themselves.

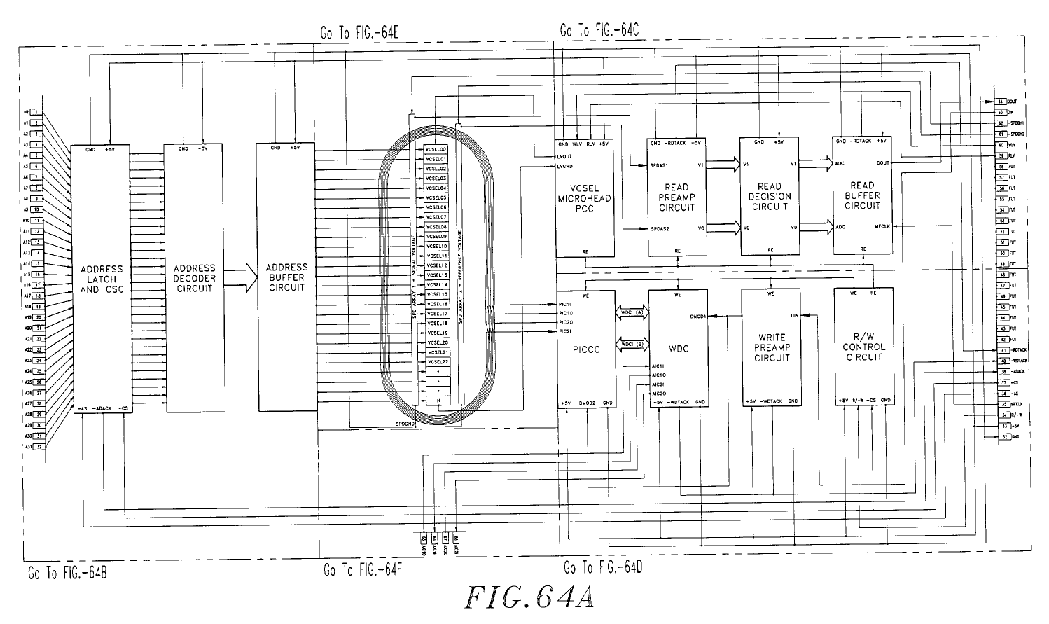

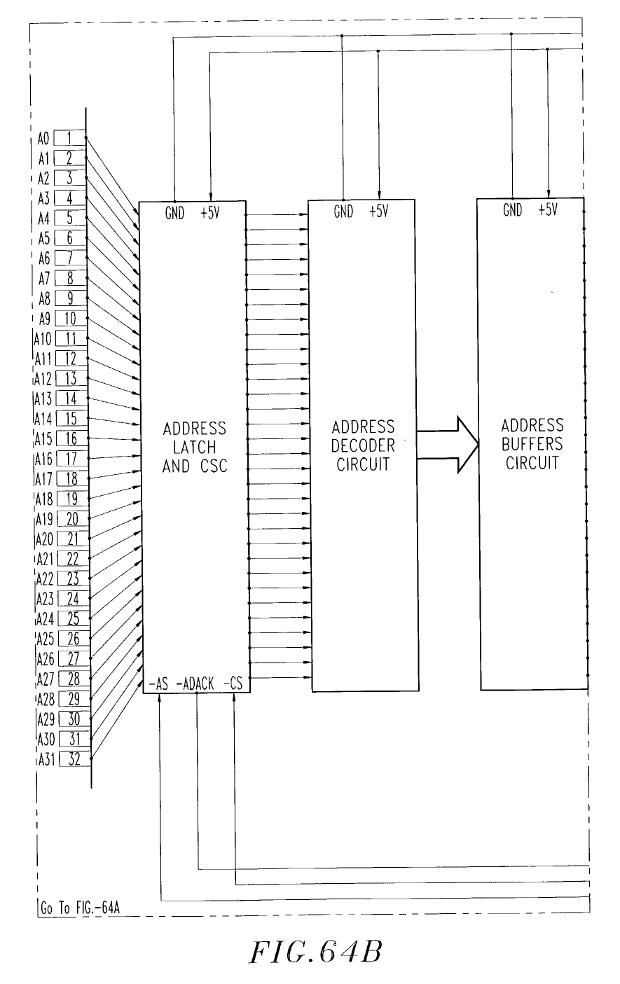

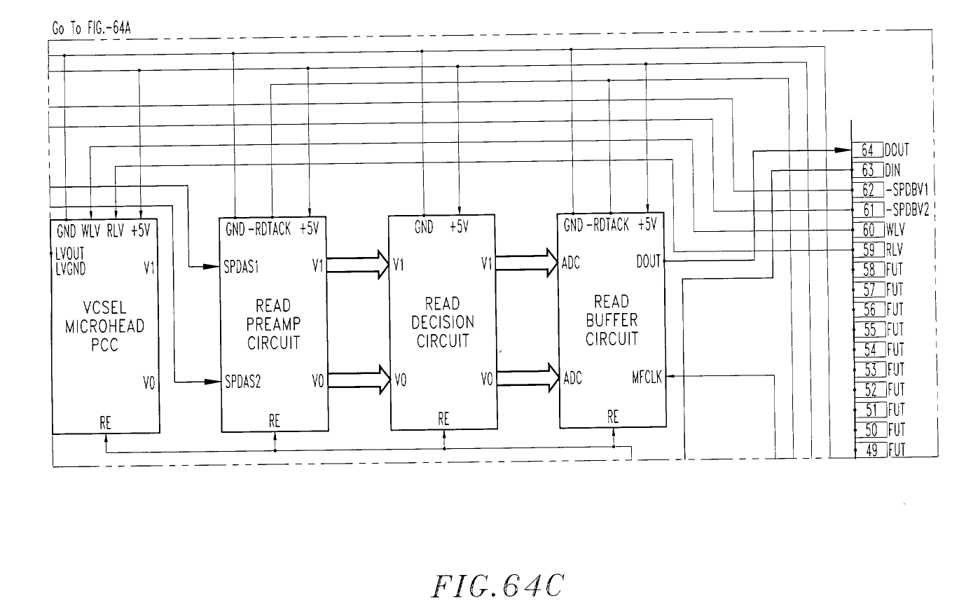

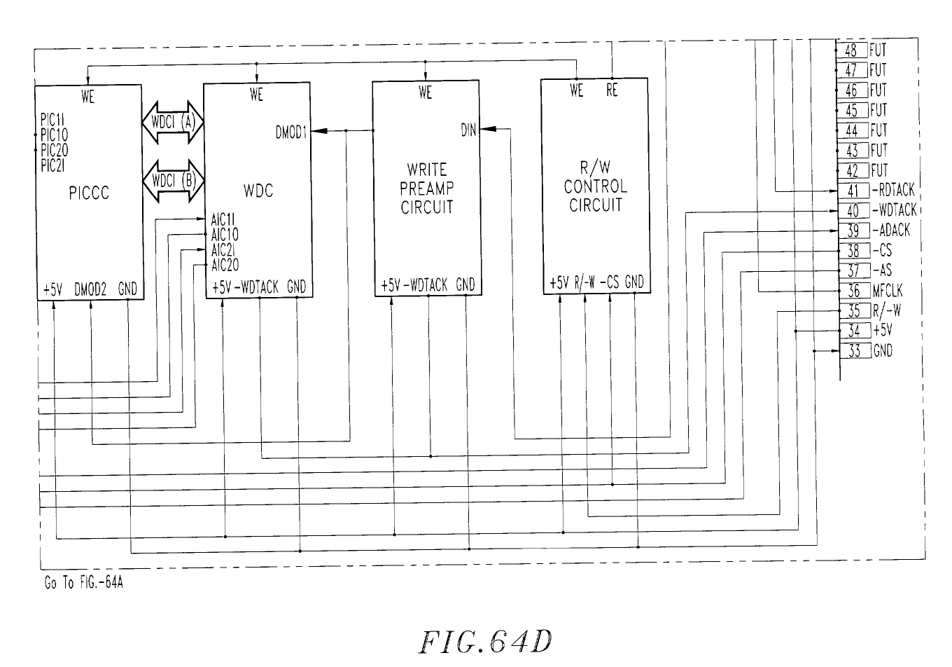

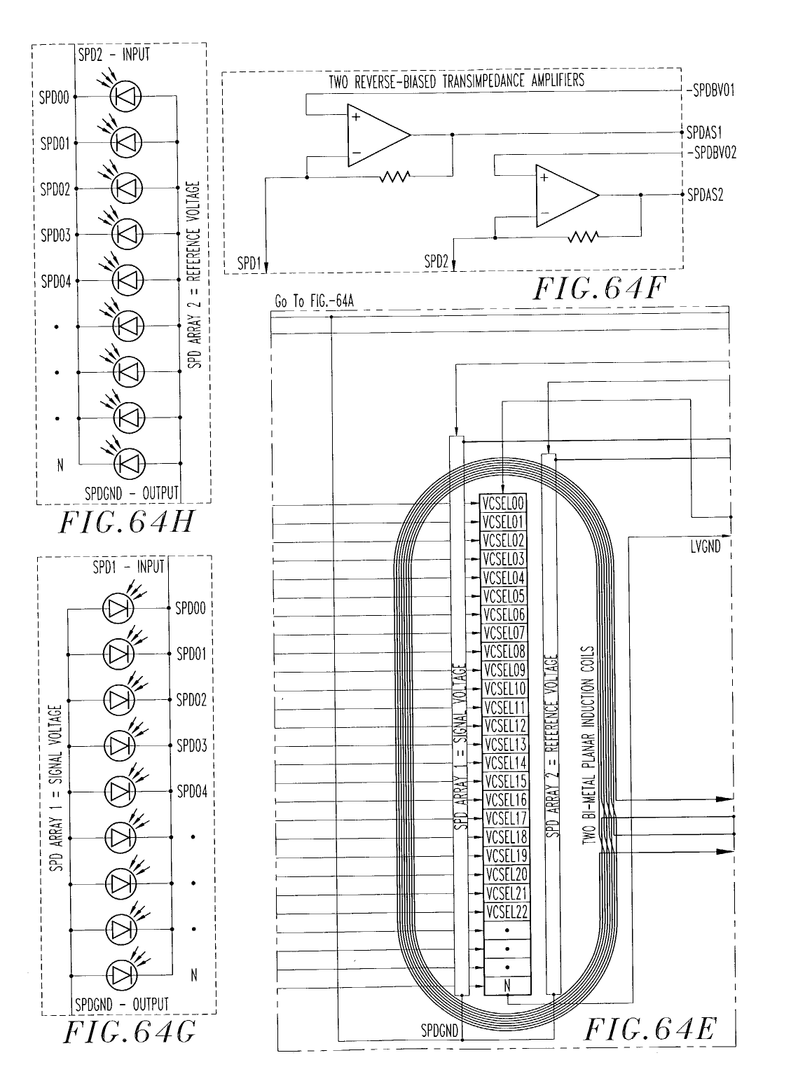

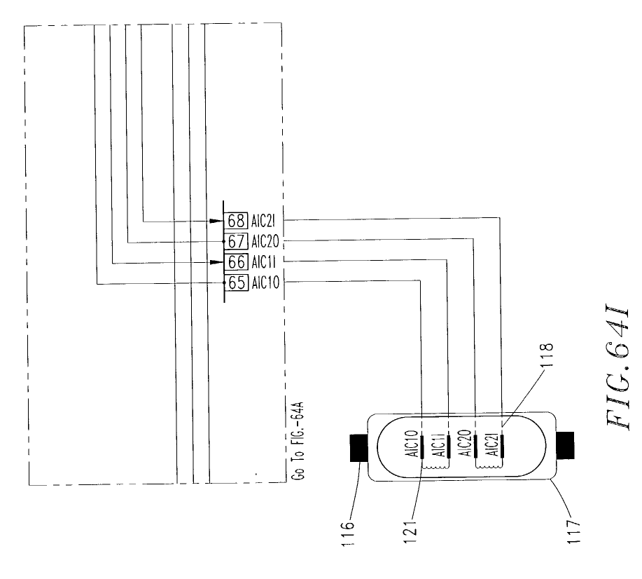

Furthermore, the integration that occurs between a microhead array of a LIMDOW or MSR Magneto-Optical Microhead Array Chip and its internal circuitry significantly improves the “signal-to-noise” ratio of output-signals being created by the LIMDOW or MSR Magneto-Optical Microhead Array Chips. Moreover, as illustrated in FIGS. 60A, 60B, and 60C, the encoded data-stream signals created within a LIMDOW or MSR Magneto-Optical Microhead Array Chip's read-channel (FIGS. 64A and 64C) is transported through shared data-bus system lines to a LIMDOW and MSR Magneto-Optical Microhead Array Chip Hard Disk Drive Disk Controller's “Data-Sequencer” for signal processing. Block-diagrams, as illustrated in FIGS. 60A, 60B, and 60C, are used to represent a IDE bus design, while the block-diagrams, as illustrated in FIGS. 61A, 61B, and 61C, are used to represent a SCSI bus design; moreover, illustrations that display a LIMDOW and MSR Magneto-Optical Microhead Array Chip Hard Disk Drive's connectivity between LIMDOW or MSR Magneto-Optical Microhead Array Chips, a LIMDOW and MSR Magneto-Optical Microhead Array Chip Hard Disk Drive's Disk Controller, and the Disk Controller's 53 (FIGS. 4, 5, and 81) four main VLSI microprocessors.

Furthermore, a first microprocessor, which is called a “Synchronous Optical Microhead Resource Controller” 62 (FIG. 4) is presented here in two interface formats: an IDE bus design 62 (FIG. 4), and a SCSI bus design 78 (FIG. 5). Both designs as presented here provide, while under program control, local microprocessor services to a LIMDOW and MSR Magneto-Optical Microhead Array Chip Hard Disk Drive's other PCB electronics.

Furthermore, as presented, both Synchronous Optical Microhead Resource Controller designs 62 (FIG. 4), 78 (FIG. 5) will also manage the various resources of a LIMDOW and MSR Magneto-Optical Microhead Array Chip Hard Disk Drive's other PCB electronic-units. A Disk Controller's other PCB electronic-units include an “Optical Microhead And Disk Controller With IDE or SCSI Interface” 55 (FIG. 4), 87 (FIG. 5), a “Spindle And Power Controller” 60 (FIG. 4), 82 (FIG. 5), an “Asynchronous Optical Microhead Address Controller” 63 (FIG. 4), 80 (FIG. 5), a “Serial EEPROM” 75 (FIG. 4), 89 (FIG. 5), and a “SDRAM Buffer” 74 (FIG. 4), 88 (FIG. 5).

In addition, the previously mentioned “Synchronous Optical Microhead Resource Controllers” 62 (FIG. 4), 78 (FIG. 5) will also communicate serially with a “Serial EEPROM” firmware chip 75 (FIG. 4), 89 (FIG. 5), which contains operational program code used by a LIMDOW and MSR Magneto-Optical Microhead Array Chip Hard Disk Drive to conduct various disk and data I/O operations. Primarily, the Synchronous Optical Microhead Resource Controllers will execute the previously mentioned program code to complete hard disk drive power-on-resets, spin-ups, and re-calibration procedures. In addition, the beforementioned Synchronous Optical Microhead Resource Controllers 62, 78 (FIGS. 4, 5, 60A, 60C, 61A, 61C, 62A, 62C, 63A, and 63C), will also, during a LIMDOW and MSR Magneto-Optical Microhead Array Chip Hard Disk Drive's normal operation 74 (FIG. 4), 88 (FIG. 5), read additional operational control code from a disk-platter data-surface and store it in a Disk Controller's memory buffer, which is comprised of (SDRAM) “Synchronous Dynamic Random Access Memory”.

Furthermore, the previously mentioned operational control code is typically called “Operational Code” (Opcode) and is used in much the same way as a host-computer's microprocessor might use a host-computer's disk-stored (OS) “Operation System” software to execute system wide operations. Moreover, the Synchronous Optical Microhead Resource Controllers 62, 78, which are used in both PCB interface designs will run as synchronous devices on their Disk Controller's PCB 55 (FIG. 4), 87 (FIG. 5). In addition, the Serial EEPROMs 75 (FIG. 4), 89 (FIG. 5), used in both PCB interface designs, will also run as synchronous devices, along with a Disk Controller's (SDRAM) “Synchronous Dynamic Random Access Memory” 74 (FIG. 4), 88 (FIG. 5) memory buffer's addressing control, data I/O busing control, and control-bus operating control.

Moreover, the Optical Microhead And Disk Controller With IDE or SCSI Interfaces 55 (FIG. 4), 87 (FIG. 5) will provide control-functions to the LIMDOW and MSR Magneto-Optical Microhead Array Chip Hard Disk Drive s under the direction of their Synchronous Optical Microhead Resource Controllers 62 (FIG. 4), 78 (FIG. 5). The “Optical Microhead And Disk Controller With IDE Interface” bus design (FIG. 4) has a block-diagram that illustrates the various component modules it uses, while displaying their connectivity (FIGS. 62A, 62B, and 62C), as well.

In addition, the “Optical Microhead And Disk Controller With SCSI Interface” bus design (FIG. 5) also has a block-diagram that illustrates the various component modules it uses, while displaying their connectivity (FIGS. 63A, 63B, and 63C). The previously mentioned block-diagrams also illustrate how each of a Disk Controller's microprocessor modules interconnect and communicate with one another to form and facilitate a LIMDOW and MSR Magneto-Optical Microhead Array Chip Hard Disk Drive's control system.

Furthermore, a Optical Microhead And Disk Controller With IDE bus design (FIG. 4) has an (ECC) “Error Correction Control” system built into its “Optical Microhead And Disk Controller With IDE Interface” 55 (FIGS. 4, 62A, 62B, and 62C). In addition, the Optical Microhead And Disk Controller With SCSI bus design (FIG. 5) also has an (ECC) “Error Correction Control” built into its “Optical Microhead And Disk Controller With SCSI Interface” 87 (FIGS. 5, 63A, 63B, and 63C), as well. The Error Correction Codes executed during host-requested read-data or write-data disk-operations are used by both previously mentioned Disk Controllers (FIGS. 4 and 5), and are based upon a Reed-Solomon encoder/decoder circuit's calculated error results.

Furthermore, the previously mentioned Optical Microhead And Disk Controller With IDE bus design (FIG. 4) has a “Data Sequencer” (i.e., sometimes called a Data-Formatter) built into its “Optical Microhead And Disk Controller With IDE Interface” 55 (FIGS. 4, 62A, 62B, and 62C). In addition, the Optical Microhead And Disk Controller With SCSI bus design (FIG. 5) also has a “Data Sequencer” (i.e., sometimes called a Data-Formatter) built into its “Optical Microhead And Disk Controller With SCSI Interface” 87 (FIGS. 5, 63A, 63B, and 63C), as well. The previously mentioned “Data Sequencer” as illustrated in FIGS. 62A, 63A, 62B, 63B, 62C, and 63C is used in both IDE and SCSI interfaces to control the operation of the read and the write-channels of a LIMDOW and MSR Magneto-Optical Microhead Array Chip Hard Disk Drive's Disk Controller 55 (FIG. 4), 87 (FIG. 5).

In addition, to initiate a host-requested disk-operation a “Synchronous Optical Microhead Resource Controller” 62, 78 (FIGS. 4, 5, 62A, 63A, 62C, and 63C) will load a set of commands into a “Writable Control Store Register”, where the loading and manipulation of this register is done through a Synchronous Optical Microhead Resource Controller's “Interface Registers”.

Moreover, as illustrated in FIGS. 60A, 60B, 60C, 61A, 61B, and 61C, a Disk Controller's “Data Sequencer”, as illustrated in FIGS. 62A, 63A, 62C, and 63C, directly controls a (R/-W) “Read and Write Enable” output line, a (-RDTACK) “Read Data Acknowledge” input line, a (-WDTACK) “Write Data Acknowledge” input line, a (MF CLK) “Multiple Frequency Clock” output line, a (DATA RD) “Data Read” input line, a (DATA WR) “Data Write” output line, a (SPDBV1) “SPD Bias Voltage One” output line, a (SPDBV2) “SPD Bias Voltage Two” output line, a (WLV) “Write Laser Voltage” output line, a (RLV) “Read Laser Voltage” output line, and a (SYSCLK) “System Clock” input line.

Furthermore, during host-requested read-data disk-operations a particular data-zone, which is located on a particular LIMDOW disk-platter's data-surface, will need to have its data-sectors, containing host requested data, to be read. Moreover, to accomplish this read-data disk-operation a Disk Controller's “Data Sequencer” (FIGS. 62A, 63A, 62B, 63B, 62C, and 63C) will use a “Data Transfer Rate Frequency Analyzer” circuit to calculate a data-transfer frequency-rate for that particular data-zone. Next, a Data Sequencer's “Multi-Frequency Clock Synthesizer” circuit will commute the previously calculated data-transfer frequency-rate to a (VCO) “Voltage-Controlled Oscillator” circuit located within a Data Sequencer's (DPLL) “Digital Phased-Locked Loop” circuit. Wherein, the previously mentioned (DPLL) “Digital Phased-Locked Loop” circuit, will transmit, after receiving the previously mentioned data-transfer frequency-rate calculation, a (DCLOCK) “Divided Clock” signal to a (MF CLK) “Multi-Frequency Clock” input-connection of a singularly selected LIMDOW or MSR Magneto-Optical Microhead Array Chip, which is positioned above that particular LIMDOW disk-platter's data-zone containing the previously mentioned host-requested data-sectors needing to be read.

Contradictory, during host-requested write-data disk-operations a particular data-zone, which is located on a particular LIMDOW disk-platter's data-surface, will need to have its host requested data-sectors written to. Therefore, a Disk Controller's “Data Sequencer”, illustrated by FIGS. 62A, 63A, 62B, 63B, 62C, and 63C, will also need to perform a data-encoding of data, which is transmitted from the Disk Controller, over a system-bus's write-data line, to a (DIN) “Data In” input of a singularly selected LIMDOW or MSR Magneto-Optical Microhead Array Chip, which is positioned above that particular LIMDOW disk-platter's data-zone containing the previously mentioned host-requested data-sectors to be written to.

Moreover, to accomplish the previously mentioned write-data disk-operation a “Write Driver Circuit” (FIGS. 64A, 64E, 65A, and 65C) will execute data-modulated current amplitudes within a LIMDOW or MSR Magneto-Optical Microhead Array Chip's selected laser-diode or VCSEL microhead when it receives incoming data-streams of encoded data, which are first encoded, then sent, by a Disk Controller's “Data Sequencer”, illustrated by FIGS. 62A, 63A, 62B, 63B, 62C, and 63C, through a shared data-bus line connected to all LIMDOW or MSR Magneto-Optical Microhead Array Chips that are installed into a LIMDOW and MSR Magneto-Optical Microhead Array Chip Hard Disk Drive's unit-assembly.

Furthermore, an Optical Microhead And Disk Controller With IDE Interface processor (FIG. 4) has a “Buffer Controller” built into its “Optical Microhead And Disk Controller With IDE Interface” 55 (FIGS. 4, 62A, 62B, and 62C). In addition, an Optical Microhead And Disk Controller With SCSI Interface processor (FIG. 5) also has a “Buffer Controller” built into its “Optical Microhead And Disk Controller With SCSI Interface” 87 (FIGS. 5, 63A, 63B, and 63B). Moreover, the previously mentioned “Buffer Controller”, illustrated by FIGS. 62A, 63A, 62B, 63B, 62C, and 63C, will support a “4-Mbyte SDRAM” buffer-cache. Moreover, a 32-bit wide implementation of this “buffer-cache” provides a “120” MB/s of maximum buffer bandwidth to a LIMDOW and MSR Magneto-Optical Microhead Array Chip Hard Disk Drive's I/O systems.

Consequently, this increase in bandwidth will allow a “Synchronous Optical Microhead Resource Controller” to have direct access to the buffer itself, eliminating the need for a separate buffer (SDRAM) “Synchronous Dynamic Random Access Memory” resource controller. Moreover, a Disk Controller's “Buffer Controller”, illustrated by FIGS. 62A, 63A, 62B, 63B, 62C, and 63C, and operates under the direction of a Disk Controller's “Synchronous Optical Microhead Resource Controller”.

In addition, an Optical Microhead And Disk Controller With IDE Interface processor 55 (FIGS. 4, 62A, 62B, and 62C) will have a “Resource Controller Interface” built into its “Optical Microhead And Disk Controller With IDE Interface” 55 (FIG. 4). In addition, an Optical Microhead And Disk Controller With SCSI Interface 87 (FIGS. 5, 63A, 63B, and 63C) will also have a “Resource Controller Interface” built into its “Optical Microhead And Disk Controller With SCSI Interface 87 (FIG. 5). The previously mentioned “Resource Controller Interface”, illustrated by FIGS. 62A, 63A, 62B, 63B, 62C, and 63C, for both interface designs, will provide the means for the beforementioned Synchronous Optical Microhead Resource Controllers to read and write (Opcode) “Operational Code” and user data to a Disk Controller's various microprocessor modules; either to control their operations, or to supply them with needed system information.

In addition, the beforementioned “Resource Controller Interface”, as illustrated in FIGS. 62A, 63A, 62B, 63B, 62C, and 63C, consists of both physical and logical components. The physical components of the interface comprise a 32-bit Address-bus, a 32-bit Data-bus, (RD STROBE) “Read Strobe”, (WR STROBE) “Write Strobe” control lines, an (ALE) “Address Latch Enable” control line, and a (WAIT) “Wait” control line. While, the logical components of the previously mentioned “Resource Controller Interface”, as illustrated in FIGS. 62A, 63A, 62B, 63B, 62C, and 63C, comprise “Internal Control Registers” and “Data Registers”, which are both accessible to the beforementioned Disk Controller's “Synchronous Optical Microhead Resource Controller”. Furthermore, by writing to and reading from the previously mentioned logical registers, a Disk Controller's “Synchronous Optical Microhead Resource Controller” can control and configure a Disk Controller's “Buffer Controller” and a Disk Controller's “Data Sequencer”, as well.

In addition, an Optical Microhead And Disk Controller With IDE Interface microprocessor 55 (FIGS. 4, 62A, 62B, and 62C) has a “Serial Interface” built into its Optical Microhead And Disk Controller With IDE Interface 55 (FIG. 4). In addition, an Optical Microhead And Disk Controller With IDE Interface microprocessor 55 (FIGS. 4, 62A, 62B, and 62C) has a “Serial Interface” built into its Synchronous Optical Microhead Resource Controller 62 (FIG. 4). In addition, an Optical Microhead And Disk Controller With SCSI Interface microprocessor 87 (FIGS. 5, 63A, 63B, and 63C) has a “Serial Interface” built into its Optical Microhead And Disk Controller With SCSI Interface 87 (FIG. 5). In addition, an Optical Microhead And Disk Controller With SCSI Interface microprocessor 87 (FIGS. 5, 63A, 63B, and 63C) has a “Serial Interface” built into its “Synchronous Optical Microhead Resource Controller” 78 (FIG. 5). The two Serial Interfaces, as illustrated in FIGS. 62A, 63A, 62B, 63B, 62C, and 63C, will provide a high-speed pathway for firmware operational control-code and data-streams; wherein, the previously mentioned firmware's operational control-code and data-streams are transferred from a Serial EEPROM component 75 (FIGS. 4, 5, and 89) to its Disk Controller 55 (FIG. 4), 87 (FIG. 5), through an executed control of its system's Synchronous Optical Microhead Resource Controller 62 (FIG. 4), 78 (FIG. 5).

In addition, an Optical Microhead And Disk Controller With IDE Interface processor 55 (FIG. 4), (FIG. 62A), (FIG. 62B), (FIG. 62C) has an “IDE Interface Controller” built right into its “Optical Microhead And Disk Controller With IDE Interface” 55 (FIGS. 4, 62A, 62B, and 62C). In addition, an Optical Microhead And Disk Controller With SCSI Interface microprocessor 87 (FIGS. 5, 63A, 63B, and 63C) has a “SCSI Interface Controller” built right into its “Optical Microhead And Disk Controller With SCSI Interface” 87 (FIG. 5). The previously mentioned IDE & SCSI Interface Controllers, as illustrated in FIGS. 62A, 63A, 62B, 63B, 62C, and 63C, provide the data handling, the bus control, and the transfer management services to and from an IDE or SCSI interface. The “Synchronous Optical Microhead Resource Controller” in both IDE & SCSI Disk Controller designs executes the configuration and control of an IDE or SCSI interface across a 32-bit address-bus and 32-bit data-bus, while a Disk Controller's “Buffer Controller” module, as illustrated in FIGS. 4 and 5, controls all data-transfer operations within the beforementioned Disk Controller.

In addition, for the IDE hard disk drive design, interfacing with a host-system is done through a 40-pin IDE interface-connector 52 (FIGS. 4, 62A, 62B, and 62C). Furthermore, the IDE Disk Controller's 55 (FIG. 4) IDE Interface Controller module, as illustrated in FIGS. 62A, 62B, and 62C, implements the IDE interface-logic, while operating under a Resource Controller's processor control. The IDE Disk Controller will receive and transmit words of data over the IDE bus. The IDE Disk Controller's Buffer Controller writes data to or reads data from the SDRAM buffer cache over thirty-two data lines. Furthermore, while under the Resource Controller's direction the IDE Disk Controller 55 (FIG. 4) controls the transfer of data and handles the addressing of the LIMDOW and MSR Magneto-Optical Microhead Array Chip Hard Disk Drive's cache. Moreover, the internal data transfer-rate to and from the LIMDOW and MSR Magneto-Optical Microhead Array Chip Hard Disk Drive's cache will be at “66.66” MB/s. In addition, these high-speed transfer-rates will allow the IDE Disk Controller to communicate over the IDE interface at a PIO data transfer-rate of “13.34” MB/s without using IOREADY “I/O Ready”, at a PIO data transfer-rate up to “33.34” MB/s using IOREADY “I/O Ready”, or at a DMA transfer-rate of “66.66” MB/s using Ultra DMA. Furthermore, the IDE Disk Controller simultaneously controls disk-to-buffer RAM transfers and microcontroller access to control-code stored in the buffer SDRAM's 74 (FIG. 4) memory during data transference across the IDE Interface.

In addition, for the SCSI hard disk drive design, interfacing with a host-system is done through a 50-pin SCSI interface-connector 83 (FIGS. 5, 63A, 63B, and 63C). Furthermore, the SCSI Disk Controller's 87 (FIG. 5) SCSI Interface Controller module, as illustrated in FIGS. 63A, 63B, and 63C, implements the SCSI interface logic, while operating under a Resource Controller's processor control. Furthermore, the SCSI Disk Controller will receive and transmit bytes of data over the SCSI bus. The SCSI Disk Controller's Buffer Controller writes data to or reads data from the SDRAM buffer cache over thirty-two data lines. Furthermore, while under the Resource Controller's direction the SCSI Disk Controller 87 (FIG. 5) controls the transfer of data and handles the addressing of the LIMDOW and MSR Magneto-Optical Microhead Array Chip Hard Disk Drive's cache. Moreover, the internal data transfer rate to and from the LIMDOW and MSR Magneto-Optical Microhead Array Chip Hard Disk Drive's cache is “64” MB/s. This high-speed transfer-rate will allow the SCSI Disk Controller to communicate over the SCSI interface at an asynchronous data transfer-rate of “12” MB/s, or at a synchronous transfer-rate of up to “40” MB/s.

In addition, the SCSI Disk Controller simultaneously controls disk-to-buffer RAM transfers and microcontroller access to control-code stored in the buffer SDRAM's 88 (FIG. 5) memory during data transference across the SCSI Interface. In addition, the LIMDOW and MSR Magneto-Optical Microhead Array Chip Hard Disk Drive design uses a serial connected and code containing Firmware chip, which is comprised of a “Flash EEPROM” chip that contains (Opcode) “Operational Code” 75 (FIGS. 4, 62A, and 62C) 89 (FIGS. 5, 63A, and 63C). The Firmware chip is connected to a LIMDOW and MSR Magneto-Optical Microhead Array Chip Hard Disk Drive's Resource Controller through a high-speed serial connection. Furthermore, this device is programmable and controls various features like disk caching, track-skewing, cylinder-skewing, error detection, and error correction.

In addition, caching for the LIMDOW and MSR Magneto-Optical Microhead Array Chip Hard Disk Drive s will enhance hard disk drive performance and significantly improve system throughput. Furthermore, through a dynamic caching scheme, like the one featured in the LIMDOW and MSR Magneto-Optical Microhead Array Chip Hard Disk Drive design, will make better use of the buffer SDRAM's memory areas 74 (FIGS. 4 and 62C) 88 (FIGS. 5 and 63C). Moreover, with this dynamic caching feature, the buffer's memory space used during a read-data or write-data disk-operation will be dynamically allocated and controlled. In addition, the cache will be flexibly divided into several memory segments under program control with each memory segment containing one cache-entry. Furthermore, a cache-entry will consist of the requested read-data, plus its corresponding prefetch-data.

Consequently, dynamic segmentation will allow LIMDOW and MSR Magneto-Optical Microhead Array Chip Hard Disk Drive s to make optimum use of their cache memory buffers. Moreover, by allowing the amount of stored data to be increased or decreased, which ever is required; dynamically the “dynamic-cache” of LIMDOW and MSR Magneto-Optical Microhead Array Chip Hard Disk Drive s will anticipate host-system requests for data and store that data for faster access. Furthermore, when the host-system requests a particular segment of data the LIMDOW and MSR Magneto-Optical Microhead Array Chip Hard Disk Drive s' dynamic caching feature will use a prefetch strategy. Moreover, a prefetch strategy that looks ahead and automatically stores the subsequent data from a disk-platter's data-surface into a high-speed buffer contained within the SDRAM memory area of the LIMDOW and MSR Magneto-Optical Microhead Array Chip Hard Disk Drive.

Moreover, since fifty-percent or more of all hard disk drive host-requested data-reads are sequential, the beforementioned host-system, more likely, will request the previously cached subsequent-data from the beforementioned SDRAM 74, 88 (FIGS. 4, 5, 62C, and 63C) memory buffer rather than from a particular LIMDOW and MSR Magneto-Optical Microhead Array Chip Hard Disk Drive's disk-platter data-surface sector area. Moreover, the beforementioned subsequent-data, being dynamically stored in high-speed cache, will be retrieved for use in microseconds, rather than in milliseconds. Consequently, the previously mentioned process of “Dynamic Caching” can provide substantial timesaving, during at least half of all hard disk drive data requests.

Therefore, the use of “Dynamic Caching” will save most of the transaction time occurring for a LIMDOW and MSR Magneto-Optical Microhead Array Chip Hard Disk Drive by eliminating the “rotational latency delays” that dominate a typical disk transaction. In addition, the beforementioned process of “Dynamic Caching” also works by continuing to fill its memory areas with adjacent data, while transferring any data requested by the host-system. Therefore, unlike a non-caching Disk Controller, a Disk Controller used in a LIMDOW and MSR Magneto-Optical Microhead Array Chip Hard Disk Drive's design will continue on with further read operations after the requested-data has been transferred to the host-system, via the I/O interface. However, the previously mentioned read operations would terminate after a programmed amount of subsequent-data had been read into a dynamic memory-segment of the beforementioned buffer cache.

In addition, the cache memory will consist of (SDRAM) “Synchronous Dynamic Random Access Memory” 74 (FIGS. 4 and 62C), 88 (FIGS. 5 and 63C), which is allocated to hold data. Moreover, data that can be directly accessed by the host-system, by means of the (RDDATA) “Read Data” and the (WRDATA) “Write Data” commands. Furthermore, the buffer cache memory will function as a group of segments with rollover points at the end of each segment. In addition, the unit of data stored will be a logical block (i.e., a multiple of a 512-byte sector). Therefore, all access to the buffer cache memory must be in multiples of “512” byte size sectors. Furthermore, when a (WRDATA) “Write Data” command is executed LIMDOW and MSR Magneto-Optical Microhead Array Chip Hard Disk Drive s will store the data to be written in a SDRAM cache buffer 74 (FIGS. 4 and 62C), 88 (FIGS. 5 and 63C). In addition, the Buffer Controller will immediately send a (GDDATA) “Good Data” status-message to the host-system before the data can actually be written to a disk-platter's data-surface. The host-system will then be free to move on to other tasks, such as preparing data for the next data-transfer, without having to wait for the LIMDOW and MSR Magneto-Optical Microhead Array Chip Hard Disk Drive to switch to a different microhead located above the appropriate track, or rotate the disk-platters to the specified sector.

Furthermore, while the host-system is preparing data for the next data-transfer, the LIMDOW and MSR Magneto-Optical Microhead Array Chip Hard Disk Drive will immediately write the cached data to a disk-platter's data-sector. This will usually complete the write-operation in less than “20” milliseconds after issuing the (GDDATA) Good Data status-message. Moreover, when writing to the cache, a single-block random write, for example, would require only “3” milliseconds of host-system processing time to execute. Therefore, without the Disk Controller's ability to write to the cache, the same write-operation would have occupied the host-system for about “20” milliseconds.

In addition, writing to cache memory dynamically will allow data to be transferred to a LIMDOW and MSR Magneto-Optical Microhead Array Chip Hard Disk Drive in a continuous flow, rather than as individual blocks of data separated by hard disk drive access delays. This is achieved by taking advantage of a LIMDOW and MSR Magneto-Optical Microhead Array Chip Hard Disk Drive's ability to write blocks of data sequentially to a LIMDOW and MSR Magneto-Optical Microhead Array Chip Hard Disk Drive with data-surfaces that where formatted with a “1:1 hard drive interleave”. This means that as the last byte of data is transferred out of the write-cache and the selected diode laser or VCSEL microhead passes over the next sector of a disk-platter's data-sector the first byte of the next data-block will be transferred, causing no interruption, or delay in the data-transfer process. The write to cache algorithm fills the cache buffer with new data from the host-system, while simultaneously transferring any data that the host-system had previously stored in the cache to the LIMDOW and MSR Magneto-Optical Microhead Array Chip Hard Disk Drive.

Furthermore, a LIMDOW and MSR Magneto-Optical Microhead Array Chip Hard Disk Drive without some kind of cache optimization would suffer just as a conventional hard disk drive would, from delays during a sequential read, which occur simply because all hard disk drive designs exhibit a “rotational latency”. Moreover, even if the selected microhead within that same LIMDOW or MSR Magneto-Optical Microhead Array Chip's microhead array were above the desired data-track to be read “rotational latency” would still be a problem. Therefore, cache optimization eliminates a LIMDOW and MSR Magneto-Optical Microhead Array Chip Hard Disk Drive's rotational latency time (i.e., on the average a “7.50” millisecond time period); moreover, when the requested-data resides in the cache.

However, the hard disk drives of today must often service requests from multiple processes in a multitasking or multi-user environment. Furthermore, in these instances, while each process might request-data sequentially, a hard disk drive must time-share among all these processes. Moreover, in conventional hard disk drive designs, the data-heads must move from one-track location to another. Therefore, with cache optimization, even if another process interrupts, the hard disk drive will continue to access the data sequentially from its high-speed cache memory. Therefore, in handling multiple processes, and when the desired data resides in the cache, cache memory optimization will achieve its most impressive performance gains, saving on both seek and latency times.

Furthermore, the cache can be flexibly divided into several memory-segments, under program control, with each memory-segment containing one cache-entry. Moreover, a cache-entry would consist of requested read-data along with any corresponding prefetch-data. The requested read-data will take up a certain amount of space in the cache-segment so the corresponding prefetch-data can essentially occupy the rest of the available space within that memory-segment. Other factors determining prefetch size are the maximum and minimum prefetch settings present in a Disk Controller's circuit design. Furthermore, the LIMDOW and MSR Magneto-Optical Microhead Array Chip Hard Disk Drive's prefetch algorithm will dynamically control the actual prefetch value based on the current demands, with consideration for overhead to subsequent commands.

Another Firmware feature incorporated into a LIMDOW and MSR Magneto-Optical Microhead Array Chip Hard Disk Drive's LIMDOW or MSR Microhead Array Chips is “Track Skewing”. Track Skewing reduces the latency time that results from a hard disk drive's switching of a read or write data-head to access sequential data. Moreover, a track skew is employed in such a way that the next logical sector of data to be accessed will be under the read or write microhead once the microhead switch has been made and that same data is ready to be accessed. In addition, when sequential-data is on the same cylinder, but on a different disk-surface, a microhead switch would also need to be executed. Since sequential microhead switching times are well defined within the LIMDOW and MSR Magneto-Optical Microhead Array Chip Hard Disk Drive design, the sector being addressed can be optimally positioned across track-boundaries to minimize any latency time accrued during LIMDOW or MSR Magneto-Optical Microhead Array Chip's microhead switching.

Another Firmware feature incorporated into LIMDOW and MSR Magneto-Optical Microhead Array Chip Hard Disk Drive design is “Cylinder Skewing”. Cylinder Skewing is also used to help minimize the latency time associated with “single-cylinder seeks”. A cylinder skew is employed in such a way that the next logical sector of data that crosses a cylinder boundary will be positioned on the hard drive's disk-platter, after a single-cylinder seek is performed. Moreover, when a LIMDOW and MSR Magneto-Optical Microhead Array Chip Hard Disk Drive is ready to continue accessing data, the sector to be accessed will be positioned directly under the addressed read or write microhead. Therefore, the cylinder skew can take place between the last-sector of data of a cylinder and the first-sector of data of the hard drive disk-platter's next cylinder.

In addition, the LIMDOW and MSR Magneto-Optical Microhead Array Chip Hard Disk Drives will also incorporate an “ID-less Format” for tracking sector locations across its data-surfaces. Moreover, the ID-Less Format has several advantages over the traditional “ID After Wedge” or “ID Before Sector” methods of sector tracking. For example, the lack of an “ID field” written to hard drive disk-platter data-surfaces will regain approximately “4” percent of the overall track real-estate present within the LIMDOW and MSR Magneto-Optical Microhead Array Chip Hard Disk Drive's unit-assembly.

Furthermore, since no ID's have to be read or corrected in case of an error, the drives overall throughput is also increased. In ID-Less Formatting of data-sectors, the ID of each sector is not written onto a disk-platter's data-surface, instead it is stored in a SDRAM's 74 (FIGS. 4 and 62C) 88 (FIGS. 5 and 63C) buffer memory area, which is called the “Descriptor”.

In addition, each data-sector will have an associated Descriptor containing the rotational start-time for each sector's disk location. Subsequently, the Descriptor does not have any defect information stored within its memory areas. LIMDOW and MSR Magneto-Optical Microhead Array Chip Hard Disk Drive s will also store a “Defect Map” within the hard disk drive's SDRAM's 74 (FIGS. 4 and 62C) 88 (FIGS. 5 and 63C) buffer memory, but in a separate memory-location away from the Descriptor. Subsequently, for the LIMDOW and MSR Magneto-Optical Microhead Array Chip Hard Disk Drive design the Sequencer section of the Disk Controller will have access to both the Descriptor and the Defect Map listings through requests made to the buffer-block within the Disk Controller. Therefore, only “end user data” and ECC information are actually written to the LIMDOW and MSR Magneto-Optical Microhead Array Chip Hard Disk Drive's disk-platter data-surfaces.

In addition, error detection and correction for the LIMDOW and MSR Magneto-Optical Microhead Array Chip Hard Disk Drive design will become a concern as the LIMDOW and MSR Magneto-Optical Microhead Array Chip Hard Disk Drive's areal densities continue to increase. Moreover, the obtaining of extremely low error-rates will require sophisticated (ECC) “Error Correction Codes”. Furthermore, LIMDOW and MSR Magneto-Optical Microhead Array Chip Hard Disk Drive s will implement a Reed-Solomon error correction technique to reduce the uncorrectable read-error rates of any data-bits being read. Therefore, when errors do occur, an automatic retry, a double-burst, and a more rigorous triple-burst correction algorithm will enable the correction of any data-sector with three-bursts of four incorrect-bytes each. Furthermore, before invoking the complex triple-burst ECC algorithm the LIMDOW and MSR Magneto-Optical Microhead Array Chip Hard Disk Drive design will always try to recover from an error by attempting to re-read the data correctly.

Furthermore, this strategy prevents the invoking of correction, on non-repeatable errors. Moreover, each time a data-sector in error is re-read, a set of ECC syndromes has to be computed, and this is a very wasteful use of processing time. Therefore, if the entire syndrome-values equal zero, the data was read with no errors and, therein the data-sector is transferred to the host-system. However, if any of the syndrome-values do not equal zero an error has occurred, the syndrome-values are retained, and another re-read is invoked. Non-repeatable errors are usually related to the signal-to-noise ratio of the system and are not due to media-defects.

Furthermore, when sets of syndromes from two consecutive re-reads are the same, a stable-syndrome has been achieved. This event may be significant depending on whether or not the automatic read-reallocation or early-correction features have been enabled within the LIMDOW and MSR Magneto-Optical Microhead Array Chip Hard Disk Drive's unit-assembly. In addition, if an early correction feature has been enabled and a stable-syndrome has been achieved, triple-burst ECC correction is applied, and the appropriate message will be transferred to the host-system (e.g., corrected data, etc.). The ECC bit will enable early ECC triple-burst correction if a stable-syndrome has been achieved before all of the re-reads have been exhausted. Therefore, if the automatic read-reallocation feature is enabled, the drive, when encountering triple-burst errors, will attempt to re-read the data. In addition, LIMDOW and MSR Magneto-Optical Microhead Array Chip Hard Disk Drive s will be equipped with an automatic read-reallocation feature, so any new defective data-sectors can be easily and automatically reallocated for the end-user.

In addition, to accommodate inline-sparing of defective sectors LIMDOW and MSR Magneto-Optical Microhead Array Chip Hard Disk Drive s will allocate thousands of extra data-sectors to the end of its physical data storage area. While in the factory, the media will be scanned for defects, and if a data-sector is found defective, the address of the defective data-sector is added to LIMDOW and MSR Magneto-Optical Microhead Array Chip Hard Disk Drive's Defect Map listing. Data sectors located physically after the defective data-sector moreover will be assigned logical block addresses, so that a sequential ordering of logical blocks can be maintained. The inline-sparing technique will be maintained in an attempt to eliminate any slow data-transfers, which result from a single defective data-sector on a cylinder. Subsequently, all factory defective data-sectors will be inline-spared, but if a defective data-sector is found in the field, inline-sparing will not be performed on those sectors. Instead, the data-sector will be reallocated to an available spare-sector on a nearby cylinder, while its previous sector location is marked as being bad.

Another preferred first and basic embodiment of the present invention, as illustrated in FIGS. 7, 11, 13, 27, and 28, defines chip configurations for a “Bottom Data-Surface LIMDOW or MSR Magneto-Optical Microhead Array Chip”, and a “Top Data-Surface LIMDOW or MSR Magneto-Optical Microhead Array Chip”. Wherein, each LIMDOW or MSR Magneto-Optical Microhead Array Chip has a different surface mounting circuit-contact pin-out arrangement. The illustrations in drawing FIGS. 7, 11, 13, 27, and 28 display a Bottom Data-Surface LIMDOW or MSR Magneto-Optical Microhead Array Chip's circuit-contact pin-out arrangements, while the illustrations in drawing FIGS. 8, 12, 14, 25, and 26 display a Top Data-Surface LIMDOW or MSR Magneto-Optical Microhead Array Chip's circuit-contact pin-out arrangements. In addition, illustrations in FIGS. 7, 11, 13, 27, 28, 8, 12, 14, 25, and 26 show how the bus-system and bus-system cables are connected and used in the LIMDOW and MSR Magneto-Optical Microhead Array Chip Hard Disk Drives, while explaining why there needs to be two different LIMDOW or MSR Magneto-Optical Microhead Array Chip circuit-contact pin-out arrangements.

Moreover, when a Bottom Data-Surface LIMDOW or MSR Magneto-Optical Microhead Array Chip 6 is used in a LIMDOW and MSR Magneto-Optical Microhead Array Chip Hard Disk Drive (FIGS. 7 and 28) it is installed into a chip-positioning circuit board with its diode laser or VCSEL microhead array facing upward toward the observer, if the observer is looking down into a plan view of the chip through the Cartesian Y-axis. Moreover, when installed, a Bottom Data-Surface LIMDOW or MSR Magneto-Optical Microhead Array Chip's 6 (FIGS. 7, 11, 13, and 28) pin-one designation dot should be located in the upper-left hand corner of the beforementioned LIMDOW or MSR Magneto-Optical Microhead Array Chip's outer-package.

Alternatively, when a Top Data-Surface LIMDOW or MSR Magneto-Optical Microhead Array Chip 6 (FIGS. 8 and 25) is used in a LIMDOW and MSR Magneto-Optical Microhead Array Chip Hard Disk Drive it is installed into a chip-positioning circuit board with its diode laser or VCSEL microhead array facing downward away from an observer, if the observer is looking down into a plan view of the chip through the Cartesian Y-axis. Moreover, when installed a Top Data-Surface LIMDOW or MSR Magneto-Optical Microhead Array Chip's 6 (FIGS. 8, 12, 14, and 25) pin-one designation dot should also be located in the upper-left hand corner of the beforementioned LIMDOW or MSR Magneto-Optical Microhead Array Chip's outer-package.

Furthermore, when LIMDOW or MSR Magneto-Optical Microhead Array Chips are installed into their chip-positioning circuit boards, and their chip-positioning circuit boards are installed into a LIMDOW and MSR Magneto-Optical Microhead Array Chip Hard Disk Drive's casting-base, there will ultimately be one LIMDOW or MSR Magneto-Optical Microhead Array Chip that is positioned for and facing each data-surface of every disk-platter installed into a LIMDOW and MSR Magneto-Optical Microhead Array Chip Hard Disk Drive's unit-assembly.

Moreover, the arrangement described above is how both LIMDOW and MSR Magneto-Optical Microhead Array Chip designs will align with each other when installed and connected into a LIMDOW and MSR Magneto-Optical Microhead Array Chip Hard Disk Drive's unit-assembly and bus-system. In addition, when installed into a LIMDOW and MSR Magneto-Optical Microhead Array Chip Hard Disk Drive's unit-assembly, there should be at-least two diode laser or VCSEL microhead arrays facing each other (FIGS. 9 and 10) with at-least one disk-platter 13 (FIGS. 1, 2, and 3) positioned between them; moreover, as if each installed LIMDOW or MSR Magneto-Optical Microhead Array Chip were looking at a reflection of itself in a mirror. Furthermore, the main reason for this approach is to simplify a LIMDOW and MSR Magneto-Optical Microhead Array Chip Hard Disk Drive's bus-system design, and to create a simple form of connectivity and construction for a LIMDOW and MSR Magneto-Optical Microhead Array Chip Hard Disk Drive's unit-assembly.

Another preferred first and basic embodiment of the present invention, as illustrated in drawing FIGS. 1, 6, 9, 10, and 15, shows Polymer flex-cable connectors 34, 67 (FIGS. 1, 6, 9, and 10) and their associated Polymer flex-cables 36 (FIGS. 1, 6, 10, and 15), which are located, when looking down into a plan view illustration of a LIMDOW and MSR Magneto-Optical Microhead Array Chip Hard Disk Drive's unit-assembly, on both the right-hand side and left-hand side of the beforementioned LIMDOW and MSR Magneto-Optical Microhead Array Chip Hard Disk Drive's chip-positioning circuit boards. Wherein, Polymer flex-cable connectors and Polymer flex-cables, if installed on the right-hand side of a LIMDOW and MSR Magneto-Optical Microhead Array Chip Hard Disk Drive's unit-assembly are dedicated to the Power, the Ground, the Data I/O, and the Control bus-systems that are used in a LIMDOW and MSR Magneto-Optical Microhead Array Chip Hard Disk Drive.

Furthermore, the previously mentioned Polymer flex-cables 36 (FIGS. 1, 6, 10, and 15) and their associated Polymer flex-cable connectors 34, 67 (FIGS. 1, 6, 9, and 10), which are located on the right-hand side of a LIMDOW and MSR Magneto-Optical Microhead Array Chip Hard Disk Drive's unit-assembly (FIG. 117), create multiple circuit connections between chip-connecting contact-points that are located on the right-hand side of installed LIMDOW or MSR Magneto-Optical Microhead Array Chips 7, 8 (FIGS. 7, 8, 26, and 27), and a Disk Controller's (PCB) “Printed Circuit Board”. Moreover, the Disk Controller PCB used in LIMDOW and MSR Magneto-Optical Microhead Array Chip Hard Disk Drive s is located underneath a LIMDOW and MSR Magneto-Optical Microhead Array Chip Hard Disk Drive's Spindle-Motor unit-assembly at the bottom of a LIMDOW and MSR Magneto-Optical Microhead Array Chip Hard Disk Drive's casting-base 12 (FIGS. 1, 2, and 3).

However, if the Polymer flex-cable connectors 40, 67 (FIGS. 1, 6, 9, and 10), and their associated Polymer flex-cables 38 (FIGS. 1, 6, 10, and 16), are installed on the left-hand side of a LIMDOW and MSR Magneto-Optical Microhead Array Chip Hard Disk Drive's unit-assembly, they are dedicated to the 32-bit Microhead-Addressing bus-systems of the LIMDOW and MSR Magneto-Optical Microhead Array Chip Hard Disk Drive. Furthermore, the beforementioned Polymer flex-cables 38 (FIGS. 1, 6, 10, 16), and their Polymer flex-cable connectors 40, 67 (FIGS. 1, 6, 9, and 10), which are located on the left-hand side of a LIMDOW and MSR Magneto-Optical Microhead Array Chip Hard Disk Drive's unit-assembly (FIG. 117), create multiple circuit connections between the chip-connecting contact-points that are located on the left-hand side of installed LIMDOW or MSR Magneto-Optical Microhead Array Chips 9, 10 (FIGS. 7, 8, 26, and 27), and a Disk Controller's (PCB) “Printed Circuit Board”. Moreover, the Disk Controller PCB used in a LIMDOW and MSR Magneto-Optical Microhead Array Chip Hard Disk Drive is located underneath a LIMDOW and MSR Magneto-Optical Microhead Array Chip Hard Disk Drive's Spindle-Motor unit-assembly at the bottom of a LIMDOW and MSR Magneto-Optical Microhead Array Chip Hard Disk Drive's casting-base 12 (FIGS. 1, 2, and 3).

Another preferred first and basic embodiment of the present invention, as illustrated in drawing FIGS. 26 and 27, shows a “Chip Placement Key” 11, which is located on the outer-package bottom-surface areas of LIMDOW or MSR Magneto-Optical Microhead Array Chips. Moreover, the previously mentioned “Chip Placement Key” 11 (FIGS. 26 and 27), which is shaped like a triangle, and located at the bottom-center of every LIMDOW or MSR Magneto-Optical Microhead Array Chip's outer-package, when installed, will have its triangle-apex facing toward the front of its outer-package's top-edge surface, while facing a LIMDOW and MSR Magneto-Optical Microhead Array Chip Hard Disk Drive's front-end. In addition, the “Chip Placement Keys” used in the LIMDOW or MSR Magneto-Optical Microhead Array Chips protrude about “1/16” of one inch out from underneath the bottom-center surface of a LIMDOW or MSR Magneto-Optical Microhead Array Chip's outer-package 11 (FIGS. 26 and 27). Furthermore, the sidewalls of the beforementioned “Chip Placement Keys” form “90” degree angles from the bottom-surface of its outer-package. In addition, the triangular-shaped “Chip Placement Keys” 11 (FIGS. 26 and 27) will also have a corresponding and triangular-shaped “Chip Placement Keyhole” 92 (FIGS. 30, 32, 35, and 37). Moreover, the previously mentioned “Chip Placement Keyholes” are located at the top-surface of the bottom-inside center mounting-plane of every chip-positioning circuit board's surface-mounted chip-socket.

In addition, the previously mentioned “Chip Placement Keyholes” 92 are also triangle-shaped and have a machined-out recess that measures “1/16” of one-inch from the top-surface of the bottom-inside center mounting-plane of every chip-positioning circuit board's surface-mounted chip-socket. Moreover, the sidewalls of the Chip Placement Keyholes will form “270” degree angles from the exposed bottom-center top-surface of every chip-positioning circuit board's surface-mounted chip-socket 92 (FIGS. 30, 32, 35, and 37).

Furthermore, the manufacturing and machining dimensions for the “Chip Placement Keys” 11 (FIGS. 26 and 27) and “Chip Placement Keyholes” 92 (FIGS. 30, 32, 35, and 37) are critical and must adhere to a tolerance that is plus or minus “1/1000” of one-inch. Moreover, the previously mentioned dimensional tolerance used for the “Chip Placement Keys” and “Chip Placement Keyholes” is necessary to insure an accurate, a secure, and a non-compromizable placement of the beforementioned LIMDOW or MSR Magneto-Optical Microhead Array Chips into surface-mounted chip-sockets of installed chip-positioning circuit boards.

Furthermore, the installation of the LIMDOW or MSR Magneto-Optical Microhead Array Chips into their chip-positioning circuit board's surface-mounted chip-sockets is done using two LIMDOW or MSR Magneto-Optical Microhead Array Chip's chip-mounting threaded hex-screws 2 (FIGS. 1, 6, 7, and 8). Moreover, the two chip-mounting hex-screws thread into a surface-mounted chip-socket's two hex-screw holes 92 (FIGS. 30, 32, 35, and 37). This will completely seat and secure the LIMDOW or MSR Magneto-Optical Microhead Array Chips into their surface-mounted chip-socket's inside-bottom chip mounting surface 92 (FIGS. 30, 32, 35, and 37).

In addition, the removal or displacement of a LIMDOW or MSR Magneto-Optical Microhead Array Chip after its installation into a chip-positioning circuit board's surface-mounted chip-socket should only occur if a LIMDOW or MSR Magneto-Optical Microhead Array Chip has failed. Moreover, a failed LIMDOW or MSR Magneto-Optical Microhead Array Chip would then need to be removed and replaced with a new and fully functioning LIMDOW or MSR Magneto-Optical Microhead Array Chip. However, if a LIMDOW or MSR Magneto-Optical Microhead Array Chip were replaced the newly installed LIMDOW or MSR Magneto-Optical Microhead Array Chip would need to be used to execute a low-level and operating system reformatting of the disk-platter data-surface located under the LIMDOW or MSR Magneto-Optical Microhead Array Chip replacement. After a low-level and operating system reformatting of the disk-platter data-surface located under the replacement chip has been executed, the newly installed replacement LIMDOW or MSR Magneto-Optical Microhead Array Chips should never be re-adjusted or moved in any way, or again, a new low-level and operating system reformatting of the adjusted LIMDOW or MSR Magneto-Optical Microhead Array Chip's disk-platter data-surface would be required.

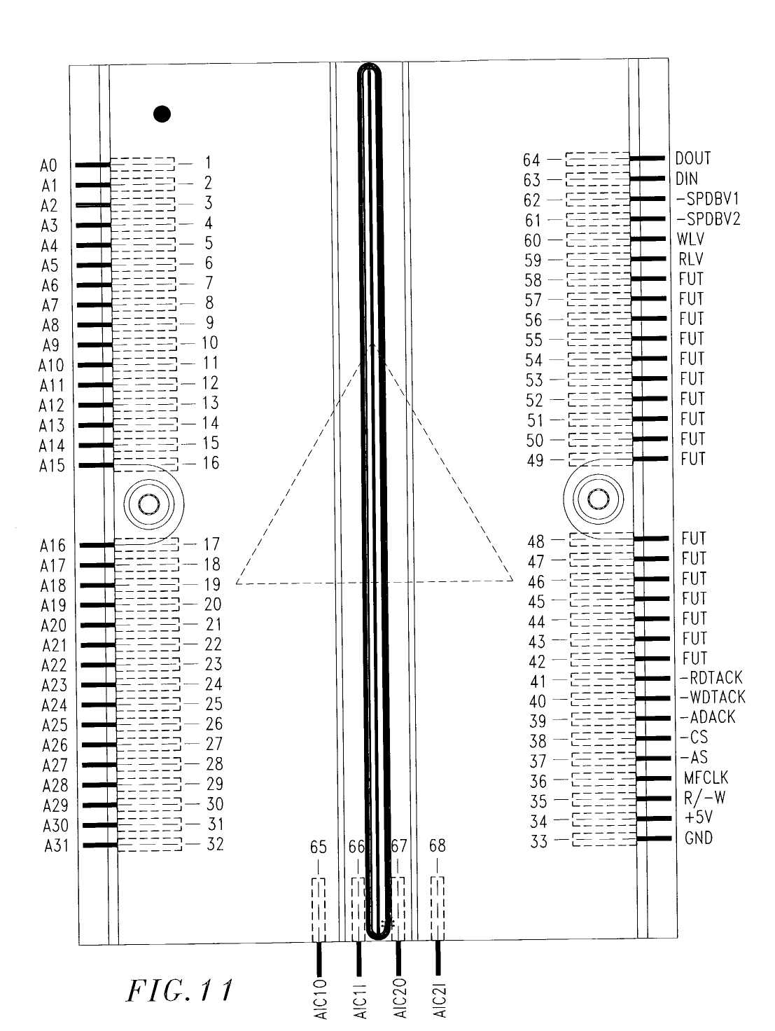

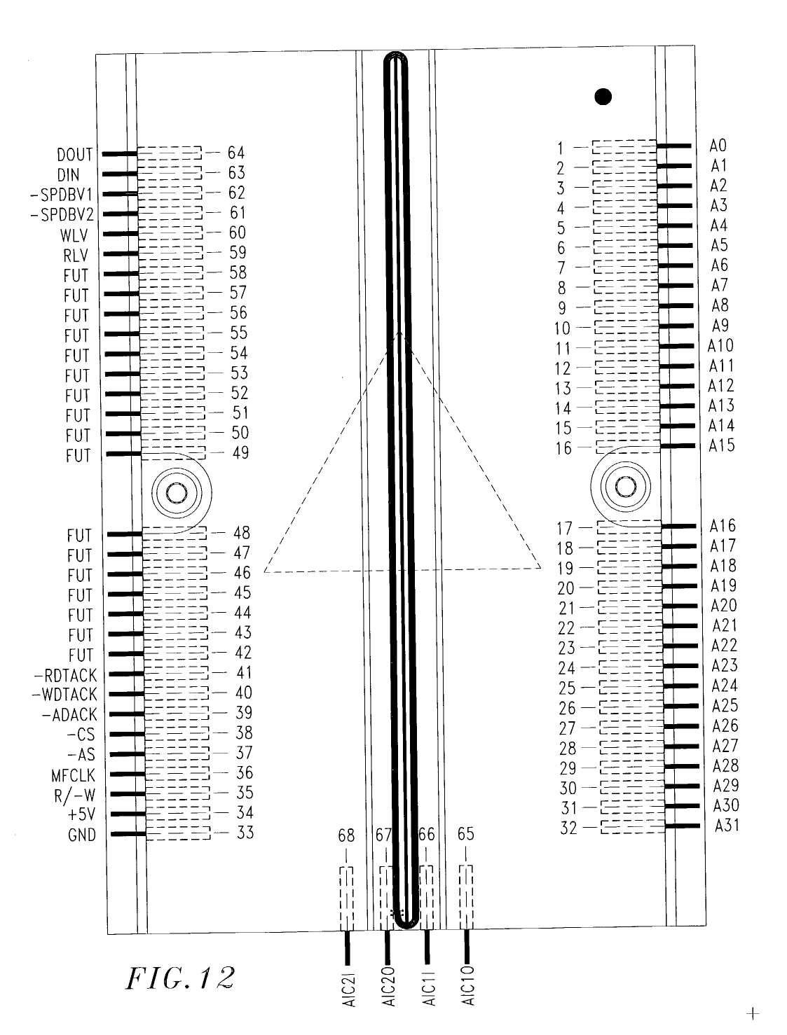

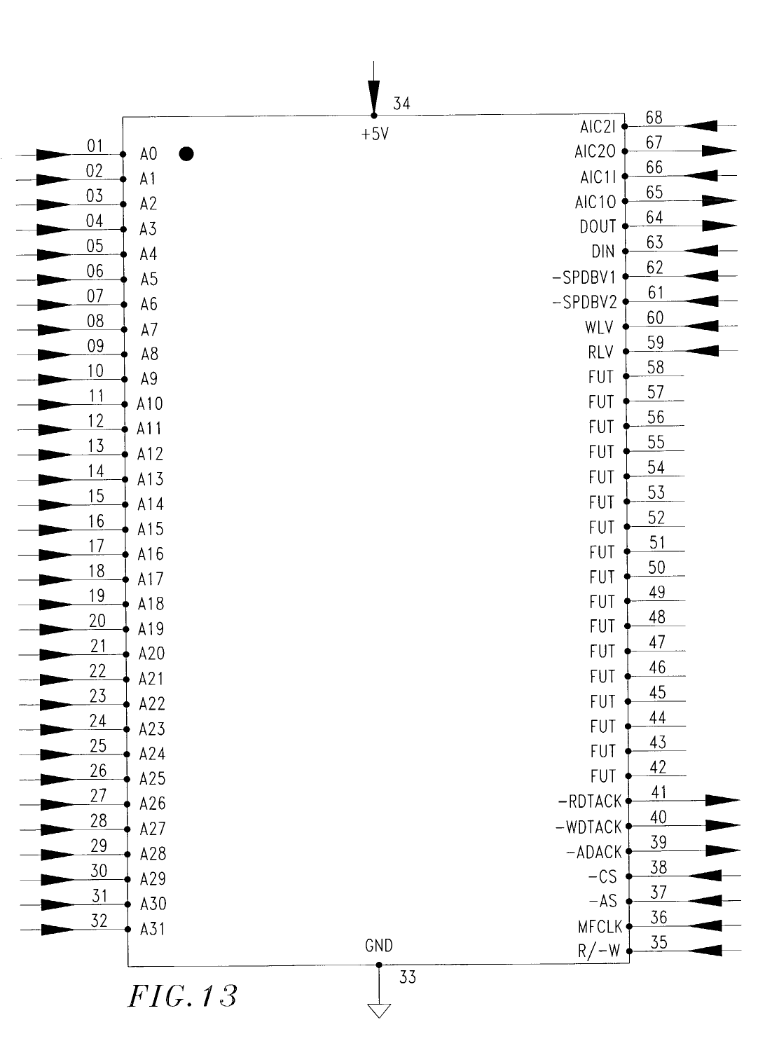

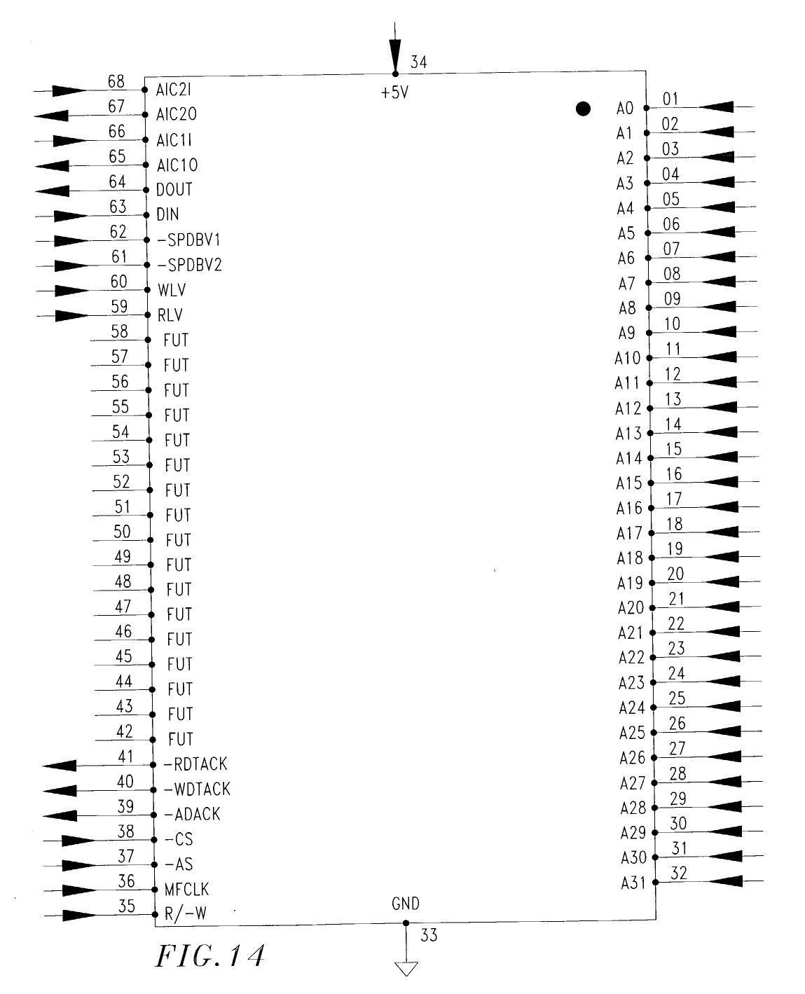

Another preferred first and basic embodiment of the present invention, as illustrated in drawing FIGS. 26 and 27, shows a LIMDOW or MSR Magneto-Optical Microhead Array Chip's sixty-eight circuit connecting contacts, which are physically embedded into the bottom-surface 7, 8, 9, 10 (FIGS. 26 and 27) of every LIMDOW or MSR Magneto-Optical Microhead Array Chip's outer-package. Moreover, for every LIMDOW or MSR Magneto-Optical Microhead Array Chip's sixty-eight embedded circuit connecting contacts there is a matching set of sixty-eight circuit connecting contacts 92 (FIGS. 30, 32, 35, and 37), which are physically embedded into the top-surface of the bottom-inside center mounting-plane of every chip-positioning circuit board's surface-mounted chip-socket 5 (FIGS. 1, 2, 7, and 8). When viewing a LIMDOW or MSR Magneto-Optical Microhead Array Chip in a plan-view the location of a LIMDOW or MSR Magneto-Optical Microhead Array Chip's pin-one designation dot can be clearly seen 6 (FIGS. 1, 7, 8, 25, and 28). Moreover, the pin-one designation dot of a plan-viewed LIMDOW or MSR Magneto-Optical Microhead Array Chip indicates that its either a “Top Data-Surface LIMDOW or MSR Magneto-Optical Microhead Array Chip” or a ‘Bottom Data-Surface LIMDOW or MSR Magneto-Optical Microhead Array Chip ”. Therefore, the pin-one designation dot of a plan-viewed LIMDOW or MSR Magneto-Optical Microhead Array Chip, also indicates, by way of reference, the locations, the names, and the number-designations of the viewed LIMDOW or MSR Magneto-Optical Microhead Array Chip's sixty-eight embedded circuit-connecting contacts, as illustrated in FIGS. 11 and 12.

Therefore, when viewing a LIMDOW or MSR Magneto-Optical Microhead Array Chip with its microheads facing upward in a portrait plan-view position, its pin-one designation dot will be located in the upper left-hand corner of its outer-package, which indicates that it is an installed “Bottom Data-Surface LIMDOW or MSR Magneto-Optical Microhead Array Chip”. In addition, when viewing a LIMDOW or MSR Magneto-Optical Microhead Array Chip with its microheads facing downward in a portrait plan-view position, its pin-one designation dot will also be located in the upper left-hand corner of its outer-package, which indicates that it is an installed “Top Data-Surface LIMDOW or MSR Magneto-Optical Microhead Array Chip”.

However, when viewing a LIMDOW or MSR Magneto-Optical Microhead Array Chip with its microheads facing upward in a portrait plan-view position, while its pin-one designation dot is located in the upper left-hand corner of its outer-package, would indicate that this is an un-installed “Bottom Data-Surface LIMDOW or MSR Magneto-Optical Microhead Array Chip” 6 (FIGS. 1, 7, 11, 13, and 28). In addition, when viewing a LIMDOW or MSR Magneto-Optical Microhead Array Chip with its microheads again facing upward in a portrait plan-view position, while its pin-one designation dot is located in the upper right-hand corner of its outer-package, would indicate that this is an un-installed “Top Data-Surface LIMDOW or MSR Magneto-Optical Microhead Array Chip” 6 (FIGS. 1, 8, 12, 14, and 25).

Furthermore, the plan-viewed and un-installed version of a “Bottom Data-Surface LIMDOW or MSR Magneto-Optical Microhead Array Chip” has its 32-bit Microhead-Addressing bus-circuit's connecting input-contacts (FIG. 11) located on the left-hand side of its outer-package's bottom-surface 9, 10 (FIGS. 7, 11, and 27). Moreover, the thirty-two Microhead-Addressing and bus-circuit connecting input-contacts are presented as two groups of sixteen input-contacts 9, 10 (FIGS. 7, 11, and 27). Moreover, a group number-one will contain input-contacts zero to sixteen 10 (FIGS. 1, 7, and 11), while a group number-two will contain input-contacts seventeen to thirty-one 9 (FIGS. 1, 7, and 11). The two groups of sixteen circuit-connecting input-contacts are physically separated from each other by a LIMDOW or MSR Magneto-Optical Microhead Array Chip's chip installing hex-screws 2 (FIGS. 1 and 7), and hex-screw holes 3 (FIGS. 1, 7, and 28). However, when logically combined, the previously mentioned two groups of sixteen circuit-connecting input-contacts complete a 32-bit Microhead-Addressing bus-system's contact configuration.

Furthermore, the beforementioned plan-viewed and un-installed “Bottom Data-Surface LIMDOW or MSR Magneto-Optical Microhead Array Chip”, should have its control and data I/O bus-circuit's connecting contacts (FIG. 11) located on the right-hand side of its outer-package's bottom-surface 7, 8 (FIGS. 1, 7, and 27). Furthermore, the thirty-two control and data I/O bus-circuit connecting contacts are presented as two groups of sixteen contacts 7, 8 (FIGS. 1, 7, and 27). Wherein, group number one will contain contacts thirty-two to forty-eight 8 (FIGS. 1, 7, and II), while group number two will contain contacts forty-nine to sixty-four 7 (FIGS. 1, 7, and 11). Furthermore, the previously mentioned two groups of sixteen circuit-connecting contacts are physically separated from each other by a LIMDOW or MSR Magneto-Optical Microhead Array Chip's installation hex-screw 2 (FIGS. 1 and 7), and hex-screw hole 3 (FIGS. 1, 7, and 28). However, when logically combined, the previously mentioned two groups of sixteen circuit-connecting contacts complete a control and data I/O bus-system's contact configuration.

Furthermore, the beforementioned plan-viewed and un-installed “Top Data-Surface LIMDOW or MSR Magneto-Optical Microhead Array Chip”, should have its 32-bit Microhead-Addressing bus-circuit's connecting input-contacts (FIG. 12) located on the right-hand side of its outer-package's bottom-surface 9, 10 (FIGS. 8 and 26). Furthermore, the thirty-two Microhead-Addressing bus-circuit-connecting input-contacts are presented as two groups of sixteen input-contacts 9, 10 (FIGS. 8 and 26). Wherein, group number one will contain input-contacts zero to sixteen 10 (FIGS. 8 and 12), while group number two will contain input-contacts seventeen to thirty-one 9 (FIGS. 8 and 12). Furthermore, the previously mentioned two groups of sixteen circuit-connecting input-contacts are physically separated from each other by a LIMDOW or MSR Magneto-Optical Microhead Array Chip's installation hex-screw 2 (FIG. 8), and hex-screw hole 3 (FIGS. 8 and 25). However, when logically combined, the previously mentioned two groups of sixteen circuit-connecting input-contacts complete a 32-bit Microhead-Addressing bus-system's contact configuration.

Furthermore, the beforementioned plan-viewed and un-installed “Top Data-Surface LIMDOW or MSR Magneto-Optical Microhead Array Chip”, should have its control and data I/O bus-circuit's connecting contacts (FIG. 12) located on the left-hand side of its outer-package's bottom-surface 7, 8 (FIGS. 8 and 26). Furthermore, the thirty-two control and data I/O bus-circuit connecting contacts are presented as two groups of sixteen contacts 7, 8 (FIGS. 8 and 26). Wherein, group number one will contain contacts thirty-two to forty-eight 8 (FIGS. 8 and 12), while group number two will contain contacts forty-nine to sixty-four 7 (FIGS. 8 and 12). Furthermore, the previously mentioned two groups of sixteen circuit-connecting contacts are physically separated from each other by a LIMDOW or MSR Magneto-Optical Microhead Array Chip's installation hex-screw 2 (FIG. 8) and hex-screw hole 3 (FIGS. 8 and 25). However, when logically combined, the previously mentioned two groups of sixteen circuit-connecting contacts complete a control and data I/O bus-system's contact configuration.

Furthermore, a plan-viewed and installed “Bottom Data-Surface LIMDOW or MSR Magneto-Optical Microhead Array Chip” will have its pin-one designation dot located in the upper left-hand corner of a LIMDOW or MSR Magneto-Optical Microhead Array Chip's outer-package 6 (FIGS. 1, 7, and 28). Moreover, a beforementioned plan-viewed and installed “Bottom Data-Surface LIMDOW or MSR Magneto-Optical Microhead Array Chip” (FIGS. 29 and 34) has its 32-bit addressing bus-circuit's connecting input-contacts (FIG. 11) located on the left-hand side of its outer-package's bottom-surface 9, 10 (FIGS. 7 and 27). In addition, a beforementioned plan-viewed and installed “Bottom Data-Surface LIMDOW or MSR Magneto-Optical Microhead Array Chip” (FIGS. 29 and 34) has its input-contacts one to thirty-two FIG. 11 dedicated to its 32-bit addressing bus-circuit.

In conclusion, an installed “Bottom Data-Surface LIMDOW or MSR Magneto-Optical Microhead Array Chip” connects its 32-bit addressing bus-circuit to a LIMDOW and MSR Magneto-Optical Microhead Array Chip Hard Disk Drive's Disk Controller and its bus-system through its surface-mounted chip-socket's “A0” to “A31” connection-contacts, as illustrated in FIG. 11.

Furthermore, the plan-viewed and installed “Bottom Data-Surface LIMDOW or MSR Magneto-Optical Microhead Array Chip” will have its pin-one designation dot located in the upper left-hand corner of a LIMDOW or MSR Magneto-Optical Microhead Array Chip's outer-package 6 (FIGS. 1, 7, and 28). Moreover, a plan-viewed and installed “Bottom Data-Surface LIMDOW or MSR Magneto-Optical Microhead Array Chip” (FIGS. 29 and 34) has its control and data I/O bus-circuit's connecting-contacts (FIG. 11) located on the right-hand side of its outer-package's bottom-surface 7, 8 (FIGS. 7 and 27).

In addition, a beforementioned plan-viewed and installed “Bottom Data-Surface LIMDOW or MSR Magneto-Optical Microhead Array Chip” (FIGS. 29 and 34) has contacts thirty-three to thirty-eight (FIG. 11) dedicated to its (GND) “Ground” output-contact, its (+5) “VDD Power” input-contact, its (R/-W) “Read or Write Enable” input-contact, its (MFCLK) “Multi-Frequency Clock” input-contact, its (-AS) “Address Strobe” input-contact, and its (-CS) “Chip Select” input-contact, as illustrated in FIG. 11.

In addition, a plan-viewed and installed “Bottom Data-Surface LIMDOW or MSR Magneto-Optical Microhead Array Chip” (FIGS. 29 and 34) has contacts thirty-nine to forty-one (FIG. 11) dedicated to its (-ADACK) “Address Acknowledge” output-contact, its (-WDTACK) “Write Data Acknowledge” output-contact, and its (-RDTACK) “Read Data Acknowledge” output-contact, as illustrated in FIG. 11.

In addition, a plan-viewed and installed “Bottom Data-Surface LIMDOW or MSR Magneto-Optical Microhead Array Chip” (FIGS. 29 and 34) has contacts forty-two to sixty-two (FIG. 1) dedicated to its (FUT) “Future” I/O contacts, as illustrated in FIG. 11. In addition, a plan-viewed and installed “Bottom Data-Surface LIMDOW or MSR Magneto-Optical Microhead Array Chip” (FIGS. 29 and 34) has contact fifty-nine (FIG. 11) dedicated to its (RLV) “Read Laser Voltage” output-contact, as illustrated in FIG. 11. In addition, a plan-viewed and installed “Bottom Data-Surface LIMDOW or MSR Magneto-Optical Microhead Array Chip” (FIGS. 29 and 34) has contact sixty (FIG. 11) dedicated to its (WLV) “Write Laser Voltage” output-contact, as illustrated in FIG. 11.

In addition, a plan-viewed and installed “Bottom Data-Surface LIMDOW or MSR Magneto-Optical Microhead Array Chip” (FIGS. 29 and 34) has contact sixty-one (FIG. 11) dedicated to its (SPDBV2) “Semiconductor Photo-Diode Biased Voltage 2” output-contact, as illustrated in FIG. 11. In addition, a plan-viewed and installed “Bottom Data-Surface LIMDOW or MSR Magneto-Optical Microhead Array Chip” (FIGS. 29 and 34) has contact sixty-two (FIG. 11) dedicated to its (SPDBV1) “Semiconductor Photo-Diode Biased Voltage 1” output-contact, as illustrated in FIG. 11.

In addition, a plan-viewed and installed “Bottom Data-Surface LIMDOW or MSR Magneto-Optical Microhead Array Chip” (FIGS. 29 and 34) has contacts sixty-three to sixty-four (FIG. 11) dedicated to its (DIN) “Data-In” input-contact, and to its (Dout) “Data-out” output-contact, as illustrated in FIG. 11. In conclusion, an installed “Bottom Data-Surface LIMDOW or MSR Magneto-Optical Microhead Array Chip” connects its control and data I/O bus-circuits to a LIMDOW and MSR Magneto-Optical Microhead Array Chip Hard Disk Drive's Disk Controller and its bus-systems through a surface-mounted chip-socket's connection-contacts as they were previously numbered and named, and illustrated in FIG. 11. In addition, a “Signal-Flow” (i.e., sometimes called an in-put/out-put logic-flow configuration) for an un-installed “Bottom Data-Surface LIMDOW or MSR Magneto-Optical Microhead Array Chip” is illustrated in FIG. 13.

Furthermore, a plan-viewed and installed “Top Data-Surface LIMDOW or MSR Magneto-Optical Microhead Array Chip” has its pin-one designation dot located in the upper left-hand corner of the LIMDOW or MSR Magneto-Optical Microhead Array Chip's outer-package 6 (FIGS. 8 and 25). Moreover, a plan-viewed and installed “Top Data-Surface LIMDOW or MSR Magneto-Optical Microhead Array Chip” (FIG. 31, FIG. 36) has its 32-bit Microhead-Addressing bus-circuit's connecting input-contacts (FIG. 12) located on the left-hand side of its outer-package's bottom-surface 9, 10 (FIGS. 8 and 26).

In addition, a plan-viewed and installed “Top Data-Surface LIMDOW or MSR Magneto-Optical Microhead Array Chip” (FIGS. 31 and 36) has its input-contacts one to thirty-two (FIG. 12) dedicated to its 32-bit Microhead-Addressing bus-circuit, as illustrated in FIG. 12. In conclusion, an “installed” “Top Data-Surface LIMDOW or MSR Magneto-Optical Microhead Array Chip” connects its 32-bit addressing bus-circuit to a LIMDOW and MSR Magneto-Optical Microhead Array Chip Hard Disk Drive's Disk Controller and its bus-system through its surface-mounted chip-socket's “A0” to “A31” connection-contacts, as illustrated in FIG. 12.

Furthermore, a plan-viewed and installed “Top Data-Surface LIMDOW or MSR Magneto-Optical Microhead Array Chip” has its pin-one designation dot located in the upper left-hand corner of the LIMDOW or MSR Magneto-Optical Microhead Array Chip's outer-package 6 (FIGS. 8 and 25). Moreover, a plan-viewed and installed “Top Data-Surface LIMDOW or MSR Magneto-Optical Microhead Array Chip” (FIGS. 31 and 36) has its control and data I/O bus-circuit's connecting contacts (FIG. 12) located on the right-hand side of its outer-package's bottom-surface 7, 8 (FIGS. 7 and 26).

In addition, a plan-viewed and installed “Top Data-Surface LIMDOW or MSR Magneto-Optical Microhead Array Chip” (FIGS. 31 and 36) has its contacts thirty-three to thirty-eight (FIG. 12) dedicated to its (GND) “Ground” output-contact, its (+5) “VDD Power” input-contact, its (R/-W) “Read or Write Enable” input-contact, its (MFCLK) “Multi-Frequency Clock” input-contact, its (-AS) “Address Strobe” input-contact, and its (-CS) “Chip Select” input-contact, as illustrated in FIG. 12. In addition, contacts thirty-nine to forty-one (FIG. 12) are dedicated to its (-ADACK) “Address Acknowledge” output-contact, its (-WDTACK) “Write Data Acknowledge” output-contact, and its (-RDTACK) “Read Data Acknowledge” output-contact, as illustrated in FIG. 12. In addition, contacts forty-two to sixty-two (FIG. 12) are dedicated to its (FUT) “Future” I/O contacts, as illustrated in FIG. 12.

In addition, contact fifty-nine (FIG. 12) is dedicated to its (RLV) “Read Laser Voltage” output-contact, contact sixty (FIG. 12) is dedicated to its (WLV) “Write Laser Voltage” output-contact, and contact sixty-one (FIG. 12) is dedicated to its (SPDBV2) “Semiconductor Photo-Diode Biased Voltage 2” output-contact. In addition, contact sixty-two (FIG. 12) is dedicated to its (SPDBV1) “Semiconductor Photo-Diode Biased Voltage 1” output-contact. While contacts sixty-three to sixty-four FIG. 12 are dedicated to its (DIN) “Data-In” input-contact, and to its (Dout) “Data-out” output-contact, as illustrated in FIG. 12.

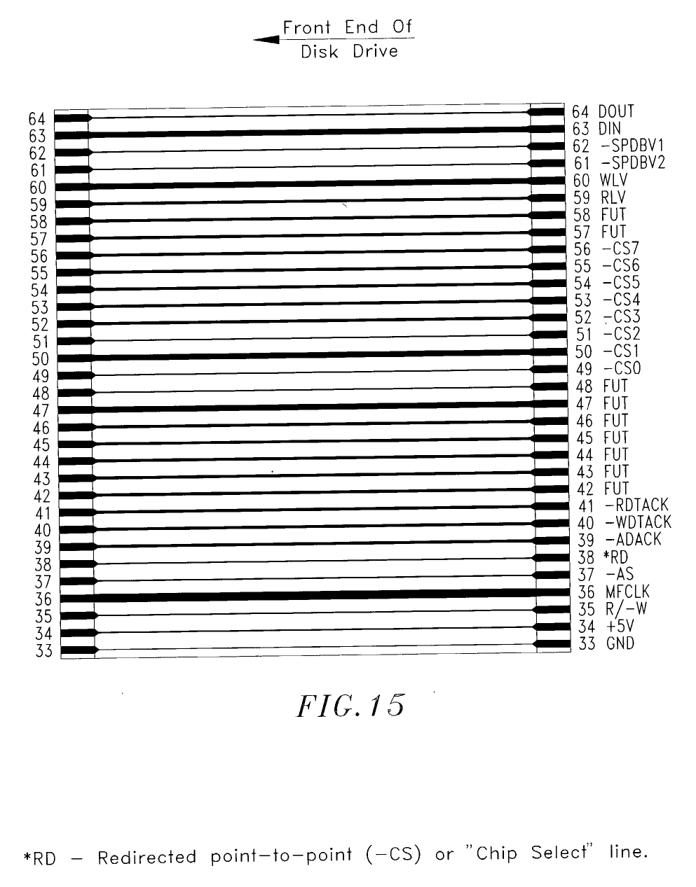

In conclusion, an installed “Top Data-Surface LIMDOW or MSR Magneto-Optical Microhead Array Chip” connects its control and data I/O bus-circuits to a LIMDOW and MSR Magneto-Optical Microhead Array Chip Hard Disk Drive's Disk Controller and it's bus-systems through a surface-mounted chip-socket's connection-contacts as they were previously numbered and named, as illustrated in FIG. 12. In addition, a “Signal-Flow” (i.e., sometimes called an in-put/out-put logic-flow configuration) for an un-installed “Top Data-Surface LIMDOW or MSR Magneto-Optical Microhead Array Chip” is illustrated in FIG. 14.

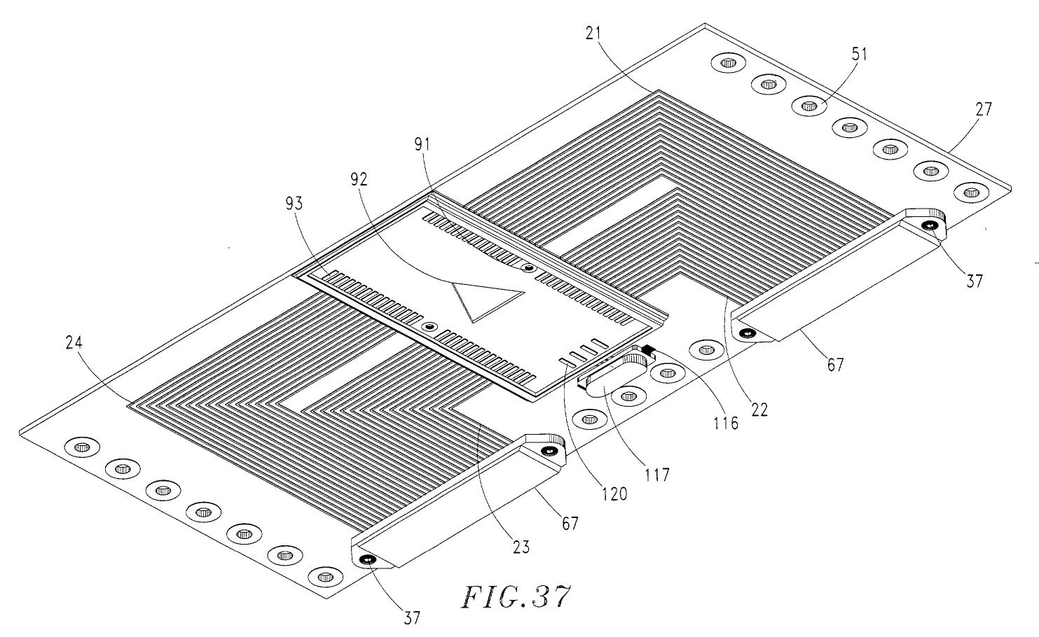

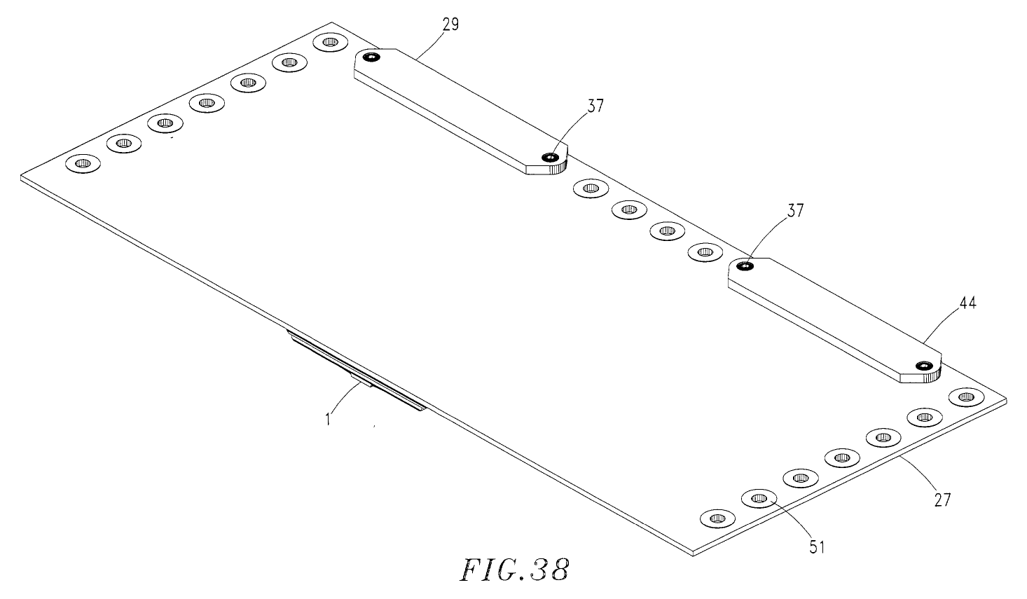

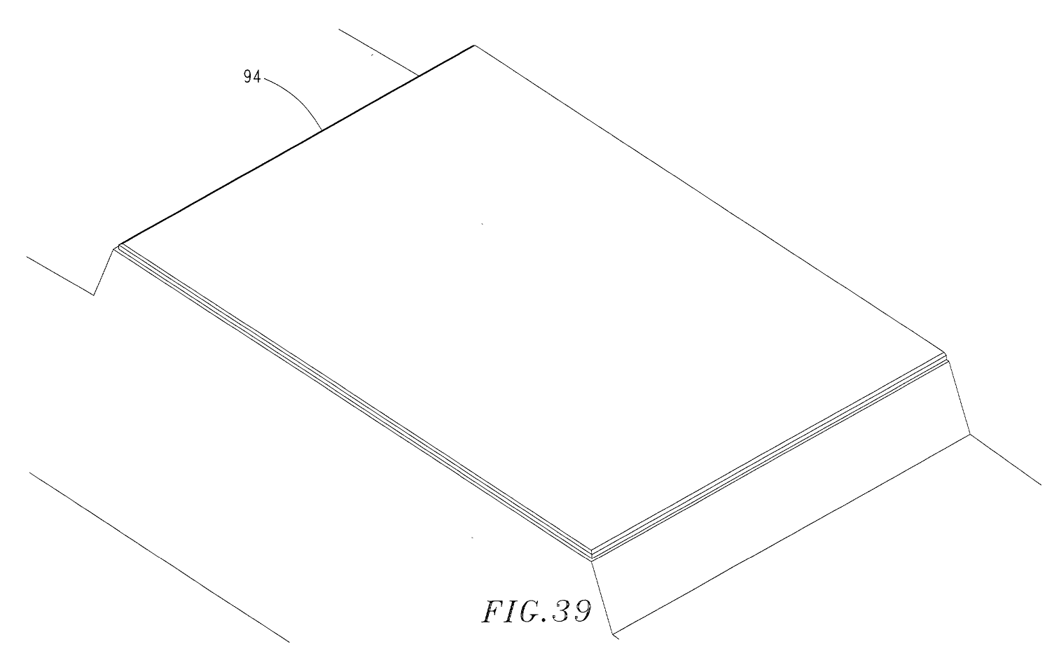

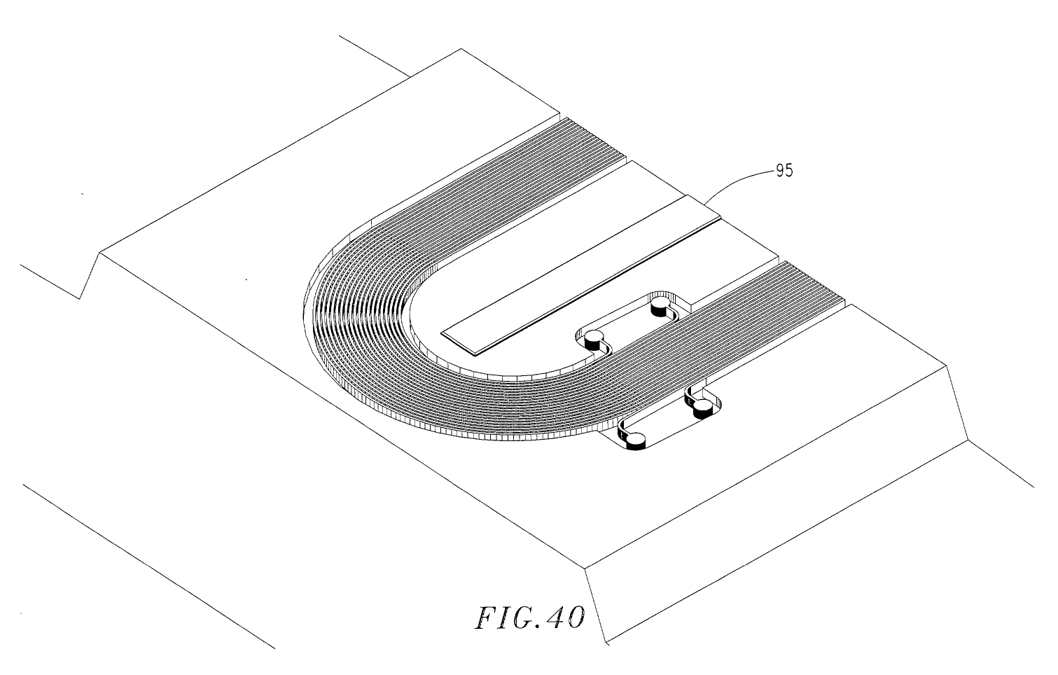

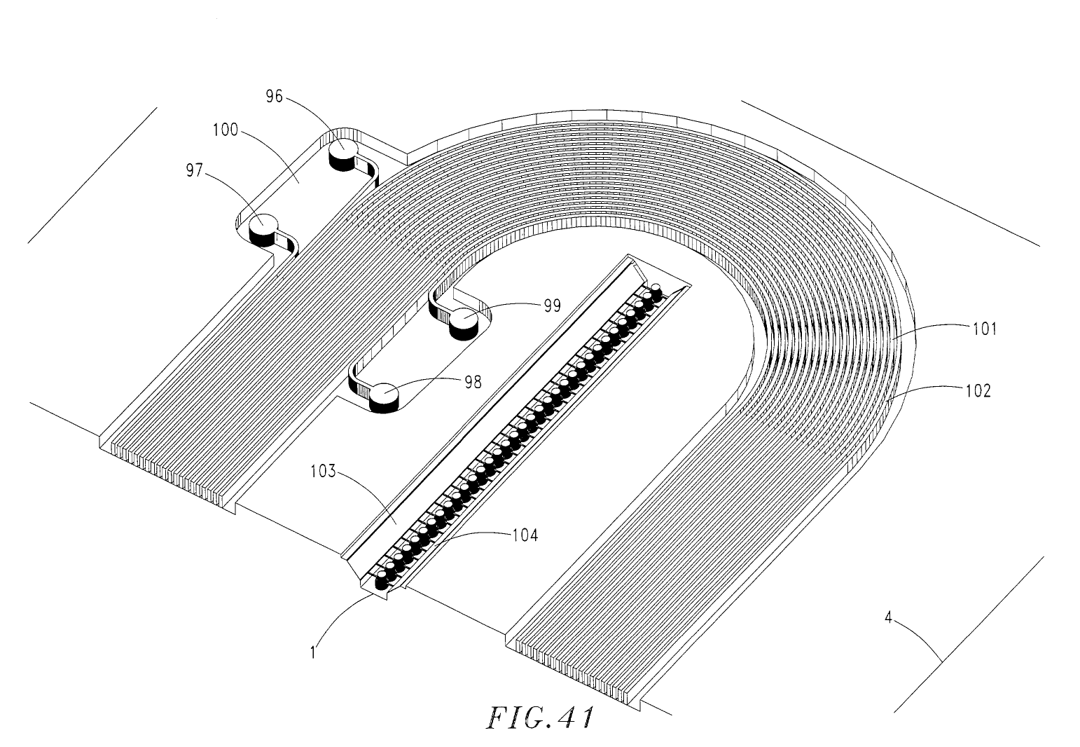

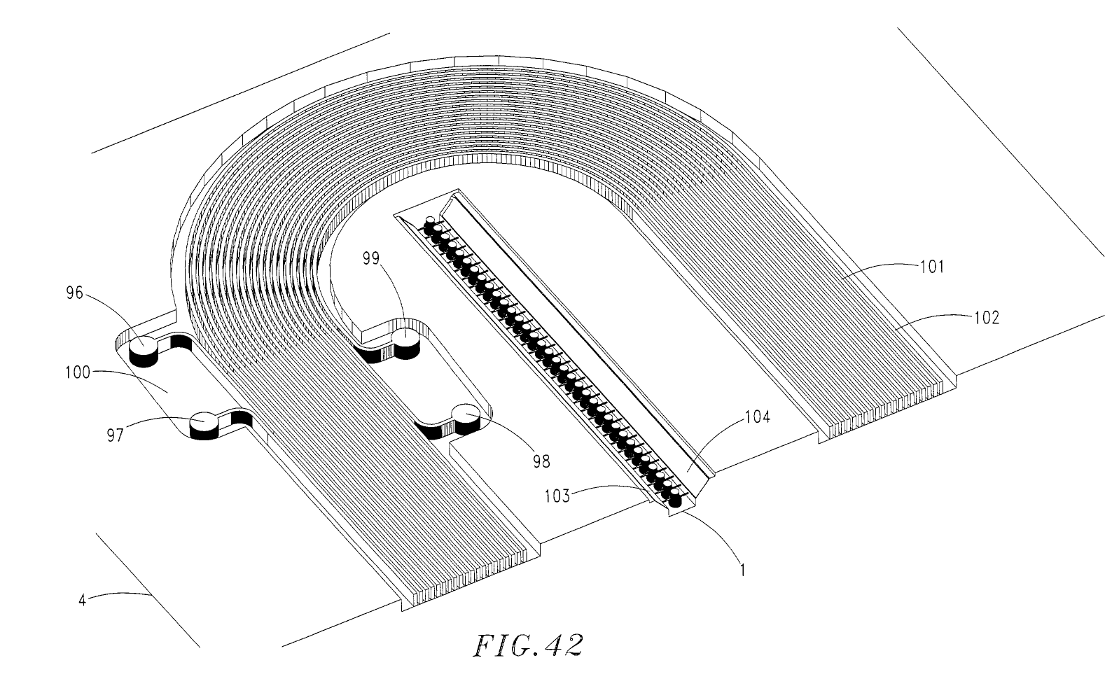

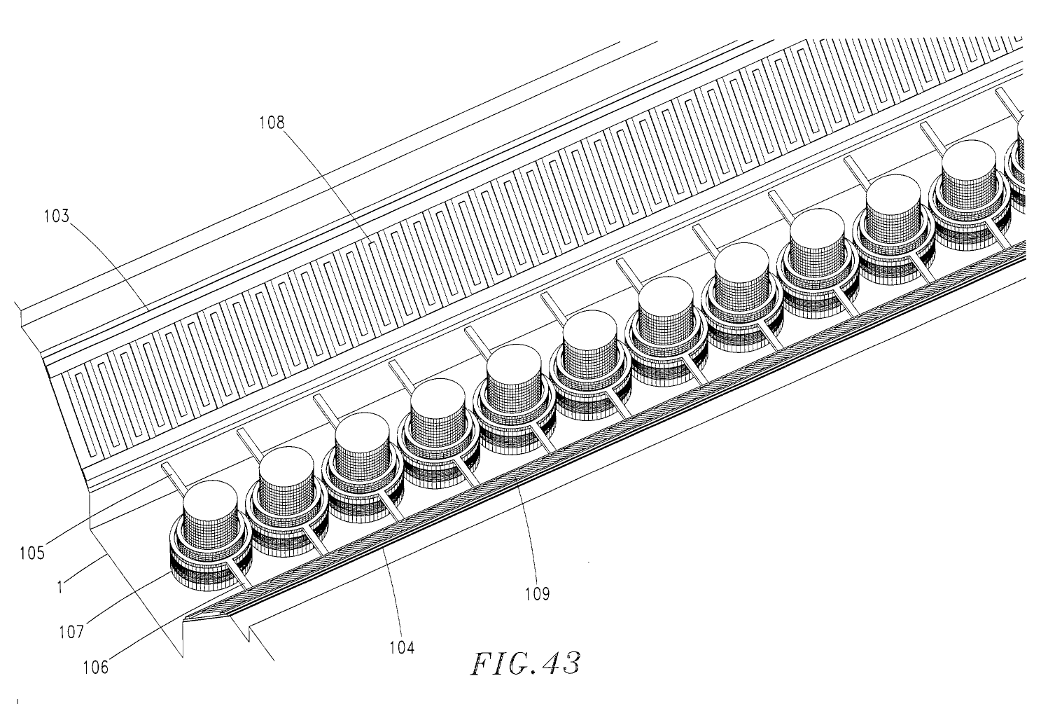

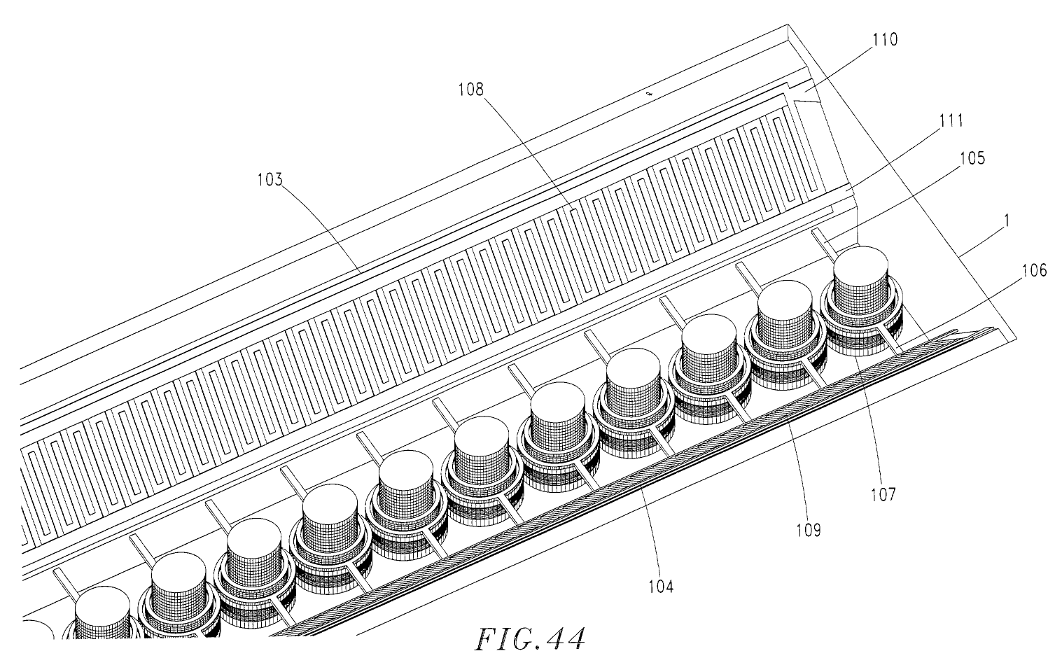

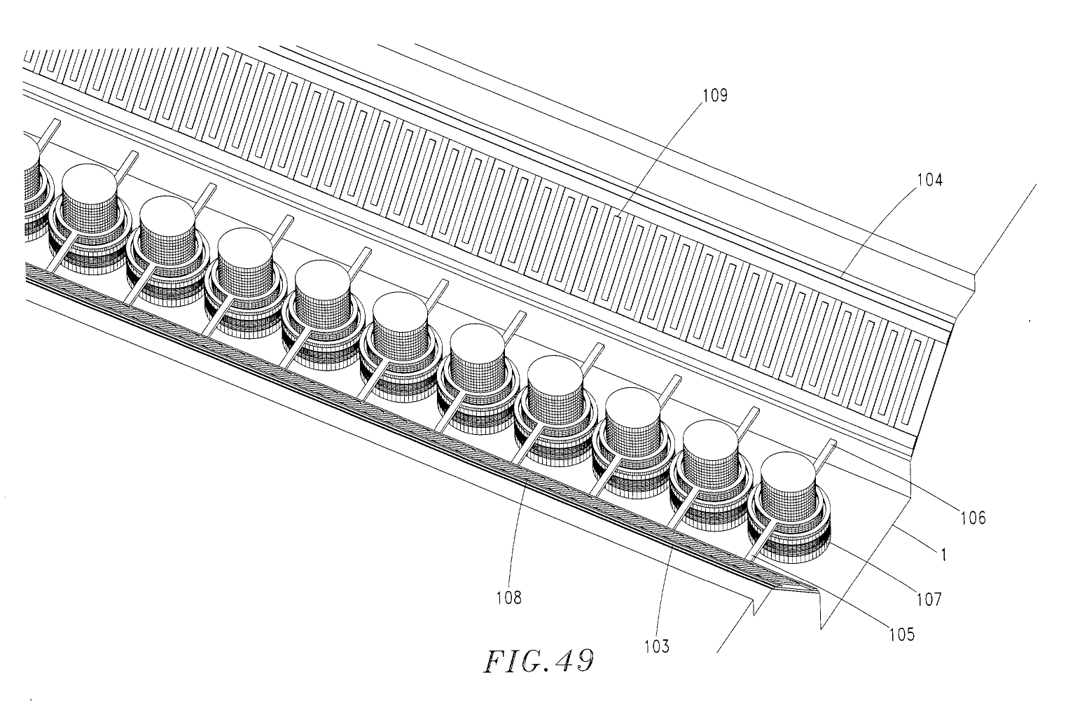

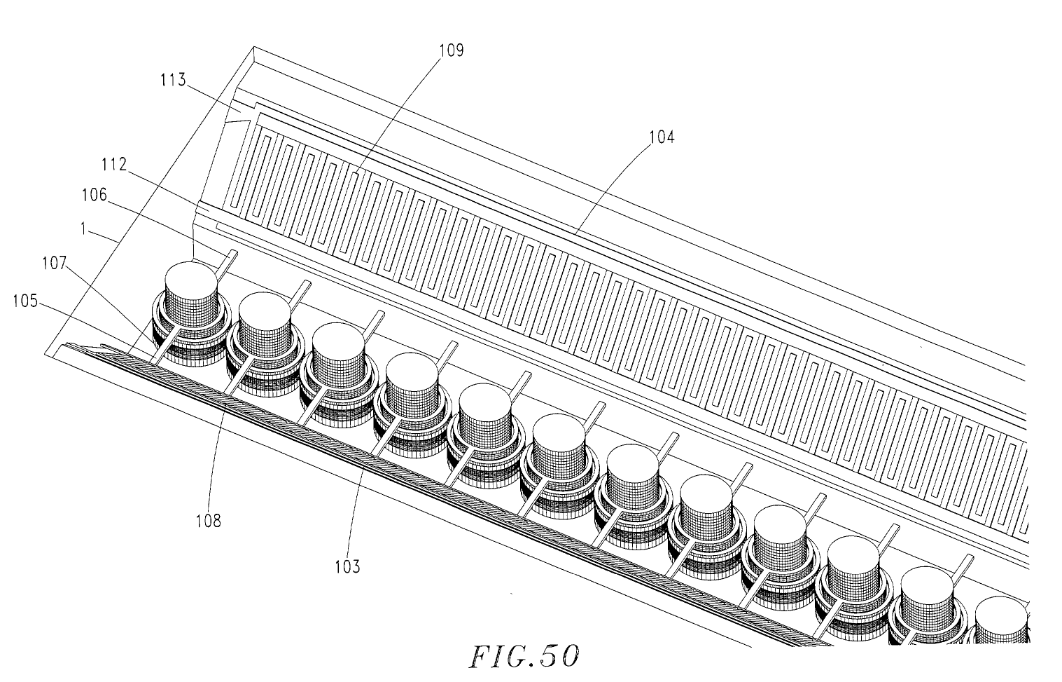

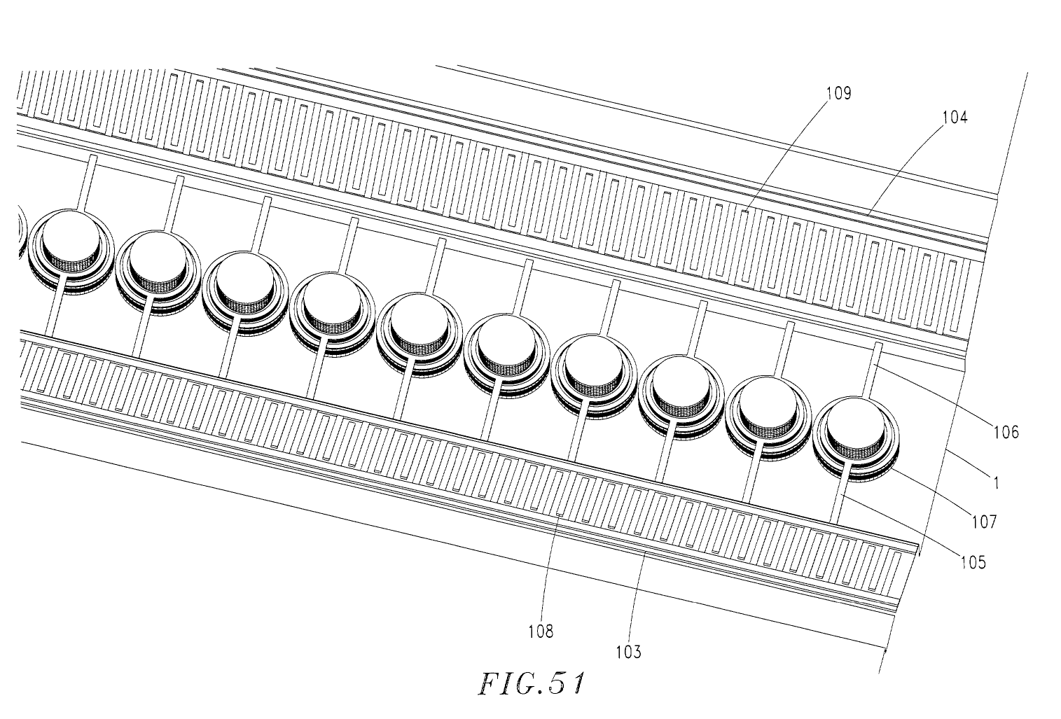

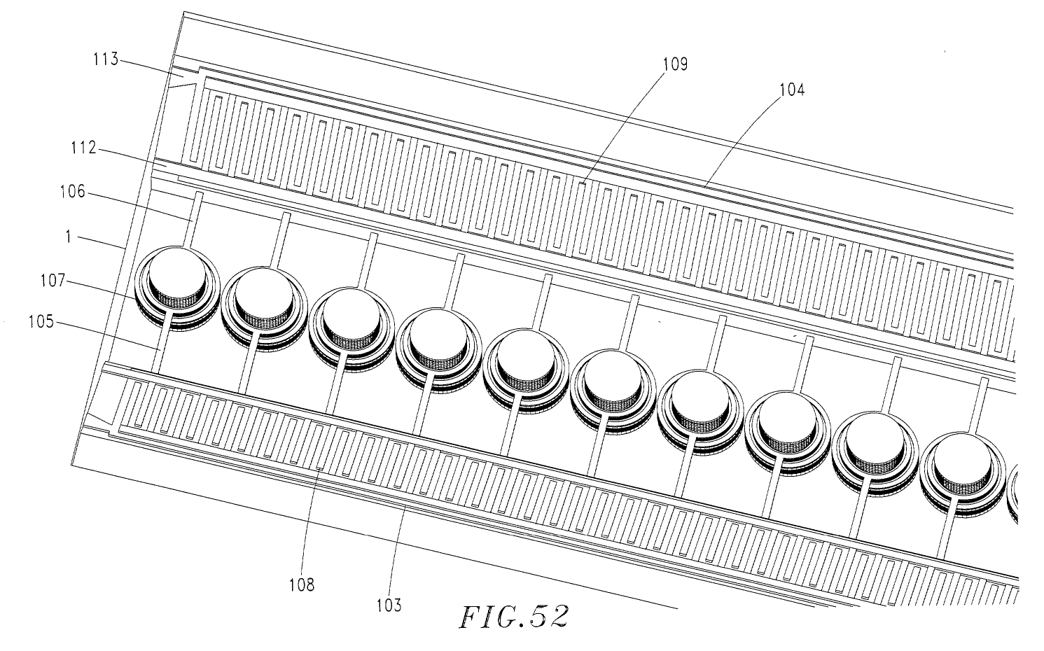

Another preferred first and basic embodiment of the present invention, as illustrated in drawing FIGS. 41, 42, 43, 44, 45, 46, 47, 48, 49, 50, 52, and 52, is the LIMDOW or MSR Magneto-Optical Microhead Array Chip core design and internal microhead structures, which are located within every LIMDOW or MSR Magneto-Optical Microhead Array Chip and comprises a microhead array containing as few as one-hundred or up to as many as four-billion multi-layered diode laser or (VCSEL) “Vertical Cavity Surface Emitting Laser” devices 1 (FIGS. 1, 2, and 3) per LIMDOW or MSR Magneto-Optical Microhead Array Chip 4 (FIGS. 41 and 42), two reversed-biased (SPD) “Semiconductor Photo-Diode” photocell arrays 103, 104 (FIGS. 41 and 42), one quarter-wave polarizing plate 94, 95 (FIGS. 39 and 40), and one Ahrens polarizing analyzer and beam-splitting calcite crystal 129, 130, 131 (FIGS. 108A and 108B).

Furthermore, the diode laser or (VCSEL) “Vertical Cavity Surface Emitting Laser” microhead arrays used in the LIMDOW or MSR Magneto-Optical Microhead Array Chips are typically forward-biased, microscopic, and alloy-doped double-heterojunction semiconductor structures. Moreover, the diode laser or VCSELs are typically built-up layer-upon-layer from a single semiconductor substrate, using existing (MBE) “Molecular Beam Epitaxy” or (MOVPE) “Metal-Organic Vapor-Phase Epitaxy”, or some other equivalent epitaxial manufacturing method. While, the LIMDOW or MSR Magneto-Optical Microhead Array Chips' support circuitry is fully integrated and constructed from the same previously mentioned material used to construct the diode laser or (VCSEL) “Vertical Cavity Surface Emitting Laser” microhead array, and within this embodiment comprise a Microhead Address Latch And Decoder Circuit, a Chip-Selection And Chip-Control Circuit, a Data I/O And Pre-Amplification Circuit, a Data Encoding/Decoding Circuit, and two reversed-biased (SPC) “Semiconductor Photo-Conductor” linear position-sensing (CdS) “Cadmium Sulfide” semiconductor devices, or as an alternative embodiment two reversed-biased (SPD) “Semiconductor Photo-Diode” photo-cell (Si) “Silicon” or (CCD) “Charged Coupled Device” semiconductor arrays.

Furthermore, the previously mentioned photocell arrays can either be constructed from and upon semiconductor substrates that are different and separate from the beforementioned support circuitry's beforementioned substrates 1 (FIGS. 1, 2, and 3) or from the same material and substrate used to construct the diode laser or VCSEL microhead arrays. Moreover, the previously mentioned integrated circuits are typically masked, lithographed, etched, and built-up from the same semiconductor substrate as the previously mentioned diode laser or VCSEL microhead arrays, along with their support and control circuitry.

For example, if the previously mentioned support circuitry is made from “Silicon-Oxide” (CMOS) “Complementary Metal Oxide Semiconductor” semiconductor wafer-chips, the wafers are typically covered with a photo-resistant oxide material that is exposed to ultraviolet-light through a light blocking mask, which causes, using a photo-resist masking technique, the oxide-areas of the Silicon wafer-chip not masked, and therefore are exposed to become photo-chemically altered, while the beforementioned areas of the “Silicon-Oxide” wafer-chip not masked are photo-chemically are then developed to expose an underlying layer beneath the photo-resist oxide material.

In addition, the newly exposed lower layers of “Silicon-Oxide” material are next chemically removed, or etched-out leaving, therein empty areas in the wafer itself, where the empty wafer areas can be filled-in later with various alloys or doped semi-conducting and/or conducting materials creating, therein a CMOS based circuit. Furthermore, deposited between the diode laser or VCSEL microhead arrays and semiconductor support circuitry is layers of non-conducting epitaxially deposited “Silicon Oxide” material, which, moreover is used as a fill-in insulating material for the non-conducting and iso-insulation areas present around every semiconductor and diode laser or VCSEL structure that is built into every LIMDOW or MSR Magneto-Optical Microhead Array Chip. The previously mentioned non-conducting “Silicon-Oxide” insulating structures are also epitaxially constructed layer-upon-layer and at the same time as the other semi-conducting circuit structures that is built into every LIMDOW or MSR Magneto-Optical Microhead Array Chip.

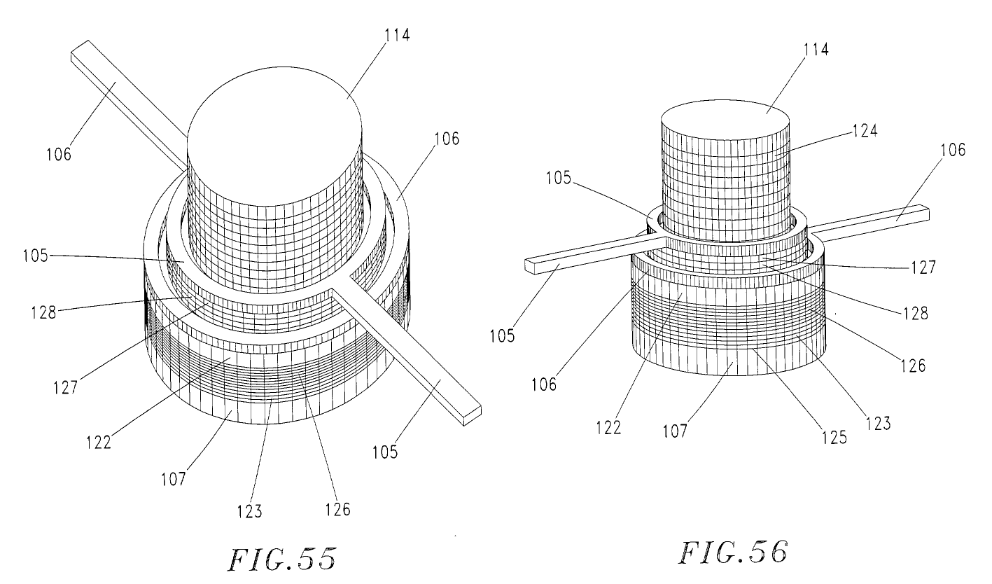

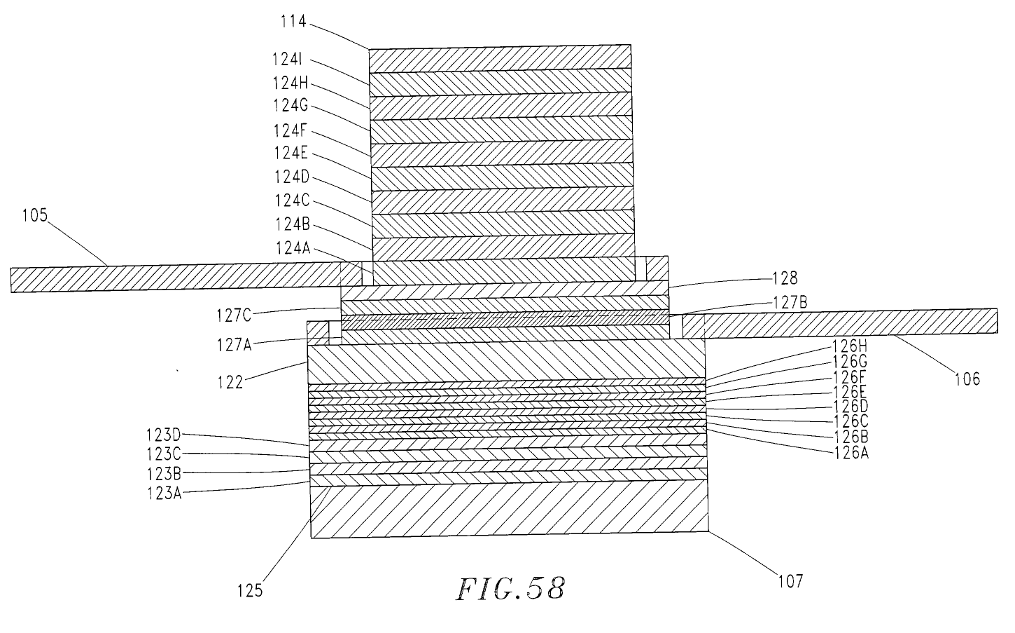

In addition, as illustrated in FIGS. 55 and 56, there is a ultra-violet VCSEL design, which is presented as an example of existing prior art technology that utilizes “electron/hole” recombination (i.e., injection) to produce a blue-green to ultra-violet diode laser or VCSEL with a wavelength range between “435” to “350” nanometers. Illustrated in FIG. 58 is a section drawing of a double hetero-junction ultra-violet VCSEL diode laser that displays different semiconductor layers as being built-up via (MBE) “Molecular Beam Epitaxy” or (MOVPE) “Metal-Organic Vapor-Phase Epitaxy”. Moreover, an epitaxy structure, which comprises, first, a metallic supporting substrate, typically uses said substrate as a back-reflecting mirror, while providing a base-structure for the growth of a VCSEL microhead's 107 (FIGS. 55, 56, and 58) subsequent multilayers. Wherein, this base-structure, while conductive, and as an alternative embodiment, serves as an electrode composed of a (NiAl) “Nickel-Aluminum” alloy-mixture, having between an eight to twelve percent lattice mismatch, or more specifically a ten percent lattice mismatch to (GaN) “Gallium-Nitride”; the VCSEL's principle construction material.

Nevertheless, (NiAl) “Nickel-Aluminum” is the typically preferred alloy-mixture for this kind of structure, while having a surface roughness of less than “15” atoms thick, the beforementioned (Ni—Al) “Nickel-Aluminum” alloy-mixture, also displays a highly reflective property as well. Furthermore, as illustrated in FIG. 58, what is also needed for constructing this VCSEL structure is a multi-layered epitaxial growth of (AlN) “Aluminum-Nitride”, while each AlN layer being only a few atoms thick, the multiple AlN layers are utilized as a buffer layer 123 (FIGS. 55, 56, and 58) for facilitating the epitaxial-growth of the subsequent multilayers that will eventually comprise the VCSEL's and/or VCSEL based microhead array's completed structure(s).

In addition, is a first distributed Bragg reflector 126 (FIGS. 55, 56, and 58), which is epitaxially grown onto the previously mentioned multi-layered buffer 123 (FIGS. 55, 56, and 58), by using any suitable epitaxial deposition method, such as (MBE) “Molecular Beam Epitaxy” or (MOVPE) “Metal-Organic Vapor-Phase Epitaxy”. Moreover, a first distributed Bragg reflector 126 (FIG. 58) is composed of alternating layers of n-doped (GaN) “Gallium-Nitride” 126A (FIG. 58) and n-doped (AlGaN) “Aluminum-Gallium-Nitride” 126B (FIG. 58); thereby, making a mirror pair or one pair of refractive opposing reflectors (AlGaN/GaN), or more precisely, two alternating layers that completes one “mirror pair”.

However, if additional mirror pairs are required, several more layers can be epitaxially deposited onto the last existing mirror-pair thus, producing additional mirror pairs. Wherein, the number of mirror pairs displayed is five to ten mirror pairs 126A, 126B (FIG. 58), 126C, 126D (FIG. 58), 126E, 126F (FIG. 58), 126G, 126H (FIG. 58), while the actual number of mirror pairs could range from fifty to one hundred mirror pairs, depending on the laser's emission frequency.

In addition, the second distributed Bragg reflector 124 (FIG. 58) is to be composed of alternating layers of (Al2O3) “Aluminum-Oxide” 124A (FIG. 58) and (ZnO) “Zinc-Oxide” 124B (FIG. 58); thereby, making a mirror pair or one pair of refractive opposing reflectors (Al2O3/ZnO), or more precisely, two alternating layers that completes one “mirror pair”.

However, if additional mirror pairs are required, several more layers can be epitaxially deposited onto the last existing mirror-pair thus, producing additional mirror pairs. Wherein, the number of mirror pairs displayed is five to ten mirror pairs 124A, 124B (FIG. 58), 124C, 124D (FIG. 58), 124E, 124F (FIG. 58), 124G, 124H (FIG. 58), 124I, 114 (FIG. 58), while the actual number of mirror pairs could range from twenty-five to fifty mirror pairs, depending on the laser's emission frequency.

However, it should be understood that the thickness and doping level of every epitaxial layer must be precisely controlled. Therefore, any deviation from design parameters, no matter how slight, would affect a typical VCSEL's performance (i.e., frequency range and flux intensity).

For example, if a VCSEL microhead were designed to emit laser light with a frequency range, say “200” to “550” nanometers, the layers that go into its construction would typically need to be one-quarter of one wavelength of the laser light emission 139 (FIG. 108A) emitted by the example VCSEL's emitter layer 114 (FIG. 58). In general, each distributed layer used in a Bragg reflector, more specifically, (DBR) “Distributed Bragg Reflector” (s) 126, 124 (FIGS. 55, 56, and 58), must have an optical thickness that is equal to one-quarter of one wavelength of a VCSEL's laser light emissions.

Furthermore, the doping of the semiconductor layers used in the construction of a VCSEL microhead is accomplished by the addition of various dopant materials (e.g., gaseous n-type dopants and gaseous p-type dopants) during the epitaxial deposition of growth materials; thereby, doping the epitaxially deposited material. Typically, the semiconductor layers used in the construction of a VCSEL microhead will use many different dopant concentrations of specific dopant materials within their different intrinsic semiconductor structures forming moreover extrinsic semiconductor structures.

For example, the alternating layers of the beforementioned first distributed Bragg reflector 126 (FIG. 58) are n-type and doped with “Selenium”, “Silicon”, or the like, to a concentration that ranges from “1E15” to “1E20” cubic-centimeters with a preferred range from “1E17” to “1E19” cubic centimeters, while a nominal range would be from “5E17” to “5E18” cubic centimeters 124A (FIG. 58). Furthermore, the percent of composition of the beforementioned first distributed Bragg reflector 126 (FIG. 58) can be stated as (Al x Ga x N/GaN) where x is the variable of “0.05” to “0.96”, while in a preferred embodiment x would be greater than “0.8”.

Therefore, once the plurality of alternating layers that are used in the beforementioned first distributed Bragg reflector 126 (FIG. 58) have been deposited on buffer layer 123 (FIG. 58), a first contact-layer 122 (FIG. 58), which is composed of highly n-doped (GaN) “Gallium-Nitride” material and epitaxially grown on top of the last alternating layer of the beforementioned first distributed Bragg reflector 126 (FIG. 58). Moreover, the first contact-layer 122 (FIG. 58) will provide connectivity to a VCSEL's n-metal contact 106 (FIG. 58), but also enhances the reliability of a VCSEL, by preventing the migration of dislocations, and the like, to a VCSEL's active-region.

Furthermore, to prevent the overcrowding of the cladding-regions, each is shown as a single layer 127A, 127C (FIG. 58). However, it should be understood that each cladding-region can also be made of more than one layer 127A, 127C (FIG. 58) with each cladding-region epitaxially deposited onto the previous cladding-region 127A (FIG. 58). Where, each cladding-region 127A, 127C (FIG. 58) is composed of any suitable doped or un-doped material, such as an n-doped and a p-doped (AlGaN) “Aluminum-Gallium-Nitride” epitaxially deposited material. Furthermore, the beforementioned active-region 127B (FIG. 58) of a VCSEL is also represented by a single layer and epitaxially deposited onto the beforementioned first cladding-region 127A (FIG. 58). However, it should be understood that the previously mentioned active-region 127B (FIG. 58) can also include one or more barriers and quantum-wells; particularly a first barrier and a second barrier with a quantum-well positioned between the previously mentioned first barrier layer and the previously mentioned second barrier layer, while the beforementioned active-region 127B (FIG. 58) is composed of (InGaN) “Indium-Gallium-Nitride” material. Moreover, a second contact-layer 128 (FIG. 58); moreover, a layer of highly p-doped (GaN) “Gallium-Nitride” material is epitaxially grown onto a diode laser or VCSEL's second cladding-region 127C (FIG. 58). Where, the previously mentioned second contact-layer provides connectivity to a VCSEL's p-metal contact 105 (FIG. 58).

In addition, a second distributed Bragg reflector is made of a plurality of alternating layers 124 (FIG. 58); moreover, a plurality of alternating layers 124, 114 (FIG. 58) that includes one or more layers of (Al2O3) “Aluminum-Oxide” material, which are illustrated as layers 124A, 124C, 124E, 124G, 124I (FIG. 58), and one or more layers of (ZnO) “Zinc-Oxide” material, which are illustrated as layers 124B, 124D, 124F, 124H, 114 (FIG. 58). For example, a layer of (Al2O3) “Aluminum-Oxide”, which was epitaxially deposited on the previously mentioned second contact-layer 128 (FIG. 58), has a layer of (ZnO) “Zinc-Oxide” subsequently and epitaxially deposited on the previously mentioned first layer of (Al2O3) “Aluminum-Oxide”; thereby, making a first mirror pair of dielectric (Al2O3/ZnO) reflectors 124A, 124B (FIG. 58). Furthermore, if additional mirror-pairs are required, several more layers of additional mirror-pairs are deposited on the existing layers of (Al2O3) “Aluminum Oxide” and (ZnO) “Zinc Oxide”. In addition, the plurality of alternating layers of the previously mentioned second distributed Bragg reflector 124 (FIG. 58) are formed from one mirror pair to ten mirror pairs with a preferred number of mirror pairs ranging from four to five pairs.

However, it should be understood that the number of mirror pairs could be adjusted for specific applications. In addition, a p-metal electrical contact 105 (FIG. 58) is formed on the previously mentioned second contact-layer 128 (FIG. 58) by disposing any suitable conductive material on the previously mentioned second contact-layer 128 (FIG. 58); moreover, a metal such as Indium-Tin-Oxide, Gold, Zinc, Platinum, Tungsten, and Germanium like metallic alloys. In addition, an n-metal electrical contact 106 (FIG. 58) is formed on the previously mentioned first contact-layer 122 (FIG. 58) by disposing any suitable conductive material on the previously mentioned first contact-layer 122 (FIG. 58) such as Indium-Tin-Oxide, Gold, Zinc, Platinum, Tungsten, and Germanium like metallic alloys. Furthermore, it should be understood that depending upon which material is selected for the previously mentioned electrical contacts 105, 106 (FIG. 58) that a specific method of disposition, disposing and patterning, onto the previously mentioned first and second contact-layers 122, 128 (FIG. 58) for a specific material, will change, along with that materials electrical contacts 105, 106 (FIG. 58).

A summarized listing of the layers that make-up the previously described double hetero-junction ultra-violet VCSEL's structure; moreover, layers, which are listed according to their epitaxial deposition:

i.) A double hetero-junction ultra-violet VCSEL's base-substrate back-reflecting mirror structure composed of (NiAl) “Nickel-Aluminum” alloy-mixture 107 (FIG. 58);

ii.) A double hetero-junction ultra-violet VCSEL's multi-layered buffer structure comprising four layers composed of (AlN) “Aluminum-Nitride” 123A, 123B, 123C, 123D (FIG. 58);

iii.) A double hetero-junction ultra-violet VCSEL's first distributed Bragg reflector 126 (FIG. 58) comprising alternating layers of n-doped (GaN) “Gallium-Nitride” 126A, 126C, 126E, 126G (FIG. 58) and n-doped (AlGaN) “Aluminum-Gallium-Nitride” 126B, 126D, 126F, 126H (FIG. 58);

iv.) A double hetero-junction ultra-violet VCSEL's first contact-layer composed of a highly n-doped (GaN) “Gallium-Nitride” material 122 (FIG. 58);

v.) A double hetero-junction ultra-violet VCSEL's n-metal contact 106 (FIG. 58);

vi.) A double hetero-junction ultra-violet VCSEL's first cladding-region composed of an n-doped (AlGaN) “Aluminum-Gallium-Nitride” material 127A (FIG. 58);

vii.) A double hetero-junction ultra-violet VCSEL's active-region comprising a single or multiple quantum-well composed of (InGaN) “Indium-Gallium-Nitride” material 127B (FIG. 58);

viii.) A double hetero-junction ultra-violet VCSEL's second cladding-region composed of a p-doped (AlGaN) “Aluminum-Gallium-Nitride” material 127C (FIG. 58);

ix.) A double hetero-junction ultra-violet VCSEL's second contact-layer composed of a highly p-doped (GaN) “Gallium-Nitride” material 128 (FIG. 58);

x.) A double hetero-junction ultra-violet VCSEL's p-metal contact 105 (FIG. 58);

xi.) A double hetero-junction ultra-violet VCSEL's second distributed Bragg reflector 124 (FIG. 58) comprising alternating layers of (Al2O3) “Aluminum-Oxide” material, which are illustrated as layers 124A, 124C, 124E, 124G, 124I (FIG. 58) and alternating layers of (ZnO) “Zinc-Oxide” material, which are illustrated as layers 124B, 124D, 124F, 124H, 114 (FIG. 58).

Furthermore, it should be noted that a double hetero-junction ultra-violet VCSEL's second contact-layer 128 (FIG. 58), second cladding-region 127C (FIG. 58), quantum-well active-region 127B (FIG. 58), and first cladding-region 127A (FIG. 58) are all etched and, therefore define the overall structures of a mesa etched VCSEL's design (FIG. 58), while their diameters will remain substantially larger than the beforementioned VCSEL's emission aperture 114 (FIG. 58), and its operating vertical cavity. Furthermore, so that the beforementioned VCSEL's active-region 127B (FIG. 58) is not damaged by the etching process, proton-implantation can be utilized for current isolation, where a proton-implantation mask's diameter is slightly larger than the beforementioned VCSEL's emission aperture's diameter 114 (FIG. 58).

In addition, as the above described etching and proton-implantation steps are completed a p-metal contact 105 (FIG. 58) is deposited upon the beforementioned VCSEL's second contact-layer 128 (FIG. 58), while leaving the beforementioned VCSEL's emission aperture area open 114 (FIG. 58). In addition, an n-metal contact is deposited upon the beforementioned first contact-layer 122 (FIG. 58), or the previously mentioned n-metal contact is deposited upon the beforementioned VCSEL's base-substrate back-reflecting mirror structure 107 (FIGS. 55, 56, and 58) as an alternative preferred embodiment.

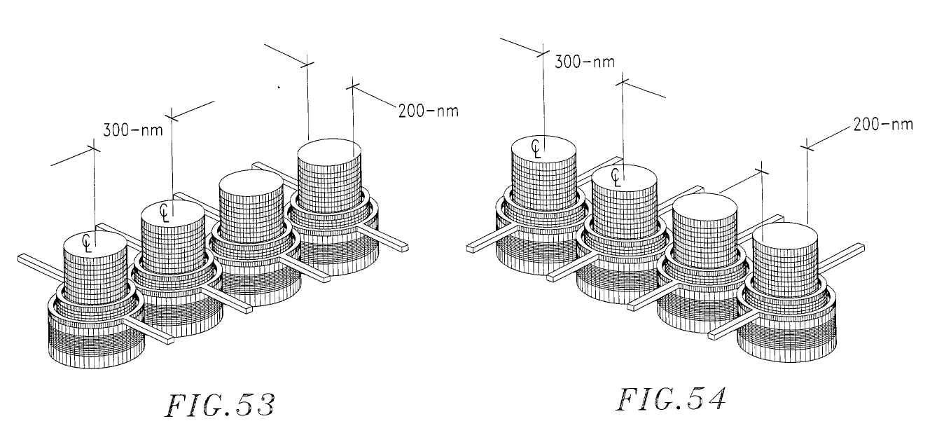

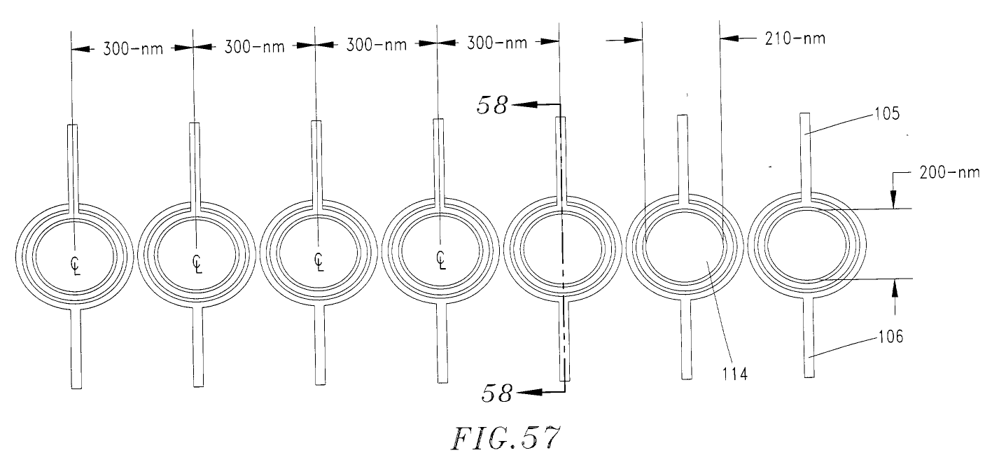

Furthermore, the metallic-alloy base-substrate and back-reflecting mirror structure 107 (FIGS. 55, 56, and 58), in conjunction with the (AlGaN/GaN) “Aluminum-Gallium-Nitride/Gallium-Nitride” Bragg reflector, provides for approximately 99% of the VCSEL's reflectivity. Furthermore, the beforementioned VCSEL microheads that could be used in a LIMDOW or MSR Magneto-Optical Microhead Array Chip's microhead array, would have a centerline-to-centerline dimension of approximately “300” nanometers (FIGS. 53, 54, and 57), while the VCSEL emission apertures 114 (FIG. 58) would have an elliptical diameter of “210”×“200” nanometers, as illustrated in FIG. 57.

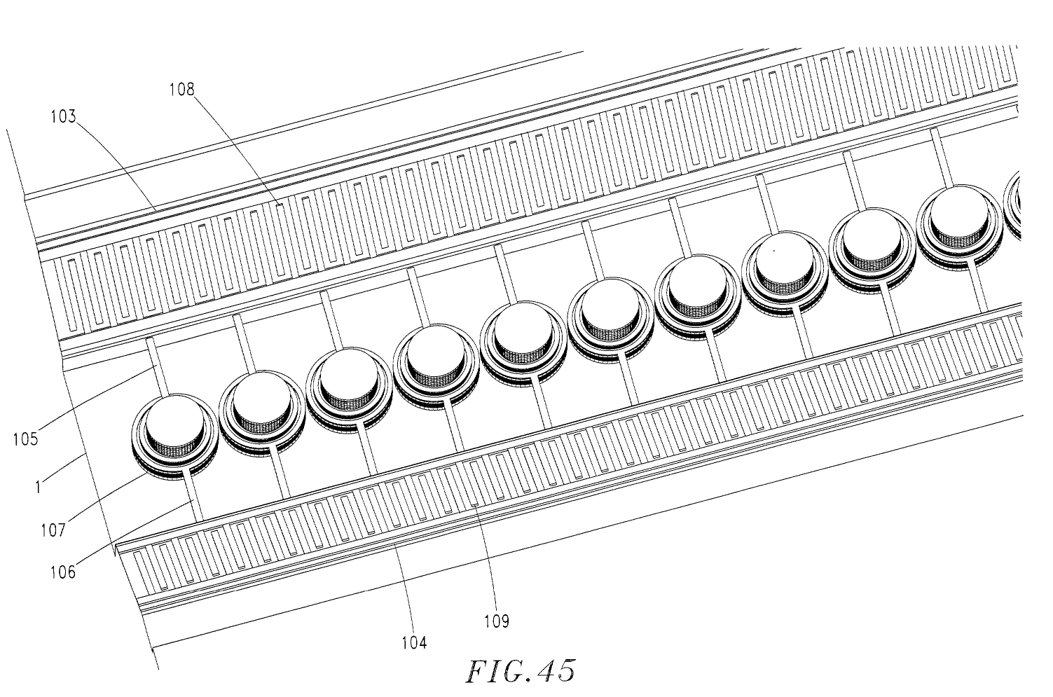

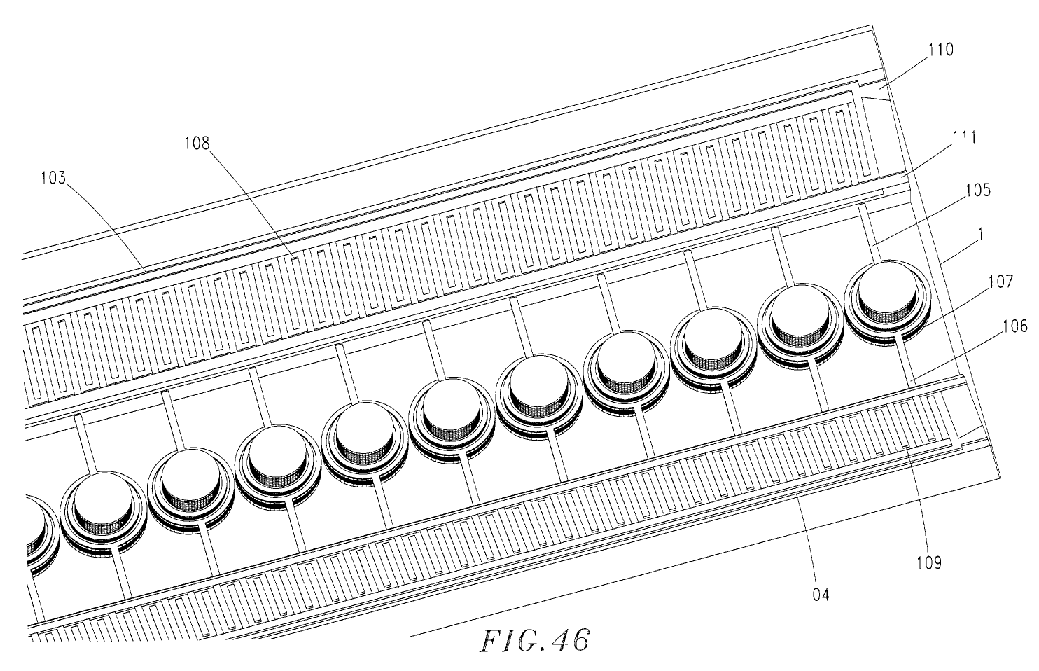

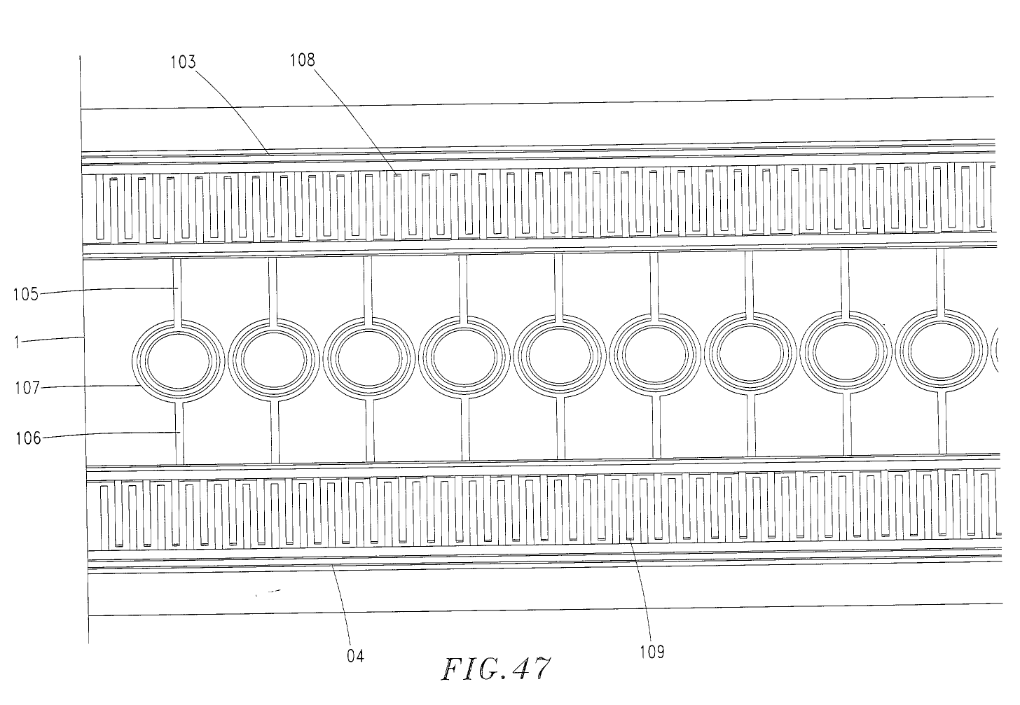

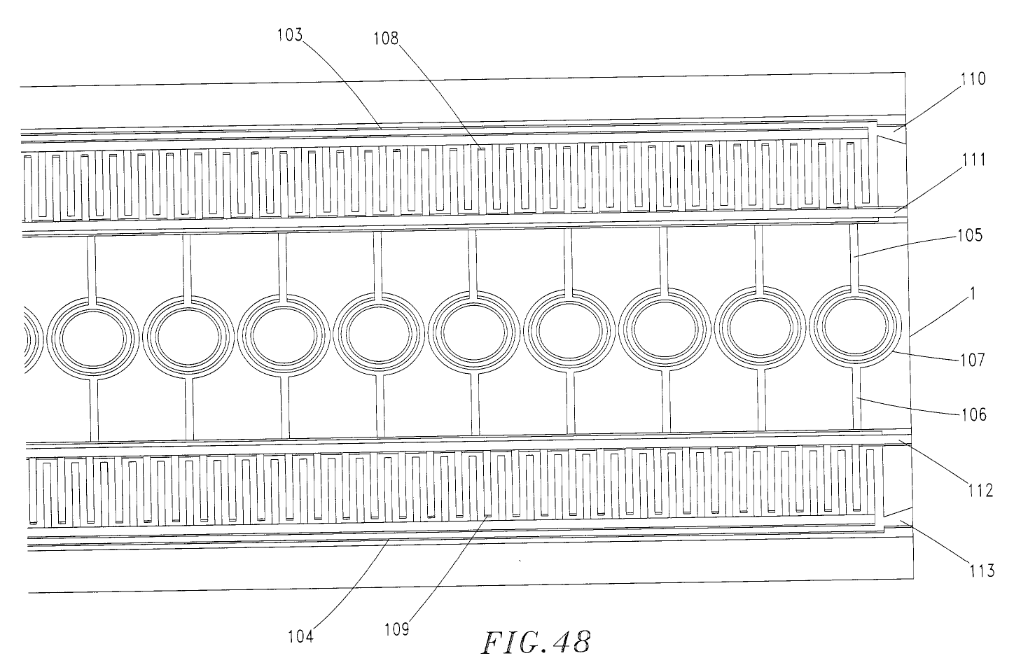

In addition, the previously mentioned and novel elliptical shape of the double hetero-junction ultra-violet VCSEL microheads (FIGS. 47 and 48) will cause their laser emissions to be elliptically shaped; thereby, increasing the “Circular Dichroism” of a disk-platter's reflected and linearly polarized E-ray; thus, improving the individually selected VCSEL microhead's demodulated read-out signal's quality of its signal-to-noise ratio.

Furthermore, the beforementioned two reversed-biased (SPC) “Semiconductor Photo-Conductor” linear position-sensing (CdS) “Cadmium Sulfide” semiconductor devices 103, 104, 107, 108 (FIGS. 41, 42, 43, 44, 45, 46, 47, 48, 49, 50, 51, and 52), or as a different preferred embodiment, the beforementioned two reversed-biased (SPD) “Semiconductor Photo-Diode” (Si) “Silicon” semiconductor photocell arrays. In addition, since the previously mentioned two reversed-biased (SPD) “Semiconductor Photo-Diode” (Si) “Silicon” semiconductor photocell arrays 103, 104, 107, 108 (FIGS. 41 and 42) are incapable of detecting frequencies of ultra-violet light so they must be coated with a phosphorous material like “Coronene” or “Liumogen” to convert disk reflected ultra-violet light into detectable frequencies of visible light.

In addition, since the previously mentioned two reversed-biased (SPD) “Semiconductor Photo-Diode” (Si) “Silicon” semiconductor photocell arrays 103, 104, 107, 108 (FIGS. 41 and 42) are incapable of detecting frequencies of ultra-violet light, they must be coated with a phosphorous material like “Coronene” or “Liumogen” to convert disk reflected ultra-violet light into detectable frequencies of visible light.

In addition, two (BIMPIC) “Bi-Metal Planar Induction Coil” devices 101, 102 (FIGS. 41 and 42) are to be positioned at the top-center of each MSR Magneto-Optical Microhead Array Chip 4 (FIGS. 41 and 42) surrounding the microhead array with two interlayered Bi-Metal Planar Induction Coils. Wherein, each Bi-Metal Planar Induction Coil will have a dual structure consisting of a vertical copper planar-wire that is coated on one side with a thin layer of magnetic-core Nickel-Ferrite material, while each coil will comprise twenty-five coil-winding turns. Consequently, the beforementioned microhead arrays used in the MSR Magneto-Optical Microhead Array Chips need to be completely surrounded two horizontal Bi-Metal Planar Induction Coils in order to affect a realignment of the magnetic domains within the MSR media's rare-earth material located within a laser localized and thermally confined data cell area.

Moreover, for the previously described reason, the (BIMPIC) “Bi-Metal Planar Induction Coil” design 101, 102 (FIGS. 41 and 42), which will be used in every MSR Magneto-Optical Microhead Array Chip made will, by necessity use a core-less induction coil design (i.e., sometimes called an ‘Air Core Induction Coil’ design). To describe further how the (BIMPIC) “Bi-Metal Planar Induction Coil” design 101, 102 (FIGS. 41 and 42) is used in the MSR Magneto-Optical Microhead Array Chip Hard Disk Drive to solve the previously mentioned problem of not having a centrally located space within a MSR Magneto-Optical Microhead Array Chip to physically place a magnetic core for a (BIMPIC) “Bi-Metal Planar Induction Coil” write-channel device. Moreover, the problem is solved by constructing a planar coil flat-wire out of two different metallic materials and having one-half of the planar flat-wire coil constructed from an electron conducting material like “Aluminum” or “Copper”, while having the other-half of the planar flat-wire coil constructed from a magnetic-field producing, non-permanent, and magnetic Ferrite material, like “Ni—Zn Ferrite”.

Next, by winding, the beforementioned two planar flat vertical wires of bi-metal into induction coils causing, therein the MBE deposited non-permanent magnetic “Ni—Zn Ferrite” material to become pressed between alternating layers of an electron conducting material, like “Aluminum” or “Copper”; moreover, forming a non-magnetic, multi-layered, and cylinder shaped induction coil with a “Ni—Zn Ferrite” magnetic core. Furthermore, because the magnetic core has a multi-layered and cylinder shape, which is hollow at its center, the microhead arrays can now be placed within the previously mentioned two Bi-Metal Planar Induction Coils center area 101, 102 (FIGS. 41 and 42); moreover, allowing the microheads to thermally confine, via curie-point manipulation, any magnetic-domain that lies across a disk-platter's data-surface, and by surrounding that magnetic-domain with a Bi-Metal Planar Induction Coil's vertical alternating magnetic field.

General Operation

In the following description, the combination of the mask layer, the information-recording layer, and the protection layer are referred to as a single magneto-optic layer. As the mask layer, GdFeCo or TbFeCo may be used, for example, and as the information recording layer, TbFeCo or DyFeCo may for example, be used. An optical disc can be so designed that a dielectric protection layer made of ZnS, a mask layer made of Gd₂₆(Fe₉₀Co₁₀)₇₆ [at %] (i.e., 50 nanometers thickness) having magneto-optic effect, an information recording layer made of Tb₂₄(Fe₉₀Co₁₀)₇₆ [at %] (i.e., 50 nanometers thickness) having magneto-optic effect, and a dielectric protection layer made of ZnS are formed on the substrate in this order. The thickness values in parentheses are only represented as examples.

In this case, the rotation of the polarization surface is mainly caused by Kerr Effect. The optical disc does not need a reflection layer because the mask layer and the information-recording layer have high reflectivity. However, when the thicknesses of the mask layer and the information-recording layer decreased to be about 30-nm increasing transmittance the rotation of the polarization surface is mainly caused by the Faraday Effect. Further, the magneto-optical disc media is so designed that a dielectric protection layer is made of an ZnS, a mask layer is made of a Tb₂₅(Fe₉₀Co₁₀)₇₅ [at %] (i.e., 50 nanometers thickness) having magneto-optic effect, an information recording layer made of Dy₂₈(Fe₇₀Co₃₀)₇₂ [at %] (i.e., 50 nanometers thickness) having magneto-optic effect, and a dielectric protection layer made of ZnS are formed on the substrate in this order. The thickness values shown in parentheses are only represented here as examples.

In addition, various conditions required in operation of the optical disc will be described. In order to have the optical disc perform normal operation; a temperature of information recording position or information reproducing position is required to satisfy the following condition:

Room Temperature<Reproduction Temperature<Temperature for deleting overwrite data (i.e., writing “0”)<Temperature for writing overwrite data (i.e., writing “1”).

Moreover, by doing so, at the time of reproduction, information on the information recording layer is transferred to a portion on the mask layer where the temperature thereof exceeds the ‘Reproduction Temperature’ by exchange coupling force, and fine resolution reproduction can be performed. At the time of deleting overwrite data (i.e., writing “0”), the mask layer is initialized by an external initializing magnetic field, and then magnetic domain of the mask layer directed to the initializing direction is transferred to the information-recording layer by exchange coupling force. At the time of writing overwrite data (i.e., writing “1”), temperature of the recording position of the optical disc is increased to be higher than the Curie point temperatures of the mask layer and the information-recording layer, and then data is written by applying an external writing magnetic field. In the above operation, reproduction and overwrite-data deletion utilize exchange-coupling force between the mask layer and the information-recording layer; however, transmitting directions of the coupling force are opposite to each other.

Moreover, in order to reverse transmitting directions of exchange coupling forces according to the temperature of recording or reproducing position, the following conditions are satisfied:

Room Temperature<Tᵣ<T_{WL}<T_{C1}, and T_{C}<T_{WH}

Here, it is assumed that both the mask layer and the information recording layer has compensation point, and temperature at the time of reproduction is expressed by Tᵣ, temperature at the time of overwrite data deletion is expressed by T_{WL}, Curie temperature of the mask layer is expressed T_{C1}, Curie temperature of the information recording layer is expressed by T_{C2} and temperature at the time of overwrite data writing is expressed by T_{WH}. It is noted that either one of the Curie temperature T_{C1} of the mask layer and the Curie temperature T_{C2} of the information-recording layer may be higher than the other may.

More preferably, the following condition is satisfied, when compensation point temperature of the mask layer is expressed by T_{comp1} and compensation point temperature of the information-recording layer is expressed by T_{comp2}:

Room Temperature<Tᵣ<T_{comp2}<T_{comp1}<T_{WL}<T_{C1}, and <T_{C2}<T_{WH}

By satisfying the above conditions, when data is transferred utilizing exchange coupling force, both of the mask layer and the information recording layer richly contains transition metal component (i.e., hereinafter referred to as ‘TM-rich’) at the time of reproduction, and both of the mask layer and the information recording layer richly contains rare-earth component (i.e., hereinafter referred to as ‘RE-rich’) at the time of overwrite data deletion. Consequently, data transferring is more efficiently carried out.

Next, in the following examination, it is assumed that the mask layer itself has a coercive force H₁, a saturation magnetization M₁ and thickness t₁, and the information-recording layer itself has coercive force H₂, a saturation magnetization H₂, and thickness t₂. Further, surface domain-walls energy by exchange coupling between two layers is expressed by σ_{w}, initializing magnetic field is expressed by Hᵢₙᵢ, reproduction magnetic field is expressed by Hᵣ, and writing magnetic field at the time of overwrite data writing is expressed by Hₑₓ.

(a) Condition at room temperature:

the following formulas should be satisfied:

H₁+(σ_{w}/(M₁·t₁))<Hᵢₙᵢ<H₂−(σ_{w}/(M₂·t₂)) (1),

H₁+(σ_{w}/(M₁·t₁))<H₂−(σ_{w}/(M₂·t₂)) (2A),

and

H₁<H₂ (2B)

The formula (1) defines a condition in which the initializing magnet field initializes only the mask layer. The formula (2) and (3) define condition in which recording data is maintained at room temperature.

(b) Condition for reproduction:

At the time of reproduction, the following formulas should be satisfied:

H₁+(σ_{w}/(M₁·t₁))<H₂−(σ_{w}/(M₂·t₂)) (3A),

H₁<H₂ (3B),

H₁+(σ_{w}/(M₁·t₁))+Hᵣ (4),

and

H₁+(σ_{w}/(M₁·t₂))−Hᵣ (5)

The formulas (3A) and (3B) define a condition in which recording data is maintained at the time of reproduction, the formula (4) defines condition in which recording data on the information recording layer is transferred to the mask layer, and the formula (5) define a condition in which recording data on the information recording layer is maintained at the time of reproduction.

(a) Condition for overwrite data deletion (i.e., writing “0”):

At the time of overwrite data deletion (i.e., writing “0”), the following formulas should be satisfied:

H₁+(σ_{w}/(M₁·t₁))>H₂−(σ_{w}/(M₂·t₂)) (6A),

H₁>H₂ (6B),

H₁+(σ_{w}/(M₁·t₁))+Hₑₓ (7A),

H₂>Hₑₓ (7B),

H₂<(σ_{w}/(M₁·t₁)) H₂−Hₑₓ (8A),

and

H₂<Hₑₓ (8B)

The formula (6A) and (6B) define a condition in which recording data is deleted. The formula (7A) and (7B) define a condition in which recording data on the mask layer (i.e., initializing data) is transferred to the information-recording layer. In this case, it is required that the writing magnetic field H.sub.ex does not delete initializing data on the mask layer. The formula (8A) and (8B) define a condition in which recording data on the information-recording layer 3 is deleted.

(d) Condition for overwrite data writing (i.e., writing “1”):

At the time of overwrite data writing (i.e., writing “0”), the following formula should be satisfied:

T_{C1}, T_{C2}<T_{WH} (9)

The formula (9) defines a condition required for Curie point writing to both of the mask layer and the information-recording layer. Therefore, both the mask and recording layers temporarily lose magnetization and data is written by the writing magnetic field Hₑₓ applied at the time of cooling.

As described above, in the present invention, compensation point material is used for the mask layer and the information recording layer, and relationship between the coercive force H₁ of the mask layer and the coercive force H₂ of the information recording layer remarkably varies depending upon the temperature of information recording or reproducing point. This is represented by the above formulas in which directions of the sign of inequality are opposite between the formulas (3A), (3B) and (6A), (6B), (4) and (7A), (7B), (5) and (8A), (8B). Thereby, transmitting directions of the exchange coupling forces can be directed opposite to each other.

Next, principles of recording and reproducing information on and from the optical disc will be described. At the time of reproduction, the mask layer is magnetized by the initializing magnetic field Hᵢₙᵢ so that all regions of the mask layer have the same vertical magnetizing direction (i.e., downward direction that corresponds to data “0”). Then, a read-out light having a predetermined polarization surface is irradiated on a reproducing position Pₚ on the magneto-optical recording medium so that the temperature of the mask layer and the information recording layer at the reproducing position Pₚ become substantially equal to the reproduction temperature.

By this, when temperature of the mask layer at the reproducing position PP exceeds the reproduction temperature Tᵣ, coercive force of the mask layer decreases, and recording data on the information recording layer is transferred to the mask layer by exchange coupling force. However, within a beam-spot of the read-out light, an area other than the reproducing position Pₚ still has the magnetizing direction of the initializing magnetic field Hᵢₙᵢ. As a result, according to magneto-optic effect such as Kerr Effect or Faraday Effect, polarization surface of the read-out laser light-beam is rotated by a certain angle (i.e., +θ or −θ) dependent upon the magnetization direction of the mask layer, and a reproduction light having polarization surface thus rotated is detected by a detector.

Therefore, if the two kinds of reproduction lights having different polarization surfaces are separated using a separation unit such as a polarizing filter or differential optical system, pit information of a portion (i.e., reproducing position Pₚ) within the read-out light spot can be selectively detected. This is optically equivalent to that a pin hole having smaller aperture than the diameter r of the read-out light spot which is defined by the wavelength λ of the read-out light and the numerical aperture NA is formed on the information recording surface of the optical disc, so that plural fine-size phase pits existing in the read-out light spot, that is, phase pits having high spatial frequency f (i.e., f>fc) can be reproduced.

At the time of overwrite deletion, the mask layer is magnetized by the initializing magnetic field Hᵢₙᵢ so that all regions of the mask layer have the same vertical magnetizing direction (i.e., downward direction which corresponds to data “0”). Then, a recording light is irradiated on a recording position P_{R} on the magneto-optical recording medium so that the temperature of the mask layer and the information recording layer at the recording position P_{R} become substantially equal to the temperature T_{WL} for the overwrite deletion.

By this, coercive force of the mask layer increases and the coercive force of the information recording layer decreases, and therefore recording data on the mask layer are transferred to the information-recording layer by exchange coupling force. As a result, magnetization direction of the information-recording layer at the recording position P_{R} is directed to the same direction (i.e., downward direction that corresponds to data “0”). Thus, overwrite deletion is performed. In this case, the overwrite deletion can be carried out onto the area only corresponding to the recording position P_{R} at minimum, and fine resolution recording is achieved by optical modulation.

At the time of overwrite writing, a recording light is irradiated on a recording position P_{R} on the magneto-optical recording medium so that temperature of the recording position P_{R} become substantially equal to the overwrite writing temperature T_{WH} higher than the Curie temperature T_{C1} of the mask layer and the Curie temperature T_{C2} of the information recording layer. By this, the mask layer and the information-recording layer lose coercive force (i.e., magnetization).

Thereafter, the writing magnetic field H.sub.ex having upward magnetization direction (i.e., corresponding to data “1”) is applied to the mask layer and the information recording layer. As a result, in the cooling process, magnetization direction of the mask layer and the information-recording layer at the recording position P_{R} are aligned to the same direction (i.e., upward direction that corresponds to data “1”). Thus, overwrite writing is performed. In this case, the overwrite deletion can be carried out onto the area only corresponding to the recording position P_{R} at minimum, and fine resolution recording is achieved by optical modulation.

Next, an operation of information recording and reproducing device for the optical disc according to the present invention will be described. The optical disc recording and reproducing device includes a recording circuit and a laser control circuit. The recording circuit outputs recording control data for performing optical modulation overwrite recording based on a recording information signal supplied from external. The laser control circuit outputs control signal, based on a mode selection signal supplied from external, for setting the laser power to be read-out laser power at the time of reproduction and setting the laser power to be recording laser power corresponding to recording control data at the time of recording.

Moreover, the device further includes a laser diode for emitting a laser beam serving as recording and read-out laser light beam, a beam splitter for passing the incident laser beam there through and reflecting a laser beam incident from a mirror, a mirror for guiding the laser beam, a quarterwave plate for adjusting the ratio of the reflected-light quantity and the transmitted-light quantity, at a position of polarizing beam splitter, of a laser light-beam from non-read-out regions of the reproducing light reflected from the beam splitter, a polarizing beam splitter for passing there through only a polarized light having a predetermined polarization state and reflecting other lights, a first light-receiving element for receiving the polarized light reflected from the polarizing beam splitter and outputting it as a first read-out signal (i.e., RF signal).

Moreover, a second light-receiving element for receiving a polarized light transmitted through the polarizing beam splitter and outputting it as a second read-out signal, a reproducing circuit including a decoder, an amplifier, etc. for converting the read-out signals and to a reproduced signal and outputting the reproduced signal, a magnet for applying reproduction magnetic field Hᵣ, a magnet for applying initializing magnetic field Hᵢₙᵢ, and a magnet for applying writing magnetic field Hₑₓ.

Firstly, a mode selection signal indicating reproduction mode is input, and the laser control circuit controls the laser diode so that power of the laser diode becomes read-out laser power. Thus, the laser diode emits read-out light. Simultaneously, the device applies the reproduction magnetic field H.sub.ini to the magneto-optical layer of the optical disc using the magnet to align the vertical magnetization direction in a predetermined direction before a recorded information read-out operation (i.e., initialization: downward direction). The linearly polarized read-out light emitted from the laser diode is focused, through the beam splitter onto the information-recording surface of the optical disc to form the read-out spot on a track. The read-out spot is moved on the track according to a rotation of the disc. On the track are formed phase pits having a spatial frequency f (i.e., f>fc) higher than a spatial frequency fc=NA/λ, which is defined by the wavelength λ of the read-out light and the numerical aperture. Specifically, plural phase pits and exists in the read-out spot, but the information of these phase pits and cannot be separated with any treatment, so that the reproducing operation cannot be surely performed.

Likewise, the same problem (i.e., that is, the accurate reproducing operation cannot be performed) occurs in the case where plural tracks are contained in the read-out light spot. In order to solve the above problem, by means of adjusting the output intensity of the read-out light, the temperature of the mask layer is increased above the reproduction temperature Tᵣ at an area located at a rear portion of the read-out spot, where recording information is transferred from the information recording layer to the mask layer by exchange coupling force in the area where information pit exists.

As a result, polarization surface of the reproduction light, which is reflected, by the information recording surface is rotated, according to magneto-optic effect, by an angle +θ or −θ, which is dependent on the vertical magnetization direction of the mask layer, i.e., the vertical magnetization direction of the information recording layer, and then the reproduction light returns to light-receiving element side. On the other hand, in an area XAR other than the area AR in the light spot, which contains the phase pit, the reproduction light is returned to the light-receiving element side with its polarization surface rotated with respect to the polarization surface of the readout light by a certain angle (e.g., constantly −θ) dependent upon the vertical magnetization direction at the time of initializing. The reproducing lights from the areas AR and XAR reach the beam-splitter in composite state.

However, if the quarterwave plate is adjusted so that the quantity of the reproducing lights whose polarization surface is rotated by the angle −θ from the area AR and the area XAR are incident to each of the first and second light-receiving elements in equal quantity and the beam-splitter is adjusted so that reproduction light having polarization angle rotated by +θ is incident upon the first light-receiving element and reproduction light having polarization surface angle rotated by −θ is incident upon the second light-receiving element, only reproduction light from the area AR and having polarization angle rotated by or +θ can be obtained by differentiating (i.e., calculating a differential output between) the first and second read-out signals.

Namely, the signal components of reproducing light from the area XAR is offset, and the area XAR is apparently shielded. Accordingly, in the reproducing circuit, only information of the area AR, that is, the phase pit can be read out, and thus the reproduced signal contains only information of the phase pit. As described above, according to the first embodiment, information having the spatial frequency f higher than the spatial frequency fc (i.e., =2NA/λ), which is defined by the wavelength λ of the read-out light and the numerical aperture of the objective lens can be reproduced.

Firstly, when a mode selection signal indicating recording mode is input, the laser control circuit recognizes the overwrite deletion instruction from recording control data output from the recording circuit. Then, the laser control circuit controls the laser diode, based on the laser control signal; so that power of the laser diode becomes recording laser power of overwrite deletion. Thus, the laser diode emits recording laser light for overwrite deletion. Simultaneously, the device applies the external magnetic field Hᵢₙᵢ to the magneto-optical layer of the optical disc using the magnet to align the vertical magnetization direction in a predetermined direction before a recorded information read-out operation (i.e., downward direction). The linearly polarized recording light emitted from the laser diode is focused, through the beam splitter onto the information-recording surface of the optical disc to form the light spot on a track. The light spot is moved on the track according to a rotation of the disc media.

By this operation, the temperature of the mask layer and the information recording layer at the area AR which is located rear side of the light spot exceeds the temperature T_{WL} for overwrite deletion, and the coercive force H₂ of the information recording layer decrease. Therefore, data (i.e., initializing data “0”) on the mask layer is transferred to the information recording layer by exchange coupling force. As described above, according to the present invention, overwrite deletion is carried out at the information reproducing position Pp in fine resolution state.

Firstly, when a mode selection signal indicating recording mode is input, the laser control circuit recognizes the overwrite writing instruction from recording control data output from the recording circuit. Then, the laser control circuit controls the laser diode, based on the laser control signal; so that power of the laser diode becomes recording laser power of overwrite writing. Thus, the laser diode emits read-out light for overwrite writing. The linearly polarized recording light emitted from the laser diode is focused, through the beam splitter onto the information-recording surface of the optical disc to form the light spot on a track. The light spot is moved on the track according to a rotation of the disc.

Moreover, by this operation, the temperature of the mask layer and the information recording layer at the area AR which is located rear side of the light spot exceeds the temperature T_{WH} for overwrite writing, and the coercive force H₁ of the mask layer and the coercive force H₂ of the information recording layer become zero. Therefore, magnetic domain in the area AR is extinguished. Accordingly, overwrite data corresponding to writing magnetic field Hₑₓ applied to the recording position P_{R} on the information-recording layer is written in cooling process, and recording is carried out in fine resolution state.

In the above-described embodiments, no layer is provided between the mask layer and the information-recording layer. However, an intermediate layer having small anisotropy of vertical magnetization, such as GdFeCo, may be provided between the two layers. This facilitates initialization, stabilizes recording and reproduction in fine resolution, and overwrites recording.

In the above-described embodiment, the mask layer is constituted by a monolayer. However, an exchange coupling layers such as GdFeCo/TbFe may be used as the mask layer. In such a case, synthetic coercive force of the layers constituting the mask layer rapidly varies according to temperature, and operation in fine resolution is stabilized.

Detailed Operation—FIGS. 62A, 63A, 62B, 63B, 62C, and 63C

The first and simplest embodiment of the present LIMDOW and MSR Magneto-Optical Microhead Array Chip Hard Disk Drive invention is based upon a shared bus-system, which is thoroughly described in the proceeding paragraphs along with the SCSI or IDE interface protocols a shared bus-system would use in communicating with a host computer system.

A detailed description of LIMDOW and MSR Magneto-Optical Microhead Array Chip Hard Disk Drive's operation typically begins with the initialization of a LIMDOW and MSR Magneto-Optical Microhead Array Chip Hard Disk Drive itself, which occurs by first performing a boot-up of its operating system and the running of its pre-check protocols. Thereafter, a LIMDOW or MSR Magneto-Optical Microhead Array Chip Hard Disk Drive will normally begin its regular operation with either a host-requested read-data or host-requested write-data disk-operation.

For example, during a read-data disk-operation a LIMDOW or MSR Magneto-Optical Microhead Array Chip Hard Disk Drive's Disk Controller will first forward a host-requested cylinder/track and data-sector address location to a LIMDOW or MSR Magneto-Optical Microhead Array Chip Hard Disk Drive's “Asynchronous Optical Microhead Address Controller” 63 (FIG. 4), 80 (FIG. 5) for translation and analysis. Wherein, an “Asynchronous Optical Microhead Address Controller”, which is located on a LIMDOW and MSR Magneto-Optical Microhead Array Chip Hard Disk Drive Controller's (PCB) “Printed Circuit Board” 63 (FIG. 4), 80 (FIG. 5), will temporarily store the host-requested address locations in an Asynchronous Optical Microhead Address Controller's “Address Translation Register”, which is located in the Asynchronous Optical Microhead Address Controller's “Address Unit”. Next, an “Asynchronous Optical Microhead Address Controller” will translate and analysis the address location information stored in an Asynchronous Optical Microhead Address Controller's “Address Translation Register” into executable control-code. Wherein, the control-code will be used to execute the host-selection of one particular LIMDOW or MSR Magneto-Optical Microhead Array Chip, which contains a stationary microhead array that contains a stationary microhead laser-diode located above one particular cylinder/track and data-sector location containing the host-requested data.

Moreover, the host-selection of a LIMDOW or MSR Magneto-Optical Microhead Array Chip and the microhead it contains is executed through a bus-system that is collectively shared by all installed LIMDOW or MSR Magneto-Optical Microhead Array Chips. This bus-system comprises a group of cables, which connects all installed LIMDOW and MSR Magneto-Optical Microhead Array Chips in a daisy-chained configuration and is used to send microhead address location and chip-control bus-signals to all LIMDOW or MSR Magneto-Optical Microhead Array Chips that are installed into a LIMDOW and MSR Magneto-Optical Microhead Array Chip Hard Disk Drive's unit-assembly.

However, before a read-data disk-operation can take place the “Asynchronous Optical Microhead Address Controller” must first select and enable one particular LIMDOW or MSR Magneto-Optical Microhead Array Chip from a group of other installed chips. While this selection process is similar to that used in conventional hard disk drives it differs because unlike flying data-head devices every installed LIMDOW and MSR Magneto-Optical Microhead Array Chip is comprised as a stationary device (i.e., always in one place), which contains a stationary microhead array that comprises a multitude of stationary and singularly addressable laser-diode microheads 1 (FIGS. 41, 42, 43, and 44).

In addition, the previously mentioned LIMDOW and MSR Magneto-Optical Microhead Array Chip process of selection is first initialized by executing a (-CS) “Chip Select” chip-control bus-signal (FIG. 64A, FIG. 64B), which is one of two control-signals responsible for the selection of a LIMDOW or MSR Magneto-Optical Microhead Array Chip amongst many that are collectively connected together in a LIMDOW and MSR Magneto-Optical Microhead Array Chip Hard Disk Drive's unit-assembly.

In addition, a LIMDOW or MSR Magneto-Optical Microhead Array Chip's chip selection process is accomplished by using point-to-point individual (-CS) “Chip Select” chip-control bus-lines. Wherein, one point-to-point chip-control bus-line is dedicated to and for each LIMDOW and MSR Magneto-Optical Microhead Array Chip installed into a LIMDOW and MSR Magneto-Optical Microhead Array Chip Hard Disk Drive's unit-assembly (i.e., eight installed Magneto-Optical Microhead Array Chips would each have its own separate “Chip Select” point-to-point control bus-line).

Subsequently, the previously mentioned (-CS) “Chip Select” point-to-point chip-control bus-lines are each redirected from their bus-line flex-cable connector location, which is present on every chip-positioning circuit board, to a chip-positioning circuit board surface-mounted chip-socket's input-contact assigned as pin-number “38”. Furthermore, the redirection of the (-CS) “Chip Select” point-to-point chip-control bus-lines, which are located on every chip-positioning circuit board that is installed into a LIMDOW and MSR Magneto-Optical Microhead Array Chip Hard Disk Drive's unit-assembly is based upon a cross-connect design, which uses a different and redirected (-CS) “Chip Select” line that is unique to each chip-positioning circuit board, to its circuit-trace architecture, and to the LIMDOW and MSR Magneto-Optical Microhead Array Chip installed into its chip-positioning circuit board's surface-mounted chip-socket, as illustrated in FIG. 17, 18, 19, 20, 21, 22, 23, and 24.

Therefore, a LIMDOW and MSR Magneto-Optical Microhead Array Chip chip-positioning circuit board surface-mounted chip-socket's input-contact assigned as pin-number “38” and a single chip-positioning circuit board's Polymer flex-cable connector input are together cross-connected, using a different Polymer flex-cable connector input contact location that is unique to each chip-positioning circuit board and the LIMDOW or MSR Magneto-Optical Microhead Array Chip installed there; moreover, giving individual chip select control over every LIMDOW or MSR Magneto-Optical Microhead Array Chip installed into a LIMDOW and MSR Magneto-Optical Microhead Array Chip Hard Disk Drive's unit-assembly.

In addition, there are eight different examples of redirected (-CS) “Chip Select” chip-selection chip-positioning circuit board cross-connects used within the LIMDOW and MSR Magneto-Optical Microhead Array Chip Hard Disk Drive's design. Wherein, FIG. 17 illustrates the (-CS) “Chip Select” Polymer flex-cable input bus-line “49” (-CSO) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

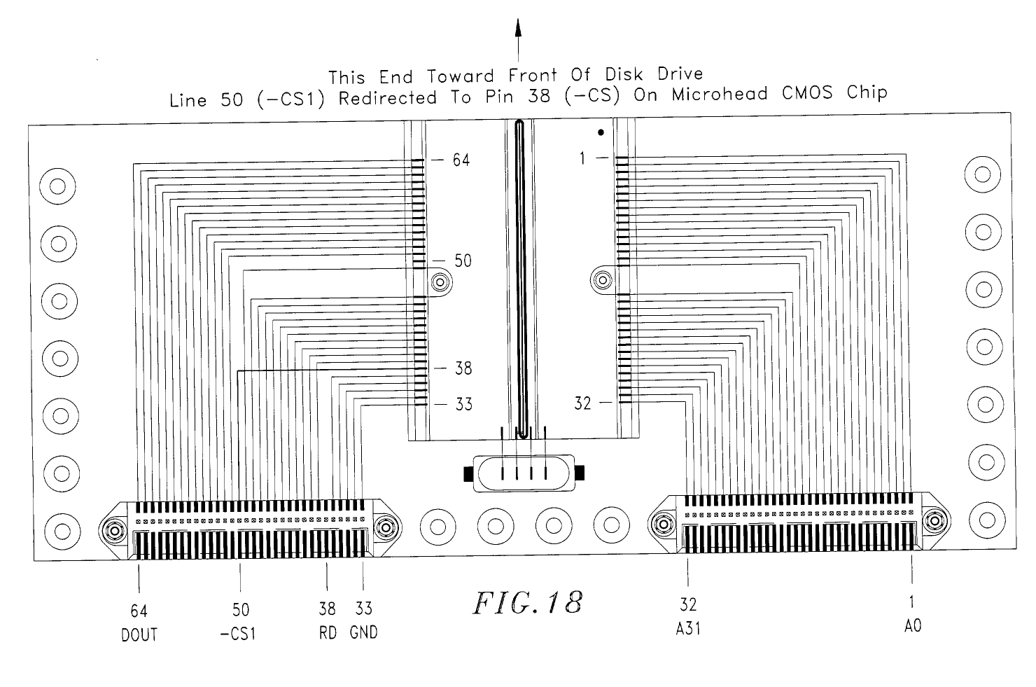

In addition, FIG. 18 illustrates the (-CS) “Chip Select” Polymer flex-cable input bus-line “50” (-CS1) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

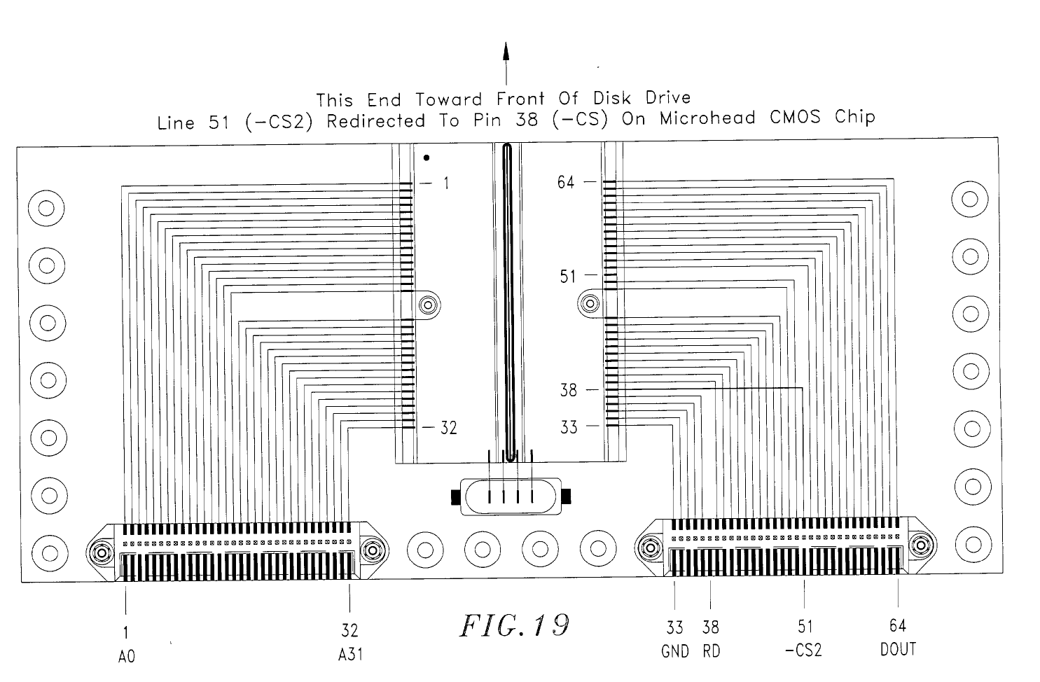

In addition, FIG. 19 illustrates the (-CS) “Chip Select” Polymer flex-cable input bus-line “51” (-CS2) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

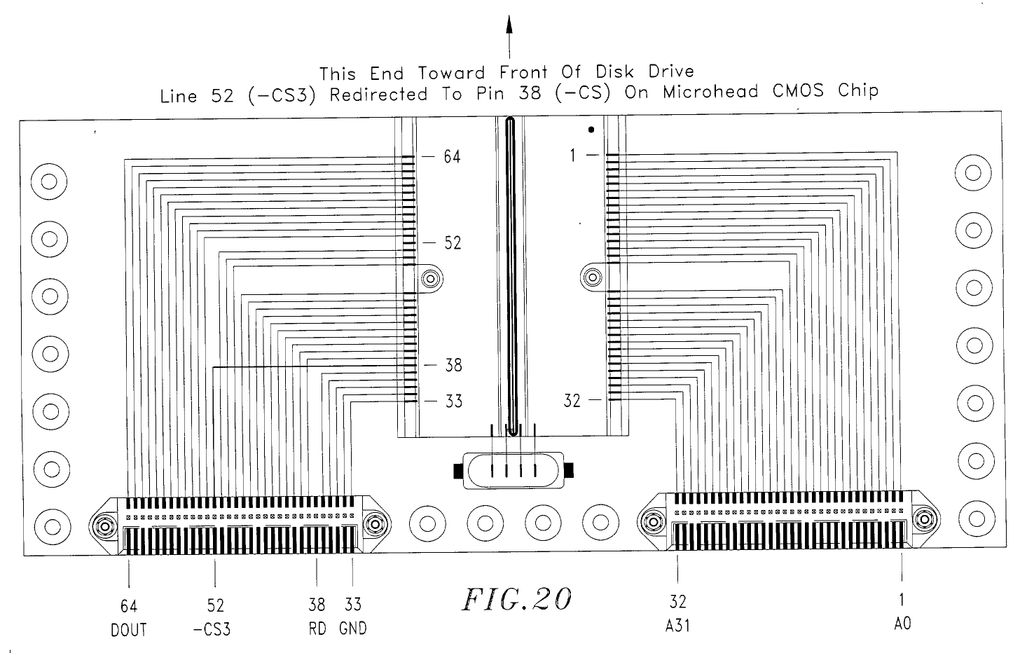

In addition, FIG. 20 illustrates the (-CS) “Chip Select” Polymer flex-cable input bus-line “52” (-CS3) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

In addition, FIG. 21 illustrates the (-CS) “Chip Select” Polymer flex-cable input bus-line “53” (-CS4) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

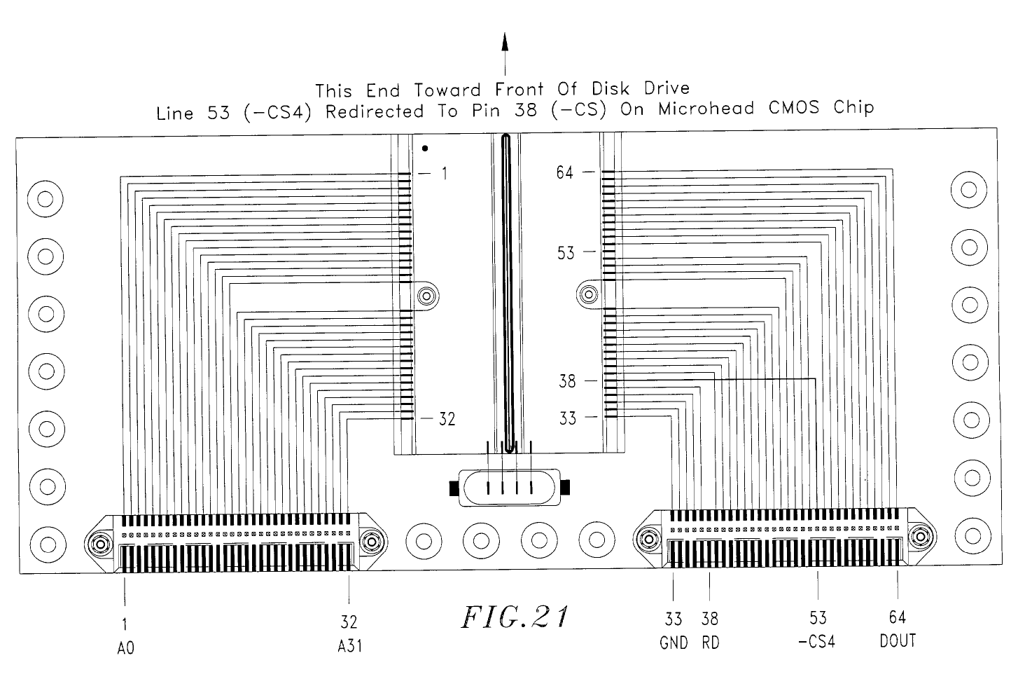

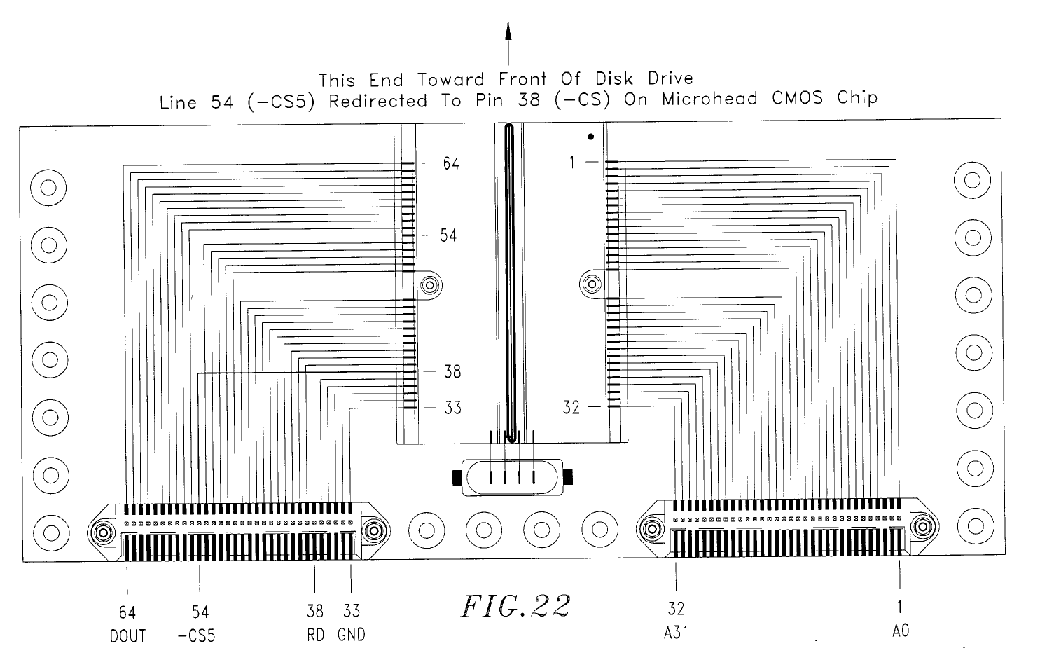

In addition, FIG. 22 illustrates the (-CS) “Chip Select” Polymer flex-cable input bus-line “54” (-CS5) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

In addition, FIG. 23 illustrates the (-CS) “Chip Select” Polymer flex-cable input bus-line “55” (-CS6) as redirected to the surface-mounted chip-socket's contact-input assigned as pin-number “38” (-CS) Chip Select contact-input (FIGS. 11 and 12), which is present in all LIMDOW and MSR Magneto-Optical Microhead Array Chips of the first bus-system embodiment.

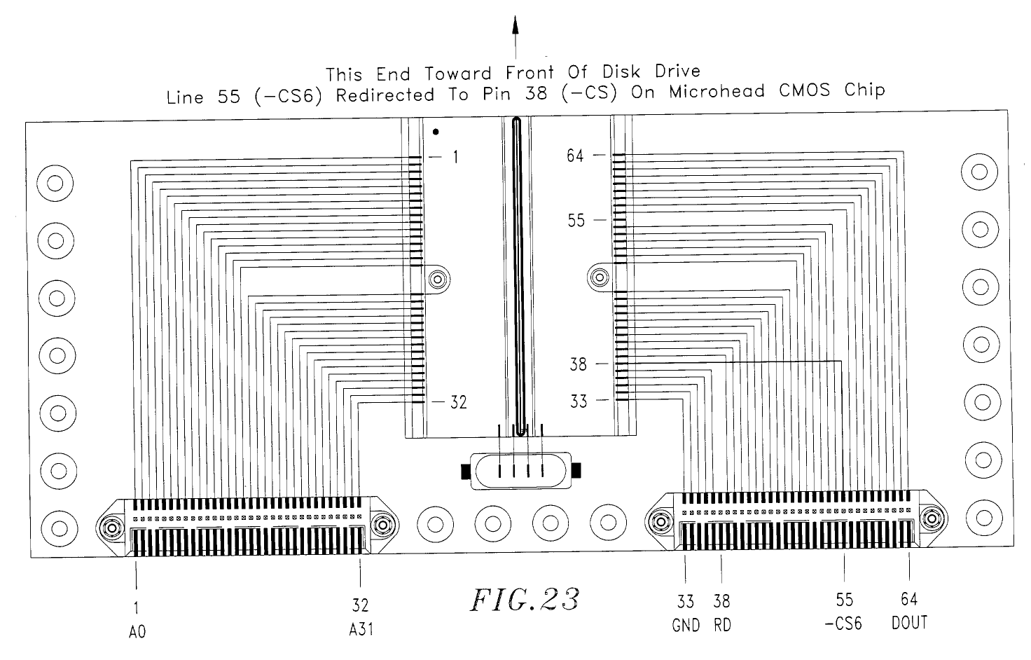

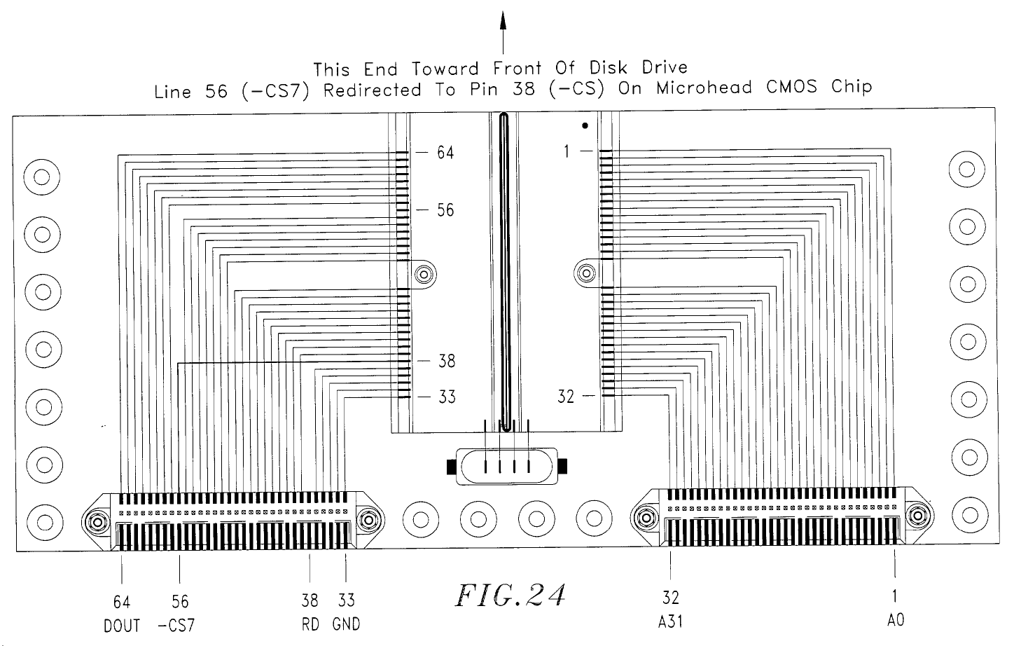

In addition, FIG. 24 illustrates the (-CS) Chip Select Polymer flex-cable input bus-line “56” (-CS7) as redirected to the surface-mounted chip-socket's contact-input assigned as pin-number “38” (-CS) “Chip Select” contact-input (FIGS. 11 and 12), which is present in all LIMDOW and MSR Magneto-Optical Microhead Array Chips of the first bus-system embodiment.

Furthermore, since there is one unique (i.e., non-bused point-to-point) (-CS) “Chip Select” bus-line available for each of the installed “8” LIMDOW and MSR Magneto-Optical Microhead Array Chips through cross-connected circuitry, each of the installed “8” LIMDOW and MSR Magneto-Optical Microhead Array Chips can now be individually selected and controlled during the course of any read-data disk-operation. Moreover, the connectivity of the LIMDOW and MSR Magneto-Optical Microhead Array Chip “Chip-Selection” process is illustrated in FIGS. 60A, 61A, 60B, 61B, 60C, and 61C.

Another preferred embodiment of the present LIMDOW and MSR Magneto-Optical Microhead Array Chip Hard Disk Drive invention, as illustrated in drawing FIGS. 4 and 5, describes a LIMDOW and MSR Magneto-Optical Microhead Array Chip's read-channel and its output signal's pathway. To start with the previously mentioned LIMDOW and MSR Magneto-Optical Microhead Array Chip's read-channel and its output signal's pathway begins at a LIMDOW and MSR Magneto-Optical Microhead Array Chip's two reversed-biased (SPC) “Semiconductor Photo-Conductor” linear position-sensing (CdS) “Cadmium Sulfide” semiconductor photoconductor-array read-elements 103, 104, 107, 108 (FIGS. 41, 42, 43, 44, 45, 46, 47, 48, 49, 50, 51, and 52), or as within a different embodiment, the two reversed-biased (SPD) “Semiconductor Photo-Diode” (Si) “Silicon” semiconductor photocell-array read-elements, as illustrated in FIGS. 64A, 64B, 64C, 64D, and 64E.

Moreover, as “magnetic-optical flux transitions”, previously recorded on a LIMDOW and MSR Magneto-Optical Microhead Array Chip Hard Disk Drive disk-platter's data-surface pass under a selected microhead's low intensity data scanning “Read Laser”, the two reversed-biased (SPD) “Semiconductor Photo-Diode” (Si) “Silicon” semiconductor photocell-array read-elements mentioned before will generate output-voltages from the reflected light they receive as the previously mentioned disk-platters rotate under the pre-selected laser-diode microhead.

Furthermore, the read-channel output signals created therein will be passed from the two reversed-biased (SPD) “Semiconductor Photo-Diode” (Si) “Silicon” semiconductor photocell-array read-elements previously mentioned, to the two reversed-biased (SPD) “Semiconductor Photo-Diode” (Si) “Silicon” semiconductor photocell-array read-element's of a LIMDOW or MSR Magneto-Optical Microhead Array Chip read-channel's (SPDAS1) “Semiconductor Photo-Diode Analog-signal 1” and (SPDAS2) “Semiconductor Photo-Diode Analog-signal 2” inputs for pre-amplification and signal encoding, as illustrated in FIGS. 64A, 64C, 79, 80, 81, 82, 83, 84, 85, and 85. Wherein, the pre-amplification of a selected microhead's data-stream signal-output will occur during a LIMDOW or MSR Magneto-Optical Microhead Array Chip Hard Disk Drive's read-data disk-operation.

In-conclusion, the following paragraphs contain a detailed description of a LIMDOW and MSR Magneto-Optical Microhead Array Chip's entire read-data disk-operation as its occurs during a read-channel's reading of data-sectors, which is thoroughly defined from its beginning (i.e., the host-systems request for data stored on a particular disk-platter) to its end (i.e., the host-systems reception of the requested data).

Moreover, a read-data disk-operation actually begins when a LIMDOW or MSR Magneto-Optical Microhead Array Chip Hard Disk Drive's Disk Controller has received a read-data request from a host computer system; moreover, a request to read-data from a particular disk-platter's cylinder/track containing a disk-sector or disk-sectors identified as containing host-requested data. For example, a host-system sends a read-data request to a LIMDOW or MSR Magneto-Optical Microhead Array Chip Hard Disk Drive's Disk Controller, through a computer system's IDE or SCSI interface, where it is received by a Disk Controller's “Optical Microhead And Disk Controller With IDE or SCSI Interface module.

Moreover, the request might look like this: Request data-read using disk id: “0”, data-head number: “5”, cylinder/track address-number: “4562”, data-sector address-number: “43”. Next, the “Asynchronous Optical Microhead Address Controller” module 63 (FIGS. 60A and 60C), 80 (FIGS. 61A and 61C), 63 (FIGS. 62A and 62B), 80 (FIGS. 63A and 63C) when it receives the request from the Disk Controller it will sample and hold it in its “Disk Controller Interface Register”, where it will be held until a different request is requested by the host-system or the read-data disk-operation has been completed. Furthermore, an Asynchronous Optical Microhead Address Controller's “Address Translator” will translate and analysis the information contained within a “Disk Controller Interface Register” and convert them into executable code the Asynchronous Optical Microhead Address Controller can use to activate the required LIMDOW or MSR Magneto-Optical Microhead Array Chip's “Address Latch And Chip-Select Circuit” bus-system signal-lines.

Moreover, to execute control over a particular LIMDOW or MSR Magneto-Optical Microhead Array Chip, an Asynchronous Optical Microhead Address Controller's “Address Translator” (FIGS. 62A, 63A, 62C, and 63C) will first tell the Asynchronous Optical Microhead Address Controller's “Address Unit” that LIMDOW or MSR Magneto-Optical Microhead Array Chip Number “5” is to selected, moreover being equivalent to a conventional flying data-head numbered as “5”. Wherein, an Asynchronous Optical Microhead Address Controller's response will be to enable the point-to-point (-CS4) “Chip Select” line-number “4” (i.e., the chip select lines available in the present design are CS0, CS1, CS2, CS3, CS4, CS5, CS6, and CS7) with a logic-low chip-control bus-signal, as illustrated in FIGS. 60A, 61A, 60B, 61B, 60C, and 61C. This begins the process that executes the selection of a single LIMDOW or MSR Magneto-Optical Microhead Array Chip, which is chosen because of its stationary location above the host-requested data-sectors present on disk-surface number “5”.

In addition, a (-CS) “Chip Select” logic-low chip-control bus-signal will make the LIMDOW or MSR Magneto-Optical Microhead Array Chip number “5” the only LIMDOW or MSR Magneto-Optical Microhead Array Chip connected to a LIMDOW or MSR Magneto-Optical Microhead Array Chip Hard Disk Drive's shared microhead addressing bus-system able to latch into its “Address Latch And Chip Select Circuit” (FIGS. 64A, 64B, and 64E) a single microhead's 32-bit address-location number, which is sent down a LIMDOW and MSR Magneto-Optical Microhead Array Chip Hard Disk Drive's thirty-two microhead addressing bus-system's thirty-two address-lines to every LIMDOW and MSR Magneto-Optical Microhead Array Chip that is connected to the shared microhead addressing bus-system, as illustrated in FIGS. 62A, 63A, 62B, 63B, 62C, and 63C.

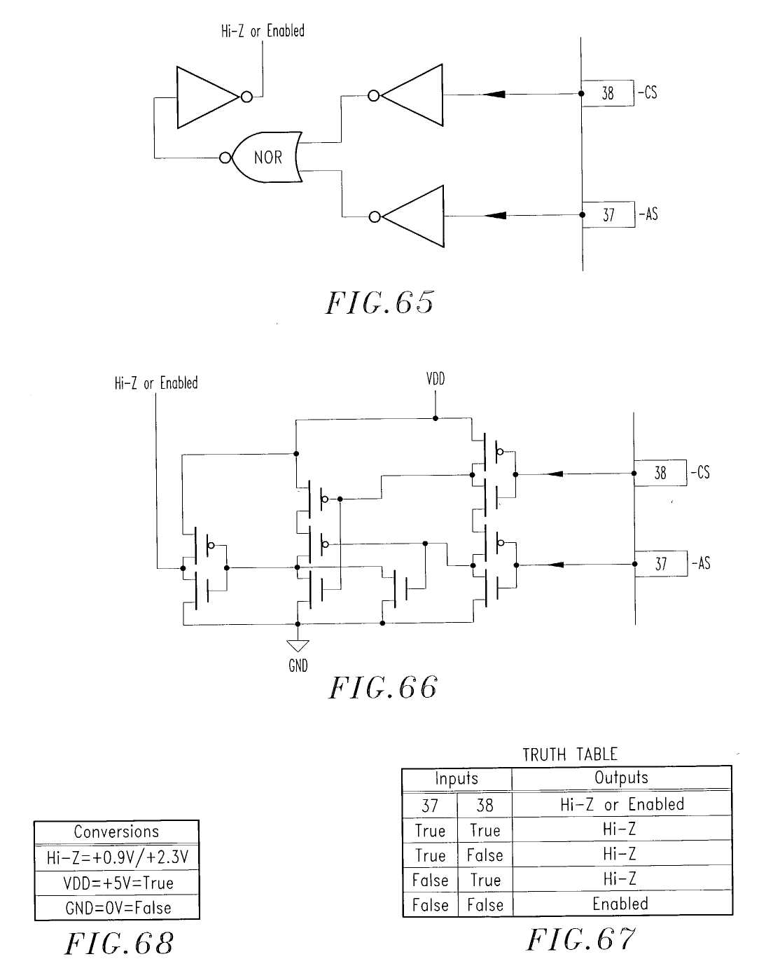

However, at the same time as the shared 32-bit microhead addressing bus-system sends the (i.e., cylinder/track) address number “4562” down its thirty-two lines, which are connected in parallel to all LIMDOW and MSR Magneto-Optical Microhead Array Chips installed into a LIMDOW and MSR Magneto-Optical Microhead Array Chip Hard Disk Drive's unit-assembly, a chip-control bus-system's logic-low control-signal called the (-AS) “Address Strobe” will be sent down the chip-control bus-system's (-AS) “Address Strobe” signal-line to an input-contact assigned as pin-number “37” (FIGS. 11 and 12) for every LIMDOW and MSR Magneto-Optical Microhead Array Chip installed. Only when a simultaneous and combined transmission of logic-low chip-control bus-signals are sent down both the (-CS4) “Chip Select 4” selection line-number “5” to input-contact assigned pin-number “38”, and the (-AS) “Address Strobe” to input-contact assigned pin-number “37” (FIGS. 65, 66, 67, and 68), will the LIMDOW or MSR Magneto-Optical Microhead Array Chip number “5” be selected for executing the host-requested read-data disk-operation.

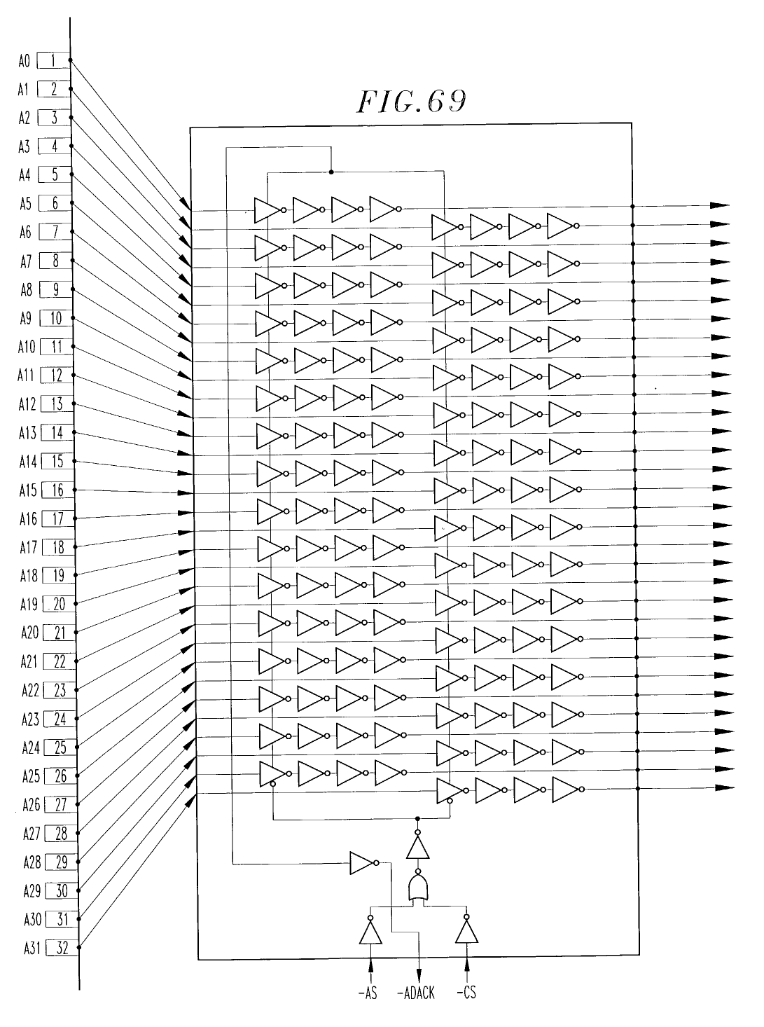

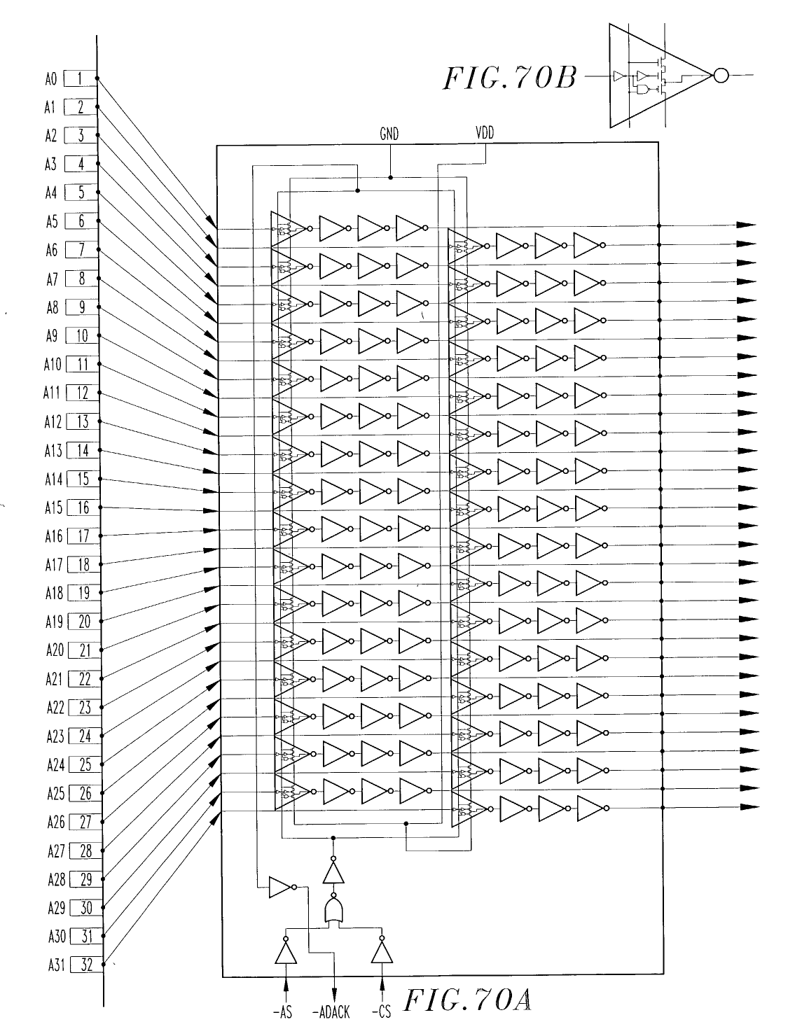

Conclusion, only the LIMDOW or MSR Magneto-Optical Microhead Array Chip number “5” is selected to latch (FIGS. 70A and 70B), into its tri-stated “Address Latch And Chip Select Circuit”, (FIGS. 69, 70A, and 70B) the previously mentioned cylinder/track location address-number “4562”. The aforementioned 32-bit address-number “4562” will stay latched into a LIMDOW Magneto-Optical Microhead Array Chip's tri-stated “Address Latch And Chip Select Circuit” as long as the previously mentioned (-CS4) and (-AS) bus-lines continue to have logic-low chip-control bus-signals present on their bus-lines.

In addition, a LIMDOW and MSR Magneto-Optical Microhead Array Chip's microhead addressing shared bus-system connection consists of a 32-bit input of thirty-two contacts, which are assigned numbers “A0” through “A31”, as illustrated in FIGS. 11, 12, 13, and 14. Next, after the microhead location address-number “4562” has been successfully latched into an “Address Latch And Chip Select Circuit” the (-ADACK) “Address Acknowledge” circuit will send a logic-low chip-control bus-signal down its chip-control bus-system control line. Moreover, the beforementioned (-ADACK) chip-control bus-signal is generated from the simultaneous enabling of a selected LIMDOW or MSR Magneto-Optical Microhead Array Chip's (-CS4) and (-AS) chip-control circuits, as illustrated in FIGS. 65, 66, 67, and 68. The previously mentioned (-CS4) and (-AS) chip-control circuits (FIGS. 65, 66, 67, and 68) are located within a selected LIMDOW or MSR Magneto-Optical Microhead Array Chip's “Address Latch And Chip Select Circuit”, as illustrated in FIGS. 69, 70A, and 70B. The (-ADACK) chip-control bus-signal is sent from a selected LIMDOW and MSR Magneto-Optical Microhead Array Chip's output-contact (FIGS. 11, 12, 13, and 14) assigned as pin-number “40” down the bus-system's cable to an “Asynchronous Optical Microhead Address Controller” module's 63 (FIGS. 60A and 60C), 80 (FIGS. 61A and 61C), 63 (FIGS. 62A and 62B), 80 (FIGS. 63A and 63C) “Address Acknowledge” input-contact location (FIGS. 60A, 61A, 60C, and 61C), which is physically located on a LIMDOW and MSR Magneto-Optical Microhead Array Chip Hard Disk Drive's PCB 63 (FIG. 4), 80 (FIG. 5).

Furthermore, the logic-low chip-control bus-signal received at an Asynchronous Optical Microhead Address Controller's (-ADACK) “Address Acknowledge” input-contact (FIGS. 60A, 61A, 60C, and 61C) tells an “Asynchronous Optical Microhead Address Controller” that the microhead location address-number “4562” has been successfully latched into a selected LIMDOW or MSR Magneto-Optical Microhead Array Chip's “Address Latch And Chip Select Circuit” (FIGS. 69, 70A, and 70B), which is located in the selected LIMDOW or MSR Magneto-Optical Microhead Array Chip number “5”. The successfully latched 32-bit microhead selecting address-signal is next sent from the previously mentioned 32-bit “Address Latch And Chip Select Circuit” to a selected LIMDOW or MSR Magneto-Optical Microhead Array Chip's 32-bit “Address Decoder Circuit” for decoding, as illustrated in FIGS. 64A, 64B, 71, 72.

Subsequently, when a selected LIMDOW or MSR Magneto-Optical Microhead Array Chip's “Address Decoder Circuit” receives a 32-bit microhead location address-number selection signal (i.e., thirty-two high and low electronic signals) it will decode it internally using an “address tree decoder” circuit, as illustrated in FIGS. 64A, 64B, 72, and 73. The process of decoding a latched 32-bit microhead location address-number by the beforementioned “address tree decoder” circuit (FIGS. 71 and 72) results in the enabling of one microhead selecting “microhead selection-line” with a logic-high chip-control bus-signal. Wherein, the previously mentioned microhead selection-line, which is numbered as “4562” is enabled out of “4,000,000,000” (i.e., thirty-two bits) of possible selection-line addresses (i.e., actual number of addressable section-lines within each microhead chip would more likely be between 100,000 and 300,000 addressable lines).

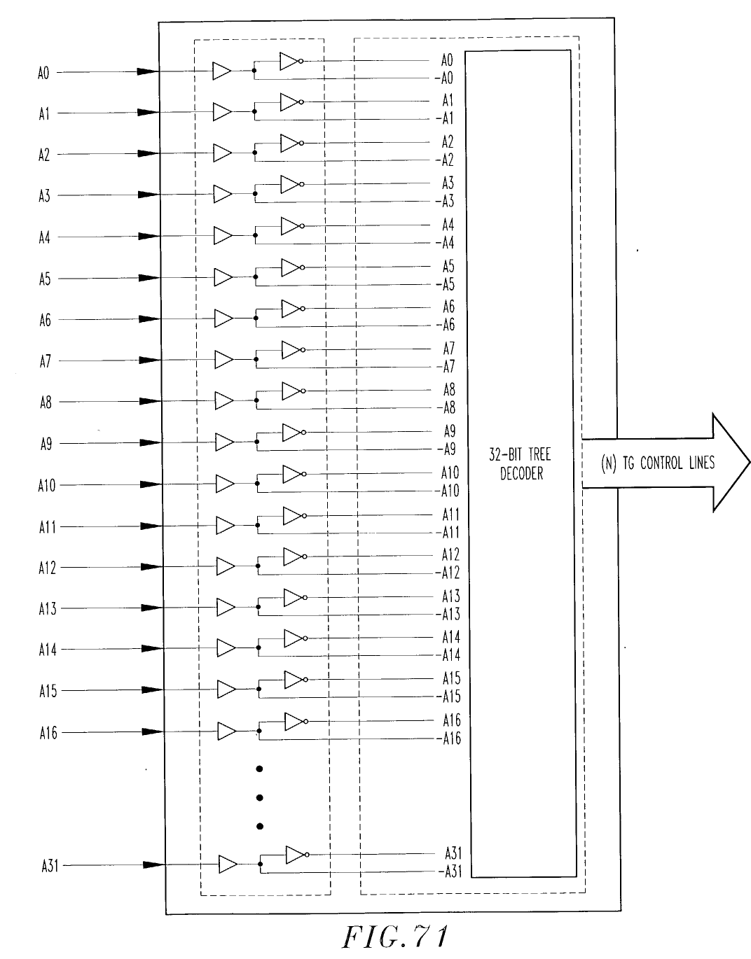

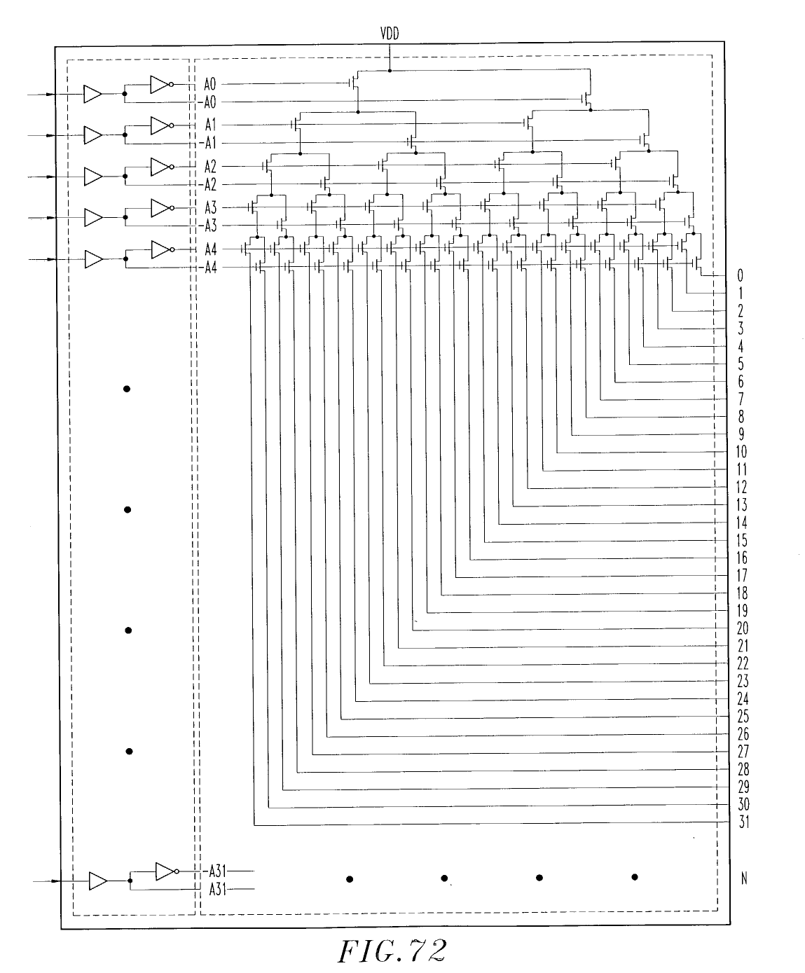

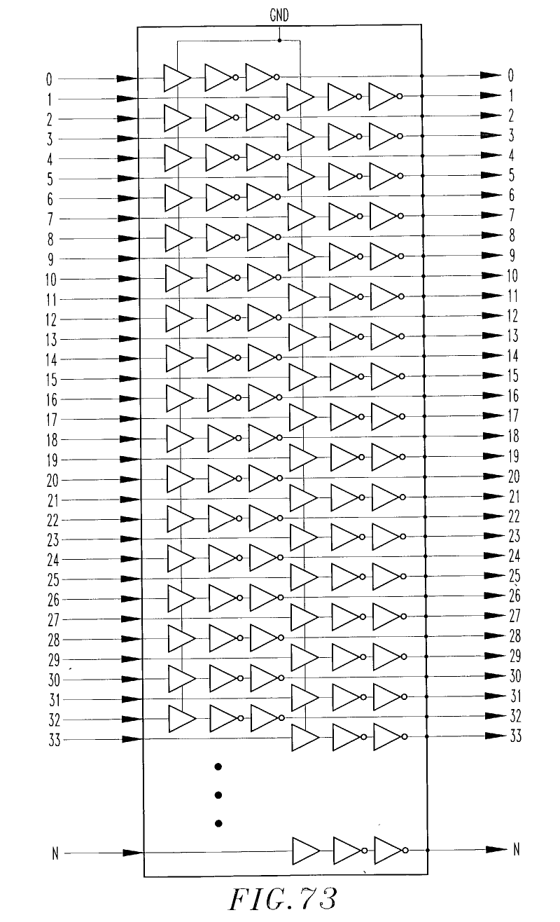

In addition, due to what is sometimes called “inverter body effect”, or the signal loss caused by semiconductor circuits containing a large number of switchable inverters, for example, like the large number of inverters present in an “address tree decoder” circuit. Moreover, this is due to the shear number of MOSFET or MESFET inverter and/or emitter gates a logic-high control-signal must travel through, which ultimately causes the previously mentioned logic-high control-signal to undergo signal loss and, therefore to degrade. Consequently, an address tree decoder's singularly enabled “Microhead Selection-Line” (MSL) will need its logic-high control-signal regenerated by a selected LIMDOW or MSR Magneto-Optical Microhead Array Chip's “Address Buffer Circuit” (FIGS. 73 and 74), or the previously mentioned signal-loss is bound to occur, possibly causing a microhead selection error.

Furthermore, when a LIMDOW or MSR Magneto-Optical Microhead Array Chip's “Address Decoder Circuit” sends a logic-high activation signal down a host-requested microhead's selection-line to a LIMDOW or MSR Magneto-Optical Microhead Array Chip's “Address Buffer Circuit” (FIGS. 64A, 64B, 73, and 74) two very important and simultaneous processes will occur:

i.) A regeneration of an address tree decoder's logic-high microhead selection signal by a LIMDOW or MSR Magneto-Optical Microhead Array Chip's “Address Buffer Circuit”, as illustrated in FIGS. 64A, 64B, and 74;

ii.) A pulling-down of the address tree decoders' unsolicited microhead selection-lines into a ground state using the Long-L inverters present within a LIMDOW or MSR Magneto-Optical Microhead Array Chip's “Address Buffer Circuit”, as illustrated in FIGS. 64A, 64B, and 74.

Consequently, the pulling-down of the unsolicited microhead selection-lines into a ground state will also put those same microhead selection lines into what is normally called a (Hi-Z) “High Impedance Line State”.

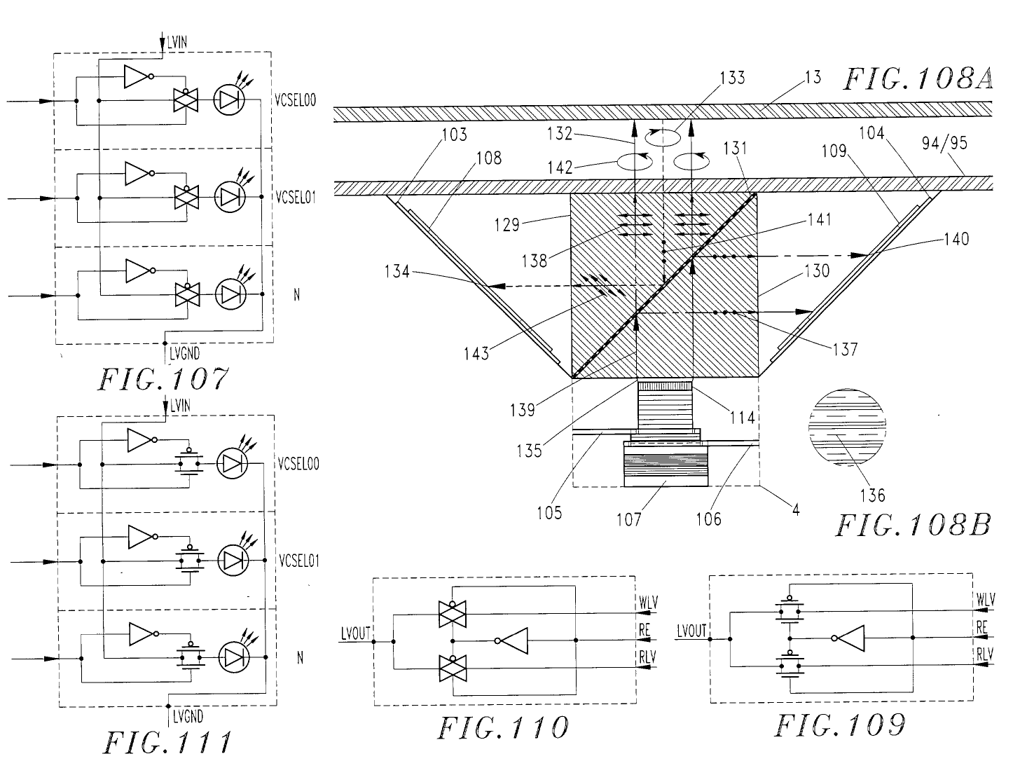

Furthermore, every MSL located within a selected LIMDOW and MSR Magneto-Optical Microhead Array Chip's microhead array has its beginning in a LIMDOW and MSR Magneto-Optical Microhead Array Chip's “Address Decoder Circuit”, while having its termination in the respective microhead’ location. Wherein, each previously mentioned MSL is terminated by a transmission-gate control-circuit, as illustrated in FIGS. 64A, 64B, 64E, 107, and 111. The MSL transmission-gates (FIGS. 107 and 111) are used to independently control a microhead's access to the host-selected LIMDOW and MSR Magneto-Optical Microhead Array Chips' power-bus system lines, as illustrated in FIGS. 107 and 111.

In addition, (RLV) “Read Laser Voltage”, (WLV1) “Write Laser Voltage One”, and (WLV2) “Write Laser Voltage 2” microhead laser power-signals, which are inputted at a selected LIMDOW or MSR Magneto-Optical Microhead Array Chip's (FIGS. 107 and 111) (LVIN) “Laser Voltage In” input-contact (FIGS. 64A and 64E), or more specifically, the switching that occurs between a LIMDOW and MSR Magneto-Optical Microhead Array Chip's (RLV) “Read Laser Voltage” and a LIMDOW and MSR Magneto-Optical Microhead Array Chip's (WLV1) “Write Laser Voltage One” and (WLV2) “Write Laser Voltage Two” microhead power-signals, occurs within a selected LIMDOW Magneto-Optical Microhead Array Chip's (Microhead PCC) “Microhead Power Control Circuit” (FIGS. 64A, 64D, 109, and 110), while the switching itself is controlled by a selected LIMDOW or MSR Magneto-Optical Microhead Array Chip's “R/W Control Circuit”, as illustrated in FIGS. 87, 88, 89, and 90.

In addition, the actual switching on or off of electrical current to a selected LIMDOW or MSR Magneto-Optical Microhead Array Chip's (RLV) “Read Laser Voltage”, (WLV1) “Write Laser Voltage One”, and (WLV2) “Write Laser Voltage Two” power-bus line is executed by a Data Sequencer's “Data Bus Controller”, as illustrated in FIGS. 62A, 63A, 62B, 63B, 62C, and 63C. Remember, for a host-requested read-data disk-operation to occur a LIMDOW or MSR Magneto-Optical Microhead Array Chip's “R/W Control Circuit” (FIGS. 87, 88, 89, and 90) must first enable a selected LIMDOW or MSR Magneto-Optical Microhead Array Chip's read-channel with a (RE) “Read Enable” logic-high control-signal.

Furthermore, in order for LIMDOW and MSR Magneto-Optical Microhead Array Chip Hard Disk Drives to commence disk-operations as quickly as possible a LIMDOW and MSR Magneto-Optical Microhead Array Chip's R/W Control Circuit's default setting after a “Power-On-Restart” and/or “Power-On-Initialization” has been executed is to have a selected LIMDOW or MSR Magneto-Optical Microhead Array Chip's read-channel enabled. The purpose of enabling a LIMDOW and MSR Magneto-Optical Microhead Array Chip's read-channel just after a “Power-On-Restart” and/or “Power-On-Initialization” is so that the (OP Code) “Operational Code” from a system containing disk-platter data-surface can be read from track-0 into a Disk Controller's (SDRAM) “Synchronous Dynamic Random Access Memory” buffer area, which has been put aside for the execution of a LIMDOW and MSR Magneto-Optical Microhead Array Chip Hard Disk Drive's disk operating OP Code software.

Furthermore, the control-bus circuits that enable or disable a read-channel of a host-selected LIMDOW or MSR Magneto-Optical Microhead Array Chip consist of three control logic circuits:

i.) A LIMDOW or MSR Magneto-Optical Microhead Array Chip's (R/-W) “Read or Write enable” control-bus signal-line, which is connected at input-contact pin-number “35”;

ii.) A LIMDOW or MSR Magneto-Optical Microhead Array Chip's (+5V) “VDD” control-bus signal-line, which is connected at input-contact, pin-number “34”;

iii.) A LIMDOW or MSR Magneto-Optical Microhead Array Chip's (CS) “Chip Select” point-to-point control-bus signal-line, which is connected at input-contact pin-number “38”.

Moreover, the three previously mentioned control logic circuits are located in every LIMDOW and MSR Magneto-Optical Microhead Array Chip (FIGS. 64A, 64C, 87, 88, 89, and 90) installed into a LIMDOW Magneto-Optical Microhead Array Chip Hard Disk Drive's unit-assembly. To enable a read-channel, which is located within every LIMDOW and MSR Magneto-Optical Microhead Array Chip, three logic conditions must occur simultaneously within the selected LIMDOW or MSR Magneto-Optical Microhead Array Chip's “R/W Control Circuit”:

i.) A logic-high control-signal must be present on a host-requested LIMDOW or MSR Magneto-Optical Microhead Array Chip's input-contact pin-number “34” (+5V) “VDD”;

ii.) A logic-low control-signal must be present on a host-requested LIMDOW or MSR Magneto-Optical Microhead Array Chip's input-contact pin-number “38” (-CS) “Chip Select”;

iii.) A logic-high control-signal must be present on a host-requested LIMDOW or MSR Magneto-Optical Microhead Array Chip's input-contact pin-number “35” (R/-W) “Read or Write enable”.

Moreover, the previously mentioned three control bus-system signal-lines must have three logic signal conditions simultaneously present across their lines in order for a host-requested LIMDOW or MSR Magneto-Optical Microhead Array Chip's read-channel to become enabled for a read-data disk-operation to be executed by the Disk Controller. Since all LIMDOW and MSR Magneto-Optical Microhead Array Chips have the same pin assignment configuration; in order to select any particular LIMDOW or MSR Magneto-Optical Microhead Array Chip that might be needed, a physical re-direction of an Asynchronous Optical Microhead Address Controller's point-to-point “Chip Select” line must be accomplished at the level of the chip-positioning circuit board.

For example, the beforementioned physical re-direction of an Asynchronous Optical Microhead Address Controller's point-to-point “Chip Select” for a line-number “4” would need to be made at the copper-trace circuit-runs (FIG. 21) of the chip-positioning circuit board containing the host-requested LIMDOW or MSR Magneto-Optical Microhead Array Chip number “5”. Whereby, a predetermined cross-connection is physically made for (-CS4) “Chip Select” line-number “4”, by re-routing a single copper-trace circuit-run (FIG. 21) from input-contact pin-number “53” of a chip-positioning circuit board's Polymer flex-cable spring-contact connector 67 (FIGS. 2, 3, and 10) location to a (-CS) “Chip Select” and null input-contact location labeled pin-number “38” of the host-requested LIMDOW or MSR Magneto-Optical Microhead Array Chip's surface-mounted chip-socket 5 (FIGS. 7, 8, and 21).

Moreover, as first embodiment of the present LIMDOW and MSR Magneto-Optical Microhead Array Chip Hard Disk Drive invention's bus system, every LIMDOW or MSR Magneto-Optical Microhead Array Chip installed into a LIMDOW or MSR Magneto-Optical Microhead Array Chip Hard Disk Drive using a chip-positioning circuit board, as described above, will be connected to the “Address Bus” system, the “Data I/O Bus” system, and the “Chip Control Bus” system of the LIMDOW or MSR Magneto-Optical Microhead Array Chip Hard Disk Drive's unit-assembly. It is through the previously described circuit cross-connection that a host-requested LIMDOW or MSR Magneto-Optical Microhead Array Chip, like chip number “5” used in the previously cross-connection example, becomes the only LIMDOW or MSR Magneto-Optical Microhead Array Chip connected to a LIMDOW or MSR Magneto-Optical Microhead Array Chip Hard Disk Drive's bus-system to become selected; having its read-channel activated, while all other LIMDOW or MSR Magneto-Optical Microhead Array Chips connected to a LIMDOW or MSR Magneto-Optical Microhead Array Chip Hard Disk Drive's bus-system, being non-selected; having their read-channels' placed into a non-logic state of impedance, or what is sometimes called a (Hi-Z) “High Impedance Line State”.

Next, a LIMDOW or MSR Magneto-Optical Microhead Array Chip, after being selected by a host-system to execute a read-data disk-operation, will also need to have its read-channel I/O enabled with a (RE) “Read Enable” logic-high control-signal; sent internally by a selected LIMDOW or MSR Magneto-Optical Microhead Array Chip's “R/W Control Circuit”, which, itself comprises of three read-channel I/O enabling line-driver circuits. The previously mentioned three read-channel line-driver circuits (FIGS. 79, 80, 85, and 86), after simultaneous reception of a R/W Control Circuit's (RE) “Read Enable” logic-high control-signal, will activated the read-channel's I/O, providing open connectivity to a LIMDOW or MSR Magneto-Optical Microbead Array Chip Hard Disk Drive's Disk Controller, which is waiting to execute the host-requested data retrieval.

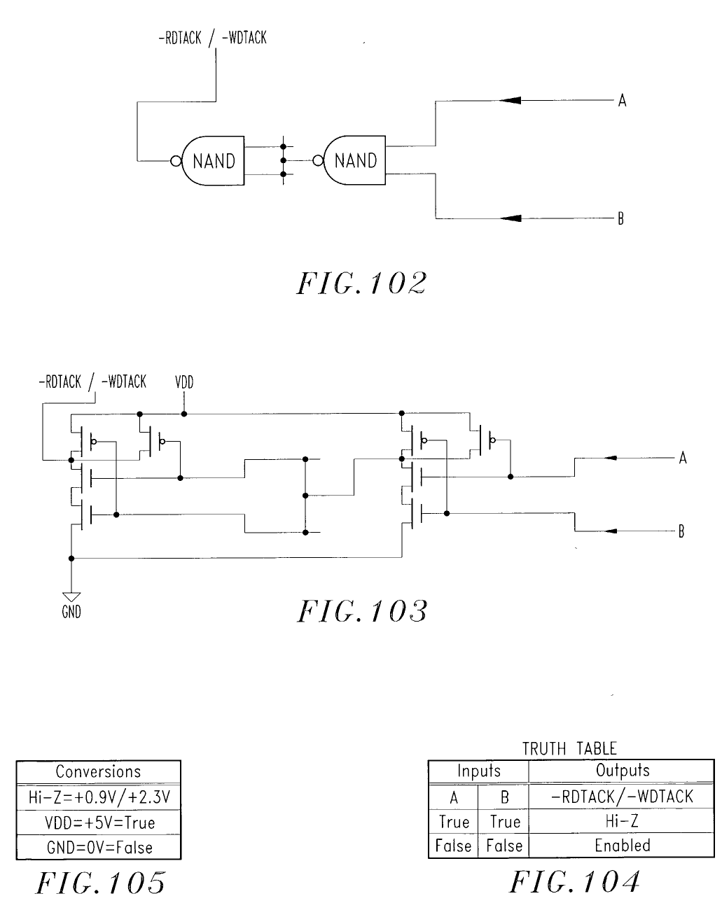

Moreover, the previously described activation process is described in more detail below. Wherein, two logic-high control-signals, being described as being sent by two of the read-channel's three line-drivers, will have entered the (A) and (B) inputs of the read-channel's double NAND (-RDTACK) “Read Data Acknowledge” control-circuit. Wherein, if the previously mentioned (A) and (B) inputs of the read-channel's double NAND (-RDTACK) “Read Data Acknowledge” control-circuit (FIGS. 102, 103, 104, and 105) both receive logic-high control-signals, then the control-circuit's double NAND, will, in response, output a (-RDTACK) “Read Data Acknowledge” logic-low control-signal out, onto the (-RDTACK) “Read Data Acknowledge” control-bus line, which is connected to all bus-system output-contacts labeled pin-number “41” on all installed LIMDOW and MSR Magneto-Optical Microhead Array Chips, as illustrated in FIGS. 64A, 64C, and 64D.

Moreover, a LIMDOW or MSR Magneto-Optical Microhead Array Chip's (-RDTACK) “Read Data Acknowledge” logic-low control-signal, while being sent to pin-number “41” over the shared control-bus, will travel through a control-bus Polymer flex-cable's (-RDTACK) “Read Data Acknowledge” control-bus signal-line 30, 36 (FIGS. 1 and 6) until it reaches a (-RDTACK) “Read Data Acknowledge” input-contact, which is located in the Data Sequencer's “Data Bus Controller”, as illustrated in FIG. 62A, 63A, 62C, and 63C. Next, after a Data Sequencer's “Data Bus Controller” has received the (-RDTACK) “Read Data Acknowledge” logic-low control-signal, the Data Sequencer's “Data Bus Controller” will know that the selected LIMDOW or MSR Magneto-Optical Microhead Array Chip's read-channel is now open and is ready to read host-requested data from a host-requested data-sector, for example, data-sector “45”, which is located on its respective disk-platter number “5”, at cylinder/track location “4562”, and read using the addressed microhead “4562”, which is located directly above cylinder/track location “4562”.

In addition, a LIMDOW or MSR Magneto-Optical Microhead Array Chip's (MPCC) “Microhead Power Control Circuit” will also receive a (RE) “Read Enable” logic-high control-signal from a LIMDOW or MSR Magneto-Optical Microhead Array Chip's “R/W Control Circuit”, which in turn will cause the Microhead Power Control Circuit's respective transmission-gates to toggle-switch a selection (FIGS. 109 and 110) of a LIMDOW or MSR Magneto-Optical Microhead Array Chip's (RLV) “Read Laser Voltage” power-line over the LIMDOW or MSR Magneto-Optical Microhead Array Chip's (WLV1) “Write Laser Voltage One”, and/or (WLV2) “Write Laser Voltage Two” power-lines. Once toggled a selected power-line will have access to a LIMDOW or MSR Magneto-Optical Microhead Array Chip's (LVOUT) “Laser Voltage Output” circuit terminal (FIGS. 109 and 110), which ultimately leads to a LIMDOW or MSR Magneto-Optical Microhead Array Chip's (LVIN) “Laser Voltage Input” circuit terminal (FIGS. 107 and 111).

Furthermore, although a (RLV) “Read Laser Voltage” power-line has been selected for a host-requested read-data disk-operation, no electrical-current will be sent down the power-line to a LIMDOW or MSR Magneto-Optical Microhead Array Chip's host-selected microhead until a host-requested data-sector has been rotated into position and detected as being underneath the host-selected microhead. Whereby, at the very instant the host-requested data-sector lines-up underneath the address selected microhead, will a low-powered electrical current be sent down the power-line to the LIMDOW or MSR Magneto-Optical Microhead Array Chip's (RLV) “Read Laser Voltage” internal power-line; therein, activating a selected microhead's data-reading low-power laser-emissions, which is continued until the whole host-requested data-sector is read in one complete revolution of the disk platter containing the sector.

Moreover, the previously mentioned data-sector as it passes underneath the host-selected microhead it is essentially scanned by the microhead's data-reading low-power laser-emissions; as this scanning process occurs, the resultant output is a streaming data-signal, which is partially encoded during its output to the Data-Sequencer's DPLL, where it will receive additional signal conditioning and conversion. Afterwards, the signal converted data-signal is next passed via the Data-Sequencer's Disk Controller Interface to the Disk Controller's ECC circuit, where it is checked against an ECC table for errors, if the data is error free it is next passed to the Disk Controller's internal memory cache via the previously mentioned Disk Controller Interface and the Disk Controller's Buffer Controller circuit, where it is next stored temporarily until the host-system is ready to retrieve it.

Furthermore, a LIMDOW or MSR Magneto-Optical Microhead Array Chip Hard Disk Drive's “Hall-Sensors” (i.e., not shown here) will provide information pertaining to the disk-platter rotation relative to data-sector location. Moreover, by using the constantly changing rotational placement of permanent-magnetic rotary-elements, which are located within a rotor-housing, the Disk Controller, using Hall-Sensors to detect the rotor located permanent-magnetic rotary-elements will always know at any given moment the location and rotational position of disk-platters and the data-sectors they contain. Moreover, the previously mentioned rotational placement is relative to the fixed windings and poles of a “Spindle-Motor” 59 (FIGS. 2 and 3). Typically, the previously mentioned “Hall-Sensors” will provide response-feedback and control information to a LIMDOW or MSR Magneto-Optical Microhead Array Chip Hard Disk Drive's “Spindle And Power Controller” 60 (FIG. 4), 82 (FIG. 5) and Spindle-Motor's driver-circuit, which is located on a Disk Controller's PCB.

In addition, the beforementioned “Hall-Sensors” (i.e., not shown here) will also provide the real-time rate of rotation and positional information for the disk-platters installed within a LIMDOW or MSR Magneto-Optical Microhead Array Chip Hard Disk Drive's unit-assembly. This information is typically sent to the beforementioned “Spindle And Power Controller” 60 (FIG. 4), 82 (FIG. 5), which, in-turn sends disk-platter rate of rotation and positional information to a Disk Controller's “Data Sequencer”, which, in-turn precisely controls the switching on and off of a LIMDOW or MSR Magneto-Optical Microhead Array Chip Hard Disk Drive's (RLV) “Read Laser Voltage”, (WLV1) “Write Laser Voltage One”, or (WLV2) “Write Laser Voltage Two”, all of which are power signals that exhibit three different electric current levels, which are used during host-requested read-data or write-data disk-operations to activate a selected microhead laser's emissions.

Moreover, the source of the laser-light used during host-requested disk-operations could possibly come from any applicably constructed semiconductor laser-diode, preferably a VCSEL, a FCSEL, or some other type of surface emitting laser-diode. Wherein, such semiconductor laser-diodes, along with their respective photo-detectors, would be comprised as a plurality of microheads; altogether, forming within every LIMDOW and MSR Magneto-Optical Microhead Array Chip an array. In addition, to the previously mentioned microhead array, there is typically an “Ahrens Polarizing Analyzer” laser-light polarizer, which in one embodiment is typically positioned just above the top surface of a group of microhead laser-diode emitters 114 (FIG. 108A). Wherein, a multidirectional un-polarized light-beam being emitted by a host-selected microhead laser-diode 135 (FIG. 108A) is instantly changed into linearly polarized laser-light 139 (FIG. 108A) as it enters the “Ahrens Polarizing Analyzer” calcite-crystal's bottom lowermost surface 130 (FIG. 108A), which, in addition, because the top surfaces of the laser-diode emitters are flush up against the bottom lowermost surface of an “Ahrens Polarizing Analyzer” calcite-crystal's bottom 130 (FIG. 108A), eliminates the need for a collimating lens allowing evanescent coupling to take place between the emitter surfaces of the laser-diodes and the bottom lowermost surface of the “Ahrens Polarizing Analyzer”.

Moreover, when un-polarized collimated laser-light 139 (FIG. 108A) reaches the first-diagonal or hypotenuse-surface 131 (FIG. 108A) of the beforementioned analyzer's bottom calcite-crystal 130 (FIG. 108A) it becomes linearly polarized (i.e., changed from a laser-light beam that is un-polarized and omni-directional into a laser-light beam that is linearly polarized and directional), while being split into two separate laser-light beams 137, 138 (FIG. 108A). Furthermore, because the two calcite-crystal triangles that make up an “Ahrens Polarizing Analyzer” have a horizontal optical-axis 136 (FIG. 108A) the “O-ray” and “E-ray” laser-light output, which comprise the two laser-light beams created earlier by the “Ahrens Polarizing Analyzer” 137, 138 (FIG. 108A) when the analyzer split an original laser-light beam source into two separate laser-light beams, will have a propagating direction that is naturally horizontal.

Furthermore, first of the two linearly polarized laser-light beams created by the analyzer consists of “O-rays” 137 (FIG. 108A) (i.e., Ordinary-rays of linearly polarized light that is perpendicular to the plane of illustration FIG. 108A), which are reflected “90” degrees to the right by the bottom calcite-crystal's 130 (FIG. 108A) diagonal hypotenuse 131 (FIG. 108A), where they are projected through and beyond the calcite crystal's right angle plane 130 (FIG. 108A) as “O-rays” 137 (FIG. 108A) of linearly polarized horizontal traveling light-rays. Moreover, the previously mentioned “O-rays” are perpendicular to the plane of illustration FIG. 108A. Subsequently, the previously mentioned “O-rays” of linearly polarized horizontal traveling laser-light continue to travel in their redirected horizontal direction 137 (FIG. 108A) until they strike 140 (FIG. 108A) the “SPD Array 2” (FIGS. 64A and 64E) (SPD) “Semiconductor Photo-Diode” reference-voltage photo-detector read element 104, 109 (FIG. 108A). Wherein, the “O-rays” will generate a reference-voltage analog-signal, which is immediately pre-amplified by a transimpedence-amplifier (FIGS. 64A and 64F) and sent to the read-channel's (SPDAS2) “Semiconductor Photo-Diode Analog-signal 2” signal-input as the selected LIMDOW or MSR Magneto-Optical Microhead Array Chip's reference-signal, as illustrated in FIGS. 64A, 64C, 79, 80, 81, 82, 83, 84, 85, and 86.

Furthermore, second of the two linearly polarized laser-light beams consists of vertically traveling “E-rays” 138 (FIG. 108A) (i.e., Extraordinary-rays of linearly polarized light that are parallel to the plane of illustration FIG. 108A), which will vertically pass through the non-reflective surface-side 139 (FIG. 108A) of the Ahrens Polarizing Analyzer's “Half-Mirror” 131 (FIG. 108A), where the Half-Mirror's reflective surface-side is facing toward the top calcite-crystal's 129 (FIG. 108A) diagonal hypotenuse's bottom-surface 131 (FIG. 108A). In addition, an Ahrens Polarizing Analyzer's top-surface will have a “Quarter-Wave Plate” comprised from calcite-crystal 94, 95 (FIG. 108A), 94 (FIG. 39), 95 (FIG. 40), which can be epitaxially deposited onto the analyzer's top outermost surface 94, 95 (FIG. 108A).

Moreover, the previously mentioned “Quarter Wave Plate” is utilized to convert linearly polarized “E-ray” laser-light 138 (FIG. 108A) into (RHCP) “Right Hand Circular Polarized” laser-light 142 (FIG. 108A), this is necessary if reproduction of the data being scanned is to occur. After the previously mentioned “Ahrens Polarizing Analyzer” in conjunction with the previously mentioned “Quarter Wave Plate” converts the vertically traveling linearly polarized “E-ray” laser-light into vertically traveling (RHCP) “Right Hand Circular Polarized” laser-light 142 (FIG. 108A) the circularly polarized “E-ray” laser-light 132 (FIG. 108A), specifically the (RHCP) “Right Hand Circular Polarized” “E-ray” laser-light, will next vertically strike, from a perpendicular direction, the perpendicular surface 13 (FIGS. 1, 2, 3, and 108A) of a disk-platter containing a (MO) “Magneto-Optical” recording rare-earth medium 13 (FIGS. 1, 2, and 3). Whereby, the (RHCP) “Right Hand Circular Polarized” “E-ray” laser-light 142 (FIG. 108A) will next be reflected 133 (FIG. 108A) back into a perpendicular direction 133 (FIG. 108A) towards the LIMDOW or MSR Magneto-Optical Microhead Array Chip's Quarter Wave Plate 94, 95 (FIG. 108A), 94 (FIG. 39), 95 (FIG. 40).

In addition, if the beforementioned (MO) “Magneto-Optical” recording rare-earth medium 13 (FIGS. 1, 2, and 3) reflecting the (RHCP) “Right Hand Circular Polarized” “E-ray” laser-light 142 (FIG. 108A) has a downward (i.e., downward meaning inward away from the disk-platter's outer most surface toward the disk-platter's core substrate) magnetized direction then, moreover the reflected (RHCP) “Right Hand Circular Polarized” “E-ray” laser-light 133 (FIG. 108A) will undergo a reversal of its circular polarization to create a (LHCP) “Left Hand Circular Polarized” “O-ray” form of the scanning laser-light 133 (FIG. 108A) therein giving it a smaller “Circular Dichroism”. Consequently, when the previously mentioned (LHCP) “Left Hand Circular Polarized” “O-ray” laser-light 133 (FIG. 108A) enters a LIMDOW or MSR Magneto-Optical Microhead Array Chip's Quarter-Wave Plate of calcite-crystal 94, 95 (FIG. 108A), 94 (FIG. 39), 95 (FIG. 40) it will be converted into a linearly polarized and vertical traveling “O-ray” form of the scanning laser-light 141 (FIG. 108A).

Furthermore, the beforementioned linearly polarized and vertical traveling “O-ray” form of the scanning laser-light will next continue its direction of propagation downward 141 (FIG. 108A) until it strikes the thin-layer dielectric half-mirror of the “Ahrens Polarizing Analyzer” 131 (FIG. 108A), which is located between the top and bottom triangle-shaped halves of the “Ahrens Polarizing Analyzer” 131 (FIG. 108A) parallel to their center hypotenuse 131 (FIG. 108A), causing the linear polarization of the beforementioned vertical traveling “O-ray” laser-light 141 (FIG. 108A) to undergo a change from a vertically traveling “O-ray” form of low-intensity linearly polarized laser-light, into a horizontal traveling “E-ray” 143 (FIG. 108A) form of low-intensity linearly polarized laser-light. Moreover, the previously mentioned horizontal traveling “E-ray” 143 (FIG. 108A) form of low-intensity linearly polarized laser-light upon contact with a Ahrens Polarizing Analyzer's 131 (FIG. 108A) thin-layer di-electric half-mirror is reflected “90%” 143 (FIG. 108A) into a right-angle direction and projected through and beyond the Ahrens Polarizing Analyzer's top calcite-crystal 129 (FIG. 108A).

In addition, the previously mentioned horizontal traveling “E-rays” 143 (FIG. 108A) of linearly polarized laser-light once it leaves the analyzer it will next become incident upon the “SPD Array 1” (FIGS. 64A and 64E) (SPD) “Semiconductor Photo-Diode” photodetector read-element (FIG. 64G), which in-turn will convert the incident laser-light into electrons, generating a signal-voltage analog-signal, which in turn is pre-amplified by a transimpedence-amplifier (FIGS. 64A and 64F) and sent to a read-channel's signal input (SPDAS1) “Semiconductor Photo-Diode Analog-signal 1” as a LIMDOW or MSR Magneto-Optical Microhead Array Chip's streaming data-signal, as illustrated in FIGS. 64A, 64C, 79, 80, 81, 82, 83, 84, 85, and 86.

Contradictorily, if the beforementioned (MO) “Magneto-Optical” recording rare-earth medium 13 (FIGS. 1, 2, and 3) reflecting the beforementioned (RHCP) “Right Hand Circular Polarized” laser-light has an upward (i.e., upward meaning outward toward the disk-platter's top outermost surface away from the disk-platter's core substrate) magnetized direction, then the beforementioned (RHCP) “Right Hand Circular Polarized” laser-light will undergo a conversion into (LHCP) “Left Hand Circular Polarized” laser-light 133 (FIG. 108A). However, it will have a larger amount of “Circular Dichroism” present than the previously mentioned (LHCP) “Left Hand Circular Polarized”, which to briefly summarize was the laser-light reflected from a disk-platter's domain-cell area but having a downward magnetized direction.

Consequently, when the (LHCP) “Left Hand Circular Polarized” laser-light having the larger amount of “Circular Dichroism” 133 (FIG. 108A) enters a LIMDOW or MSR Magneto-Optical Microhead Array Chip's Quarter-Wave Plate of calcite-crystal 94, 95 (FIG. 108A), 94 (FIG. 39), 95 (FIG. 40) it will be converted into a linearly polarized “O-ray” laser-light. Next, the previously mentioned linearly polarized “O-ray” laser-light, will propagate toward the analyzer's center hypotenuse 131 (FIG. 108A) as it passes through the analyzer's top-prism, until it strikes the analyzer's thin-layer di-electric half-mirror 131 (FIG. 108A), which is located between the analyzer's top and bottom triangle-shaped halves 131 (FIG. 108A) parallel to their hypotenuse 131 (FIG. 108A). Wherein, upon contact with the analyzer's thin-layer di-electric half-mirror the linearly polarized “O-ray” laser-light will be reflected “90%” 143 (FIG. 108A) into a right-angle direction and projected through and beyond the analyzer's top calcite-crystal 129 (FIG. 108A). Thereafter, the linearly polarized “O-ray” laser-light will undergo the change from an “O-ray” into an “E-ray” form of high-intensity linearly polarized laser-light.

Moreover, the newly formed “E-rays” of high-intensity linearly polarized laser-light will continue to propagate into a horizontal direction through and beyond the analyzer's top-prism until it strikes the “SPD Array 1” (FIGS. 64A and 64E) (SPD) or “Semiconductor Photo-Diode” photodetector array (FIG. 64G). Wherein, the incident laser-light is converted into electrons, generating a signal-voltage analog-signal that is pre-amplified by a transimpedence-amplifier (FIGS. 64A and 64F) then sent to the read-channel's signal-input for (SPDAS1) “Semiconductor Photo-Diode Analog-signal 1”, as illustrated in FIGS. 64A, 64C, 79, 80, 81, 82, 83, 84, 85, and 86.

To summarize the process, when data scanning laser-light comprising of “E-rays” of linearly polarized laser-light is reflected by a disk-platter's (MO) “Magneto-Optical” rare-earth recording medium, if the medium's area where the reflection takes place comprises of data-cells that are magnetized into a downward direction, then a LIMDOW or MSR Magneto-Optical Microhead Array Chip's Ahrens Polarizing Analyzer will convert the reflected “E-rays” into a low-intensity form of laser-light, which in turn will be made to impact the “SPD Array 1” (FIGS. 64A and 64E) (SPD) “Semiconductor Photo-Diode” photodetector array read-element to generate a low-peak signal-voltage analog-signal. Whereby, the previously mentioned low-peak signal-voltage analog-signal will be compared using a read-channel's first comparator to a divided by half reference-voltage analog-signal. Wherein, the previously mentioned comparator will create a digital logic-low data-bit, having a logic value of “0”.

Contradictorily, if a scanning laser-light comprising of “E-rays” of linearly polarized laser-light is reflected by a disk-platter's (MO) “Magneto-Optical” rare-earth recording medium, if the medium's area where the reflection takes place comprises of data-cells that are magnetized into an upward direction, then a LIMDOW or MSR Magneto-Optical Microhead Array Chip's Ahrens Polarizing Analyzer will convert the reflected “E-rays” into a high-intensity form of laser-light, which in turn will be made to impact the “SPD Array 1” (FIGS. 64A and 64E) (SPD) “Semiconductor Photo-Diode” photodetector array read-element to generate a high-peak signal-voltage analog-signal. Whereby, the previously mentioned high-peak signal-voltage analog-signal will be compared using a read-channel's first comparator to a divided by half reference-voltage analog-signal. Wherein, the previously mentioned comparator will create a digital logic-high data-bit, having a logic value of “1”.

In addition, after a microhead has completed a successful data-reading scanning process the “5” to “15” milli-watts of electrical current used to power the host-selected microhead laser-diode during its data reading scanning process will be switched off from the (LVIN) “Laser Voltage Input” power-bus (FIGS. 107 and 111) by a Data Sequencer's “Bus Controller” (FIGS. 62A, 63A, 62B, 63B, 62C, and 63C), but only after the host-requested data-sectors have been successfully read from the correct disk-platter cylinder/track data-surface location into a Data Sequencer's (DPLL) “Digital Phase-Locked Loop” circuit for signal processing. Consequently, powering up a selected microhead laser-diode (FIGS. 107 and 111) for only the amount of time it is actually used to read data greatly increases the (MTBF) “Mean Time Before Failure” rating of every single microhead laser-diode that comprises a LIMDOW and MSR Magneto-Optical Microhead Array Chip's microhead array.

In addition, lets take a closer look at a LIMDOW and MSR Magneto-Optical Microhead Array Chip's conversion of two analog-signals to a digital data-stream, which only occurs during a host-requested read-data disk-operation. Moreover, digital data-streams are created when a host-selected LIMDOW or MSR Magneto-Optical Microhead Array Chip's microhead array, during a read-data disk-operation, generates two analog-signals, which are then used to create the previously mentioned digital data-stream. Wherein, as the result of incidental laser-light, a first analog-signal “signal-one” is generated from a (SPD Array 1) Semiconductor Photo-Diode Array 1's output, as illustrated in FIGS. 64A, 64E, 64F, 64G, 79, 80, 81, and 82, which is passed to an analog read-channel's (SPDAS1) “Semiconductor Photo-Diode Analog Signal 1” pre-amp input as a read-channel's signal-voltage analog-signal, as illustrated in FIGS. 64A, 64E, 64F, 64G, 79, 80, 81, and 82, while a second analog-signal “signal-two” is generated from a (SPD Array 2) Semiconductor Photo-Diode Array 2's output, as illustrated in FIGS. 64A, 64E, 64F, 64G, 79, 80, 81, and 82, which is passed to an analog read-channel's (SPDAS2) “Semiconductor Photo-Diode Analog Signal 2” pre-amp input as a read-channel's reference-voltage analog-signal, as illustrated in FIGS. 64A, 64E, 64F, 64G, 79, 80, 81, and 82.

Furthermore, during a host-requested read-data disk-operation the previously mentioned two analog-signals coming from the read channel's (SPDAS1) “Semiconductor Photo-Diode Analog Signal 1” and (SPDAS2) “Semiconductor Photo-Diode Analog Signal 2” outputs are each pre-amplified by a transimpedence amplifier. Wherein, the read-channel's signal-voltage analog-signal and reference-voltage analog-signal is made to enter a read-channel's “Read Preamp Circuit” (FIGS. 64A and 64C). Wherein, the two analog-signals will begin to undergo an (ADC) “Analog to Digital” conversion process. After receiving the read channel's signal-voltage analog-signal and reference-voltage analog-signal (FIGS. 64A and 64C), and by using a “High Performance Comparator” circuit (FIGS. 79 and 80) located in a read-channel's “Read Preamp Circuit” (FIGS. 64A and 64C), the read-channel will begin a comparison process of the aforesaid two analog signals. The “High Performance Comparator” circuit's (FIGS. 79 and 80) output of digital data-streams are based upon a comparative logic formula, which states, (V1 positive)>(V0 negative)=(Logic 1)=(VDD) or “+5 Volts”, while (V1 positive)<(V0 negative)=(Logic 0)=(VSS) or “0 Volts”.

Therefore, if the signal-voltage received by the “High Performance Comparator” SPDAS1's signal-voltage input comes from the SPDAS1's signal-voltage output, as illustrated in FIGS. 64A, 64E, 64F, and 64G, as a signal with a voltage level above a SPDAS2's voltage-divided reference-signal's voltage-threshold, then the “High Performance Comparator” will output a logic “1”, as illustrated in FIGS. 79 and 80. However, if the signal-voltage received by the “High Performance Comparator” SPDAS1's signal-voltage input comes from a SPDAS1's signal-voltage output, as illustrated in FIGS. 64A, 64E, 64F, and 64G, as a signal with a voltage level that is below the SPDAS2's voltage-divided reference-signal's voltage-threshold, then the “High Performance Comparator” will output a logic “0”, as illustrated in FIGS. 79 and 80.

Furthermore, the circuit that directly proceeds the two signal pre-amplifying analog-signal transimpedence amplifiers in the order of processing data-signal output is a LIMDOW or MSR Magneto-Optical Microhead Array Chips read-channel “High Performance Comparator” circuit, as illustrated in FIGS. 79, 80, 81, 82, 83, 84, 85, and 86. Furthermore, the “High Performance Comparator” circuit offers greater accuracy in its “analog-to-digital” signal conversions, while providing amplification to the comparators digital-signal output. A read-channel's “High Performance Comparator” circuit, as illustrated in FIGS. 79, 80, 81, 82, 83, 84, 85, and 86, consists of three-stages:

i.) An input-preamplifier stage, as illustrated in FIGS. 81 and 82;

ii.) A positive-feedback or what is sometimes called a decision-stage, as illustrated in FIGS. 83 and 84;

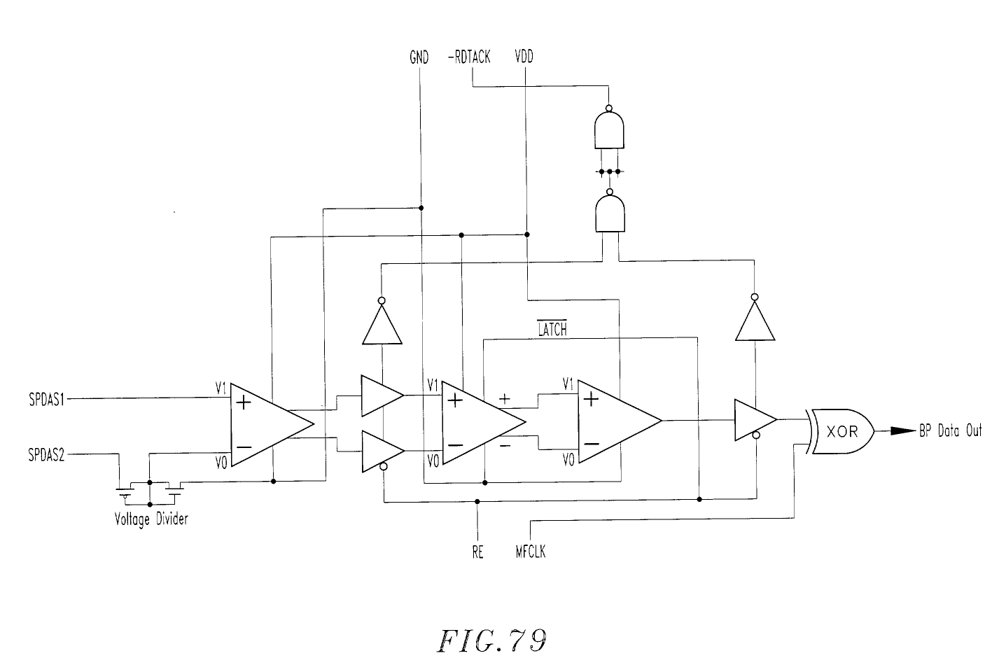

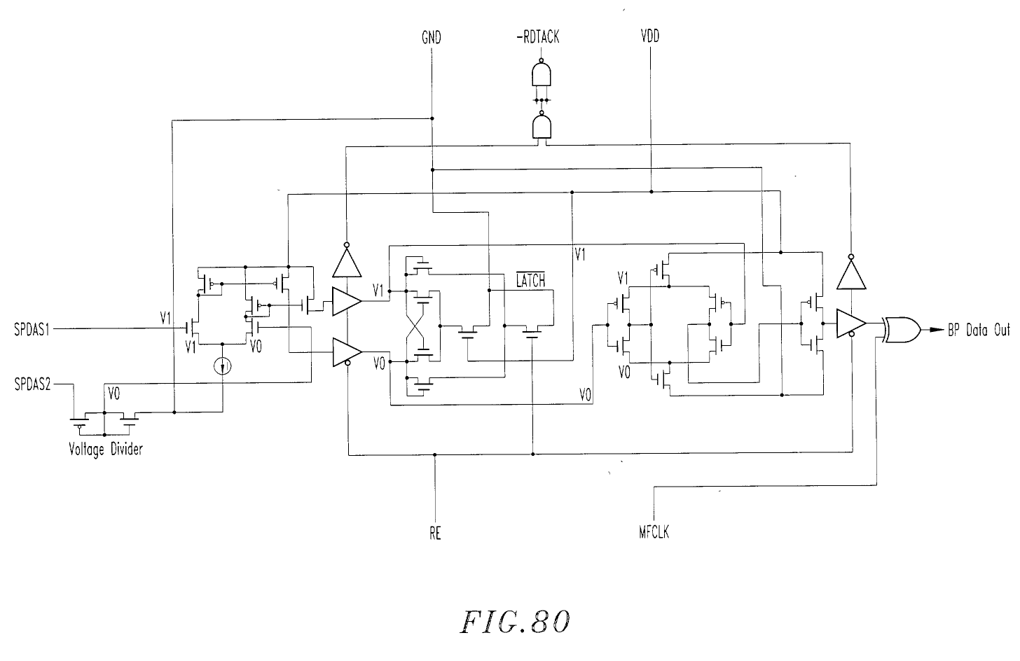

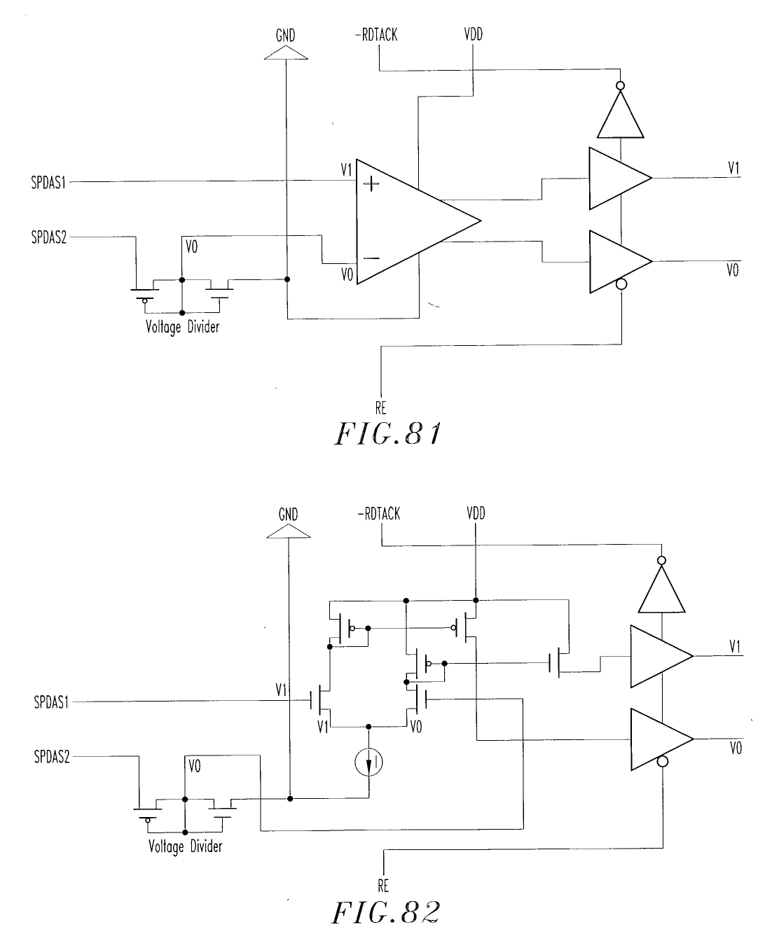

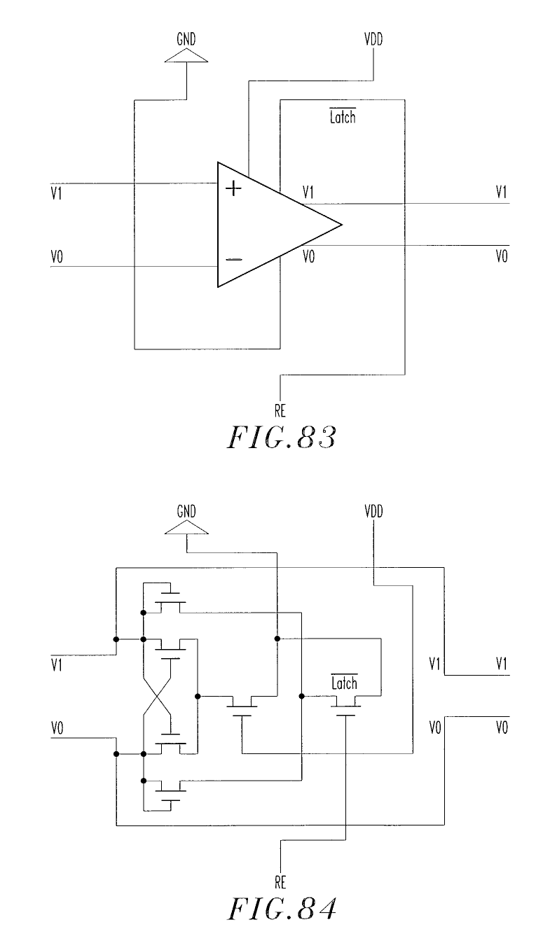

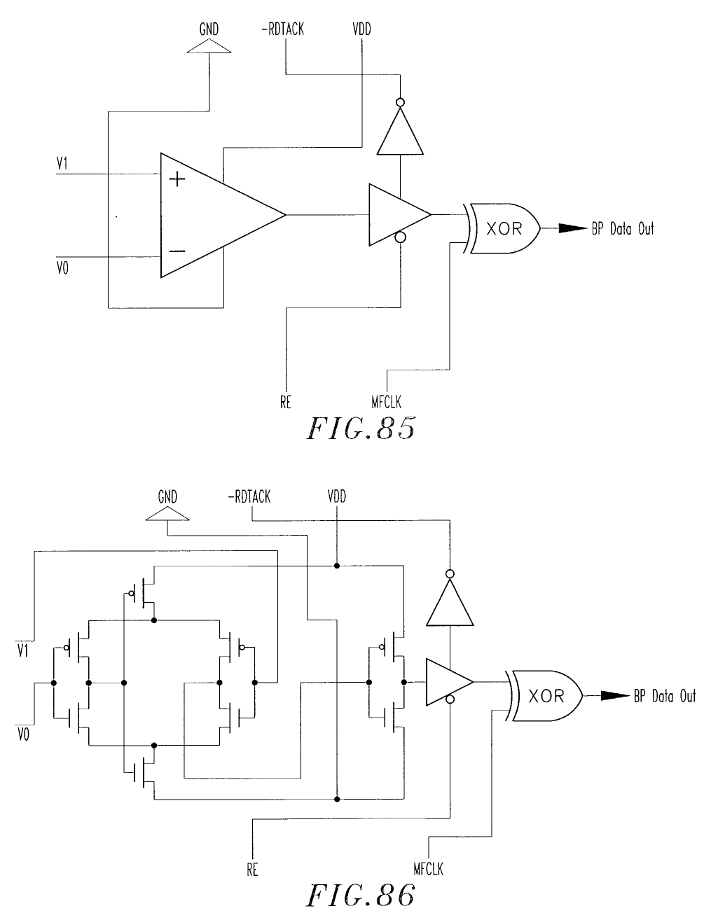

iii.) An output-buffer stage, as illustrated in FIGS. 85 and 86.

Subsequently, the previously mentioned input pre-amplifier stage (FIGS. 81 and 82) amplifies incoming-signals to improve the aforesaid comparators sensitivity (i.e., increases the minimum input signal with which the previously mentioned comparator can make a precise decision when it converts an analog signal to a digital signal), while isolating input-signals from any switching noise that might come from the aforesaid positive-feedback stage (i.e., this stage is very important because of the low signal-to-noise ratio the circuit provides to the read-channel's output signals). In summary, the positive-feedback stage (FIGS. 83 and 84) is used to determine, by using a comparator, which of the two previously mentioned input-signal voltages is largest.

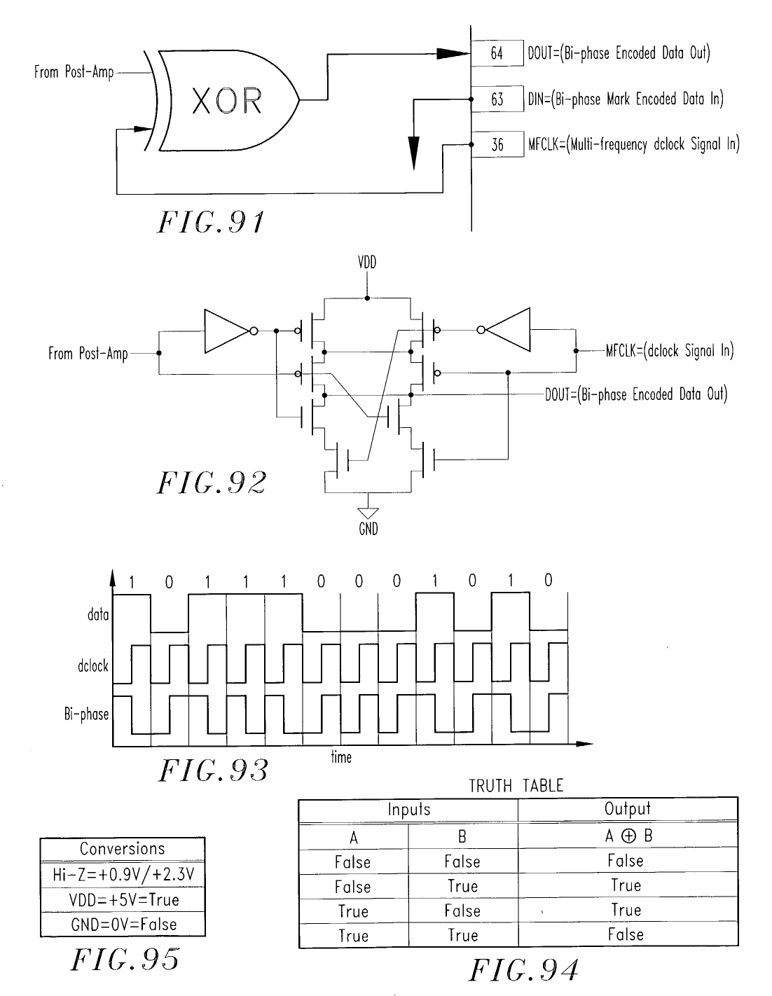

In addition, and in order of signal processing is an aforesaid output-buffer stage (FIGS. 85 and 86), which amplifies the signal output of the positive-feedback stage creating, therein a digital data-stream signal, which is next passed onto a read-channel's “XOR Phase Detector” circuit, where it will undergo a process of encoding (FIGS. 85, 86, and 106). Wherein, a read-channel's output signal is encoded with a frequency-specific “Bi-Phase Data Encoding” square-wave code, as illustrated in FIGS. 91, 92, 93, 94, 95, and 106. The resulting output-signal is a “Bi-Phase Encoded Data Stream”, as illustrated in FIGS. 91, 92, 93, 94, 95, and 106, which is next passed to a LIMDOW or MSR Magneto-Optical Microhead Array Chip's (Dout) “Data out” output-contact labeled as pin-number “63”.

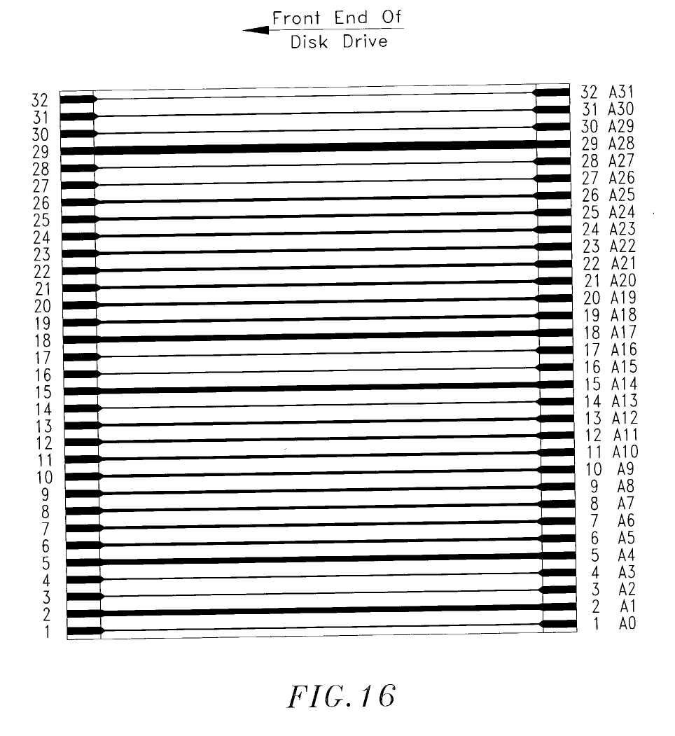

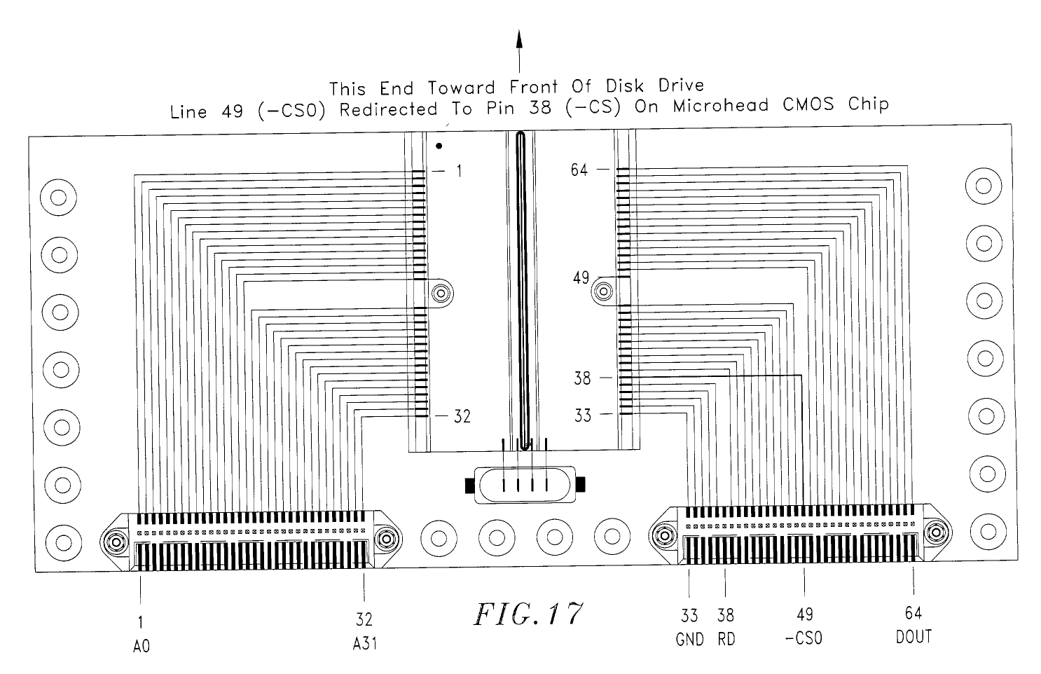

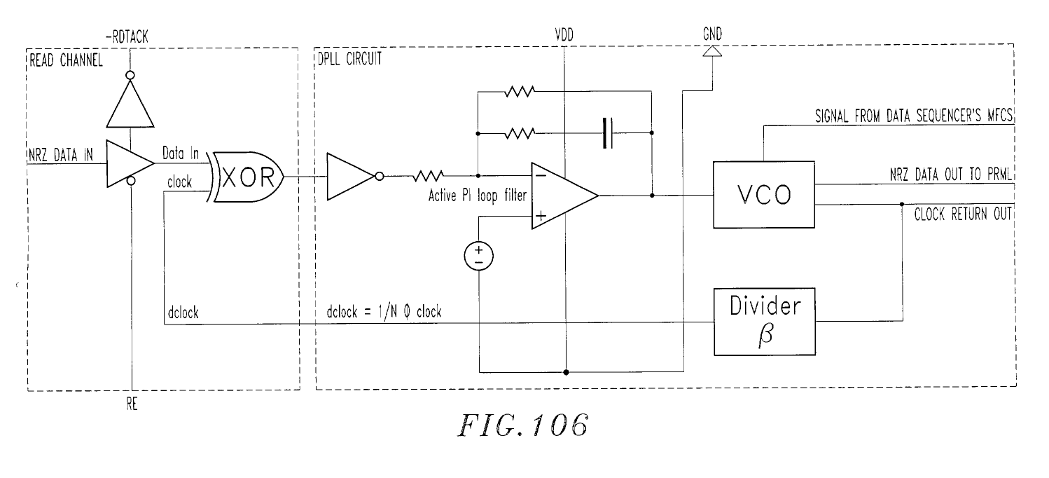

Contiguously, and as long as a read-data disk-operation is being executed, will a “Bi-Phase Encoded Data Stream” output-signal travel onto the aforesaid data-bus cable (FIGS. 15 and 16), where it is lead to a Disk Controller's “Data-Sequencer”, as illustrated in FIGS. 62A, 63A, 62C, and 63C. The read-channel's frequency-specific bi-phase data encoded data-stream output-signal is next made to enter a Data Sequencer's (DPLL) “Digital Phased-Locked Loop” circuit for further signal processing (FIGS. 62A, 63A, 62B, and 63B). Wherein, the data-stream output-signal is next decoded and its clock-signal recovered (FIG. 106) (i.e., the following paragraphs will explain this process in detail).

To explain further, during a host requested read-data disk-operation a Data Sequencer has a “Data Transfer Rate Frequency Analyzer” (FIGS. 62A, 63A, 62B, and 63B) that will calculate the optimal transfer frequency-rate for any data-zone needing to be read during the operation, and communicates that calculation to a Data Sequencer's “Multi-Frequency Clock Synthesizer” module, as illustrated in FIGS. 62A, 63A, 62B, and 63B. Wherein, a Data Sequencer's “Multi-Frequency Clock Synthesizer” will generate a clock-referencing voltage-signal that is based upon the previously mentioned calculations that it received from a Data Sequencer's “Data Transfer Rate Frequency Analyzer”, which it sends to a Data Sequencer's (DPLL) “Digital Phased-Locked Loop” circuit, where it is used to assist in the asynchronous and error free assimilation of the data-stream containing a digital reproduction of the optically stored data retrieved from the data-sector locations of specific disk-platter data-surfaces that contained host-requested data.

In addition, the previously mentioned (DPLL) “Digital Phased-Locked Loop” circuit (FIGS. 62A, 63A, 62B, and 63B), which has a (VCO) “Voltage Controlled Oscillator” circuit that is used to generate a divided-by-two dclock-signal from the clock-referencing voltage-signal it receives from a Data Sequencer's “Multi-Frequency Clock Synthesizer”. Wherein, the previously mentioned (VCO) will send the previously mentioned dclock-signal, using a (MFCLK) “Multi-Frequency Clock” control-bus line (FIGS. 15 and 16), to all (MFCLK) “Multi-Frequency Clock” input-contacts labeled pin-number “35” of all installed LIMDOW or MSR Magneto-Optical Microhead Array Chips, as illustrated in FIGS. 11, 12, 13, and 14. Once received by the host-selected LIMDOW or MSR Magneto-Optical Microhead Array Chip, which is labeled within this embodiment as chip number-5, the (DCLOCK) “Divided Clock” dclock-signal is rerouted from the input-contact labeled as pin-number “35” to the dclock-signal input of the read-channel's pre-dpll “XOR Phase Detector” circuit (FIG. 106), which is located opposite the data-signal input of the read-channel's pre-dpll “XOR Phase Detector” circuit, as illustrated in FIGS. 85, 86, 91, and 92.

In addition, a read-channel's buffered data-stream signal, which is routed directly to the data-signal input (FIG. 106) of the read-channel's pre-dpll “XOR Phase Detector” circuit, as illustrated in FIGS. 85, 86, 91, 92, and 106, where it will undergo a bi-phase data encoding process.

Furthermore, during the host requested read-data disk-operation, scanned data, using LIMDOW or MSR Magneto-Optical Microhead Array Chip number: “5”, from data-surface: “5”, using microhead: “4562”, from cylinder/track number: “4562”, at sector number: “43” is converted from a photo-generated analog-signal to a comparator generated digital-signal. Then the comparator generated digital-signal is passed onto the previously mentioned XOR phase-detector's “Bi-Phase Data Encoding Circuit” (FIGS. 85, 86, 91, and 92), where the read-channel's data-stream output is bi-phase encoded then sent to the Data Sequencer's (DPLL) “Digital Phase-Locked Loop” circuit (FIG. 106) for further signal processing.

Furthermore, the Disk Controller's “Data Sequencer” contains the data-receiving portion of a LIMDOW or MSR Magneto-Optical Microhead Array Chip's pre-dpll circuit, which is located within the Data-Sequencer's (DPLL) “Digital Phase-Locked Loop” circuit, as illustrated in FIGS. 62A, 63A, 62B, and 63B. In addition, the Data Sequencer's (DPLL) “Digital Phase-Locked Loop” circuit, as illustrated in FIGS. 62A, 63A, 62C, 63C, uses circuits located within its (VCO) “Voltage Controlled Oscillator” to recover clock-signals from the “Bi-Phase Encoded Data Stream” output-signals it receives. After a clock-signal is recovered and extracted by the (VCO) “Voltage Controlled Oscillator” circuit the recovered clock-signal is primarily used during a host requested read-data disk-operation to resolve any data-transfer frequency-rates for any disk-platter data-zone needed to be read during the read-data disk-operation, as per read-data requests sent by the host-system. Moreover, the Disk Controller's “Data Sequencer” is also designed to make on-the-fly data-transfer frequency-rate comparisons, which will be used to make on-the-fly adjustments to a LIMDOW or MSR Magneto-Optical Microhead Array Chip Hard Disk Drive's data-transfer frequency-rates and spindle motor control systems that control the rate of rotation for all disk-platters installed into a LIMDOW and MSR Magneto-Optical Microhead Array Chip Hard Disk Drive's unit-assembly.

Therefore, when the “Data Sequencer” makes an on-the-fly comparison of the various signals previously described, an on-the-fly data transferring frequency-rate optimization and/or correction can be made using the DPLL's clock generating (VCO) “Voltage Controlled Oscillator” (FIG. 106) circuit to execute changes in data-transfer frequency rates occurring within the DPLL circuit, by implementing change to the frequency rate of its dclock output signal. Moreover, on-the-fly adjustments to a Spindle-Motor's “constant angular velocity” are accomplished using a Data Sequencer's “Disk Controller Interface”. Wherein, the “Disk Controller Interface”, by analyzing various information provided by feed-back signals can accurately control a Spindle-Motor's rate of revolutions per-minute using a Disk Controller's “Motor Controller” circuit to execute an on-the-fly control over a LIMDOW or MSR Magneto-Optical Microhead Array Chip Hard Disk Drive's Spindle-Motor, as illustrated in FIGS. 62A, 63A, 62B, 63B, 62C, and 63C. Consequently, this will offer a more responsive and a faster Phased-Locked Loop of data-stream output-signals created by a selected LIMDOW or MSR Magneto-Optical Microhead Array Chip's read-channel during read-data disk-operations.

Moreover, as illustrated in FIG. 106, the Data Sequencer's (DPLL) “Digital Phase-Locked Loop” circuit, after receiving the read-channel's encoded data-stream output-signal, it will decode the “Bi-Phase Encoded Data Stream” and recover the clock-signal contained within the data-stream's signal, using circuits that located within the DPLL's (VCO) “Voltage Controlled Oscillator” circuit (FIG. 106) to execute the clock-signal's recovery. The clock-signal after being recovered by the DPLL's (VCO) “Voltage Controlled Oscillator” circuit is sent to a Data Sequencer's “Data Transfer Rate Frequency Analyzer” for further processing. Wherein, the previously mentioned “Data Transfer Rate Frequency Analyzer” will make an on-the-fly comparison between the data-transfer frequency rate of the DPLL's recovered clock-signal and the original data-transfer frequency rate that was calculated earlier and used to initialize a read-data disk-operation for a particular host-requested data-zone that contains the host-requested data-sectors, by using the calculated data-transfer frequency rate to resolve the respective data-zone's data-transfer frequency rate.

Moreover, the Data Sequencer's “Data Transfer Frequency Rate Analyzer” will analyze various on-the-fly feedback signals and make on-the-fly comparisons in order to create an optimized data-transfer frequency rate calculation, which after its creation is sent to a Data Sequencer's (MFCS) “Multi-Frequency Clock Synthesizer” module, as illustrated in FIGS. 62A, 63A, 62B, and 63B. Wherein, the (MFCS) “Multi-Frequency Clock Synthesizer” will use the data-transfer frequency-rate calculation it received from the Data Sequencer's “Data Transfer Frequency Rate Analyzer” to create a new clock-signal at the new frequency rate, which in turn is sent to a DPLL's “Voltage Controlled Oscillator” circuit, where it is re-routed as a divided or dclock-signal to the host-selected LIMDOW or MSR Magneto-Optical Microhead Array Chip, where it will be used to implement read-data synchronization between data-stream output-signals and the Disk Controller. In addition, the beforementioned decoded “Bi-Phase Encoded Data Stream” data-signal is also re-encoded by the aforesaid (VCO) “Voltage Controlled Oscillator” circuit (FIG. 106) into a conventional (NRZ) “Non-Return to Zero” encoded data-signal, which after its re-encoding is in turn transferred to a Disk Controller's “PRML Controller” circuit, as illustrated in FIGS. 62A, 63A, 62B, and 63B, where it will undergo additional signal processing.

Moreover, the encoding of a read-channel's data-stream output-signals with “Bi-Phase Data Encoding” is executed using an exclusive “XOR Phase Detector” circuit to perform the process, as illustrated in FIGS. 91, 92, 93, 94, 95, and 106. This strategy makes possible a quick and easy recovery of a clock-signal from the read-channel's data-stream output-signals, and the conversion of the remaining serial data-output signal into a regular (NRZ) “Non-Return to Zero” encoded data-stream, using a well-known simple process, as illustrated in FIG. 106. Furthermore, the previously mentioned bi-phase data encoding of the read-channel's data-stream output-signals, also makes it possible to “Digitally Phase-Lock Loop” the data-stream with much greater accuracy, while avoiding placement of an odd-parity bit at the end of every eight-bit word to eliminate the possibility of all eight bits being high.

Therefore, when we use “Bi-Phase Data Encoding” (FIG. 93) to encode a data-stream output-signal, the parity bits normally used by a data-stream output-signal to achieve full data-transfer synchronization are not needed when using this scheme. This is simply because; bi-phase encoding reconfigures the data-stream output-signal to have rise and fall of its data to occur at the center of the data-stream output-signal's clock. Next, the (NRZ) “Non-Return to Zero” encoded data-stream is sent by the DPLL's (VCO) “Voltage Controlled Oscillator” (FIG. 106) circuit as a serial signal to a Data Sequencer's “PRML Controller” circuit for “Veterbi” signal-analysis. The Data Sequencer's “PRML Controller” circuit is also where a (NRZ) “Non-Return to Zero” encoded serial data-stream will undergo a final conversion, where it is changed into a 16-bit double data-word. After its final conversion the reproduced data is sent to a Disk Controller's “Buffer Controller” for temporary storage, so that the Data Sequencer's “Disk Controller Interface” and “ECC” circuits, as illustrated in FIGS. 62A, 63A, 62B, 63B, 62C, and 63C, can identify the temporarily stored data as belonging to, for example, the host-requested data contained in data-sector “43”.

Consequently, if the Data Sequencer's “Disk Controller Interface” and “ECC” circuits, as illustrated in FIGS. 62A, 63A, 62B, 63B, 62C, and 63C, make a positive target-sector identification, for example in the case of data-sector “43”, then the read-data that the Disk Controller's “Buffer Controller” has temporarily stored, can be presented to the host-system in the form of 16-bit data-blocks, which is executed through a Disk Controller's “IDE or SCSI Interface Controller”.

In addition, during a read-data disk-operation, when a full data-sector is read (i.e., for example data-sector “43” being a full data-sector of “1024k”) into the Disk Controller's “Buffer Controller” for temporary storage, after which the Disk Controller's (ECC) “Error Correction Control” circuit module will check to see if the firmware stored in a Disk Controller's “Serial EEPROM” needs to apply (ECC) “Error Correction Control” to the temporarily stored reproduced data. The Disk Controller's “Buffer Controller” will store the reproduced data into a temporary memory-cache, while (ECC) “Error Correction Code”, if needed, is applied to it, if it is not, the reproduced data is transferred to the host-system using an IDE or an SCSI interface as the transfer interface. Wherein, a Disk Controller's “IDE or SCSI Interface Controller” is used to execute and control the transfer of host-requested data to the host-system. For example, the transfer of host-requested data read and reproduced from data-sector “43”.

In addition, the detailed description of the present LIMDOW and MSR Magneto-Optical Microhead Array Chip Hard Disk Drive invention's first embodiment will continue, as illustrated in drawing FIG. 64A and 64D, with a description of a LIMDOW and MSR Magneto-Optical Microhead Array Chip's write-channel, along with all of the various circuits that comprise it. Including a detailed description explaining how the write-channel is given connectivity to the host-system, using the LIMDOW or MSR Magneto-Optical Microhead Array Chip Hard Disk Drive's SCSI or IDE interface, which is both used in the first embodiment to connect a LIMDOW or MSR Magneto-Optical Microhead Array Chip Hard Disk Drive up to the host computer system.

Furthermore, a write-channel's signal-path during a write-data disk-operation will essentially follow a reversal of the steps used to describe the read-channel's signal-path during a read-data disk-operation. Moreover, a host-system executes a write-data disk-operation within a LIMDOW or MSR Magneto-Optical Microhead Array Chip Hard Disk Drive by first presenting it with a 16-bit data-word data-block. The previously mentioned data-block is sent to the “IDE or SCSI Interface Controller” located within the LIMDOW or MSR Magneto-Optical Microhead Array Chip Hard Disk Drive's Disk Controller, via an IDE or SCSI interface connector attached to the Disk Controller's PCB. During a write-data disk-operation, the 16-bit data-word data-block would first be transmitted to the Disk Controller's “Buffer Controller” for temporary storage in a LIMDOW or MSR Magneto-Optical Microhead Array Chip Hard Disk Drive's cache memory.

To explain further, because data-blocks can be presented to a LIMDOW or MSR Magneto-Optical Microhead Array Chip Hard Disk Drive at transfer-rates that exceeds the transfer-rate at which a LIMDOW or MSR Magneto-Optical Microhead Array Chip Hard Disk Drive can write-data to a LIMDOW or MSR Magneto-Optical Microhead Array Chip Hard Disk Drive disk-platter's data-surface, data is stored temporarily in the Buffer Controller's cache-memory. Furthermore, the host-system can present data to a LIMDOW or MSR Magneto-Optical Microhead Array Chip Hard Disk Drive for storage at transfer-rates independent of the transfer-rate at which a LIMDOW or MSR Magneto-Optical Microhead Array Chip Hard Disk Drive can write-data to a LIMDOW or MSR Magneto-Optical Microhead Array Chip Hard Disk Drive disk-platter's data-surface.

Therefore, upon correct identification of a target-sector's address, the beforementioned data-block will be shifted to a Data Sequencer's “Disk Controller Interface” and then to the drive's “ECC” circuits, as illustrated in FIGS. 62A, 63A, 62B, 63B, 62C, and 63C. After the previously mentioned data-block is shifted to the drive's “ECC” circuits, (ECC) “Error Correction Code” will be generated and appended to the beforementioned data-block. A Data Sequencer's “Data Encoder” will next convert the previously mentioned data-blocks into a (NRZ) “Non-Return to Zero” encoded serial data-stream input-signal. The data-stream input-signal, after being encoded will be transferred at a calculated and optimal data-transfer frequency-rate for the data-zone containing the empty data-sector the host-system will use for the data-block's storage. The data-stream input-signal is used to complete the write-data disk-operation, by using it's encoded data-stream to execute a controlled modulation of either a selected laser-diode's emissions (i.e., done when using the LIMDOW storage media disk material) or a controlled modulation of a selected microhead array chip's induction-coil produced magnetic fields in conjunction with controlled modulation of a selected laser-diode's emissions (i.e., done when using the MSR storage media disk material) to create a faithful writing of the data comprising the data-stream input-signal.

However, before data can be written to any particular data-sector of any particular disk-platter a LIMDOW or MSR Magneto-Optical Microhead Array Chip must first be host-selected to execute the process. This process begins when a LIMDOW or MSR Magneto-Optical Microhead Array Chip Hard Disk Drive's Disk Controller first forwards a host-requested cylinder/track and data-sector address location to a LIMDOW or MSR Magneto-Optical Microhead Array Chip Hard Disk Drive's “Asynchronous Optical Microhead Address Controller” 63 (FIG. 4), 80 (FIG. 5) for translation.

Wherein, an “Asynchronous Optical Microhead Address Controller”, which is located on a LIMDOW and MSR Magneto-Optical Microhead Array Chip Hard Disk Drive Disk Controller's (PCB) “Printed Circuit Board” 63 (FIG. 4), 80 (FIG. 5) temporally stores the host-requested data location addresses in an Asynchronous Optical Microhead Address Controller's “Address Translation Register”, which is located in the Asynchronous Optical Microhead Address Controller's “Address Unit”. Next, an “Asynchronous Optical Microhead Address Controller” will translate the address information stored in an Asynchronous Optical Microhead Address Controller's “Address Translation Register” into executable form of control-code. Wherein, the control-code will be used to execute the host-requested selection of one particular LIMDOW or MSR Magneto-Optical Microhead Array Chip, which contains a stationary microhead that is located above one particular cylinder/track and data-sector location the host-system wishes to use to store incoming data.

Moreover, the host-selection of a LIMDOW or MSR Magneto-Optical Microhead Array Chip and the data-sector locating microhead it contains is executed through a bus-system that is collectively shared by all installed LIMDOW or MSR Magneto-Optical Microhead Array Chips. This bus-system comprises a group of cables, which will collectively connect all installed LIMDOW or MSR Magneto-Optical Microhead Array Chips into a daisy-chained bus configuration, and will be used to send asynchronous microhead address and chip-control bus-signals simultaneously to all of the LIMDOW or MSR Magneto-Optical Microhead Array Chips that are installed into a LIMDOW or MSR Magneto-Optical Microhead Array Chip Hard Disk Drive's unit-assembly.

However, before a write-data disk-operation can take place, the beforementioned “Asynchronous Optical Microhead Address Controller” must first select and enable one particular LIMDOW or MSR Magneto-Optical Microhead Array Chip from the group of installed chips. While this selection process is similar to that used in conventional hard disk drives it differs because every installed LIMDOW or MSR Magneto-Optical Microhead Array Chip is comprised as a stationary device (i.e., never moving, always in one place), which has a stationary microhead array that comprises a multitude of stationary photo-detectors and singularly addressable laser-diodes 1 (FIGS. 41, 42, 43, and 44) all of which are contained within every stationary microhead array.

In addition, the previously mentioned LIMDOW or MSR Magneto-Optical Microhead Array Chip selection process is first initialized by executing a (-CS) “Chip Select” chip-control bus-signal (FIG. 64A, FIG. 64B), which is one of two control-signals responsible for the selection of one LIMDOW or MSR Magneto-Optical Microhead Array Chip amongst many that are collectively connected to a LIMDOW or MSR Magneto-Optical Microhead Array Chip Hard Disk Drive. A LIMDOW or MSR Magneto-Optical Microhead Array Chip's Chip-Selection process is accomplished through point-to-point individual (-CS) “Chip Select” chip-control bus-system ribbon cable lines. Wherein, point-to-point chip-control bus-system control lines somewhere along their signal paths are dedicated to and for each LIMDOW or MSR Magneto-Optical Microhead Array Chip that is installed into a LIMDOW or MSR Magneto-Optical Microhead Array Chip Hard Disk Drive's unit-assembly (i.e., eight installed Magneto-Optical Microhead Array Chips would each have its own separate “Chip Select” point-to-point chip-control bus-system control line).

Subsequently, the previously mentioned (-CS) “Chip Select” point-to-point control-signal bus lines are each redirected from their bus line flex-cable connector location, which is present on every chip-positioning circuit board to a previously mentioned chip-positioning circuit board's surface-mounted chip-socket's pin-number “38” input-contact. Furthermore, the previously mentioned redirection of the (-CS) “Chip Select” point-to-point chip-control bus-system signal lines, which are located on every chip-positioning circuit board installed into a LIMDOW or MSR Magneto-Optical Microhead Array Chip Hard Disk Drive's unit-assembly is based upon a cross-connect design that uses a (-CS) “Chip Select” line that is different and unique for every chip-positioning circuit board's circuit-trace architecture, as illustrated in FIGS. 17, 18, 19, 20, 21, 22, 23, and 24.

Therefore, the LIMDOW or MSR Magneto-Optical Microhead Array Chip's chip-positioning circuit board surface-mounted chip-socket's input-contact labeled pin-number “38” and the chip-positioning circuit board's Polymer flex-cable connector inputs are cross-connected, giving control over the selection of every LIMDOW and MSR Magneto-Optical Microhead Array Chip installed into a LIMDOW or MSR Magneto-Optical Microhead Array Chip Hard Disk Drive's unit-assembly.

In addition, here are eight examples of redirected (-CS) “Chip Select” Chip-Selection chip-positioning circuit board cross-connects used by the LIMDOW or MSR Magneto-Optical Microhead Array Chips. Wherein, FIG. 17 illustrates the (-CS) “Chip Select” Polymer flex-cable input bus-line “49” (-CS0) as being redirected to the surface-mounted chip-socket's contact-input labeled as pin-number “38” (-CS) “Chip Select” contact-input (FIGS. 11 and 12), which is present in all LIMDOE and MSR Magneto-Optical Microhead Array Chips.

In addition, FIG. 18 illustrates the (-CS) “Chip Select” Polymer flex-cable input bus-line “50” (-CS1) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

In addition, FIG. 19 illustrates the (-CS) “Chip Select” Polymer flex-cable input bus-line “51” (-CS2) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

In addition, FIG. 20 illustrates the (-CS) “Chip Select” Polymer flex-cable input bus-line “52” (-CS3) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

In addition, FIG. 21 illustrates the (-CS) “Chip Select” Polymer flex-cable input bus-line “53” (-CS4) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

In addition, FIG. 22 illustrates the (-CS) “Chip Select” Polymer flex-cable input bus-line “54” (-CS5) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

In addition, FIG. 23 illustrates the (-CS) “Chip Select” Polymer flex-cable input bus-line “55” (-CS6) as being redirected to the surface-mounted chip-socket's contact-input labeled as pin-number “38” (-CS) Chip Select contact-input (FIGS. 11 and 12), which is present in all LIMDOW and MSR Magneto-Optical Microhead Array Chips.

In addition, FIG. 24 illustrates the (-CS) Chip Select Polymer flex-cable input bus-line “56” (-CS7) as being redirected to the surface-mounted chip-socket's contact-input labeled as pin-number “38” (-CS) “Chip Select” contact-input (FIGS. 11 and 12), which is present in all LIMDOW and MSR Magneto-Optical Microhead Array Chips.

Furthermore, since there is one unique (i.e., non-bused point-to-point) (-CS) “Chip Select” bus-line available to each of the installed “8” LIMDOW or MSR Magneto-Optical Microhead Array Chips through cross-connect circuitry. Wherein, each of the installed “8” LIMDOW or MSR Magneto-Optical Microhead Array Chips can now be individually selected and controlled during the course of a write-data disk-operation. Moreover, the connectivity of the LIMDOW and MSR Magneto-Optical Microhead Array Chip “Chip-Selection” process is illustrated in FIGS. 60A, 61A, 60B, 61B, 60C, and 61C.

In addition, a Data Sequencer's “Data Bus Controller” is used during a write-data disk-operation to switch a selected LIMDOW or MSR Magneto-Optical Microhead Array Chip's (R/-W) “Read or Write” condition from a (RE) “Read Enable” read condition to a (WE) “Write Enabled” write condition. Whereby, the switching of a LIMDOW or MSR Magneto-Optical Microhead Array Chip's Data I/O condition from a (RE) “Read Enable” read-condition to a (WE) “Write Enabled” write-condition is simply accomplished, when the Data Sequencer sends a logic-low low-voltage chip-control bus-signal down through the (R/-W) “Read or Write” chip-control bus-line, where it collectively connects to every LIMDOW or MSR Magneto-Optical Microhead Array Chip installed and connected to a LIMDOW or MSR Magneto-Optical Microhead Array Chip Hard Disk Drive's bus-system, and through which the logic-low low-voltage chip-control bus-signal will finely reach the host-selected LIMDOW or MSR Magneto-Optical Microhead Array Chip. Whereby, the LIMDOW or MSR Magneto-Optical Microhead Array Chip being host-selected, would be the only LIMDOW or MSR Magneto-Optical Microhead Array Chip connected to the bus-system to have its Data I/O condition switched from a read-condition to a write-condition, as illustrated in FIGS. 60A, 61A, 60B, 61B, 60C, and 61C.

In addition, and at a precise rotational moment, when the host-requested disk-sector to be written too is directly underneath the host-selected microhead, an encoded (RLL) “Runtime Length Limited” data-stream signal is transmitted from the Data Sequencer's “Data Bus Controller”, as illustrated in FIGS. 62A, 63A, 62B, 63B, 62C, and 63C, to a selected MSR Magneto-Optical Microhead Array Chip's (DIN) “Data In” input-contact labeled as pin-number “63” (FIGS. 64A and 64C). Wherein, the previously mentioned data-stream signal is re-routed to a host-selected MSR Magneto-Optical Microhead Array Chip's Write Pre-amp Circuit's (DIN) “Data In” input, where the (RLL) “Runtime Length Limited” data-stream signal is first pre-amplified and then sent to the (DMOD1) “Data Modulated Input 1” input of the selected MSR Magneto-Optical Microhead Array Chip's Write Driver Circuit.

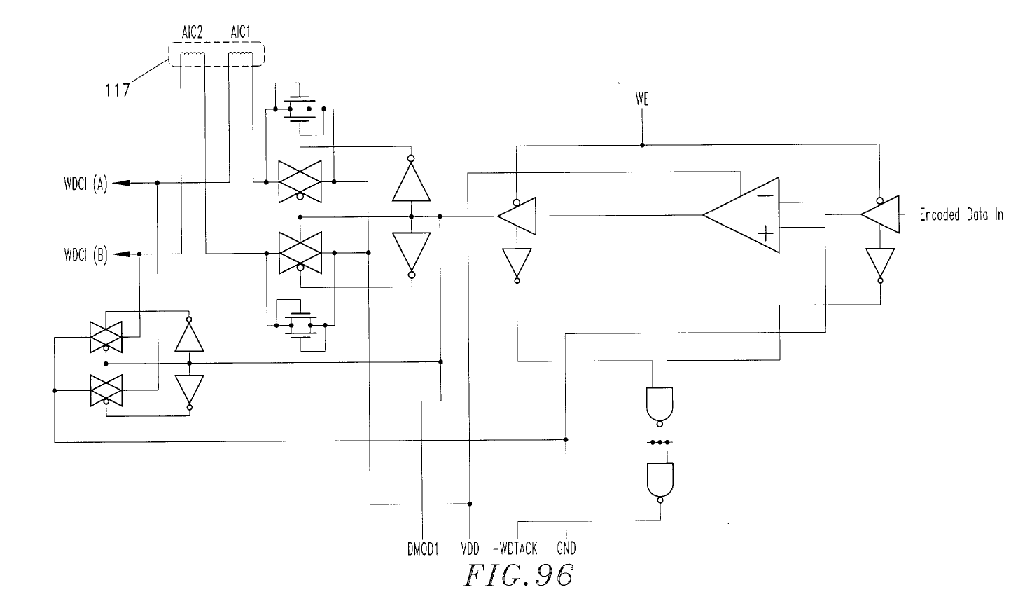

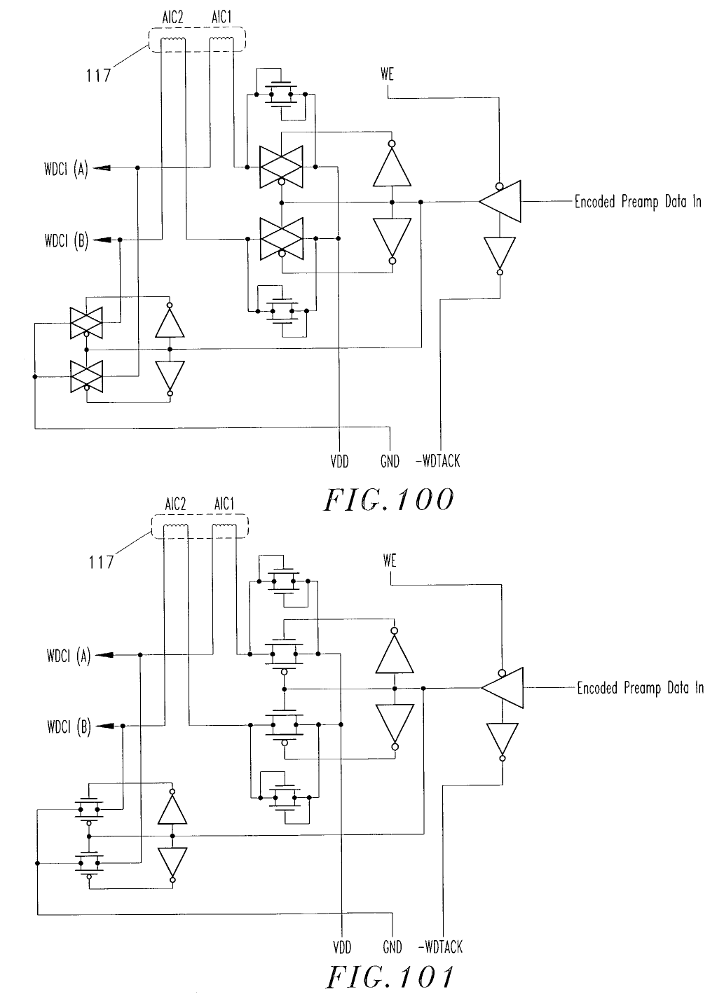

In addition, a MSR Magneto-Optical Microhead Array Chip's (WDC) “Write Driver Circuit”, as illustrated in FIGS. 96, 97, 98, 99, 100, and 101, will use the alternating high and low voltages that comprise an encoded (RLL) “Runtime Length Limited” data-stream input-signal to execute a data modulated “Rotate Toggle” switching of four transmission-gates (FIGS. 100 and 101), which are located within the Write Driver Circuit and used to execute a controlled switching between an “Alpha” (BIMPIC) “Bi-Metal Planar Induction Coil” and a “Beta” (BIMPIC) “Bi-Metal Planar Induction Coil” and their access to the electrical power provided by each Coil's dedicated power-bus, which are used to provide each (BIMPIC) “Bi-Metal Planar Induction Coil” with its own induction driving direct-electrical current. Wherein, one source of DC electric power, will provide two separate power signals, each comprising a direct-electrical current, but with opposing directions of current propagation. Therefore, the two separate power signals previously mentioned, because they are comprised as two separate direct-current electrical signals with opposed directions of current propagation, each can be dedicated to and be exclusively used by its respective (BIMPIC) “Bi-Metal Planar Induction Coil”. Wherein, each contra-propagating current will be used to magneto-optically record to a MSR disc media, data, comprised as a stream of logic opposing data-bits.

For example, when the “Alpha” (BIMPIC) “Bi-Metal Planar Induction Coil” is given access to induction driving electricity through a “rotate toggle” switching of four transmission gates, that electricity will be received by the “Alpha” coil as a direct-electrical current with a direction of propagation that opposes the direct-electric current used in the Beta coil, it will use this electrical current exclusively to produce a vertical magnetic-field specifically oriented for creating data-bits that will oppose the logic-states of data-bits produced by the “Beta” coil. When the “Beta” (BIMPIC) “Bi-Metal Planar Induction Coil” is given access to induction driving electricity through a “rotate toggle” switching of four transmission gates, that electricity will be received by the “Beta” coil as a direct-electrical current with a direction of propagation that opposes the direct-electric current used in the Alpha coil, it will use this electrical current exclusively to produce a vertical magnetic-field specifically oriented for creating data-bits that will oppose the logic-states of data-bits produced by the “Alpha” coil.

However, during a write-data disk-operation the write-data process actually begins when a Disk Controller has received a write-data disk-operation request from the host-system to write-data to a particular disk-platter's cylinder/track location that contains disk-sector(s) marked as empty. For example, the previously mentioned host-system will send a write-data request through its respective computer's IDE or SCSI interface. Wherein, the write-data request is received by a LIMDOW or MSR Magneto-Optical Microhead Array Chip Hard Disk Drive's Disk Controller, and might look like this—Requested write-data using disk id: “0”, at head number: “5”, at cylinder/track number: “4562”, at sector number: “43”. Moreover, the previously mentioned Disk Controller's “Asynchronous Optical Microhead Address Controller”, as illustrated in FIGS. 62A, 63A, 62B, 63B, 62C, and 63C, would receive the previously mentioned write-data request from a LIMDOW or MSR Magneto-Optical Microhead Array Chip Hard Disk Drive's Disk Controller and place it into its “Disk Controller Interface Register” (FIGS. 62C and 63C), where it would be held until a different microhead address is requested by the host-system, or the write-data disk-operation has been completed.

Moreover, an Asynchronous Optical Microhead Address Controller's, as illustrated in FIGS. 62A, 63A, 62B, 63B, 62C, and 63C, “Address Translator” reads the previously mentioned address information from within a “Disk Controller Interface Register” and translates it into control code. The control code is then stored into an Address Translator's “Address Translator Register”, where it is utilized by the Disk Controller's “Asynchronous Optical Microhead Address Controller” to activate the required LIMDOW or MSR Magneto-Optical Microhead Array Chip's microhead addressing and Chip-Selection chip-control bus-system signal-lines.

Furthermore, an Asynchronous Optical Microhead Address Controller's “Address Translator”, as illustrated in FIGS. 62A, 63A, 62C, and 63C, first tells an Asynchronous Optical Microhead Address Controller's “Address Unit” that LIMDOW or MSR Magneto-Optical Microhead Array Chip Number-“5”, being basically equivalent to a conventional flying head numbered as head number-“5” is the data-head to be used. The Asynchronous Optical Microhead Address Controller's response is to enable the point-to-point (-CS4) “Chip Select” line number “4” (i.e., the chip select lines available within the present design are CS0, CS1, CS2, CS3, CS4, CS5, CS6, CS7) with a logic-low control-signal, as illustrated in FIGS. 60A, 61A, 60B, 61B, 60C, and 61C. This enabling of the (-CS4) “Chip Select” line number “4” simply begins a process that executes the selection of a single LIMDOW or MSR Magneto-Optical Microhead Array Chip, which is chosen because of its stationary location above the host-requested data-sectors present on disk-platter number “3”, disk-surface number “5”.

In addition, the (-CS) “Chip Select” logic-low control-signal makes the requested LIMDOW or MSR Magneto-Optical Microhead Array Chip number “5” the only LIMDOW or MSR Magneto-Optical Microhead Array Chip connected to a LIMDOW or MSR Magneto-Optical Microhead Array Chip Hard Disk Drive's 32-bit microhead addressing bus-system able to latch into its “Address Latch Circuit”, as illustrated in FIGS. 64A, 64B, and 64E, a particular microhead's 32-bit address number, which is sent down a LIMDOW or MSR Magneto-Optical Microhead Array Chip Hard Disk Drive's thirty-two address-lines to all of the installed LIMDOW or MSR Magneto-Optical Microhead Array Chips that are connected to a LIMDOW or MSR Magneto-Optical Microhead Array Chip Hard Disk Drive's 32-bit microhead addressing bus-system, as illustrated in FIGS. 62A, 63A, 62B, 63B, 62C, and 63C.

However, at the same time as the previously mentioned 32-bit microhead addressing bus-system sends a (i.e., same as the cylinder/track number) and microhead address number “4562” down its thirty-two address bus-lines a chip-select control-bus control-signal called an (-AS) “Address Strobe” control-signal is simultaneously sent down its own signal line to every installed LIMDOW or MSR Magneto-Optical Microhead Array Chip's input-contact assigned as pin-number “37”, as illustrated in FIGS. 11 and 12. Moreover, through a simultaneous and combined execution of these two logic-low control-signals for (-CS4) “Chip Select 4” line-number “5” at input-contact assigned as pin-number “38” and for (-AS) “Address Strobe” at input-contact assigned as pin-number “37”, as illustrated in FIGS. 65, 66, 67, and 68, can a particular, in this case, LIMDOW or MSR Magneto-Optical Microhead Array Chip number “5” be selected for the host-requested write-data disk-operation.

Conclusion, a LIMDOW or MSR Magneto-Optical Microhead Array Chip, which is assigned as chip number “5” in a daisy-chain flex-cable line-up is singularly selected to tri-state latch (FIGS. 70A and 70B) the (i.e., cylinder/track) address number “4562” into its “Address Latch And Chip Select Circuit”, as illustrated in FIGS. 69, 70A, and 70B. Furthermore, the beforementioned 32-bit microhead address number “4562” will stay latched in a LIMDOW and MSR Magneto-Optical Microhead Array Chip's tri-stated “Address Latch And Chip Select Circuit” as long as the (-CS4) and (-AS) control-signal bus-system signal lines continue to have logic-low control-signals present on their lines.

In addition, the address line inputs of LIMDOW or MSR Magneto-Optical Microhead Array Chips consists of thirty-two input contact-pins; wherein, a LIMDOW or MSR Magneto-Optical Microhead Array Chip's microhead addressing bus-system signal inputs are assigned numbers “A0” through “A31”, as illustrated in FIGS. 11, 12, 13, and 14. Furthermore, during a write-data disk-operation the microhead address number “4562” is latched into an “Address Latch And Chip Select Circuit”, where it is temporally stored. In the mean time an (-ADACK) “Address Acknowledge” circuit will send a logic-low control-signal down an (-ADACK) “Address Acknowledge” circuit's chip-control control-bus signal-line. The (-ADACK) control-signal is generated when (-CS4) and (-AS) circuits (FIGS. 65, 66, 67, and 68) are simultaneously enabled.

Moreover, the (-CS4) and (-AS) circuits, as illustrated in FIGS. 65, 66, 67, and 68, are located within a host-selected LIMDOW or MSR Magneto-Optical Microhead Array Chip's “Address Latch And Chip Select Circuit”, illustrated by drawing FIGS. 69, 70A, and 70B. The (-ADACK) control-bus signal is sent from a host-selected LIMDOW or MSR Magneto-Optical Microhead Array Chip's output-contact assigned as pin-number “39”, as illustrated in FIGS. 11, 12, 13, and 14, to a (-ADACK) “Address Acknowledge” input-contact, which is located at a Disk Controller's “Asynchronous Optical Microhead Address Controller”, as illustrated in FIGS. 60A, 61A, 60C, 61C, located on a LIMDOW and MSR Magneto-Optical Microhead Array Chip Hard Disk Drive's PCB 63 (FIG. 4), 80 (FIG. 5).

In addition, a logic-low control-bus signal received at an (-ADACK) input-contact of the aforesaid “Asynchronous Optical Microhead Address Controller” tells the aforesaid “Asynchronous Optical Microhead Address Controller” that microhead address, number “4562”, has been successfully latched into the “Address Latch And Chip Select Circuit”, as illustrated in FIGS. 69, 70A, and 70B, located in the host-selected LIMDOW and MSR Magneto-Optical Microhead Array Chip number “5”. Furthermore, the successfully latched address signal is now passed from a 32-bit “Address Latch And Chip Select Circuit” down to a host-selected LIMDOW or MSR Magneto-Optical Microhead Array Chip's 32-bit “Address Decoder Circuit”, as illustrated in FIGS. 64A, 64B, 71, and 72. Subsequently, when the host-selected LIMDOW or MSR Magneto-Optical Microhead Array Chip's “Address Decoder Circuit” receives the aforesaid 32-bit microhead address signal it will reroute it to its internal “address tree decoder” for decoding, as illustrated in FIGS. 64A, 64B, 72, and 73. In addition, the decoding process of the previously latched 32-bit microhead address signal, by the “address tree decoder” circuit (FIGS. 71 and 72), will result in the enabling of one particular microhead selection-line with a logic-high control-signal. Moreover, the previously mentioned microhead selection-line also has, for the physical circuit-line it represents, an address number of “4562”, which is the same as the host requested microhead's number.

In addition, what is normally called “inverter body effect”, which is associated with and caused by circuits that contain a large number of semiconductor inverters, like the number of inverters present in an “address tree decoder” circuit, will ultimately be the cause of poor signal strength. Consequently, an address tree decoder's singularly enabled microhead selection-line will need its logic-high control-signal regenerated by a host-selected LIMDOW or MSR Magneto-Optical Microhead Array Chip's “Address Buffer Circuit” (FIGS. 73 and 74), or the aforesaid microhead selection-line's signal will suffer signal-loss, causing a microhead selection error to occur.

Furthermore, when a host-selected LIMDOW or MSR Magneto-Optical Microhead Array Chip's “Address Decoder Circuit” sends a microhead selection-line's signal to a host-selected LIMDOW and MSR Magneto-Optical Microhead Array Chip's “Address Buffer Circuit”, as illustrated in FIGS. 64A, 64B, 73, and 74, two very important and simultaneous processes will occur:

i.) A signal regeneration of an address tree decoder's only enabled microhead selection-line by a LIMDOW and MSR Magneto-Optical Microhead Array Chip's “Address Buffer Circuit”, will occur;

ii.) The unsolicited microhead selection-lines of the address tree decoder are pulled-down to a ground state through the microhead selection-lines' internal Long-L inverters, as illustrated in FIGS. 64A, 64B, and 74, where pulling-down of the unsolicited microhead selection-lines, into a grounded state, will also put the unsolicited microhead selection-lines into a (Hi-Z) “High Impedance Line State”.

Furthermore, every microhead selection-line within a LIMDOW and MSR Magneto-Optical Microhead Array Chip has its circuit beginning in an “Address Decoder Circuit” and its circuit ending to occur at its respective microhead. Wherein, each selection-line is terminated with a selection-line transmission-gate control-circuit, which is attached to a selection-line's circuit ending, as illustrated in FIGS. 64A, 64B, 64E, 107, and 111. Moreover, a selection-line's transmission-gate (FIGS. 107 and 111) will independently control its respective microhead's access to power-bus lines, as illustrated in FIGS. 107 and 111.

However, (RLV) “Read Laser Voltage”, (WLV1) “Write Laser Voltage One”, and (WLV2) “Write Laser Voltage Two” power-bus power signals are inputted at a single (FIGS. 107 and 111) (LVIN) “Laser Voltage In” input (FIGS. 64A and 64E), or to be more specific, the switching between the (RLV) “Read Laser Voltage”, (WLV1) “Write Laser Voltage One”, and (WLV2) “Write Laser Voltage Two” power-bus power signals occurs within a LIMDOW Magneto-Optical Microhead Array Chip's (VCSEL Microhead PCC) “Vertical Cavity Surface Emitting Laser Power Control Circuit”, as illustrated in FIGS. 64A, 64D, 109, and 110, by a “R/W Control Circuit”, as illustrated in FIGS. 87, 88, 89, and 90.

In addition, the actual on and off switching of electrical power to the (RLV) “Read Laser Voltage”, (WLV1) “Write Laser Voltage One”, and (WLV2) “Write Laser Voltage Two” power-bus power lines is executed by a Data Sequencer's “Data Bus Controller”, as illustrated in FIGS. 62A, 63A, 62B, 63B, 62C, and 63C. Furthermore, during a write-data disk-operation a “R/W Control Circuit”, as illustrated in FIGS. 87, 88, 89, and 90, must first enable a host-selected LIMDOW or MSR Magneto-Optical Microhead Array Chip's write-channel with a (WE) “Write Enable” logic-low control-signal. Furthermore, in order for LIMDOW or MSR Magneto-Optical Microhead Array Chip Hard Disk Drives to commence disk-operations as quickly as possible the previously mentioned R/W Control Circuit's default setting, after a “Power-On-Restart” or “Power-On-Initialization” is to have a host-selected LIMDOW and MSR Magneto-Optical Microhead Array Chip's read-channel enabled. The purpose of enabling the host-selected, i.e., the host-selected in this case meaning the LIMDOW and MSR Magneto-Optical Microhead Array Chip that is positioned over the disk-platter data-surface that contains the hard disk drive's (OP Code) Operational Code and hard disk drive's operating system software instructions. The previously mentioned LIMDOW and MSR Magneto-Optical Microhead Array Chip will have an activated read-channel after a “Power-On-Restart” or “Power-On-Initialization”, so (OP Code) “Operational Code”, which is usually stored on cylinder/track “0”, is read from a disk-platter's track “0” immediately into a buffer's (SDRAM) “Synchronous Dynamic Random Access Memory” memory area, which is put aside for the execution of a LIMDOW or MSR Magneto-Optical Microhead Array Chip Hard Disk Drive's (OP Code) Operational Code and hard disk drive's system operating instructions. In addition, a (R/-W) “Read or Write enable” control-bus signal is used to enable a host-selected LIMDOW and MSR Magneto-Optical Microhead Array Chip's write-channel during a write-data disk-operation, and is comprised of three chip-control logic circuits:

i.) A (R/-W) “Read or Write enable” control-bus signal-line, which is connected at the input-contact assigned pin-number “35”, where it can be accessed by the Disk Controller;

ii.) A (+5) “VDD” control-bus signal-line, which is connected at the input-contact assigned pin-number “34”, where it can be accessed by the Disk Controller;

iii.) An Asynchronous Optical Microhead Address Controller's (-CS) “Chip Select” point-to-point signal-line, which is connected at the input-contact assigned pin-number “38”, where it can be accessed by the Disk Controller.

Moreover, the three chip-control logic circuits are duplicated in every LIMDOW and MSR Magneto-Optical Microhead Array Chip, as illustrated in FIGS. 64A, 64C, 87, 88, 89, and 90, installed into a LIMDOW and MSR Magneto-Optical Microhead Array Chip Hard Disk Drive's unit-assembly.

Furthermore, to enable a write-channel within a host-selected LIMDOW or MSR Magneto-Optical Microhead Array Chip, three logic-signal conditions must simultaneously occur within the host requested LIMDOW or MSR Magneto-Optical Microhead Array Chip's “R/W Control Circuit” :

i.) Reception of a logic-high control-signal at the host-selected LIMDOW or MSR Magneto-Optical Microhead Array Chip's input-contact labeled as pin-number “34” and designated (+5V) “VDD”;

ii.) Reception of a logic-low control-signal at the host-selected LIMDOW or MSR Magneto-Optical Microhead Array Chip's input-contact labeled as pin-number “38” and designated (-CS) “Chip Select”;

iii.) Reception of a logic-low control-signal at the host-selected LIMDOW Magneto-Optical Microhead Array Chip's input-contact labeled as pin-number “35” and designated (R/-W) Read or Write enable”.

Moreover, the three chip-control bus-signal line-conditions, previously described in the above paragraph, must first be simultaneously activated, by continuous transmission of the previously mentioned three chip-control bus-signals across their respective chip-control bus-cable signal-lines, where they will be received by a host-selected LIMDOW or MSR Magneto-Optical Microhead Array Chip's ” R/W Control Circuit”. Wherein, the “R/W Control Circuit” will send out three (WE) “Write Enable” bus-signals to enable the three circuits, when enabled together will create a LIMDOW or MSR Magneto-Optical Microhead Array Chip's write-channel circuit.

For example, during a write-data disk-operation, when the host-system has requested the selection of installed LIMDOW or MSR Magneto-Optical Microhead Array Chip number “5” to occur using a physical re-direction of an Asynchronous Optical Microhead Address Controller's point-to-point (-CS4) “Chip Select” signal-line, assigned as signal-line number “4”. Moreover, a cross-connect circuit redirection, for example, can easily be made to occur for the (-CS4) “Chip Select” signal-line, by making the cross-connect circuit re-direction at the fifth LIMDOW or MSR Magneto-Optical Microhead Array Chip's chip-positioning circuit board. Therefore, by using the copper circuit-trace assigned as copper circuit-trace number “53” (FIG. 21), we can make a cross-connect circuit redirection to occur for (-CS3) “Chip Select” line-number “4”, by creating a copper circuit-trace that begins its circuit run at the input-contact assigned as pin-number “53” of a chip-positioning circuit board's Polymer flex-cable spring-contact connector 67 (FIGS. 2, 3, and 10), and from there traces its way to the (-CS) “Chip Select” and null input-contact, where it will complete its cross-connect circuit redirection of (-CS3) “Chip Select” line-number “4”, by making its circuit completing physical connection with pin-number “38” of a host-requested LIMDOW or MSR Magneto-Optical Microhead Array Chip's chip-positioning circuit board's surface-mounted chip-socket 5 (FIGS. 7, 8, and 21) using copper circuit-trace number “53” (FIG. 21).

Furthermore, every installed LIMDOW and MSR Magneto-Optical Microhead Array Chip is connected to LIMDOW or MSR Magneto-Optical Microhead Array Chip Hard Disk Drive's three-bus systems, which are labeled as:

i.) The “Address Bus” bus-system;

ii.) The “Data I/O Bus” bus-system;

iii.) The “Chip Control Bus” bus-system.

Thereafter, the host-selected LIMDOW or MSR Magneto-Optical Microhead Array Chip, which is labeled as LIMDOW or MSR Magneto-Optical Microhead Array Chip number “5”, becomes the only LIMDOW or MSR Magneto-Optical Microhead Array Chip connected to a LIMDOW or MSR Magneto-Optical Microhead Array Chip Hard Disk Drive's bus-system to have its write-channel, during a write-data disk-operation, activated. While all of the other installed LIMDOW or MSR Magneto-Optical Microhead Array Chips connected to a LIMDOW or MSR Magneto-Optical Microhead Array Chip Hard Disk Drive's bus-system, would have their write-channels three-stated into a (Hi-Z) “High Impedance Line State”.

Furthermore, the host-selected LIMDOW or MSR Magneto-Optical Microhead Array Chip write-channel's I/O is enabled when a (WE) “Write Enable” logic-high control signal is sent to a host-selected LIMDOW or MSR Magneto-Optical Microhead Array Chip's “R/W Control Circuit”. In addition, a write-channel's two line-drivers, as illustrated in FIGS. 96, 97, 98, and 99, will receive a R/W Control Circuit's (WE) “Write Enable” logic-high control-signal; thereby, activating the aforesaid write-channel's I/O connectivity to a LIMDOW or MSR Magneto-Optical Microhead Array Chip Hard Disk Drive's bus-system and its Disk Controller as well. Moreover, two logic-high control-signals were also sent by the previously mentioned write-channel's two line-drivers, where they entered the (A) and (B) input-terminals of a write-channel's double NAND (-WDTACK) “Write Data Acknowledge” control-circuit.

Moreover, if the previously mentioned two input-terminals (A) and (B) of a write-channel's double NAND (-WDTACK) “Write Data Acknowledge” control-circuit, as illustrated in FIGS. 102, 103, 104, and 105, were to receive logic-high control-signals, then the write-channel's double NAND (WDTACK) “Write Data Acknowledge” control-circuit, would in response, output a (-WDTACK) “Write Data Acknowledge” logic-low control-signal out onto a (-WDTACK) “Write Data Acknowledge” control-bus signal line, which is connected to all output-contacts labeled with a pin-number of “40” of every installed LIMDOW or MSR Magneto-Optical Microhead Array Chip, as illustrated in FIGS. 64A, 64C, and 64D.

In addition, a LIMDOW or MSR Magneto-Optical Microhead Array Chip's (-WDTACK) “Write Data Acknowledge” logic-low control-signal, after being sent to pin-number “40”, will travel through a LIMDOW or MSR Magneto-Optical Microhead Array Chip Hard Disk Drive's bus-system Polymer flex-cable's (-WDTACK) “Write Data Acknowledge” control-bus signal line 30, 36 (FIGS. 1 and 6) until it reaches a (-WDTACK) “Write Data Acknowledge” input, which is located at a Data Sequencer's “Data Bus Controller”, as illustrated in FIGS. 62A, 63A, 62C, and 63C. Moreover, after the previously mentioned Data Sequencer's “Data Bus Controller” has received the beforementioned (-WDTACK) “Write Data Acknowledge” logic-low control-signal the aforesaid Data Sequencer's “Data Bus Controller”, will know, that a host-selected LIMDOW or MSR Magneto-Optical Microhead Array Chip's write-channel is open and ready to write host-requested data to data-sector “43”, which is located on cylinder/track “4562”, using address selected VCSEL microhead “4562”.

Furthermore, a (MPCC) “Microhead Power Control Circuit” also receives a (WE) “Write Enable” logic-high control-signal from the beforementioned “R/W Control Circuit”, which will cause the aforesaid VCSEL Microhead PCC's transmission-gate controller to switch its selection (FIGS. 109 and 110) of (WLV) “Write Laser Voltage” bus-line over to the (RLV) “Read Laser Voltage” bus-line. Moreover, the switch selected (WLV) “Write Laser Voltage” bus-line can now channel a Write Laser Voltage to a (LVOUT) “Laser Voltage Output” circuit terminal (FIGS. 109 and 110), which leads to a host-selected LIMDOW or MSR Magneto-Optical Microhead Array Chip microhead array's input terminal (LVIN) “Laser Voltage Input” terminal (FIGS. 107 and 111), and although the previously mentioned (WLV) “Write Laser Voltage” power-line (FIGS. 107 and 111) has been selected for a host-requested write-data disk-operation no electrical-current will be sent to the host-selected microhead; at least, not until the host requested data-sector passes directly underneath the previously selected microhead. Moreover, when the host requested data-sector rotates directly underneath the previously selected VCSEL's microhead will a high-output of electrical current be sent down a (WLV) “Write Laser Voltage” power-line (FIGS. 107 and 111) turning on a host-selected microhead's high-powered write-data laser emission.

Furthermore, “Hall-Sensors” (i.e., not shown here) will provide the radial position of any data-sector, at all times, on-the-fly; moreover, through the permanent-magnetic rotary-elements located in the spindle motor's rotor, which are relative to the fixed windings and poles of the “Spindle-Motor” 59 (FIGS. 2 and 3) stator. Typically, the previously mentioned “Hall-Sensors” (i.e., not shown here) will provide response-control information to the beforementioned “Spindle And Power Controller” 60 (FIG. 4), 82 (FIG. 5); moreover, the beforementioned Spindle-Motor's driver-circuit. In addition, the aforesaid “Hall-Sensors” (i.e. not shown here) will also provide a LIMDOW or MSR Magneto-Optical Microhead Array Chip Hard Disk Drive's disk-platters rate of rotation, and positional information, which is necessary in an “ID-less Tracking Format”, to the beforementioned “Spindle And Power Controller” 60 (FIG. 4), 82 (FIG. 5).

In addition, during a host-requested write-data disk-operation, the beforementioned “Spindle And Power Controller” 60 (FIG. 4), 82 (FIG. 5), will, in-turn, send this information to the beforementioned Disk Controller's “Data Sequencer”, which, in turn, will control the on and off switching of the previously mentioned (WLV) “Write Laser Voltage” power-line's electric current, which is based upon the rate of rotation, and positional information it receives.

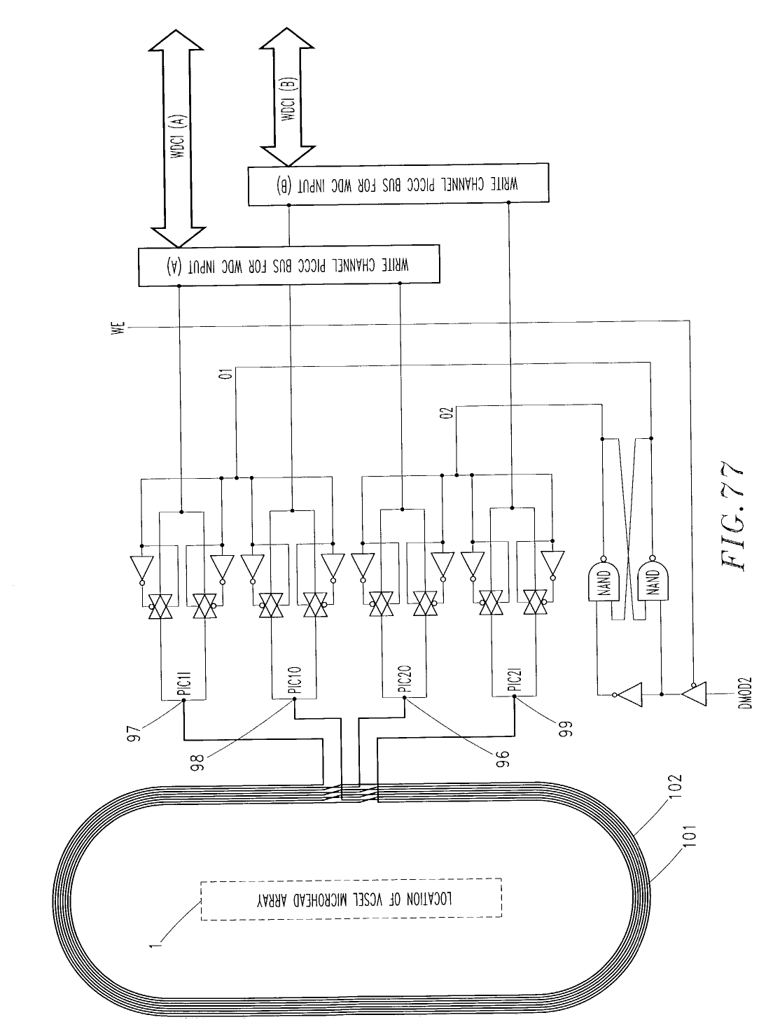

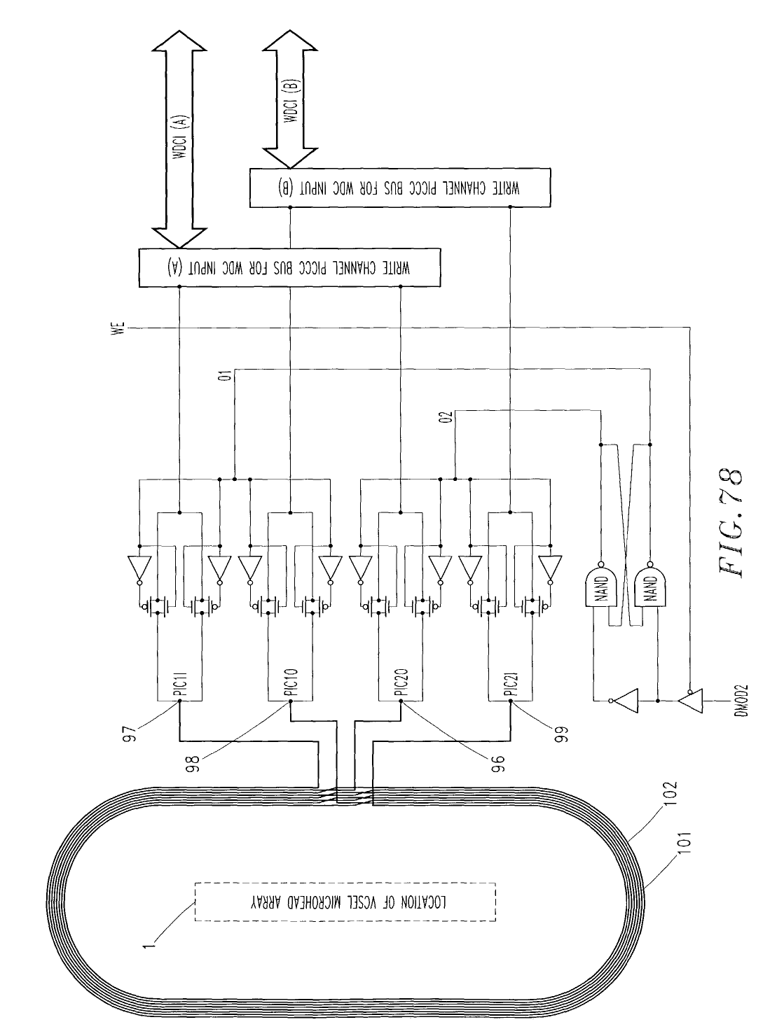

In addition, a “Write Driver Circuit” has four transmission-gates, which it uses to control the directional-flow of the previously mentioned (VDD) “+5 Volt” direct-current; moreover, a (VDD) “+5 Volt” direct-current, which can be swiftly directed, or redirected, through a switch toggling of the beforementioned (VDD) “+5 Volt” direct-current's current, between Input (A) or Input (B) bus-conduits. Moreover, the Input (A) or Input (B) bus-conduits are in-turn connected to a host-selected MSR Magneto-Optical Microhead Array Chip's “Alpha” and/or “Beta” (BIMPIC) “Bi-Metal Planar Induction Coil”, as illustrated in FIGS. 64A and 64D. Specifically, and to explain further, the beforementioned (VDD) “+5 Volt” direct-current's current (FIGS. 100 and 101) will travel through a Write Driver Circuit's Input (A) bus-conduit (FIGS. 100 and 101) to a Write Channel PICCC Bus For WDC Input (A)'s power-bus (FIGS. 77 and 78), which is connected to a host-selected MSR Magneto-Optical Microhead Array Chip's “Alpha” coil's (PIC1I) “Planar Induction Coil 1 input” 97 (FIGS. 41, 42, 77, and 78) of a “Rotate Toggle” selected (BIMPIC) “Bi-Metal Planar Induction Coil”, as illustrated in FIGS. 77 and 78.

However, if reversed, a (VDD) “+5 Volt” direct-current's current (FIGS. 100 and 101) will travel through a Write Driver Circuit's Input (B) bus-conduit (FIGS. 100 and 101) to a Write Channel PICCC Bus For WDC Input (B)'s power-bus (FIGS. 77 and 78), which is connected to a host-selected MSR Magneto-Optical Microhead Array Chip's “Beta” coil's (PIC2I) “Planar Induction Coil 2 input” 99 (FIGS. 41, 42, 77, and 78) of a “Rotate Toggle” selected (BIMPIC) “Bi-Metal Planar Induction Coil”, as illustrated in FIGS. 77 and 78. Whereby, data-storing magnetic-reversals and “Rotate Toggling” of a host-selected MSR Magneto-Optical Microhead Array Chip's two (BIMPIC) “Bi-Metal Planar Induction Alpha and Beta Coils” occurs according to a (RLL) “Runtime Length Limited” data-stream controlled (i.e., modulated) transmission-gate switching of a (VDD) “+5 Volt” direct-current's current-reversals, which are sent to the previously mentioned Write Driver Circuit's Input bus-conduits (A) and (B), as illustrated in FIGS. 64A, 64D, 100, and 101.

For example, when the two transmission-gates that control a (VDD) “+5 Volt” direct-current's access to the previously mentioned Write Driver Circuit's Input (A) bus-conduit are switched on by a (RLL) “Runtime Length Limited” data-stream logic-high bit-input (FIGS. 100 and 101), or when the beforementioned two transmission-gates that control the (VDD) “+5 Volt” direct-current's access to the Write Driver Circuit's Input (B) bus-conduit are switched off; moreover, allowing the aforesaid Write Driver's beforementioned (VDD) “+5 Volt” direct-current to flow from the beforementioned Write Driver Circuit's Input (A) bus-conduit to an “Alpha” coil's (PIC1I) “Planar Induction Coil 1 Input” 97 (FIGS. 41, 42, 77, and 78) moving through the beforementioned “Alpha” coil causing magnetic induction, while exiting out through an “Alpha” coil's (PIC1O) “Planar Induction Coil 1 Output” 98 (FIGS. 41, 42, 77, and 78), and continuing on out to a Write Driver Circuit's Input (B) bus-conduit, which is switched off causing a re-routing of the Write Driver Circuit's (VDD) “+5 Volt” direct-current to be pulled to a Write Driver Circuit's ground; moreover, causing a host-selected domain-cell's magnetic field to vertically align into an upward position, as illustrated in FIGS. 96, 97, 100, and 101.

However, when the beforementioned two transmission-gates that control the beforementioned (VDD) “+5 Volt” direct-current's access to the previously mentioned Write Driver Circuit's Input (A) bus-conduit are switched off by a (RLL) “Runtime Length Limited” data-stream logic-low bit-input (FIGS. 100 and 101), the beforementioned two transmission-gates that control the beforementioned (VDD) “+5 Volt” direct-current's access to the previously mentioned Write Driver Circuit's Input (B) bus-conduit are switched on; moreover, allowing the aforesaid Write Driver's beforementioned (VDD) “+5 Volt” direct-current to flow from a Write Driver Circuit's Input (B) bus-conduit to a “Beta” coil's (PIC2I) “Planar Induction Coil 2 Input” 99 (FIGS. 41, 42, 77, and 78) moving through a “Beta” coil causing magnetic induction, while exiting out through a “Beta” coil's (PIC2O) “Planar Induction Coil 2 Output” 96 (FIGS. 41, 42, 77, and 78), and continuing on out to a Write Driver Circuit's Input (A) bus-conduit, which is switched off, causing a re-routing of a Write Driver Circuit's (VDD) “+5 Volt” direct-current to be pulled to a Write Driver Circuit's ground; moreover, causing a host-selected domain-cell's magnetic field to vertically align into an downward position, as illustrated in FIGS. 96, 97, 100, and 101.

In addition, each of the beforementioned Write Driver Circuit's (VDD) “+5 Volt” direct-current's current-pathways, which are illustrated as (WDCI (A)) and (WDCI (B)) will each use a dummy-loading MOSFET or MESFET device (FIGS. 100 and 101) to maintain current-load on its respective current-pathway; eliminating any jitter distortion that might be caused by a slow rising of electrical charge within each direct-current's pathway.

In addition, every chip-positioning circuit board installed into a MSR Magneto-Optical Microhead Array Chip Hard Disk Drive's unit-assembly comprising a surface-mounted chip socket will also have a single surface-mounted auxiliary component containing two induction-coils 117 (FIGS. 1, 2, 3, 29, 30, 31, 32, 33, 34, 35, 36, and 37). Moreover, the previously mentioned surface-mounted auxiliary component containing two induction-coils is attached to the previously mentioned chip-positioning circuit board with two solder leads present on the beforementioned chip-positioning circuit board's outer-surface 116 (FIGS. 1, 2, 3, 29, 30, 31, 32, 33, 34, 35, 36, and 37).

Furthermore, the previously mentioned surface-mounted auxiliary component containing two induction-coils, while being connected to its respective MSR Magneto-Optical Microhead Array Chip, through the beforementioned MSR Magneto-Optical Microhead Array Chip's four metal contacts located at the bottom-edge bottom-surface of every MSR Magneto-Optical Microhead Array Chip, and four other metal contacts located in the bottom-edge top-surface of every surface-mounted chip-socket 119, 120 (FIGS. 30, 32, 35, and 37).

Furthermore, the first auxiliary induction-coil, which is located within the previously mentioned surface-mounted auxiliary component is the second auxiliary induction-coil, and has an impedance rating larger than either of the two (BIMPIC) “Bi-Metal Planar Induction Alpha or Beta Coils”. Moreover, the first auxiliary induction-coil has its (AIC1O) “Auxiliary Induction Coil One Out” output-line connected to its respective surface-mounted chip socket's (AIC1O) “Auxiliary Induction Coil One Out” output-contact number “66”, while its (AIC1I) “Auxiliary Induction Coil One In” input-line is connected to its respective surface-mounted chip socket's (AIC1I) “Auxiliary Induction Coil One In” input-contact number “65”. Furthermore, the second auxiliary induction-coil is located within the previously mentioned surface-mounted auxiliary component as is the first auxiliary induction-coil, and has an impedance rating larger than either of the two (BIMPIC) “Bi-Metal Planar Induction Alpha or Beta Coils”. Moreover, the beforementioned second auxiliary induction-coil has its (AIC2O) “Auxiliary Induction Coil Two Out” output-line connected to its respective surface-mounted chip socket's (AIC2O) “Auxiliary Induction Coil Two Out” output-contact number “68”, while its (AIC2I) “Auxiliary Induction Coil Two In” input-line is connected to its respective surface-mounted chip socket's (AIC2I) “Auxiliary Induction Coil Two In” input-contact number “67”.

Furthermore, the previously mentioned first and second load balancing MOSFET circuits also selectively balance the loads of the first and previously mentioned second auxiliary coils. Wherein, the first load balancing MOSFET circuit will balance the load of the beforementioned first auxiliary coil when a selected (BIMPIC) “Bi-Metal Planar Induction Alpha or Beta Coil” (FIGS. 64A, 64D, 77, and 78) is driven by the beforementioned Write Driver Circuit's VDD direct current.

In addition, the second load balancing MOSFET circuit will balance the load of the second auxiliary coil when a selected (BIMPIC) “Bi-Metal Planar Induction Alpha or Beta Coil” (FIGS. 64A, 64D, 77, and 78) is driven by the beforementioned Write Driver Circuit's VDD direct current. Moreover, since load impedance for each auxiliary coil is fixed at all times the charging currents of their respective auxiliary coils can be made equal to each other at all times. Therefore, it is possible to set the value of a drive current for a selected (BIMPIC) “Bi-Metal Planar Induction Alpha or Beta Coil” (FIGS. 64A, 64D, 77, and 78) to be equal in one direction to that of a drive current in the opposite direction, so that distortion free recording of data during a write-data disk-operation can occur.

In addition, while no transmission-gate is provided between the respective auxiliary induction-coil and a selected (BIMPIC) “Bi-Metal Planar Induction Alpha or Beta Coil” (FIGS. 64A, 64D, 77, and 78) the drive current can be nominally inverted immediately after an inversion occurs in the recording signal, allowing the beforementioned Write Driver Circuit's VDD direct-current to suddenly rise or fall. In addition, since the beforementioned load of a respective auxiliary induction coil does not constantly attain “0” the circuit's power consumption is significantly reduced. Furthermore, with the beforementioned Write Driver Circuit's VDD direct current being supplied to each auxiliary induction coil, the constant charging of an auxiliary induction coil is made possible. Therein, enabling an auxiliary induction-coil to be sufficiently charged, while enabling the beforementioned Write Driver Circuit's VDD direct-current, through a selected (BIMPIC) “Bi-Metal Planar Induction Alpha or Beta Coil” (FIGS. 64A, 64D, 77, and 78) to rise or fall.

Furthermore, during a host requested write-data disk-operation a host-selected MSR Magneto-Optical Microhead Array Chip's (BIMPIC) “Bi-Metal Planar Induction Alpha and Beta Coils” (FIGS. 64A, 64D, 77, and 78) are simultaneously switched on by a logic-high control-signal called the (WE) “Write Enable” control-signal. Moreover, the previously mentioned (WE) “Write Enable” logic-high control-signal will come from the beforementioned “R/W Control Circuit” (FIGS. 64A and 64D), and will enter the (WE) inputs of four write-channel I/O data circuits, including the beforementioned (PICCC) “Planar Induction Coil Control Circuit” (FIGS. 64A and 64D). Thereby, enabling the connectivity of a host-selected MSR Magneto-Optical Microhead Array Chip's write-channel. Simultaneously, a (RE) “Read Disable” logic-low control-signal will come from the beforementioned “R/W Control Circuit” (FIGS. 64A and FIG. 64D), and will enter the (RE) inputs of four read-channel I/O data circuits; thereby, disabling the connectivity of a host-selected LIMDOW and MSR Magneto-Optical Microhead Array Chip's read-channel.

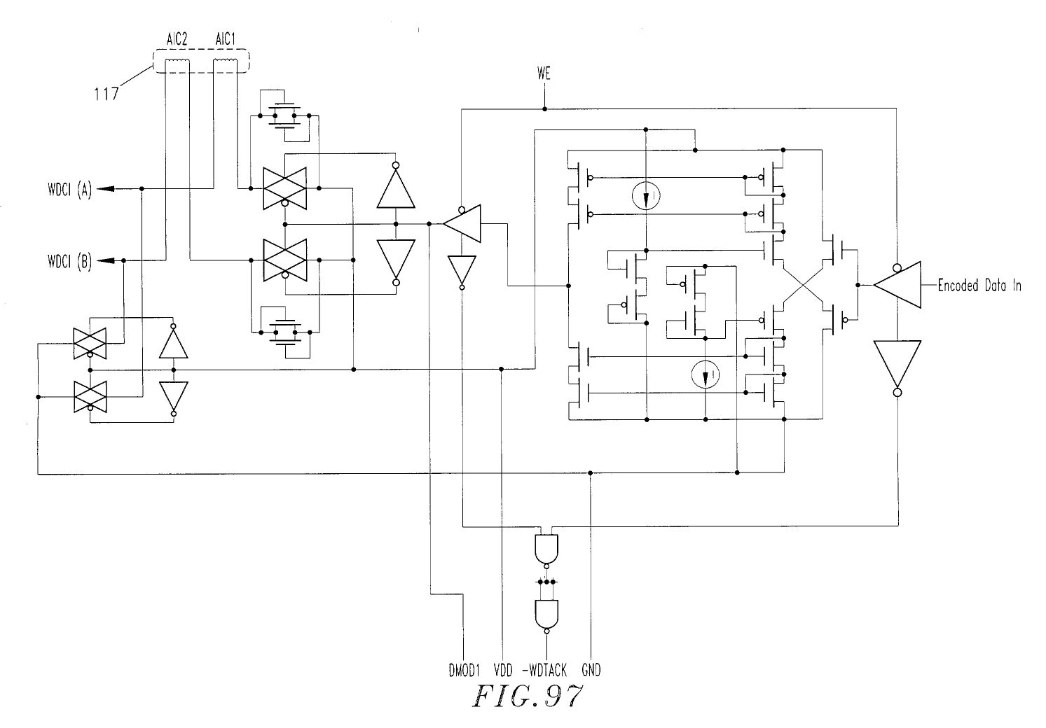

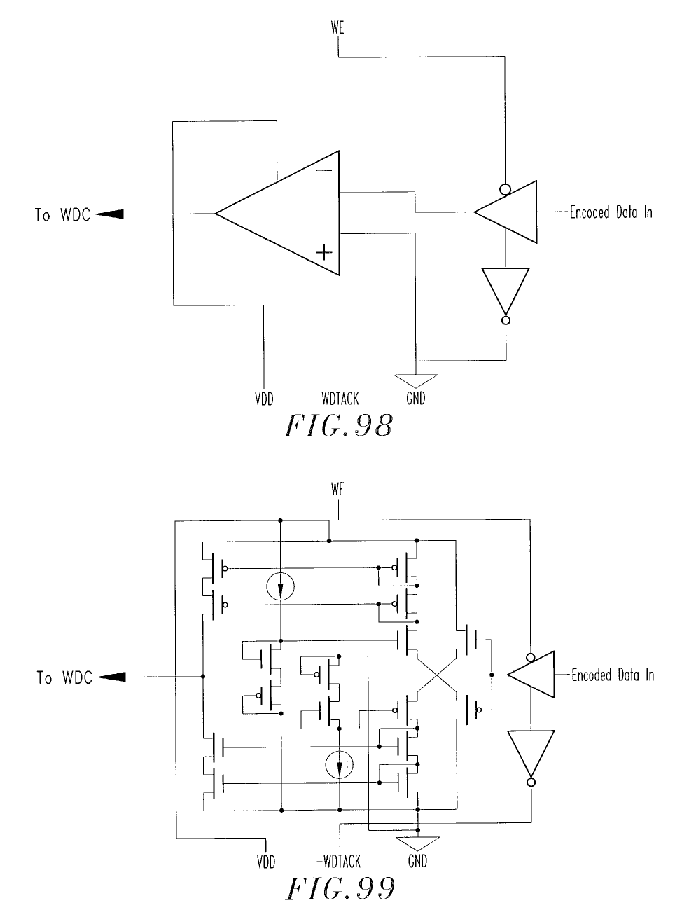

In addition, a host-selected MSR Magneto-Optical Microhead Array Chip's (BIMPIC) “Bi-Metal Planar Induction Alpha and Beta Coils” (FIGS. 64A, 64D, 77, and 78) are simultaneously “Switch Toggled” on during read-data disk-operations, but are “Rotate Toggled” on and off during write-data disk-operations. Furthermore, during a host-requested write-data disk-operation a Data Sequencer's “Data Encoder” will send a (RLL) “Runtime Length Limited” data-stream signal, via the (WR DATA) “Write Data” data-bus, to all of the installed LIMDOW and MSR Magneto-Optical Microhead Array Chip's (DIN) “Data In” input-contact, pin-number “63”, as illustrated in FIGS. 60A, 61A, 60B, 61B, 60C, and 61C. Moreover, the previously mentioned (RLL) “Runtime Length Limited” data-stream signal entering the host-selected LIMDOW and MSR Magneto-Optical Microhead Array Chip's (DIN) “Data In” input-contact pin-number “63” is internally re-routed to two different LIMDOW and MSR Magneto-Optical Microhead Array Chip's data modulating circuit areas, as illustrated in FIGS. 64A and 64D. Therefore, the first (RLL) “Runtime Length Limited” data-stream signal is re-routed to a (DMOD1) “Data Modulation 1” input of the beforementioned (WDC) “Write Driver Circuit” (FIGS. 64A and 64D), after being received from the beforementioned Write Preamp Circuit's preamplified signal output-line, as illustrated in FIGS. 98 and 99.

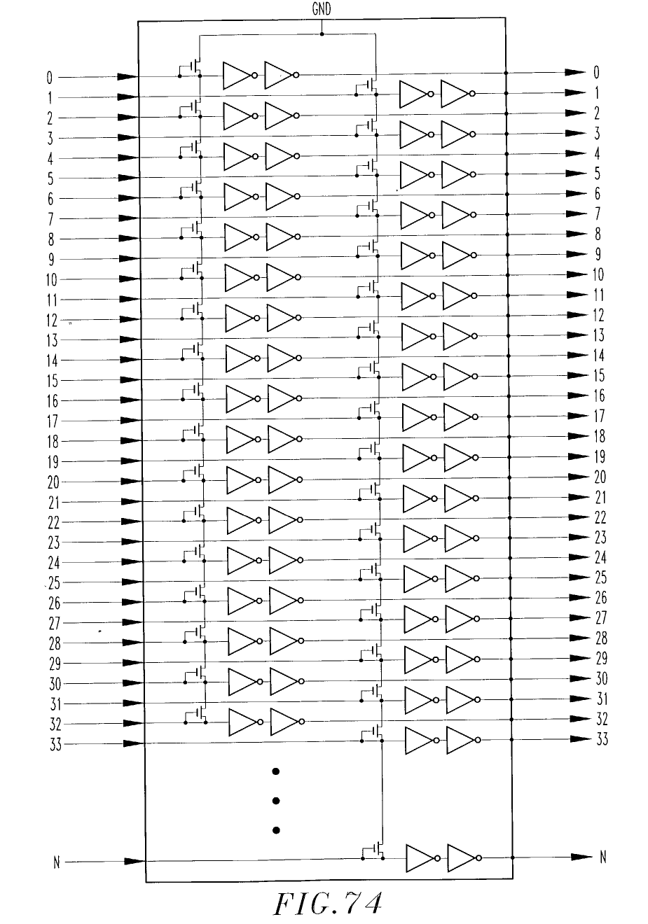

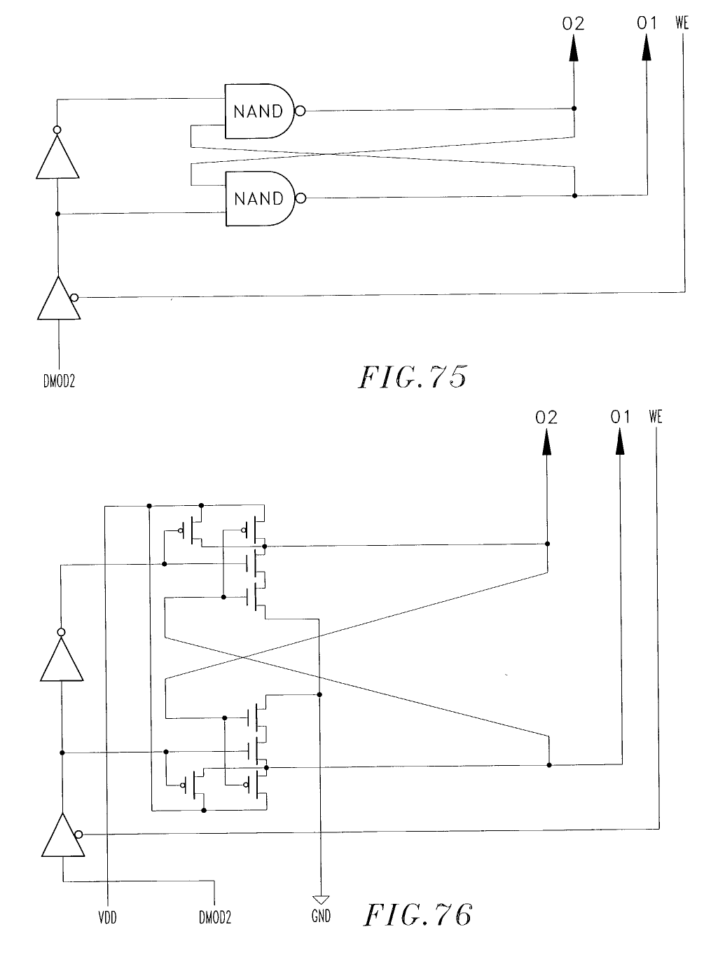

In addition, the previously mentioned second (RLL) “Runtime Length Limited” data-stream signal is re-routed from a Write Preamp Circuit's pre-amplified signal output-line (FIGS. 98 and 99), by branching off an additional output-line from the Write Preamp Circuit's preamplified signal output-line, and re-routing it to a (DMOD2) “Data Modulation 2” input of the beforementioned (PICCC) “Planar Induction Coil Control Circuit”, as illustrated in FIGS. 64A, 64D, 75, 76, 77, and 78. Furthermore, within the previously mentioned (PICCC) “Planar Induction Coil Control Circuit” the beforementioned second (RLL) “Runtime Length Limited” data-stream signal, after entering a (PICCC) Planar Induction Coil Control Circuit's Flip-Flop circuit, the data-stream signal is split into two overlapping and digitally opposing transmission-gate modulation control-signals (FIGS. 75, 76, 77, and 78), and placed onto two separate control-bus lines; Flip-Flop control-bus line-number “01”, and Flip-Flop control-bus line-number “02”, as illustrated in FIGS. 75 and 76. Furthermore, the previously mentioned Flip-Flop control-bus output-signals are used to “Switch Toggle” the beforementioned (BIMPIC) Bi-Metal Planar Induction Alpha and Beta Coil's (FIGS. 64A, 64D, 77, and 78) accessibility to the beforementioned “Write Channel PICCC Bus For WDC Input (A)” bus-circuit, which is connected to the beforementioned (WDCI (A)) Write Driver Circuit's Input (A) data-writing direct-current output-signal, or the beforementioned “Write Channel PICCC Bus For WDC Input (B)” bus-circuit, which is connected to the beforementioned (WDCI (B)) Write Driver Circuit's Input (B) data-writing direct-current output-signal.

Furthermore, the beforementioned Flip-Flop (FIGS. 74 and FIG. 75) control-bus line-number “01” connects to four transmission-gates, which control the aforesaid “Alpha” coil's access to the beforementioned (WDCI (A)) Write Driver Circuit's Input (A) data-writing direct-current output-signal, while the beforementioned Flip-Flop control-bus line-number “02” connects to four transmission-gates, which control the aforesaid “Beta” coil's access to the beforementioned (WDCI (B)) Write Driver Circuit's Input (B) data-writing direct-current output-signal.

For example, when the beforementioned Flip-Flop circuit's (DMOD2) “Data Modulation 2” input connection receives a logic-high data-bit modulation signal, the beforementioned flip-flop's control-bus line-number “01” receives from the beforementioned Flip-Flop circuit a logic-high control-signal; therein, opening the aforesaid “Alpha” coil's access to the beforementioned (WDCI (A)) Write Driver Circuit's Input (A) data-writing direct-current output-signal, as illustrated in FIGS. 64A, 64D, 77, and 78; thereby, causing a host-selected data-surface's domain-cell to become vertically magnetized into an upward direction, which represents a binary “1” logic-high data-bit, as illustrated in FIGS. 96, 97, 100, and 101. Simultaneously, when the beforementioned flip-flop's control-bus line-number “02” receives from the beforementioned Flip-Flop circuit a logic-low control-signal; therein, closing the aforesaid “Beta” coil's access to the beforementioned (WDCI (B)) Write Driver Circuit's Input (B) data-writing direct-current output-signal, as illustrated in FIGS. 64A, 64D, 77, and 78.

However, when the beforementioned Flip-Flop circuit's (DMOD2) “Data Modulation 2” input connection receives a logic-low data-bit modulation signal, the beforementioned flip-flop's control-bus line-number “01” receives from the beforementioned Flip-Flop circuit a logic-low control-signal; therein, closing the aforesaid “Alpha” coil's access to the beforementioned (WDCI (A)) Write Driver Circuit's Input (A) data-writing direct-current output-signal, as illustrated in FIGS. 64A, 64D, 77, and 78. Simultaneously, when the beforementioned flip-flop's control-bus line-number “02” receives from the beforementioned Flip-Flop circuit a logic-high control-signal; therein, opening the aforesaid “Beta” coil's access to the beforementioned (WDCI (B)) Write Driver Circuit's Input (B) data-writing direct-current output-signal, as illustrated in FIGS. 64A, 64D, 77, and 78; thereby, causing a host-selected data-surface's domain-cell to become vertically magnetized into a downward direction, which represents a binary “0” logic-low data-bit, as illustrated in FIGS. 96, 97, 100, and 101.

Therefore, during write-data disk-operations, when the beforementioned (BIMPIC) “Bi-Metal Planar Induction Alpha and Beta Coils” are used to transcribe data to a MSR Magneto-Optical Microhead Array Chip Hard Disk Drive disk-platter's data-surface (FIGS. 64A, 64D, 77, and 78), the aforesaid “Alpha” coil will always be used to transcribe a binary “1” logic-high data-bit to a host-selected MSR Magneto-Optical Microhead Array Chip Hard Disk Drive disk-platter's data-surface, while the aforesaid “Beta” coil will always be used to transcribe a binary “0” logic-low data-bit to a host-selected MSR Magneto-Optical Microhead Array Chip Hard Disk Drive disk-platter's data-surface.

Furthermore, during a write-data disk-operation an address selected microhead will activate its data-writing high-power or medium-power output laser-diode emissions, while at the same time one of the beforementioned (BIMPIC) “Bi-Metal Planar Induction Alpha and Beta Coils” applies a vertical magnetic field to a host-selected MSR Magneto-Optical Microhead Array Chip Hard Disk Drive disk-platter's data-surface. Moreover, an address selected microhead's data-writing high-power or medium-power output laser-diode emissions will raise the temperature of a “200” nanometers in diameter domain-cell, which contains a rare-earth recording material like (TbFeCo) “Terbium-Iron-Cobalt” or (GdTbFe) “Gadolinium-Terbium-Iron”, to go just beyond its curie-point, while at the same time one of the beforementioned two (BIMPIC) “Bi-Metal Planar Induction Alpha and Beta Coils” applies a vertical magnetic field to a host-selected MSR Magneto-Optical Microhead Array Chip Hard Disk Drive disk-platter's data-surface. Wherein, by applying an induced vertical magnetic field, which corresponds to either a vertically upward or a vertically downward magnetic direction, when used in concert with the MSR media, we can apply several different combinations of coercive magnetic force to several different magnetic recordings layers within the media achieving therein a “Magnetic-Induced Super Resolution” Magneto-Optical Microhead Array Chip Hard Disk Drive design.

Alternatively, if host-selected data-sectors, which are typically pre-configured within a LIMDOW disk-media's (TbFeCo) “Terbium-Iron-Cobalt” and/or (GdTbFe) “Gadolinium-Terbium-Iron” rare-earth data-recording material layer as a plurality of concentric circle data-track segments containing pluralities of magnetic oriented data-cells, were subjected to a host-selected laser-diode's high-power emission output, they would undergo, due to the coercive magnetic force emanating from the LIMDOW disk media's magnetic material substrate, an upward magnetic reorientation, which is used to represent binary “1” s.

Contradictorily, if host-selected data-sectors, which are typically pre-configured within a LIMDOW disk-media's (TbFeCo) “Terbium-Iron-Cobalt” and/or (GdTbFe) “Gadolinium-Terbium-Iron” rare-earth data-recording material layer as a plurality of concentric circle data-track segments containing pluralities of magnetic oriented data-cells, were subjected to a host-selected laser-diode's medium-power emission output, they would undergo, due to the coercive magnetic force emanating from the LIMDOW disk media's magnetic material substrate, a downward magnetic reorientation, which is used to represent binary “0” s.

In addition, the two (BIMPIC) “Bi-Metal Planar Induction Coil” devices 101, 102 (FIGS. 41 and 42) are to be positioned at the top-center of each MSR Magneto-Optical Microhead Array Chip 4 (FIGS. 41 and 42), which surrounds a microhead array with two interlayer Bi-Metal Planar Induction Coils. Wherein, each Bi-Metal Planar Induction Coil will have a dual structure consisting of a vertical copper planar-wire that is coated on one side with a thin layer of magnetic-core Nickel-Ferrite material, while each coil will comprise twenty-five coil-winding turns. Consequently, the beforementioned microhead arrays that are used in the MSR Magneto-Optical Microhead Array Chips need to be completely surrounded by two horizontal Bi-Metal Planar Induction Coils in order to affect a realignment of magnetic fields within the rare-earth materials located within a laser localized and thermally confined data cell area and, therefore will have no room at its center for a Nickel-Ferrite core structure.

Moreover, for the previously described reason, the (BIMPIC) “Bi-Metal Planar Induction Coil” design 101, 102 (FIGS. 41 and 42), which will be used in every MSR Magneto-Optical Microhead Array Chip made will, by necessity use a core-less induction coil design (i.e., sometimes called an “Air Core Induction Coil” design). To describe further how the (BIMPIC) “Bi-Metal Planar Induction Coil” design 101, 102 (FIGS. 41 and 42) is used in the MSR Magneto-Optical Microhead Array Chip Hard Disk Drive to solve the previously mentioned problem of not having a centrally located space within a MSR Magneto-Optical Microhead Array Chip to physically place a magnetic core for a (BIMPIC) “Bi-Metal Planar Induction Coil” write-channel device. Moreover, the problem is solved by constructing a planar coil flat-wire out of two different metallic materials and having one-half of the planar flat-wire coil constructed from an electron conducting material like “Aluminum” or “Copper”, while having the other-half of the planar flat-wire coil constructed from a magnetic-field producing, non-permanent, and magnetic Ferrite material, like “Ni—Zn Ferrite”.

Next, by winding, the beforementioned two planar flat vertical wires of bi-metal into induction coils causing, therein the MBE deposited non-permanent magnetic “Ni—Zn Ferrite” material to become pressed between alternating layers of an electron conducting material, like “Aluminum” or “Copper”; moreover, forming a non-magnetic, multi-layered, and cylinder shaped induction coil with a “Ni—Zn Ferrite” magnetic core. Furthermore, because the magnetic core has a multi-layered and cylinder shape, which is hollow at its center, the microhead arrays can now be placed within the previously mentioned two Bi-Metal Planar Induction Coils center area 101, 102 (FIGS. 41 and 42).

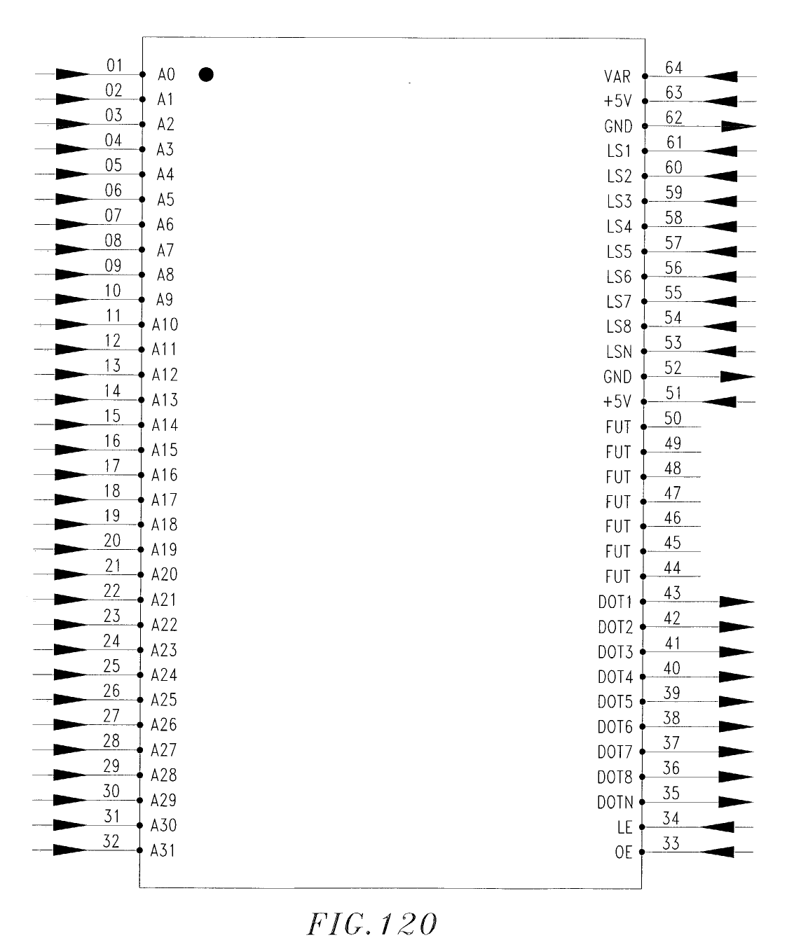

Additional Embodiments—FIGS. 113 through 141

Additional Embodiments, as illustrated in FIGS. 113 through 141, describes two additional bus-systems, which will be utilized by the present invention to provide faster access to data and disk-sector data-areas, subsequently increasing data-throughput and transfer-rates. Moreover, the two additional bus-systems are comprised as: 1.) A dedicated microhead array chip bus-system; and 2.) A dedicated multichannel microhead array chip bus-system. As illustrated in drawing FIGS. 113, 114, and 115, we can see that there are some structural similarities between the advanced bus-system embodiments about to be described below and the structure of the first bus-system design described earlier in the first bus-system embodiment.

Moreover, the two additional bus-system embodiments begin by describing the general structure of the LIMDOW and MSR Magneto-Optical Microhead Array Chip Hard Disk Drive that utilizes the dedicated microhead’ array chip and dedicated multichannel microhead array chip bus-system designs. Moreover, the two additional bus-system embodiments will finish, first by describing the physical structures and configurations of the dedicated microhead array chip and dedicated multichannel microhead array chip bus-systems, and second by describing the operation of the dedicated microhead array chip and dedicated multichannel microhead array chip bus-systems.

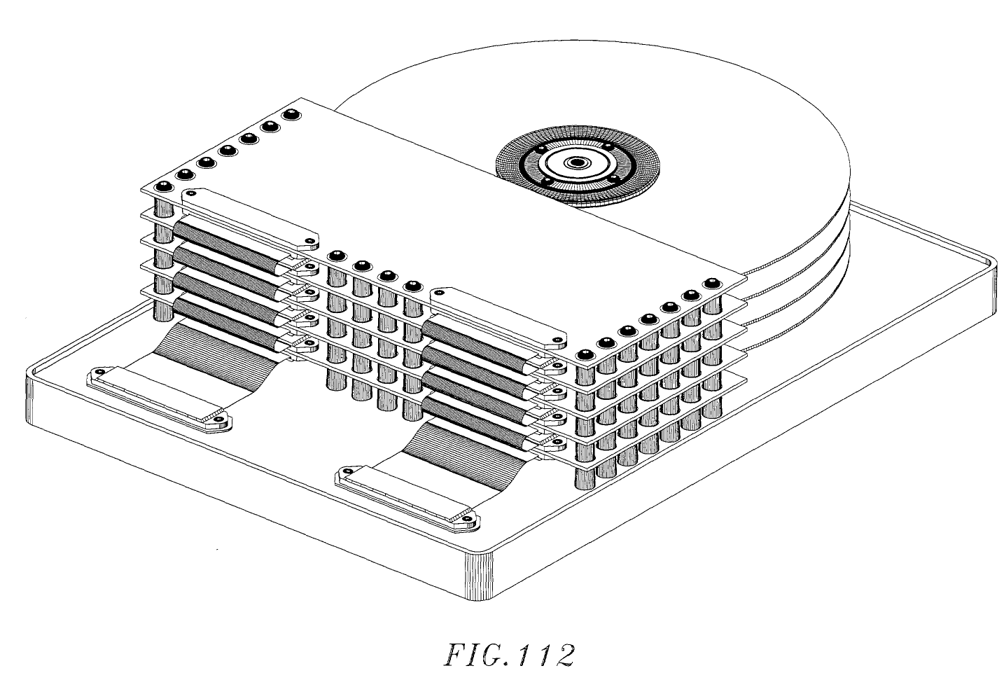

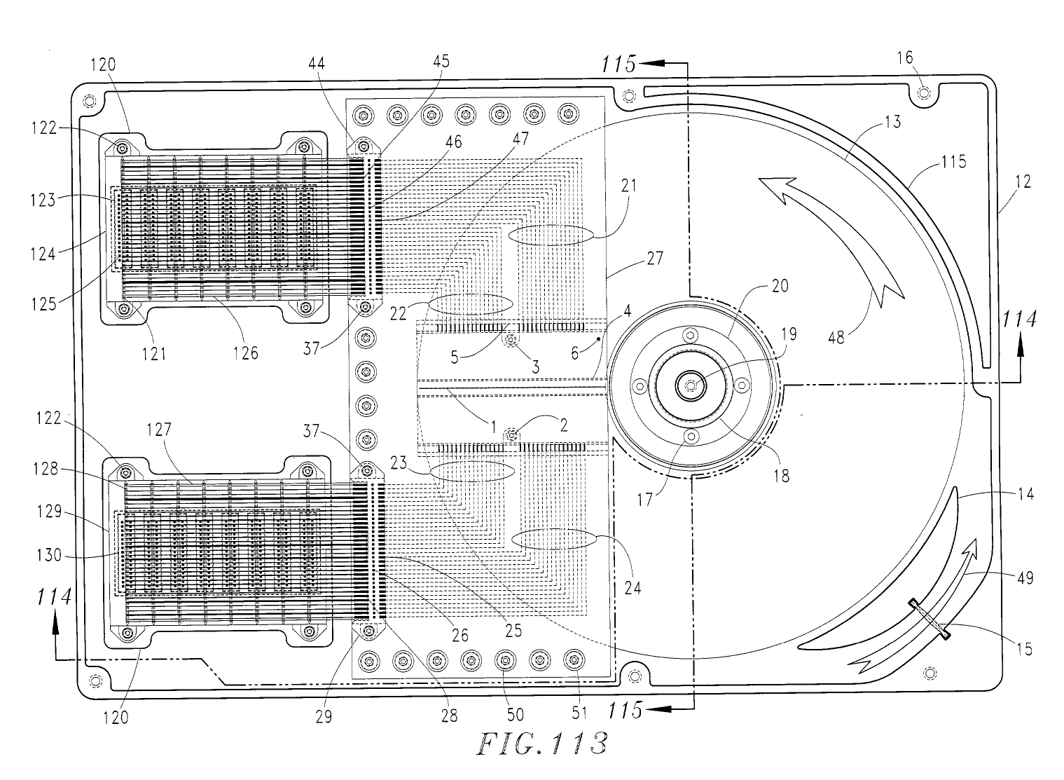

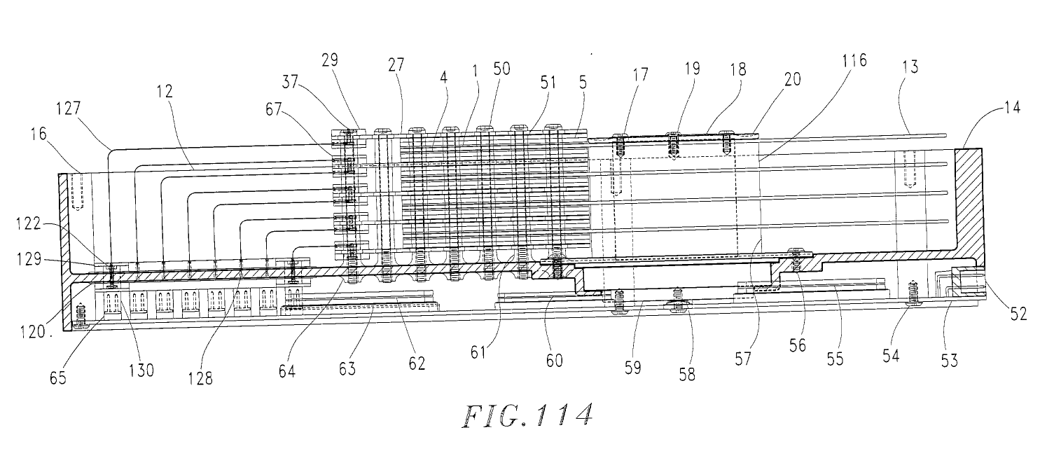

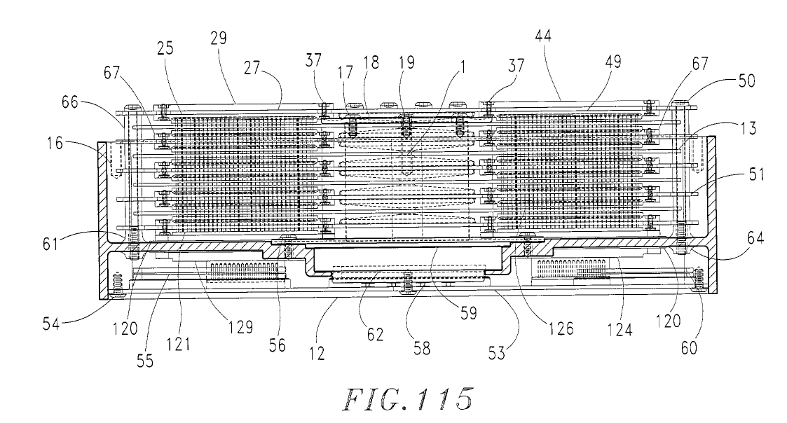

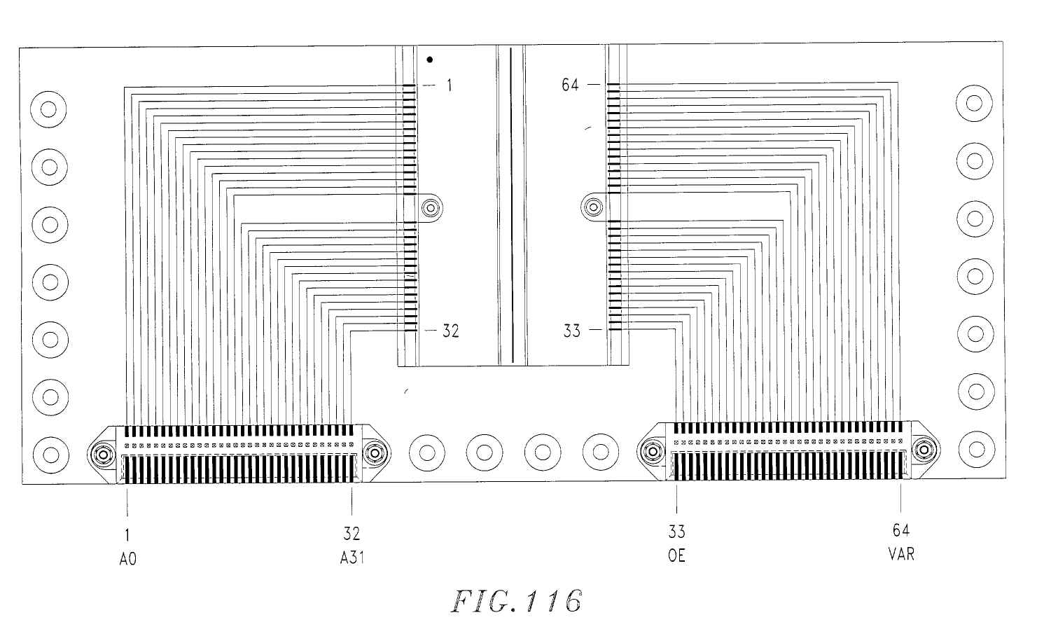

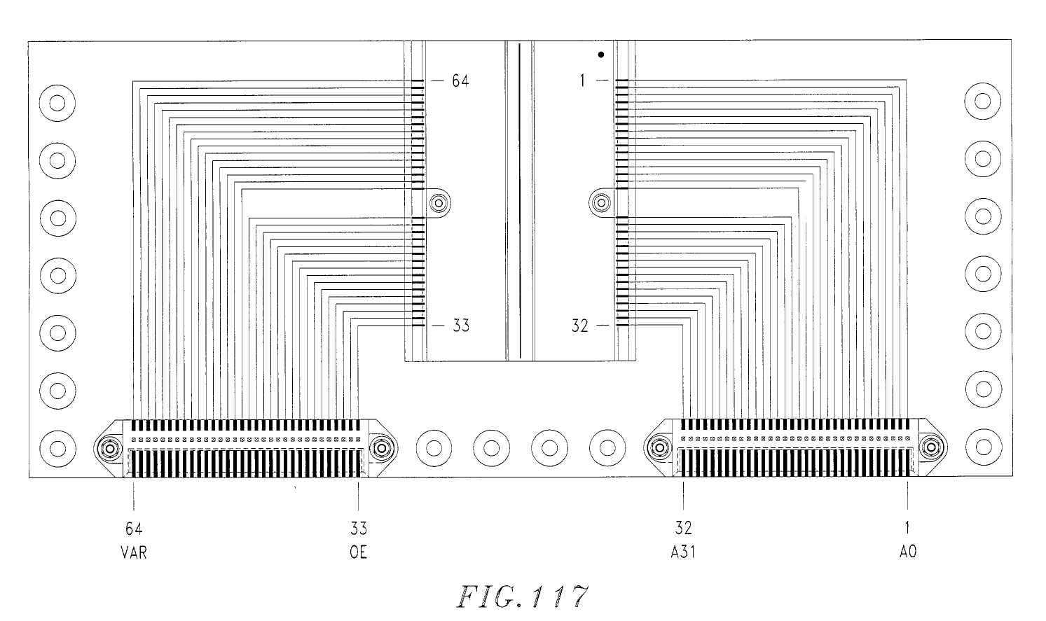

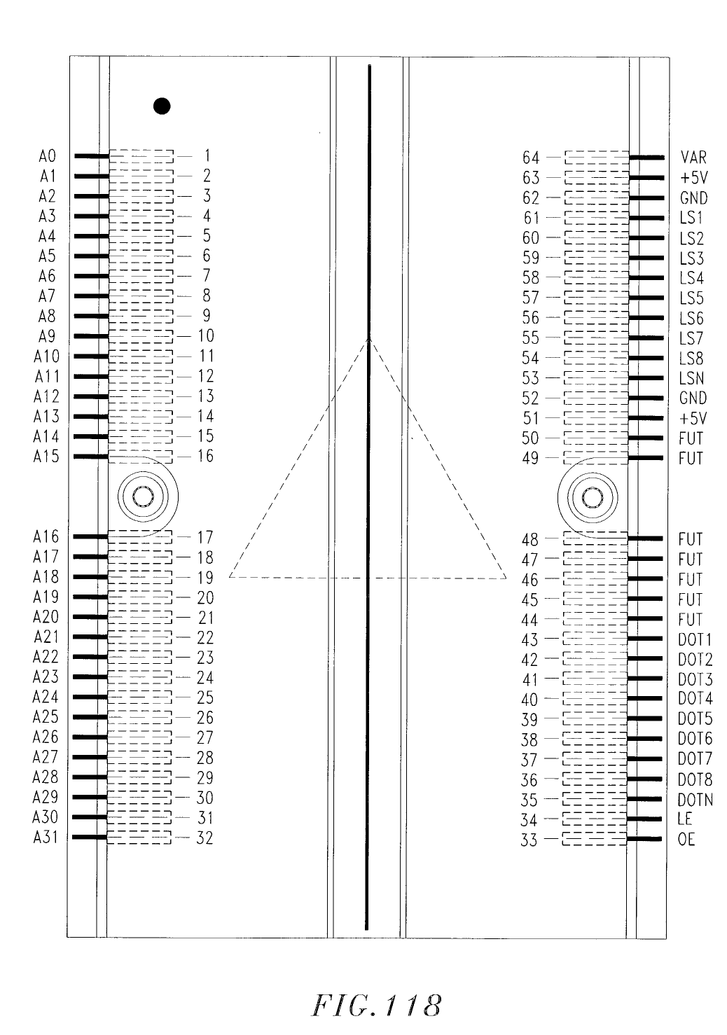

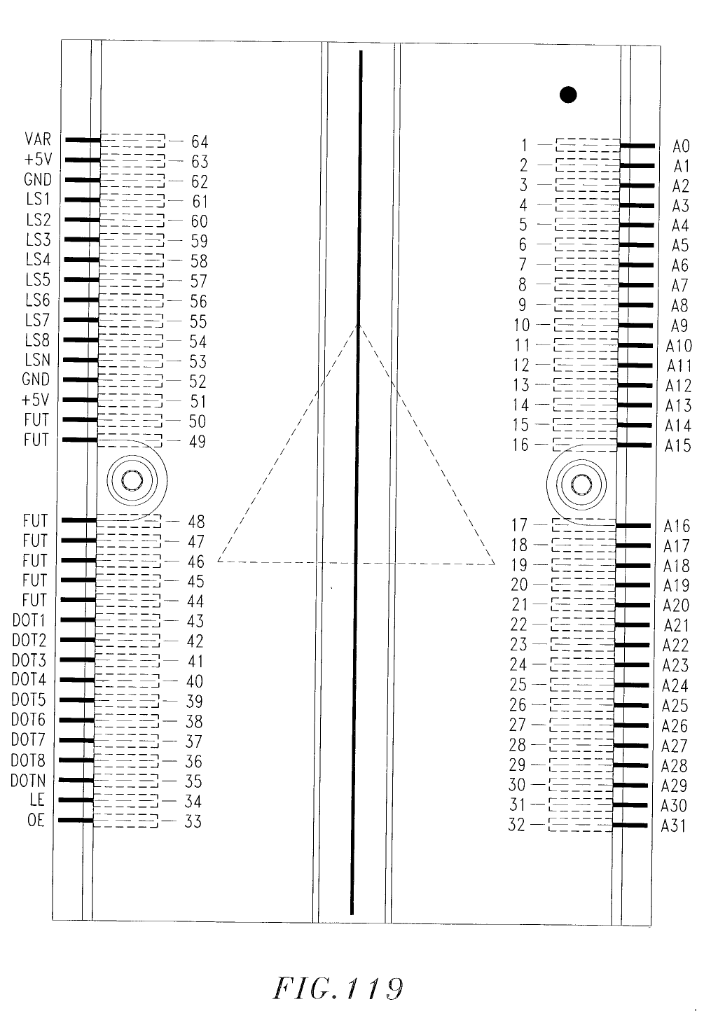

To begin with the casting-base 12 (FIGS. 113, 114, and 115) of dedicated microhead array chip and dedicated multichannel microhead array chip based LIMDOW and MSR Magneto-Optical Microhead Array Chip Hard Disk Drives is constructed from a single machined piece of aluminum-alloy, which provides a mounting surface for a spindle-motor drive mechanism 59 (FIGS. 2 and 3), a (PCB) “Printed Circuit Board” hard disk drive controller 53 (FIGS. 2 and 3), a hard disk drive's housing-cover and housing-cover gasket (i.e., not shown here), and plurality of LIMDOW or MSR Magneto-Optical Microhead Array Chip chip-positioning circuit board assemblies 27 (FIGS. 113, 114, and 115). The bottom inside of the casting-base 12 (FIGS. 113, 114, and 115) acts as a mounting flange for a (DC) “Direct Current” “Spindle-Motor” drive assembly 59 (FIGS. 114 and 115). Integral with the casting-base 12 (FIGS. 113, 114, and 115) is the DC Spindle-Motor drive assembly, which comprises a fixed-shaft and brushless DC Spindle-Motor drive mechanism 59 (FIG. 114 and 1 15) that drives the “counterclockwise” rotation 48 (FIG. 113) of disk-platters 13 (FIGS. 113, 114, and 115) installed into a LIMDOW and MSR Magneto-Optical Microhead Array Chip Hard Disk Drive's unit-assembly, as illustrated in FIG. 117.

In addition, a LIMDOW and MSR Magneto-Optical Microhead Array Chip Hard Disk Drive, depending on the drive's intended application, can use either LIMDOW or MSR disk-media 13 (FIGS. 113, 114, and 115) to comprise disk-platters, which will be used for storing information to and reproducing information from. Wherein, the disk-platters are constructed as double-sided, multi-layered, and circular-shaped disk structures. Having a substrate constructed using a composite material containing a liquid crystal polymer and magnetic rare-earth ceramic powder. When the previously described composite material containing a liquid crystal polymer and magnetic rare-earth ceramic powder is used to form a LIMDOW or a MSR disk-media's substrate, the magnetic rare-earth ceramic powder within the composite material, during part formation, will need to have the random magnetic-domain orientation inherent to powdered magnetic rare-earth ceramic bulk material, magnetically reoriented as having a singular magnetic vertical orientation. By using a powerful electromagnet to apply a directionally orientated and powerful magnetic field to the low-pressure mold injected with the part, forming composite material will effect a singular magnetic vertical reorientation of the composite material as it forms within the mold disk-shaped substrate platter.

Furthermore, the magnetically activated and vertically oriented rare-earth ceramic material will also function to magnetically reorganize molecules of liquid crystal polymer into tightly organized magnetically oriented molecules having formed throughout the composite material mutually and magnetically aligned into a single share direction of molecular orientation. The magnetically induced molecular orientation of liquid crystal polymer molecules will cause the disk shaped substrate platters to exhibit a desired amount of anisotropic thermal expansion that will for the composite material used in constructing disk shaped substrate platters successfully demonstrate a predictable control over the amount and direction of thermal expansion exhibited by parts created using a low-pressure injection mold system that can form parts like disk-shaped substrate platters by injecting under low-pressure a bulk form of the composite material into specially designed and part specific injection molds. Wherein, molds newly injected with the part forming composite material will next undergo the post-injection process of cooling down to ambient room temperature, which in turn will cause a part forming solidification of the composite material injected earlier under low-pressure into part forming injection molds. Next, newly formed disk shaped substrate platters will need to undergo a sputtered deposition of the highly reflective non-magnetic composite material like the highly reflective alloy composite “Titanium-Chromate”.

Moreover, several more layers of thin-film material will need to be sputtered or epitaxially deposited upon the previously mentioned highly reflective non-magnetic alloy composite “Titanium-Chromate”. The additional layers of thin-film material will in general follow an order of epitaxial deposition that begins with a transparent dielectric layer, continuing with several rare-earth magnetic transition and recording layers, and finishing with a protective layer, all of which are basically a plurality of epitaxially deposited layers of thin film material forming therein, structures, used to comprise the LIMDOW and MSR disk-media. Wherein, the epitaxially deposited layers of thin film material will be executed using an order of layered material deposition that starts from the outermost surfaces of the magnetic substrate disk-platters designed for use within the LIMDOW and MSR disk-media. Wherein, continued deposition of additional thin film material layers must follow an order of layered epitaxial deposition that is made to occur in an outward direction that is perpendicular to and away from the disk-media's magnetic substrate disk-platter. Wherein, the outward deposition of layers comprising thin-film material will be made to occur simultaneously upon the two opposing outmost surfaces of the substrate disk-platter. A first layer, which is adjacent to and deposited upon the outmost surfaces of the substrate disk-platter and constructed using a highly reflective non-magnetic alloy composite material like “Titanium-Chromate” or “TiAlCo—B”. The substrate disk-platter can also be made using conventional construction materials like glass, or Invar. In addition, a magnetic substrate disk-platter can also be constructed using a suspension of magnetic rare-earth ceramic material, which can undergo a scintillated construction and part formation as disk shaped substrate platters.

Moreover, all of the previously mentioned materials used to construct the disk-shaped substrate platters can also be coated with a highly reflective non-magnetic alloy composite material like “Titanium-Chromate” or “TiAlCo—B”, using any well known process of material deposition, like the well known sputtered and epitaxial forms of material deposition to epitaxially deposit simultaneously a layer of highly reflective non-magnetic alloy composite material like “Titanium-Chromate” or “TiAlCo—B” upon the two opposing outmost surfaces of the disk shaped substrate platter. Layers comprised using a highly reflective non-magnetic material like “Titanium-Chromate” or “TiAlCo—B”, are principally used within a disk-media to reflect data-scanning laser-light produced by individual laser-diode microheads present within every LIMDOW or MSR Magneto-Optical Microhead Array Chip.

Moreover, a first transparent dielectric layer must be formed from a transparent de-oxygenated material such as (SiN) “Silicon-Nitride” or (AlN) “Aluminum-Nitride”. Magneto-optical disk-media, because they contain transition and recording layers formed using amorphous magnetic rare-earth and transition-metal alloys such as (TbFeCo) or (GdTbFe), all protection layers must also be constructed using an optically transparent material, which is to be comprised using a construction material having a non-oxygen containing molecular structure. Typically, the last layer to be deposited is a second protective layer, which is also formed from an optically transparent material, which is to be comprised using a construction material with a non-oxygen containing molecular structure, such as (SiN) “Silicon-Nitride” or (AlN) “Aluminum-Nitride”.

Typically, disk-platters are mounted upon a rotating spindle assembly 57 (FIG. 114), which is rotated “3,400” to “20,000” (RPM) “Revolutions-Per-Minute” by an in-spindle brushless DC Spindle-Motor 59 (FIGS. 114 and 115), relative to the beforementioned frame casting-base 12 (FIGS. 113, 114, and 115). Typically, a Spindle-Motor is secured to an aluminum-alloy casting-base 12 (FIGS. 113, 114, and 115) with four motor mounting hex-screws 56 (FIGS. 114 and 115). In addition, the Spindle-Motor 59 (FIGS. 114 and 115) has a rotor 57 (FIG. 114), which is flanged at the base, and a disk-platter axle, which is located at the center of the previously mentioned rotor 57 (FIG. 114).

In addition, rotatable-flanged rotor housing is used to firmly secure and position all installed disk-platters. Wherein, each disk-platter has a respective disk-spacer 116 (FIG. 114) placed between each proceeded disk-platter installed within the drive. With a final disk-platter 13 (FIGS. 113, 114, and 115) shown as being secured into place by a rotor-housing cap 20 (FIGS. 113) and four rotor-housing cap mounting hex-screws 17 (FIGS. 113, 114, and 115).

Preferably, the Spindle-Motor should have bearings formed as part of the Spindle-Motor's drive-assembly 59 (FIGS. 114 and 115), which is typically used to rotate a spindle-assembly 57 (FIG. 114) in a counter-clockwise direction relative to the frame casting-base 12 (FIGS. 113, 114, and 115). The Spindle-Motor 59 (FIGS. 114 and 115) itself is mounted to the bottom-inside surface of the casting-base 12 (FIGS. 113, 114, and 115) using four motor mounting hex-screws 56 (FIGS. 114 and 115).

Furthermore, located at the center of the rotor-housing's top-bearing 18 (FIGS. 113, 114, and 115) is a Spindle-Motor's non-moving bearing-rod core 19 (FIGS. 113, 114, and 115). Moreover, a non-moving bearing-rod core 19 (FIGS. 113, 114, and 115) has its top-end threaded for use in securing a LIMDOW and MSR Magneto-Optical Microhead Array Chip Hard Disk Drive's housing-cover. Wherein, the securing of the previously mentioned housing-cover is accomplished using a single cover mounting hex-screw, which is screwed into the threaded top-end of the bearing-rod core, through a single cover mounting hex-screw hole 19 (FIGS. 113, 114, and 115), which is located along with several other cover mounting hex screw holes within the housing-cover and used along with their respective cover mounting hex screws to tightly secure a LIMDOW and MSR Magneto-Optical Microhead Array Chip Hard Disk Drive's housing-cover to the drive's casting-base 12 (FIGS. 113, 114, and 115). Preferably, there are “6” other threaded hex-screw holes 16 (FIGS. 113, 114, and 115) in a LIMDOW and MSR Magneto-Optical Microhead Array Chip Hard Disk Drive's casting-base 12 (FIGS. 113, 114, and 115), all of which are also used in the additional securing and sealing of a (i.e., not shown here) LIMDOW and MSR Magneto-Optical Microhead Array Chip Hard Disk Drive's housing-cover onto the drive's casting-base housing.

Furthermore, the Spindle-Motor's driver-circuit, which is called the “Spindle And Power Controller” 60 (FIG. 4), 82 (FIG. 5), 60 (FIG. 60A), 60 (FIG. 60C), 82 (FIG. 61A), 82 (FIG. 61C), 60 (FIG. 62A), 60 (FIG. 62C), 82 (FIG. 63A), 82 (FIG. 63C) is provided to communtate e.g. with the three-phase windings of a LIMDOW and MSR Magneto-Optical Microhead Array Chip Hard Disk Drive's brushless Spindle-Motor 59 (FIGS. 114 and 115). Hall-Sensors (i.e., not shown here) are also provided to determine the position of the permanent-magnetic rotary-elements located within a rotor relative to the fixed windings and poles of the Spindle-Motor itself 59 (FIGS. 114 and 115). Typically, Hall-Sensors (i.e., not shown here) provide response-control feedback information to a “Spindle And Power Controller” 60 (FIG. 4), 82 (FIG. 5), 60 (FIG. 60A), 60 (FIG. 60C), 82 (FIG. 61A), 82 (FIG. 61C), 60 (FIG. 62A), 60 (FIG. 62C), 82 (FIG. 63A), 82 (FIG. 63C). In addition, the previously mentioned Spindle And Power Controller's driver-circuit is also used to control the Hall-Sensors in a conventional fashion as well.

In addition, final assembly of a LIMDOW and MSR Magneto-Optical Microhead Array Chip Hard Disk Drive will be done in a contamination free “Clean Room” manufacturing facility. To provide the LIMDOW and MSR Magneto-Optical Microhead Array Chip Hard Disk Drives with contamination free environments a housing-cover sealing-gasket is provided to create an air-tight seal between a LIMDOW and MSR Magneto-Optical Microhead Array Chip Hard Disk Drive's casting-base 12 (FIGS. 113, 114, and 115) and its (i.e., not shown here) housing-cover. Sealing-gaskets will be installed during final assembly of the LIMDOW and MSR Magneto-Optical Microhead Array Chip Hard Disk Drive unit assemblies, by using “6” threaded hex-screws (i.e., not shown here) to secure into place a LIMDOW and MSR Magneto-Optical Microhead Array Chip Hard Disk Drive's housing-cover, causing the housing-cover gasket, which is installed between the housing-cover and the casting-base along a gasket compressing grove, to compress in the vertical direction, while causing it to expand in the horizontal direction, creating an air-tight seal between the housing-cover and the casting-base that will maintain for the drive's interior an environment free from contamination.

Furthermore, to provide an environment that continues to be clean and free from air-borne contaminants; an internal air-filtering device is used 15 (FIG. 113) to filter the drive's internal air supply. The drawing FIG. 113 comprises an orthographic plan-view drawing that clearly illustrates the location of an internal air-filtering device 15 (FIG. 113), while using an air-flow direction indication arrow to illustrate airflow 49 (FIG. 113) direction through the filter. Also, drawing FIG. 113 visually clarifies that the air-flow direction through the air-filter 15 (FIG. 113) follows the same 48 (FIG. 113) direction of counterclockwise rotation used by a LIMDOW and MSR Magneto-Optical Microhead Array Chip Hard Disk Drive's installed disk-platters 13 (FIGS. 113, 114, and 115).

Moreover, the LIMDOW or MSR Magneto-Optical Microhead Array Chips used within a LIMDOW and MSR Magneto-Optical Microhead Array Chip Hard Disk Drive's unit-assembly are installed into fixed positions that lie very close to a LIMDOW and MSR Magneto-Optical Microhead Array Chip Hard Disk Drive's rotating disk-platter data-surfaces (i.e., within a very close 150 microns). Therefore, it is essential that the air circulating through LIMDOW and MSR Magneto-Optical Microhead Array Chip Hard Disk Drive s be kept free of dust, pollen, and other air-borne particles and contaminates, least they become trapped between a microhead array of a LIMDOW or MSR Magneto-Optical Microhead Array Chip and a disk-platter's data-surface, causing surface damage and data-loss to a disk-platter's data-surface. Furthermore, when the LIMDOW and MSR Magneto-Optical Microhead Array Chip Hard Disk Drives are in use rotation of its installed disk-platters force air through the previously described air-filter 15 (FIG. 113). By using an air-foil shape 14 (FIG. 113) within the air-filter's passageway design internal air-pressure within the passageway is slightly lowered 15 (FIG. 113) from the rest of the drive's interior, causing a constant stream of air to be made to flow through the “0.3” micron air-filter 15 (FIG. 113).

Moreover, the beforementioned air-filter is installed into a slot lying between the upper right-hand corner of a LIMDOW and MSR Magneto-Optical Microhead Array Chip Hard Disk Drive's casting-base 12 (FIG. 113), and the air-filter's airfoil shaped passageway 14 (FIG. 113). Furthermore, during normal hard disk drive operation, while the disk-platters within a LIMDOW and MSR Magneto-Optical Microhead Array Chip Hard Disk Drive are rotating, the air-circulation induced by an airfoil's low-pressure passageway 14 (FIG. 113) will also help a LIMDOW and MSR Magneto-Optical Microhead Array Chip Hard Disk Drive to keep cool.

Additional embodiments of the present invention, as illustrated in FIGS. 113 through 141, also show how to execute placement of LIMDOW or MSR Magneto-Optical Microhead Array Chips. Wherein, the LIMDOW or MSR Magneto-Optical Microhead Array Chips are positioned by a chip-positioning circuit board 27 (FIGS. 113, 114, and 115). To insure rigid and stable placement of the LIMDOW or MSR Magneto-Optical Microhead Array Chips, the chip-positioning circuit boards need core structures constructed from a rigid material like “Titanium” or a “Graphite Carbon Composite”. Furthermore, a chip-positioning circuit board's core structure 27 (FIGS. 113, 114, and 115) has two main large-area plan parallel surfaces. Wherein, each side of every chip-positioning circuit board would have eighteen embossed bolt-flanges; a total of thirty-six bolt-flanges 51 (FIGS. 113, 114, and 115) for each chip-positioning circuit board's core structure. Moreover, each chip-positioning circuit board's thirty-six embossed bolt-flanges are created as raised surfaces; protruding “1/16” of one-inch in an outward direction perpendicular to a chip-positioning circuit board's main large-area surface, which will later contain sixty-four copper-circuit trace-runs. Each embossed bolt-flange will have its top-surface area machined down and shaped into a bolt-flange with a high degree of flatness, which must be within an allowed tolerance of plus or minus “⅛” of one-micron.

Moreover, after each chip-positioning circuit board has its thirty-six embossed bolt-flanges machined down to a specified tolerance, a first-layer application of fiberglass insulation is applied to the outer surfaces of the chip-positioning circuit boards. The beforementioned first fiberglass insulation layer will provide fundamental electrical insulation for a chip-positioning circuit board's installed copper circuit trace-runs 21, 22, 23, 24 (FIG. 113). Only after the fiberglass insulation has been applied to surfaces reserved for the future installation of a chip-positioning circuit board's copper circuit trace-runs, can installation of a chip-positioning circuit board's sixty-four copper circuit trace-runs proceed. Installation of the fiberglass insulation will both protect and isolate any installed copper circuit trace-runs, not only from each other, but also from the metallic material used to construct a chip-positioning circuit board's core-structure.

In addition, the previously mentioned thirty-six embossed bolt-flanges 51 (FIGS. 113), which are passively used to install completed chip-positioning circuit boards into a LIMDOW and MSR Magneto-Optical Microhead Array Chip Hard Disk Drive's unit-assembly (FIG. 117). Moreover, completed chip-positioning circuit boards will need to be free of dirt, fiberglass, or any other particulate matter to be installed properly. To explain this further, during a LIMDOW and MSR Magneto-Optical Microhead Array Chip Hard Disk Drive's final assembly (FIG. 117) if any particulate matter were to be left on any chip-positioning circuit board's embossed bolt-flange mounting surfaces 51 (FIGS. 113), the installation and placement of chip-positioning circuit boards, as illustrated by FIGS. 113, 114, and 115, could, after the installation be misaligned while in their respective LIMDOW and MSR Magneto-Optical Microhead Array Chip Hard Disk Drive's unit-assembly (FIG. 117), adversely affecting the LIMDOW and MSR Magneto-Optical Microhead Array Chip Hard Disk Drive's overall performance. Therefore, after applying fiberglass insulation to a chip-positioning circuit board's outermost surfaces the thirty-six embossed bolt-flanges 51 (FIG. 113) of the chip-positioning circuit boards must be thoroughly cleaned and made fiberglass and dirt free.

In addition, surface-mounted chip-sockets 5 (FIGS. 113, 114, and 115), which are used by chip-positioning circuit boards to install, position, and connect LIMDOW or MSR Magneto-Optical Microhead Array Chips into a LIMDOW and MSR Magneto-Optical Microhead Array Chip Hard Disk Drive's unit-assembly (FIG. 112), while providing electrical connectivity between the LIMDOW or MSR Magneto-Optical Microhead Array Chips and the copper circuit trace-runs 21, 22, 23, 24 located across the outer surface of a chip-positioning circuit board, as illustrated in FIGS. 113, 116, and 117.

In addition, and only after the installation of a chip-positioning circuit board's surface-mounted chip-socket 5 (FIGS. 113, 114, and 115) has been accomplished, can a final topcoat layer of insulating fiberglass be applied to a chip-positioning circuit board's outer-most surface areas 21, 22, 23, 24 (FIGS. 30, 32, 35, and 37) and, therein to its surface-mounted chip-socket's base-area perimeter 5 (FIGS. 113, 114, and 115), which will help to seal and secure a chip-positioning circuit board's surface-mounted chip-socket(s) 5 into their final position(s). While applying fiberglass to a chip-positioning circuit board and to a chip-positioning circuit board's surface-mounted chip-socket(s) 5 (FIGS. 113, 114, and 115) care must be taken to keep the beforementioned fiberglass insulation off any chip-positioning circuit board's embossed machined bolt-flange mounting surfaces 51 (FIGS. 113, 114, and 115), and out of the contact-circuit areas 93 (FIGS. 30, 32, 35, and 37) of a chip-positioning circuit board's surface-mounted chip-socket(s) 5 (FIGS. 113, 114, and 115).

Moreover, contact-circuit areas 93 (FIGS. 30, 32, 35, and 37), which are used to connect installed LIMDOW or MSR Magneto-Optical Microhead Array Chips, illustrated by FIGS. 29, 31, 34, and 36, to a LIMDOW and MSR Magneto-Optical Microhead Array Chip Hard Disk Drive's internal bus system are located at the inner-bottom surface-areas 93 (FIGS. 30, 32, 35, and 37) of every surface-mounted chip-socket(s) 5 (FIGS. 113, 114, and 115) of every chip-positioning circuit board installed into a LIMDOW and MSR Magneto-Optical Microhead Array Chip Hard Disk Drive's unit-assembly, as illustrated in FIG. 117.

Moreover, the surface-mounted chip-sockets 5 (FIGS. 113, 114, and 115), like the chip-sockets illustrated in chip-positioning circuit board drawing FIGS. 29, 30, 31, 32, 33, 34, 35, 36, 37, and 38, have been designed to firmly secure and position LIMDOW or MSR Magneto-Optical Microhead Array Chips into pre-designated and stationary positions above a drive's disk-platter data-surfaces. Furthermore, the secured installation of the beforementioned LIMDOW or MSR Magneto-Optical Microhead Array Chips (FIGS. 29, 31, 34, and 36) into their surface-mounted chip-sockets 5 (FIGS. 113, 114, and 115) is accomplished using a triangular-shaped “Chip Placement Key” 11 (FIGS. 7, 8, 26, and 27) and two surface mounting chip-socket threaded hex-screws (i.e., two threaded hex-screws per LIMDOW or MSR Magneto-Optical Microhead Array Chip) 2 (FIGS. 1 and 6).

In addition, a triangular-shaped placement key 11 (FIGS. 7, 8, 26, and 27) of a LIMDOW or MSR Magneto-Optical Microhead Array Chip is molded and shaped out of an extruded bottom-surface material, which is part of every LIMDOW or MSR Magneto-Optical Microhead Array Chip's outer-casing package 4 (FIGS. 26 and 27). To meet with tolerances, triangular-shaped placement keys 11 (FIGS. 7, 8, 26, and 27) of LIMDOW or MSR Magneto-Optical Microhead Array Chips are located at the bottom of every LIMDOW or MSR Magneto-Optical Microhead Array Chip and machined down into a final triangular-shaped extruding plate 11 (FIGS. 7, 8, 26, and 27). After its final machining a LIMDOW or MSR Magneto-Optical Microhead Array Chip's placement key 11 will protrude about “1/16” of one-inch down from underneath the bottom-center surface of a LIMDOW or MSR Magneto-Optical Microhead Array Chip's outer-casing package 4 (FIGS. 1, 26, and 27). The triangle-shaped chip placement keys 11 will both position and secure the LIMDOW or MSR Magneto-Optical Microhead Array Chips (FIGS. 29, 31, 34, and 36) into the surface-mounted chip-sockets 5 (FIGS. 1, 2, and 6) of chip-positioning circuit boards, as illustrated in FIGS. 29, 30, 31, 32, 33, 34, 35, 36, 37, and 38, by fitting the previously mentioned triangle-shaped keys 11 into triangle-shaped and correspondingly sized chip placement keyholes 92 (FIGS. 30, 32, 35, and 37), which are located at the top-center surface of the bottom-center plane 92 of every surface-mounted chip-socket installed 5 (FIGS. 1, 2, and 6). Further, the previously mentioned chip placement keyholes 92 (FIGS. 30, 32, 35, and 37) will have the apex of their triangular shaped keyhole pointed toward the front of its respective chip-positioning circuit board's front-end 92 (FIGS. 30, 32, 35, and 37).

Furthermore, the LIMDOW or MSR Magneto-Optical Microhead Array Chips are secured into surface-mounted chip-sockets using two threaded hex-screws 2 (FIGS. 113, 114, and 115), which are pushed through a LIMDOW or MSR Magneto-Optical Microhead Array Chip's two un-threaded hex-screw holes 3 (FIGS. 1, 6, 7, 8, 25, 26, 27, and 28) into a surface-mounted chip-socket's two threaded hex-screw holes 93 (FIGS. 30, 32, 35, and 37). Wherein, the previously mentioned hex-screws are screwed into the previously mentioned surface-mounted chip-socket's two threaded hex-screw holes 93, by turning them, using a torque wrench, in a clockwise-direction, until the two surface-mounted chip-socket's hex-screws 2 have reached a predetermined tightness, which will be indicated by the torque wrench. In this way, the surface-mounted chip-sockets will keep the LIMDOW or MSR Magneto-Optical Microhead Array Chips, illustrated by FIGS. 29, 31, 34, 36, tightly seated and secured into their respective chip-positioning circuit boards, as illustrated in FIGS. 29, 30, 31, 32, 33, 34, 35, 36, 37, and 38.

In addition, as illustrated in drawing FIGS. 113, 114, and 115, the additional embodiments of the LIMDOW and MSR Magneto-Optical Microhead Array Chip Hard Disk Drive design describes in detail the structures behind the previously mentioned Polymer flex-cables and their respective Polymer flex-cable connectors 67. Polymer flex-cable connectors 67 are installed onto chip-positioning circuit boards 27 (FIGS. 113, 114, and 115) to provide via Polymer flex-cables 126, 127 (FIGS. 113, 114, and 115) bus-system connectivity between chip-positioning circuit boards the LIMDOW or MSR Magneto-Optical Microhead Array Chips (FIGS. 29, 31, 34, and 36) they contain, and the Drive's Disk Controller, which is illustrated by FIGS. 4 and 5.

Moreover, Polymer flex-cable connectors 67 and Polymer flex-cables 126, 127 (FIGS. 113, 114, and 115), will be giving to each LIMDOW or MSR Magneto-Optical Microhead Array Chip (FIGS. 25, 26, 27, and 28) separate and dedicated access to a LIMDOW and MSR Magneto-Optical Microhead Array Chip Hard Disk Drive's Disk Controller. Further, the previously mentioned Polymer flex-cable connectors 67 and Polymer flex-cables 126, 127 (FIGS. 113, 114, and 115) will in return, be giving to a LIMDOW and MSR Magneto-Optical Microhead Array Chip Hard Disk Drive's Disk Controller separate and dedicated access to each LIMDOW or MSR Magneto-Optical Microhead Array Chip, as illustrated in FIGS. 25, 26, 27, and 28. When the previously mentioned Polymer flex-cable connectors 67 are installed onto a chip-positioning circuit board they will provide multiple circuit connections between an installed LIMDOW and MSR Magneto-Optical Microhead Array Chip and the connectors 67 respective Polymer flex-cables 43, 36, 38, 30, by making physical electron conducting contact with the exposed copper ends of a chip-positioning circuit boards sixty-four copper-circuit trace-runs 21, 22, 23, 24 (FIGS. 113, 114, and 115).

To explain further, by using open-circuit contact-points 46, 26 (FIGS. 113, 114, and 115), which are located on the forward-facing side of the bottom inside-edge of a Polymer flex-cable connector's outer-shell casing 25, 47 (FIGS. 113, 114, and 115), the beforementioned open-circuit contact-points 46, 26 (FIGS. 113, 114, and 115) shall form a multiple circuit connection with a chip-positioning circuit board's 27 (FIGS. 113, 114, and 115) sixty-four copper-circuit trace-runs 21, 22, 23, 24 when the Polymer flex-cable connectors 67 (FIGS. 29, 30, 31, 32, 33, 34, 35, 36, and 37) are bolted, using two Polymer flex-cable connector hex-screws 37 (FIGS. 113, 114, and 115), onto the exposed copper ends of copper-circuit trace-runs 47, 25 (FIG. 113) of the chip-positioning circuit boards 27 (FIGS. 113, 114, and 115).

Furthermore, when the exposed copper ends of the copper-circuit trace-runs 46, 26 (FIGS. 113, 114, and 116) of Polymer flex-cables 43, 30 (FIGS. 113, 114, and 115) are inserted into Polymer flex-cable female connectors 28, 45 (FIGS. 113, 114, and 115) the cables are held into place by internal spring-contacts 28, 45 located within the Polymer flex-cable connectors. Giving the previously mentioned Polymer flex-cable connectors 67 (FIGS. 113, 114, and 115) and their respective LIMDOW and MSR Magneto-Optical Microhead Array Chip containing chip-positioning circuit boards 27 (FIGS. 113, 114, and 115), using a single Polymer flex-cable, a connectivity to a Disk Controller and its various bus-systems that is dedicated and separate from all other LIMDOW and MSR Magneto-Optical Microhead Array Chips installed into LIMDOW and MSR Magneto-Optical Microhead Array Chip Hard Disk Drive's unit-assembly (FIG. 112).

Moreover, a LIMDOW and MSR Magneto-Optical Microhead Array Chip Hard Disk Drive's first chip-positioning circuit board, illustrated in FIGS. 33, 34, and 35, is positioned at and attached to a LIMDOW and MSR Magneto-Optical Microhead Array Chip Hard Disk Drive's casting-base 12 (FIGS. 113, 114, and 115) and chip-positioning circuit board mounting pedestals 61, 64 (FIGS. 114 and 115) therein. Furthermore, when a LIMDOW and MSR Magneto-Optical Microhead Array Chip Hard Disk Drive's unit-assembly (FIG. 112) is viewed with its front-end turned-up vertical into the Y-direction of Cartesian coordinates (i.e., what is sometimes called the portrait-position), the beforementioned Polymer flex-cable connectors 67 (FIGS. 113, 114, and 115) and the beforementioned Polymer flex-cables 126, 127 (FIGS. 113, 114, and 115), if located on the right-hand side of chip-positioning circuit boards installed into a LIMDOW and MSR Magneto-Optical Microhead Array Chip Hard Disk Drive's unit-assembly (FIG. 112) will provide for each installed LIMDOW and MSR Magneto-Optical Microhead Array Chip a multiple connection circuit that provides a separate and dedicated access to a LIMDOW and MSR Magneto-Optical Microhead Array Chip Hard Disk Drive's Disk Controller and the Disk Controller's Power, Ground, Data I/O, and Control bus-systems.

Furthermore, the beforementioned Polymer flex-cable connectors 67 (FIGS. 113, 114, and 115) and the beforementioned Polymer flex-cables 126, 127 (FIGS. 113, 114, and 115), if installed on the right-hand side of the beforementioned chip-positioning circuit boards will form a multiple circuit connection between installed LIMDOW or MSR Magneto-Optical Microhead Array Chips (FIGS. 29, 31, 34, 36, and 38), through a LIMDOW or MSR Magneto-Optical Microhead Array Chip's chip-connecting contact-points 7, 8 (FIGS. 7, 8, 26, and 27), and a Disk Controller's (PCB) “Printed Circuit Board” unit-assembly 53 (FIGS. 113, 114 and 115). Moreover, remembering that a Disk Controller's PCB 53 is positioned just under a LIMDOW and MSR Magneto-Optical Microhead Array Chip Hard Disk Drive's Spindle-Motor unit-assembly 59 (FIGS. 114 and 115), facing the bottom-inside surface of a LIMDOW and MSR Magneto-Optical Microhead Array Chip Hard Disk Drive's casting-base 12 (FIGS. 113, 114, and 115).

In addition, when a LIMDOW and MSR Magneto-Optical Microhead Array Chip Hard Disk Drive's unit-assembly (FIG. 112) is viewed with its front-end turned-up vertical into the Y-direction of Cartesian coordinates (i.e., what is sometimes called the portrait-position), the beforementioned Polymer flex-cable connectors 67 (FIGS. 29, 30, 31, 32, 33, 34, 35, 36, and 37) and the beforementioned Polymer flex-cables 126, 127 (FIGS. 113, 114, and 115), if located on the left-hand side of chip-positioning circuit boards installed into a LIMDOW and MSR Magneto-Optical Microhead Array Chip Hard Disk Drive's unit-assembly (FIG. 112) will provide for each installed LIMDOW and MSR Magneto-Optical Microhead Array Chip a multiple connection circuit that provides a separate and dedicated access to a LIMDOW and MSR Magneto-Optical Microhead Array Chip Hard Disk Drive's 32-bit Microhead Addressing bus-system.

In addition, the beforementioned Polymer flex-cable connectors 67 (FIGS. 29, 30, 31, 32, 33, 34, 35, 36, and 37) and the beforementioned Polymer flex-cables 126, 127 (FIGS. 113, 114, and 115), if installed on the left-hand side of the beforementioned chip-positioning circuit boards, will form a multiple circuit connection between installed LIMDOW or MSR Magneto-Optical Microhead Array Chips (FIGS. 29, 31, 34, 36, and 38), through their chip-connecting contact-points 9, 10 (FIGS. 7, 8, 26, and 27) and a Disk Controller's (PCB) “Printed Circuit Board” unit-assembly 53 (FIGS. 113, 114, and 115). Moreover, remembering that a Disk Controller's PCB 53 (FIGS. 113, 114, and 115) is positioned just under a LIMDOW and MSR Magneto-Optical Microhead Array Chip Hard Disk Drive's Spindle-Motor unit-assembly 59 (FIGS. 114 and 115), facing the bottom-inside surface of a LIMDOW and MSR Magneto-Optical Microhead Array Chip Hard Disk Drive's casting-base 12 (FIGS. 113, 114, and 115).

Furthermore, in addition too the previously mentioned Polymer flex-cable connectors 67 (FIGS. 29, 30, 31, 32, 33, 34, 35, 36, and 37) are the Polymer flex-cable connectors called female bridge-connectors 124, 129 (FIGS. 113, 114, and 115), which are used to connect a LIMDOW and MSR Magneto-Optical Microhead Array Chip Hard Disk Drive's chip-positioning circuit board assemblies, illustrated by FIGS. 29, 30, 31, 32, 33, 34, 35, 36, 37, and 38, up to the previously mentioned Disk Controller's PCB unit-assembly 53 (FIGS. 113, 114, and 115). Wherein, a top-plug portion or first top-half of the beforementioned female bridge-connector 124, 129 (FIGS. 113, 114, and 115) comprises a 32-bit thirty-two spring-contact Polymer flex-cable female-connector 121, 128 (FIGS. 113, 114, and 115), a female bridge-connector's sealing-gasket 120 (FIGS. 113, 114, and 115), and a female bridge-connector's two installation hex-screws 122 (FIGS. 113, 114, and 115).

Moreover, the aforesaid top-plug portions of the beforementioned two female bridge-connectors 124, 129 (FIGS. 113, 114, and 115) are to be installed into two slot-holes, which were previously created in the bottom-half of a casting-base's component mounting base-plate 12 (FIGS. 113, 114, and 115), which is opposite to the previously mentioned LIMDOW and MSR Magneto-Optical Microhead Array Chip Hard Disk Drive's front-end (FIGS. 113, 114, and 115). Moreover, the previously mentioned top-plug portions of the beforementioned female bridge-connectors 124, 129 (FIGS. 113, 114, and 115) are connected, using a female bridge-connector's two hex-screws 122 (FIGS. 113, 114, and 115), to the inside top-surface of the bottom-half of the beforementioned casting-base's component mounting base-plate 12 (FIGS. 113, 114, and 115).

Furthermore, in addition to the beforementioned top-plug portion or first-half of the beforementioned female bridge-connector 124, 129 (FIGS. 113, 114, and 115) is a bottom-plug portion or second-half of the beforementioned female bridge-connector 124, 129 (FIGS. 113, 114, and 115), which comprises a thirty-two pin micro-plug female-connector 125, 130 (FIGS. 113, 114, and 115), which has an install location identical to the install location of its companion top-plug portion 124, 129 (FIGS. 113, 114, and 115). Moreover, the beforementioned two female bridge-connectors 124, 129 (FIGS. 113, 114, and 115) are used to connect a LIMDOW and MSR Magneto-Optical Microhead Array Chip Hard Disk Drive's chip-positioning circuit boards, as illustrated in FIGS. 29, 30, 31, 32, 33, 34, 35, 36, 37, and 38, to a Disk Controller's two thirty-two pin micro-plug male connectors 65, 69 (FIG. 4) 77, 79 (FIG. 5). The previously mentioned micro-plug male connectors 65 (FIG. 114) are located on the top-surfaces of Disk Controller PCB unit-assemblies 53 (FIGS. 113, 114, and 115), which also face toward a Spindle-Motor's flanged mounting-base 12 (FIGS. 113, 114, and 115). The top-plug portions of the beforementioned female bridge-connectors 124, 129 (FIGS. 113, 114, and 115) each comprise eight 32-bit thirty-two spring-contact Polymer flex-cable female connectors 121, 128 (FIGS. 113, 114, and 115).

In addition, every female bridge-connector 124, 129 (FIGS. 113, 114, and 115) installed into a LIMDOW and MSR Magneto-Optical Microhead Array Chip Hard Disk Drive has two sealing-gaskets 120 (FIGS. 113, 114, and 115), which are used for sealing a LIMDOW and MSR Magneto-Optical Microhead Array Chip Hard Disk Drive's interior-space from any air-borne particles existing in the air outside a LIMDOW and MSR Magneto-Optical Microhead Array Chip Hard Disk Drive's enclosed interior-space.

Moreover, the sealing gaskets 120 (FIG. 113) will tightly seal the surface lying areas between a female bridge-connector's top-plug and bottom-plug portions and a female bridge-connector's installation slot-holes. Moreover, the sealing gaskets 120 (FIG. 113) will also protect a LIMDOW and MSR Magneto-Optical Microhead Array Chip Hard Disk Drive's enclosed interior environment from air-borne dust and/or particle contamination. Furthermore, the beforementioned female bridge-connectors 124, 129 (FIGS. 113, 114, and 115) are fastened to a LIMDOW and MSR Magneto-Optical Microhead Array Chip Hard Disk Drive's casting-base 12 (FIGS. 113, 114, and 115) using two female bridge-connector threaded hex-screws 122 (FIGS. 113, 114, and 115).

Furthermore, the top-plug portion or first-half of the previously mentioned female bridge-connectors 124, 129 (FIGS. 113, 114 and 115) provides separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and a LIMDOW and MSR Magneto-Optical Microhead Array Chip Hard Disk Drive's chip-positioning circuit boards, illustrated by FIGS. 29, 30, 31, 32, 33, 34, 35, 36, 37, and 38, and their respective LIMDOW or MSR Magneto-Optical Microhead Array Chips (FIGS. 29, 31, 34, and 36). Moreover, the separate and dedicated connectivity between the previously mentioned bus-system and Disk Controller is executed through two primary bus-system Polymer flex-cables 126, 127 (FIGS. 113, 114, and 115), which are physically connected, using the beforementioned two female bridge-connector's top-plug portions 124, 129 (FIG. 113), to a first chip-positioning circuit board's two bottom Polymer flex-cable connectors 67 (FIGS. 114 and 115).

Furthermore, the first chip-positioning circuit board to be installed into a LIMDOW and MSR Magneto-Optical Microhead Array Chip Hard Disk Drive's unit-assembly (FIG. 112) is positioned by eighteen “Titanium” alloy circuit-board spacers 66 (FIGS. 113, 114, and 115), a casting-base 12 (FIGS. 113, 114, and 115), and eighteen hex-screw bolt-pedestals 61, 64 (FIGS. 113, 114, and 115). Moreover, eighteen chip-positioning circuit board spacers 66 (FIGS. 113, 114, and 115) are also used to install each proceeding chip-positioning circuit board into a LIMDOW and MSR Magneto-Optical Microhead Array Chip Hard Disk Drive's unit-assembly, illustrated by FIG. 112. The last chip-positioning circuit board assembly, as illustrated in FIGS. 2, 3, 36, 37, 38, and 112, which is installed into a LIMDOW and MSR Magneto-Optical Microhead Array Chip Hard Disk Drive's unit-assembly (FIG. 112) and locked into place 66 (FIGS. 113, 114, and 115) with eighteen chip-positioning circuit board's hex-screws 50 (FIGS. 113, 114, and 115).

Installation of all chip-positioning circuit boards into a LIMDOW and MSR Magneto-Optical Microhead Array Chip Hard Disk Drive's unit-assembly (FIG. 112) is finally accomplished when the beforementioned chip-positioning circuit board's eighteen installation hex-screws 50 (FIGS. 113, 114, and 115) are first inserted into and through a last chip-positioning circuit board's hex-screw holes 51 (FIGS. 113, 114, and 115), while continuing with the insertion of the beforementioned chip-positioning circuit board hex-screws 50 through all chip-positioning circuit board spacers and spacer holes 66 (FIGS. 113, 114, and 115) until they reach the hex-screw holes 51 (FIGS. 113, 114, and 115) then, afterwards threading the beforementioned chip-positioning circuit board hex-screws 50 (FIGS. 113, 114, and 115) into a casting-base's eighteen hex-screw bolt-pedestals 61, 64 (FIGS. 114 and 115), which are located on the upward facing outer-surface of a casting-base component mounting base-plate's bottom-half area 13 (FIGS. 113, 114, and 115).

Moreover, the threaded hex-screws 50 (FIGS. 113, 114, and 115) are tightened into place by turning them clockwise with a torque hex-wrench into the eighteen hex-screw bolt-pedestals 61, 64 (FIGS. 113, 114, and 115) of a casting-base, which are located on the top outer-surface of the component mounting base-plate's bottom-half 13 (FIGS. 113, 114, and 115), which will secure all of the previously mentioned chip-positioning circuit boards into their final and stationary positions, as illustrated in FIGS. 113, 114, and 115.

In addition, chip-positioning circuit board assemblies, as illustrated in drawing FIGS. 113, 114, 115, 116 and 117, are used in the LIMDOW and MSR Magneto-Optical Microhead Array Chip Hard Disk Drive design to place the LIMDOW or MSR Magneto-Optical Microhead Array Chips into stationary positions above respective disk-platter data-surfaces 13 (FIGS. 113, 114, and 115). Moreover, with the first chip-positioning circuit board having a top-installed “Bottom Surface LIMDOW or MSR Magneto-Optical Microhead Array Chip” is installed into a stationary position above a LIMDOW and MSR Magneto-Optical Microhead Array Chip Hard Disk Drive's disk-platter one, data-surface one 13 (FIGS. 113, 114, and 115).

In addition, the first chip-positioning circuit board will provide system connectivity through its two bottom Polymer flex-cable connectors 67 (FIGS. 113, 114, and 115), which are located closest to a LIMDOW and MSR Magneto-Optical Microhead Array Chip Hard Disk Drive's casting-base 12 (FIGS. 113, 114, and 115), where connectivity is accomplished using two bus-system Polymer flex-cables 126, 127 (FIGS. 113, 114, and 115), which are inserted into the bottom two 32-bit spring-contact flex-cable connectors 67 (FIGS. 114 and 115) of the first chip-positioning circuit board.

Moreover, chip-positioning circuit board spring-contact flex-cable connectors are ultimately used to connect a two separate Polymer flex-cables 126, 127 to each of the installed chip-positioning circuit board assemblies used in a LIMDOW and MSR Magneto-Optical Microhead Array Chip Hard Disk Drive's unit-assembly (FIG. 112) into a LIMDOW and MSR Magneto-Optical Microhead Array Chip Hard Disk Drive's bus-system. Moreover, the two female bridge-connectors 124, 129 (FIGS. 114 and 115), which are located on the inside-bottom surface of a LIMDOW and MSR Magneto-Optical Microhead Array Chip Hard Disk Drive's casting-base 12 (FIGS. 113, 114, and 115) are used to connect to a Disk Controller's two “32-pin” mini-plug male connectors, which are located on the Disk Controller's PCB 65 (FIG. 114), through two rectangular shaped slot-holes located in the bottom-half of the casting-base's component mounting base-plate 12 (FIGS. 113, 114, and 115).

In addition, the second chip-positioning circuit board installed into a LIMDOW and MSR Magneto-Optical Microhead Array Chip Hard Disk Drive's unit-assembly (FIG. 112) is an “In-between Disk-Platter” chip-positioning circuit board assembly, as illustrated by FIGS. 29, 30, 31, and 32, shows a bottom-installed “Top-surface LIMDOW or MSR Magneto-Optical Microhead Array Chip” (FIG. 25) as being put into position for disk-platter one, data-surface two, while displaying a top-installed “Bottom Surface LIMDOW or MSR Magneto-Optical Microhead Array Chip” (FIG. 28) as being put into position for disk-platter two, data-surface one.

Furthermore, a second chip-positioning circuit board's bottom two Polymer flex-cables 126, 127 (FIGS. 113, 114, and 115) are used to connect the second chip-positioning circuit board's bottom-installed “Top-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the second chip-positioning circuit board's bottom-installed “Top-surface LIMDOW or MSR Magneto-Optical Microhead Array Chip” (FIG. 25).

Furthermore, a second chip-positioning circuit board's top two Polymer flex-cables 126, 127 (FIGS. 113, 114, and 115) are used to connect the second chip-positioning circuit board's top-installed “Bottom-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the second chip-positioning circuit board's bottom-installed “Bottom-surface LIMDOW or MSR Magneto-Optical Microhead Array Chip” (FIG. 25).

In addition, the third chip-positioning circuit board installed into a LIMDOW and MSR Magneto-Optical Microhead Array Chip Hard Disk Drive's unit-assembly (FIG. 112) is an “In-between Disk-Platter” chip-positioning circuit board assembly, as illustrated by FIGS. 29, 30, 31, and 32, shows a bottom-installed “Top-surface LIMDOW or MSR Magneto-Optical Microhead Array Chip” (FIG. 25) as being put into position for disk-platter two, data-surface two, while displaying a top-installed “Bottom Surface LIMDOW or MSR Magneto-Optical Microhead Array Chip” (FIG. 28) as being put into position for disk-platter three, data-surface one.

Furthermore, a third chip-positioning circuit board's bottom two Polymer flex-cables 126, 127 (FIGS. 113, 114, and 115) are used to connect the third chip-positioning circuit board's bottom-installed “Top-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the third chip-positioning circuit board's bottom-installed “Top-surface LIMDOW or MSR Magneto-Optical Microhead Array Chip” (FIG. 25).

Furthermore, a third chip-positioning circuit board's top two Polymer flex-cables 126, 127 (FIGS. 113, 114, and 115) are used to connect the third chip-positioning circuit board's top-installed “Bottom-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the third chip-positioning circuit board's bottom-installed “Bottom-surface LIMDOW or MSR Magneto-Optical Microhead Array Chip” (FIG. 25).

In addition, the fourth chip-positioning circuit board installed into a LIMDOW and MSR Magneto-Optical Microhead Array Chip Hard Disk Drive's unit-assembly (FIG. 112) is an “In-between Disk-Platter” chip-positioning circuit board assembly, as illustrated by FIGS. 29, 30, 31, and 32, shows a bottom-installed “Top-surface LIMDOW or MSR Magneto-Optical Microhead Array Chip” (FIG. 25) as being put into position for disk-platter three, data-surface two, while displaying a top-installed “Bottom Surface LIMDOW or MSR Magneto-Optical Microhead Array Chip” (FIG. 28) as being put into position for disk-platter four, data-surface one.

Furthermore, a fourth chip-positioning circuit board's bottom two Polymer flex-cables 126, 127 (FIGS. 113, 114, and 115) are used to connect the fourth chip-positioning circuit board's bottom-installed “Top-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the fourth chip-positioning circuit board's bottom-installed “Top-surface LIMDOW or MSR Magneto-Optical Microhead Array Chip” (FIG. 25).

Furthermore, a fourth chip-positioning circuit board's top two Polymer flex-cables 126, 127 (FIGS. 113, 114, and 115) are used to connect the fourth chip-positioning circuit board's top-installed “Bottom-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the fourth chip-positioning circuit board's bottom-installed “Bottom-surface LIMDOW or MSR Magneto-Optical Microhead Array Chip” (FIG. 25).

In addition, the fifth chip-positioning circuit board installed into a LIMDOW and MSR Magneto-Optical Microhead Array Chip Hard Disk Drive's unit-assembly is a “Last Disk Platter” chip-positioning circuit board assembly, as illustrated by FIGS. 36, 37, and 38, which displays a bottom-installed “Top-surface LIMDOW or MSR Magneto-Optical Microhead Array Chip” (FIG. 25) as being put into position for disk-platter four, data-surface two.

Furthermore, a fifth chip-positioning circuit board's bottom two Polymer flex-cables 126, 127 (FIGS. 113, 114, and 115) are used to connect the fifth chip-positioning circuit board's bottom-installed “Top-surface LIMDOW or MSR Magneto-Optical Microhead Array Chip” (FIG. 25) to the top-plug portion or first-half of the previously mentioned female bridge-connectors 124, 129 (FIGS. 113, 114 and 115), which in turn will provide a separate and dedicated connectivity between a LIMDOW and MSR Magneto-Optical Microhead Array Chip Hard Disk Drive's bus-system, a LIMDOW and MSR Magneto-Optical Microhead Array Chip Hard Disk Drive's Disk Controller, and the fifth chip-positioning circuit board's bottom-installed “Top-surface LIMDOW or MSR Magneto-Optical Microhead Array Chip” (FIG. 25).

In addition, the last two Polymer flex-cable connectors 29, 44 (FIGS. 113, 114, and 115) are not Polymer flex-cable connectors at all, but are in reality Polymer flex-cable connector termination-caps. Moreover, the termination-caps are located on the topside surface of the fifth and last chip-positioning circuit board used in a LIMDOW and MSR Magneto-Optical Microhead Array Chip Hard Disk Drive's unit-assembly, as illustrated in FIG. 112. The fastening of the fifth chip-positioning circuit board's two termination-caps 29, 44 (FIGS. 113, 114, and 115) to the fifth and last chip-positioning circuit board's topside surface is accomplished with four threaded flex-cable connector hex-screws 37 (FIGS. 113, 114, and 115).

Additional Embodiments, as illustrated in FIGS. 113 through 141, also describes a “Magneto-Optical Microhead Array Chip, Internal Data-Striping, And Hard Disk Drive Controller” and “I/O Controller And Target Channel Adapter Interface”, which are two major printed circuit board 53 (FIGS. 113, 114, and 115) components that comprise a Disk Controller used by the dedicated multichannel microhead array chip bus-system LIMDOW and MSR Magneto-Optical Microhead Array Chip Hard Disk Drive design. Components located on a printed circuit board 53 (FIGS. 113, 114, and 115), which is installed onto the bottom of a LIMDOW and MSR Magneto-Optical Microhead Array Chip Hard Disk Drive's casting-base 12 (FIGS. 1, 2, and 3). The Disk Controller used by a dedicated multichannel microhead array chip bus-system will control installed LIMDOW or MSR Magneto-Optical Microhead Array Chips through sixteen “32-pin” mini-plug male connectors 65 (FIGS. 114 and 115). Moreover, the sixteen “32-pin” mini-plug male connectors 65 (FIGS. 114 and 115) will connect to sixteen “32-pin” mini-plug female bridge-connectors 130 (FIGS. 114), which are located at the bottom area of a casting-base's component mounting base-plate 12 (FIG. 114). The Disk Controller's PCB is attached to a LIMDOW and MSR Magneto-Optical Microhead Array Chip Hard Disk Drive's casting-base 12 (FIGS. 113, 114, and 115) with six PCB mounting hex-screws 54 (FIGS. 114 and 115). Moreover, the previously mentioned six PCB mounting hex-screws 54 are inserted through a Disk Controller's six PCB hex-screw holes 70 (FIGS. 4 and 5), and screwed clockwise into the previously mentioned six PCB hex-screw holes, which are located around the bottom edge areas 16 (FIGS. 113, 114, and 115) of a LIMDOW and MSR Magneto-Optical Microhead Array Chip Hard Disk Drive's casting-base 12 (FIGS. 113, 114, and 115).

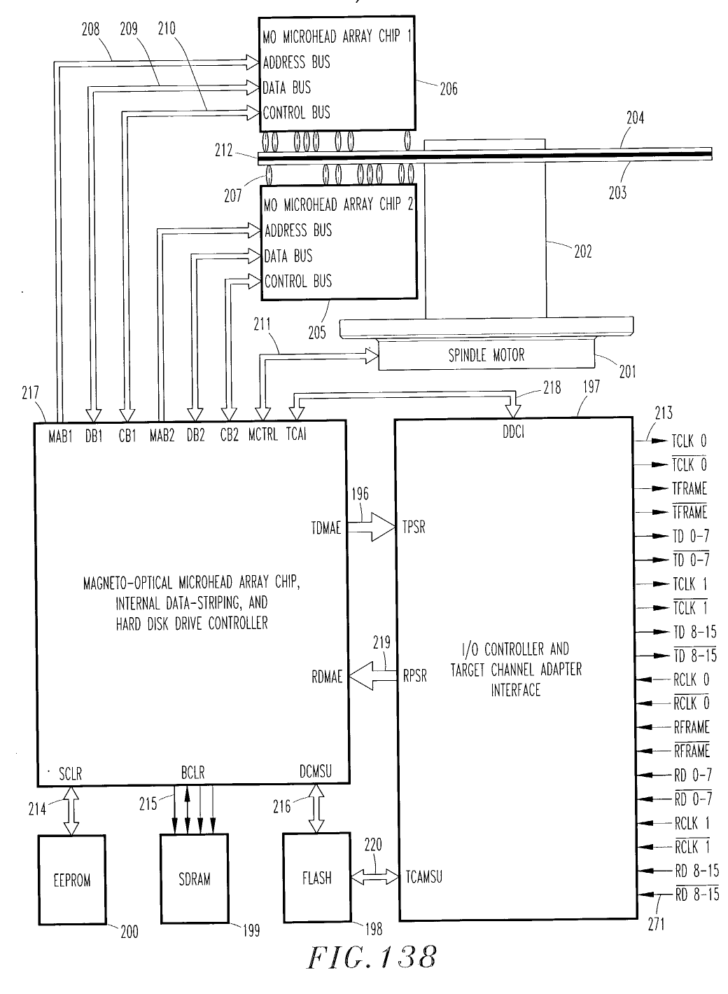

In addition, a Disk Controller's PCB has attached at its center, four metal circuit-contacts 58 (FIGS. 4 and 5). The previously mentioned metal circuit-contacts 58 are used by a Spindle And Power Controller's driver circuitry to communtate with a Spindle-Motor and its hall-sensor circuits (i.e., not shown here). Furthermore, when the Disk Controller's PCB unit-assembly is installed onto a dedicated multichannel microhead array chip bus-system LIMDOW and MSR Magneto-Optical Microhead Array Chip Hard Disk Drive's casting-base 12 (FIGS. 113, 114, and 115) the four metal circuit-contacts 58 will make a connection with the previously mentioned Spindle And Power Controller's driver circuitry through circuit-contacts located on a Polymer circuit-trace substrate flex-cable 211 (FIG. 138), which is located at the bottom of a Spindle-Motor's stator housing 59, 202 (FIGS. 113, 114, 115, and 138). Using the beforementioned four circuit-contacts 58, all of a Spindle-Motor's 59, 201 (FIGS. 113, 114, 115, and 138) velocity and radial positioning control, along with its hall sensor monitoring signals, will be sent by two-way communication, through a Spindle-Motor's Polymer circuit-trace substrate-cable 211 (FIG. 138) to and from the previously mentioned PCB's circuit-contacts 53 (FIGS. 114 and 115), and back again to a dedicated multichannel microhead array chip bus-system LIMDOW and MSR Magneto-Optical Microhead Array Chip Hard Disk Drive's “Spindle-Motor” 59, 201 (FIGS. 113, 114, 115, and 138). Moreover, a Disk Controller's PCB unit-assembly is used in a dedicated multichannel microhead array chip bus-system LIMDOW and MSR Magneto-Optical Microhead Array Chip Hard Disk Drive's unit-assembly to contain and install most of a dedicated multichannel microhead array chip bus-system LIMDOW and MSR Magneto-Optical Microhead Array Chip Hard Disk Drive's electronics. A Disk Controller's PCB unit-assembly consists of two main (VLSI) “Very Large Scale Integration” surface-mounted microprocessors.

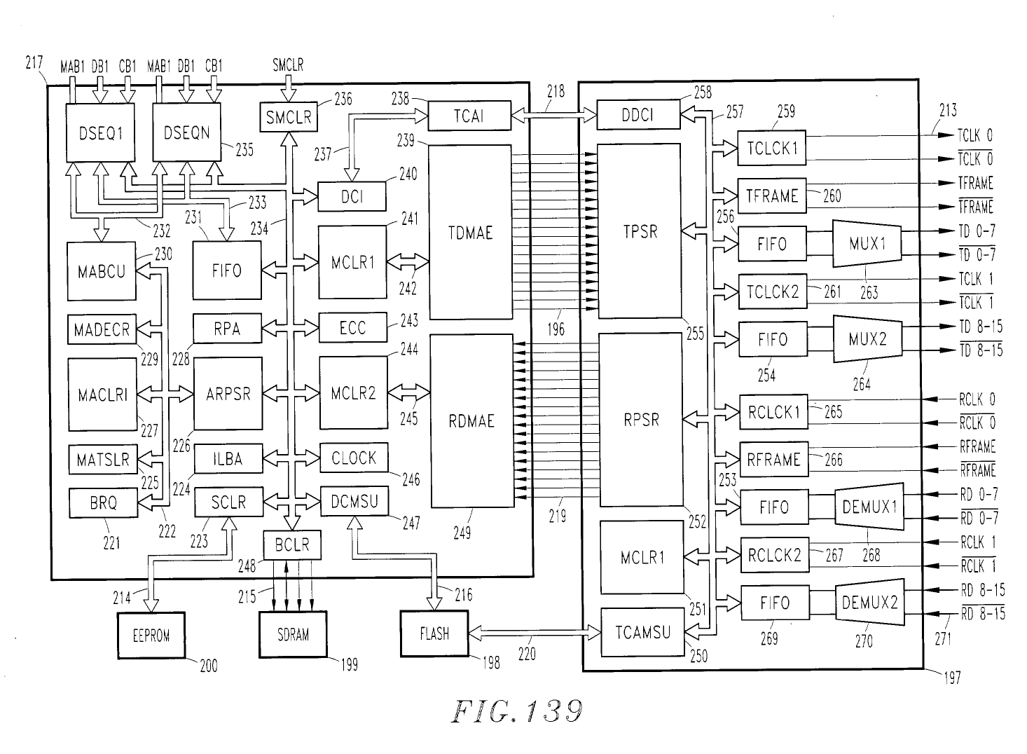

Furthermore, the previously mentioned VLSI components include an “I/O Controller And Target Channel Adapter Interface” 197 (FIGS. 138 and 139) and a “Magneto-Optical Microhead Array Chip, Internal Data-Striping, And Hard Disk Drive Controller” 217 (FIGS. 138 and 139), which reside on a Disk Controller's PCB unit-assembly. However, the electronics used by every installed LIMDOW or MSR Magneto-Optical Microhead Array Chip to control functions like “Microhead-Addressing and Selection” are all built into the LIMDOW or MSR Magneto-Optical Microhead Array Chips themselves.

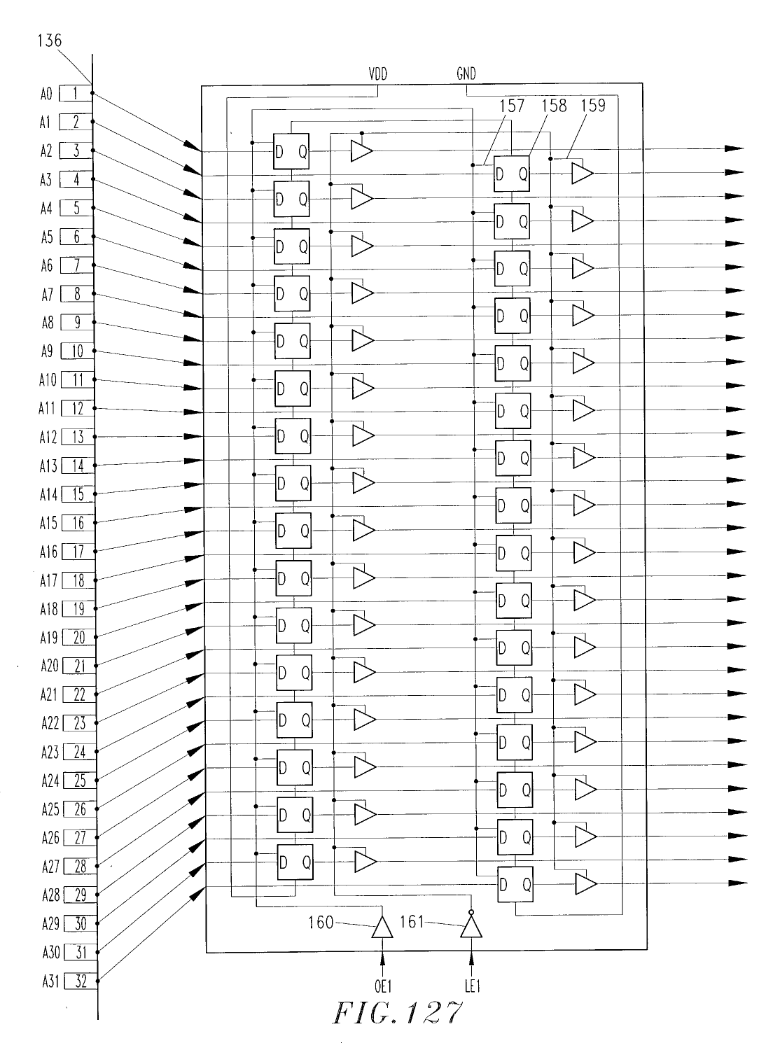

Furthermore, the integration that occurs between the microhead array of a dedicated multichannel microhead array chip bus-system LIMDOW or MSR Magneto-Optical Microhead Array Chip and a dedicated multichannel microhead array chip bus-system LIMDOW or MSR Magneto-Optical Microhead Array Chip's internal circuitry significantly improves the “signal-to-noise” ratio of the output-signals being created by the dedicated multichannel microhead array chip bus-system LIMDOW or MSR Magneto-Optical Microhead Array Chips. Moreover, as illustrated in FIGS. 138 and 139, the multiple data-stream signals created then output to a dedicated multichannel microhead array chip bus-system LIMDOW or MSR Magneto-Optical Microhead Array Chip's multiple read-channel (FIG. 125) are transported using dedicated data-bus system lines to a dedicated multichannel microhead array chip bus-system LIMDOW and MSR Magneto-Optical Microhead Array Chip Hard Disk Drive Disk Controller and the plurality of Data-Sequencers it uses in multichanneled signal processing. The Block-diagram, illustrated in FIG. 138, is used to represent the general connectivity between components used in a dedicated multichannel microhead array chip bus-system LIMDOW and MSR Magneto-Optical Microhead Array Chip Hard Disk Drive's design, while the block-diagram, illustrated in FIG. 139, is used to represent the general connectivity between the “Magneto-Optical Microhead Array Chip, Internal Data-Striping, And Hard Disk Drive Controller” and the “I/O Controller And Target Channel Adapter Interface” components, which are the main VLSI microprocessors that make up a dedicated multichannel microhead array chip bus-system LIMDOW and MSR Magneto-Optical Microhead Array Chip Hard Disk Drive's Disk Controller 53 (FIGS. 114 and 115).

Furthermore, a VLSI component, which is called a “Magneto-Optical Microhead Array Chip, Internal Data-Striping, And Hard Disk Drive Controller” 217 (FIGS. 138 and 139) is presented here to provide, while under program control, local microprocessor services to a dedicated multichannel microhead array chip bus-system LIMDOW and MSR Magneto-Optical Microhead Array Chip Hard Disk Drive. Furthermore, a “Magneto-Optical Microhead Array Chip, Internal Data-Striping, And Hard Disk Drive Controller” 217 (FIGS. 138 and 139) is also presented here to manage the various resources of a dedicated multichannel microhead array chip bus-system LIMDOW and MSR Magneto-Optical Microhead Array Chip Hard Disk Drive's other PCB electronic-units. Including, a “Serial EEPROM” 200 (FIGS. 138 and 139), a “SDRAM Buffer” 199 (FIGS. 138 and 139), and a “Serial Flash VDRAM” 198 (FIGS. 138 and 139).

In addition, the previously mentioned “Magneto-Optical Microhead Array Chip, Internal Data-Striping, And Hard Disk Drive Controller” 217 (FIG. 138 and 139) will communicate serially with a “Serial EEPROM” firmware chip 200 (FIGS. 138 and 139), which contains operational program code used by a dedicated multichannel microhead array chip bus-system LIMDOW and MSR Magneto-Optical Microhead Array Chip Hard Disk Drive to conduct various disk and data I/O operations. Primarily, the previously mentioned “Magneto-Optical Microhead Array Chip, Internal Data-Striping, And Hard Disk Drive Controller” 217 (FIG. 138 and 139) will execute the previously mentioned program code to complete hard disk drive power-on-resets, spin-ups, and re-calibration procedures. In addition, the previously mentioned “Magneto-Optical Microhead Array Chip, Internal Data-Striping, And Hard Disk Drive Controller” 217 (FIG. 138 and 139) will also, during a dedicated multichannel microhead array chip bus-system LIMDOW and MSR Magneto-Optical Microhead Array Chip Hard Disk Drive's normal operation, read additional operational control code from a disk-platter 204, 205 (FIG. 139), data-surface and store it in a Disk Controller's memory buffer, which is comprised as (SDRAM) “Synchronous Dynamic Random Access Memory” 199 (FIG. 138 and 139).

Furthermore, the previously mentioned operational control code is typically called (Opcode) “Operational Code” and is used in much the same way as a host-computer's microprocessor might use a host-computer's disk-stored (OS) “Operation System” software to execute system wide operations. Moreover, the previously mentioned “Magneto-Optical Microhead Array Chip, Internal Data-Striping, And Hard Disk Drive Controller” 217 (FIGS. 138 and 139), which is used as a synchronous device on a Disk Controller's PCB 217 (FIGS. 138 and 139). In addition, the Serial EEPROM 200 (FIGS. 138 and 139), will run as an asynchronous device, while a Disk Controller's (SDRAM) “Synchronous Dynamic Random Access Memory” 199 (FIGS. 139 and 140) will run as the Disk Controller's synchronous memory buffer with synchronous addressing control, synchronous data I/O busing control, and synchronous control-bus operational control.

Moreover, a “Magneto-Optical Microhead Array Chip, Internal Data-Striping, And Hard Disk Drive Controller” 217 (FIGS. 138 and 139), will provide control-functions throughout the dedicated multichannel microhead array chip bus-system based LIMDOW and MSR Magneto-Optical Microhead Array Chip Hard Disk Drives. In addition, a “Magneto-Optical Microhead Array Chip, Internal Data-Striping, And Hard Disk Drive Controller” 217 (FIG. 139), also has a block-diagram that illustrates the various internal component modules it uses, while displaying their connectivity 217 (FIG. 139). The previously mentioned block-diagram (FIG. 139) also illustrate how each of a “Magneto-Optical Microhead Array Chip, Internal Data-Striping, And Hard Disk Drive Controller” 217 (FIGS. 138 and 139) internal modules interconnect and communicate with one another to form and facilitate a dedicated multichannel microhead array chip bus-system LIMDOW and MSR Magneto-Optical Microhead Array Chip Hard Disk Drive's control system.

Furthermore, a “Magneto-Optical Microhead Array Chip, Internal Data-Striping, And Hard Disk Drive Controller” 217 (FIGS. 138 and 139) has an internal (ECC) “Error Correction Control” system module 243 (FIG. 139) built into it. The Error Correction Codes executed during host-requested read-data or write-data disk-operations that are used by a “Magneto-Optical Microhead Array Chip, Internal Data-Striping, And Hard Disk Drive Controller” 217 (FIGS. 138 and 139) are based upon a Reed-Solomon encoder/decoder circuit's calculated error results.

Furthermore, the previously mentioned “Magneto-Optical Microhead Array Chip, Internal Data-Striping, And Hard Disk Drive Controller” 217 (FIGS. 138 and 139) has a plurality of “Data Sequencers” 235 (FIG. 139) (i.e., sometimes called a Data-Formatter) built into it. Wherein, each of the Data Sequencers that make up the previously mentioned plurality of Data Sequencers, as illustrated in FIG. 139, is used to control the operation of an equal number of read and the write-channels of used within a dedicated multichannel microhead array chip bus-system LIMDOW and MSR Magneto-Optical Microhead Array Chip Hard Disk Drive.

In addition, to initiate a host-requested disk-operation a “Magneto-Optical Microhead Array Chip, Internal Data-Striping, And Hard Disk Drive Controller” 217 (FIGS. 138 and 139) will load a set of commands into a “Writable Control Store Register”, where the loading and manipulation of this register is done through a “Magneto-Optical Microhead Array Chip, Internal Data-Striping, And Hard Disk Drive Controller's” 217 (FIGS. 138 and 139) internal “Interface Registers”, which is located internally within its (ARPSR) “Arm RISC Processor” 226 (FIG. 139).

Moreover, as illustrated in FIG. 139, each Data-Sequencer contained within a Magneto-Optical Microhead Array Chip, Internal Data-Striping, And Hard Disk Drive Controller's 217 (FIGS. 138 and 139) plurality of Data Sequencers 235 (FIG. 139) has direct control over its own (MAB) “Microhead Address-Bus” output, a (DB) “Data I/O-Bus” input/output, a (CB) “Control-Bus” output.

In addition, “Magneto-Optical Microhead Array Chip, Internal Data-Striping, And Hard Disk Drive Controller” 217 (FIGS. 138 and 139) has a (BCLR) “Buffer Controller” built into itself 248 (FIG. 139). Moreover, the previously mentioned (BCLR) “Buffer Controller” 248 (FIG. 139), illustrated by FIG. 139, will support a “1-Gbyte SDRAM” buffer-cache. Moreover, a 128-bit wide implementation of this “buffer-cache” provides a “30” GB/s of maximum buffer bandwidth to a dedicated multichannel microhead array chip bus-system based LIMDOW and MSR Magneto-Optical Microhead Array Chip Hard Disk Drive's I/O systems 197 (FIGS. 138 and 139).

Consequently, this increase in bandwidth will allow a “Magneto-Optical Microhead Array Chip, Internal Data-Striping, And Hard Disk Drive Controller” 217 (FIGS. 138 and 139) to have direct access to the buffer itself, eliminating the need for a separate buffer (SDRAM) “Synchronous Dynamic Random Access Memory” resource controller. Moreover, a Magneto-Optical Microhead Array Chip, Internal Data-Striping, And Hard Disk Drive Controller's 217 (FIGS. 138 and 139) (BCLR) “Buffer Controller” 248 (FIG. 139) operates internally under the direction of the (ARPSR) “Arm RISC Processor” 226 (FIG. 139).

In addition, a “Magneto-Optical Microhead Array Chip, Internal Data-Striping, And Hard Disk Drive Controller” 217 (FIGS. 138 and 139) will have a (TCAI) “Target Channel Adapter Interface” 238 (FIG. 139) built into itself. The previously mentioned (TCAI) “Target Channel Adapter Interface” 238 (FIG. 139), by interfacing with the (DDCI) “Disk Drive Controller Interface” 258 (FIG. 139), will provide the means for the “Magneto-Optical Microhead Array Chip, Internal Data-Striping, And Hard Disk Drive Controller” 217 (FIGS. 138 and 139) to read and write (Opcode) “Operational Code” and user data to and from itself and the “I/O Controller And Target Channel Adapter Interface” 197 (FIGS. 138 and 139). Wherein, communication between the (TCAI) “Target Channel Adapter Interface” 238 (FIG. 139) and the (DDCI) “Disk Drive Controller Interface” 258 (FIG. 139) is necessary to control the operations of both “Magneto-Optical Microhead Array Chip, Internal Data-Striping, And Hard Disk Drive Controller” 217 (FIGS. 138 and 139) and “I/O Controller And Target Channel Adapter Interface” 197 (FIGS. 138 and 139) modules, and to supply both modules with needed system information.

In addition, the (BCLR) “Buffer Controller” 248 (FIG. 139) operates consists of both physical and logical components. The physical components of the interface comprise a 32-bit Address-bus, a 128-bit Data-bus, (RD STROBE) “Read Strobe”, (WR STROBE) “Write Strobe” control lines, an (ALE) “Address Latch Enable” control line, and a (WAIT) “Wait” control line. While, the logical components of the previously mentioned (BCLR) “Buffer Controller” 248 (FIG. 139) comprise of “Internal Control Registers” and “Data Registers”, which are both accessible to the “Magneto-Optical Microhead Array Chip, Internal Data-Striping, And Hard Disk Drive Controller” 217 (FIGS. 138 and 139). Furthermore, by writing to and reading from the previously mentioned logical registers, a Disk Controller's “Magneto-Optical Microhead Array Chip, Internal Data-Striping, And Hard Disk Drive Controller” 217 (FIGS. 138 and 139) can control and configure a (BCLR) “Buffer Controller” 248 (FIG. 139).

In addition, a Disk Controller's “Magneto-Optical Microhead Array Chip, Internal Data-Striping, And Hard Disk Drive Controller” 217 (FIGS. 138 and 139) has an internal (SCLR) “Serial Controller” 223 (FIG. 139). The previously mentioned (SCLR) “Serial Controller” 223 (FIG. 139) will provide the “Magneto-Optical Microhead Array Chip, Internal Data-Striping, And Hard Disk Drive Controller” 217 (FIGS. 138 and 139) with an internal high-speed serial interface and pathway for firmware based operational control-code and data-streams. Wherein, the previously mentioned firmware's operational control-code and data-streams are transferred at high speeds between a firmware containing Serial EEPROM 200 (FIGS. 138 and 139) and a “Magneto-Optical Microhead Array Chip, Internal Data-Striping, And Hard Disk Drive Controller” 217 (FIGS. 138 and 139), through an executed control of the internal (SCLR) “Serial Controller” 223 (FIG. 139).

In addition, a “I/O Controller And Target Channel Adapter Interface” 197 (FIGS. 138 and 139) has a “System Wide Network” (SWN) interface 213, 271 (FIG. 138 and 139) that provides connectivity to a system wide network comprised with an architecture that is designed around a point-to-point, switched I/O fabric, whereby end node devices (i.e., which can range from very inexpensive I/O devices like single chip SCSI or Ethernet adapters to very complex host computers) are interconnected by cascaded switch devices. The physical properties of the previously mentioned architecture will interconnect and support two predominant environments, with bandwidth, distance, and cost optimizations appropriate for these environments:

i.) Module-to-module, as typified by computer systems that support I/O module add-in slots;

ii.) Chassis-to-chassis, as typified by interconnecting computers, external storage systems, and external LAN/WAN access devices (such as switches, hubs, and routers) in a data-center environment.

The architecture's switched fabric provides a reliable transport mechanism, where messages are enqueued for delivery between end nodes. In general, message content and meaning is not specified by the previously mentioned architecture, but rather is left to the designers of end node devices and the processes that are hosted on those end node devices. The previously mentioned architecture will define hardware transport protocols that are sufficient to support both reliable messaging (i.e., send/receive) and memory manipulation semantics (e.g., remote DMA) without software intervention in the data movement path.

In addition, the previously mentioned architecture will define protection and error detection mechanisms that permit the architecture's transactions to originate and terminate from either privileged kernel mode (i.e., to support legacy I/O and communication needs) or user space (i.e., to support emerging interprocess communication demands). The previously mentioned architecture's specification also addresses the need for a rich manageability infrastructure to support interoperability between multiple generations of components from many vendors over time. This infrastructure will provide an ease of use and consistent behavior for high volume, cost sensitive deployment environments. The previously mentioned architecture also specifies the interfaces for industry standard management that will interoperate with enterprise class management tools for configuration, asset management, error reporting, performance metric collection, and topology management necessary for data center deployment of the previously mentioned architecture.

The previously mentioned “I/O Controller And Target Channel Adapter Interface” 197 (FIGS. 138 and 139) will provide the data handling, the bus control, and the transfer management services to and from and its “System Wide Network” (SWN) interface 213, 271 (FIG. 138 and 139). The “Magneto-Optical Microhead Array Chip, Internal Data-Striping, And Hard Disk Drive Controller” 217 (FIGS. 138 and 139) executes the configuration and control over the “I/O Controller And Target Channel Adapter Interface” 197 (FIGS. 138 and 139) and its “System Wide Network” (SWN) interface 213, 271 (FIG. 138 and 139) across a 32-bit address-bus and 128-bit data-bus, while a Magneto-Optical Microhead Array Chip, Internal Data-Striping, And Hard Disk Drive Controller's 217 (FIGS. 138 and 139) “Buffer Controller” module controls all data-transfer operations within the beforementioned Disk Controller.

In addition, interfacing with a host-system is done through a 24-pin interface-connector (i.e., not shown here) for I/O Controller and Target Channel Adapter boards to the previously mentioned architecture's backplanes. These connectors are a one-piece design mounted on the backplane, into which the previously mentioned architecture's board is inserted. One example of a suitable connector is specified in a draft called: New Work Proposal to the International Electrotechnical Commission (IEC). The detailed connector specification is included in draft specification IEC 61076. Two connectors are defined, one type for use with 1X and 4X boards, and a second type for 12X boards. The previously mentioned architecture's boards and backplanes shall incorporate features shown in the appropriate sections below that specify the connector to board and connector to backplane interfaces. The 1X/4X and 12X connectors are externally identical, but the backplane footprint for the 1X/4X connector may have a reduced footprint from that used for the 12X connector if desired, due to the smaller number of contacts utilized. The board footprint for the connector contacts is the same in all cases.

Moreover, the board edge “paddle” which mates with the connector is covered by a “paddle guard”, a plastic shroud that fits over the paddle to protect the contacts during insertion and withdrawal of the board from the previously mentioned architecture's backplane connector. The paddle guard also serves to initiate closure of the connector housing when the board is inserted. It is the responsibility of the connector supplier to perform the indicated tests on any backplane connectors to be used for the previously mentioned architecture's boards and supply the data to potential customer companies to indicate compliance.

Moreover, the previously mentioned architecture's backplane connector is a low insertion force connector with two sets of contacts. One set of contacts is used on the primary side of the previously mentioned architecture's board for high-speed differential pair signals and their corresponding grounds. A second set of contacts is used on the secondary side of the board for low-speed signals, power, and ground. The 12X connector contains 24 pairs of high-speed contacts (i.e., 48 pins) and 18 low speed/power contacts. The 1X/4X connector contains eight pairs of high-speed contacts and the same number (i.e., 18) low speed/power contacts.

Moreover, closure of the mechanism that engages the high-speed contacts is achieved by an internal mechanism, which is actuated by outline features on the paddle guard. It is thus vitally important that the paddle guard outline not deviate from that described in the sections below. Sequencing of low speed/power contacts for hot insertion and withdrawal of boards is accomplished through the use of contact staggering, controlled by openings in the paddle guard. The mechanical, electrical, and environmental performance requirements for the previously mentioned architecture's backplane connectors are defined in the below sections.

FIG. 89, Backplane connector, and board paddle (a), paddle guard assembly (b) a b. Note that all drawing dimensions in the following sections are in millimeters (i.e., mm). The connector drawings contained in this document are intended for reference purposes only. The reader is encouraged to consult IEC specification 61076 and the respective supplier's drawings for detailed design information.

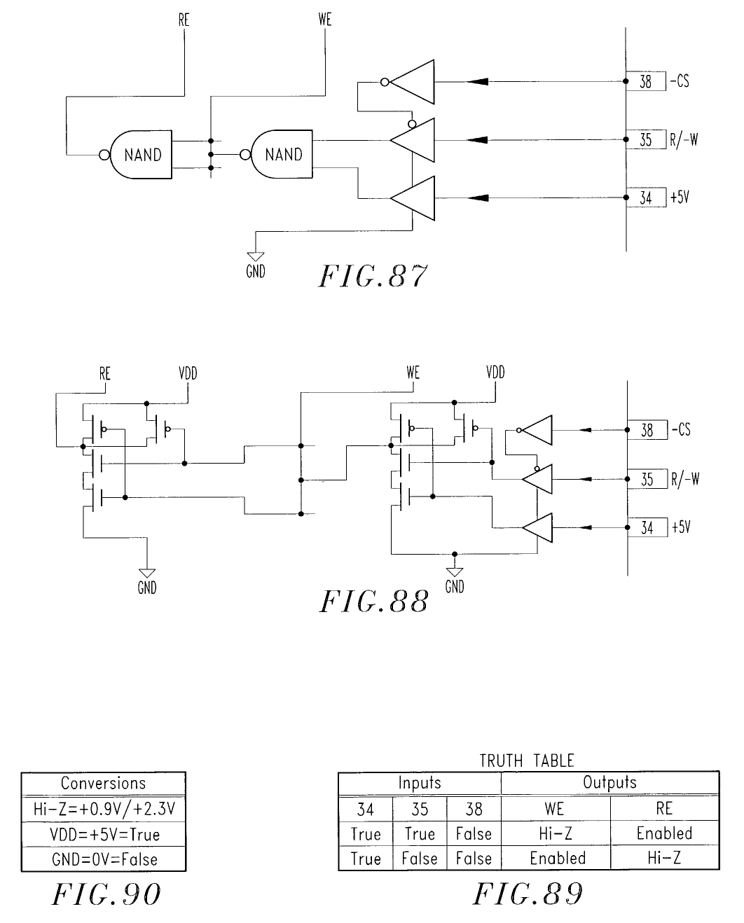

i.) The contact patterns shown in FIG. 90 shall be used on the primary side of the previously mentioned architecture's boards for high-speed contacts to the backplane connector.

ii.) The contact pattern shown in FIG. 91 shall be used on the secondary side of the previously mentioned architecture's boards for low-speed and power contacts.

iii.) The board paddle design shown in FIG. 92 shall be used on the previously mentioned architecture's boards to insure interoperability.

Moreover, as mentioned in the previous sections, the sequencing of signals for hot insertion and withdrawal is controlled by the openings in the paddle guard.

Furthermore, an “I/O Controller And Target Channel Adapter Interface” 197 (FIGS. 138 and 139) implements “System Wide Network” (SWN) 213, 271 (FIG. 138 and 139) interface-logic, while operating under a Magneto-Optical Microhead Array Chip, Internal Data-Striping, And Hard Disk Drive Controller's 217 (FIGS. 138 and 139) control. The “I/O Controller And Target Channel Adapter Interface” 197 (FIGS. 138 and 139) will receive and transmit words of data over the “System Wide Network” (SWN) 213, 271 (FIG. 138 and 139) bus, which connects directly into a switch controlled backplane.

The Magneto-Optical Microhead Array Chip, Internal Data-Striping, And Hard Disk Drive Controller's 217 (FIGS. 138 and 139) “Buffer Controller” 248 (FIG. 139) writes data to or reads data from the SDRAM buffer-cache 199 (FIGS. 138 and 139) over one-hundred and twenty-eight data lines 215 (FIGS. 138 and 139). While under the Magneto-Optical Microhead Array Chip, Internal Data-Striping, And Hard Disk Drive Controller's 217 (FIGS. 138 and 139) direction the “Buffer Controller” 248 (FIG. 139) controls the transfer of data and handles the addressing of a dedicated multichannel microhead array chip bus-system LIMDOW and MSR Magneto-Optical Microhead Array Chip Hard Disk Drive's cache 199 (FIGS. 138 and 139).

Moreover, the internal data transfer-rate to and from a dedicated multichannel microhead array chip bus-system LIMDOW and MSR Magneto-Optical Microhead Array Chip Hard Disk Drive's cache 199 (FIGS. 138 and 139) will be at “10” GB/s. In addition, these high-speed transfer-rates will allow the “I/O Controller And Target Channel Adapter Interface” 197 (FIGS. 138 and 139) to communicate over a “System Wide Network” (SWN) 213, 271 (FIG. 138 and 139) interfaces at a transfer-rate of 10-GB/s using a multiple of DMA channels. Furthermore, Magneto-Optical Microhead Array Chip, Internal Data-Striping, And Hard Disk Drive Controller 217 (FIGS. 138 and 139) simultaneously controls disk-to-buffer RAM transfers and microcontroller access to control-code stored in the buffer SDRAM's 74 (FIG. 4) memory during a data transference across the “System Wide Network” (SWN) 213, 271 (FIG. 138 and 139) interface.

In addition, a dedicated multichannel microhead array chip bus-system LIMDOW and MSR Magneto-Optical Microhead Array Chip Hard Disk Drive uses a serial connected and code containing Firmware chip, which is comprised of a “Flash EEPROM” chip that contains (Opcode) “Operational Code” 200 (FIGS. 138 and 139). The Firmware chip is connected to a dedicated multichannel microhead array chip bus-system LIMDOW and MSR Magneto-Optical Microhead Array Chip Hard Disk Drive's Magneto-Optical Microhead Array Chip, Internal Data-Striping, And Hard Disk Drive Controller 217 (FIGS. 138 and 139) through a high-speed serial connection 214. This device is programmable and controls various features like disk caching, track skewing, cylinder skewing, error detection, and error correction.

In addition, caching for dedicated multichannel microhead array chip bus-system LIMDOW and MSR Magneto-Optical Microhead Array Chip Hard Disk Drives will enhance hard disk drive performance and significantly improve system throughput. Through a dynamic caching scheme, like the one featured in the dedicated multichannel microhead array chip bus-system LIMDOW and MSR Magneto-Optical Microhead Array Chip Hard Disk Drive design, will make better use of the buffer SDRAM's memory areas 200 (FIGS. 138 and 139). With this dynamic caching feature, the buffer's memory space used during a read-data or write-data disk-operation will be dynamically allocated and controlled. The cache will be flexibly divided into several memory segments under program control with each memory segment containing one cache-entry. A cache-entry will consist of the requested read-data, plus its corresponding prefetch-data.

Consequently, dynamic segmentation will allow dedicated multichannel microhead array chip bus-system LIMDOW and MSR Magneto-Optical Microhead Array Chip Hard Disk Drives to make optimum use of their cache memory buffers. By allowing the amount of stored data to be increased or decreased, which ever is required; dynamically the dynamic-cache of dedicated multichannel microhead array chip bus-system LIMDOW and MSR Magneto-Optical Microhead Array Chip Hard Disk Drives will anticipate host-system or SWN requests for data and store that data for faster access. When a host-system or SWN requests a particular segment of data a dedicated multichannel microhead array chip bus-system LIMDOW and MSR Magneto-Optical Microhead Array Chip Hard Disk Drive's dynamic caching feature will use a prefetch strategy. A prefetch strategy looks ahead and automatically stores subsequent data from a particular disk-platter's data-surface into a high-speed buffer contained within the SDRAM 200 (FIGS. 138 and 139) memory area of the dedicated multichannel microhead array chip bus-system LIMDOW and MSR Magneto-Optical Microhead Array Chip Hard Disk Drive.

Moreover, since fifty-percent or more of all hard disk drive host-requested or SWN requested data-reads are sequential, the beforementioned host-system or SWN, more likely, will request the previously cached subsequent-data from the SDRAM 200 (FIGS. 138 and 139) memory buffer rather than from a particular data-surface sector area. Moreover, the beforementioned subsequent-data, being dynamically stored in high-speed cache, will be retrieved for use in microseconds, or even in nanoseconds, rather than in the more typical milliseconds. Consequently, the previously mentioned process of “Dynamic Caching” can provide substantial timesaving, during at least half of all dedicated multichannel microhead array chip bus-system LIMDOW and MSR Magneto-Optical Microhead Array Chip Hard Disk Drive data requests.

Furthermore, the use of “Dynamic Caching” will save most of the transaction time occurring for a dedicated multichannel microhead array chip bus-system LIMDOW and MSR Magneto-Optical Microhead Array Chip Hard Disk Drive by eliminating, in concert with microhead array chips that are controlled independently from each other, the “rotational latency delays” that dominate a typical disk transaction. The process of “Dynamic Caching” works by continuing to fill its memory areas with adjacent data, while transferring any data requested by the host-system or SWN. Unlike a non-caching Disk Controller, a Disk Controller used in a dedicated multichannel microhead array chip bus-system LIMDOW and MSR Magneto-Optical Microhead Array Chip Hard Disk Drive will continue on with further read-data disk operations after the requested-data has been transferred to a host-system or SWN, via the “System Wide Network” (SWN) 213, 271 (FIG. 138 and 139) interface. However, the previously mentioned read-data disk operations would terminate after a programmed amount of subsequent-data had been read into a buffered dynamic memory-segment of the beforementioned cache.

In addition, the cache memory will consist of (SDRAM) “Synchronous Dynamic Random Access Memory” 200 (FIGS. 138 and 139), which is allocated to hold data. Data that can be directly accessed by the host-system or SWN, by means of the (RDDATA) “Read Data” and the (WRDATA) “Write Data” commands. A buffer cache memory functions as a group of segments with rollover points at the end of each segment. The unit of data stored will be a logical block; i.e., for example a multiple of a 512-byte sector. All access to the buffer cache memory must be in multiples of “512” byte size sectors; i.e., for example “4096” byte size sectors. Furthermore, when a (WRDATA) “Write Data” command is executed a dedicated multichannel microhead array chip bus-system LIMDOW and MSR Magneto-Optical Microhead Array Chip Hard Disk Drive will store the data to be written in a SDRAM based cache buffer SDRAM 200 (FIGS. 138 and 139). The “Buffer Controller” 248 (FIG. 139) will immediately send a (GDDATA) “Good Data” status-message to the host-system or SWN before the data can actually be written to a disk-platter's data-surface. The host-system or SWN will then be free to move on to other tasks, such as preparing data for the next data-transfer, without having to wait for a dedicated multichannel microhead array chip bus-system LIMDOW and MSR Magneto-Optical Microhead Array Chip Hard Disk Drive to switch to a different microhead, located above the appropriate track, or rotate the disk-platters to the specified sector.

Furthermore, while the host-system or SWN is preparing data for the next data-transfer a dedicated multichannel microhead array chip bus-system LIMDOW and MSR Magneto-Optical Microhead Array Chip Hard Disk Drive will immediately write the cached data to a disk-platter's data-sector. This will usually complete a write-data disk operation in less than “20” milliseconds after issuing the (GDDATA) Good Data status-message. When writing data to the cache, a single-block random write, for example, typically requires only “3” milliseconds of host-system or SWN processing time to execute. Therefore, without the Disk Controller's ability to write data to the cache, the same write-operation would typically occupy the host-system or SWN for about “20” milliseconds.

In addition, writing data to cache memory dynamically allows the data to be transferred to a dedicated multichannel microhead array chip bus-system LIMDOW and MSR Magneto-Optical Microhead Array Chip Hard Disk Drive in a continuous flow, rather than as individual blocks of data separated by hard disk drive's access delays. This is achieved by taking advantage of a dedicated multichannel microhead array chip bus-system LIMDOW and MSR Magneto-Optical Microhead Array Chip Hard Disk Drive's ability to write blocks of data sequentially to data-surfaces that where formatted with a “1:1 hard disk drive interleave”. This means that as the last byte of data is transferred out of the write-cache and the selected diode laser or VCSEL microhead passes over the next sector of a disk-platter's data-sector the first byte of the next data-block will be transferred, causing no interruption, or delay in the data-transfer process. The write data to cache algorithm fills the cache buffer with new data from the host-system or SWN, while simultaneously transferring any data that the host-system or SWN had previously stored in the cache to the dedicated multichannel microhead array chip bus-system LIMDOW and MSR Magneto-Optical Microhead Array Chip Hard Disk Drive.

Furthermore, a dedicated multichannel microhead array chip bus-system LIMDOW and MSR Magneto-Optical Microhead Array Chip Hard Disk Drive without some kind of cache optimization would suffer, just as any conventional hard disk drive would, from delays during sequential reads, which occur simply because all hard disk drive designs exhibit “rotational latency”. Even if a single microhead selected within that same LIMDOW or MSR Magneto-Optical Microhead Array Chip's microhead array were above the desired data-track to be read “rotational latency” would still occur.

However, if multiple of microheads within the same array were to be used simultaneously along with cache optimization, and each microhead array chip installed within a drive were simultaneously used and independently controlled, a dedicated multichannel microhead array chip bus-system LIMDOW and MSR Magneto-Optical Microhead Array Chip Hard Disk Drive's rotational latency time would typically average a “0.01” milliseconds. Current hard disk drives often service requests from multiple processes in a multi-tasking or multi-user environment. In these instances, while each process might request-data sequentially, a current hard disk drive must time-share among all these processes. In conventional hard disk drive designs, the data-heads must move from one data-track location to another. With cache optimization, even if another process were to interrupt another the hard disk drive would continue to access the data sequentially from its high-speed cache memory. In handling multiple processes, and when the desired data resides in the cache, “cache memory optimization” will achieve its most impressive performance gains, saving on both seek and latency times.

Furthermore, the cache can be flexibly divided into several memory-segments, while under program control, with each memory-segment containing one cache-entry. A cache-entry would consist of requested read-data along with any corresponding prefetch-data. The requested read-data will only take up a certain amount of memory space in the cache-segment so the corresponding prefetch-data can essentially occupy the rest of the available memory space within the cache. Other factors determining prefetch size are the maximum and minimum prefetch settings determined by the “Buffer Controller” 248 (FIG. 139). A dedicated multichannel microhead array chip bus-system LIMDOW and MSR Magneto-Optical Microhead Array Chip Hard Disk Drive's prefetch algorithm will dynamically control the actual prefetch value, which is based upon the current demands with consideration for overhead to subsequent commands.

Another Firmware feature incorporated into a dedicated multichannel microhead array chip bus-system LIMDOW and MSR Magneto-Optical Microhead Array Chip Hard Disk Drive's Microhead Array Chips is “Track Skewing”. Track Skewing reduces the latency time that results from a hard disk drive's switching of a read or write data-head to access sequential data. A track skew is employed in such a way that the next logical sector of data to be accessed will be under the read or write microhead once the microhead switch has been made and that same data is ready to be accessed. When sequential-data is on the same cylinder/track, but on a different disk-surface, an electronically executed microhead switch would also need to be performed. Since sequential microhead switching times are well defined within the dedicated multichannel microhead array chip bus-system LIMDOW and MSR Magneto-Optical Microhead Array Chip Hard Disk Drive design, the data-sector being addressed can be optimally positioned across track-boundaries to minimize any latency time accrued during LIMDOW or MSR Magneto-Optical Microhead Array Chip's microhead switching.

Another Firmware feature incorporated into the dedicated multichannel microhead array chip bus-system LIMDOW and MSR Magneto-Optical Microhead Array Chip Hard Disk Drive design is called “Cylinder Skewing”. Cylinder Skewing is also used to help minimize the latency time associated with “single-cylinder seeks”. A cylinder skew is employed in such a way that the next logical sector of data, across a cylinder boundary, will be accordingly positioned on a proceeding disk-platter, after a single-cylinder seek is performed. When a dedicated multichannel microhead array chip bus-system LIMDOW and MSR Magneto-Optical Microhead Array Chip Hard Disk Drive is ready to continue accessing data, the sector to be accessed will be positioned directly under the addressed read or write microhead. Therefore, the Cylinder Skew can take place between the last-sector of data of a cylinder and the first-sector of data of a proceeding disk-platter's seeked cylinder.

In addition, the dedicated multichannel microhead array chip bus-system LIMDOW and MSR Magneto-Optical Microhead Array Chip Hard Disk Drives will also incorporate an “ID-less Format” for tracking data sector locations across its multiple data-surfaces. The ID-Less Format has several advantages over the traditional “ID After Wedge” or “ID Before Sector” methods of data sector tracking. For example, the lack of an “ID field” typically written to current hard drive disk-platter data-surfaces will regain approximately “4” percent of the overall data track real-estate present within a dedicated multichannel microhead array chip bus-system LIMDOW and MSR Magneto-Optical Microhead Array Chip Hard Disk Drive's unit-assembly (FIG. 112). Since no ID's have to be read or corrected in case of an error, a dedicated multichannel microhead array chip bus-system LIMDOW and MSR Magneto-Optical Microhead Array Chip Hard Disk Drive's overall data throughput is also increased. In ID-Less Formatting of data-sectors, the ID of each data sector is not written onto a disk-platter's data-surface, instead it is stored in a SDRAM's 199 (FIGS. 138 and 139) buffer memory area called the “Descriptor”.

In addition, each data-sector will have an associated Descriptor containing the rotational start-time for each data sector's disk-platter location. Subsequently, the Descriptor does not have any defect information stored within its memory areas. Dedicated multichannel microhead array chip bus-system LIMDOW and MSR Magneto-Optical Microhead Array Chip Hard Disk Drives also store a “Defect Map” within a SDRAM's 199 (FIGS. 138 and 139) buffer memory, but in a separate memory-location away from the Descriptor. Subsequently, for the dedicated multichannel microhead array chip bus-system LIMDOW and MSR Magneto-Optical Microhead Array Chip Hard Disk Drive design the multiple Data Sequencers 235 (FIG. 139) within a Magneto-Optical Microhead Array Chip, Internal Data-Striping, And Hard Disk Drive Controller 217 (FIGS. 138 and 139) will have access to both the Descriptor and the Defect Map listings, which is accessed through special requests made to the “Buffer Controller” 248 (FIG. 139) located within a Magneto-Optical Microhead Array Chip, Internal Data-Striping, And Hard Disk Drive Controller 217 (FIGS. 138 and 139). Only “end user data” and ECC information are actually written to data-surfaces of a dedicated multichannel microhead array chip bus-system LIMDOW and MSR Magneto-Optical Microhead Array Chip Hard Disk Drive's disk-platters.

In addition, error detection and correction for a dedicated multichannel microhead array chip bus-system LIMDOW and MSR Magneto-Optical Microhead Array Chip Hard Disk Drive becomes a concern as the dedicated multichannel microhead array chip bus-system LIMDOW and MSR Magneto-Optical Microhead Array Chip Hard Disk Drive's areal densities continue to increase. Wherein, the obtaining of extremely low error-rates will require sophisticated (ECC) “Error Correction Codes”. Dedicated multichannel microhead array chip bus-system LIMDOW and MSR Magneto-Optical Microhead Array Chip Hard Disk Drives will implement a Reed-Solomon error correction technique to reduce the uncorrectable read-error rates of any data-bits being read. Therefore, when errors do occur, an automatic retry, a double-burst, and a more rigorous triple-burst correction algorithm will enable the correction of any data-sector, using three-bursts each with four incorrect-bytes. Before invoking the complex triple-burst ECC algorithm, dedicated multichannel microhead array chip bus-system LIMDOW and MSR Magneto-Optical Microhead Array Chip Hard Disk Drives will always try to recover from an error by attempting to re-read the data correctly.

Furthermore, this error correction strategy prevents the invoking of correction, on non-repeatable errors. Each time a data-sector in error is re-read, a set of ECC syndromes has to be computed, and this is a very wasteful use of processing time. Therefore, if the entire syndrome-values equal zero, the data was read with no errors and the data-sector is transferred to the host-system or SWN. However, if any of the syndrome-values do not equal zero, an error has occurred; the syndrome-values are retained, and another re-read is invoked. Non-repeatable errors are usually related to the signal-to-noise ratio of a drive's system and are not due to media-defects.

Furthermore, when sets of syndromes from two consecutive re-reads are the same, a stable-syndrome has been achieved. The event mentioned above may be significant and depends on whether or not the automatic read-reallocation or early-correction features have been enabled within a dedicated multichannel microhead array chip bus-system LIMDOW and MSR Magneto-Optical Microhead Array Chip Hard Disk Drive's unit-assembly (FIG. 112). If, however, an early correction feature has been enabled and a stable-syndrome has been achieved, triple-burst ECC correction is applied, and the appropriate message will be transferred to the host-system or SWN (e.g., corrected data, etc.). The ECC bit will enable early ECC triple-burst correction if a stable-syndrome has been achieved before all of the re-reads have been exhausted. Therefore, if the automatic read-reallocation feature is enabled, the drive, when encountering triple-burst errors, will attempt to re-read the data. Additionally, dedicated multichannel microhead array chip bus-system LIMDOW and MSR Magneto-Optical Microhead Array Chip Hard Disk Drives will be equipped with an automatic read-reallocation feature, so any new defective data-sectors can be easily and automatically reallocated for the end-user.

In addition, to accommodate inline-sparing of defective data-sectors dedicated multichannel microhead array chip bus-system LIMDOW and MSR Magneto-Optical Microhead Array Chip Hard Disk Drives will allocate thousands of extra data-sectors to the end of its physical data storage area. While in the factory, the media will be scanned for defects, and if a data-sector is found defective, the address of the defective data-sector is added to a dedicated multichannel microhead array chip bus-system LIMDOW and MSR Magneto-Optical Microhead Array Chip Hard Disk Drive's Defect Map listing. Data-sectors located physically after the defective data-sector; moreover, will be assigned logical block addresses, so that a sequential ordering of logical blocks can be maintained. The inline-sparing technique will be maintained in an attempt to eliminate any slow data-transfers, which result from a single defective data-sector on a cylinder. Subsequently, all factory defective data-sectors will be inline-spared, but if a defective data-sector is found in the field, inline-sparing will not be performed on those sectors. Instead, the data-sector will be reallocated to an available spare-sector on a nearby cylinder, while its previous sector location is marked as being bad.

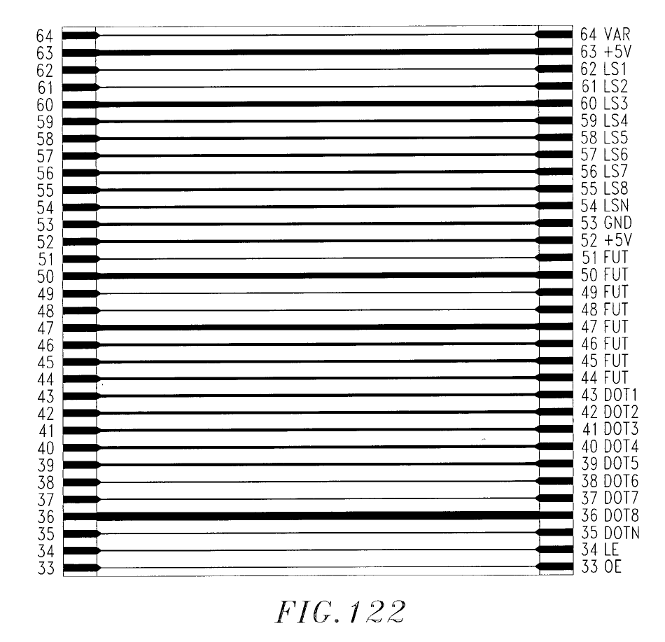

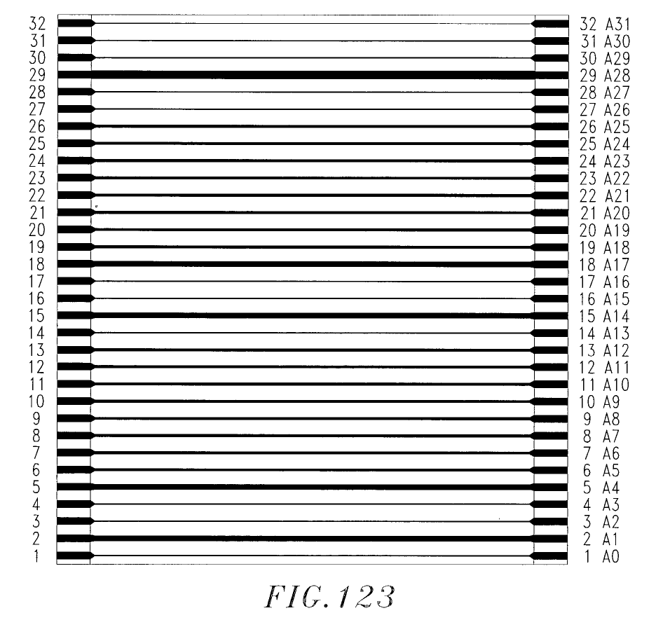

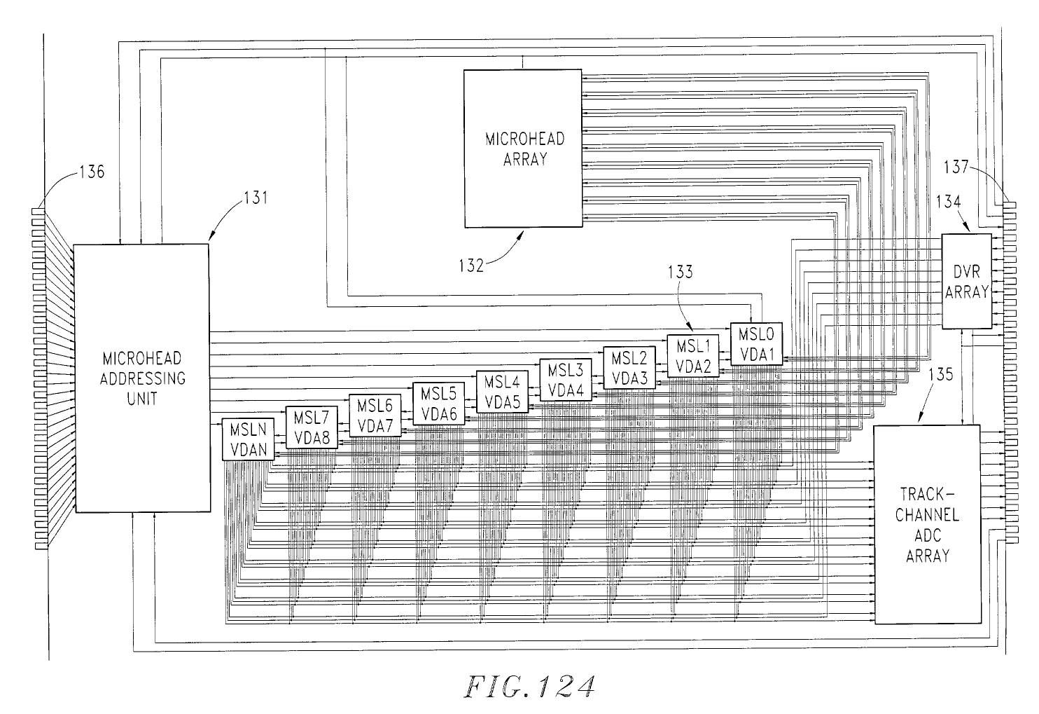

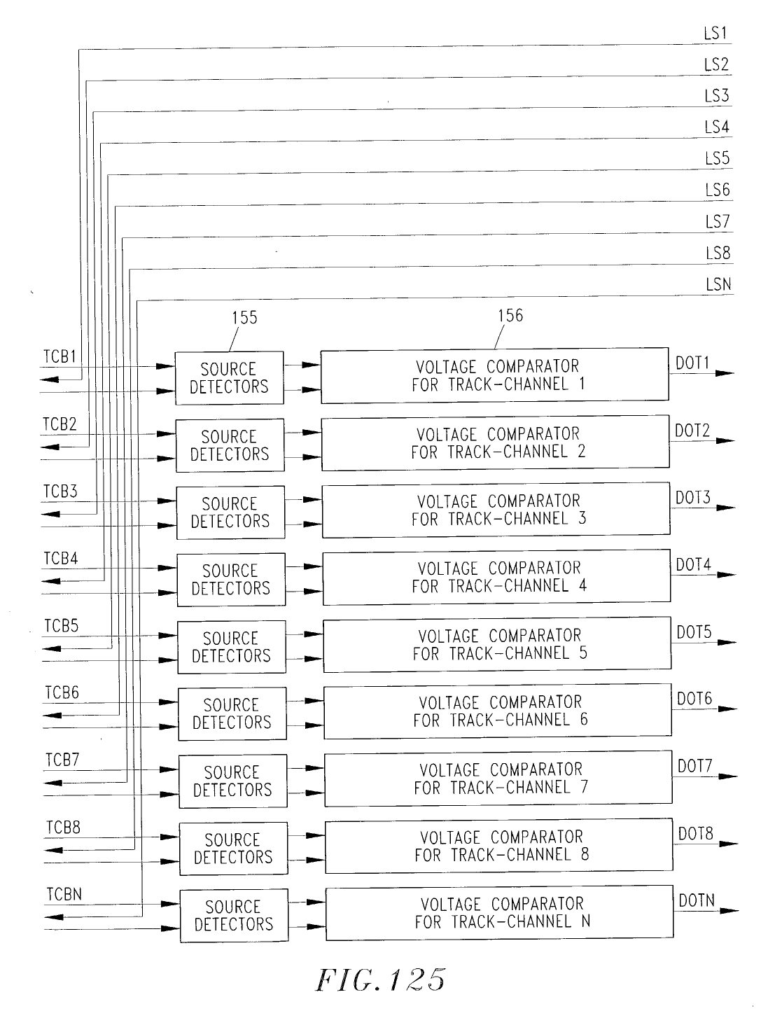

Additional embodiments of the present invention, as illustrated in FIGS. 118, 119, 120 and 121, defines chip configurations for a “Bottom Data-Surface a dedicated multichannel microhead array chip bus-system LIMDOW or MSR Magneto-Optical Microhead Array Chip”, and a “Top Data-Surface dedicated multichannel microhead array chip bus-system LIMDOW or MSR Magneto-Optical Microhead Array Chip”. Wherein, each dedicated multichannel microhead array chip bus-system LIMDOW or MSR Magneto-Optical Microhead Array Chip has a different surface mounting circuit-contact pin-out arrangement. FIG. 118 illustrates a Bottom Data-Surface a dedicated multichannel microhead array chip bus-system LIMDOW or MSR Magneto-Optical Microhead Array Chip's circuit-contact pin-out arrangements, while FIG. 119 illustrates a Top Data-Surface a dedicated multichannel microhead array chip bus-system LIMDOW or MSR Magneto-Optical Microhead Array Chip's circuit-contact pin-out arrangements. FIGS. 120 and 121 illustrate signal configurations and directions for a “Bottom Data-Surface a dedicated multichannel microhead array chip bus-system LIMDOW or MSR Magneto-Optical Microhead Array Chip”, and a “Top Data-Surface a dedicated multichannel microhead array chip bus-system LIMDOW or MSR Magneto-Optical Microhead Array Chip”. While, FIGS. 122 and 123 illustrate flex cable configurations. FIGS. 118, 119, 120, 121, 122, and 123, while displaying connectivity, also explain why their needs to be two different dedicated multichannel microhead array chip bus-system LIMDOW or MSR Magneto-Optical Microhead Array Chip circuit-contact pin-out arrangements.

Moreover, when a Bottom Data-Surface (FIGS. 113, 116, 118, and 120) dedicated multichannel microhead array chip bus-system LIMDOW or MSR Magneto-Optical Microhead Array Chip 4 (FIGS. 113, and 114) is used in a dedicated multichannel microhead array chip bus-system LIMDOW and MSR Magneto-Optical Microhead Array Chip Hard Disk Drive it is installed into a chip-positioning circuit board with its diode laser or VCSEL microhead array facing upward toward the observer, if the observer is looking down into a plan view of the chip through the Cartesian Y-axis.

Moreover, when installed, a Bottom Data-Surface dedicated multichannel microhead array chip bus-system LIMDOW or MSR Magneto-Optical Microhead Array Chip's 6 (FIGS. 113, 118, and 120) pin-one designation dot should be located in the upper-left hand corner of the beforementioned dedicated multichannel microhead array chip bus-system LIMDOW or MSR Magneto-Optical Microhead Array Chip's outer-package.

Alternatively, when a Top Data-Surface (FIGS. 117, 119, and 121) dedicated multichannel microhead array chip bus-system LIMDOW or MSR Magneto-Optical Microhead Array Chip 4 (FIGS. 113, and 114) is used in a dedicated multichannel microhead array chip bus-system LIMDOW and MSR Magneto-Optical Microhead Array Chip Hard Disk Drive it is installed into a chip-positioning circuit board with its diode laser or VCSEL microhead array facing downward away from an observer, if the observer is looking down into a plan view of the chip through the Cartesian Y-axis.

Moreover, when installed, a Top Data-Surface dedicated multichannel microhead array chip bus-system LIMDOW or MSR Magneto-Optical Microhead Array Chip's (FIGS. 119 and 121) pin-one designation dot should also be located in the upper-left hand corner of the beforementioned dedicated multichannel microhead array chip bus-system LIMDOW or MSR Magneto-Optical Microhead Array Chip's outer-package.

Furthermore, when LIMDOW or MSR Magneto-Optical Microhead Array Chips are installed into their chip-positioning circuit boards, and their chip-positioning circuit boards are installed into a dedicated multichannel microhead array chip bus-system LIMDOW and MSR Magneto-Optical Microhead Array Chip Hard Disk Drive's casting-base, there will ultimately be one LIMDOW or MSR Magneto-Optical Microhead Array Chip that is positioned for and facing each data-surface of every disk-platter installed into a dedicated multichannel microhead array chip bus-system LIMDOW and MSR Magneto-Optical Microhead Array Chip Hard Disk Drive's unit-assembly (FIG. 112).

Moreover, the arrangement described above is how both dedicated multichannel microhead array chip bus-system LIMDOW or MSR Magneto-Optical Microhead Array Chip designs will align with each other when installed and connected into a dedicated multichannel microhead array chip bus-system LIMDOW and MSR Magneto-Optical Microhead Array Chip Hard Disk Drive's unit-assembly (FIG. 112) and bus-system. When installed into a dedicated multichannel microhead array chip bus-system LIMDOW and MSR Magneto-Optical Microhead Array Chip Hard Disk Drive's unit-assembly, there should be at-least two diode laser or VCSEL microhead arrays facing each other (FIGS. 9 and 10) with at-least one disk-platter 13 (FIGS. 113, 114, and 115) positioned between them, as if each installed dedicated multichannel microhead array chip bus-system LIMDOW or MSR Magneto-Optical Microhead Array Chip were looking at a reflection of itself in a mirror.

Additional embodiments of the present invention, as illustrated in FIGS. 113 through 141, shows Polymer flex-cable connectors 67 (FIGS. 113, 114, and 115) and their associated Polymer flex-cables 126, 127 (FIGS. 113, 114, and 115), which are located, when looking down into a plan view illustration of a dedicated multichannel microhead array chip bus-system LIMDOW and MSR Magneto-Optical Microhead Array Chip Hard Disk Drive's unit-assembly (FIG. 112), on both the right-hand side and left-hand side of the dedicated multichannel microhead array chip bus-system LIMDOW and MSR Magneto-Optical Microhead Array Chip Hard Disk Drive's chip-positioning circuit boards. Wherein, the Polymer flex-cable connectors 67 and Polymer flex-cables 126, 127 if installed on the right-hand side of a dedicated multichannel microhead array chip bus-system LIMDOW and MSR Magneto-Optical Microhead Array Chip Hard Disk Drive's unit-assembly (FIG. 112) are dedicated to the Power, the Ground, the Data I/O, and the Control bus-systems that are used in a dedicated multichannel microhead array chip bus-system LIMDOW and MSR Magneto-Optical Microhead Array Chip Hard Disk Drive.

Furthermore, the previously mentioned Polymer flex-cables 126, 127 (FIGS. 113, 114, and 115) and their associated Polymer flex-cable connectors 67 (FIGS. 113, 114, and 115), which are located on the right-hand side of a dedicated multichannel microhead array chip bus-system LIMDOW and MSR Magneto-Optical Microhead Array Chip Hard Disk Drive's unit-assembly (FIG. 112), create multiple circuit connections between chip-connecting contact-points that are located on the right-hand side of installed dedicated multichannel microhead array chip bus-system LIMDOW or MSR Magneto-Optical Microhead Array Chips 4 (FIG. 113), and a Disk Controller's (PCB) “Printed Circuit Board” 53 (FIGS. 113, 114, and 115). The Disk Controller PCB 53 used in dedicated multichannel microhead array chip bus-system LIMDOW and MSR Magneto-Optical Microhead Array Chip Hard Disk Drives is located underneath a dedicated multichannel microhead array chip bus-system LIMDOW and MSR Magneto-Optical Microhead Array Chip Hard Disk Drive's Spindle-Motor unit-assembly 59 (FIGS. 113, 114, and 115) at the bottom of a dedicated multichannel microhead array chip bus-system LIMDOW and MSR Magneto-Optical Microhead Array Chip Hard Disk Drive's casting-base 12 (FIGS. 113, 114, and 115).

However, if the Polymer flex-cable connectors 67 (FIGS. 113, 114, and 115), and their associated Polymer flex-cables 126, 127 (FIGS. 113, 114, and 115) are installed on the left-hand side of a dedicated multichannel microhead array chip bus-system LIMDOW and MSR Magneto-Optical Microhead Array Chip Hard Disk Drive's unit-assembly (FIG. 112), they are dedicated to the 32-bit Microhead-Addressing bus-systems of the dedicated multichannel microhead array chip bus-system LIMDOW and MSR Magneto-Optical Microhead Array Chip Hard Disk Drive.

Furthermore, the beforementioned Polymer flex-cables 126, 127 (FIGS. 113, 114, and 115), and their Polymer flex-cable connectors 67 (FIGS. 113, 114, and 115), which are located on the left-hand side of a dedicated multichannel microhead array chip bus-system LIMDOW and MSR Magneto-Optical Microhead Array Chip Hard Disk Drive's unit-assembly (FIG. 112), create multiple circuit connections between the chip-connecting contact-points that are located on the left-hand side of installed LIMDOW or MSR Magneto-Optical Microhead Array Chips 4 (FIGS. 113, 114, and 115), and a Disk Controller's (PCB) “Printed Circuit Board” 53.

Moreover, the Disk Controller PCB 53 used in a dedicated multichannel microhead array chip bus-system LIMDOW and MSR Magneto-Optical Microhead Array Chip Hard Disk Drive is located underneath a dedicated multichannel microhead array chip bus-system LIMDOW and MSR Magneto-Optical Microhead Array Chip Hard Disk Drive's Spindle-Motor unit-assembly 59 at the bottom of a dedicated multichannel microhead array chip bus-system LIMDOW and MSR Magneto-Optical Microhead Array Chip Hard Disk Drive's casting-base 12 (FIGS. 113, 114, and 115).

Additional embodiments of the present invention, as illustrated in FIGS. 113 through 141, shows a “Chip Placement Key” 11 (FIGS. 26 and 27), which is located on the outer-package bottom-surface areas of dedicated multichannel microhead array chip bus-system LIMDOW or MSR Magneto-Optical Microhead Array Chips. The previously mentioned “Chip Placement Key” 11 (FIGS. 26 and 27), which is shaped like a triangle, is installed it will have its triangle-apex facing toward the front of its outer-package's top-edge surface, while facing a dedicated multichannel microhead array chip bus-system LIMDOW and MSR Magneto-Optical Microhead Array Chip Hard Disk Drive's front-end.

In addition, the “Chip Placement Keys” 11 used in dedicated multichannel microhead array chip bus-system LIMDOW or MSR Magneto-Optical Microhead Array Chips protrude about “1/16” of one inch out from underneath the bottom-center surface of a Chip's outer-package 11 (FIGS. 26 and 27). Furthermore, the sidewalls of the beforementioned “Chip Placement Keys” form “90” degree angles from the bottom-surface of its outer-package. Additionally, the triangular-shaped “Chip Placement Keys” 11 (FIGS. 26 and 27) will also have a corresponding and triangular-shaped “Chip Placement Keyhole” 92 (FIGS. 30, 32, 35, and 37). The previously mentioned “Chip Placement Keyholes” 92 are located at the top-surface of the bottom-inside center mounting-plane of every chip-positioning circuit board's surface-mounted chip-socket.

In addition, the previously mentioned “Chip Placement Keyholes” 92 are also triangle-shaped and have a machined-out recess that measures “1/16” of one-inch from the top-surface of the bottom-inside center mounting-plane of every chip-positioning circuit board's surface-mounted chip-socket 5 (FIGS. 113, 114, and 115). The sidewalls of the Chip Placement Keyholes 92 (FIGS. 30, 32, 35, and 37) will form “270” degree angles from the exposed bottom-center top-surface of every chip-positioning circuit board's surface-mounted chip-socket. The manufacturing and machining dimensions for the “Chip Placement Keys” 11 (FIGS. 26 and 27) and “Chip Placement Keyholes” 92 (FIGS. 30, 32, 35, and 37) are critical and must adhere to a tolerance that is plus or minus “1/1000” of one-inch. The previously mentioned dimensional tolerance used for the “Chip Placement Keys” and “Chip Placement Keyholes” is necessary to insure an accurate, a secure, and a non-compromizable placement of dedicated multichannel microhead array chip bus-system LIMDOW or MSR Magneto-Optical Microhead Array Chips into surface-mounted chip-sockets of installed chip-positioning circuit boards 27 (FIGS. 113, 114, and 115).

Furthermore, the installation of the dedicated multichannel microhead array chip bus-system LIMDOW or MSR Magneto-Optical Microhead Array Chips into their chip-positioning circuit board's surface-mounted chip-sockets is done using two chip-mounting threaded hex-screws 2 (FIG. 113). The two chip-mounting hex-screws 2 thread into a surface-mounted chip-socket's two hex-screw holes 92 (FIGS. 30, 32, 35, and 37). This will completely seat and secure the dedicated multichannel microhead array chip bus-system LIMDOW or MSR Magneto-Optical Microhead Array Chips into their surface-mounted chip-socket's inside-bottom chip mounting surface 92 (FIGS. 30, 32, 35, and 37).

In addition, the removal or displacement of a dedicated multichannel microhead array chip bus-system LIMDOW or MSR Magneto-Optical Microhead Array Chip after its installation into a chip-positioning circuit board's surface-mounted chip-socket should only need to occur if a dedicated multichannel microhead array chip bus-system LIMDOW or MSR Magneto-Optical Microhead Array Chip has failed. A failed dedicated multichannel microhead array chip bus-system LIMDOW or MSR Magneto-Optical Microhead Array Chip would then need to be removed and replaced with a new and fully functioning Chip.

Additional embodiments of the present invention, as illustrated in FIGS. 113 through 141, shows a dedicated multichannel microhead array chip bus-system LIMDOW or MSR Magneto-Optical Microhead Array Chip's sixty-four circuit connecting contacts, which are physically embedded into the bottom-surface of every a dedicated multichannel microhead array chip bus-system LIMDOW or MSR Magneto-Optical Microhead Array Chip's outer-package. For every dedicated multichannel microhead array chip bus-system LIMDOW or MSR Magneto-Optical Microhead Array Chip's sixty-four embedded circuit connecting contacts there is a matching set of sixty-four circuit connecting contacts, which are physically embedded into the top-surface of the bottom-inside center mounting-plane of every chip-positioning circuit board's surface-mounted chip-socket 5 (FIGS. 113, 114, and 115).

Moreover, when viewing a dedicated multichannel microhead array chip bus-system LIMDOW or MSR Magneto-Optical Microhead Array Chip in plan-view, where the location of a dedicated multichannel microhead array chip bus-system LIMDOW or MSR Magneto-Optical Microhead Array Chip's pin-one designation dot can be clearly seen 6 (FIG. 113). The pin-one designation dot of a plan-viewed dedicated multichannel microhead array chip bus-system LIMDOW or MSR Magneto-Optical Microhead Array Chip indicates that its either a “Top Data-Surface dedicated multichannel microhead array chip bus-system LIMDOW or MSR Magneto-Optical Microhead Array Chip” or a “Bottom Data-Surface dedicated multichannel microhead array chip bus-system LIMDOW or MSR Magneto-Optical Microhead Array Chip”.

Therefore, the pin-one designation dot of a plan-viewed LIMDOW or MSR Magneto-Optical Microhead Array Chip, also indicates, by way of reference, the locations, the names, and the number-designations of the plan-viewed dedicated multichannel microhead array chip bus-system LIMDOW or MSR Magneto-Optical Microhead Array Chip's sixty-four embedded circuit-connecting contacts, as illustrated in FIGS. 118 and 119.

Moreover, when viewing a dedicated multichannel microhead array chip bus-system LIMDOW or MSR Magneto-Optical Microhead Array Chip with its microheads facing upward in a portrait plan-view position, its pin-one designation dot will be located in the upper left-hand corner of its outer-package, which indicates that it is an installed “Bottom Data-Surface dedicated multichannel microhead array chip bus-system LIMDOW or MSR Magneto-Optical Microhead Array Chip” (FIG. 118). When viewing a dedicated multichannel microhead array chip bus-system LIMDOW or MSR Magneto-Optical Microhead Array Chip with its microheads facing downward in a portrait plan-view position, its pin-one designation dot will also be located in the upper left-hand corner of its outer-package, which indicates that it is an installed “Top Data-Surface dedicated multichannel microhead array chip bus-system LIMDOW or MSR Magneto-Optical Microhead Array Chip” (FIG. 119).

However, when viewing a dedicated multichannel microhead array chip bus-system LIMDOW or MSR Magneto-Optical Microhead Array Chip with its microheads facing upward in a portrait plan-view position, while its pin-one designation dot is located in the upper left-hand corner of its outer-package, could also indicate that this is an un-installed “Bottom Data-Surface dedicated multichannel microhead array chip bus-system LIMDOW or MSR Magneto-Optical Microhead Array Chip” (FIGS. 118 and 120). Additionally, when viewing a dedicated multichannel microhead array chip bus-system LIMDOW or MSR Magneto-Optical Microhead Array Chip with its microheads again facing upward in a portrait plan-view position, while its pin-one designation dot is located in the upper right-hand corner of its outer-package, this would indicate that this is an un-installed “Top Data-Surface dedicated multichannel microhead array chip bus-system LIMDOW or MSR Magneto-Optical Microhead Array Chip” (FIGS. 119 and 121).

Furthermore, the plan-viewed and un-installed version of a “Bottom Data-Surface dedicated multichannel microhead array chip bus-system LIMDOW or MSR Magneto-Optical Microhead Array Chip” has its 32-bit Microhead-Addressing bus-circuit's connecting input-contacts (FIG. 118) located on the left-hand side of its outer-package's bottom-surface. The thirty-two Microhead-Addressing and bus-circuit connecting input-contacts are presented as two groups of sixteen input-contacts. Group number-one will contain input-contacts zero to sixteen, while a group number-two contains input-contacts seventeen to thirty-one. The two groups of sixteen circuit-connecting input-contacts are physically separated from each other by a dedicated multichannel microhead array chip bus-system LIMDOW or MSR Magneto-Optical Microhead Array Chip's chip installing hex-screws 2 (FIG. 113) and hex-screw holes 3 (FIG. 113). When logically combined, the previously mentioned two groups of sixteen circuit-connecting input-contacts complete a 32-bit Microhead-Addressing bus-system's contact configuration.

Furthermore, the beforementioned plan-viewed and un-installed “Bottom Data-Surface dedicated multichannel microhead array chip bus-system LIMDOW or MSR Magneto-Optical Microhead Array Chip” has its control and data I/O bus-circuit's connecting contacts (FIG. 118) located on the right-hand side of its outer-package's bottom-surface. The thirty-two control and data I/O bus-circuit connecting contacts are presented as two groups of sixteen contacts. Group number one will contain contacts thirty-two to forty-eight, while group number two contains contacts forty-nine to sixty-four. The two groups of sixteen circuit-connecting contacts are physically separated from each other by a dedicated multichannel microhead array chip bus-system LIMDOW or MSR Magneto-Optical Microhead Array Chip's installation hex-screw 2 (FIG. 113) and hex-screw hole 3 (FIG. 113). When logically combined, the previously mentioned two groups of sixteen circuit-connecting contacts complete a control and data I/O bus-system's contact configuration.

Furthermore, the beforementioned plan-viewed and un-installed “Top Data-Surface dedicated multichannel microhead array chip bus-system LIMDOW or MSR Magneto-Optical Microhead Array Chip” has its 32-bit Microhead-Addressing bus-circuit's connecting input-contacts (FIG. 119) located on the right-hand side of its outer-package's bottom-surface. The thirty-two Microhead-Addressing bus-circuit-connecting input-contacts are presented as two groups of sixteen input-contacts. Group number one will contain input-contacts zero to sixteen, while group number two contains input-contacts seventeen to thirty-one. The previously mentioned two groups of sixteen circuit-connecting input-contacts are physically separated from each other by a dedicated multichannel microhead array chip bus-system LIMDOW or MSR Magneto-Optical Microhead Array Chip's installation hex-screw 2 (FIG. 113) and hex-screw hole 3 (FIG. 113). When logically combined, the previously mentioned two groups of sixteen circuit-connecting input-contacts complete a 32-bit Microhead-Addressing bus-system's contact configuration.

Furthermore, the plan-viewed and un-installed “Top Data-Surface dedicated multichannel microhead array chip bus-system LIMDOW or MSR Magneto-Optical Microhead Array Chip” has its control and data I/O bus-circuit's connecting contacts (FIG. 119) located on the left-hand side of its outer-package's bottom-surface. The thirty-two control and data I/O bus-circuit connecting contacts are presented as two groups of sixteen contacts. Group number one will contain contacts thirty-two to forty-eight, while group number two contains contacts forty-nine to sixty-four. The previously mentioned two groups of sixteen circuit-connecting contacts are physically separated from each other by a dedicated multichannel microhead array chip bus-system LIMDOW or MSR Magneto-Optical Microhead Array Chip's installation hex-screw 2 (FIG. 113) and hex-screw hole 3 (FIG. 113). When logically combined, the previously mentioned two groups of sixteen circuit-connecting contacts complete a control and data I/O bus-system's contact configuration.

In addition, a plan-viewed and installed “Bottom Data-Surface dedicated multichannel microhead array chip bus-system LIMDOW or MSR Magneto-Optical Microhead Array Chip” will have its pin-one designation dot located in the upper left-hand corner of its outer-package 6 (FIG. 113). While, a plan-viewed and installed “Bottom Data-Surface dedicated multichannel microhead array chip bus-system LIMDOW or MSR Magneto-Optical Microhead Array Chip” (FIG. 113) has its 32-bit addressing bus-circuit's connecting input-contacts (FIG. 118) located on the left-hand side of its outer-package's bottom-surface.

Additionally, the plan-viewed and installed “Bottom Data-Surface dedicated multichannel microhead array chip bus-system LIMDOW or MSR Magneto-Optical Microhead Array Chip” (FIG. 118) has its input-contacts one to thirty-two dedicated to its 32-bit addressing bus-circuit. An installed “Bottom Data-Surface dedicated multichannel microhead array chip bus-system LIMDOW or MSR Magneto-Optical Microhead Array Chip” connects its 32-bit addressing bus-circuit to a dedicated multichannel microhead array chip bus-system LIMDOW and MSR Magneto-Optical Microhead Array Chip Hard Disk Drive's Disk Controller and it's dedicated multichannel microhead array chip bus-system through its surface-mounted chip-socket's “A0” to “A31” circuit connection-contacts.

Furthermore, the plan-viewed and installed “Bottom Data-Surface dedicated multichannel microhead array chip bus-system LIMDOW or MSR Magneto-Optical Microhead Array Chip” will have its pin-one designation dot located in the upper left-hand corner of a dedicated multichannel microhead array chip bus-system LIMDOW or MSR Magneto-Optical Microhead Array Chip's outer-package 6 (FIG. 113). A plan-viewed and installed “Bottom Data-Surface dedicated multichannel microhead array chip bus-system LIMDOW or MSR Magneto-Optical Microhead Array Chip” has its control and data I/O bus-circuit's connecting-contacts (FIG. 118) located on the right-hand side of its outer-package's bottom-surface.

In addition, a plan-viewed and installed “Bottom Data-Surface dedicated multichannel microhead array chip bus-system LIMDOW or MSR Magneto-Optical Microhead Array Chip” has contacts thirty-three to sixty-four (FIGS. 118 and 120) dedicated to its (OE) “Output Enable” input-contact, its (LE) “Latch Enable” input-contact, its (DOTN) “Data Output Track Number” output-contact, its (FUT) “Future” input-contact, its (+5V) “VDD” input-contact, its (GND) “VSS” output-contact, its (LSN) “Laser Signal Number” input-contact, a second (+5V) “VDD” input-contact, and its (VAR) “Variable” voltage input-contact.

Moreover, the plan-viewed and installed “Bottom Data-Surface dedicated multichannel microhead array chip bus-system LIMDOW or MSR Magneto-Optical Microhead Array Chip” (FIGS. 118 and 120) has contact thirty-three dedicated to its (OE) “Output Enable” input-contact, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contact thirty-four dedicated to its (LE) “Latch Enable” input-contact, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contacts thirty-five through forty-three dedicated to its (DOTN) “Data Output Track Number” output-contacts, as illustrated in FIG. 118.

In addition, a plan-viewed and installed “Bottom Data-Surface dedicated multichannel microhead array chip bus-system LIMDOW or MSR Magneto-Optical Microhead Array Chip” (FIGS. 118 and 120) has contacts forty-four through fifty dedicated to its (FUT) “Future” alternatively called the “to be determined or reserved for future contacts”, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contact fifty-one dedicated to its first (+5V) “VDD” input-contact, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contact fifty-two dedicated to its first (GND) “VSS” ground output-contact, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contacts fifty-three through sixty-one dedicated to its (LSN) “Laser Signal Number” input-contacts, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contact sixty-two dedicated to its second (GND) “VSS” ground output-contact, as illustrated in FIG. 118. A plan-viewed and installed “Bottom Data-Surface dedicated multichannel microhead array chip bus-system LIMDOW or MSR Magneto-Optical Microhead Array Chip” (FIGS. 118 and 120) has contact sixty-three dedicated to its second (+5V) “VDD” input-contact, as illustrated in FIG. 118. Additionally, a plan-viewed and installed “Bottom Data-Surface dedicated multichannel microhead array chip bus-system LIMDOW or MSR Magneto-Optical Microhead Array Chip” (FIGS. 118 and 120) has contact sixty-four dedicated to its (VAR) “Variable” channel selecting voltage input-contact, as illustrated in FIG. 118.

In conclusion, an installed “Bottom Data-Surface dedicated multichannel microhead array chip bus-system LIMDOW or MSR Magneto-Optical Microhead Array Chip” connects its control and data I/O bus-circuits to a dedicated multichannel microhead array chip bus-system LIMDOW and MSR Magneto-Optical Microhead Array Chip Hard Disk Drive's Disk Controller and it's bus-systems through a surface-mounted chip-socket's connection-contacts, as they were previously numbered and named and illustrated in FIG. 118. Additionally, a “Signal-Flow” (i.e., sometimes called an in-put/out-put logic-flow configuration) for an un-installed “Bottom Data-Surface dedicated multichannel microhead array chip bus-system LIMDOW or MSR Magneto-Optical Microhead Array Chip” is illustrated in FIG. 120.

In addition, a plan-viewed and installed “Top Data-Surface dedicated multichannel microhead array chip bus-system LIMDOW or MSR Magneto-Optical Microhead Array Chip” has its pin-one designation dot orientated in the upper left-hand corner of its outer-package 6 (FIG. 113). Wherein, a plan-viewed and installed “Top Data-Surface dedicated multichannel microhead array chip bus-system LIMDOW or MSR Magneto-Optical Microhead Array Chip” (FIGS. 119 and 121) has its 32-bit Microhead-Addressing bus-circuit's connecting input-contacts located on the left-hand side of its outer-package's bottom-surface.

Moreover, the plan-viewed and installed “Top Data-Surface dedicated multichannel microhead array chip bus-system LIMDOW or MSR Magneto-Optical Microhead Array Chip” (FIG. 119) has its input-contacts one to thirty-two dedicated to its 32-bit addressing bus-circuit. An installed “Top Data-Surface dedicated multichannel microhead array chip bus-system LIMDOW or MSR Magneto-Optical Microhead Array Chip” connects its 32-bit addressing bus-circuit to a dedicated multichannel microhead array chip bus-system LIMDOW and MSR Magneto-Optical Microhead Array Chip Hard Disk Drive's Disk Controller and it's dedicated multichannel microhead array chip bus-system through its surface-mounted chip-socket's “A0” to “A31” circuit connection-contacts.

Furthermore, the plan-viewed and installed “Top Data-Surface dedicated multichannel microhead array chip bus-system LIMDOW or MSR Magneto-Optical Microhead Array Chip” will have its pin-one designation dot orientated in the upper left-hand corner of its outer-package 6 (FIG. 113). Wherein, a plan-viewed and installed “Top Data-Surface dedicated multichannel microhead array chip bus-system LIMDOW or MSR Magneto-Optical Microhead Array Chip” has its control and data I/O bus-circuit's connecting-contacts (FIG. 119) located on the right-hand side of its outer-package's bottom-surface.

In addition, a plan-viewed and installed “Top Data-Surface dedicated multichannel microhead array chip bus-system LIMDOW or MSR Magneto-Optical Microhead Array Chip” has contacts thirty-three to sixty-four (FIGS. 118 and 120) dedicated to its (OE) “Output Enable” input-contact, its (LE) “Latch Enable” input-contact, its (DOTN) “Data Output Track Number” output-contact, its (FUT) “Future” input-contact, its (+5V) “VDD” input-contact, its (GND) “VSS” output-contact, its (LSN) “Laser Signal Number” input-contact, a second (+5V) “VDD” input-contact, and its (VAR) “Variable” voltage input-contact.

Moreover, the plan-viewed and installed “Top Data-Surface dedicated multichannel microhead array chip bus-system LIMDOW or MSR Magneto-Optical Microhead Array Chip” (FIGS. 119 and 121) has contact thirty-three dedicated to its (OE) “Output Enable” input-contact, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contact thirty-four dedicated to its (LE) “Latch Enable” input-contact, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contacts thirty-five through forty-three dedicated to its (DOTN) “Data Output Track Number” output-contacts, as illustrated in FIG. 119.

In addition, a plan-viewed and installed “Top Data-Surface dedicated multichannel microhead array chip bus-system LIMDOW or MSR Magneto-Optical Microhead Array Chip” (FIGS. 119 and 121) has contacts forty-four through fifty dedicated to its (FUT) “Future” alternatively called the “to be determined or reserved for future contacts”, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contact fifty-one dedicated to its first (+5V) “VDD” input-contact, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contact fifty-two dedicated to its first (GND) “VSS” ground output-contact, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contacts fifty-three through sixty-one dedicated to its (LSN) “Laser Signal Number” input-contacts, as illustrated in FIG. 119. A plan-viewed and installed “Top Data-Surface dedicated multichannel microhead array chip bus-system LIMDOW or MSR Magneto-Optical Microhead Array Chip” (FIGS. 119 and 121) has contact sixty-two dedicated to its second (GND) “VSS” ground output-contact, as illustrated in FIG. 119. A plan-viewed and installed “Top Bottom Data-Surface dedicated multichannel microhead array chip bus-system LIMDOW or MSR Magneto-Optical Microhead Array Chip” (FIGS. 119 and 121) has contact sixty-three dedicated to its second (+5V) “VDD” input-contact, as illustrated in FIG. 119. Additionally, a plan-viewed and installed “Top Data-Surface dedicated multichannel microhead array chip bus-system LIMDOW or MSR Magneto-Optical Microhead Array Chip” (FIGS. 119 and 121) has contact sixty-four dedicated to its (VAR) “Variable” channel selecting voltage input-contact, as illustrated in FIG. 119.

In conclusion, an installed “Top Data-Surface dedicated multichannel microhead array chip bus-system LIMDOW or MSR Magneto-Optical Microhead Array Chip” connects its control and data I/O bus-circuits to a dedicated multichannel microhead array chip bus-system LIMDOW and MSR Magneto-Optical Microhead Array Chip Hard Disk Drive's Disk Controller and it's bus-systems through a surface-mounted chip-socket's connection-contacts, as they were previously numbered and named and illustrated in FIG. 119. Additionally, a “Signal-Flow” (i.e., sometimes called an in-put/out-put logic-flow configuration) for an un-installed “Top Data-Surface dedicated multichannel microhead array chip bus-system LIMDOW or MSR Magneto-Optical Microhead Array Chip” is illustrated in FIG. 121.

Additional embodiments of the present invention, as illustrated in FIGS. 113 through 141, shows a dedicated multichannel microhead array chip bus-system LIMDOW or MSR Magneto-Optical Microhead Array Chip's internal core and microhead structures, which are located within every dedicated multichannel microhead array chip bus-system LIMDOW or MSR Magneto-Optical Microhead Array Chip and comprises a microhead array containing a multitude of microheads, each comprising a diode laser or (VCSEL) “Vertical Cavity Surface Emitting Laser” device 1 (FIGS. 113, 114, and 115), a reversed-biased (SPC) “Semiconductor Photo-Conductor” linear position-sensing (CdS) “Cadmium Sulfide” semiconductor device, or as an alternative embodiment a reversed-biased (SPD) “Semiconductor Photo-Diode” photocell (Si) “Silicon” or (CCD) “Charged Coupled Device” semiconductor 191 (FIGS. 120 and 121).

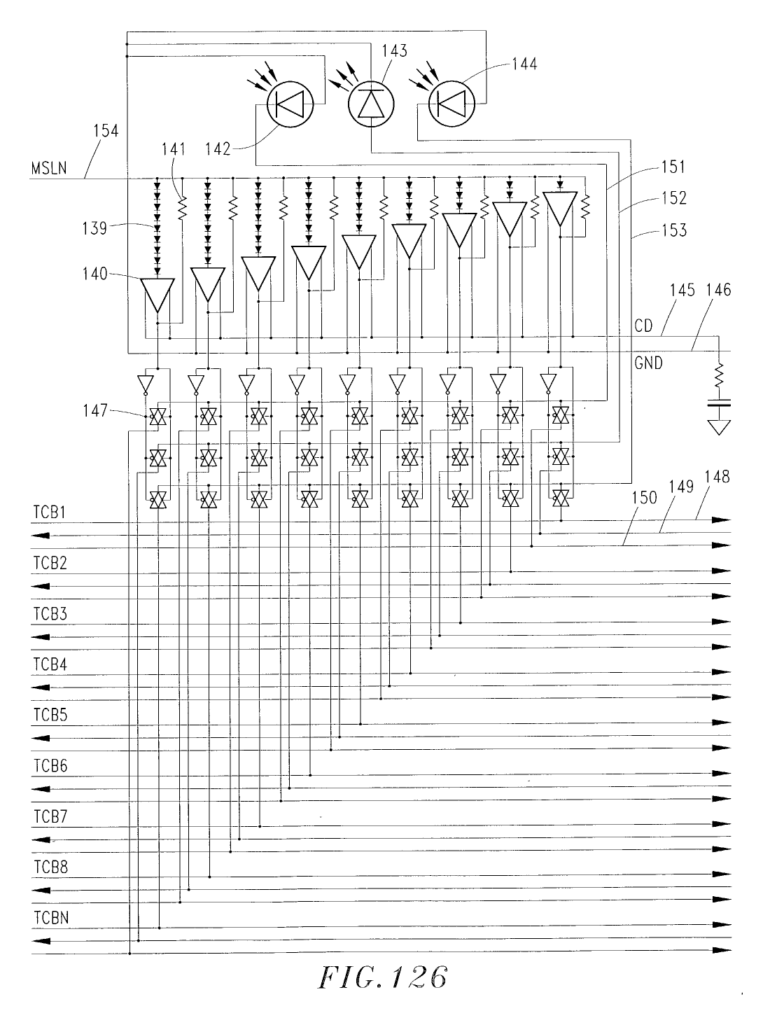

Furthermore, the diode laser or VCSEL microhead arrays used in the dedicated multichannel microhead array chip bus-system LIMDOW or MSR Magneto-Optical Microhead Array Chips are typically forward-biased, microscopic, and alloy-doped double-heterojunction semiconductor diode plus mirror structures. The diode lasers or VCSELs are typically built-up layer-upon-layer from a single semiconductor substrate, using well-known MBE or MOVPE, or some other equivalent epitaxial manufacturing method. While, a dedicated multichannel microhead array chip bus-system LIMDOW or MSR Magneto-Optical Microhead Array Chip's support and signal circuitry is fully integrated and constructed either from the same extrinsic semiconductor material used to construct the diodes used to form diode lasers or VCSELs (e.g., Gallium-Arsenide or Gallium-Nitride) or constructed using (SOI) “Silicon On Insulator” based technologies, like CMOS on Sapphire. As illustrated in FIG. 124, the previously mentioned support and signal circuitry will comprise a Microhead Addressing Unit 131, a Microhead Array 132, a Track Channel (ADC) “Analog to Digital Conversion” Array 135, a (DVR) “Driver” Array 134, an array of (MSLN) “Microhead Selection Line Number” (VDAN) “Voltage Detector Array Number” 133. The previously mentioned integrated circuits are typically masked, lithographed, etched, and built-up from the same semiconductor substrate (i.e., insulator) as the previously mentioned diode laser or VCSEL microhead arrays.

Moreover, the extrinsic semiconductor materials used in constructing diode lasers and VCSELs have crystalline lattice structures that are incompatible to the lattice structures of Silicon and Silicon-Oxide substrates and therefore, will not grow epitaxially upon CMOS based substrates. However, by using a well-known insulator material like Sapphire as the substrate material, full integration of CMOS based Silicon-Oxide circuits and Gallium-Arsenide or Gallium-Nitride diode lasers VCSELs is possible. The construction of a CMOS/diode laser or CMOS/VCSEL hybrid is therefore accomplished using a well-known SOI manufacturing process.

Moreover, the support circuitry and photo-detectors of a dedicated multichannel microhead array chip bus-system LIMDOW or MSR Magneto-Optical Microhead Array Chip are constructed first before its support circuitry. Wherein, the previously mentioned insulator substrate material (e.g., 100 microns of Sapphire) is covered with a thin layer of Silicon using a high-temperature method of epitaxial deposition. Next, the previously mentioned layer of Silicon is selectively oxidized and covered with a photo-resistant oxide material. Next, the wafer, covered with photo-resistant oxide material is exposed to ultraviolet-light using an ultraviolet-light blocking mask, which causes the oxide-areas of the wafer not masked to undergo a photochemical change. Wherein, the photo-chemically-changed areas of the wafer not masked are then developed to expose an underlying Silicon-Oxide layer beneath the photo-resist oxide material. The newly exposed layers of “Silicon-Oxide” are next chemically removed or etched-out leaving empty areas in the wafer. Next, the empty areas in the wafer can later be filled-in with various alloys or doped semi-conducting and/or conducting materials using a well-known process of metalising, creating submicron CMOS based circuitry.

Moreover, the diode lasers or VCSELs of a dedicated multichannel microhead array chip bus-system LIMDOW or MSR Magneto-Optical Microhead Array Chip are constructed second using an epitaxial process like MBE or MOPVE to deposit multiple layers of Gallium based material upon the previously mentioned insulator substrate (e.g., Sapphire) wafer. Next, the previously mentioned layers of Gallium based materials are shaped, using various etching and lithography techniques, into the diode lasers or VCSELs used in a dedicated multichannel microhead array chip bus-system LIMDOW or MSR Magneto-Optical Microhead Array Chip as a light source(s).

Furthermore, deposited between the diode laser or VCSEL microhead arrays and CMOS based support circuitry are layers of non-conducting epitaxially deposited “Silicon Oxide” material, which moreover is used as a fill-in and insulating material for the non-conducting and iso-insulation areas present around every diode laser or VCSEL structure built within a dedicated multichannel microhead array chip bus-system LIMDOW or MSR Magneto-Optical Microhead Array Chip's structure. The previously mentioned non-conducting “Silicon-Oxide” insulating structures are epitaxially constructed, layer-upon-layer, just as if the other semi-conducting circuit structures that are used within every a dedicated multichannel microhead array chip bus-system LIMDOW or MSR Magneto-Optical Microhead Array Chip.

Additional embodiments of the present invention, as illustrated in FIGS. 58 and 59, defines a ultra-violet VCSEL design, which is presented as an example of existing prior art technology that utilizes “electron/hole” recombination (i.e., injection) to produce a blue-green to ultra-violet diode laser or VCSEL laser with a wavelength range of “435” to “350” nanometers. Illustrated in FIGS. 58 is a section drawing of a double hetero-junction ultra-violet VCSEL diode laser that displays different semiconductor layers as being built-up via (MBE) “Molecular Beam Epitaxy” or (MOVPE) “Metal-Organic Vapor-Phase Epitaxy”. This VCSEL is a mesa etched structure, which comprises, first of all, a metallic supporting substrate, which typically uses the previously mentioned substrate as a back-reflecting mirror, while providing a base-structure for the growth of the VCSELs' 107 (FIGS. 55, 56, and 58) subsequent multilayers. This base-structure is conductive, and as an alternative embodiment, serves as an electrode composed of a (NiAl) “Nickel-Aluminum” alloy-mixture, having between an eight to twelve percent lattice mismatch, or more specifically a ten percent lattice mismatch to (GaN) “Gallium-Nitride”; the VCSEL's principle construction material.

Nevertheless, (NiAl) “Nickel-Aluminum” is the typically preferred alloy-mixture for this kind of structure, while having a surface roughness of less than “15” atoms thick, the (Ni—Al) “Nickel-Aluminum” alloy-mixture, also displays a highly reflective property as well. Furthermore, as illustrated in FIG. 58, what is also needed for constructing this VCSEL structure is a multilayered epitaxial growth of (AlN) “Aluminum-Nitride”, while each AlN layer being only a few atoms thick, the multiple AlN layers are utilized as a buffer layer 123 (FIGS. 55, 56, and 58) for facilitating the epitaxial-growth of the subsequent multilayers that will eventually comprise the VCSEL's and/or VCSEL based microhead array's completed structure(s).

In addition, is a first distributed Bragg reflector 126 (FIGS. 55, 56, 58, and 59), which is epitaxially grown onto the previously mentioned multilayered buffer 123 (FIGS. 55, 56, 58, and 59), by using any suitable epitaxial deposition method, such as (MBE) “Molecular Beam Epitaxy” or (MOVPE) “Metal-Organic Vapor-Phase Epitaxy”. A first distributed Bragg reflector 126 (FIG. 58) is composed of alternating layers of n-doped (GaN) “Gallium-Nitride” 126A (FIG. 58) and n-doped (AlGaN) “Aluminum-Gallium-Nitride” 126B (FIG. 58); thereby, making a mirror pair or one pair of refractive opposing reflectors (AlGaN/GaN), or more precisely, two alternating layers that completes one “mirror pair”.

However, if additional mirror pairs are required, several more layers can be epitaxially deposited onto the last existing mirror-pair thus, producing additional mirror pairs. Wherein, the number of mirror pairs displayed is five to ten mirror pairs 126A, 126B (FIG. 58), 126C, 126D (FIG. 58), 126E, 126F (FIG. 58), 126G, 126H (FIG. 58), while the actual number of mirror pairs could range from fifty to one hundred mirror pairs, depending on the laser's emission wavelength.

In addition, the second distributed Bragg reflector 124 (FIG. 58) is to be composed of alternating layers of (Al2O3) “Aluminum-Oxide” 124A (FIG. 58) and (ZnO) “Zinc-Oxide” 124B (FIG. 58); thereby, making a mirror pair or one pair of refractive opposing reflectors (Al2O3/ZnO), or more precisely, two alternating layers that completes one “mirror pair”.

However, if additional mirror pairs are required, several more layers can be epitaxially deposited onto the last existing mirror-pair thus, producing additional mirror pairs. Wherein, the number of mirror pairs displayed is five to ten mirror pairs 124A, 124B (FIG. 58), 124C, 124D (FIG. 58), 124E, 124F (FIG. 58), 124G, 124H (FIG. 58), 124I, 114 (FIG. 58), while the actual number of mirror pairs could range from twenty-five to fifty mirror pairs, depending on the laser's emission wavelength. It should be understood that the thickness and doping level of every epitaxial layer must be precisely controlled. Therefore, any deviation from design parameters, no matter how slight, would affect a typical VCSEL's performance (i.e., frequency range and flux intensity).

Furthermore, to prevent the overcrowding of the cladding-regions, each is shown as a single layer 127A, 127C (FIG. 58). It should be understood, however, that each cladding-region can also be made of more than one layer 127A, 127C (FIG. 58) with each cladding-region epitaxially deposited onto the previous cladding-region 127A (FIG. 58). Wherein, each cladding-region 127A, 127C (FIG. 58) is composed of any suitable doped or un-doped material, such as an n-doped and a p-doped (AlGaN) “Aluminum-Gallium-Nitride” epitaxially deposited material. The active-region 127B (FIG. 58) of a VCSEL is also represented by a single layer and epitaxially deposited onto the beforementioned first cladding-region 127A (FIG. 58). It should be understood, however, that the previously mentioned active-region 127B (FIG. 58) can also include one or more barriers and quantum-wells; particularly a first barrier and a second barrier with a quantum-well positioned between the previously mentioned first barrier layer and the previously mentioned second barrier layer, while the beforementioned active-region 127B (FIG. 58) is composed of (InGaN) “Indium-Gallium-Nitride” material. A second contact-layer 128 (FIG. 58), which is a layer constructed using highly p-doped (GaN) “Gallium-Nitride” material that is epitaxially grown onto a diode laser or VCSEL's second cladding-region 127C (FIG. 58). Wherein, the previously mentioned second contact-layer provides connectivity to a VCSEL's p-metal contact 105 (FIG. 58).

In addition, the second distributed Bragg reflector 124 (FIG. 58) is to be composed of alternating layers of (Al2O3) “Aluminum-Oxide” 124A (FIG. 58) and (ZnO) “Zinc-Oxide” 124B (FIG. 58); thereby, making a mirror pair or one pair of refractive opposing reflectors (Al2O3/ZnO), or more precisely, two alternating layers that completes one “mirror pair”. If additional mirror pairs are required, several more layers can be epitaxially deposited onto the last existing mirror pair; thus, producing additional mirror pairs. Where, the number of mirror pairs displayed is five to ten mirror pairs 124A, 124B (FIG. 58), 124C, 124D (FIG. 58), 124E, 124F (FIG. 58), 124G, 124H (FIG. 58), 124I, 114 (FIG. 58), while the actual number of mirror pairs could range from twenty-five to fifty mirror pairs, depending on the laser's emission wavelength. It should be understood, however, that the thickness and doping level of every epitaxial layer must be precisely controlled. Therefore, any deviation from design parameters, no matter how slight, would affect a typical VCSEL's performance (i.e., frequency range and flux intensity).

For example, if a VCSEL microhead were designed to emit laser light with a wavelength range, say “200” to “550” nanometers, the layers that go into its construction would typically need to be one-quarter of one wavelength of the laser light emission 139 (FIG. 108A) emitted by the example VCSEL's emitter layer 114 (FIG. 58). In general, each distributed layer used in a Bragg reflector, more specifically, (DBR) “Distributed Bragg Reflector” (s) 126, 124 (FIGS. 55, 56, and 58), must have an optical thickness that is equal to one-quarter of one wavelength of a VCSEL's laser light emissions.

Furthermore, the doping of the semiconductor layers used in the construction of a VCSEL microhead is accomplished by the addition of various dopant materials (e.g., gaseous n-type dopants and gaseous p-type dopants) during the epitaxial deposition of growth materials; thereby, doping the epitaxially deposited material. Typically, the semiconductor layers used in the construction of a VCSEL microhead will use many different dopant concentrations of specific dopant materials within their different intrinsic semiconductor structures forming moreover extrinsic semiconductor structures.

For example, the alternating layers of the beforementioned first distributed Bragg reflector 126 (FIG. 58) are n-type and doped with “Selenium”, “Silicon”, or the like, to a concentration that ranges from “1E15” to “1E20” cubic-centimeters with a preferred range from “1E17” to “1E19” cubic centimeters, while a nominal range would be from “5E17” to “5E18” cubic centimeters 124A (FIG. 58). Furthermore, the percent of composition of the beforementioned first distributed Bragg reflector 126 (FIG. 58) can be stated as (Al x Ga x N/GaN) where x is the variable of “0.05” to “0.96”, while in a preferred embodiment x would be greater than “0.8”.

In addition, is a second distributed Bragg reflector, which is made of a plurality of alternating layers 124 (FIG. 58). Moreover, a plurality of alternating layers 124, 114 (FIG. 58) that includes one or more layers of (Al2O3) “Aluminum-Oxide” material, which are illustrated as layers 124A, 124C, 124E, 124G, 124I (FIG. 58), and one or more layers of (ZnO) “Zinc-Oxide” material, which are illustrated as layers 124B, 124D, 124F, 124H, 114 (FIG. 58). For example, a layer of (Al2O3) “Aluminum-Oxide”, which was epitaxially deposited on the previously mentioned second contact-layer 128 (FIG. 58), has a layer of (ZnO) “Zinc-Oxide” subsequently and epitaxially deposited on the previously mentioned first layer of (Al2O3) “Aluminum-Oxide”; thereby, making a first mirror pair of dielectric (Al2O3/ZnO) reflectors 124A, 124B (FIG. 58). If additional mirror-pairs are required, several more layers of additional mirror-pairs are deposited on the existing layers of (Al2O3) “Aluminum Oxide” and (ZnO) “Zinc Oxide”. The plurality of alternating layers used to create the previously mentioned second distributed Bragg reflector 124 (FIG. 58) are formed from one mirror pair to ten mirror pairs with a preferred number of mirror pairs ranging from four to five mirror pairs.

However, it should be understood that the number of mirror pairs could be adjusted for specific applications. In addition, a p-metal electrical contact 105 (FIG. 58) is formed on the previously mentioned second contact-layer 128 (FIG. 58) by disposing any suitable conductive material on the previously mentioned second contact-layer 128 (FIG. 58). Moreover, the previously mentioned metal material used in the construction of the p-metal electrical contact could be made using Indium-Tin-Oxide, Gold, Zinc, Platinum, Tungsten, and Germanium like metallic alloys. In addition, an n-metal electrical contact 106 (FIG. 58) is formed on the previously mentioned first contact-layer 122 (FIG. 58) by disposing any suitable conductive material such as Indium-Tin-Oxide, Gold, Zinc, Platinum, Tungsten, and Germanium like metallic alloys. It should be understood that depending upon which material is selected for the previously mentioned electrical contacts 105, 106 (FIG. 58) that a specific method of disposition, disposing and patterning, onto the previously mentioned first and second contact-layers 122, 128 (FIG. 58) for a specific material, will change, along with that materials electrical contacts 105, 106 (FIG. 58).

Furthermore, it should be noted that a double hetero-junction ultra-violet VCSEL's second contact-layer 128 (FIG. 58), second cladding-region 127C (FIG. 58), quantum-well active-region 127B (FIG. 58), and first cladding-region 127A (FIG. 58) are all etched and, therefore define the overall structures of a mesa etched VCSEL's design (FIG. 58), while their diameters will remain substantially larger than the beforementioned VCSEL's emission aperture 114 (FIG. 58), and its operating vertical cavity. Furthermore, so that the beforementioned VCSEL's active-region 127B (FIG. 58) is not damaged by the etching process, proton-implantation can be utilized for current isolation; wherein, a proton-implantation mask's diameter is slightly larger than the VCSEL's emission aperture's diameter 114 (FIG. 58).

In addition, as the above described etching and proton-implantation steps are completed a p-metal contact 105 (FIG. 58) is deposited upon the beforementioned VCSEL's second contact-layer 128 (FIG. 58), while leaving the beforementioned VCSEL's emission aperture area open 114 (FIG. 58). In addition, an n-metal contact is deposited upon the beforementioned first contact-layer 122 (FIG. 58), or the previously mentioned n-metal contact is deposited upon the beforementioned VCSEL's base-substrate back-reflecting mirror structure 107 (FIGS. 55, 56, and 58) as an alternative preferred embodiment.

Furthermore, the metallic-alloy base-substrate and back-reflecting mirror structure 107 (FIGS. 55, 56, and 58), in conjunction with the (AlGaN/GaN) “Aluminum-Gallium-Nitride/Gallium-Nitride” Bragg reflector, provides for approximately 99% of the VCSEL's reflectivity. Additionally, the VCSEL microheads used in a dedicated multichannel microhead array chip bus-system LIMDOW or MSR Magneto-Optical Microhead Array Chip's microhead array, would have a centerline-to-centerline dimension of approximately “300” nanometers (FIGS. 53, 54, and 57), while the VCSEL emission apertures 114 (FIG. 59) would have a circular diameter of “200” nanometers, as illustrated in FIG. 59.

Alternative Operation—FIGS. 113 through 141

The alternative operational embodiment for the present LIMDOW and MSR Magneto-Optical Microhead Array Chip Hard Disk Drive invention describes two different embodiments of the invention's high-speed high-end bus-system:

1.) A bus-system for a dedicated LIMDOW and MSR Magneto-Optical Microhead Array Chip Hard Disk Drive design; and

2.) A bus-system for a dedicated multichannel LIMDOW and MSR Magneto-Optical Microhead Array Chip Hard Disk Drive design.

Wherein, both embodiments are thoroughly described along with the operation of high-speed PCI transcending interfaces and how they connect a LIMDOW or MSR Magneto-Optical Microhead Array Chip Hard Disk Drive up to a Host Computer or Storage Area Network system. A detailed description of LIMDOW and MSR Magneto-Optical Microhead Array Chip Hard Disk Drive's alternative operation typically begins with the initialization of a LIMDOW and MSR Magneto-Optical Microhead Array Chip Hard Disk Drive itself, which occurs by first performing a boot-up of its operating system and the running of its pre-check protocols. Thereafter, a LIMDOW or MSR Magneto-Optical Microhead Array Chip Hard Disk Drive will normally begin its regular operation with either a host-requested read-data or host-requested write-data disk-operation.

In addition, in order for LIMDOW and MSR Magneto-Optical Microhead Array Chip Hard Disk Drives to commence disk-operations as quickly as possible a LIMDOW and MSR Magneto-Optical Microhead Array Chip's R/W Control Circuit's default setting after a “Power-On-Restart” and/or “Power-On-Initialization” has been executed is to have a selected LIMDOW or MSR Magneto-Optical Microhead Array Chip's read-channel enabled. The purpose of enabling a LIMDOW and MSR Magneto-Optical Microhead Array Chip's read-channel just after a “Power-On-Restart” and/or “Power-On-Initialization” is so that the (OP Code) “Operational Code” from a system containing disk-platter data-surface can be read from track-0 into a Disk Controller's (SDRAM) “Synchronous Dynamic Random Access Memory” buffer area 198 (FIGS. 138 and 139), which has been put aside for the execution of a LIMDOW and MSR Magneto-Optical Microhead Array Chip Hard Disk Drive's disk operating OP Code software.

Moreover, before a read-data disk-operation can take place the “Magneto-Optical Microhead Array Chip, Internal Data-Stripping, And Hard Disk Drive Controller” 217 (FIGS. 138 and 139) must first select and enable specific LIMDOW or MSR Magneto-Optical Microhead Array Chips. While this selection process is similar to that used in conventional hard disk drives it differs because unlike flying data-head hard disk drives every installed LIMDOW and MSR Magneto-Optical Microhead Array Chip is comprised as a stationary device (i.e., always located in one place) that contains a microhead array comprising a multitude of stationary and singularly addressable laser-diode microheads 1 (FIGS. 113, 114, and 115). Further, the previously mentioned LIMDOW and MSR Magneto-Optical Microhead Array Chip process of selection is initialized through individual cables 126, 127 (FIGS. 113, 114, 115, 122, and 123) that are dedicated to each and every installed LIMDOW or MSR Magneto-Optical Microhead Array Chip.

For example, during a read-data disk-operation a LIMDOW or MSR Magneto-Optical Microhead Array Chip Hard Disk Drive's Disk Controller will first forward nine host-requested cylinder/track and data-sector address locations to a LIMDOW or MSR Magneto-Optical Microhead Array Chip Hard Disk Drive's “I/O Controller And Target Channel Adapter Interface” 197 (FIGS. 138 and 139) for translation and analysis. Wherein, an “I/O Controller And Target Channel Adapter Interface”, which is located on a LIMDOW and MSR Magneto-Optical Microhead Array Chip Hard Disk Drive Controller's (PCB) “Printed Circuit Board” 63 (FIG. 4), 80 (FIG. 5), will temporarily store the host-requested address locations in an I/O Controller And Target Channel Adapter Interface's “Address Translation Register”, which is located in the Asynchronous Optical Microhead Address Controller's “TCAMSU” 250 (FIG. 139). Next, an “I/O Controller And Target Channel Adapter Interface” will translate and analysis the address location information stored in an I/O Controller And Target Channel Adapter Interface's “Address Translation Register” into executable control-code, which will be sent 220 (FIGS. 138 and 139) to Flash SRAM memory, where it will be stored and later used by the drive's “Magneto-Optical Microhead Array Chip, Internal Data-Stripping, And Hard Disk Drive Controller” 217 (FIGS. 138 and 139).

Moreover, a component called the “DCMSU” 247 (FIGS. 138 and 139), which is internal to the “Magneto-Optical Microhead Array Chip, Internal Data-Stripping, And Hard Disk Drive Controller” 217 (FIGS. 138 and 139), reads using an address-bus 216 from flash memory the translated address location control-codes for a preselect number of microheads. These translated address location control-codes are used by the “DCMSU” 247 (FIGS. 138 and 139) to generate a multitude of thirty-two bit microhead address signals it also redirects to and is used by the Magneto-Optical Microhead Array Chip, Internal Data-Stripping, And Hard Disk Drive Controller's individual “Microhead Address Bus” lines 208, 209, 210 to select a multitude of microheads to perform, in parallel, read-data and/or write-data disk-operations. This dedicated multichannel bus-system comprises a group of ribbon-cables 126, 127 (FIGS. 113, 114, and 115) that separately connect each installed LIMDOW and MSR Magneto-Optical Microhead Array Chip to a hard disk drive's Disk-Controller and unit-assembly and are used to send microhead address bus-signals to each LIMDOW or MSR Magneto-Optical Microhead Array Chip that is installed in a LIMDOW and MSR Magneto-Optical Microhead Array Chip Hard Disk Drive's unit-assembly FIG. 112.

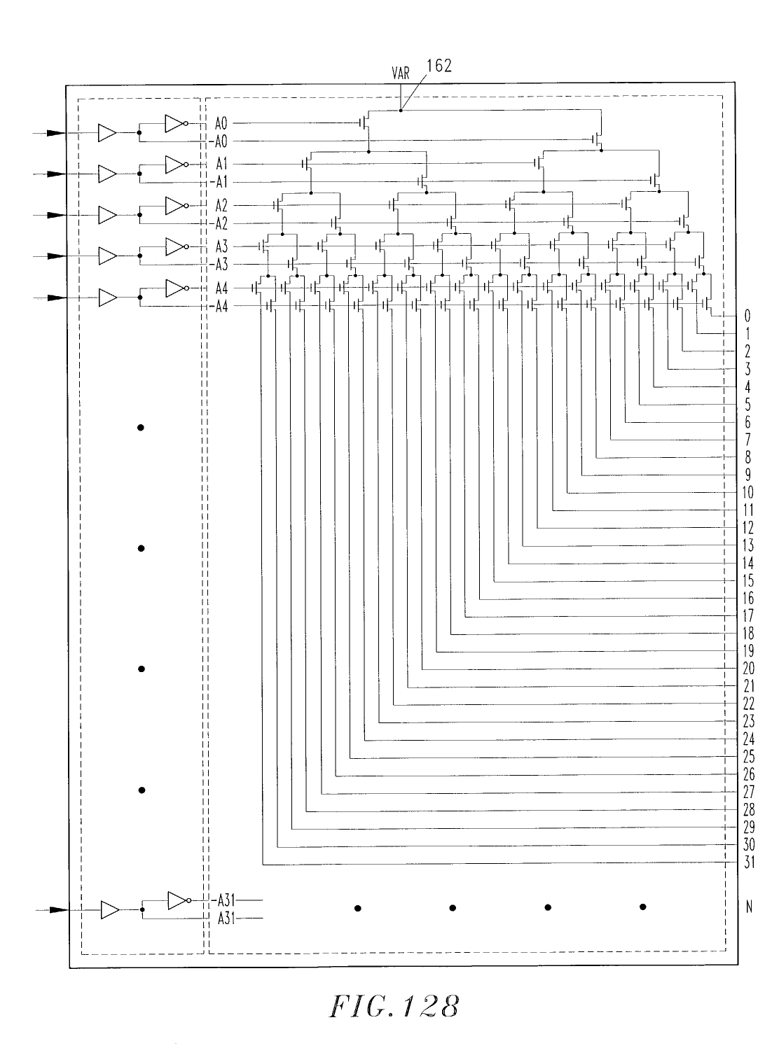

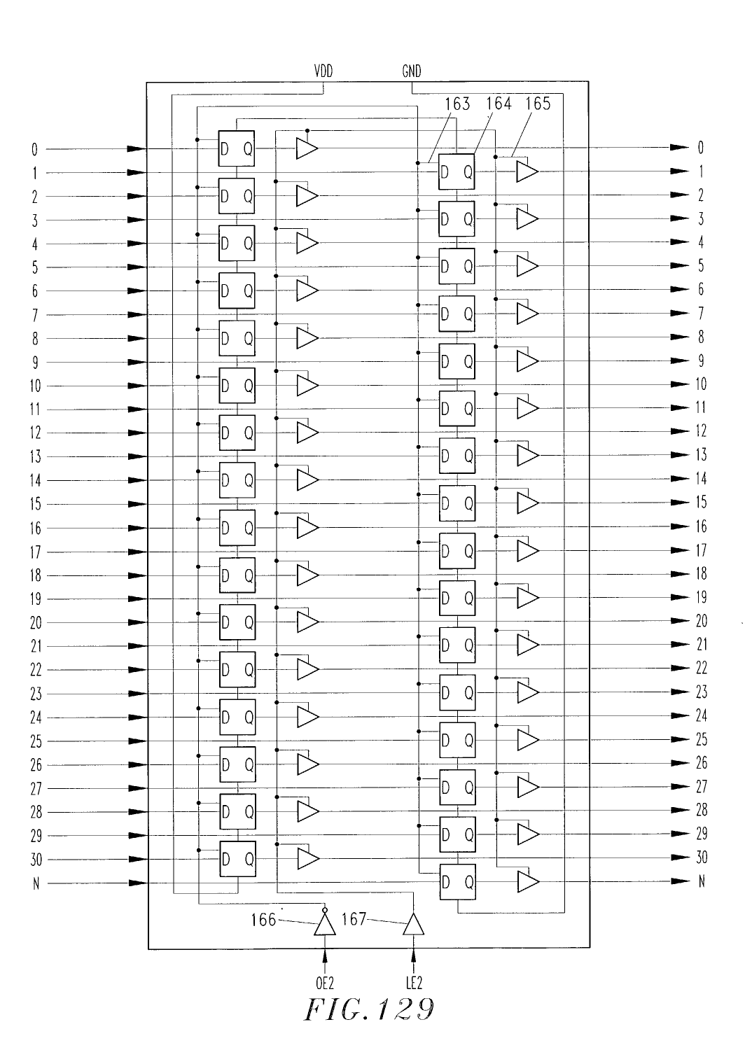

For example, each installed Microhead Array Chip will contiguously receive eight thirty-two bit microhead address signals from the Magneto-Optical Microhead Array Chip, Internal Data-Stripping, And Hard Disk Drive Controller, which are next latched within a Microhead Array Chip's “Microhead Addressing Unit” 131 (FIG. 124). Each time a microhead address signal is latched in circuit location 157, 158, 159 (FIG. 127) and then decoded in a microhead address decoder circuit location 162 (FIG. 128) an individual “Microhead Selection Line” (MSL) is selected to activate one particular microhead for use during a read-data disk-operation. At the same time each individual “Microhead Selection Line” (MSL) 154 (FIG. 126) has a different voltage-signal (voltage varies from 1 to 9 volts) placed on its line, which in turn is latched in circuit location 163, 164, 165 (FIG. 129), and used to select and activate one out of nine “Track Channel Bus” (TCB) data-bus lines 150, 149, 148 (FIG. 125 and 126).

Moreover, this step is repeated contiguously another eight times until each selected microhead has its own track-channel data-bus selected. Further, when a specific voltage is routed down a MSL line 154 it comes in contact with nine ‘Voltage-Detectors’ 140 (FIG. 131) that have each been configured, using a series of voltage passing diodes 139, to specifically pass only one particular voltage level. Each Voltage Detector has a ground-line (GND) 146, a CD line 145, a resistor-line 141 (FIG. 126), and a logic RESET line. When a specific voltage is passed through one of the nine ‘Voltage-Detectors’ 140 (FIGS. 126 and 132) the Voltage Detector's logic RESET line sends a logic “1” voltage signal to a group of three CMOS inverter logic-gates 141, causing them to allow read data-bus signals 151, 153 (FIG. 126) to pass on through to only one particular “Target Channel Bus” data-bus line 148, 149, 150 (FIG. 126). The read-data signals are generated by two photo-detectors 142, 144 (FIG. 126).

As illustrated in drawing FIGS. 113 through 139, a LIMDOW and MSR Magneto-Optical Microhead Array Chip's read-channel and its output signal's pathway begins at a LIMDOW and MSR Magneto-Optical Microhead Array Chip's two reversed-biased (SPC) “Semiconductor Photo-Conductor” semiconductor photoconductor-array read-elements 132, 142, 144, 108 (FIGS. 124, 126, 134, and 135). Further, as “magnetic-optical flux transitions”, previously recorded on a LIMDOW and MSR Magneto-Optical Microhead Array Chip Hard Disk Drive disk-platter data-surfaces pass under the previously selected microheads' low-intensity data-scanning “Read Laser” 207 (FIG. 138), the two reversed-biased (SPD) “Semiconductor Photo-Diode” read-elements 142, 144 mentioned above will generate output-voltages from the reflected light they receive as disk-platter data-surfaces 203, 204 (FIG. 138) rotate under pre-selected microheads. Further, the read-channel output signals created therein, will be passed from the two reversed-biased (SPD) “Semiconductor Photo-Diode” read-elements 142, 144 previously mentioned to the read-channel's (SPDAS1) “Semiconductor Photo-Diode Analog-signal 1” 174, 176 (FIG. 135) and (SPDAS2) “Semiconductor Photo-Diode Analog-signal 2” 175, 177 (FIG. 135) inputs for pre-amplification and signal encoding, as illustrated in FIGS. 125, 132, 133, and 135. Additionally, the pre-amplification 174, 175 of a selected microhead's data-stream signal-output will occur during a LIMDOW or MSR Magneto-Optical Microhead Array Chip Hard Disk Drive's read-data disk-operation.

In addition, each LIMDOW and MSR Magneto-Optical Microhead Array Chip's microhead addressing bus-system connection consists of a 32-bit input of thirty-two contacts 136, which are assigned numbers “A0” through “A31”, as illustrated in FIGS. 124 and 127. A 32-bit microhead address signal is latched when the OE1 160 (FIG. 127) and the LEI 161 (FIG. 127) chip-control circuits located within each LIMDOW or MSR Magneto-Optical Microhead Array Chip's “Microhead Addressing Unit” are simultaneously sent chip-control logic-signals, as illustrated in FIGS. 124 and 127. Further, the successfully latched 32-bit microhead selecting address-signal is next sent from the previously mentioned 32-bit “Address Latch Circuit” (FIG. 127) to the Microhead Addressing Unit's “Address Decoder Circuit” (FIG. 128) for decoding.

Subsequently, when a selected LIMDOW or MSR Magneto-Optical Microhead Array Chip's “Address Decoder Circuit” receives a 32-bit microhead location address-number selection signal (i.e., thirty-two high and low electronic signals) it will decode it internally using an “address tree decoder” circuit, as illustrated in FIG. 128. The process of decoding a latched 32-bit microhead location address-number by the before mentioned “address tree decoder” circuit results in the enabling of one microhead selecting “Microhead Selection-Line” (MSL) with a logic-high bus-signal. Wherein, the previously mentioned microhead selection-line, which, as an example is numbered as “4562”, is enabled out of “4,000,000,000” (i.e., thirty-two bits) of possible selection-line addresses (i.e., actual number of addressable section-lines within each microhead chip will more likely be between 100,000 and 300,000 addressable lines).

In addition, due to what is sometimes called “inverter body effect” or the signal loss caused by semiconductor circuits containing a large number of switchable inverters; e.g., like the number of inverters present in an “address tree decoder” circuit. Moreover, this is due to the shear number of MOSFET or MESFET inverter and/or emitter gates logic-high control-signals must travel through to accomplish microhead selection, which ultimately causes original logic-high control-signals to undergo signal-loss. Consequently, an address tree decoder's enabled “Microhead Selection-Line” (MSL) will need its logic-high control-signal regenerated by the Microhead Addressing Unit's an “Address Buffer Circuit” (FIGS. 124 and 129). Additionally, an “Address Buffer Circuit” (FIGS. 124 and 129) is also used to latch MSLN voltages, which makes TCBN selection possible.

Furthermore, every MSL located within a selected LIMDOW and MSR Magneto-Optical Microhead Array Chip's microhead array has its beginning in a Microhead Addressing Unit's “Address Decoder Circuit” (FIG. 128), while its termination is located in a respective Microhead Selection Line termination location (FIG. 126). Wherein, each individual “Microhead Selection Line” (MSL) 154 (FIG. 126) next has a different voltage-signal (voltage varies from 1 to 9 volts) placed on its line, which in turn is latched in circuit location 163, 164, 165 (FIG. 129), and used to select and activate for example one out of nine “Track Channel Bus” (TCB) data-bus lines 150, 149, 148 (FIG. 125 and 126). This step is repeated contiguously another eight times until each selected microhead has its own track-channel data-bus. Further, when a specific voltage is routed down a MSL line 154 it comes in contact with nine ‘Voltage-Detectors’ 140 (FIG. 131) that have each been configured, using a series of voltage passing diodes 139, to specifically pass only one particular voltage level. Each Voltage Detector has a ground-line (GND) 146, a CD line 145, a resistor-line 141 (FIG. 126), and a logic RESET line. When a specific voltage is passed through one of the nine ‘Voltage-Detectors’ 140 (FIGS. 126 and 132) the Voltage Detector's logic RESET line sends a logic “1” voltage signal to a group of three CMOS inverter logic-gates 141, causing them to allow read data-bus signals 151, 153 (FIG. 126) to pass on through to only one particular “Target Channel Bus” data-bus line 148, 149, 150 (FIG. 126). The read-data signals are generated by two photo-detectors 142, 144 (FIG. 126).

In addition, (RLV) “Read Laser Voltages” microhead laser power-signals, which are made input at the LIMDOW or MSR Magneto-Optical Microhead Array Chip's “Laser Signal N” (LSN) input-contacts (FIGS. 118 and 119). The switching on and period and the power-levels of electrical current that is sent to the LIMDOW or MSR Magneto-Optical Microhead Array Chip's “Laser Signal N” (LSN) power-bus lines are controlled and executed by a multitude of “Data Sequencers” (DSEQN) 235, as illustrated in FIG. 139. Further, although “Laser Signal N” (LSN) power-bus lines have been selected for a host-requested read-data disk-operation, no electrical-current will be sent down the power-lines until a host-requested data-sector has been rotated into position and detected as being underneath the host-selected microheads. Whereby, at the very instant the host-requested data-sectors line-up underneath the address selected microheads, low-powered electrical currents will be sent down the “Laser Signal N” (LSN) power-bus lines to the LIMDOW or MSR Magneto-Optical Microhead Array Chips' contacts LS1, LS2, LS3, LS4, LS5, LS6, LS7, LS8, and LSN 137 (FIGS. 118, 119, 120, 121, and 124).

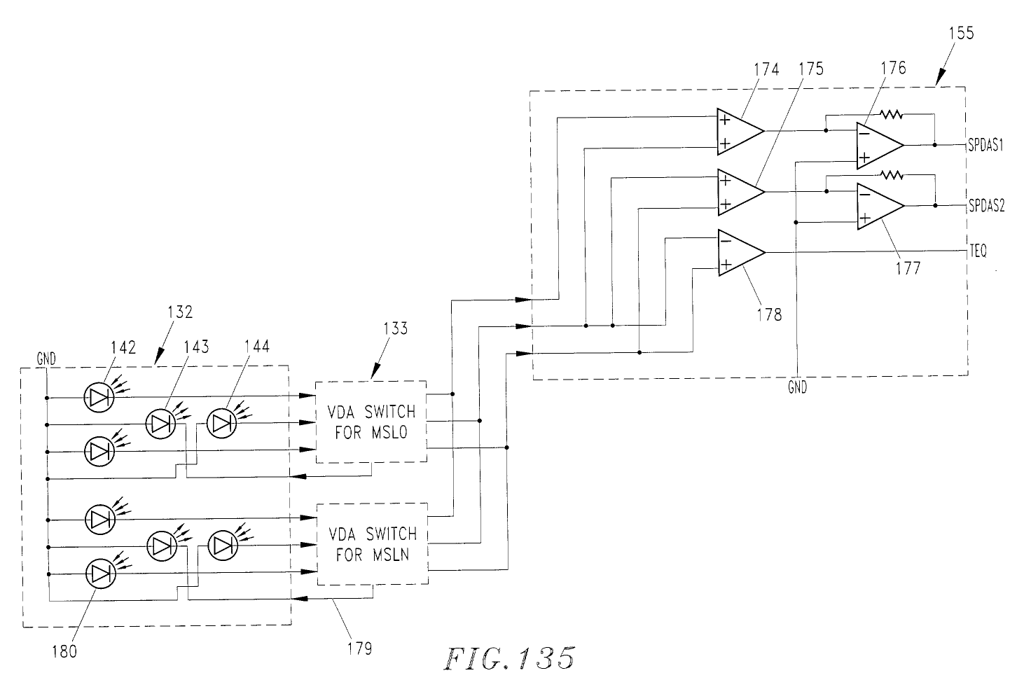

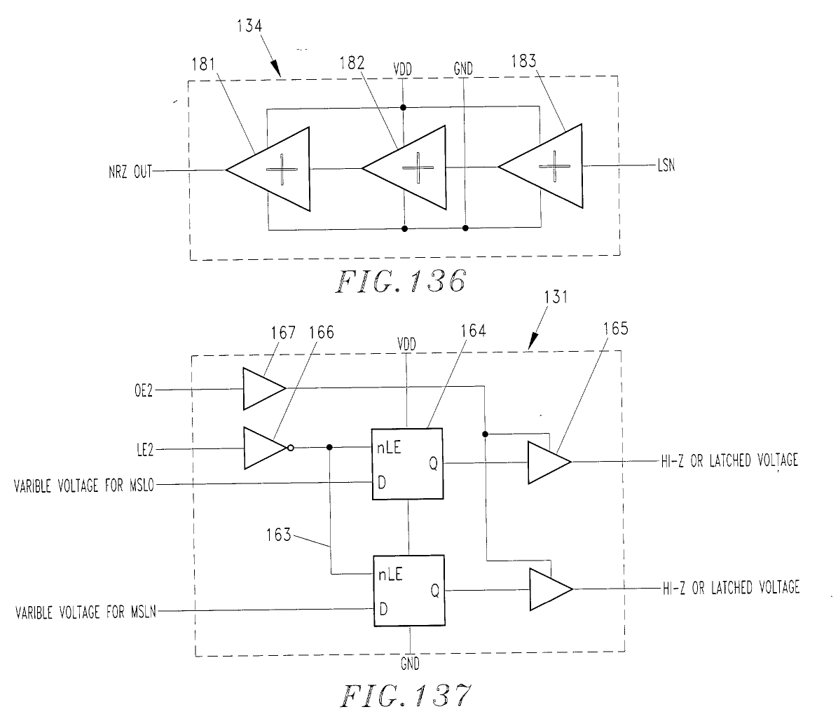

Moreover, from the LSN contacts the low-powered electrical current signals are internally rerouted to the LIMDOW or MSR Magneto-Optical Microhead Array Chips' 205, 206 (FIG. 138) internal “DVR ARRAY” circuit 134 (FIGS. 124 and 136), where they undergo pre-amplification by three passive signal-shaping operational amplifiers 181, 182, 183 (FIG. 136). Further, after pre-amplification the low-powered electrical read-data signals enter their respective TCB, where they are redirected to the LIMDOW or MSR Magneto-Optical Microhead Array Chips' internal “Microhead Array” 132 (FIGS. 124, 126, and 134) and their respective oval-shaped polarity-stable VCSEL laser-diodes 143 (FIGS. 126 and 134). Next, the multitude of low-powered read-data current signals are converted by a multitude of laser-diodes 143 (FIGS. 126 and 134) into a multitude of coherent laser-beam emissions 207, which are used to read data from each microheads' respective data-track, until the host-requested data-sectors located across a multitude of respective data-tracks are simultaneously read in one complete revolution of the disk-platter data-surfaces 203, 204 (FIG. 138) containing the respective data-sectors.

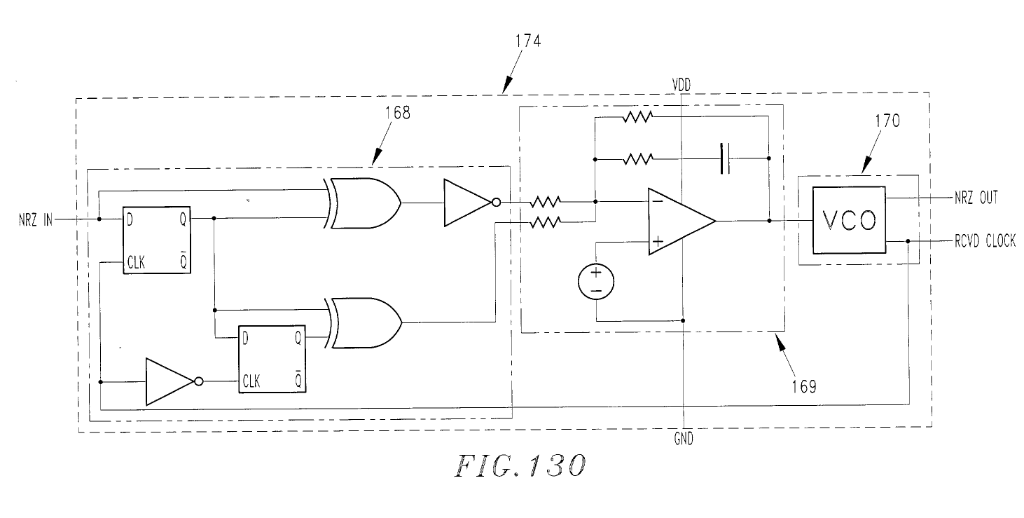

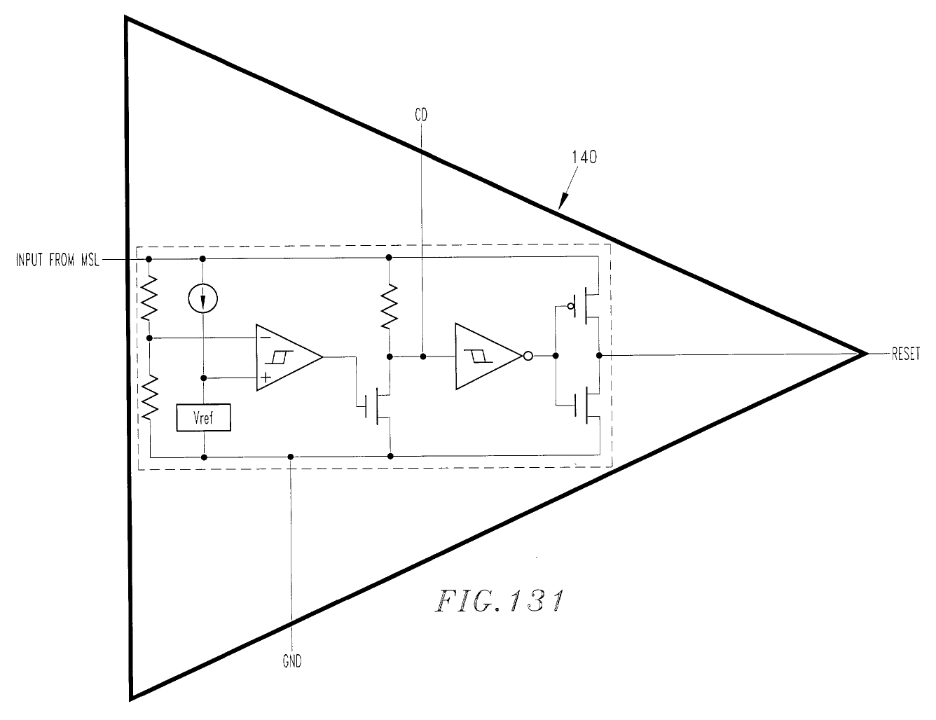

Moreover, the previously mentioned data-sector as it passes underneath the host-selected microhead it is essentially scanned by the microheads' data-reading low-power laser-emissions 207 (FIG. 138). Further, as this scanning process occurs, the resultant output is a streaming data-signal, which is partially encoded during its output to the Data-Sequencer's DPLL circuit 174 (FIG. 130), where it will receive additional signal conditioning and conversion. Afterwards, the DPLL processed data-signal is next passed via the Magneto-Optical Microhead Array Chip, Internal Data-Stripping, And Hard Disk Drive Controller's internal bus 234 (FIG. 139) to the Magneto-Optical Microhead Array Chip, Internal Data-Stripping, And Hard Disk Drive Controller's internal ECC circuit 243 (FIG. 139), where it is checked against an ECC table for errors, if the data is error free it is next passed to the Magneto-Optical Microhead Array Chip, Internal Data-Stripping, And Hard Disk Drive Controller's internal SDRAM memory cache 199 (FIG. 139), via the Magneto-Optical Microhead Array Chip, Internal Data-Stripping, And Hard Disk Drive Controller's internal bus and its “Buffer Controller” (BCLR) circuit 248 and the BCLR's address, control, data-bus lines 215, where the read-data is next stored temporarily until the host-system is ready to retrieve it from memory.

Furthermore, a LIMDOW or MSR Magneto-Optical Microhead Array Chip Hard Disk Drive's “Hall-Sensors” (i.e., not shown here) will provide information pertaining to disk-platter rotation relative to data-sector location. Accomplished, using constantly changing rotational placement of permanent-magnetic rotary-elements located within a rotor-housing 202 (FIG. 138), the Disk Controller, using Hall-Sensors, can detect a rotor's location relative to the permanent-magnetic rotary-elements. In this way the Disk Controller will always know at any given moment the location and rotational position of the hard disk drive's installed disk-platters and the data-sectors they contain. Moreover, the previously mentioned rotational placement is relative to the fixed windings and poles of a “Spindle-Motor” 201 (FIG. 138). Typically, the previously mentioned “Hall-Sensors” will provide response-feedback and control information to a LIMDOW or MSR Magneto-Optical Microhead Array Chip Hard Disk Drive's “MCTRL” 211 (FIG. 138) Spindle-Motor 201 driver-circuit, which is internally located in the Magneto-Optical Microhead Array Chip, Internal Data-Stripping, And Hard Disk Drive Controller 217 (FIGS. 138 and 139).

Moreover, the source of the laser-light used during host-requested disk-operations could possibly come from any applicably constructed semiconductor surface emitting laser-diode. Wherein, such semiconductor laser-diodes 143, along with their respective photo-detectors 142, 144, 180, would be comprised as a plurality of microheads 132 (FIG. 134) forming a “Microhead Array” 132 (FIG. 124) within each LIMDOW and MSR Magneto-Optical Microhead Array Chip. When data scanning laser-light comprising of “E-rays” of linearly polarized laser-light is reflected by a disk-platter's (MO) “Magneto-Optical” rare-earth recording medium, if the medium's area where the reflection takes place comprises of data-cells that are magnetized into a downward direction, then a LIMDOW or MSR Magneto-Optical Microhead Array Chip's Ahrens Polarizing Analyzer will convert the reflected “E-rays” into a low-intensity form of laser-light, which in turn will be made to impact the “SPD Array 1” (FIGS. 64A and 64E) (SPD) “Semiconductor Photo-Diode” photo detector array read-element to generate a low-peak signal-voltage analog-signal. Whereby, the previously mentioned low-peak signal-voltage analog-signal will be compared using a read-channel's first comparator to a divided by half reference-voltage analog-signal. Wherein, the previously mentioned comparator will create a digital logic-low data-bit, having a logic value of “0”.

Contradictorily, if a scanning laser-light comprising of “E-rays” of linearly polarized laser-light is reflected by a disk-platter's (MO) “Magneto-Optical” rare-earth recording medium, if the medium's area where the reflection takes place comprises of data-cells that are magnetized into an upward direction, then a LIMDOW or MSR Magneto-Optical Microhead Array Chip's Ahrens Polarizing Analyzer will convert the reflected “E-rays” into a high-intensity form of laser-light, which in turn will be made to impact the “SPD Array 1” (FIGS. 64A and 64E) (SPD) “Semiconductor Photo-Diode” photo detector array read-element to generate a high-peak signal-voltage analog-signal. Whereby, the previously mentioned high-peak signal-voltage analog-signal will be compared using a read-channel's first comparator to a divided by half reference-voltage analog-signal. Wherein, the previously mentioned comparator will create a digital logic-high data-bit, having a logic value of

In addition, lets take a closer look at a LIMDOW and MSR Magneto-Optical Microhead Array Chip's conversion of analog-signals to a digital data-stream, which only occurs during a host-requested read-data disk-operation. Moreover, digital data-streams are created when host-selected LIMDOW Magneto-Optical Microhead Array Chips' microhead arrays, during a read-data disk-operation, generate for each TCB, two analog-signals that are used to create the previously mentioned digital data-streams. Moreover, the first group of analog-signals called “signal-one” is generated from a multitude of (SPD Array 1) Semiconductor Photo-Diode Arrays 132 (FIG. 135) and sent out to a multitude of (SPDAS1) “Semiconductor Photo-Diode Analog Signal 1” pre-amp inputs. While the second group of analog-signals called “signal-two” is generated from a multitude of (SPD Array 2) Semiconductor Photo-Diode Arrays 132 (FIG. 135) and sent out to a multitude of (SPDAS2) “Semiconductor Photo-Diode Analog Signal 2” pre-amp inputs.

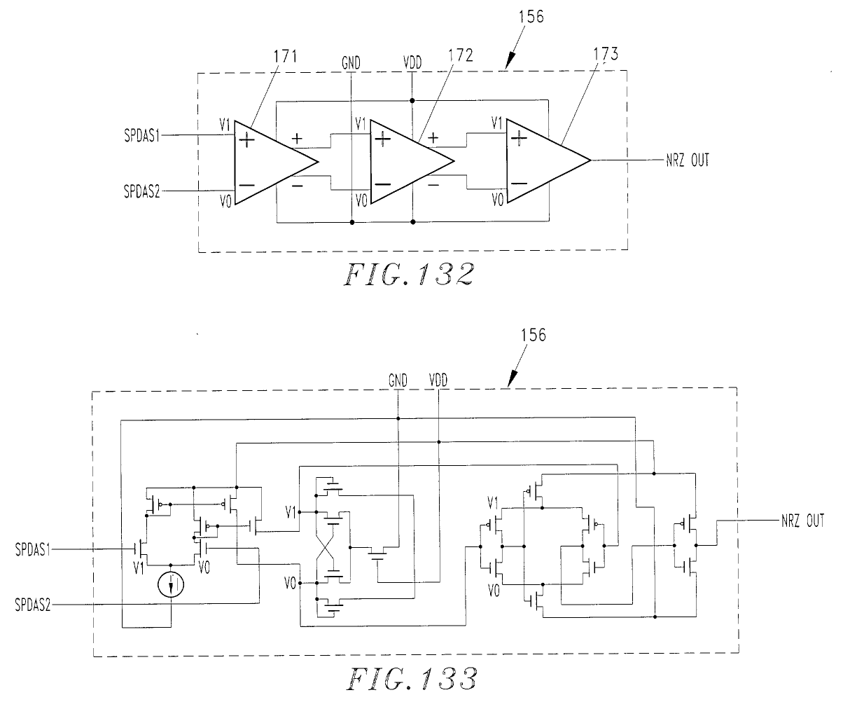

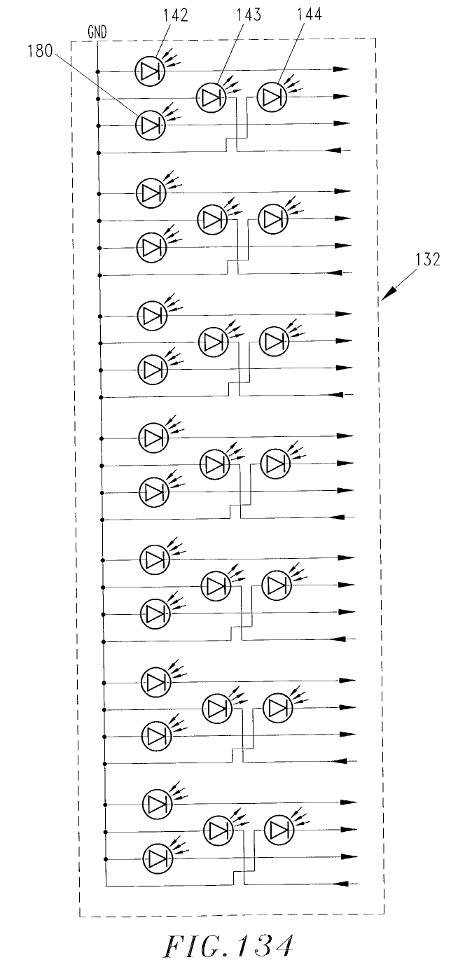

Furthermore, during a host-requested read-data disk-operation the previously mentioned analog-signals coming from a multitude of (SPDAS1) “Semiconductor Photo-Diode Analog Signal 1”, and (SPDAS2) “Semiconductor Photo-Diode Analog Signal 2” outputs are each pre-amplified by a transimpedence amplifier 155 (FIG. 135). Wherein, signal-voltage analog-signals and reference-voltage analog-signals enter a multitude of “Source Detectors” circuits 155 (FIG. 125). Whereby, these analog-signals will begin to undergo an “Analog to Digital” (ADC) conversion process. Additionally, after receiving signal-voltage analog-signals and reference-voltage analog-signals “High Performance Comparator” circuits 156 (FIGS. 132 and 133) located in a multitude of “Voltage Comparator For Track-Channels” 156 (FIG. 125) will begin a comparison process of the previously mentioned analog signals. Moreover, the “High Performance Comparator” circuits' 156 (FIGS. 125, 132, and 133) output of digital data-streams are based upon a logic formula, which states, (V1 positive)>(V0 negative)=(Logic 1)=(VDD) or “+5 Volts”, while (V1 positive)<(V0 negative)=(Logic 0)=(VSS) or “0 Volts”.

Therefore, if the signal-voltages received by a multitude “High Performance Comparators” comes from a multitude of SPDAS1 signal-voltage outputs 176 (FIG. 135) and have voltage levels above the voltage-thresholds of voltage-divided reference-signals coming from the multitude of SPDAS2 outputs, then the multitude of “High Performance Comparators” will output logic “1s”. However, if the signal-voltages received by a multitude “High Performance Comparators” comes from a multitude of SPDAS1 signal-voltage outputs 176 (FIG. 135) and have voltage levels below the voltage-thresholds of voltage-divided reference-signals coming from the multitude of SPDAS2 outputs, then the multitude of “High Performance Comparators” will output logic “0s”.

Furthermore, a “High Performance Comparator” circuit offers greater accuracy in its “analog-to-digital” signal conversions, while providing amplification to the comparators digital-signal output. Moreover, a “High Performance Comparator” circuit 156, as illustrated in FIGS. 132 and 133, consists of three-stages:

i.) An input-preamplifier stage 171, as illustrated in FIGS. 132 and 133;

ii.) A positive-feedback circuit or what is sometimes called a decision-stage circuit 172, as illustrated in FIGS. 132 and 133;

iii.) An output-buffer stage 173, as illustrated in FIGS. 132 and 133.

Subsequently, the previously mentioned input pre-amplifier stage 171 (FIGS. 132 and 133) amplifies incoming-signals to improve the aforesaid comparators sensitivity (i.e., increases the minimum input signal with which the previously mentioned comparator can make a precise decision when it converts an analog signal to a digital signal), while isolating input-signals from any switching noise that might come from the aforesaid positive-feedback stage (i.e., this stage is very important, because of the low signal-to-noise ratio the circuit provides to the track channel's output signals).

In addition, the positive-feedback stage 172 (FIGS. 132 and 133) is used to determine, by comparison, which of the two input-signal voltages is larger than the other. Next, the aforesaid output-buffer stage 173 (FIGS. 132 and 133) amplifies the signal output of the positive-feedback stage 172; creating a digital data-stream signal, which is next sent to a track channel's DPLL circuit 174 (FIG. 130), where it will undergo a process of encoding using a frequency-specific “Bi-Phase Data Encoding” code.

Moreover, the resulting output-signal is a “Bi-Phase Encoded Data Stream”, which is next sent to a LIMDOW Magneto-Optical Microhead Array Chip's (Dout) “Data out” output-contact, pin-number “63”. Contiguously, a “Bi-Phase Encoded Data Stream” output-signal will travel onto the aforesaid data-bus cable (FIGS. 15 and 16), where it is lead to a Disk Controller's “Data-Sequencer”, as illustrated in FIGS. 62A, 63A, 62C, and 63C. Moreover, the read-channel's frequency-specific bi-phase data encoded data-stream output-signal is next made to enter a Data Sequencer's (DPLL) “Digital Phased-Locked Loop” circuit for further signal processing (FIGS. 62A, 63A, 62B, and 63B); wherein, the data-stream output-signal is decoded and its clock-signal recovered (FIG. 106) (i.e., the following paragraphs will explain this process in greater detail).

Moreover, during a host requested read-data disk-operation a Data Sequencer's “Data Transfer Rate Frequency Analyzer” (FIGS. 62A, 63A, 62B, and 63B) will calculate the optimal transfer frequency-rate for any data-zone needing to be read, and communicates that calculation to a Data Sequencer's “Multi-Frequency Clock Synthesizer” module, as illustrated in FIGS. 62A, 63A, 62B, and 63B. Next, a Data Sequencer's “Multi-Frequency Clock Synthesizer” will generate a clock-referencing voltage-signal that is based upon the previously mentioned calculations it received from a Data Sequencer's “Data Transfer Rate Frequency Analyzer”, and sends it to a Data Sequencer's (DPLL) “Digital Phased-Locked Loop” circuit, where it is used to assist in the synchronous and error free transmission of signals containing host-requested data, which were reproduced from optically stored data contained in data-sector locations of specific disk-platter data-surfaces.

In addition, a (DPLL) “Digital Phased-Locked Loop” circuit (FIGS. 62A, 63A, 62B, and 63B) has a (VCO) “Voltage Controlled Oscillator” circuit that is used to generate a divided-by-two dclock-signal from the clock-referencing voltage-signal it received from a Data Sequencer's “Multi-Frequency Clock Synthesizer”. Wherein, a (VCO) will send the dclock-signal it created through a (MFCLK) “Multi-Frequency Clock” control-bus line (FIGS. 15 and 16), which is connected to all (MFCLK) “Multi-Frequency Clock” input-contacts, pin-number “35”, of all installed LIMDOW Magneto-Optical Microhead Array Chips, as illustrated in FIGS. 11, 12, 13, and 14. Furthermore, from the host-selected LIMDOW Magneto-Optical Microhead Array Chip, which is presented within this embodiment as chip number-5, the received (DCLOCK) “Divided Clock” dclock-signal is rerouted from input-contact, pin-number “35”, to a second entrance, which is located at the clock-input portion of a read-channel's pre-dpll circuit (FIG. 106), while a first entrance is located at the data-stream input for the read-channel's “XOR Phase Detector” circuit, as illustrated in FIGS. 85, 86, 91, and 92.

Moreover, a read-channel's buffered output of data-stream signals directly enter the data-input entrance (FIG. 106) located at the read-channel's “XOR Phase Detector” circuit, as illustrated in FIGS. 85, 86, 91, 92, and 106, where the previously mentioned data-stream signals will undergo a bi-phase data encoding process. Therefore, during the host requested read-data disk-operation any data read using LIMDOW Magneto-Optical Microhead Array Chip number: “5”, from data-surface: “5”, at cylinder/track number: “4562”, at sector number: “43” is converted from a photo-generated analog-signal to a comparator generated digital-signal, which is passed on through the previously mentioned XOR phase-detector's “Bi-Phase Data Encoding Circuit” (FIGS. 85, 86, 91, and 92), where data-stream output are encoding then sent to the Data Sequencer's (DPLL) “Digital Phase-Locked Loop” circuit (FIG. 106) for signal processing, decoding, buffer storage, and (ECC) “Error Correction Code” correction.

Furthermore, the Disk Controller's “Data Sequencer” contains the data receiving portion of a LIMDOW Magneto-Optical Microhead Array Chip's pre-dpll circuit, which is located within the Data-Sequencer's (DPLL) “Digital Phase-Locked Loop” circuit, as illustrated in FIGS. 62A, 63A, 62B, and 63B. In addition, the Data Sequencer's (DPLL) “Digital Phase-Locked Loop” circuit, as illustrated in FIGS. 62A, 63A, 62C, 63C, will use circuits located within its (VCO) “Voltage Controlled Oscillator” circuit to recover a clock-signal from the “Bi-Phase Encoded Data Stream” output-signals it receives. After its extraction by the (VCO) “Voltage Controlled Oscillator” circuit the recovered clock-signal is primarily used during a host requested read-data disk-operation to resolve any data-transfer frequency-rates for any disk-platter data-zone needed to be read, as per read-data requests sent by the host-system. Moreover, the Disk Controller's “Data Sequencer” is designed to make on-the-fly data-transfer frequency-rate comparisons, which will be used to make on-the-fly adjustments to a LIMDOW Magneto-Optical Microhead Array Chip Hard Disk Drive's data-transfer frequency-rates and spindle motor control systems that control the rate of rotation for all disk-platters installed into a LIMDOW Magneto-Optical Microhead Array Chip Hard Disk Drive's unit-assembly.

Therefore, when the “Data Sequencer” makes an on-the-fly comparison of the various signals previously described, an on-the-fly data transferring frequency-rate optimization and/or correction can be made using the DPLL's clock generating (VCO) “Voltage Controlled Oscillator” (FIG. 106) circuit to execute changes in data-transfer frequency rates occurring within the DPLL circuit, by implementing change to the frequency rate of its dclock output signal. Moreover, on-the-fly adjustments to a Spindle-Motor's “constant angular velocity” are accomplished using a Data Sequencer's “Disk Controller Interface”. Wherein, the “Disk Controller Interface”, by analyzing various information provided by feed-back signals can accurately control a Spindle-Motor's rate of revolutions per-minute using a Disk Controller's “Motor Controller” circuit to execute an on-the-fly control over a LIMDOW MSR Magneto-Optical Microhead Array Chip Hard Disk Drive's Spindle-Motor, as illustrated in FIGS. 62A, 63A, 62B, 63B, 62C, and 63C.

Consequently, this will offer a more responsive and a faster Phased-Locked Loop of data-stream output-signals created by a selected LIMDOW MSR Magneto-Optical Microhead Array Chip's read-channel during read-data disk-operations.

Moreover, as illustrated in FIG. 106, the Data Sequencer's (DPLL) “Digital Phase-Locked Loop” circuit, after receiving the read-channel's encoded data-stream output-signal, will decode the “Bi-Phase Encoded Data Stream” and recover the clock-signal contained within the data-stream signal, using circuits that are located within the DPLL's (VCO) “Voltage Controlled Oscillator” circuit (FIG. 106) to execute the clock-signal's recovery from the data-stream output-signal. The clock-signal after being recovered by the DPLL's (VCO) “Voltage Controlled Oscillator” circuit is next sent to a Data Sequencer's “Data Transfer Rate Frequency Analyzer” for further processing. Wherein, the previously mentioned “Data Transfer Rate Frequency Analyzer” will make an on-the-fly comparison between the data-transfer frequency rate of the DPLL's recovered clock-signal and the original data-transfer frequency rate that was calculated earlier and used to initialize a read-data disk-operation for a particular host-requested data-zone, by using the calculated data-transfer frequency rate to resolve the data-zone's data-transfer frequency rate.

Moreover, the Data Sequencer's “Data Transfer Frequency Rate Analyzer” will analyze various on-the-fly comparisons, in order to create an optimized data-transfer frequency rate calculation, which after its creation is sent to a Data Sequencer's (MFCS) “Multi-Frequency Clock Synthesizer” module, as illustrated in FIGS. 62A, 63A, 62B, and 63B. Wherein, the (MFCS) “Multi-Frequency Clock Synthesizer” will use the data-transfer frequency-rate calculation it received from the Data Sequencer's “Data Transfer Frequency Rate Analyzer” to create a new clock-signal at the new frequency rate, which is sent to a DPLL's “Voltage Controlled Oscillator” circuit to be re-routed as a divided or dclock-signal back to the selected LIMDOW Magneto-Optical Microhead Array Chip, where it will be used to implement read-data synchronization of the data-stream output-signal and the Disk Controller. In addition, the before mentioned decoded “Bi-Phase Encoded Data Stream” data-signal is also re-encoded by the aforesaid (VCO) “Voltage Controlled Oscillator” circuit (FIG. 106) into a conventional (NRZ) “Non-Return to Zero” encoded data-signal, which after its re-encoding is transferred to a Disk Controller's “PRML Controller” circuit, as illustrated in FIGS. 62A, 63A, 62B, and 63B, where it will undergo additional signal processing.

In addition, the encoding of a read-channel's data-stream output-signals with “Bi-Phase Data Encoding” is executed using an exclusive “XOR Phase Detector” circuit to perform the process, as illustrated in FIGS. 91, 92, 93, 94, 95, and 106. This strategy makes possible a recovery of a clock-signal from the read-channel's data-stream output-signals, and the conversion of the remaining data-stream, from a “Bi-Phase Encoded Data Stream” into a regular (NRZ) “Non-Return to Zero” encoded data-stream into a simple process, as illustrated in FIG. 106. Furthermore, the previously mentioned bi-phase data encoding of the read-channel's data-stream output-signals, make it possible to “Digitally Phase-Lock Loop” the data-stream with much greater accuracy, while not having to place an odd-parity bit at the end of every eight-bit word to eliminate the possibility of all eight bits being high.

Therefore, when we use “Bi-Phase Data Encoding” (FIG. 93) to encode a data-stream output-signal, the parity bits normally used by a data-stream output-signal to achieve full data-transfer synchronization are not needed when using this scheme. Next, the (NRZ) “Non-Return to Zero” encoded data-stream is sent by the DPLL's (VCO) “Voltage Controlled Oscillator” (FIG. 106) circuit as a serial signal to a Data Sequencer's “PRML Controller” circuit for “Veterbi” signal-analysis. The Data Sequencer's “PRML Controller” circuit is also where a (NRZ) “Non-Return to Zero” encoded serial data-stream will undergo a final conversion, where it is changed into a 16-bit double data-word. After its conversion the reproduced data is sent to a Disk Controller's “Buffer Controller” for temporary storage, so that the Data Sequencer's “Disk Controller Interface” and “ECC” circuits, as illustrated in FIGS. 62A, 63A, 62B, 63B, 62C, and 63C, can identify the temporarily stored data as belonging, for example, to the host-requested target data-sector “43”.

Consequently, if the Data Sequencer's “Disk Controller Interface” and “ECC” circuits, as illustrated in FIGS. 62A, 63A, 62B, 63B, 62C, and 63C, make a positive target-sector identification, for example sector “43”, then the read-data the Disk Controller's “Buffer Controller” has temporarily stored, can now be presented to the host-system in the form of 16-bit data-blocks, which is executed through a Disk Controller's “IDE or SCSI Interface Controller”. During a read-data disk-operation when a full data-sector is read (i.e., for example data-sector “43” being a full sector of “1024k”) into the Disk Controller's “Buffer Controller” for temporary storage, the Disk Controller's (ECC) “Error Correction Control” circuit module will check to see if the firmware stored in a Disk Controller's “Serial EEPROM” needs to apply (ECC) “Error Correction Control” to the just read data. The Disk Controller's “Buffer Controller” will store the just read data into a temporary memory-cache, while (ECC) “Error Correction Code”, if needed, is applied, if it is not, the data is transferred to the host-system using the IDE or SCSI interface system's bus-channel as the transfer interface. Wherein, the Disk Controller's “IDE or SCSI Interface Controller” is used to execute and control the transfer of host-requested data to the host-system, for example, the transfer host-requested data read from data-sector “43”.

In addition, a write-channel's signal-path, during a write-data disk-operation, accept for microhead addressing process, which are the same for both read-data and write-data disk-operations, follows a reversal of the steps used to describe the read-channel's signal-path during a read-data disk-operation. Further, because data-blocks can be presented to a LIMDOW Magneto-Optical Microhead Array Chip Hard Disk Drive at transfer-rates that exceeds the transfer-rate at which a LIMDOW Magneto-Optical Microhead Array Chip Hard Disk Drive can write-data to a LIMDOW Magneto-Optical Microhead Array Chip Hard Disk Drive disk-platter's data-surface; therefore, data is stored temporarily in the Buffer Controller's cache-memory. Furthermore, the host-system can present data to a LIMDOW Magneto-Optical Microhead Array Chip Hard Disk Drive for storage at transfer-rates independent of the transfer-rate at which a LIMDOW Magneto-Optical Microhead Array Chip Hard Disk Drive can write-data to a LIMDOW Magneto-Optical Microhead Array Chip Hard Disk Drive disk-platter's data-surface.

Therefore, upon correct identification of a target-sectors address, the before mentioned data-block is shifted to a Data Sequencer's “Disk Controller Interface” and “ECC” circuits, as illustrated in FIGS. 62A, 63A, 62B, 63B, 62C, and 63C. After the data-block is shifted to the area located within the “Disk Controller Interface” and “ECC” circuits, (ECC) “Error Correction Code” will be generated and appended to the before mentioned data-block. In addition, a Data Sequencer's “Data Encoder” will next convert the temporarily stored data-blocks into a (NRZ) “Non-Return to Zero” encoded serial data-stream input-signal. The data-stream input-signal, after being encoded will be transferred at a calculated and optimal data-transfer frequency-rate for the data-zone containing the empty data-sector the host-system will use for data storage. The data-stream input-signal is used to complete the write-data disk-operation, by using its encoded data-stream to execute a controlled modulation of magnetic fields, in conjunction with data-writing laser-emissions, to create a faithful writing of the data that comprises the data-stream input-signal. During a write-data disk-operation, data is written to the magnetic recording layer present within all LIMDOW Magneto-Optical disc media, using the LIMDOW Magneto-Optical process of data-recording to write the data as “optically isolated magnetic transitions” at a particular cylinder/track location pre-selected as having an empty data-sector available for data storage, as illustrated in FIGS. 62A, 63A, 62B, 63B, 62C, and 63C.

Furthermore, at a precise rotational moment, when the host-requested disk-sector to be written too is directly underneath the host-selected microhead, an encoded (RLL) “Runtime Length Limited” data-stream signal is transmitted from the Data Sequencer's “Data Bus Controller”, as illustrated in FIGS. 62A, 63A, 62B, 63B, 62C, and 63C, to a selected LIMDOW Magneto-Optical Microhead Array Chip's (DIN) “Data In” input-contact, assigned pin-number “63” (FIGS. 64A and 64C). Wherein, the previously mentioned data-stream signal is re-routed to a host-selected LIMDOW Magneto-Optical Microhead Array Chip's Write Pre-amp Circuit's (DIN) “Data In” input, where the (RLL) “Runtime Length Limited” data-stream signal is first pre-amplified and then sent to the (DMOD1) “Data Modulated Input 1” input of the selected LIMDOW Magneto-Optical Microhead Array Chip's Write Driver Circuit.

Furthermore, when a host-selected LIMDOW Magneto-Optical Microhead Array Chip's “Address Decoder Circuit” sends a microhead selection-line's signal to a host-selected LIMDOW Magneto-Optical Microhead Array Chip's “Address Buffer Circuit”, as illustrated in FIGS. 64A, 64B, 73, and 74, two very important and simultaneous processes will occur:

i.) A signal regeneration of an address tree decoder's only enabled microhead selection-line, by a LIMDOW Magneto-Optical Microhead Array Chip's “Address Buffer Circuit”, will occur;

ii.) The unsolicited microhead selection-lines of the address tree decoder are pulled-down to a ground state through the microhead selection-lines' internal Long-L inverters, as illustrated in FIGS. 64A, 64B, and 74, where pulling-down of the unsolicited microhead selection-lines, into a grounded state, will also put the unsolicited microhead selection-lines into a (Hi-Z) “High Impedance Line State”.

Furthermore, every microhead selection-line within a LIMDOW Magneto-Optical Microhead Array Chip has its circuit beginning in an “Address Decoder Circuit” and its circuit ending to occur at its respective microhead. Wherein, each selection-line is terminated with a selection-line transmission-gate control-circuit, which is attached to a selection-line's circuit ending, as illustrated in FIGS. 64A, 64B, 64E, 107, and 111. Moreover, a selection-line's transmission-gate (FIGS. 107 and 111) will independently control its respective microhead's access to power-bus lines, as illustrated in FIGS. 107 and 111.

However, (RLV) “Read Laser Voltage”, (WLV1) “Write Laser Voltage One”, and (WLV2) “Write Laser Voltage Two” power-bus power signals are inputted at a single (FIGS. 107 and 111) (LVIN) “Laser Voltage In” input (FIGS. 64A and 64E), or to be more specific, the switching between the (RLV) “Read Laser Voltage”, (WLV1) “Write Laser Voltage One”, and (WLV2) “Write Laser Voltage Two” power-bus power signals occurs within a LIMDOW Magneto-Optical Microhead Array Chip's (VCSEL Microhead PCC) “Vertical Cavity Surface Emitting Laser Power Control Circuit”, as illustrated in FIGS. 64A, 64D, 109, and 110, by a “R/W Control Circuit”, as illustrated in FIGS. 87, 88, 89, and 90.

Furthermore, every installed LIMDOW Magneto-Optical Microhead Array Chip is connected to a LIMDOW Magneto-Optical Microhead Array Chip Hard Disk Drive's three-bus system, which are labeled as:

i.) The “Address Bus” bus-system;

ii.) The “Data I/O Bus” bus-system;

iii.) The “Chip Control Bus” bus-system.

Thereafter, the host-selected LIMDOW Magneto-Optical Microhead Array Chip, which is labeled as LIMDOW Magneto-Optical Microhead Array Chip number “5”, becomes the only LIMDOW Magneto-Optical Microhead Array Chip connected to a LIMDOW Magneto-Optical Microhead Array Chip Hard Disk Drive's bus-system to have its write-channel, during a write-data disk-operation, activated. While all of the other installed LIMDOW Magneto-Optical Microhead Array Chips connected to a LIMDOW Magneto-Optical Microhead Array Chip Hard Disk Drive's bus-system, would have their write-channels three-stated into a (Hi-Z) “High Impedance Line State”.

Furthermore, a (MPCC) “Microhead Power Control Circuit” also receives a (WE) “Write Enable” logic-high control-signal from the before mentioned “R/W Control Circuit”, which will cause the aforesaid VCSEL Microhead PCC's transmission-gate controller to switch its selection (FIGS. 109 and 110) of (WLV) “Write Laser Voltage” bus-line over to the (RLV) “Read Laser Voltage” bus-line. Moreover, the switch selected (WLV) “Write Laser Voltage” bus-line can now channel a Write Laser Voltage to a (LVOUT) “Laser Voltage Output” circuit terminal (FIGS. 109 and 110), which leads to a host-selected LIMDOW Magneto-Optical Microhead Array Chip VCSEL microhead array's input terminal (LVIN) “Laser Voltage Input” terminal (FIGS. 107 and 111), and although the previously mentioned (WLV) “Write Laser Voltage” power-line (FIGS. 107 and 111) has been selected for a host-requested write-data disk-operation no electrical-current will be sent to the host-selected VCSEL microhead; at least, not until the host requested data-sector passes directly underneath the previously selected VCSEL's microhead. Moreover, when the host requested data-sector rotates directly underneath the previously selected VCSEL's microhead will a high-output of electrical current be sent down a (WLV) “Write Laser Voltage” power-line (FIGS. 107 and 111) turning on a host-selected VCSEL microhead's high-powered write-data laser emission.

Moreover, if a host-selected LIMDOW Magneto-Optical Microhead Array Chip Hard Disk Drive disk-platter's data-surface domain-cell contains (TbFeCo) “Terbium-Iron-Cobalt” or (GdTbFe) “Gadolinium-Terbium-Iron” crystals having an upward magnetic direction they represent a binary “1”; however, if a host-selected LIMDOW Magneto-Optical Microhead Array Chip Hard Disk Drive disk-platter's data-surface domain-cell contains (TbFeCo) “Terbium-Iron-Cobalt” or (GdTbFe) “Gadolinium-Terbium-Iron”, crystals having a downward magnetic direction they represent a binary “0”.

In addition, as illustrated in drawing FIGS. 4, 5, 62A, 63A, 62B, 63B, 62C, and 63C, this preferred embodiment describes both read-channel and write-channel circuit configurations used by the LIMDOW Magneto-Optical Microhead Array Chips along with their connectivity to the operational control of a LIMDOW Magneto-Optical Microhead Array Chip Hard Disk Drive's SCSI or IDE interface designs, which are both used to connect a LIMDOW Magneto-Optical Microhead Array Chip Hard Disk Drive up to a host computer system.

Furthermore, the before mentioned two reversed-biased (SPC) “Semiconductor Photo-Conductor” linear position-sensing (CdS) “Cadmium Sulfide” semiconductor devices 103, 104, 107, 108 (FIGS. 41, 42, 43, 44, 45, 46, 47, 48, 49, 50, 51, and 52), or as a different preferred embodiment, the before mentioned two reversed-biased (SPD) “Semiconductor Photo-Diode” (Si) “Silicon” semiconductor photocell arrays. In addition, since the previously mentioned two reversed-biased (SPD) “Semiconductor Photo-Diode” (Si) “Silicon” semiconductor photocell arrays 103, 104, 107, 108 (FIGS. 41 and 42) are incapable of detecting frequencies of ultra-violet light so they must be coated with a phosphorous material like “Coronene” or “Liumogen” to convert disk reflected ultra-violet light into detectable frequencies of visible light. Furthermore, the previously mentioned photocell arrays are the last two of three semiconductor substrate surfaces present within a LIMDOW Magneto-Optical Microhead Array Chip device to be photo-resist oxide-masked, etched, and built-up, through MBE, into semiconductor circuit arrays.

1. An optical hard disk drive that uses a connected plurality of non-positional, stationary, photo-emitters and photo-detectors in place of a single positional, non-stationary, photo-emitter and photo-detector to facilitate the transcription or the retrieval of information to or from at least one data-surface of at least one non-volatile limdow or msr memory medium, comprising:
a) an arrangement of coils and magnets that converts electric current into mechanical power providing for a rotation of said non-volatile limdow or msr memory medium,
b) at least one rotatable non-volatile limdow or msr memory medium having at least one data-surface used for said transcription or said retrieval of said information to or from said data-surface,
c) at least one connected plurality of photo-emitters and photo-detectors positioned into stationary locations above said data-surface of said rotatable non-volatile limdow or msr memory medium,
d) parallel circuitry which allows the transfer of electrical impulses to or from said connected plurality of photo-emitters and photo-detectors to or from at least one central processing unit used to control system wide operation of said optical hard disk drive,
whereby, said optical hard disk drive successfully replaces said single positional, non-stationary, photo-emitter and said single positional, non-stationary, photo-detector with a new technology that is stationary which, during catastrophic disk failure is non-destructive to digital information previously transcribed onto said data-platters, and
whereby, a photo-emitter positioned above a host requested cylinder-track location is switched on, while a different amplitude modulated photo-emitter positioned above a previously requested cylinder-track location is simultaneously switched off, causing the seek-times of said optical hard disk drive to be decreased by at least two-thousand times over current flying-head magnetic or optical hard disk drives.
